(19) United States
(12) Patent Application Publication
(10) Pub. No.: US 2022/0089237 A1
(43) Pub. Date: Mar. 24, 2022

(54) ROBOTIC PRODUCTION ENVIRONMENT FOR VEHICLES

(71) Applicant: ARRIVAL LTD., London (GB)

(72) Inventors: Denis SVERDLOV, London (GB); Douglas MORTON, London (GB); Sergey MALYGIN, London (GB); Andrey KOSTIN, London (GB); Andrey VOLKOV, London (GB); Alexis LARIN, London (GB); Dmitrii RUDNITCKII, London (GB); Murray SCHOFIELD, London (GB); Rob THOMPSON, London (GB); Jennifer CHAPMAN, London (GB); Patrick BION, London (GB); James GADD, London (GB); Ben JARDINE, London (GB); Glenn SAINT, London (GB); Tom ELVIDGE, London (GB); Karandeep BHOGAL, London (GB); Daryl ZALAN, London (GB)

(21) Appl. No.: 17/348,988

(22) Filed: Jun. 16, 2021

(30) Foreign Application Priority Data
Jun. 16, 2020 (GB) 2009134.4
Jul. 2, 2020 (GB) 2010194.5
Aug. 19, 2020 (GB) 2012958.1
Sep. 9, 2020 (GB) 2014142.0
Sep. 17, 2020 (GB) 2014676.7
Oct. 15, 2020 (GB) 2016381.2
Oct. 22, 2020 (GB) 2016782.1
Mar. 2, 2021 (GB) 2102953.3
Mar. 9, 2021 (GB) 2103252.9
Mar. 16, 2021 (GB) 2103641.3

(51) Int. Cl. B62D 65/04; B62D 65/18; B62D 65/02; B25J 9/16

(52) U.S. Cl. CPC B62D 65/04; B25J 9/1697; B62D 65/024; B62D 65/18

(57) ABSTRACT

A vehicle robotic production environment, in which the environment hosts robotic agents that are organised as groups of cells, each cell with no more than 10 robots. One group of robotic cells transforms fabric into vehicle composite panels and other parts, eliminating the need for steel panel pressing equipment. Other robotic cells assemble at least portions of a vehicle together from modular components, such as aluminium extrusions. Each cell is served by AMRs (autonomous mobile robots), eliminating the need for a costly moving production line. The robotic production environment can be implemented or installed in a factory that is less than 25,000 square meters in area, with a conventional flat concrete floor that has not been strengthened for a vehicle body panel stamping press. Conventional vehicle production plants are typically over 1M square meters in area, with specially strengthened concrete floors.

### CROSS-REFERENCE TO RELATED APPLICATIONS

This application is based on, and claims priority to GB Application No. GB2009134.4, filed 16 Jun. 2020; GB Application No. GB 2010194.5, filed 2 Jul. 2020; GB Application No. GB 2012958.1, filed 19 Aug. 2020; GB Application No. GB 2014142.0, filed 9 Sep. 2020; GB Application No. GB 2014676.7, filed 17 Sep. 2020; GB Application No. GB 2016381.2, filed 15 Oct. 2020; GB Application No. GB 2016782.1, filed 22 Oct. 2020; GB Application No. GB 2102953.3, filed 2 Mar. 2021; GB Application No. GB 2103252.9, filed 9 Mar. 2021; and GB Application No. GB 2103641.3, filed 16 Mar. 2021, the entire contents of each of which being fully incorporated herein by reference.

### TECHNICAL FIELD

This disclosure relates to robotic production environments for vehicles, as well as systems and methods for assembling vehicles that are designed for robotic production. Specific vehicle components, such as composite panels, as well as entire families of vehicles, designed for efficient customisation to meet customer requirements using automated vehicle design tools, are also disclosed.

We use the term ‘vehicle’ in this specification expansively to cover anything that can move or transport people or goods, e.g. over road, rail, air or sea; it includes manually driven vehicles; vehicles with SAE (J3016) Automation levels 0-5; it includes drones. It includes cars, shuttles, trucks, vans, buses, trains, trams, boats, hovercraft and aircraft. Zero emission electric vehicles are an important focus.

### BACKGROUND

Creating sustainable environments, especially urban environments, will require a broad range of vehicle innovations; vehicles will need to be zero or low-emission, yet will need to be designed to be manufacturable to deliver purchase price parity with conventional internal combustion engine (ICE) vehicles, despite including very costly battery packs or fuel cells. This new generation of vehicles would ideally be purpose-built for specific market needs or customer requirements; the implicit requirement underlying this goal is that, even at relatively low volumes (e.g. 10,000 units a year), these vehicles would need to be designed to be manufacturable to deliver purchase price parity with conventionally manufactured vehicles.

If we take some specific vehicle segments, namely battery-powered zero emission electrically powered cars, vans and buses, then achieving these goals is especially challenging. ICE price parity for low production run vehicles that target specific niches is not possible with the current vehicle design and manufacturing paradigm, with a 3-5 year design and development time and design and development investments of €1bn+. This conventional paradigm inevitably requires factories that produce a singular vehicle type, using moving production and assembly lines that require huge capital investment and require vast factories (1M+ square metres). One further example: the conventional paradigm also requires the use of stamped steel or aluminium panels. Stamping requires huge matched-steel tools (moulds used to press sheet metal into shape); often several pairs are required for a single part in a process known as progressive stamping. Designing these tools can take a year or more; because of their weight and the considerable forces (e.g. 200+ tons) they apply, specially strengthened and costly foundations are needed. It typically costs tens of millions of dollars to set up a production line; it then takes many months to tune the line. To pay back the investment, metal stamping lines are dedicated to a single product for many years.

Once complete, the stamped metal body is welded together to form the familiar ‘body in white’ (BIW). The welding jigs and robots are dedicated to a single product; further increasing time and investment. Next, metal has to be protected from the atmosphere. This requires a large paint setup, starting with an e-coating line, which may be the most significant investment in the paint shop due to the size of the tanks required to fully submerge the BIW. Subsequent paint layers are built up on top to produce the finished vehicle. Automotive factory paint shops are hence very costly, and require environmental permits which can significantly slow down the factory build process and limit the locations in which factories can be built.

This conventional approach therefore locks in a specific vehicle design, including a specific battery pack and vehicle body panel design, for many years, so that vehicle design is able to react only slowly to the new acute environmental and urban transportation challenges we are now facing, and equally slowly to users' increasing demands for transportation environments that are engaging, safe and zero emission. Low volume production runs of vehicles designed to meet emerging, specific customer needs (e.g. a fleet buyer who wants to buy 1,000 buses, or 10,000 delivery vans, customised to their specific requirements) are not possible with the current vehicle design and manufacturing paradigm.

Attempting to re-purpose the existing vehicle design and vehicle manufacturing paradigms to zero emission vehicles has resulted in vehicles that are generally more expensive than their internal combustion engine equivalent, are low margin (and frequently loss making), require huge initial investments and capital expenditure, need very high mass production levels to generate a profit, and yet are often poorly suited to the specific demands of fleet customers and individual users because they are mass-produced products which have not been tailored to meet specific requirements.

Reference may be made to PCT/GB2018/052415, the contents of which are incorporated by reference.

### SUMMARY OF THE INVENTION

This invention is defined in the appended claim. One example implementation is the Arrival® system. The Arrival system includes a vehicle robotic production environment, in which the environment hosts robotic agents that are organised as groups of cells, each cell with no more than 10 robots, and in which:

(i) one group of cells transforms fabric into vehicle composite panels and other parts, eliminating the need for steel panel pressing equipment;
(ii) other cells assemble at least portions of a vehicle together from modular components; and
(iii) each cell is served by AMRs (autonomous mobile robots), eliminating the need for a moving production line in the production environment.

Some optional features include the following:
the production environment is installed in a factory, or a network of factories, that are each less than 25,000 square meters in area.
the production environment is installed in a building with a conventional flat concrete floor that has not been strengthened for a vehicle body panel stamping press.
some of the cells are configured to transform fabric into coloured vehicle composite panels and other parts, removing the need to install a paint shop of the kind needed to paint conventional pressed steel parts.
each cell comprises a group of robots that are programmed to assemble, at a fixed location and not a moving production line, at least part of the vehicle by joining together multiple, modular components, each component designed or selected for robotic production, handling or assembly; and the cells together assemble substantially the entire vehicle.
each cell comprises a group of robots that are programmed to assemble, at a fixed location and not a moving production line, at least part of the vehicle by (a) joining together multiple components to form a structural chassis, and a body structure, and (b) adding composite body panels and composite roof panels to the body structure, and all of the components and the panels are designed or selected for robotic production, handling or assembly.

The Arrival Robotic Production Environment is reconfigurable:
the robotic production environment is configured to assemble at least one of the following vehicle types: small passenger car, large passenger car, small van, large van, specialist vans, truck and lorries of different lengths and capacities, buses of different lengths and capacities and in which multiple cells can be re-purposed to be part of a set of cells that produce any of those types of vehicle.
the robotic production environment is configured to be automatically reconfigurable through software-implemented changes to automatically: make different components, to assemble different types of vehicles, to assemble different configurations of the same type of vehicles, to use different assembly techniques, to use different components, or to transport vehicle parts or structures through the physical environment of the factory using alternate physical routes.
the robotic production environment is automatically reconfigurable through software-implemented changes that alter one or more of: the function of robotic agents, the physical location or arrangement of robotic agents, the number of operative robotic agents; the routes taken by AMRs.

The Arrival Robotic Production Environment has a specific layout:
the vehicle robotic production environment has a layout or arrangement of cells positioned on a standardised rectilinear grid.
the physical layout or arrangement of cells in the robotic production environment has been planned by an automated layout design tool that determines the optimal or preferred layout or arrangement of cells and the robotic services they each perform.
the layout or arrangement of cells in the environment has been designed by an automated simulation tool which takes into account parameters including: production cost; production time; production quality; component availability; use of AMRs to transport components and sub-assemblies.
the robotic production environment is configured to include a model or map of its physical environment that is generated or augmented or refined in real time by AMRs and robots using at least SLAM computer vision techniques.
the robotic production environment includes a master semantic model of its physical environment that enables AMRs and robotic agents to relate at a semantic level to the function or other attributes of objects, both fixed and dynamic they detect.
an automated layout design tool determines the layout or arrangement of cells and the robotic services they each perform using simulation, including simulation using a robotic services control system, and the robotic services control system used in the simulation is also used to control robotic services in the real-world robotic production environment.

This document is organised as follows:
Background Page 1-3
Summary of the Invention Page 3-5
Brief Summary of the FIGS.
Detailed Description
High level overview of the Arrival System Page 14-21
Section A: Hardware Modularity; the unified hardware platform. Page 22-56
Section B: Software modularity; the unified software architecture and ‘plug and play’ methodology. Page 57-89
Section C: The Arrival Cyber Security System. Page 90-103
Section D: The Arrival Technology Platform: creating a new vehicle design using the Vehicle Builder tool. Page 104-125
Section E: Robofacturing: robotic data-driven continuous delivery production. Page 126-162
Section F: The Arrival Microfactory. Page 163-199
Section G: The Arrival battery module and the Flex PCB connector. Page 200-232
Section H: The Arrival Composites System. Page 233-296
Section I: The Arrival Van System. Page 297-348
Section J: The Arrival Bus System. Page 349-440
Section K: The Arrival Car System. Page 441-489
Appendix 1 Section A: Page 490-505
Appendix 1 Section B: Page 506-523
Appendix 1 Section C: Page 524-528
Appendix 1 Section D: Page 529-545
Appendix 1 Section E: Page 546-551
Appendix 1 Section F: Page 552-577
Appendix 1 Section G: Page 578-583
Appendix 1 Section H: Page 584-612
Appendix 1 Section I: Page 613-627
Appendix 1 Section J: Page 628-668
Appendix 1 Section K: Page 669-687
Claims: Page 688-697
Brief Summary of the FIGS.

As noted above, one implementation of the invention is found in the Arrival system. The Detailed Description will describe the Arrival system with reference to the following Sections A-K:
Section A: Hardware Modularity; the unified hardware platform: see FIGS. 1-17.
Section B: Software modularity; the unified software architecture and ‘plug and play’ methodology: see FIGS. 18-39.
Section C: The Arrival Cyber Security System: see FIGS. 40-44.
Section D: The Arrival technology platform: creating a new vehicle design using the vehicle builder tool: see FIGS. 45-47.
Section E: Robofacturing: robotic data-driven continuous delivery production: see FIGS. 48-58.
Section F: The Arrival Microfactory: see FIGS. 59-68.
Section G: The Arrival battery module and the Flex PCB connector: see FIGS. 69-76.
Section H: The Arrival Composites System: see FIGS. 77-85.
Section I: The Arrival Van System: see FIGS. 86-105.
Section J: The Arrival Bus System: see FIGS. 106-175.
Section K: The Arrival Car System: see FIGS. 176-184.

Each Section A-K follows the same format: first, an introduction; then a brief summary of the Figures relevant to that Section, then a list of the key Features relevant to that section, and finally a more detailed consideration of those Features. Appendix 1 consolidates all of these Features and various optional sub-features together.

### BRIEF DESCRIPTION OF THE FIGURES

FIG. 1 shows the Arrival Bus;

FIG. 2 shows the seven 1.5 m long transverse sections that make up most of the Bus;

FIG. 3 shows five of these 1.5 m sections in more detail, exposing the underlying superstructure;

FIG. 4 shows one of these 1.5 m sections in more detail;

FIG. 5 shows the outside of the Arrival Bus, pointing out the various 1.5 m long elements;

FIG. 6 shows the 350 mm×350 mm battery module;

FIG. 7 shows a pack of twelve battery modules being slid into an Arrival Bus;

FIGS. 8-15 show various fasteners optimised for robotic use;

FIGS. 16-17 show Arrival part identification labels;

FIG. 18—a functional model of an exterior lighting feature;

FIG. 19—a structural model of the exterior lighting feature of FIG. 18;

FIG. 20—a modified structural model of a version of the exterior lighting feature;

FIG. 21—another modified structural model of a version of the exterior lighting feature;

FIG. 22—a hardware topology of the exterior lighting feature of FIG. 18 in a vehicle;

FIG. 23—a logical schema of software components that can be applied on the hardware topology of FIG. 22;

FIG. 24—a software allocation scheme of the software components of FIG. 23 on two ECUs;

FIG. 25—a content of meta information of a modular software component;

FIG. 26—a Software Component (SWC) Metamodel;

FIG. 27—a diagram of Ports and Interfaces of the SWC Metamodel;

FIG. 28—a diagram of Sender-Receiver Communication in the SWC Metamodel;

FIG. 29—a diagram of an n:1 communication in the SWC Metamodel;

FIG. 30—a diagram of Client-Server Communication in the SWC Metamodel;

FIG. 31—a diagram of Software Component Connectors in the SWC Metamodel;

FIG. 32—a diagram of Port Groups in the SWC Metamodel;

FIG. 33—a diagram of all types of SWC Ports and Connections with graphical notations;

FIG. 34—a diagram of integration between an ECU-Abstraction Software Component and a Hardware Component;

FIG. 35—a System Software and Hardware Component Metamodel;

FIG. 36—a System Metamodel;

FIG. 37—a diagram of a vehicle design process with Vehicle Builder;

FIG. 38—a diagram of data structures obtained and used in Vehicle Builder;

FIG. 39—a diagram of a hybrid network in a vehicle.

FIG. 40—is a schematic of a connected system including a device, an internal component of the device and a remote server.

FIG. 41—is a diagram of a communication method to establish whether the device is authorized by the server.

FIG. 42—is a diagram of a communication method to establish whether the device is authorized to use the component.

FIG. 43—is a diagram of a full authentication method with the device, the component, and the server.

FIG. 44—is a diagram of a Secure Touch Points (STP) network topology.

FIG. 45—is a schematical vehicle model layout with E/E components pins' locations.

FIG. 46—is the schematical vehicle model layout from FIG. 45 with an E/E topology including ECUs and its connections to all pins of the E/E components.

FIG. 47—is a weighted bipartite graph of a wiring optimization problem.

FIG. 48—is a diagram of an APL program structure with alternative child abilities;

FIG. 49—is a diagram of an APL program structure with a child operation being a parent;

FIG. 50—is a diagram of a layered structure of rService;

FIG. 51—is a diagram of a part of rService “Consolidate” structure;

FIG. 52—is a scheme of interaction of rServiceHub and Operations Control System (OSC);

FIG. 53—is a 3D view of an rService layout;

FIG. 54—is a 3D view of a workcell layout;

FIG. 55—is a scheme of allocation of rServices into basic workcells;

FIG. 56—is a view of a 2D simulation of a microfactory layout;

FIG. 57—is a view of a 3D simulation of a microfactory environment and operations;

FIG. 58—is a scheme of main types of interactions provided through Blackboard OCS;

FIG. 59 shows a robotic cell in a microfactory; the cell is a composite panel trimming cell;

FIG. 60 shows a schematic view of the part of a microfactory producing composite parts;

FIG. 61 shows a schematic view of a six robot cell used for assembling a vehicle;

FIGS. 62-67 show a build sequence in the six robot cell;

FIG. 68 shows a schematic view of an eight cell production environment;

FIG. 69 is a perspective view of a single battery module, the Arrival HVBM;

FIG. 70 is a schematic view of a pack of twelve HVBM battery modules being slid into the side of an Arrival Bus chassis or skateboard platform;

FIG. 71 is a perspective view of five HVBM battery modules connected together with Flex PCB connectors;

FIG. 72 is an exploded view of the HVBM battery module showing the multi-later structure optimised for robotic production;

FIG. 73 is a top down view of the end of a Flex PCB connector that connects to a HVBM battery module;

FIG. 74 is a perspective view an HVBM battery module with Flex PCB connector;

FIG. 75 is a top down view of a group of five HVBM battery modules connected together with Flex PCB connectors;

FIG. 76, adjacent to FIG. 75, shows a perspective view of those modules with Flex PCB connectors;

FIG. 77 and FIG. 78 shows schematics of a kitting cell;

FIG. 79 shows a moulding cell;

FIG. 80 shows a trimming cell;

FIG. 81 shows an assembly cell;

FIG. 82 is a layout for the Arrival composites part production section of a microfactory;

FIG. 83 is a schematic perspective view of the composites microfactory;

FIG. 84 is a layout view of the FIG. 83 microfactory;

FIG. 85 shows a robotic tool for automatically shaping a material kit to conform to a mould;

FIG. 86 shows a perspective view of the Arrival Van;

FIG. 87 shows a cross-sectional view through the entire Van;

FIG. 88 shows a cross-sectional view through the front of the Van, showing the heights off the ground from the internal flat floor and the single step;

FIG. 89 shows the structural chassis;

FIG. 90 shows the structural chassis, with battery modules and other components;

FIG. 91 shows a cross-sectional view through the front of the Van, including the footrest height above the internal flat floor;

FIG. 92 shows the internal flat floor and footrest in the driver cabin;

FIG. 93 shows a view into the open, rear of the van;

FIG. 94 shows the large field of view for the driver;

FIG. 95 shows the position of the driver in relation to the front of the van;

FIG. 96 shows the dashboard and display screen in the driver's cabin;

FIG. 97 and FIG. 98 shows the touch sensor;

FIG. 99 shows the touchpads on the steering wheel;

FIG. 100 shows the structural hoops that make up the superstructure, mounted on the chassis or platform;

FIG. 101 shows the van with its composite panels;

FIG. 102 shows a cross-sectional view through the front of the Van, including the front bulkhead;

FIG. 103 shows the cantilevered shelf supports in the van cargo area;

FIG. 104 shows the hinged service hatch;

FIG. 105 shows the integrated drop-down window;

FIGS. 106-108 are perspective, side and front views of the 12 m Arrival Bus;

FIG. 109 is an internal view;

FIG. 110 is a cut-away showing the main structural elements;

FIG. 111 shows the rear wheels and related structural wheel arches;

FIGS. 112-113 are exploded and non-exploded views of the main structural elements in a single transverse chassis section;

FIG. 114-FIG. 116 shows a build sequence in which several transverse chassis sections are joined together;

FIGS. 117-118 shows the battery pack insertion sequence;

FIGS. 119-120 is a cut-away, showing the single level flat floor running through the bus;

FIGS. 121-124 show the structural cast aluminium wheel arches and related components;

FIG. 125 shows the structural chassis transverse and longitudinal beams;

FIG. 126 shows the transverse chassis section including glass roof lights openings;

FIG. 127 shows the main structure of the Bus, with single, low flat floor and roof lights;

FIGS. 128A-128B show the single, low flat floor and cantilever mounted seating;

FIGS. 129A-129D-FIG. 132 show display screen content;

FIGS. 133-135 show driver display screen content;

FIGS. 136-138 show display screen content;

FIG. 139 shows mobile phone app content;

FIGS. 140-142 show the ‘stop request’ sensor and related mobile phone app content;

FIG. 143 shows the external full length display panels;

FIG. 144 starts the sequence of figures showing the robotic build sequence; this shows all of the transverse chassis sections that need to be assembled and brought together to form the Bus;

FIGS. 145-146 summarise the complete build sequence for a single transverse chassis section;

FIG. 147 shows the main parts of a transverse chassis section;

FIG. 148 shows how some of the roof parts join together;

FIG. 149 starts the complete build sequence, starting with the central beam;

FIGS. 150-156 continue the build sequence for the base of a transverse chassis section;

FIGS. 157-162 show the side and roof build sequence and the install on to the base;

FIG. 163 shows a wheel arch base section;

FIGS. 164-171 shows assembling together multiple transverse chassis sections;

FIGS. 172-173 shows installing battery modules into the chassis;

FIG. 174 shows an exploded view of all of the transverse chassis sections in a bus;

FIG. 175 shows the transverse chassis sections in three different lengths of Bus;

FIGS. 176A-176G provide images of vehicles designed in accordance with the Arrival System, with FIGS. 176A-176D showing perspective views of a number of variants; and

FIGS. 176E-176G showing views of a schematic;

FIGS. 177A-177D provide views of a skateboard platform, with FIG. 177A showing a perspective view; FIG. 177B showing an exploded view; FIG. 177C showing a top view; and FIG. 177D showing a front view;

FIG. 178 provides a schematic of the electronics architecture of the skateboard platform;

FIGS. 179A-179E provides views demonstrating a battery pack of a skateboard platform, with FIG. 179A showing an exploded view of the battery pack which includes a number of battery modules and a cooling circuit; FIG. 179B showing a cross-section view intersecting between the battery modules of the battery pack; FIG. 179C showing a cross-section view intersecting through the battery modules of the battery pack; FIG. 179D showing a cross-section view from the side, along the length of the battery pack; and FIG. 179E showing a cross-section view from above to provide details of the cooling circuit of the battery pack;

FIGS. 180A-180G provide details of a production process of a battery pack, with FIG. 180A showing a flow chart that details method steps of the production process; FIG. 180B showing a first step of assembling the cooling circuit; FIG. 180C showing a second step of assembling the cooling assembly which includes the cooling circuit; FIG. 180D showing a third step of assembling a first row of battery modules as part of the battery pack; FIG. 180E showing a fourth step of assembling a flexible printed circuit board to provide an electronic connection to the battery modules; FIG. 180F showing a fifth step of assembling a battery cover of the battery pack; and FIG. 180G showing a sixth step of assembling a second row of battery modules as part of the battery pack;

FIGS. 181A-181G provide details of a production process of a cradle of the skateboard platform, with FIG. 181A showing an exploded view of the cradle; FIG. 181B showing a flow chart that details method steps of the production process; FIG. 181C showing a first step of assembling inner extrusions; FIG. 181D showing a second step of assembling cradle extrusions that include the inner extrusions; FIG. 181E showing a third step of assembling the cradle extrusions with a cross plate and pod mounts; FIG. 181F showing a fourth step of assembling a cross plate as part of the cradle; and FIG. 181G showing a fifth step of assembling the cradle to include wishbones, together with a sixth step of assembling the cradle to include torsion bars;

FIGS. 182A-182B provide views of a centre module of the skateboard platform; with FIG. 182A showing a perspective view with part cut away to reveal the internal components including the battery pack; and FIG. 182B showing a cross section revealing further details of these internal components;

FIGS. 183A-183F provide details of the electronics architecture of the vehicle, with FIG. 183A showing a front perspective view of a super junction box of the skateboard platform;

FIG. 183B showing a rear perspective view of the super junction box; FIG. 183C showing a perspective view of the skateboard platform installed with the super junction box; FIG. 183D showing a cross section from the side of the skateboard platform that is installed with the super junction box; FIG. 183E showing a perspective view of a cassette which is installed into a top hat of the vehicle; and FIG. 183F showing an exploded view of a vehicle including the cassette; and

FIGS. 184A-184H provide details of a production process for mounting the top hat to the skateboard platform, with FIG. 184A provides a perspective view of the cradle including the wishbones and pod mount; FIG. 184B showing a flow chart that details method steps of the production process; FIG. 184C illustrating a first step of positioning the top hat above the pod mount; FIG. 184D illustrating a second step of lowering the top hat onto the pod mount;

FIG. 184E illustrating a third step of locking the top hat into place; FIG. 184F showing a locking mechanism in an unlocked position; FIG. 184G showing a locking mechanism in an locked position; and FIG. 184H provides a view from below of the skateboard platform with the locking mechanism in the locked position.

### DETAILED DESCRIPTION

High Level Overview of the Arrival System

The Arrival system is a system for designing and producing a range of different vehicles, such as cars, shuttles, trucks, vans and buses, using a shared platform and shared components that are modular in both hardware and software terms. The Arrival system also enables autonomous robotic production, including robotic production of complete vehicles, as well as components for those vehicles.

This specification describes a number of Features; we organise these Features into the following Sections A-H.
Section A: Hardware Modularity; the unified hardware platform.
Section B: Software modularity; the unified software architecture and ‘plug and play’ methodology.
Section C: The Arrival Cyber Security System.
Section D: Arrival Technology Platform: creating a new vehicle design using the Vehicle Builder tool.
Section E: Robofacturing: robotic data-driven continuous delivery production.
Section F: The Arrival Microfactory
Section G: The Arrival battery module and the Flex PCB connector.
Section H: The Arrival Composites System.
Section I: The Arrival Van System.
Section J: The Arrival Bus System.
Section K: The Arrival Car System.

Section A: Hardware modularity is one of the key enabling technologies in the Arrival system since it enables re-use of the same type of modular component in multiple places in any given Arrival Vehicle; this sort of component re-use is key to reducing the cost of components and simplifying robotic assembly. One example: Arrival vehicles are assembled from aluminium extrusions of a set length; these extrusions can be used in different parts of the vehicle chassis.

Section B focusses on software modularity (including ‘Plug and Play’ and decentralised autonomy in a distributed architecture). Software modularity enables, for example, a modular software component to be deployed to an ECU (electronic control units) and to run on that ECU. An example: the software component could relate to an optional feature, like lane departure warning; by modularising the software that enables this function, it can be added only when needed to the appropriate vehicle systems. Modularity of ECU (electronic control unit) embedded software enables the tailoring of software according to the individual requirements of different ECUs and their tasks in the automotive architecture.

Section C: Arrival vehicles use a particular security architecture that is more robust and secure than a conventional architecture; it is particularly relevant where a vehicle implements a modular, plug and play approach.

Section D: All of these preceding strands are brought together in the Vehicle Builder design tool; the Vehicle Builder design tool includes a data repository defining all components available in the Unified Software Architecture and the Unified Hardware Platform and is able to automatically design a complete vehicle, including ECU software configuration, by assembling together those components that meet a specific customer requirement.

Section E describes Robofacturing—the set of techniques that enable efficient, scalable robotic production.

Section F describes a microfactory, is a relatively small and low capital expenditure (CapEx) factory that is not based on conventional long moving production lines, but is instead a robotic production environment including small cells of autonomous or semi-autonomous robots, with each cell assembling together various sub-assemblies (e.g. adding composite panels to a body frame) and also assembling together various elements (e.g. chassis, drivetrain, wheels, HVBMs, body) to form a complete, individual vehicle. In the Arrival system, just a small number of different types of cells are able to produce an entire vehicle; different cells of the same type can be used in different sequences; cells can be rapidly re-purposed from one specific task to another. This approach gives a degree of flexibility and scalability that is impossible with a conventional moving production line system. The microfactory receives data defining a vehicle to be assembled from the Vehicle Builder tool (see Section D) and can then automatically complete, using Robofacturing processes (see Section E) all steps needed to assemble that vehicle. Because the Unified Software Architecture and the Unified Hardware Platform has been designed to ensure that all compliant software and hardware will work together reliably, the key elements of the vehicle should work with each other as predicted, once all hardware and software components are properly installed in a vehicle and communicating with each other.

Section G describes the modular battery system and the flexible PCB high voltage conductor developed by Arrival and used in several Arrival vehicles.

In Section H, we describe the Arrival composite panel system: this system enables high performance lightweight automotive composite panels to be made rapidly and cheaply, doing away with the need for costly metal stamping presses and conventional painting setups. We describe how the composite automotive body panels (and other parts) are made, and how the composite panel production system forms an integrated part of the entire Arrival system.

Section I describes the Arrival Van system; the Arrival Van is optimised for improved driver ergonomics.

Section J describes the Arrival Bus system; the Arrival Bus a low-floor bus optimised for improved driver and passenger experience. Section J describes how the structure of an Arrival bus is assembled at a microfactory.

Section K describes the Arrival Car system; the Arrival Car is a flexible skateboard-based system that supports multiple different car types.

And we can move through this sequence: taking the Arrival Van (described in Section I) as our context: The Arrival van can incorporate or otherwise implement the hardware modularity described in Section A; can incorporate, or otherwise implement the Unified Software Architecture, Plug and Play and decentralised autonomy described in Section B; can incorporate or otherwise use the security architecture described in Section C; can be configured using the Vehicle Builder tool described in Section D; can be built using the Robofacturing robotic production processes described in Section E; can be produced in a microfactory as described in Section F; can incorporate the battery module and Flex PCB connector described in Section G; can include composite panels and parts as described in Section H.

The Arrival system can be thought of as part of ‘machine that can build machines’; the effective and practical realisation of a true ‘machine that can build machines’ requires this complex, inter-dependent combination of multiple Features. The full realisation of the goal of fast, responsive, low-cost, low CapEx vehicle design and build can be thought of as an emergent property of this complex system; as with any complex system, each element in this system contributes synergistically to the whole.

The Arrival system leverages a number of technology macro-trends. First, Arrival leverages the rapid advances in robotic AI in designing and deploying a distributed, scalable flexible AI and robotic-based production system (‘Robofacturing’, deployed in ‘microfactories’) that enables the rapid design and cost effective production of devices, of which zero emission vehicles are just one example. If we look specifically at zero emission vehicles, then the Arrival system disrupts the current vehicle design and manufacturing paradigm (that requires a 3-5 year design and development time and design and development investments of €1bn+). Instead, the Arrival system, as a flexible vehicle development platform, enables a broad range of zero emission vehicles to be purpose-built for specific market needs or customer requirements even at relatively low volumes (e.g. 1,000 buses a year from a microfactory), at purchase price parity with conventionally manufactured internal combustion engine vehicles, all in small footprint, relatively low CapEx microfactories.

The microfactory approach is significantly cheaper in CapEx than moving production line factories, meaning that much lower annual production volumes can still be profitable, in turn enabling fleet customer specific designs. But microfactories can be readily scaled up by adding additional robotic production cells or scaled down if needed, or switched to different vehicle designs. Microfactories are described in more detail in Section F, but in brief, a microfactory includes multiple robotic production cells, that each include one or more robots (which may be autonomous or semi-autonomous) and can specialise or be optimised for one specific function or type of function, or be general purpose. Cells are not connected by a moving production line, but instead automated guided vehicles move the chassis or other vehicle components being assembled from cell to cell until the vehicle is fully assembled. AMRs provide cells with the components. A conventional production line is costly, slow and expensive to plan and build, and inflexible once set-up: Arrival's robotic production cells are far more flexible—for example, the production process can be rapidly re-configured to use cells in a different sequence (e.g. if components are running low in one cell, or if one cell needs maintenance, then the flow can be re-configured to compensate for that virtually instantaneously; further, the same cell can be re-used several times for different assembly operations for the same vehicle. If the microfactory needs to switch to building a different type or design of vehicle (instead of or in addition to the vehicle currently being built), then that can be achieved rapidly by in essence re-programming the operations performed by each cell and the components provided to each cell. The microfactory can be situated in a conventional 100,000 square foot warehouse; it needs no specialist paint shop because the vehicles it assembles use composite panels that are coloured as an integral part of the panel production process, or that use coloured vinyl or plastic coatings; eliminating a specialist paint shop not only saves space, but also the need for environmental controls and permits. The use of composite panels means that the microfactory has no need for a sheet-metal stamping plant with special foundations. It is therefore much simpler to plan and construct—typically taking 6 months to commission, compared to 3 years for a conventional plant, and takes 1/10th the CapEx.

Because a microfactory is much smaller (e.g. 10,000-25,000 square metres) than a conventional vehicle factory (1M+ square metres), it can be built in areas of demand, anywhere in the world, establishing a local presence quickly, with shorter supply chains, enhanced local employment, enhanced local tax base, and no requirement for ocean container shipping, further reducing the carbon footprint. Microfactory production using small cells of robots requires radical re-thinking of how a vehicle should be designed: this design for robotic production is at the heart of the Arrival system. Conventional robotic vehicle manufacture requires very substantial investment in arrays of robots along a moving production line, each robot performing a set number of highly repetitive, pre-programmed tasks; this well-established approach amounts to automating processes otherwise undertaken by skilled human assembly line workers. The Arrival system does not merely automate repetitive, pre-programmed tasks using robots, but instead creates an autonomous robotic production environment (or ‘robotic microfactory’) that operates with no pre-defined Takt Time and is able to determine by itself, dynamically, what steps and when to perform by what robots (or ‘robotic agents’) or non-robotic agents, how the robotic agents are to interact with each other and external agents, how to rapidly arbitrate potential conflicts between the agents (e.g. conflicts in the paths traced by end effectors of robotic arms in a robotic cell or in the paths of mobile robots that could lead to collisions etc.) and how to optimally assemble components and indeed entire vehicles. The Arrival system also learns, using machine learning/AI processes, so that the autonomous operations improve, e.g. in speed and accuracy, over time. The evolution of robotic automation to robotic autonomy will be one of the defining attributes of the emerging new wave of industrial innovation. Whilst this specification focusses on the robotic production of vehicles and parts for vehicles, the principles of the Arrival system apply equally to any item which is capable of being produced robotically; the term ‘vehicle’ can hence, in the extreme limit’ be construed to cover any robotically produced item; it could, for example, cover buildings and parts of buildings that are robotically constructed.

Before we progress to each of these Sections A-K, we give some preliminary comments on modularity. The concept of modularity is a philosophy right at the heart of Arrival. It influences everything from the way Arrival designs components and assemble vehicles, to the way it structures its business activities. Modularity is typically discussed in terms of modules (hardware, software, teams . . . ) that can be altered or replaced without affecting the remainder of the system (vehicle, product, company . . . ).

Arrival modules are constructed with standardised units (dimensions, interfaces) for flexibility and variety in use. A standardised interface enables modules to connect, interact, or exchange resources (such as energy or data). By defining standard units and interfaces, modules can work with little or no knowledge of the definitions of other separate components. Such modules are less constrained and more versatile. A system comprising of loosely coupled modules is more robust to change, to flawed designs and to failure; it is hence unlike a tightly integrated system where each component is designed to work specifically (and often exclusively) with other particular components.

Modularity enables Arrival to build scalable robust products and systems which cope with errors and failures, and take advantage of unknown future opportunities. Each module comprises distinct function(s) (purpose) and modules can be combined to provide new collective functions. Modules can require capabilities that other modules satisfy. Modularity enables parallelism; a method of producing/designing/working in which the process is separated into parts that can be done in a different order or in different places or with different strategies. Modularity speeds up the design process and makes it more reliable. A module can be applied to different scenarios; modularity enables facilitates reuse in new contexts. Modularity leads to flexibility since different components can be readily mixed and matched in a variety of configurations. Modules hide the details of their implementation, but publicly define their capabilities and interfaces. Modularity leads to simplicity: Breaking a system into varying degrees of interdependence and independence serves to reduce complexity of the system. Modularity enables components to be replaced with alternative implementations that provide the same services. Modularity accommodates uncertainty because the particular elements of a modular design may be changed after the fact and in unforeseen ways as long as the design rules are obeyed. Modularity reduces risk, since modules can be tested and run in isolation.

Decentralised autonomy in a distributed architecture is a key, complimentary approach used in the Arrival system. Simple rules (simple devices, interfaces and agents) can result in complex and robust systems. The concept of distributed devices enable reliable, safe and predictable fault-tolerant behaviour, even in the face of a dynamic system with frequent component changes and incomplete information (high uncertainty). Arrival needs an approach which copes gracefully with errors and new information and facilitates rapid development, iteration and continuous improvement. Decentralised autonomy is the mechanism by which Arrival reduces the time required to develop and validate new hardware devices, software functions and products, whilst achieving consistent and reliable performance and a high degree of safety.

The Arrival distributed architecture system:

The system is comprised of distributed autonomous devices largely without central coordination/management.
System may comprise different (and dynamic) kinds of devices and network links.
System and functions are agnostic to hardware, software or communication protocols (independence).
Self-contained, trustless devices communicate with each other over a secure network by message passing.
Devices are responsible for their own safety, meaning that a fault or erroneous command is less likely to cause serious problems.
It is not necessary to know in advance the overall or ‘final’ structure (number and type of devices, topology).
The system copes with change and uncertainty in design and function. Devices can be modified, added and removed without affecting other modules: simplifying design, configuration, testing, validation and certification.
The architecture facilitates new, iterated and improved and disruptive hardware devices/software/function/architecture/control in future.
The system is reliable and robust; failures/errors are contained and single point of failure avoided (fault tolerance). System is tolerant of individual failures (of devices or messages). Fault containment and reduced contamination. Negates bad actors. Isolation.
The system is highly scalable, functioning efficiently even as the system grows with new devices (automatically).
Increased performance with reduced overhead (shared computing resource).
Secure (against malicious of faulty participants). Valuable/safety-critical messages (or data). are protected. Few vulnerabilities. Each device has a limited and incomplete view (and control) of the system.
The architecture supports granular/zonal control allowing continuous operation even if some devices are sleeping/offline/faulty.

Requirements

Each device is uniquely identifiable
Network is scalable and secure
Devices are responsible for their own safety
Our methods of design and produce must enable this approach

From this high level introduction to the Arrival modularity and distributed architecture approach, we now move on to the detail.

Section A: Hardware Modularity; the Unified Hardware Platform

Introduction to this Section A

The core objective of the Arrival system is to move beyond the existing vehicle design and production paradigm. As we have seen, the conventional paradigm is exemplified by the traditional pressed steel monocoque that is incrementally transformed into a finished vehicle as it progresses along a moving production line in a 2M+ square meter factory that has cost $2Bn+ to build and locks the factory into building essentially the same vehicle over many years to recoup the huge investment in plant and tooling. Conventional vehicle design is able to react only slowly to the acute environmental and urban transportation challenges we are now facing, and equally slowly to users' increasing demands for transportation environments that are engaging, safe and zero emission. Low volume production runs of vehicles designed to meet emerging, specific customer needs (e.g. a fleet buyer who wants to buy 1,000 buses, or 10,000 delivery vans, customised to their specific requirements) are not possible with the current vehicle design and production paradigm.

The Arrival system is designed to address these challenges: it proposes a holistic and fundamental re-appraisal of how to design and produce vehicles. Arrival vehicles are designed to meet some specific and challenging goals: (a) to be made from modular hardware components that are optimised for robotic production, handling and assembly; (b) to be rapidly designed and configured using the same automated vehicle design tools (see the Vehicle Builder Tool in Section D); (c) to be built using the same robotic production techniques irrespective of vehicle type (e.g. whether a car, van or bus) (see Section E); (d) and to be built in the same robotic production environment which is capable of producing any type of vehicle without costly re-tooling or re-designing the robotic production environment (see Section F).

Hardware modularity or standardisation is a core enabling technology to achieving these goals. Whilst a degree of hardware modularity has been established in vehicle mass production since the Model T Ford, (and in other areas too, like Le Corbusier's Modulor) the Arrival system extends the notion of hardware modularity to include a number of specific features that enable these goals to be achieved.

This Section A looks principally at the modular or standardised hardware components. We will see later in this document (Section J) how the Arrival Bus is made from a series of 1.5 m long chassis sections that are assembled together; a 12M bus would have seven of these 1.5 m long chassis sections, plus front and rear sections. What that means is that every one of these seven chassis sections has structural components that make up the skateboard platform that are each identical and 1.5 m long; the superstructure that sits on the skateboard platform will again have a number of identical 1.5 m long beams or struts. Each of these is robotically handled, assembled and joined in the same manner, and each is optimised for robotic handling (e.g. widespread use of lightweight extruded aluminium struts with simple male and female mating parts that can be robotically pushed together; adhesive is then robotically injected into the joint to permanently attach the components together; there is no welding required).

This degree of hardware modularity, optimised for robotic handling, is key to delivering the kinds of scale economies that are usually obtained by having a pressed steel monocoque chassis. By standardising on this 1.5 m length, it means that every one of the full colour, high resolution display panels that run along the sides of the Arrival bus are also the same length (just under 1.5 m); there can be eighteen of these in each bus, so having a single model of display panel simplifies logistics, and also simplifies robotic handling and installation since the same handling an installation process is repeated eighteen times for a bus. And by standardising on this 1.5 m length, every composite body panel for these sections is also approximately that size too, again simplifying composite panel production, logistics, and robotic handling and installation, since the same handling an installation process is repeated for each panel; Arrival Bus could have 24 or more side panels of the identical size, so it is very valuable to have scale economies associated with this degree of modular or standardised composite panel size.

So modular or standardised hardware components can include structural items and physical fasteners, such as: (a) aluminium extrusions, from which parts of a vehicle body structure and parts of the vehicle chassis (or skateboard platform) are formed; (b) cast aluminium structural wheel arches with mounting points for the suspension and integrated drive units (which can include an inverter, motor and gearbox), eliminating the need to mount these components into a separate chassis; (c) composite panels; and (d) the physical fasteners and fittings used to attach components together.

We will see later in this document (Section G) how Arrival vehicles can use a number of modular high voltage battery modules, called the HVBM. These are each 350 mm square and 100 mm tall, with flat surfaces easily gripped by a robot, and can be assembled together into arrays of adjacent modules; because each HVBM delivers approximately 400V, they can be parallel connected in any arbitrary number; that means battery packs with different capacities and ranges can be readily produced by using different numbers of HVBMs and because of the standardised sizing of the modules, it becomes much easier to design a way of robotically mounting or positioning these HVBMs in a vehicle chassis or skateboard platform that is common across different Arrival vehicles—e.g. is the same across Arrival cars, vans and buses.

So modular or standardised hardware components can include electronic modules, such as any of the following: high voltage battery module; battery pack; master BMS; low voltage battery; onboard charger; charging controller; DC-DC converter; integrated drive unit; motor; gearbox; traction inverter; drive control unit; communications module; ECU; ethernet switch; HMI platform; video surveillance system; vehicle sound engine platform; unified computing platform; sensors; weight sensors; computer vision sensors; LIDAR sensors; radar-based sensors.

We list here how Arrival components are modular or standardised:
the vehicle component is modular or standardised by virtue of having a size that conforms to regular size intervals and is part of a family of other types of components, all with sizing that also conforms to the same size intervals. Standardised sizing intervals: (a) makes organising component layout and vehicle design in a software tool faster since the tool has fewer permutations to calculate and (b) it enables more efficient use of space within the Arrival vehicle since modules can be packed more tightly and neatly and (c) it facilitates computer vision recognition of the location and pose of a component, as well as robotic handling and installation of the component.
the vehicle component is modular or standardised by virtue of being part of a family of other types of components, all being configured to be positioned or installed in the vehicle in a regular, rectilinear grid or installation pattern. This also: (a) makes organising component layout and vehicle design in a software tool faster since the tool has fewer permutations to calculate and (b) it enables more efficient use of space within the Arrival vehicle since modules can be packed more tightly and neatly and (c) it facilitates computer vision recognition of the location and pose of a component, as well as robotic handling and installation of the component.
the vehicle component is modular or standardised by virtue of being part of a family of other types of components, all having an external feature or features (e.g. flat surfaces; absence of rounded, hard to grip surfaces; perpendicular edges) that are optimised for robotic handling, installation or assembly, such as autonomous robotic handling, installation or assembly. This facilitates computer vision recognition of the location and pose of a component, as well as robotic handling and installation of the component.
the vehicle component is modular or standardised by virtue of being part of a family of other types of components, all having the same overall type of shape (e.g. a box type shape), the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors. This also: (a) makes organising component layout and vehicle design in a software tool faster since the tool has fewer permutations to calculate and (b) it enables more efficient use of space within the Arrival vehicle since modules can be packed more tightly and neatly and (c) it facilitates computer vision recognition of the location and pose of a component, as well as robotic handling and installation of the component.
the vehicle component is modular or standardised by virtue of being part of a family of other types of components, all designed for an installation path to a final position, in which the installation path is optimised for robotic handling, installation or assembly, such as autonomous robotic handling, installation or assembly. This in turn can require careful design of the centre of mass and the robotic gripping points used to grip the component, so that the component can be reliably held by the robot as it is moved through space.
the vehicle component is modular or standardised by virtue of being part of a family of other types of components, that each use the same, standardised physical installation systems, that are each optimised for robotic handling and use. This reduces costs and the complexity of inventory management, and reduces the range of different tools or end-effectors needed, speeding up assembly.
the vehicle component is modular or standardised by virtue of being part of a family of other types of components, that each use the same, standardised identification system that gives each individual component a unique identification that is (i) computer readable but not meaningful to a human; and (ii) enables each individual component to be tracked from initial production to initial installation, and subsequent servicing and end-of-life. Eliminating human-readable text gives greater control, since the unique identification can point to a server-side entry and access to that can be controlled.
the vehicle component is modular or standardised by virtue of being part of a family of other types of components, that each use the same, standardised data and/or power interface. This facilitates automated planning of the electrical/data layout and also facilitates robotic installation of modules and the data cabling that connects them.
the vehicle component is modular or standardised by virtue of being part of a family of other types of components, that each use the same, standardised security system. This facilitates automated planning of the data layout and also facilitates robotic installation.
the vehicle component is modular or standardised by virtue of being part of a family of other types of components, all optimised for robotic computer vision systems and optimised for radiant heat dissipation, by virtue of being substantially black in colour. Making modules a consistent colour (such as black) generates a more consistent edge appearance, which helps computer vision system recognise edges, and hence identify the module and determine its location and pose.

We can generalise to the following nine features:

Feature 1: Modular Hardware Component Sizing

A vehicle component that is modular or standardised by virtue of having a size that conforms to regular size intervals and is part of a family of other types of components, all with sizing that also conforms to the same size intervals.

Feature 2: Modular Hardware Components Installed Using the Same Regular, Rectilinear Grid or Installation Pattern

A vehicle component that is modular or standardised by virtue of being part of a family of other types of components, all being configured to be positioned or installed in the vehicle in a regular, rectilinear grid or installation pattern.

Feature 3: Modular Hardware Components Configured for Robotic Assembly

A vehicle component that is modular or standardised by virtue of being part of a family of other types of components, all having external feature or features that are optimised for robotic handling, installation or assembly, such as autonomous robotic handling, installation or assembly.

Feature 4: Modular Hardware Components that are Box Shaped

A vehicle component that is modular or standardised by virtue of being part of a family of other types of components, all having the same overall type of shape (such as box shaped), the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors.

Feature 5: Modular Hardware Components with Install Path Optimised for Robotic Installation

A vehicle component that is modular or standardised by virtue of being part of a family of other types of components, all designed for an installation path to a position, in which the installation path is optimised for robotic handling, installation or assembly, such as autonomous robotic handling, installation or assembly.

Feature 6: Modular Hardware Components with Standardised Fasteners

A vehicle component that is modular or standardised by virtue of being part of a family of other types of components, that each use the same, standardised physical installation systems, such as self-aligning fasteners, that are each optimised for robotic handling and use.

Feature 7: Modular Hardware Components with Standardised Self-Aligning Electrical Interfaces

A vehicle component that is modular or standardised by virtue of being part of a family of other types of components, that each use the same, standardised self-aligning electrical interfaces, that are each optimised for robotic handling and use.

Feature 8: Modular Hardware Components that Use the Same Unique ID System

A vehicle component that is modular or standardised by virtue of being part of a family of other types of components, that each use the same, standardised identification system that gives each individual component a unique identification that is (i) computer readable but not meaningful to a human; and (ii) enables each individual component to be tracked from initial production to initial installation, and subsequent servicing and end-of-life.

Feature 9: Modular Hardware Components that are Black

A vehicle component that is modular or standardised by virtue of being part of a family of other types of components, all optimised for robotic computer vision systems and optimised for radiant heat dissipation, by virtue of being substantially black in colour.

### BRIEF SUMMARY OF THE FIGURES RELATING TO THIS SECTION A

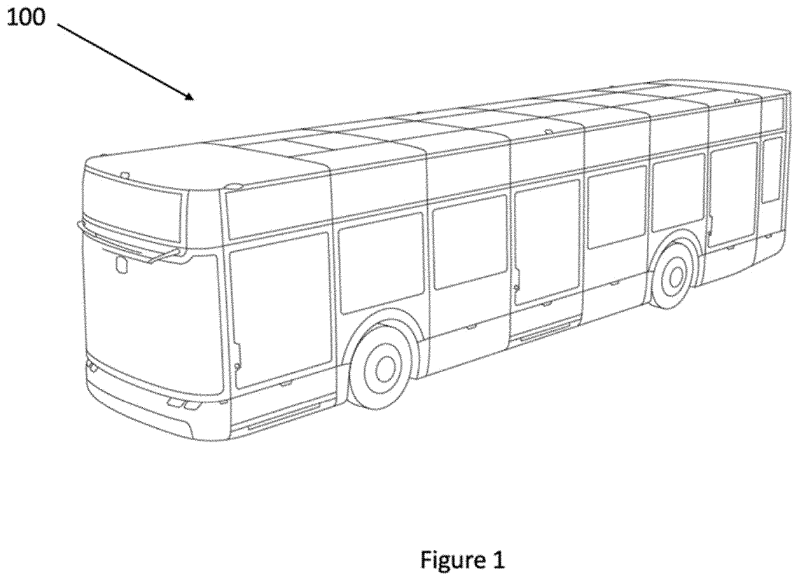

FIG. 1 shows the Arrival Bus.

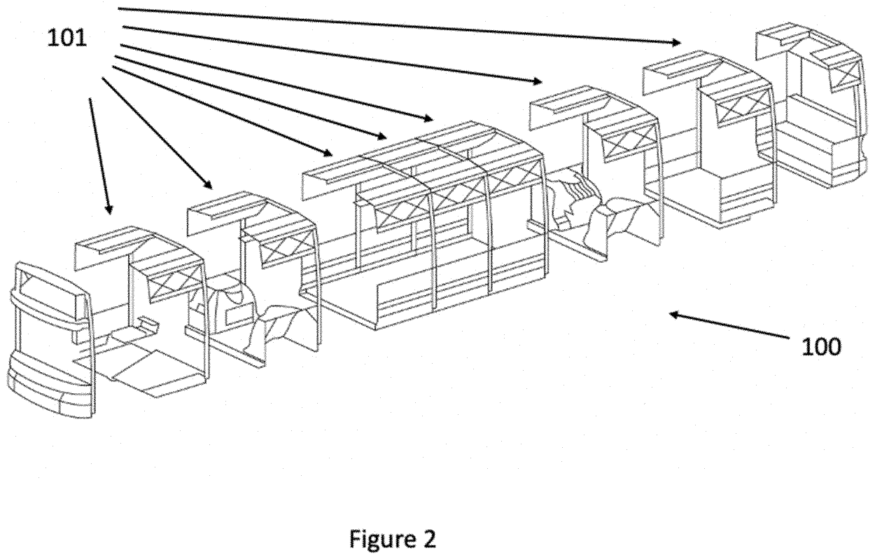

FIG. 2 shows the seven 1.5 m long transverse sections that make up most of the Bus.

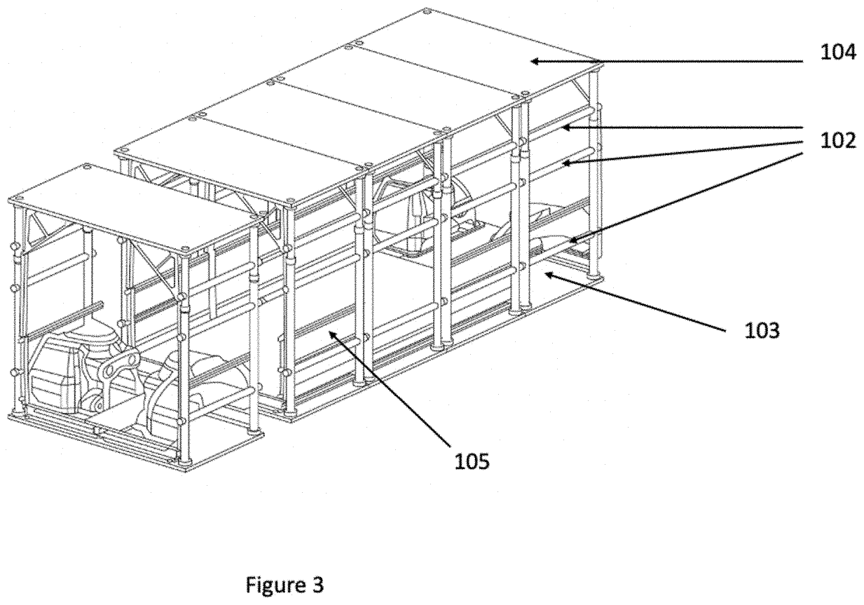

FIG. 3 shows five of these 1.5 m sections in more detail, exposing the underlying superstructure.

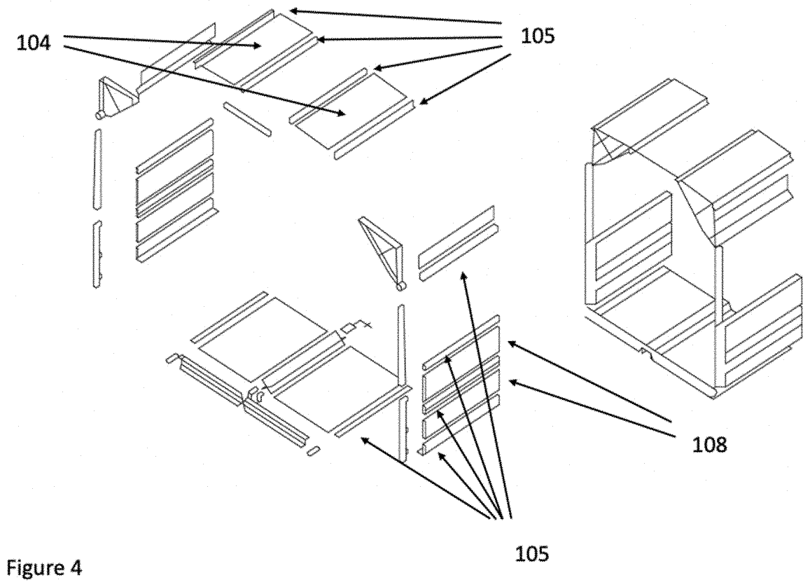

FIG. 4 shows one of these 1.5 m sections in more detail.

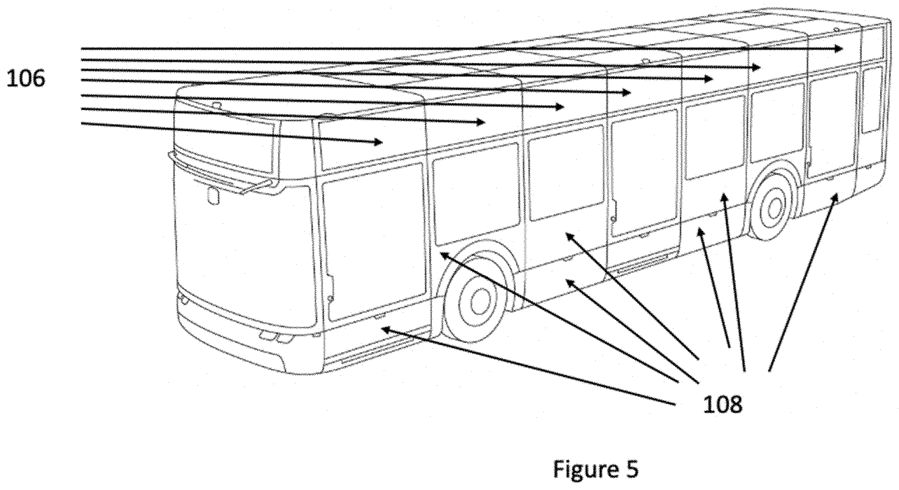

FIG. 5 shows the outside of the Arrival Bus, pointing out the various 1.5 m long elements.

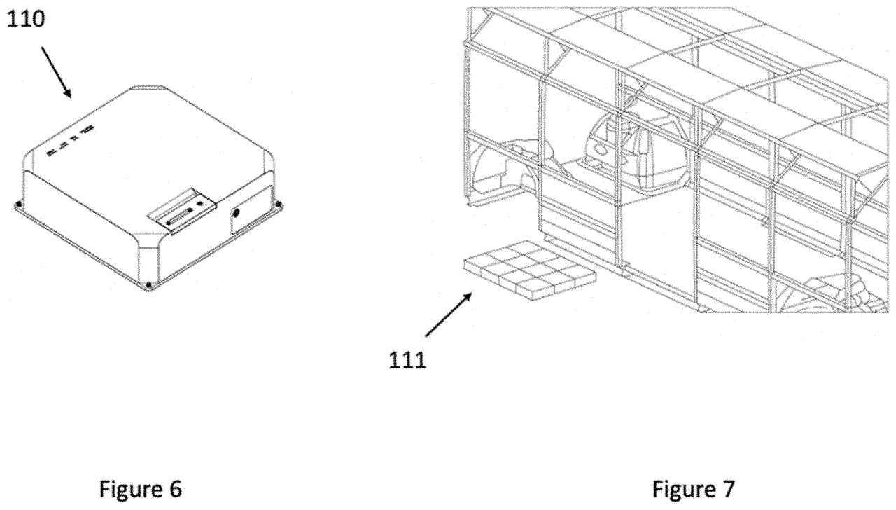

FIG. 6 shows the 350 mm×350 mm battery module.

FIG. 7 shows a pack of twelve battery modules being slid into an Arrival Bus.

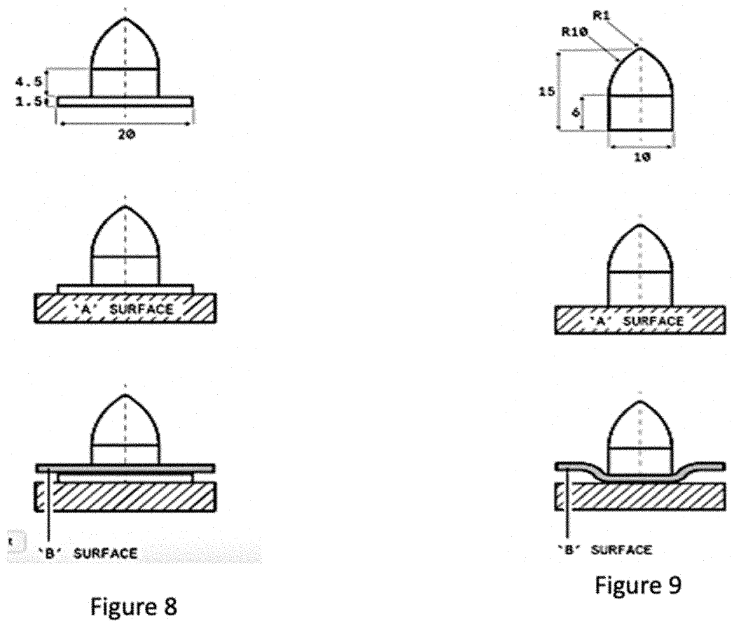

FIGS. 8-15 shows various fasteners optimised for robotic use.

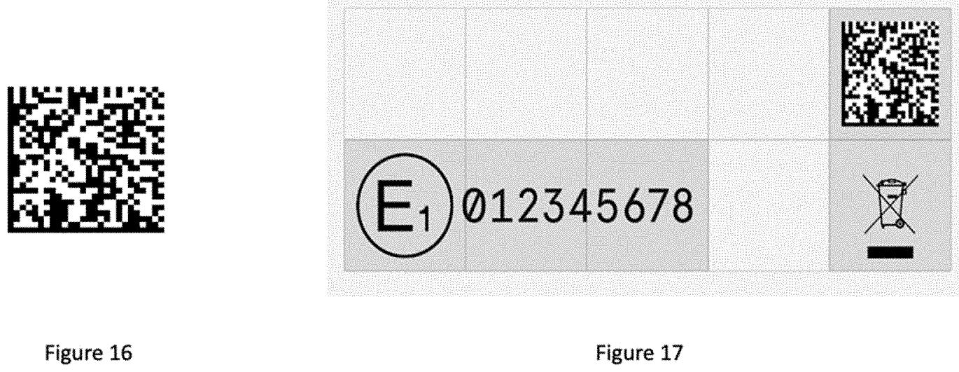

FIGS. 16-17 show Arrival part identification labels.

### FIGS. 1-17 Index

| Reference | |
|---|---|
| numeral | Description of item |
| 100 | Arrival Bus |
| 101 | transverse sections of 1.5 m length |
| 102 | 1.5 m long aluminium strut |
| 103 | 1.5 m long aluminium base plate |
| 104 | 1.5 m long composite roof panel |
| 105 | 1.5 m long extruded aluminium strut |
| 106 | 1.5 m long colour display panels |
| 108 | 1.5 m long composite body panels |
| 110 | 350 mm × 350 mm Battery module |
| 111 | Array of battery modules |

### DETAILED DESCRIPTION RELATING TO THIS SECTION A

In the following part of this Section A, we will look at the Arrival modular hardware system in more detail.

Feature 1: Modular Hardware Component Sizing

Hardware Modularity: Standard Size Architecture:

We have seen in the introduction that Arrival uses standard hardware sizing across a broad range of different items. The example given earlier was for the Arrival Bus, which is constructed from a number of 1.5 m long sections. FIG. 1 shows the Arrival Bus 100; in FIG. 2 we can see how the bus is in fact made from seven modular, 1.5 m long transverse sections 101; these sections include both the chassis and the superstructure. FIG. 3 shows the transverse sections 101 in more detail so we can see the different components that all conform to the 1.5 m length requirement: these include all of the longitudinal struts 102 that make up a structural ladder frame, the 1.5 m long aluminium base plates 103, the 1.5 m long composite roof panels 104 and the extruded aluminium struts 105 that make up an inner frame. This modular approach to the construction of the Arrival Bus enables the core structural components to be made from a relatively small number of different components, each with a standardised length. And these components are all designed for robotic production, and also handling and assembly: for example, they are generally light and have even distributed weight distribution so can be easily and predictably manipulated by a robot. They are rigid and have flat surfaces that are easily gripped by a robotic gripped and have few or no hard to grip curved surfaces. FIG. 4 shows a single transverse chassis section in more detail: we can see the 1.5 m long composite roof panels, the 1.5 m long extruded aluminium struts; the 1.5 m long composite side panels 108. Returning to the finished bus, FIG. 5, we see how hardware modularity, and in particular the consistent use of building items to a 1.5 m scale, is apparent even from the exterior: we can see the seven 1.5 m long colour display panels 106 that run along virtually the entire length of the Arrival Bus; we can see how each composite body panel is in fact 11.5 m long body panel.

FIG. 6 is another example of hardware modularity: each HVBM battery module 110 is 350 mm×350 mm square. A group of twelve modules can be combined together, as shown in FIG. 7; because of the simple, whole number sizing of the HVBS, it is easy to see that the group of HVBMs will have a 1.4 m width, and hence should fit within the cavity defined by the 1.5 m length of each chassis section.

We can look at this through a more theoretical lens too: A ‘size architecture’ relates to the physical design of Arrival components—criteria that capture the principles of physical modularity and consistency in design language. By using a pre-set grid size as bounds for production geometry, spaces left for components will never be too small, and components will never be too large. The size architecture number system is a simple and compatible system to accurately cover a wide range of sizes. Modules are designed in increments of 100 mm on external dimensions. For example 100×100, 200×100, or 300×200 etc. Grid size defined by these sizes includes tolerance. The word ‘size’ should be interpreted broadly. In many cases it will refer to a dimension of length, but it may also refer to an area, weight, capacity to perform, rating and so forth. Some modules can be electrically connected to the vehicle and these electrical connectors also conform to the same standardised sizing. For example, external overmoulded harness connectors are 100 mm wide, regardless of contact configuration. 100 mm wide modules have one connector per side (maximum two connectors per module). 200 mm modules have up to two connectors per side (maximum four connectors per module).

Properties of the ‘Size Architecture’ Number System

Simplicity: Human friendly numbers. It is important that the number system be intuitive, with few things to remember, and as few steps for any process or calculation. We have a strong preference for integers with few significant figures, and few decimal places.

Coverage: Accurate and evenly spaced. The number series presents a limited number of choices to cover a wide range of values. It is important that these values give good coverage on the number line, with small gaps and even spacing.

Compatibility: Sizes which work well together: components that fit nicely next to each other and fill the available area without leaving gaps which are difficult to use. Given that the sizes of components is driven by the number system, then a measure of a good number system should describe the inter-relatedness of any values produced. We have defined this property in terms of mathematical closure. Closure describes if an operation on one value generated by the number system, produces another value from the number system. Individual operations could include division, multiplication, addition or subtraction. The number system is a compromise between simplicity, coverage, and compatibility. We therefore would not expect perfect closure of the set, so we measure the proportion of operations which are closed relative to the proportion which are not closed. Compatibility is hence the ratio of number of closed operations divided by the number of open operations.

The Number System

The number system uses standard Base 10, split in to equal steps with a constant factor in between.

$$\{ ⌊ {( \sqrt[3]{10} )}^{i} ⌉ \times {10}^{x} \vert \begin{matrix}\begin{matrix}\begin{matrix}n ∈ {ℕ}_{1} \\ i ∈ {ℕ}_{1}\end{matrix} \\ i ⩽ n\end{matrix} \\ x ∈ ℤ\end{matrix} \}$$

First Preference

The first order preference divides 10 in to three equal steps, thus ³√10. Values produced are rounded to the nearest integer.

$$\{ ⌊ {( \sqrt[3]{10} )}^{i} ⌉ \times {10}^{x} \vert \begin{matrix}\begin{matrix}i ∈ {ℕ}_{1} \\ i ⩽ 3\end{matrix} \\ x ∈ ℤ\end{matrix} \}$$

$$\begin{matrix}\{ 1 , 2 , 5 \} \times {{10}^{x}}_{x ∈ ℤ} & \begin{matrix}Maximum toleranc \text{e:} 3 X \% \\ Maximum rounding error of 0.12 \%\end{matrix} \\ & \begin{matrix}Maximum toleranc \text{e:} 3 X \% \\ Maximum rounding error of 0.12 \%\end{matrix}\end{matrix}$$

Second Preference

The second order preference divides 10 in to ten equal steps, thus ¹⁰√10.

Values produced are rounded to 0.25.

$${0.25 ‖ {( \sqrt[10]{10} )}^{i} / 0.25 ‖}_{i ∈ {ℕ}_{i} \vert i ⩽ 10} {\times {10}^{x}}_{x ∈ ℤ}$$

$$\begin{matrix}\begin{matrix}\{ 1.00 , 1.25 , 1.50 , 2.00 , 2.50 , \\ 3.00 , 4.00 , 5.00 , 6.00 , 8.00 \}\end{matrix} {\times {10}^{x}}_{x ∈ ℤ} & & Rounded values to be confirmed \\ & & \begin{matrix}Maximum toleranc \text{e:} X \% \\ Maximum rounding error of \%\end{matrix}\end{matrix}$$

Grid sized modules: Electronic components that function regardless of their installation location within a vehicle or product should be designed to the following guidelines. Unit size: Negotiate the physical unit size (bounding boxes), the negotiation is likely to involve all parties (designers, PCB engineers, etc) involved with the component.

Components/assemblies shared across Arrival adhere to a grid space “box” so that when the technology improves, the updated component integrates into the existing product seamlessly. Dimensions should be determined by the functional requirements for the component in conjunction with the Arrival number preference system described above. Installation orientation: Determine the orientation that the unit geometry will be when it is installed. All connectors (mechanical, electrical, thermal) should go on the bottom face.

Components should be designed to the grid size: the design boundary, negotiated and communicated. The production size accounts for tolerance and is bounded by the grid size. Components are designed to the grid size: the predefined physical boundary interface which is based on the size architecture number system. The production size takes account of tolerance within the boundary defined by the grid size. The production size (the geometry after production tolerance) does not extend outside of the grid size. Between teams, we need only communicate the grid size. The production size is driven by production tolerance and should not be widely communicated as it is likely to change as production processes evolve. The production size is driven such that components will interface and assemble within a platform designed to accommodate grid sized components. By using the grid size as bounds for production geometry, spaces left for components will never be too small, and components will never be too large. Clearance (an intentional space created between parts) is considered as a virtual component within an assembly. Clearance is provided in the assembly context not in the part—think of the clearance as a ‘virtual part’ with two interfaces; one interface presented up to the assembly and one down to the part. Clearance is a function of the assembly, not the component. The reason is because the component does not know about the assembly context. If a component will be used in a dynamically moving assembly (such as sliding in and out) or frequently removed (such as for servicing), then a large gap may be required. If instead precise assembly methods are used, then the gap can be reduced accordingly. The product does not change. Ideally we would have nice numbers for both the part and the clearance (which itself can be considered as a virtual component). This would mean the module spacing would be a similarly nice number (being the sum of both the part and the clearance). Being a ‘virtual component’, clearance does not have a tolerance.

We can generalise to:

A vehicle component that is modular or standardised by virtue of having a size that conforms to regular size intervals and is part of a family of other types of components, all with sizing that also conforms to the same size intervals.

Optional Sub-Features:
substantially all of the structural components used in the vehicle are modular or standardised vehicle components, having a size that conforms to the regular size intervals.
substantially all of the longitudinal extruded beams or members used in the chassis or skateboard of the vehicle are modular or standardised vehicle components, having a size that conforms to the regular size intervals.
substantially all of the transverse extruded beams or members used in the chassis or skateboard of the vehicle are modular or standardised vehicle components, having a size that conforms to the regular size intervals.
substantially all of the vertical extruded beams or members used in the superstructure or body of the vehicle are modular or standardised vehicle components, having a size that conforms to the regular size intervals.
substantially all of the vertical extruded beams or members used in the superstructure or body of the vehicle are separated by horizontal distances that conform to the regular size intervals.
the structural cast wheel arches or wheel supports used in the vehicle are modular or standardised vehicle components, having a size that conforms to the regular size intervals.
the front and rear suspension cradles of the vehicle are modular or standardised vehicle components, having a size that conforms to the regular size intervals.
the body panels used in the vehicle are modular or standardised vehicle components, having a size that conforms to the regular size intervals.
substantially all of the body panels used in the vehicle are composite panels.
where the vehicle is constructed from a number of transverse chassis sections, then some or all of those transverse chassis sections are modular or standardised vehicle components, having a size that conforms to the regular size intervals.
substantially all of the battery modules used in the vehicle are modular or standardised vehicle components that have a size that conforms to the regular size intervals.
the casing of the battery pack that contains the battery modules is a modular or standardised vehicle component that has a size that conforms to the regular size intervals.
one or more of the following are modular or standardised vehicle components that have a size that conforms to the regular size intervals: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
the size intervals are configured to facilitate robotic handling and assembly.
the size intervals are selected to facilitate computer assisted design of the component.
the size intervals are selected to minimise the computation time for trajectory planning and collision detection.
the size of a component is defined by an automated sizing algorithm.
the size of a component is defined by an automated sizing algorithm that calculates the optimal size for that component, given multiple input parameters.
the size of a component is selected to facilitate computer vision based detection, including pose and orientation detection.
the size of a component is selected to facilitate calculation of the swing path during handling and installation.
some or all components have a similar shape.
some or all components have a similar, simplified box-like shape.
some or all components have a flat top.
some or all components have a flat sides.
some or all components have a flat base.
sizing is defined by 100 mm increments.
sizing is defined by 10 mm increment.
the component is made from rigid material to minimise deformation during handling.

Feature 2: Modular Hardware Components Installed Using the Same Regular, Rectilinear Grid or Installation Pattern

In preceding Feature 1, we introduced the concept of Hardware Modularity, with the sizes of different components all conforming to pre-set increments in size. Having modules with standardised sizing is useful, but what makes it even more useful is if modules or other components are actually positioned or installed according to a standardised grid—e.g. the physical locations of modules is constrained in a way consistent with the size increments. The transverse chassis sections 101 shown in FIG. 2 and in more detail in FIG. 3 and FIG. 4 are examples of an entire vehicle in effect laid out with structural components that conform to a rectilinear grid with 1.5 m long dimension.

Another example: a component like a box-shaped controller may have an overall size that conforms to the size scale described in Feature 1, but in addition has fixing holes at each corner and these conform to that same (or a derived or related) scale. The fixing holes can align with drill holes in a supporting plate for that controller; the drill holes are positioned in a way that conforms to a regular, rectilinear grid or installation pattern. The overall result is a controller unit with a size that conforms to a standardised size scale, being itself installed in a manner that conforms to a regular, rectilinear grid or installation pattern. This approach to standardised, hardware component sizing, coupled with standardised, hardware component positioning, constrains two variables (size, location) and hence makes automated, software-based design and layout feasible, and also simplifies robotic handling, assembly and installation.

Positioning or installing objects according to a standardised grid applies not just to the vehicle, but also the production environment where the vehicle is made; we will see how the Layout Studio and microfactories also apply the same rules. For example, the size of robotic cells and their placement conforms to the same rectilinear grid; the size and routing of pathways for AMRs conforms to the same rectilinear grid. All of this facilitates software simulation and analysis of a proposed factory layout, enables more effective optimisation of that layout, and facilitates physical construction.

We can generalise to:

A vehicle component that is modular or standardised by virtue of being part of a family of other types of components, all being configured to be positioned or installed in the vehicle in a regular, rectilinear grid or installation pattern.

Optional Sub-Features
rectilinear grid or installation pattern is optimised for robotic installation or assembly, such as autonomous robotic installation or assembly.
rectilinear grid or installation pattern is optimised to facilitate computer vision based detection of the position of component
rectilinear grid or installation pattern is optimised to facilitate computer vision based detection of the correct installation of a component
rectilinear grid or installation pattern is selected to facilitate calculation of the swing path during handling and installation
the size of robotic cells in a vehicle production environment and their placement conforms to same rectilinear grid or installation pattern
the size and routing of pathways for AMRs in a vehicle production environment conforms to same rectilinear grid or installation pattern
vehicle component is modular or standardised by virtue of having a size that conforms to regular size intervals and is part of a family of other types of components, all with sizing that also conforms to the same size intervals, as per Feature 1 and its optional sub-features.

Feature 3: Modular Hardware Components Configured for Robotic Assembly

The Arrival system defines how components are moved within a microfactory, for both external logistics and internal logistics. Components should be: rigid and non-deformable, stackable in shelving, and stable when transported by AMRs and designed for safe, manual handling. These requirements, whilst straightforward in themselves, can result in the radical re-design and improvement of components. For example, the HVBM 110 shown in FIG. 6 exemplifies a component that meets these criteria and, as a consequence, is very different from earlier battery modules.

Mobile robotics are developed for indoor logistics: Parts should rest stably on the AMR mobile platform without jigs; that implies that the parts should have large flat surfaces that can rest stably on the AMR platform. Parts should not obscure sensors or cameras on the AMR mobile platform. Again, these requirements are straightforward in themselves, but lead to the overall Arrival production system being reliable, scalable and efficient.

With the Arrival system, individual parts are shaped to make them suitable for handling and manipulation by a robot. Robots need to grasp components safely, and to have sufficient space or clearance to reach and install components, and to work with component materials that are intrinsically compatible with robotic handling. Dealing with each of these in turn:

Grasping—i.e. to help robots hold on to parts. Components will be picked up and moved by robots, and the component design should have affordances for secure grip to allow fast acceleration and movement. For this, we need a sufficiently large grasping surface, with the right high friction material, with contact points close to the centre of mass to reduce the moment of force on the robot. Generally speaking, simple geometries are easier to grasp. These predictable gripping or grasping features also enable precise knowledge of part location (localisation). Specific examples: Components to be handled by vacuum gripper should have a flat area at least 20 mm². Components to be handled by vacuum gripper should have a centre of mass moment less than a pre-set Nm so that they can be safely manipulated by the vacuum gripper. Components to be handled by parallel gripper should have parallel flat areas.

Clearance for robots: there must be sufficient place planned or simulated for all robotic operations. Localised clearance is only the minimum requirement. Tooling access may also be restricted by other factors, including robot arm reach, robot position and holding fixtures. Tooling access: When designing with fasteners such as bolts and screws, we need to ensure there is sufficient clearance around the fastener head for the robotic driver (usually at least 18 mm) and sufficient access for the robotic head. Robots approach in the axis of the fastener, and do not require leverage, such as a human would need for a spanner.

A wireframe draggable model of the robot (dexterity and reach) is typically used to simulate the swing path in CAD and to verify that all paths are viable, with sufficient clearance.

Examples of types of access for Robofacturing: Standard tool access is preferred, as opposed to specialist tools (e.g. screwdriver, nut runner, sealing gun). Gripper access for part loading during the process: use a common part design to reduce gripper variants; simplify assembly sequence; minimise ‘insert’ type of operations.

Material properties: Rigid and predictable materials are preferred by robots. Deformable or inconsistent materials are difficult for robots to handle and are avoided.

In the Arrival system, the robotic tooling or end effectors are common or shared between different vehicles to enable microfactories to produce the full range of Arrival vehicles without manual intervention; robots need to be able to access much smaller ranges of tools in order to perform all of the functions required of them; this make selecting an appropriate tool faster. For example, only a limited number of fastener systems are used and components are designed with shapes or geometries that enable them to be robotically assembled or attached using this limited number of different fastener systems. Self-aligning fasteners are used where possible—i.e. correct assembly does not depend on highly accurate robotic positioning of a fastener or the tool to attach the fastener. Bonding adhesives are also used where possible, with just a single design of adhesive applicator used.

We can generalise to:

A vehicle component that is modular or standardised by virtue of being part of a family of other types of components, all having external surface or casing feature or features that are optimised for robotic handling, installation or assembly, such as autonomous robotic handling, installation or assembly.

Optional Sub-Features:
external surface or casing feature or features are gripping features.
external surface or casing feature or features are a sufficient grasping surface, close to the component centre of mass.
external surface or casing feature or features enable accurate component location or localisation.
external surface or casing feature or features enable a secure grip during robotic handling, enabling movement with fast acceleration and deceleration.
some or all of the family of components have a similar shape.
some or all of the family of components have a similar, simplified box-like shape.
some or all of the family of components have a flat top.
some or all of the family of components have a flat side.
some or all of the family of components have a flat base.
sizing is defined by 100 mm increments.
sizing is defined by 10 mm increment.
size of a component is defined by an automated sizing algorithm.
size of a component is defined by an automated sizing algorithm that calculates the optimal size for that component, given multiple input parameters.
casing feature or features of a component are selected to facilitate computer vision based detection, including pose and orientation detection.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.

Feature 4: Modular Hardware Components that are Box Shaped

We have seen how Arrival modules can have a size that conforms to a size scale, are located on a rectilinear grid and have an external feature or features that are optimised for robotic handling, installation or assembly. One specific example that brings all of these features together is to give modules a specific type of shape, such as a box shape, like the battery module 110 shown in FIG. 6 and described in more detail in Section G.

We can generalise to:

A vehicle component that is modular or standardised by virtue of being part of a family of other types of components, all having the same overall type of shape (such as box shaped), the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors.

Optional Sub-Features
box shape is optimised for robotic handling, installation or assembly, such as autonomous robotic handling, installation or assembly.
box shape is selected to facilitate computer vision based detection, including pose and orientation detection.
box size is selected to conform to regular size intervals.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features.

Feature 5: Modular Hardware Components with Install Path Optimised for Robotic Installation

Components are configured to interact, connect, and interface with other parts through methods and approaches suited for robots. A tool will assess the number of operations, the time taken to complete the operations, and the actions involved to give feedback on a total cost of assembly, and where errors may occur. The following considerations, important for robotic assembly, are implemented in the Arrival system: Fewer unique operations; Fewer operations overall; Fewer operations means fewer connection points to define in D2R (Design to Robofacturing) process/tool; Combined operations (integrated functions, such as cooling pipes in casting); We aim to simplify tooling by using a common contact mechanism; If a component's shape is irregular and cannot be avoided, then gripping features need to be designed into it. Single vector engagement is used: Parts should engage with other parts through a single vector of movement, so that alignment can be determined through force/torque sensor feedback on the robots, to coordinate grasping certainty axis with direction of insertion and connection features (reduce positional uncertainty). Sequential operations are used: One by one, bottom to top, avoiding parallel operations. Assemble then fix is used: Position first and then fix in place. To aid assembly, components should self-locate. Adding auto alignment features allows parts to self-locate. Standardised fasteners are used to simplify assembly. Section J gives a robotic build sequence for the Arrival Bus components described earlier; this build sequence exemplifies the robotic production requirements described above.

We can generalise to:

A vehicle component that is modular or standardised by virtue of being part of a family of other types of components, all designed for an installation path to a position, in which the installation path is optimised for robotic handling, installation or assembly, such as autonomous robotic handling, installation or assembly.

Optional Sub-Features
installation path is selected to ensure enough space for robotic operations.
installation path is selected to ensure enough access space for a robotic head.
robots approach in the axis of fasteners for the component, and do not require leverage (such as for a spanner).
installation path is calculated in CAD using a wireframe draggable model of the component and the robot.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features
vehicle component is modular or standardised by virtue of being part of a family of other types of components, all having the same overall box shape, as per Feature 4 and its optional sub-features.

Feature 6: Modular Hardware Components with Standardised Fasteners

Arrival has a set of standard interfaces that are used whenever possible, to aid with efficiency and Robofacturing. Standard interfaces are part of the size architecture interfaces library.

Arrival Standard fasteners: a common set of fasteners for Arrival products and assemblies. Fasteners are an important part of building vehicles, components and assemblies. It is important to manage the variety of fasteners in our supply chain and production environment to help us move fast and streamline our operations. The standard fastener library is a common set of fasteners: a limited number of choices to cover a wide range of sizes—to be used across all products in Arrival. Reducing the variety of equivalent yet different fasteners which achieve substantially the same goal, is worthwhile so that we can leverage the advantages associated with standardisation, including: Fast development and reduced uncertainty—simple options with clear guidelines and pooled experience; Simplified operations—sourcing, logistics and warehousing all benefit from fewer different parts; Lower cost—combined purchasing power brings down the cost of fasteners.

Advantages of Arrival Standard fasteners: Simplified production: Limiting the number of different driver types simplifies production and assembly by reducing the complexity of pick and place and auto feed; the impact on servicing and maintenance is also reduced by limiting the range of tools required.

Simplified logistics: Each new part we add to the standard stock is another part which we need to source, ship, and store. The number of fasteners we need to manage in inventory is the product of the number of different fastener types, the head sizes, the length of each fastener, the grade and surface finish of each fastener. Unless carefully managed, it is quickly possible to end up with many hundreds or even thousands of different fasteners which need to be managed.

inventory=types×diameters×lengths×grades×finishesinventory=types×diameters×lengths×grades×finishes

Economy of scale are delivered: Standardising our fasteners means combining our purchasing power, and leveraging the aggregate volume across all projects, which brings down the cost of fasteners.

Stocked part count is dramatically reduced: With our design approach of modular assembly and multiple factory locations we need to keep fastener options a limited as possible to reduce stocked parts in each location or parts per assembly.

Grouping fasteners per assembly and components will help speed up production and reduce part cost, both controlling the length and size of fastener per part system or assembly will also improve overall speed and cost of production.

Examples: Bolts, screws, nuts, washers, rivets, clips and snap rings, rivnuts.

Datum strategies: Techniques for desensitising the design of alignment requirements in assemblies to cope with production variation and tolerance.

Self-aligning features: Mechanical location features enable automatic alignment of components, especially for robotic assembly. Mechanical location features enable automatic alignment of components, especially for robotic assembly. Key principles are: Part to part alignment reduces the need for complex handling system & holding fixtures; it also helps the alignment of the fastener holes; by default all parts that ‘mate’ need to have self-alignment; only use a robot's accuracy as a last resort.

Alignment pins: Bullet shaped pins allow components to automatically align. The shape of the pins provide a constant insertion force, unlike a chamfer and angle change which can be harsher on the assembly. The curved profile sections of the pins align them to corresponding holes/slots. The cylindrical section determines the final position of the pinned part.

There are two options for alignment pin geometries: Shouldered and Simplified.

Shouldered: Suitable for allowing a small gap between A and B surfaces, as the shoulder of the pin goes against the B surface, as shown in FIG. 8.

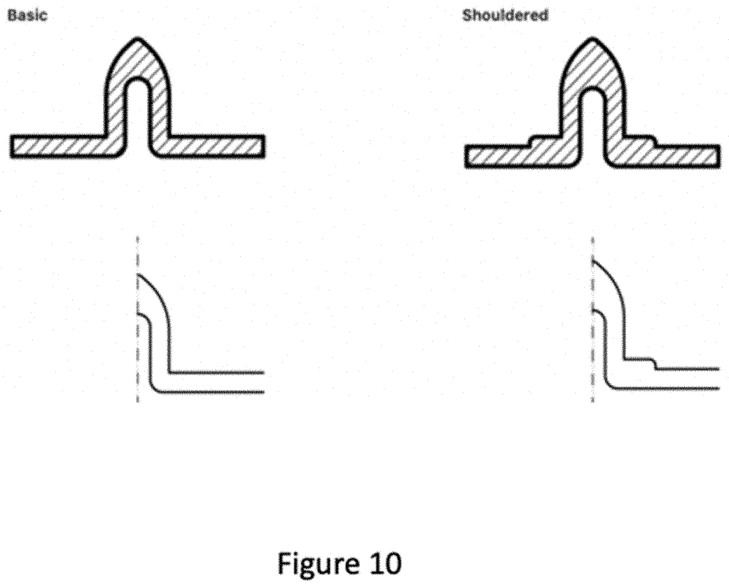

Simplified: Suitable for use if the corresponding part has a raised section of geometry to act as a shoulder, as shown in FIG. 9.

Tolerance and fit: Both pin options have a maximum diameter of Ø10 mm, and can self-locate into a corresponding hole up from an initial position ≤4.5 mm off-centre. Tolerance is determined by corresponding hole size. For instance, an 11 mm hole would allow a total tolerance of ±1 mm, with a maximum gap of 0.5 mm around the pin.

Pin geometry implementation options. Profile moulding: Pins can be directly implemented into the shape of parts, for instance injection moulded parts. Maintaining a consistent wall thickness will reduce the likelihood of sink marks in plastic moulded pieces. Examples are shown in FIG. 10.

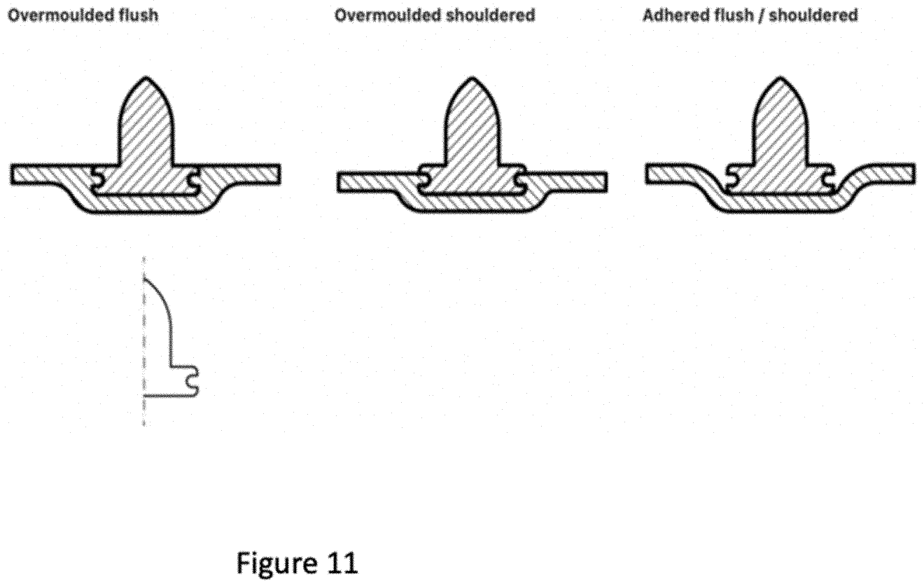

Over-moulded/adhered: Separately moulded/machined pins can be overmoulded into, or adhered onto, other components. Pins can be overmoulded at such a depth that the base of the pin becomes flush with the surface it is moulded into. Pins can be adhered with a suitable adhesive to the surface of other components. The depth of indented location features in the component to determine whether the pin sits flush or proud. Examples are shown in FIG. 11. Pins can be adhered with a suitable adhesive to the surface of other components. The depth of indented location features in the component determine whether the pin sits flush or proud.

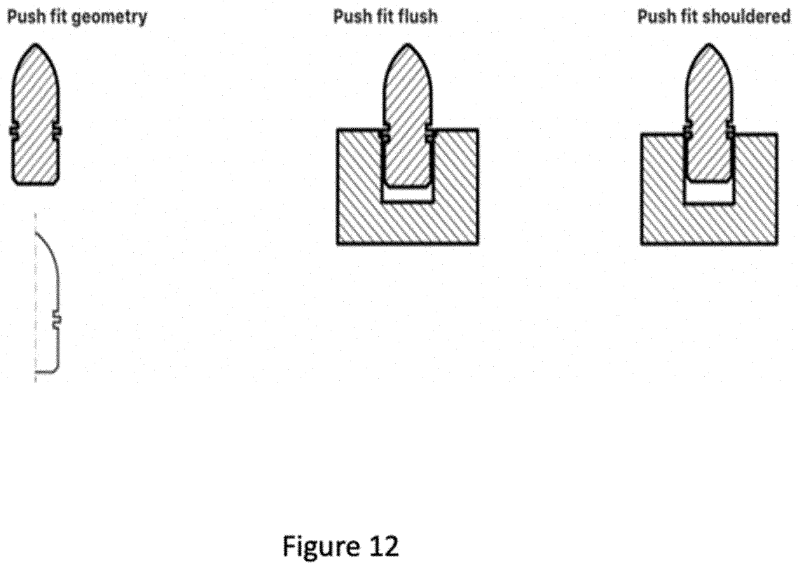

Push fit: The push fit pin design can be implemented into components without adhesive, as shown in FIG. 12.

Push fit: Like the other pin designs, it is a simple revolve that creates the automatic-alignment feature, a shoulder, a chamfered lead in, and sufficient material to engage with a suitable cavity

Push fit flush: If the cavity for a push fit pin has a step to accommodate the pin's shoulder, then the base of the pin can sit flush against the surface of the component.

Push fit shouldered: If the cavity for a push fit pin has no step, then the shoulder of the pin will sit proud, creating a gap between two components once aligned.

Rotation and size variance control: Using multiple alignment features can add further automated control during assembly.

Automatic rotation: Parts with 2 or more alignment pins can automatically rotate a part into position as the pins align with their corresponding holes, as long as the centres of the ends of the tapered pins is aligned somewhere within the corresponding holes.

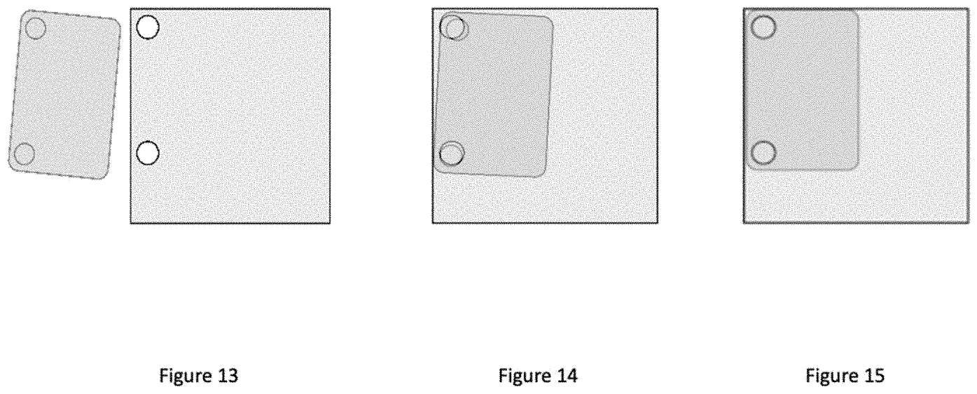

A part with alignment pins (left), and a part with corresponding holes (right) is shown in FIG. 13. The centres of the pins need to be aligned somewhere within the corresponding holes/slots, is shown in FIG. 14.

The pinned part will then automatically rotate into position as the tapered pins are pushed through the holes:

Constraining part size variance: Using a slot and a hole can also automatically rotate a part in position. An advantage of using a slot is that size variance with manufactured parts can be accounted for, and alignment with certain edges can be controlled.

Controlling two aligned edges: This method enables two edges to remain aligned regardless of size variance.

We can generalise to:

A vehicle component that is modular or standardised by virtue of being part of a family of other types of components, that each use the same, standardised physical installation systems, that are each optimised for robotic handling and use.

Optional Sub-Features
standardised physical installation systems include physical fasteners.
physical fasteners are self-aligning or self-locating.
robots approach a fastener or the location of the fastener in the axis of the fastener.
self-aligning or self-locating fastener is a bullet shaped pin.
bullet shaped pin either includes a shoulder or has no shoulder.
bullet shaped pins are overmoulded into, or adhered onto, other components.
bullet shaped pins are adhered with a suitable adhesive to the surface of other components.
bullet shaped pins are push-fit.
parts with two or more alignment pins automatically rotate a part into position as the pins align with their corresponding holes
standardised physical installation systems include glue based systems.
robots are configured for one or more of: Pick and Place, Insert, Glue, Screw, Welding.
a software implemented tool assess the number of operations, the time taken to complete the operations, and the actions involved to give feedback on a total cost of assembly, and where errors may occur.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features.
vehicle component is modular or standardised by virtue of being part of a family of other types of components, all having the same overall box shape, as per Feature 4 and its optional sub-features.
vehicle component is modular or standardised by virtue of being part of a family of other types of components, all designed for an installation path to a position, in which the installation path is optimised for robotic handling, installation or assembly, such as autonomous robotic handling, installation or assembly, as per Feature 5 and its optional sub-features.

Feature 7: Modular Hardware Components with Standardised Self-Aligning Electrical Interfaces

Self-aligning electrical interfaces are used: the electrical connection for components has a float to cope with misalignment during assembly; this gives an electrical and electronic interface for power, signal (data), that is optimised for robotic assembly. Applications include: Automatic connection of components (such as battery module pack or steering rack) upon mechanical assembly into vehicle; quick-swappable batteries (such as for scooter/bike or AMR robot).

Features include: Pre-alignment pins: Some connectors (such as for removable devices, interchangeable batteries, drawer interconnects, and so-forth) have pins to aid in auto-alignment of connectors. Such tapered (conical or rounded) pins would be advantageous for robotic assembly and blind mating of connectors. These pins are often grounded to the connector chassis, but these could also double as high current carrying pins.

Typical components that use these standardised electrical interfaces include: vehicle component includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.

We can generalise to:

A vehicle component that is modular or standardised by virtue of being part of a family of other types of components, that each use the same, standardised self-aligning electrical interfaces, that are each optimised for robotic handling and use.

Optional Sub-Features
standardised self-aligning electrical interfaces includes a float to cope with misalignment during assembly. Ap
standardised self-aligning electrical interfaces enable automatic connection of electrical components upon mechanical assembly into a vehicle.
standardised self-aligning electrical interfaces include pre-alignment pins to aid in auto-alignment of connectors.
pre-alignment pins are tapered conical or rounded pins.
vehicle component includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.

Feature 8: Modular Hardware Components that Use the Same Unique ID System

The value of companies is increasingly driven by their ability to collect and analyse information about their products, customers and supply chains. Arrival is able to identify components, parts, products and vehicles throughout their life. The identification of components facilitates traceability from production and assembly, through logistics, use, servicing and end of life. In addition to identification, robots need to know how the parts they need to pick up or assemble are positioned—i.e. their pose. Automated computer vision systems are used for object 6DoF pose estimation. Components with flat surfaces meeting at sharp edges are easier for computer vision systems to track and to run objection detection and 6DoF pose estimation algorithms against. Complexity of geometry has an impact on the computation time for trajectory planning and collision detection: components with large simple, flat surfaces are easier to handle computationally. Rigid and predictable materials are preferred by robots; deformable or inconsistent materials are difficult for robots to handle and are avoided.

In addition to pose estimation, each component is identifiable, either directly or by inference. Each component is traceable, uniquely and throughout production and use.

Arrival marks hardware components permanently with only the information it cannot avoid: those symbols required by law, and means of product identification. Graphics are formatted using Arrival's procedural labelling system, combining mandatory markings from the modular symbol library with the Arrival unique identification marker, a 2D data matrix which visually encodes the Arrival unique identifier. No other information or human readable text will be marked on our products. These unique markers are generated by an API and encode no meaningful information. Associated names, serial numbers and metadata are retrieved from a database by scanning this machine readable marking.

Why do we choose to avoid marking our products with any human readable text? There are many reasons why we should not mark our products with human readable text, and instead use the Arrival unique identification marker to retrieve appropriate information from the cloud database.
The text we write may be incorrect. Retrieving information on request means we can easily fix any mistakes server-side. Changes can be instantly propagated to all affected products.
Arrival may choose to change the text. We can update the metadata and aliases in the database at any point, even after the product has been marked.
The device properties may change. Our devices are software defined, which means their function is determined by the software which runs on it, and this will change.
products are customised for each application. We don't necessarily know where a product will be used at the point at which we mark it.
products will be increasingly customer specific. If a customer buys a special “parcel lift controller” from Arrival, then the product should be described as a parcel lift controller and not “Arrival generic control module”.
Information should be audience appropriate. Arrival service technicians should be presented with relevant information for servicing, which will be different to stock-keeping or logistics.
information should be clearly understandable to everyone. By retrieving information on request from a database we can present the user with text in their preferred language: French text to a French speaking technician, Kaji text to an imports official in Japan.
prevent reverse-engineering of the Arrival supply chain. Arrival does not want people to know which microfactory, region or supplier a product originates from.
prevent reverse-engineering of our production volumes. Arrival does not want to share any sequential data because this can be used to estimate the volume of product produced.
dates are not relevant. Arrival does not want to advertise the production date or expiry date, because we intend to incorporate ‘used’ components and parts back in to our supply chain for second life, as-new, and refurbished or reconditioned.
audience should have appropriate authorisation. Arrival controls the visibility of information based on the authorisation of the viewer. As it cannot control who observes the part, it must control this in how information is retrieved form the database by implementing access control on the app.

Entities are ascribed a unique identifier. The identifier is an arbitrary and universally unique number against which aliases and metadata can be associated in a database. Hardware components should be permanently marked with a unique identification marker—a 2D barcode which visually encodes the identifying number. RFID tags can also be used to encode the identifying number to be read electronically with a contactless scanner (e.g. RFID tags in composite panels and other parts). Electronic components can be identified electronically over a connected network.

The Arrival unique identifier is an arbitrary and universally unique number which is used to identify all entities in the Arrival universe and against which aliases and metadata are associated in a database.

Here is an example of an Arrival unique identifier:

BGtVbULnzqFuopHlyYt7BKF3zKQaS7kmDMG6Va110wU

The identifier is our way of identifying products so that we can trace them through their life. It's a unique name we give to each new part, and which we store in a database along with any data we collect about that part (such as where it was made and how it is used). We can also use it to name things which are not physical, but which we want to track—like software or users. Arrival requires a consistent ecosystem-wide unique identification scheme which can map to anything, evolve (transform, update, combine), and pertain to any physical or virtual object in the Arrival universe. The solution is compatible with various different use-cases, and even unknown future applications. This leads us to the conclusion that every physical entity has a digital meta-identity. The Arrival unique identifier (AUID) is used to identify all entities in the Arrival universe. The identifier does not directly encode meaningful information, but instead gains meaning through associations made in a database. Such associations include aliases and metadata

The design for the Arrival unique identifier is as follows: There will be one universal Arrival identifier standard which will be used to identify all entities, physical or otherwise. Each entity will be assigned a unique identifier. The number itself is arbitrary. Aliases will be used where human readability is required (the identifier will not be viewed directly) Information and metadata is linked to identifiers in a database. Sufficiently complex number to cover future applications including traceability and tracking within blockchain systems.

The Arrival unique identifier string is a combination of many random bits (for complexity) which are encoded to reduce string length.

The ‘number’ behind the identifier is arbitrary and random (or pseudo-random). The unique identifier itself is largely invisible to the user; instead, human-readable names (aliases) and part numbers are retrieved from the database by association.

The identifier itself is a random string which encodes no information, but which gains meaning by association with metadata in a cloud database. Product names, team specific part numbers and production batch numbers can all be linked to this identifier as associations in the database.

This approach is complementary to any existing or future specific naming or numbering techniques, such as vehicle part numbering, PCB part numbering, TO serial number, electronic component naming and is not intended to replace these human-centred constructs.

Instead, the Arrival unique identifier number would be sufficiently complex that other or existing part numbering systems can be represented by association. This means we can retain any team/discipline/product/organisation specific naming conventions without forcing consensus or reducing usability.

Labelling system: The graphical layout of labelling elements, ready for application on to a component or product, combines Arrival's modular symbol library and unique identification marker, with the procedural layout framework.

The Arrival unique identification marker is a machine readable visual marker encoding the Arrival unique identifier to support the identification of Arrival products and components using computer vision.

FIG. 16 is an example of an Arrival unique identification marker. The marker can be scanned using a smartphone, a camera, or a barcode reader. When you scan an Arrival identification marker, you can retrieve information about that specific product from the cloud database. The identification marker is a passive optical 2D barcode, enabling part identification and traceability through life without physical or electronic interaction. The identification marker is a specific variant of a data matrix which encodes the Arrival unique identification number. The identification marker does not directly encode any meaningful information, but can retrieve information from a database when scanned. The Database can implement:

Storing identifiers: The identifier would be persistent and remain unchanged in the database. Immutable;

Linking identifiers: It should be possible to link one identifier with another. Associations can be used to nest parts within assemblies, or products within bulk packaging;

Linking other entities: Associate a discrete PCB component, a PCB part number (following existing sequential naming convention), and a human readable product name with the same unique identifier.

Linking metadata: Documents, production equipment data, performance through life, test results, decisions/approvals etc.

Direct part marking techniques: The permanent marking of physical components with the graphical output of the Arrival labelling system, to facilitate the reliable identification and tracking through their life. Direct part marking is the process to permanently mark parts with graphical information generated using the Arrival labelling system, including the Arrival unique identification marker. This is done to allow the tracking of parts through the full life cycle, and can assist in data logging for safety, warranty issues and satisfy regulatory requirements.

There are several techniques for permanently marking components; the most versatile of which is laser etching, which is the preferred choice for most types of component. It is important to note that the identifier is unique for each instance of a product, meaning that the graphic must change and cannot be part of the tooling. Digital processes such as laser marking, inkjet printing and direct (maskless) digital imaging are therefore more suitable for marking components

Layout framework: An algorithm for generating labels for marking Arrival parts. Analogous to how CSS (Cascading Style Sheets) presents and arranges content in a predictable way. CSS uses a cascading priority scheme to determine which rule applies to each element. Individual product markings would be derived (ideally automatically/procedurally) from the modular symbol library—showing only those applicable to the specific application. An example Arrival part label is at FIG. 17.

We can generalise to:

A vehicle component that is modular or standardised by virtue of being part of a family of other types of components, that each use the same, standardised identification system that gives each individual component a unique identification that is (i) computer readable but not meaningful to a human; and (ii) enables each individual component to be tracked from initial production to initial installation, and subsequent servicing and end-of-life.

Optional Sub-Features
component is tracked using a smart or computer implemented supply chain system.
real-time component data is fed into the computer implemented supply chain system, which automatically adjusts supply chain parameters, such as which components are ordered and their delivery schedules, based on the real-time data.
the real-time data fed to the computer implemented supply chain system includes real-time installation data.
the real-time data fed to the computer implemented supply chain system includes real-time component performance data.
the real-time data fed to the computer implemented supply chain system includes real-time component maintenance data.
the real-time data fed to the computer implemented supply chain system includes real-time component fault data.
real-time component data is fed to an AB testing system for analysis.
real-time component data is analysed for predictive maintenance.
unique identification is a 2D barcode and/or RFID tag.
component is any component used in the vehicle.

Feature 9: Modular Hardware Components that are Black

Automated computer vision systems are used for object 6DoF pose estimation. Components with flat surfaces meeting at sharp edges are easier for computer vision systems to track and to run objection detection and 6DoF pose estimation algorithms against. However, non-uniform colours can confuse edge detection systems and make pose estimation less reliable. Many electronic Arrival components need to dissipate heat efficiently: for example, ECUs, battery modules, and integrated drive units all need to dissipate heat efficiently and predictably. Arrival components can address both of these requirements by colouring the component substantially black.

We can generalise to:

A vehicle component that is modular or standardised by virtue of being part of a family of other types of components, all optimised for robotic computer vision systems and optimised for radiant heat dissipation, by virtue of being substantially black in colour.

Optional Sub-Features
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing; sensors; weight sensors; computer vision sensors; LIDAR sensors; radar-based sensors.

Section B: Software Modularity: The Unified Software Architecture and Plug and Play Methodology

Introduction to this Section B

Plug and Play (PnP) Methodology is based on the modularity of Arrival software components and enables proper functioning of Arrival electronic devices, applications, and services once Arrival vehicle or product starts its operation. The Arrival software and control approach is designed to support the vision of a modular and upgradeable ‘device on wheels’. The criteria within the plug and play theme capture the main aspects of software modularity required for achieving this vision. Both hardware and software modules are secure, intelligent, and can report their own health status to the Arrival cloud. Once an Arrival component is plugged into an Arrival vehicle, it will start functioning easily and automatically without configuration or modification of the existing system.

Plug and play is the software equivalent of the size architecture system, the modular hardware platform described in Section A above.

Unified Software Architecture

To configure software components in a similar way, the software architecture provides for:
Unified communications between all software components
Unified communications between all software components and a cloud or server
Unified monitoring and diagnostics
Unified cyber security measures (such as protocol/authentication procedures)
Unified configuration and update procedures

The Arrival's unified software architecture is based on the following principles:

Software modularity: The modularity of control module (ECU) embedded software enables tailoring of software according to the individual requirements of the control module and their tasks in the automotive architecture. Also, such highly cohesive architecture limits the individual responsibilities of a software module—an individual software component will typically perform a small and specific set of tasks. Such software modules are also referred to as modular software components.

Layered software architecture: Control module embedded software is decomposed to the application layer and the basic software layer, which allows to decrease coupling between embedded software and hardware part of the control module. This approach allows reusing software parts and components, especially software components of the application layer, in different vehicle models with different hardware topologies.

Self-contained: adding a new module adds new functions, features, or capabilities. Functions are assigned to modules. Modules are responsible not only for delivering the functions but reporting the extent to which they can fulfil those functions, for example as following manner: “I'm not ASIL D”; “I can for one year”; “I don't know, I have a faulty sensor”.

Common communication: components are configured to share information with one another. Network protocol is the main basis for the communications.

Pre-configured (auto-initialised): All components are easy to integrate as being pre-configured and can be auto-initialised.

Self-aware: Software components support self-awareness features of hardware; provided are Health monitoring; Issue discovery (awareness); Root cause; Identify solutions (resourceful—cope outside of ‘normal’ scenarios); Issue resolution (fix).

Latent value: Software components support calculation of remaining life of hardware, such as for crash damaged or end of life vehicles, reuse, and refurbishment.

The Unified software architecture also provides for secure, distributed, fault tolerant and updatable/upgradeable software solutions.

Implementation of the above principles in the Arrival system enables the following:

Knowledge base on vehicle systems: out-of-the-box vehicle systems which are configured, tested and pre-integrated with each other and have flexible deployment schemas. The Arrival knowledge base comprises developed catalogues or libraries of system features, system functions, software components, hardware components, vehicle models etc.

Common technology framework: Arrival Technology Platform (ATP), and the whole Arrival system, provides for the common technology framework to build and maintain new vehicle models in easy and consistent way according to the common and unified architectural principles.

Integrated Toolchain: Common technology framework allows to define all vehicle specifications according to pre-set requirements and to validate consistency of overall vehicle architecture, by means of such Arrival tools as Vehicle Builder, Version control system, Artifactory and Integrated development environment (IDE).

### BRIEF SUMMARY OF THE FIGURES RELATING TO THIS SECTION B

Some features, implementations and examples of Arrival's unified software architecture, software modularity, Plug and Play methodology and an automated vehicle design tool Vehicle Builder are illustrated in the accompanying figures, in which:

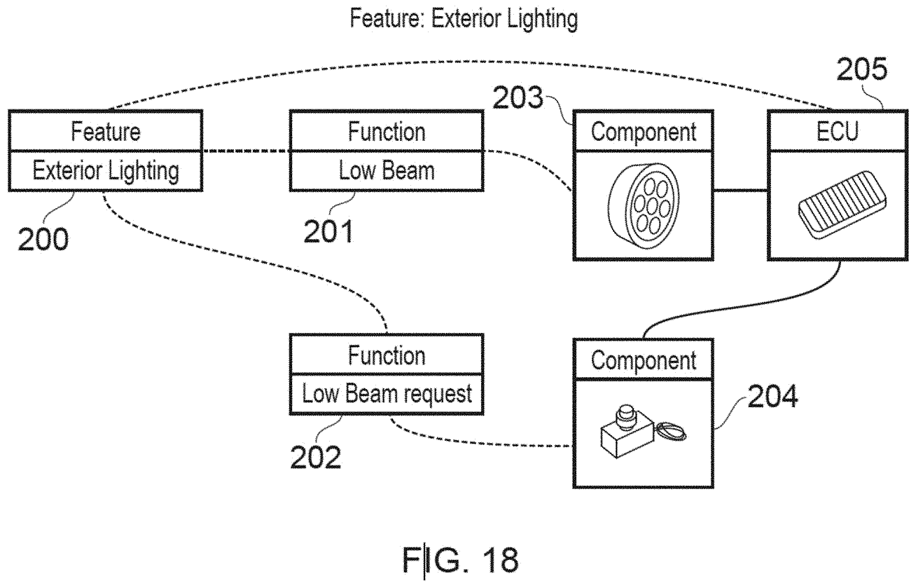

FIG. 18—a functional model of an exterior lighting feature;

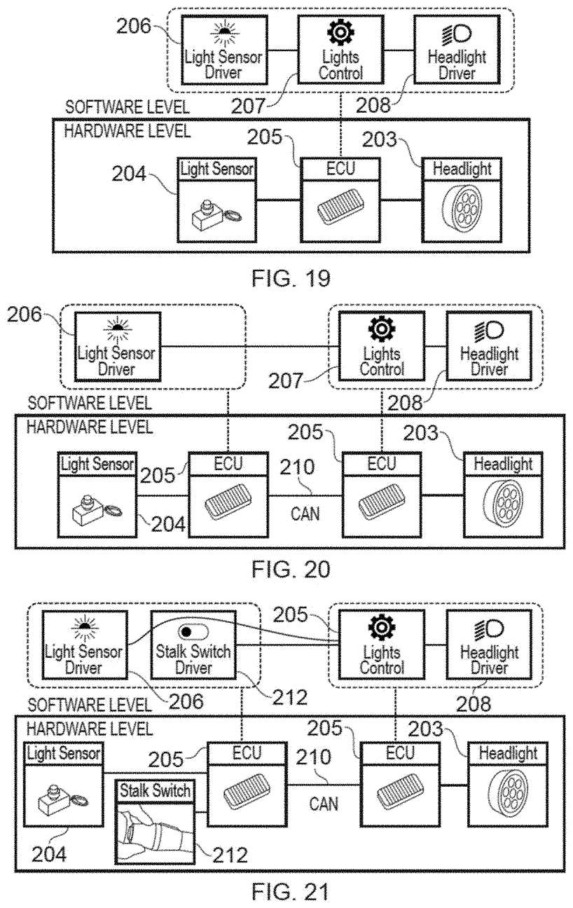

FIG. 19—a structural model of the exterior lighting feature of FIG. 18;

FIG. 20—a modified structural model of a version of the exterior lighting feature;

FIG. 21—another modified structural model of a version of the exterior lighting feature;

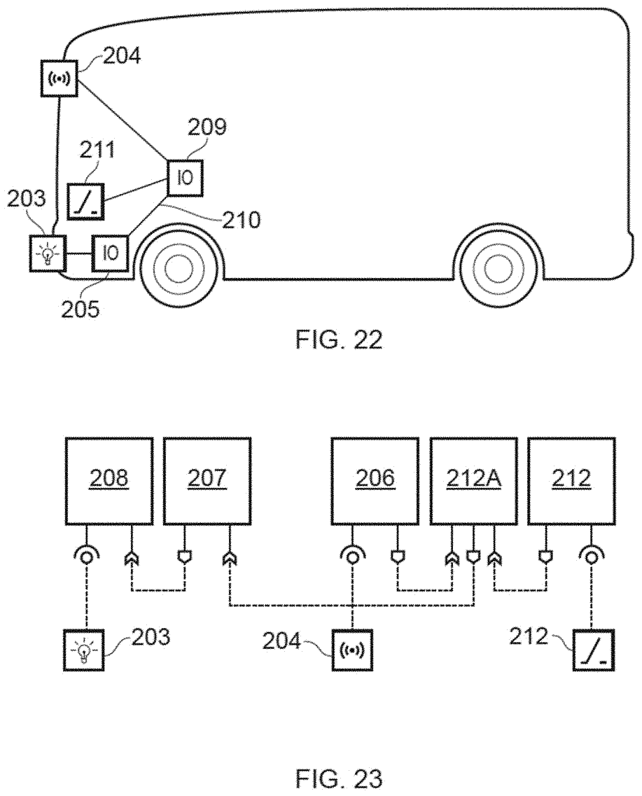

FIG. 22—a hardware topology of the exterior lighting feature of FIG. 18 in a vehicle;

FIG. 23—a logical schema of software components that can be applied on the hardware topology of FIG. 22;

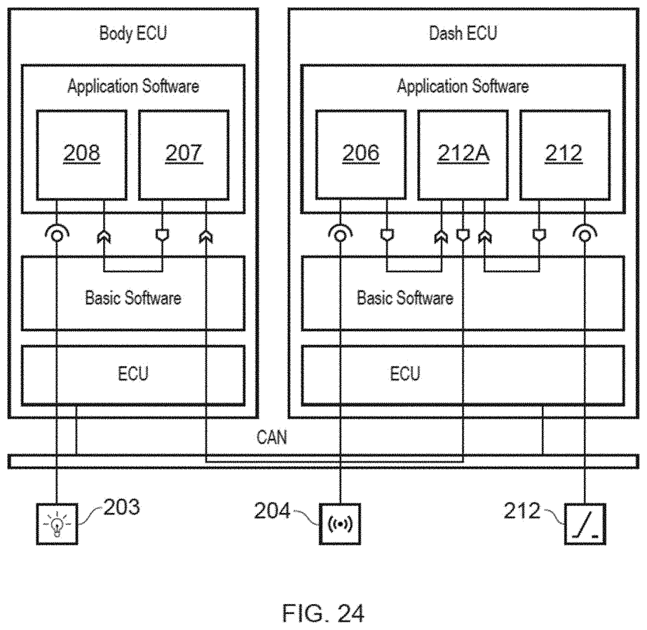

FIG. 24—a software allocation scheme of the software components of FIG. 23 on two ECUs;

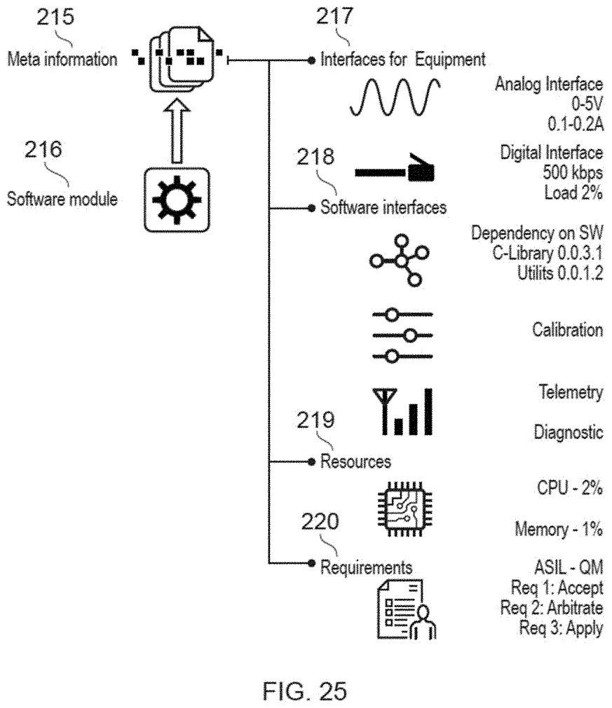

FIG. 25—a content of meta information of a modular software component;

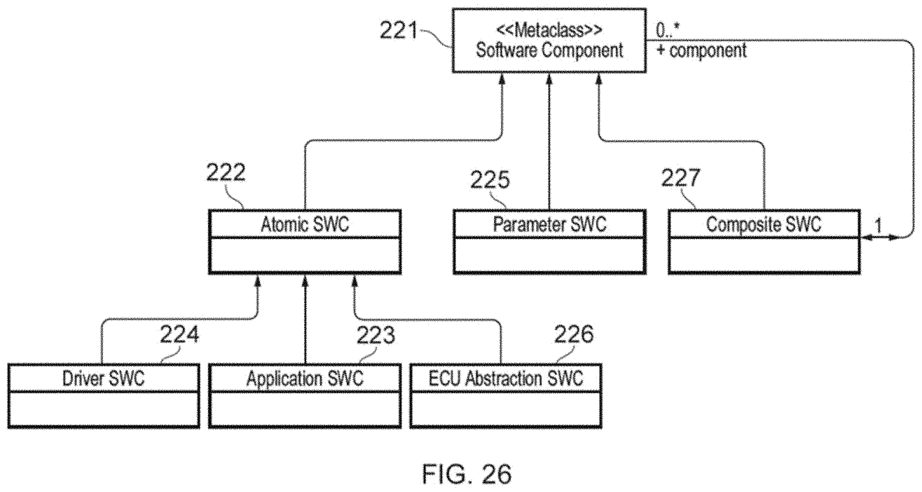

FIG. 26—a Software Component (SWC) Metamodel;

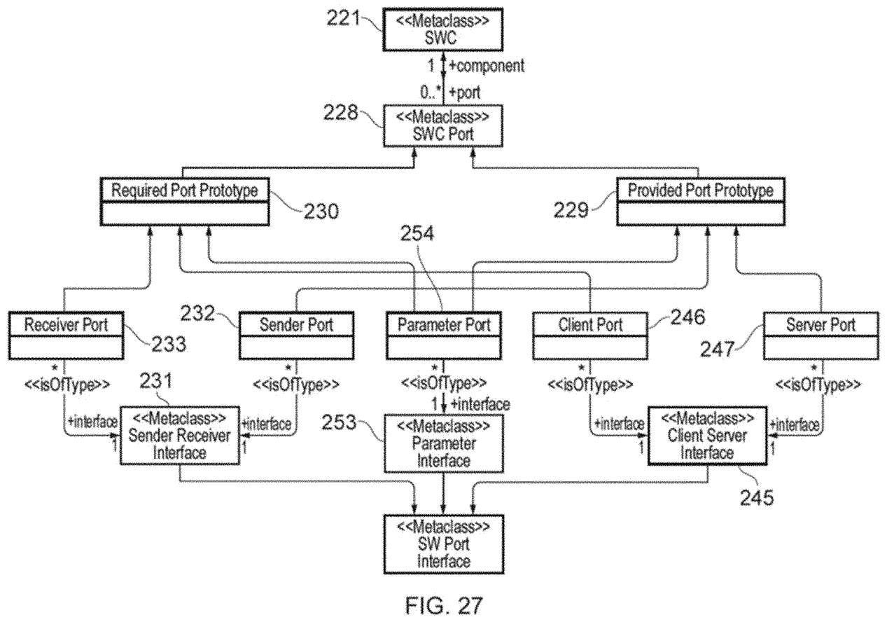

FIG. 27—a diagram of Ports and Interfaces of the SWC Metamodel;

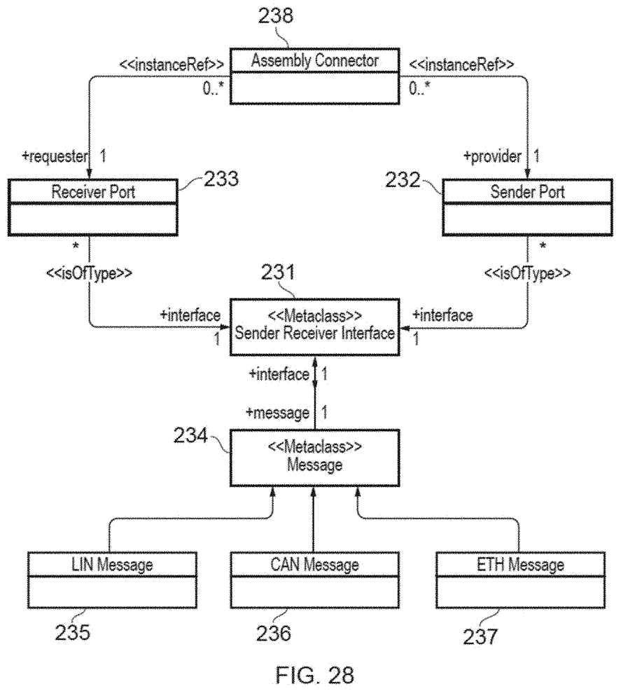

FIG. 28—a diagram of Sender-Receiver Communication in the SWC Metamodel;

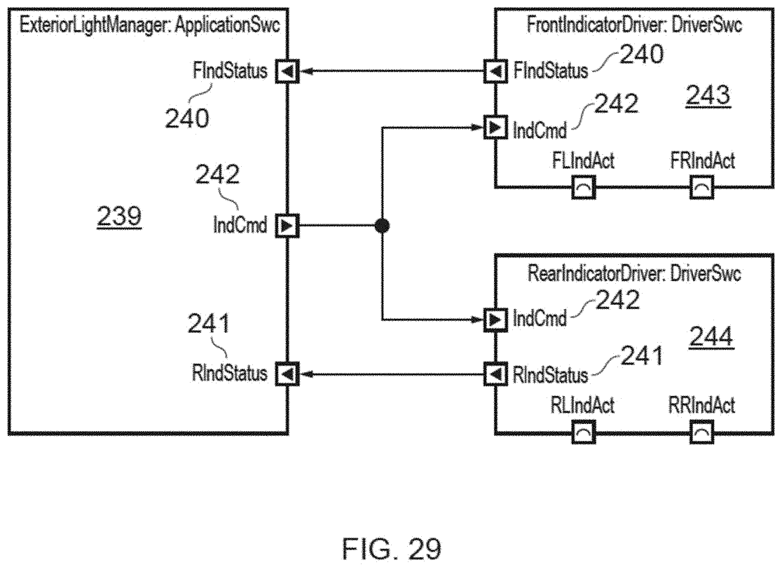

FIG. 29—a diagram of an n:1 communication in the SWC Metamodel;

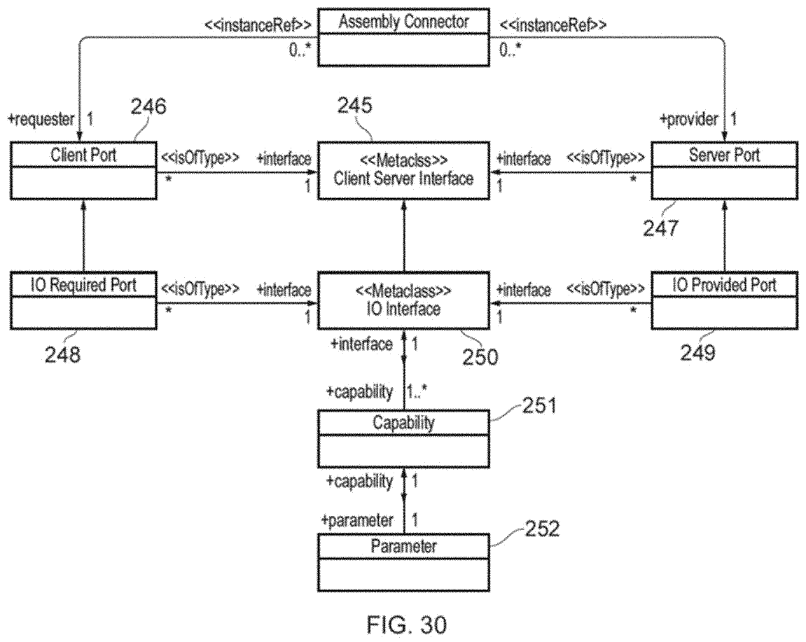

FIG. 30—a diagram of Client-Server Communication in the SWC Metamodel;

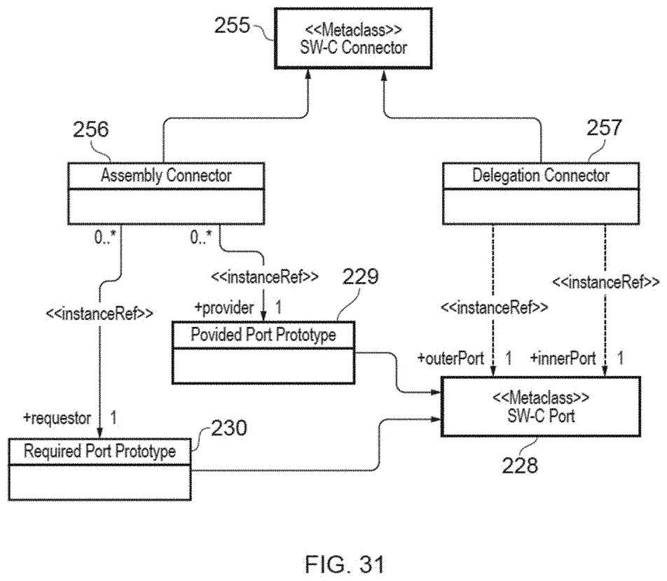

FIG. 31—a diagram of Software Component Connectors in the SWC Metamodel;

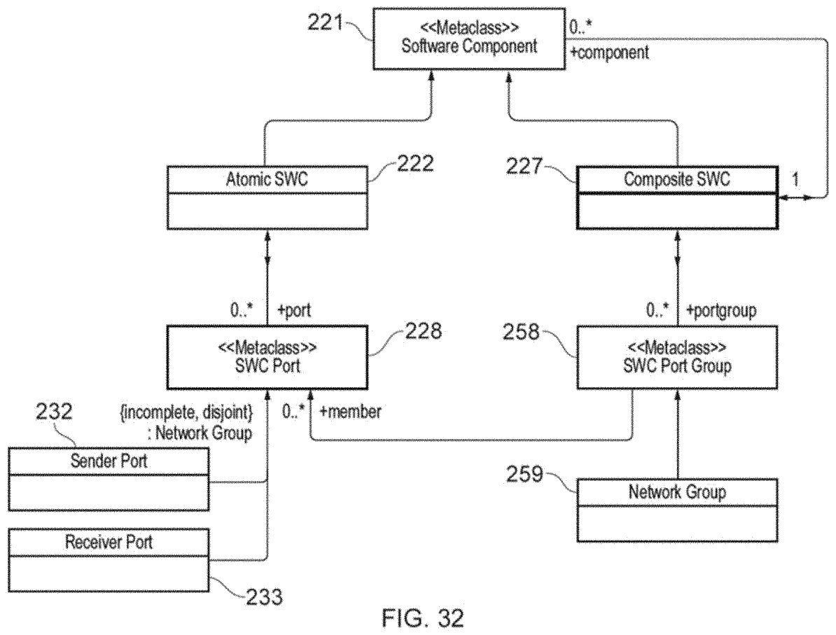

FIG. 32—a diagram of Port Groups in the SWC Metamodel;

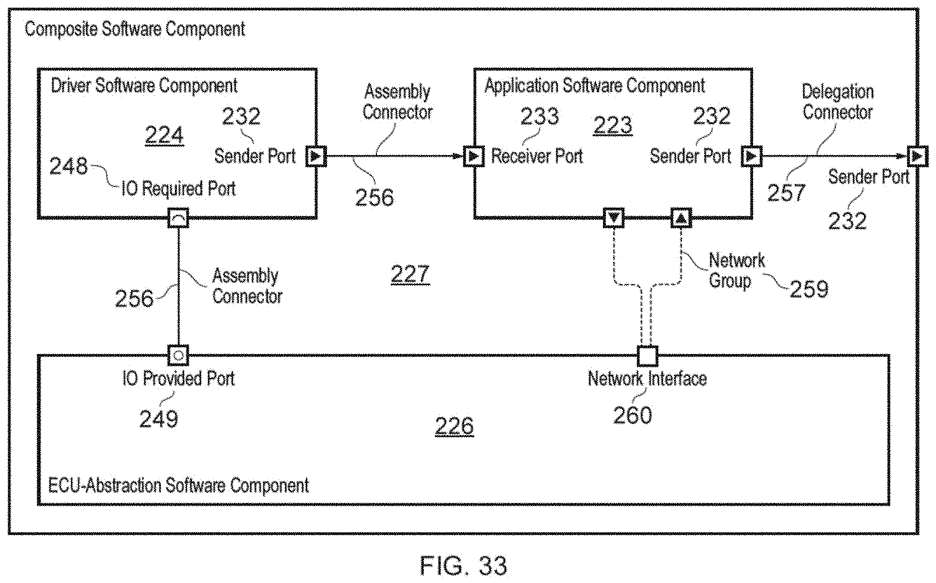

FIG. 33—a diagram of all types of SWC Ports and Connections with graphical notations;

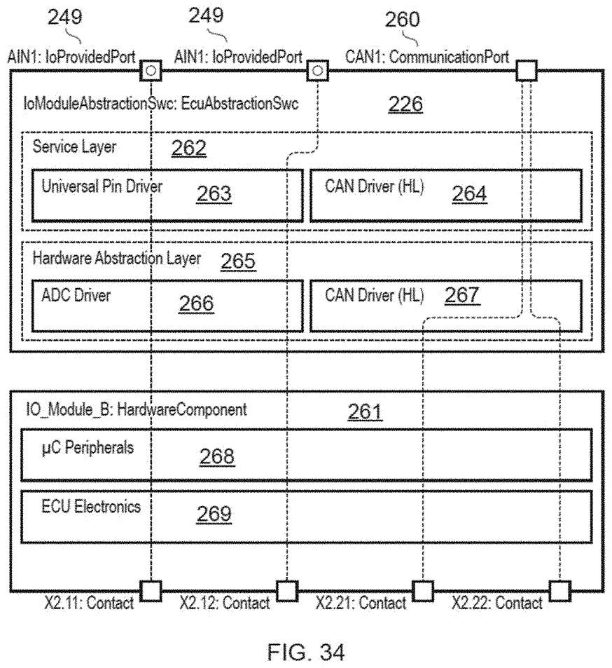

FIG. 34—a diagram of integration between an ECU-Abstraction Software Component and a Hardware Component;

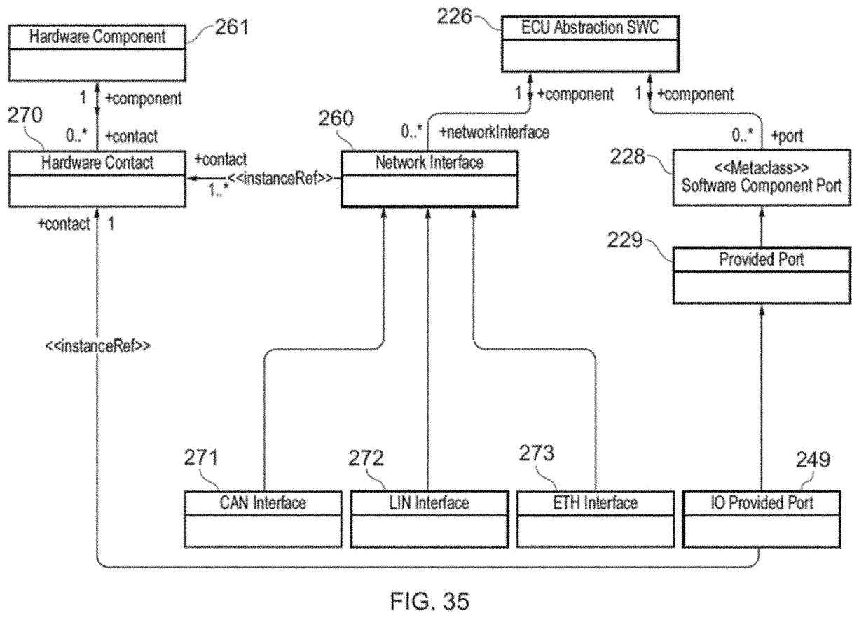

FIG. 35—a System Software and Hardware Component Metamodel;

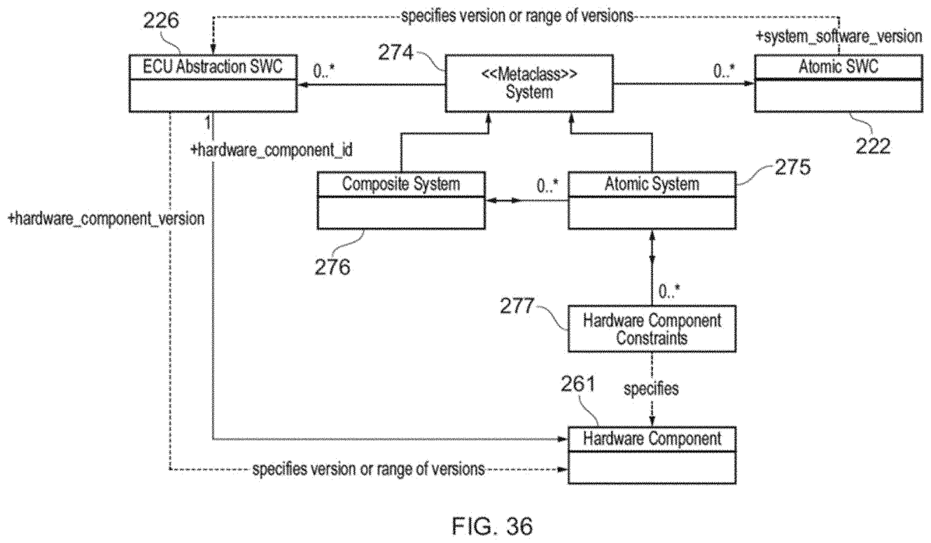

FIG. 36—a System Metamodel;

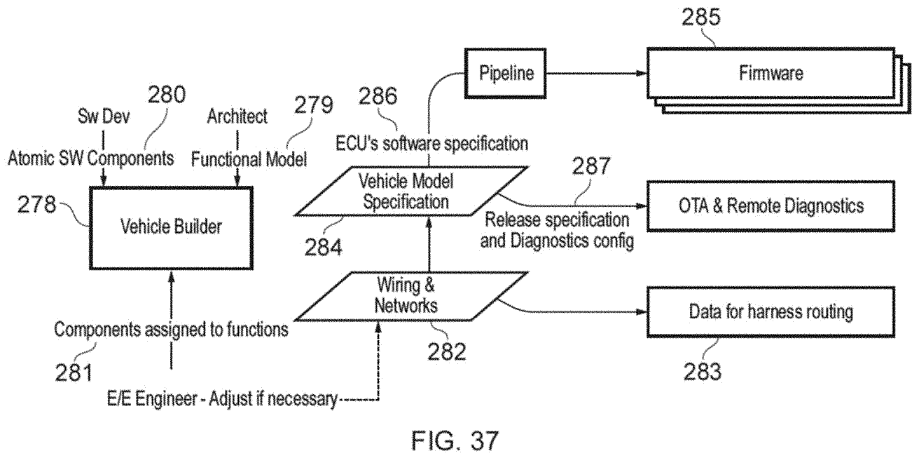

FIG. 37—a diagram of a vehicle design process with Vehicle Builder;

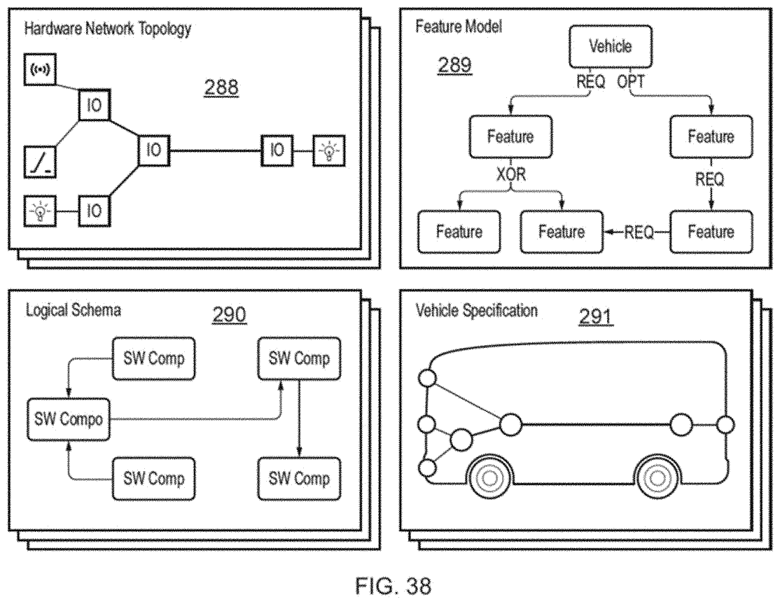

FIG. 38—a diagram of data structures obtained and used in Vehicle Builder;

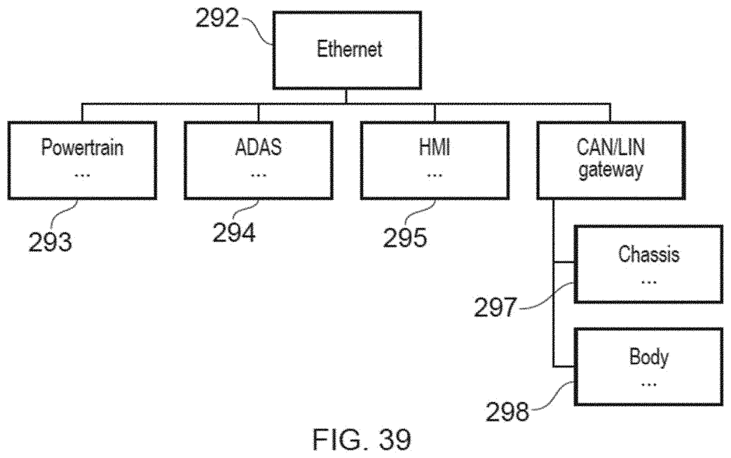

FIG. 39—a diagram of a hybrid network in a vehicle.

### DETAILED DESCRIPTION RELATING TO THIS SECTION B

Plug and Play for Vehicles

The objective of Plug and Play (PnP) Methodology is that any vehicle or product should function as was designed, the next minute after assembly. It is not possible to develop, build and test the many different variants of a vehicle that are possible once you have a fully modular set of hardware and software components. So, Arrival has created a Vehicle Builder tool (see also Section D) that enables any vehicle to be designed virtually, with selecting all desired features and functions for the vehicle, and the Vehicle Builder tool then automatically configures the hardware components, wiring, networks, software components and their allocation for the complete vehicle. This is a very complex task, conventionally solved through significant manual efforts of many developers, engineers and experts, but the Vehicle Builder is configured to construct the vehicle rapidly, automatically, and consistently.

Vehicle Builder implements several unique algorithms for the automatic creation and configuration of a vehicle, including the automatic design of the ECUs arrangement, wiring harness, networks and then the allocation of software components among the hardware of the vehicle, as described in more detail below.

Let us explain the process of designing a vehicle configuration on a simplified example with reference to the illustrations of FIGS. 18-21.

FIG. 18 is a schematic diagram illustrating a functional model of an exterior lighting feature, the model is based on Arrival's knowledge base on vehicle systems and can be used as an input for the Vehicle Builder tool to enable designing a vehicle with this feature. To this end, the Vehicle Builder tool comprises a user interface (UI) that enables a user to select and manage desired features for a vehicle. In addition, or in alternative to the latter, the Vehicle Builder can automatically add some features as recommended or required to the vehicle, after which the user can approve the feature addition or reject it.

For example, the system feature 200 “Exterior Lighting” can be selected by the user in the Vehicle Builder UI or added automatically by the Vehicle Builder tool as a default feature for the vehicle. Based on said input, the Vehicle Builder tool determines what system functions and what hardware components, among those available in the Arrival technology platform, are required to provide the feature 200 in the vehicle. In the given example, it is determined that required are Function 201 “Low Beam”, Function 202 “Low Beam Request”, two hardware components: “Headlight” 203, “Light Sensor” 204, and an ECU 205 to control the hardware components.

FIG. 19 illustrates a structural model of the system feature 200 including a software level and a hardware level. The software level comprises a set of modular software components that can be allocated on the ECU 205 to control the components 203 and 204 of the hardware level. The modular software components are a light sensor driver 206, a lights control component 207 and a headlight driver 208.

Arrival's ECU (can also be referred to as an input/output (IO) module), such as ECU 205, is one of the technological enables of the PnP Methodology. The ECU is a robust and highly integrated automotive controller with protected and reconfigurable general-purpose inputs/outputs. It provides connectivity between on-board processing systems and peripheral input/output systems.

Arrival's ECUs are also characterized by:
a grid sized form (as per the Arrival size architecture)
automotive networks communications interfaces such as Ethernet, CAN, and LIN
universal inputs/outputs (10)
analog inputs
high/low side output (e.g. 3A)
different voltage supply (e.g. 5V, 12V, and 24V)
pull up/down for sensors
robust environmental protection (e.g. IP6K9K)
proper functional safety level (e.g. ASIL-B ISO 26262)

Universal Inputs/Outputs (IO), or universal pins, of Arrival's ECUs are designed so as its functioning is defined by software.

Analog inputs of ECUs are usually used for connecting with analog sensors, for example, related to such electromechanical components as brakes and accelerator pedals.

As one can see, the configuration required for implementing the system feature 200 is not so complicated. Still, the issue is that the system configuration complexity is increased dramatically with any developments or improvements of the desired system features. Even a minor update of the lighting feature 200, like automatic daylight running lights, requires a set of software and hardware modifications to be made as illustrated in FIGS. 20 and 21.

In FIG. 20 shown is a modified structural model illustrating how the structure of FIG. 19 is to be modified in case the light sensor component 204 is located far enough from the headlight component 203 in the designed vehicle to require an additional ECU 209, for example, in a dashboard of the vehicle, for controlling the headlight component 203. In the given case, the light sensor driver 206 is allocated on the ECU 209 and a CAN bus 210 is used to enable communications between ECU 205 and the ECU 209, and thereby, between the software components 206 and 207 residing on these ECUs.

FIG. 21 illustrates another modification of the structural model shown in FIG. 19 when a stalk switch 211 is included in the designed vehicle. In the given case, the stalk switch hardware component 211 is connected to the nearby ECU 209 and corresponding software component—a stalk switch driver 211, is allocated on the same ECU 209. At that, if the existing CAN bus 210 has enough bandwidth to ensure all required inter-components communications, no new network connections are to be introduced (as it is in the illustrated example).

It will be understood by those skilled in the art that the above example is simplified for the sake of clarity showing the exterior light system feature separately and independently from any other vehicle systems and features. For a real vehicle with a variety of system features, the overall complexity of the design process and a resultant configuration is extremely high.

That is why the conventional approach to the vehicle design process requires essential manual efforts, time, and expenses to implement any changes in the vehicle configuration even in case of an update or development of one system feature of the vehicle.

In contrast to the conventional approach, the Arrival system comprises the developed knowledge base of ready-out-of-the-box vehicle systems, tested and pre-integrated with each other, and Vehicle Builder being an automated vehicle design tool that allows for simple and rapid development and modification of the vehicle design.

FIGS. 22-24 illustrate a hardware topology, software components and connections logic and a software allocation scheme that can be used for designing the exterior lighting feature 200 in Vehicle Builder.

FIG. 22 illustrates a hardware topology of the exterior lighting feature 200 in a vehicle which can serve as an input to Vehicle Builder or can be defined in Vehicle Builder. This topology corresponds to the hardware level of the structural model illustrated in FIG. 21: there are the stalk switch 211 and the light sensor 204 connected to the ECU 209, the headlight 203 connected to the ECU 205, and the CAN bus 210 connecting the ECUs 205 and 209 to each other.

FIG. 23 illustrates a logical scheme of software components or system functions, with their ports and interfaces, that can be used to control the hardware components as shown in FIG. 22 to enable providing the exterior lighting feature 200 in the designed vehicle. The scheme of FIG. 23 differs from the software components of FIG. 21 in that it comprises an additional component—an interior light manager 212A. Such logic can be defined (manually or automatically) in Vehicle Builder with the use of the libraries of modular hardware and software components, system functions and features as provide by the Arrival system.

FIG. 24 illustrates an example of software allocation and integration scheme detailing how the software components of FIG. 23 are allocated on the ECUs 205 and 209 and connected by their interfaces and ports. Automated allocation of software components on hardware components is one of the functions of Vehicle Builder. The resultant allocation scheme defines, inter alia, what part of the data exchange between the software components is conducted through vehicle networks, outside an individual ECU, i.e. through physical network bus such as the CAN bus 210. FIG. 24 further illustrates the Arrival's layered software architecture where embedded software is decomposed to the application layer 213 and the basic software layer 214.

FIGS. 22-24 show a simplified example of the use of the Arrival system, the Unified Software Architecture and Vehicle Builder for designing a Plug and Play system feature for a vehicle: once the system configuration and software allocation scheme are generated by Vehicle Builder, it creates a firmware for ECUs of the vehicle enabling the Plug and Play functionality of the vehicle. As mentioned above, the software modularity is one of the keys for automation of vehicle system design in Vehicle Builder.

Each software components designed according to the software modularity principles and the Plug and Play methodology comprises a specification in the form of meta information about related properties, functions, interfaces, resources, and requirements. For example, FIG. 25 illustrates a content of meta information 215 of a modular software component 216 comprising: complete information about hardware interfaces (or interfaces for equipment) 217, software interfaces 218, resources 219, and requirements 220.

Vehicle Builder is configured to define possible hardware and software configurations based on this meta information in an automated manner, by tailoring requirements and capabilities of the software components to the requirements and capabilities of system features, functions, ECUs, and other modular hardware components. That is possible as Arrival's modular software components are self-contained.

The Software Modularity is described in mode details below.

There are two options to implement software modularity: precompiled packages and source code packages. Both these options are used in the Arrival system, depending on the case and applicable requirements.

To this end, Arrival's unified software architecture leverages a collection of Metamodels describing Software components, including Application Software, System Software, Interfaces and Ports, Hardware Components and Systems. Said Models and principles of their creation and usage are disclosed below.

The Software Component Model is a Unified Modeling Language (UML) domain model developed for Arrival's software components within the application software layer. The domain model is an UML metamodel and it has been created with the main purpose of supporting a component-based software architecture which enables modularity, reusability, scalability and reduced dependency between hardware and software.

The Software Component Model is a definition of Arrival Software Components semantics, that is, what a software component is meant to be, the syntax of software components, how they are represented, composed, connected, and what are all the properties associated to them (ports, stereotypes, interfaces, connectors, etc.). The model is useful and meaningful as long as actual implementations of the software components conform to it.

The following nomenclature is used hereinafter (including the accompanying Figures referenced below):
SWC (or SW-C) stands for Software Component;
VFB—Virtual Functional Bus;
PPort—Provider Port,
RPort—Receiver Port,
aggr—Aggregated (used to specify if an attribute is aggregated in a meta-class);
ref—Referenced (used to specify if an attribute is referenced by a meta-class).

In the context of the component-based software architecture, a Software Component is defined as a self-contained object that encapsulates certain functionality and that can interact with its environment via defined ports and interfaces.

Software Components (SWCs) are central structural elements (basic building blocks) of the application software architecture.

SWCs are configured, by the design, to provide for the following features:
Reusability: components are designed to be atomic enough so reusability can happen across applications and product lines, for example, different vehicles and even types of vehicles.
Transferability: components can be allocated to different ECUs thanks to the hardware abstraction provided by Arrival's unified software architecture.
Scalability: common components can adapt to different vehicle platforms, so proliferation of software with similar functionality is avoided. A software component can be extended from an already existing component to provide for a new behavior or function.
Encapsulation: components do not expose any aspect of their internal behavior and only their required/provided interfaces are visible within the architecture.
Independence: components are designed to have minimal dependencies on other components so as the modularity of software is achieved.

Software Component Model

The SWC model is an UML domain-specific metamodel that contains all types of architectural elements (meta-classes) and formal relationships that are associated to Arrival's Software Components within the application software layer. All relevant metamodel class-diagrams are presented and explained in detail below.

Software Component Metaclass and Associated Stereotypes

FIG. 26 illustrates a diagram of the Software Component Metaclass. The software component metaclass represents a software component in the application layer, which is a self-contained architectural element as mentioned above.

Depending on the type of the software component within the application layer, different stereotypes are applicable to the SWC as specified in FIG. 26.

At this point, it is worth clarifying the concept of “atomic”: an atomic software component is atomic in the sense that it cannot be further decomposed and distributed across multiple ECUs. Atomic software components are characterized because they can aggregate an internal behavior (will not be applicable in the case of parameter software components).

All relevant properties associated to atomic software components (application SWC, driver SWC, parameter SWC and ECU-abstraction SWC) and composite software components metaclasses at the VBF level are specified below.

The Software Component 221 class is an abstract and “parent” class for all types of software components (atomic and non-atomic). The properties associated to the parent class will be inherited to all children.

The Software Component class has the following properties:

id (type: string)—defining a unique identifier of the software component in Arrival's Component Library.
name (type: string)—defining a human-readable name of the software component.
description (type: string)—defining a human-readable description of the software component.
repository (type: string)—defining a full path to a repository where SWC specification and source code are located.
ports (type: aggr)—defining a set of SWC Ports owned by the SWC which they can be RPorts, PPorts or both.
port groups (type: aggr)—defining port groups (a group of ports that share a common functionality, for example, specific network resources) being part of the component.

The Atomic Software Component 222 class is the parent class associated to all types of atomic software components.

The Atomic SWC class has the following property:

internal behaviour (type: string)—defining the SWC internal behaviours owned by the SWC type and located in a different physical file.

The Application Software Component 223 class is subtype of Atomic SWC 222 and is associated to an application or part of an application. The Application SWC is allowed to use all types of communication patterns (client/server, sender/receiver) with other software components.

The Application SWC class has the following property:

supporting_feature (type: string)—defining references to the vehicle features which this component supports. These features are defined in Vehicle Builder and used to automatically onboard all needed software components depending on what feature set was chosen.

A Driver Software Component 224 class is associated with an atomic component that handles specific tasks of sensors and actuators of a 3rd-party E/E Component. The driver SWC is usually located on the same ECU as the sensor/actuator it handles.

The Driver SWC class has the following property:

supporting_components (type: string)—defining references to the 3rd-party E/E Components which this driver can sense or actuate. In case when this field is empty, the driver software component is universal and can be used for different types of E/E Components or the driver is configured to work with few different types of E/E Components simultaneously.

This property field is used for automatic allocation of the driver on a specific Hardware Component in Vehicle Builder.

A parameter SWC 225 is a software component with the only task of providing values for calibrating other components. This component is atomic, but it is differentiated from the other atomic software components as it has no internal behavior associated.

An ECU-Abstraction Software Component 226 class is associated with an atomic component which provides access to ECU electronics for other types of software components. In other words, this type of SWC introduces the possibility to link from the software representation to its hardware description, abstracting the location of peripheral I/O devices and the ECU hardware layout, therefore having certain hardware dependencies.

The ECU-Abstraction Software Component type has the following properties:

hardware component id (type: ref)—defining a reference on unique identifier of Hardware Component for which this system software is dedicated.
hardware component version (type: string)—defining a range of versions of Hardware Component for which this system software is dedicated.

Multiple SWCs that are grouped and interconnected logically can be considered a composition or Composite Software Component (SWC) 227. Composite SWC 227 is a non-atomic component that abstracts a collection of atomic software components that can work together at the VFB level.

The Composite Software Component type has the following property:

components (type: aggr)—defining internal SWCs that form the composite SWC. At that, the internal SWCs can only be of types of application SWC, parameter SWC and driver SWC.

Software Component Ports and Interfaces

All interactions between software components, such as synchronous or asynchronous procedure calls, sending and receiving messages via network, are described in Arrival's software component model by “port-interface” design pattern. This pattern defines only one rule—the interfaces of two ports must be compatible to interconnect these ports between each other.

Types of ports and their interfaces are shown in FIG. 27 and described in more detail below.

A software component port (SWC port) 228 is an interaction point through which the software component communicates with its environment. Since software components are encapsulated classifiers and thus they have the ability to own ports, such port can be understood as a property of the software component metaclass. Each port instance can only be assigned to one specific software component instance.

The metamodel comprising types of ports and interfaces of the SWC model is shown in FIG. 27.

As one can see in FIG. 27, all software components ports are typed by an interface. The interface represents the type of communication (data as well as service oriented) with other software components. In order to connect software component ports, it is necessary that they are typed by the same interface. The connection between ports happens by using elements called Connectors that are described in more detail below.

Software component ports can be of two types:
Provided Port 229 which provides data or a service of a server defined in the port interface.
Required Port 230 which requests data or a service of a server defined in the port interface.

Sender-Receiver Communication

This type of communication allows for the specification of the typically asynchronous communication pattern where a sender provides data that is required by one or more receivers. This type of communication is provided by a sender-receiver interface 231.

The sender-receiver interface 231 is a part of the diagram in FIG. 27. More details of sender-receiver communication are shown in FIG. 28 comprising a separate diagram of types of a sender-receiver interface 231.

A sender port 232 is a sub-type of the provider port 229 prototype and is associated with ports which are typed by the sender-receiver interface 231.

The sender port 232 type has the following properties:

id (type: string)—defining a unique identifier of the port in software component scope.
name (type: string)—defining a human-readable name of the software component.
port_interface (type: ref)—defining the port interface used to type the port prototype; it can be a client/server interface, a sender/receiver interface, or a parameter interface. Such interfaces are used to interconnect compatible ports only.
connectors (type: ref)—defining connectors connecting this port to other SWC ports; it can be assembly connectors (PPort to RPort) or delegation connectors (PPort to PPort).

A receiver port 233 is a sub-type of required port 230 prototype and is associated with ports which are typed by the sender-receiver interface 231.

The receiver port 233 type has the following properties:

id (type: string)—defining a unique identifier of the port in software component scope.
name (type: string)—defining a human-readable name of the software component.
port_interface (type: ref)—defining the port interface used to type the port prototype; it can be a client/server interface, a sender/receiver interface, or a parameter interface. Such interfaces are used to interconnect compatible ports only.
connectors (type: ref)—defining connectors connecting this port to other SWC ports; it can be assembly connectors (PPort to RPort) or delegation connectors (PPort to PPort).

A sender receiver interface 231 is the one used in the case of sender-receiver communication. This type of interface allows for the specification of the typically asynchronous communication pattern where a sender provides data that is required by one or more receivers.

The sender receiver port interface 231 type has the following property:

message (type: ref)—defining a message declared by the interface to be sent or received.

The sender receiver interface will formally specify the kind of information that is sent and received, the type of data element can be practically anything (integer, complex array, string, etc.). This interface is used for data exchange between software components, specially, in the case of senders needing to send information to an arbitrary number of receivers. Receivers have complete freedom on when and how to use the data-elements provided by the senders and they do not inform about the information being used. The idea behind this is that each data element that is sent/received within software components (mostly between application SWCs) will have a physical network signal associated with it.

The sender is completely decoupled from any receivers and it is not aware of how many (if any) receivers are using the values it is producing. The way senders provide data-elements can vary, the approach of “last-is-best” can be taken meaning that the last value made available by the sender is the current one or another option is the “queued” approach in which values are stored in a queue of predefined size.

As shown in FIG. 28, a message 234 metaclass can be typed by three types of messages: Local Interconnect Network (LIN) message 235, CAN Message 236 and Ethernet (ETH) message 237.

The only on way to interconnect two ports between each other, is to make a Connector, such as Assembly connector 238 between sender and receiver ports which identifiers are identical and internal message is the same.

A diagram in FIG. 29 illustrates a correct n:1 communication case, i.e. the case where the same data-elements are provided by two different software components, while are required by one receiver (n:1). In the illustrated case, the Exterior Light manager (ExteriorLightManager) 239 (an application SWC) obtains a state of front and rear indicators on different ports—FIndStatus 240 and RIndStatus 241 respectively. Based on these states a command, IndCmd 242, to switch on/off specific indicators—a front indicator controlled by a FrontIndicatorDriver 243 or a rear indicator controlled by a RearIndicatorDriver 244 (both are driver SWCs) can be composed by the Exterior Light manager 239 the in a correct way.

Client-Server Communication

A Client-Server Interface 245 is the one used in the case of client-server communication and declares a number of operations that can be invoked on a server by a client (instead of information to be transferred among software components like in the case of sender-receiver interface).

The client initiates the communication, requesting the server to perform a specific service (operation call) and this triggers the server to execute the required operation (the server will never start an operation on its own). Once the operation has been executed, the server provides the client with the result (synchronous operation call) or else the client checks for the completion of the operation by itself (asynchronous operation call).

The client-server interface 245 is a part of the diagram in FIG. 27, and FIG. 30 further illustrates this interface in more detail showing a separate diagram of the metamodel which is used to describe the client-server communication.

As shown, the client-server interface 245 operates between a client port 246 and a server port 247. In Arrival’ meta-model these types of ports are used to describe communication between a Driver SWC and an ECU-Abstraction SWC. Because of that the client port 246 is specified as an IO Required Port 248 and the server port 247 is specified as an IO Provided Port 249.

The IO Required Port 248 class is a sub-type of Required Port 230 Prototype typed by an IO Interface 250.

The IO Required Port type has the following properties:

id (type: string)—defining a unique identifier of the port between all receiver ports of all software components in the library.
name (type: string)—defining a human-readable name of the port; the name is used to distinguish ports during modeling process in Vehicle Builder.
port_interface (type: ref)—defining the port interface used to type the port prototype; it can be a client/server interface or its sub-types. Such interfaces are used to interconnect compatible ports only.

The IO Provided Port 249 class is a sub-type of Provider Port 229 Prototype typed by the IO Interface 250.

The IO Provided Port type has the following properties, similar to the IO Required Port type:

id (type: string)—defining a unique identifier of the port between all receiver ports of all software components in the library.
name (type: string)—defining a human-readable name of the port; the name is used to distinguish ports during modeling process in Vehicle Builder.
port_interface (type: ref)—defining the port interface used to type the port prototype; it can be a client/server interface or its sub-types. Such interfaces are used to interconnect compatible ports only.

The IO Interface 250 class is a sub-type of Client-Server Interface 245 and is associated with a set of capabilities which port provides or requires.

Application software is configured to initiate a communication, requesting the system software to provide specific capabilities and this triggers the server to execute a required operation. For example, when an application software (an application SWC) needs access to an analog input/output (IO) interface, a system software (a universal IO Driver) provides capabilities to access a specific hardware contact. Such case is defined by two ports—the first one is the IO Required Port 248 from the side of an Application SWC, the second one is the IO Provided Port 249 from the side of an ECU-Abstraction SWC, and a connection between them which can be established only if these ports have compatible interfaces. In other words, the capabilities which the IO Provided Port provides must be exceeding or equal to the capabilities which the IO Required Port requires.

The IO Interface 250 type has the following properties:

capabilities (type: aggr)—defining what kind of capabilities 251 a port provides or requires.
capabilities[i].parameters (type: aggr)—defining parameters 252 (if they exist) of each of the capabilities 251 associated to the IO interface.

Calibration Data Communication

A parameter interface 253 can only be owned by a parameter software component 225 type and it does not establish real transmission of data, but it exposes the concept of a software component accessing fixed, constant, calibration data.

The parameter port interface type has the following properties:

name (type: string)—defining a name of the parameter interface.
parameterDataElement (type: ref)—defining the data element(s) (calibration data) provided by the interface to calibrate other SWCs.

The parameter interface 253 is always provided by a parameter SWC and it can be required by either an application SWC, a composite SWC or a sensor-actuator SWC.

A parameter port 254 is a sub-type of Provider Port Prototype 229 typed by a parameter interface and owned by a parameter SWC.

The parameter port has the following properties:

name (type: string)—defining a name of the port.
portInterface (type: ref)—defining a name of the parameter interface that types the parameter port.
connectors (type: ref)—defining connectors connecting this port to other SWC ports; they can be assembly connectors (PPort to RPort) or delegation connectors (PPort to PPort).

Software Component Connectors

Software Component Connector 255 class is associated with an element which is used to connect RPorts 230 and PPorts 229 between software components or to symbolize software compositions. A diagram of the SWC Connector metaclass is presented in FIG. 31.

There are two different types of SWC connectors—Assembly Connector 256 and Delegation Connector 257. The Assembly Connector 256 is used to describe connections between RPorts 230 and PPorts 229, and the Delegation Connector 257 is used to expose the SWC Port to outside a software components composition.

The Assembly Connector 256 class is associated with an element which is used to connect RPorts and PPorts that are typed by the same port interface.

The Assembly Connector type has the following properties:

provider (type: ref)—defining a reference to an instance of the providing port.
requester (type: ref)—defining a reference to an instance of the requiring port.

The Delegation Connector 257 class is associated with an element which is used to expose inner software component ports to the external interface of a composite software component. A delegation connector can only connect ports of the same kind (PPort and PPort, or RPort and RPort).

The Delegation Connector type has the following properties:

innerPort (type: ref)—defining a reference to the SWC port that belongs to the inner SWC in the composite SWC.
outerPort (type: ref)—defining a reference to the SWC port that is exposed and located outside of the composite SWC.

Software Component Port Groups

The software component port groups define a logical grouping of port prototypes which is used as input to configure the system software layer for providing ECU resources for these ports. Such port group is defined locally in a composite software component and refers to the “outer” ports belonging to embedded components. FIG. 32 illustrates a port groups model.

The main use case for SWC port groups 258 is to express the required communication resources for ports which are included in the group, for example, SWC ports 228.

A Network Group 259 class represents the usage of an access to a single network for all Sender Ports 232 and/or Receiver Ports 233 which are included in this group. This information shall be available for Vehicle Builder on an SWC firmware assembling phase in order to allocate required ECU resources for specific group of ports. When this information is propagated into the ECU Configuration file, it is used as an input for the configuration of the ECU-abstraction layer in the system software.

The Network group type has the following properties:

id (type: string)—defining a unique identifier of the group between all groups which are defined in the Composition SWC.
Members (type: aggr)—defining a set of references to outer ports of the embedded components which are related to this group.
network interface (type: ref)—defining a reference to specific Network Interface which is defined in an embedded ECU-Abstraction SWC to provide an access to the network resources.

FIG. 33 illustrates all types of software component ports and connections using special graphical notations.

In FIG. 33, Software Components are depicted by rectangles with solid boundaries, with an identifier of each component located inside the software component boundary. SWC Ports are depicted by specific icons which are placed on the software component boundary, each port identifier is located inside the software component boundary. A connection between Sender Port 232 and Receiver Port 233 is depicted by solid line with an arrowhead directed from the sender towards the receiver, this is due to “broadcast” nature of communication between software components (usually one-directional). The connection between IO Required Port 248 and IO Provided Port 249 is depicted by solid line without an arrowhead, such connections are used between Driver SWC 224 and ECU-Abstraction SWC 226 to illustrate Universal Pin Driver call from the application layer. The delegation connection 257 is used to expose Sender Ports 232 or Receiver Ports 233 of embedded software components outside the ECU boundaries.

A Network Interface 260 is depicted by specific icon which is placed on the ECU-Abstraction SWC 226 boundary. In case when Sender Ports 232 or Receiver Ports 233 are included in a specific Network Group 259 to obtain an access to a specific network, these ports are connected by dashed line with the corresponding Network Interface 260.

With the above, a software architecture that realizes a system feature can be modeled in the Vehicle Builder tool using the SWC UML Metamodel, including a definition of all required SWCs and the communications between them via proper interfaces. At that, each software component port is typed by a specific interface with the definition of all required attributes of the interface.

Hardware level Components can be described with similar domain model to enable vertical integration between Application Software, System Software and Hardware Layer. The metamodel of Hardware Component and format of Hardware Component specification are described in more detail below.

Compatibility between Application and System Software can be described as one-to-one relationship. It means that, for example, Application SWC with version A.B.C can only compatible with System Software with version X.Y.Z. The manifest of compatible System Software is presented in meta-information section of Application SWC. This ensures unambiguous matching between versions of Application and System Software.

Dependency between System Software and Hardware Components is described as follows.

The system software layer consists of two parts—the first part is generic set of system software libraries and the second one is specific system software components that provide an abstraction of hardware component resources access for the application layer. The first part is described in a dependency file of Application SWC. The second part is published as a set of ECU-Abstraction Software Components with the same version as System Software pack—X.Y.Z for each supported Hardware Component.

The integration example between an ECU-Abstraction Software Component and a Hardware Component is schematically illustrated in FIG. 34 using the graphical notations of FIG. 33.

In FIG. 34, the ECU-Abstraction Software Component 226 has ID ‘IoModuleAbstractionSwc’, and the Hardware Component 261 has ID ‘IO_Module_B’.

The ECU-Abstraction Software Component 226 comprises a Service Layer 262 consisting of two SWCs, Universal Pin Driver 263 and CAN Driver (HL) 264, and a Hardware Abstraction Layer 265 consisting of two SWCs, ADC Driver 266 and CAN Driver (LL) 267.

The Hardware Component 261 comprises two components, mC Peripherals 268 and ECU Electronics 269 and four physical contacts X2.11, X2.12, X2.21 and X.2.22.

Each of the physical contacts X2.11 and X2.12 is included into a connection to form an IO Provided Port (AIN1) 248 with the use of the ECU Electronics 269, mC Peripherals 268, ADC Driver 266 and Universal Pin Driver 263.

The two physical contacts X2.21 and X.2.22 are a part of a Network Interface (CAN1) 260 that uses the ECU Electronics 269, mC Peripherals 268, CAN Driver (LL) 267 and CAN Driver (HL) 264.

One version of System Software can be compatible with different versions of components of the same type. In the context of the above example, the ECU-Abstraction Software Component 226 with ID=‘IoModuleAbstractionSwc’ and version=‘0.18.0.0’ can be compatible with Hardware Components 261 having ID=‘IoModule’ and versions in a range of ‘>0.4.1<=0.4.3’.

In some cases, it can be required to directly specify what kind of Hardware Component(s) can be used for deployment. It can be specified by setting constraints for Hardware Component selection during a software allocation procedure. Such constraints can be defined by key-value pair and matching operation—equal or not-equal.

System Software and Hardware Component Metamodel

The System Software and Hardware Component model contains metaclasses and associated stereotypes to describe the ECU-Abstraction Software Component, the Hardware Component and their relationships.

The System Software and Hardware Component metamodel is illustrated in FIG. 35. The ECU-Abstraction SWC 226, the IO Provided Port 249 classes are described above.

Network Interface 260 abstract class describes an access to the network resources. The Network Interface type has the following properties:

id (type: string)—defining a unique identifier of the Network Interface in this ECU-Abstraction Software Component.
name (type: string)—defining a human-readable name of the interface, which is used to distinguish interfaces during modeling phase in Vehicle Builder.

This abstract class is implemented by specific classes depending on type of network which this interface is used for.

Further, CAN Interface 271 class describes an access to CAN networks. LIN Interface 272 class describes an access to LIN networks, and Ethernet (ETH) Interface 273 class describes an access to Ethernet networks.

Hardware Component 261 class describes electric/electronic (E/E) container which can be used for control software deployment or can be used as peripheral device which is sensed or actuated by a Driver Software Component on an ECU. The hardware component type has such properties as id, name, and version, all are of the string type.

Hardware Contact 270 class describes a physical contact and has such properties as id, name, and type, all are of the string type.

System Model

FIG. 36 shows a diagram that represents a formal entity model of a Composite System.

As one can see, the composite system model comprises elements being entities from other models including the Software Component Metamodel and Hardware Component Metamodel described above.

In Arrival system, a system specification is produced based on the model as shown in FIG. 36.

The System 274 is a basic entity type which exists to generalize the properties of Atomic System 275 and Composite System 276 sub-types. It can also be a basis for other sub-types that may be developed in the future within the Arrival system and model.

The System itself is characterized as a collection of tightly linked constituent atomic components, whether they originate from software or hardware domain. The System covers a very specific and well-defined set of system functions belonging to a specific functional area of Arrival's vehicle, such as Low Voltage operations, Vehicle State, Connected Vehicle etc. Arrival's vehicles comprise such systems as HMI, Drivetrain, High Voltage Power. A System Library contains all the systems developed by Arrival.

The concept of a System 274 within Arrival Vehicle Platform reflects the fact that Systems are the entities that compose a vehicle platform, and they are the key deliverables of Arrival Technology. The system metamodel is designed to fit the system development into the concept of feature driven development provided by Arrival's Plug and Play Methodology.

One foundational property of a System 274 is that a system is subject to release procedures, and all its constituent parts get released along with the System they comprise. The driver for the new system release is a feature as a carrier of new set of system requirements.

The system 274 metaclass has the following properties:

id (type: string)—defining a unique identifier of the system in the System Library.
name (type: string)—defining a human-readable name of the system, such as “Drivetrain System”.
description (type: string)—defining a human-readable description of the system.
repository (type: string)—defining a valid link to Software Version Control system; the full path to the repository where System Specification is located.
version (type: string)—defining a version of the system this specification describes.
software components (type: aggr)—defining a collection of “Software Component” entities. Software Components that “belong” to this system as its constituent parts. Release cycle of these Software Components is strongly coupled with release cycle of the system, meaning that new versions of such Software Components may only appear with new release of the system.
assembly connectors (type: aggr)—defining a collection of “Assembly Connector” entities to define logical connections between Sender/Receiver ports of SW Components within the system.
hardware component constraints (type: ref)—defining an embedded structure that describes the allocation constraints this Atomic System has towards the hardware platform.
references (type: aggr)—defining a set of external references on entities from other models.

Atomic System 275 is subtype of the System 274 type, introduced to describe:
Monolithic Arrival systems that do not have clearly defined component schema allowing for flexible allocation into multiple ECU as a firmware. This is possible as the software has been built to function on special-purpose hardware boards, which in turn require purpose-built basic software to provide APIs to hardware capabilities.
3rd-party monolithic Systems.

Many types of constraints apply to atomic systems, yet the modelling aspect of the atomic system shall:
clearly define the external interfaces of such monolithic systems.
describe it as a single entity occupying the entire hardware device it is designed to be hosted at.

The generic way to model an Atomic System 275 is to describe it via two software components: an Application SWC 223 and ECU Abstraction SWC 226, thus modelling the functional software layer and the basic software layer of the atomic system. Application SWC in turn should have Hardware Component Constraints 277 defined which clearly point to a hardware platform that supports this Atomic System.

The atomic system 275 class has the following property:

Address (type: string)—defining a network address of the atomic system, for example, via a CAN node address.

Hardware Component Constraints 277 allow to specify the selection criteria of a hardware platform for an Atomic System 275. They can be described in a way to allow placement at multiple compatible hardware platforms or just point to certain hardware product by containing a reference to a particular part number.

Composite system 276 is another sub-type of a System 274 type that describes groups of more loosely coupled Software Components, commonly featuring a unified release cycle. A Composite System consists of zero or more Atomic Software Components 222, Assembly Connectors 256 between them, and Atomic Systems 275.

The composite system 276 class has the following property:

atomic systems (type: aggr)—a collection of “Atomic System” entities; it must be present if the composite system does not refer to at least one Software Component. All referred atomic systems are constituent parts of the composite system.

Every System in Arrival's System Library has a System specification comprises a complete information of the system, all its parts, components and etc, defined in accordance with the metamodels described above.

In addition, the system specification has the following characteristics:
The content of the model adheres to the Composite System model.
The system specification is located at the path specified in its “repository” property.
If the “repository” property contains the path to a directory, the directory shall contain the only one file of the specification.

The aforesaid discloses Metamodels developed within the Arrival System to enable the Unified Software Architecture with the software modularity which further serves as a basis for the Plug and Play functionality of Arrival's vehicles and products.

Plug and Play and Vehicle Builder

The Plug and Play (PnP) Methodology as itself is a combination of architectural principles and approaches adopted in the Arrival system.

Unified Exchange Formats are important element of the ATP and the Unified software architecture contributing to the PnP Methodology implementation. The standardisation of exchange formats within the Arrival system allows to integrate all the tools into a single tool chain for PnP process automatization. So, all descriptions, specifications, and meta information in the Arrival system have the unified formats that inter alia apply to descriptions of Basic Software, SWCs, System Features, ECU configurations and the whole vehicle specifications.

The PnP Methodology is further based on the layered software architecture as described above.

In ATP, the application software layer of the Electrical/Electronic (E/E) architecture is a collection of loosely coupled and highly cohesive modular software components. A loosely coupled architecture implies limited dependencies between software components that allow for relocation of software components on different ECUs without changing the system design. Likewise, a highly cohesive architecture limits the individual responsibilities of a module—an individual software component will typically perform a small set of tasks.

As for the basic software layer, this layer provides ability to develop the application software of the E/E architecture completely hardware independent.

With the unified, layered software architecture in the Arrival system provided is a unified interface for the application software to access electrical values of underlying ECUs, including:
Functionality of virtual communication bus
Metadata for real-time allocation of software components
Services to ensure the data storage and maintenance of non-volatile data
Functionality and data for the diagnosis of each ECU
Functionality and data for the validation of vehicle systems
Functionality for cryptographical authentication of the signal values in transmitted data packets.

All the above is used and adopted in Vehicle Builder that is a single, automated tool to design automotive configurations for a vehicle according to input requirements. Vehicle Builder provides for designing an overall E/E architecture of a vehicle in an automated manner design and further allows to validate consistency of the designed E/E architecture and even to facilitate diagnostics of the vehicle in future use.

FIG. 37 illustrates a vehicle design process with Vehicle Builder 278.

At the first step of the design process, Vehicle Builder receives, as an input, a set of desired system features for a designed vehicle that can be defined by a user, such as a customer, a designer, or an engineer, for example, by selecting available options through a User Interface (UI) of Vehicle Builder. In addition, or in alternative to the user-defined set of system features, Vehicle Builder is configured to add to the configuration certain system features as default options, for example, if they are required for proper functioning of the designed vehicle or included into a base vehicle configuration.

Also, as shown in FIG. 37, Vehicle Builder can be provided with functional models 279 of the desired system features, provided by a system architect. However, this is an optional input as Vehicle Builder is able to access a Functions Library of system functions developed within ATP and automatically match the desired system features with the available system functions. In this way, Vehicle Builder is configured to automatically select the required system functions for providing the desired features in the vehicle and obtain or generate the required functional models of the selected system functions.

Similarly, Vehicle Builder can be provided with a set of Atomic SWCs 280 and Hardware components 281 assigned with the required system functions to enable providing the desired system features. These are also optional inputs as Vehicle Builder is able to access a Software Library of modular SWCs and a Component Library of hardware components within ATP to automatically obtain the required SWCs and hardware components for implementing the required system functions.

Based on the desired system features, related system functions, software and hardware components, including functional models, Vehicle Builder automatically generates, with the use of an Auto Wiring tool and algorithm:
a hardware and network topology of a vehicle including an optimized wiring scheme, and
an optimized allocation scheme of SWCs on ECUs of the vehicle.

The Auto Wiring tool and algorithm are described in more detail below.

The generated configurations 282 of hardware, ECUs, networks and SWC allocation can then be approved or edited by the user through Vehicle Builder's UI. Modifications to the generated configurations can be introduced by the user either directly, when the user manually changes the hardware configuration or modifies the software selection or allocation, or through modifications of any input data or involved constraints and requirements to enable a new cycle of the automated design process by the Auto Wiring tool.

Further, after the approval of the said configurations, Vehicle Builder is configured to generate:
data for harness routing 283 in accordance with the wiring scheme,
a vehicle model specification 284, and
a firmware 285 for the vehicle model.

The vehicle model specification includes a ECUs software specification 286 based on the software allocation scheme and specifications of the involved SWCs.

Further, based on the vehicle model specification, Vehicle Builder generates and outputs a Release specification and Diagnostics configuration 287 that enable an automated validation of the vehicle model systems as designed with an over-the-air (OTA) release of the firmware as validated to produced vehicles of this vehicle model. Furthermore, the Diagnostics configuration enables an automated configuration of a remote diagnostic system for conducting remote diagnostics of vehicles of this model during use.

The above is enabled by the complete information about vehicle systems and components available in ATP because of the use of the modular hardware, the unified software architecture with the software modularity, the unified exchange formats and other tools and principles of the Plug and Play Methodology.

FIG. 38 schematically illustrates data structures that are obtained and used in Vehicle Builder during the vehicle design process. The hardware and network topology 288 provides an information on what hardware components, including ECUs, are to be used in the designed vehicle model, including connections between them. The feature model 289 describes all the system features to be implemented in the vehicle model and their interconnections. The logical schema 290 (or functional model) comprises an information about software components required to implement system functions inherited from the feature model and connections (interfaces and ports) between the software components. On the basis of these data structures, processed in combination, and the ATP Libraries including Functions Library, Software Library and Components Library, Vehicle Builder generates a vehicle model specification 291 that can be used for a vehicle production.

As follows from the aforesaid, the automated vehicle design process in Vehicle Builder provides for Plug and Play functionality of Arrival vehicles. Vehicle Builder, based on the modularity and unification of all components and procedures within the Arrival system, automatically provides, already on the stage of designing a vehicle model:
a complete vehicle model specification,
an optimized hardware/network topology and wiring for the vehicle model (including full data for harness routing for the vehicle production),
a firmware for all ECUs ready to be installed to vehicles of this model, and
a full bundle of data and configurations for validation and diagnostics of all vehicle systems and components.

This directly provide for the Plug and Play functionality of Arrival's vehicles. More detailed disclosure of the design process in Vehicle Builder, including a description of the auto wiring tool and algorithm, is provided in Section D below.

As for the Plug and Play theme, we need to further disclose how the common communication aspect is achieved in Arrival's vehicles.

Common Communication: Ethernet

In the Arrival system, Ethernet is the backbone; adopting Ethernet is a key enabler for reliable and cost-effective Plug and Play solutions.

Legacy bus systems have reached their capacity limits and a new consolidated future-proof solution is needed. The Ethernet networking standard has been widely adopted as the networking technology of choice for the IT and telecoms sector and consumer electronic markets, and it has experienced significant adoption in industrial engineering and in the aerospace industry. Ethernet and the internet protocol (IP) are mature technologies with very high production volumes throughout the IT industry. Ethernet offers the high bandwidth required to support the powerful computing and burgeoning data transfer needs of modern vehicles, providing a reliable basis for future automotive innovations.

Ethernet offers significant opportunity for building powerful, flexible, modular, cost effective vehicle systems, which are scalable without changing fundamental communication paradigms. The increased bandwidth opens creativity for new applications being future-proof.

Adopting Ethernet as the communication backbone of Arrival vehicles makes available commercial off the shelf (COTS) products from other mature sectors, and opens a suddenly large number of existing protocols, technologies, applications and suppliers available, offering an independence and freedom of choice largely unavailable to conventional automotive OEMs.

Whilst Ethernet is a mature and proven technology in IT and telecoms, it is relatively new in the automotive sector which has more stringent requirements for safety. The majority of automotive OEMs are already using Ethernet within vehicles only for non-safety-critical applications such as diagnostics and entertainment. There do not exist any vehicles on the road which exclusively use Ethernet (with no CAN/LIN).

In contrast with the conventional approach, the ultimate target of the Arrival system is to use Ethernet for the entire Arrival's vehicle wiring system—from infotainment through to safety critical functions. Alternatively, Arrival's vehicles can use a hybrid of Ethernet at the core and existing network protocols towards the periphery, connected via gateways.

FIG. 39 illustrate a schematic diagram of a possible hybrid network solution for a vehicle. In the illustrated example, Ethernet is a main bus used by evolved vehicle systems, such as a powertrain system 293, an advanced driver-assistance system (ADAS) 294 and humane-machine interface system 295, that require high-speed network communications. Further the illustrated vehicle network comprises a CAN/LIN gateway 296 for connecting Ethernet with CAN bus or LIN bus used by other vehicle systems with less network requirements, such as vehicle chassis 297 and vehicle body 298.

Ethernet is future proof; flexible and its high bandwidth opens creativity for new applications. It is scalable without changing fundamental communication paradigms. It is common and enables the Arrival system to use the same protocol for vehicles as with Arrival robotic factories, production equipment and AMRs as well as to use the same protocol for in-vehicle, vehicle to vehicle, and outside the vehicle communications. This common communication basis provides for further benefits and advantages, for example, allows Arrival's vehicles communicating with an operations control system (OCS) in Arrival's robotic factories so as to report the status of the vehicle production to the OCS, or to receive and implements instructions from the OCS such as to move autonomously from a production zone to a storage area when the vehicle production is completed.

Section C: The Arrival Cyber Security System

Introduction to this Section C

Following Plug and Play principles embodied in the Arrival vehicles and components as described in Section B, once an Arrival component is plugged into an Arrival vehicle or product, it will start functioning easily and automatically without configuration or modification of the existing system. At that, cyber security requirements might be conflicting with the task of providing Plug and Play functionality for vehicle components.

Indeed, modern vehicles are cyber-physical systems, i.e. engineered systems that are built from, and depend upon, the seamless integration of computational algorithms and physical components, and cyber security vulnerabilities could impact safety of life of the vehicle's user and other people.

Multiple authorities and regulations all over the world cover vehicle cyber security to ensure that systems are designed free of unreasonable risks to vehicle safety, including those that may result due to existence of potential cyber security vulnerabilities. It is thereby required to continuously enhance vehicle cyber security to mitigate cyber threats that could present unreasonable safety risks to the public or compromise sensitive information such as consumers' personal data.

Conventional approach to cyber security of a vehicle is based on that a vehicle network is treated as a trusted environment, whilst everything outside the vehicle is treated as untrusted, risky environment where potential threats originate from.

The Arrival system, instead, treats the vehicle network as untrusted one. Thereby, all communications between components using the vehicle network are encrypted, and vehicle components do not accept commands from other vehicle components without verification or authentication. As a result, Arrival's vehicles and vehicle components are secured and prevented from an unauthorized use, and personal data as well as valuable analytics or diagnostics data of the vehicle are prevented from an unauthorized access.

Arrival's unique approach to cyber security of vehicles and vehicle components as described in more detail below.

### BRIEF SUMMARY OF THE FIGURES RELATING TO THIS SECTION C

Some features, implementations and examples of the following disclosure are illustrated in the accompanying figures, in which:

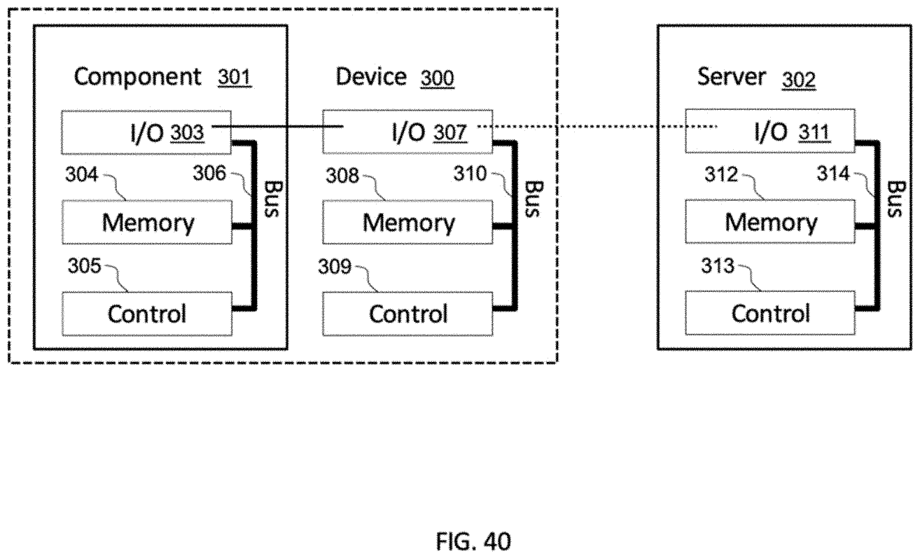

FIG. 40—is a schematic of a connected system including a device, an internal component of the device and a remote server.

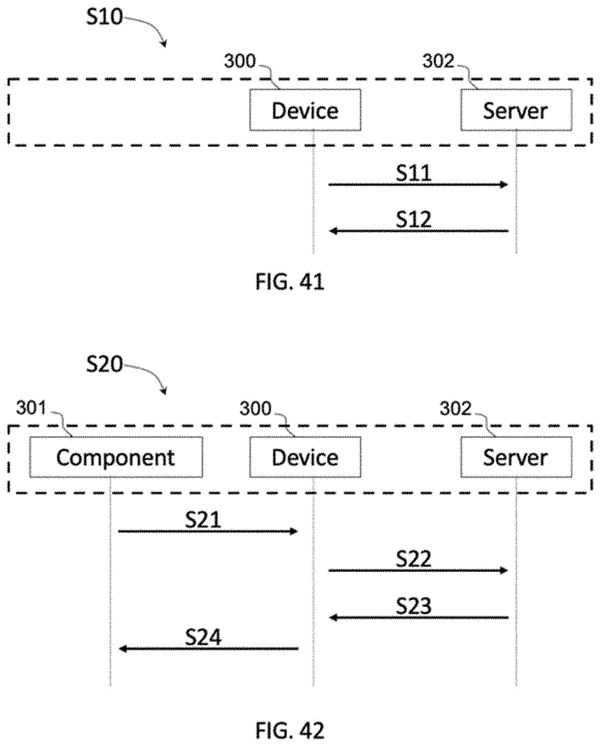

FIG. 41—is a diagram of a communication method to establish whether the device is authorized by the server.

FIG. 42—is a diagram of a communication method to establish whether the device is authorized to use the component.

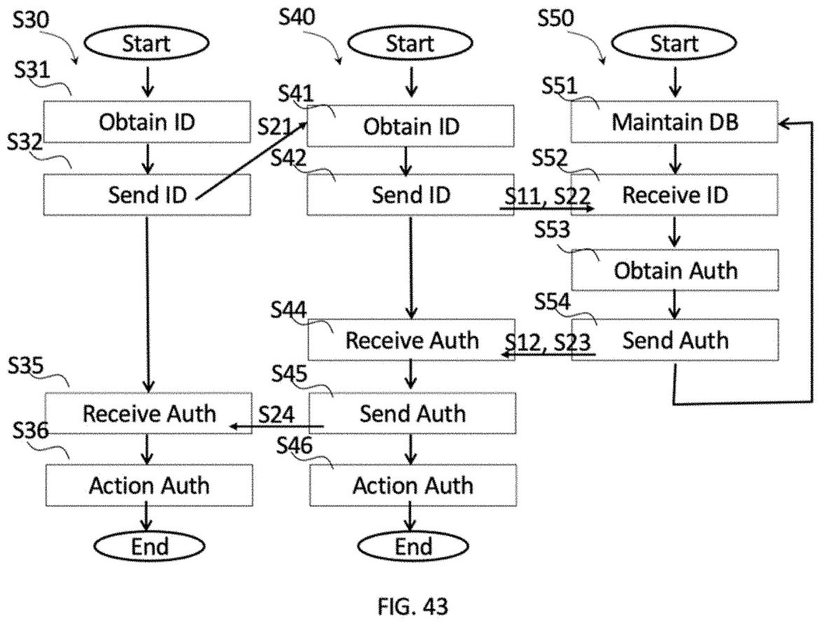

FIG. 43—is a diagram of a full authentication method with the device, the component, and the server.

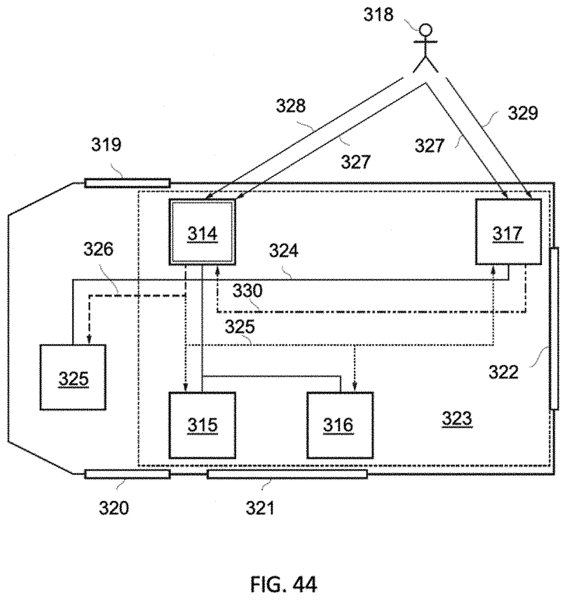

FIG. 44—is a diagram of a Secure Touch Points (STP) network topology.

### DETAILED DESCRIPTION RELATING TO THIS SECTION C

Let us begin with generic security measures applicable to all Arrival's products, vehicles, and components.

Generic Security Measures in a Connected System

A device 300 (for example, a vehicle) is a member of a connected system. The device 300 includes a plurality of hardware electrical or electronical components 301 (or simply—components). FIG. 40 illustrates a hardware topology that facilitates registration of an electrical component 301 by the device 300. Each component 301 is configured to communicate with the device 300 (e.g. vehicle). The server 302, for example the one provided by a cloud service, is configured to communicate with the device 300.

The component 301, the device 300, and the server 302 have corresponding architectures that facilitate their communication. The component 301 comprises an input/output unit (I/O) 303, a memory 304, and a control 305, each of which is configured to communicate via a bus 306. The device 300 comprises an input/output unit (I/O) 307, a memory 308, and a control 309, each of which is configured to communicate via a bus 310. The server 302 comprises an input/output unit (I/O) 311, a memory 312, and a control 313, each of which is configured to communicate via a bus 314. Each of the component 301, the device 300 and the server 302 includes a processor that functions as the control 305, 309, 313. The I/O 303 of the component is configured to communicate with the I/O 307 of the device. The I/O 307 of the device is configured to communicate with the I/O 311 of the server.

The memory 304 of the component 301 stores an identity information. The identity information includes a name of the component 301, wherein each component is assigned a unique name. The identity information may further include an attribute information that provides details of how the component 301 is configured. The identify information includes at least one of text, numerals, and a machine-readable code (such as a bar code, QR code, microchip). As an example, the identify information includes a blockchain that enhances traceability by tracking how and where each component has previously been deployed. Security is enhanced by providing the identity information in an encrypted format. The identity information stored by the memory 304 can also be presented by a label attached to the housing of the component 301.

Provision of the I/O 303 and the memory 304 as part of each component 301 allows each component to serve as an independent unit that can be transferred from one device 300 to another device. The memory 308 of the device 300 stores an identity information of the device 300, together with the identity information of one or more components 301 that have been registered. For each electrical component, the memory 308 of the device stores an indication of whether that specific component is authorized to be used by the device 300. The memory 312 of the server 302 stores a database that specifies whether each of the plurality of electrical components, such as the component 301, has been authorized for use in the device 300 and other Arrival's devices (vehicles). The information about each individual device 300 and each individual electrical component 301 is stored on the database of the server 302.

The control 313 is configured to retrieve information from the database in the memory 312 and update the database. Accordingly, the control 313 is configured to determine whether the device 300 and the electrical component 301 are authorized ones. Furthermore, the control 313 is configured to update the authorization of whether the device 300 and the electrical component 301 are authorized with time.

The server 302 is remote from the device 300. The server 302 is considered to be a “cloud server”, because functionality of the server 302 is distributed via the internet across a plurality of servers. The provision of the cloud server enhances resilience, preventing vulnerability to the performance of an individual server. Furthermore, the distributed nature of the cloud server 302 across a number of locations facilitates communication between the cloud server 302 and a mobile device 300, and is particularly beneficial to enhancing communications between the cloud server 302 a plurality of distributed devices 300. As an alternative, the server 302 is a specific individual server.

Registration and Authorization

FIG. 41 shows a diagram of a communication method S10 used by the system to establish whether the device 300 (e.g. vehicle) is authorized by the server 302. In step S11, the device 300 transmits the identification information of the device 300 to the server 302. In step S12, the device 300 receives a confirmation of whether it is authorized for use or not.

FIG. 42 illustrates a diagram of a communication method S20 used by the system to establish whether the device 300 (e.g. vehicle) is authorized to use the component 301 (e.g. a battery pack). In the method S20, the identification information is passed from the component 301 to the device 300 (step S21) and then to the server 302 (step S22). In reply, the authorization information is passed from the server 302 to the device 300 (step S23) and to the component 301 (step S24). In more detail, in step S21, the component 301 registers the identification information with the device 300. In step S24, the electronic device 300 confirms to the component 301 whether it is authorized to be used in the electronic device 300. In step S23, the device 300 transmits the identification information of the component 301 to the server 302. In step S24, the device 300 receives a confirmation of whether the component 301 is authorized to be used in the device 300.

FIG. 43 provide further detail of a secure registration and authentication method applicable to Arrival's devices such as Arrival's vehicles. The relevant registration and authentication process is described and illustrated below from the perspective of the component 301 (method S30), the device 300 (method S40), and the server 302 (method S50).

Method S30, from the perspective of the component 301, is as follows:
In step S31, the control 305 of the component obtains the identity information (ID) from the memory 304 of the component.
In step S32, the control 305 instructs the I/O 303 of the component to send the identity information (ID) to the I/O 307 of the device 300 (corresponding to S21), wherein upon receipt of the ID information by the device 300, the ID information is stored in the memory 308 of the device 300. As a consequence, the component 301 is considered to be registered by the device 300.
In step S35, the I/O 303 of the component receives an authorization information (Auth) from the I/O 307 of the device 300 (corresponding to S24).
In step S36, the control 305 of the component actions the authorization information. If the component is authorized, then operation of the component is permitted. If the component is not authorized, then operation of the component is restricted.

Method S40, from the perspective of the device 300, is as follows:
In step S41, the control 309 of the device obtains the identity information (ID), from the memory 308 of the device, wherein the ID information relates to the device itself (corresponding to S10), or the component (corresponding to S20).
In step S42, the control 309 instructs the I/O 307 of the device to send the identity information (ID) to the I/O 311 of the server 302 (corresponding to S11, S22).
In step S44, the I/O 307 of the device receives an authorization information (Auth) from the I/O 311 of the server 302 (corresponding to S12, S23).
In step S45, the I/O 307 of the device sends the authorization information (Auth) to the I/O 303 of the component 301.
In step S46, the control 309 of the device actions the authorization information. With respect to authorization of the device 300 (corresponding to S10), if the device is authorized, then operation of the device is permitted, whereas if the device is not authorized, then operation of the device is restricted. With respect to authorization of the component 301 (corresponding to S20), if the component is authorized, then operation of the component is permitted, whereas if the component is not authorized, then operation of the component is restricted.

Method S50, from the perspective of the server 302, is as follows:
In step S51, the control 313 of the server maintains the database (DB) stored by the memory 312 of the server, which associates the identity information (ID) with the authorization information (Auth), for both of the component 301 and the device 300.
In step S52, the I/O 311 of the server receives the identity information (ID) from the I/O 307 of the device 300 (corresponding to S11, S22).
In step S53, the processor of the server 302 retrieves the authorization information (Auth) that corresponds to the identity information (ID) from the memory 312 of the server. The processor updates the database (DB) to record that it has been accessed. Furthermore, for the situation in which the identity information (ID) corresponds to the component 301 that is associated with the device 300 (S20), the processor updates the database (DB) to record the association between the component 301 and the device 300.
In step S54, the I/O 311 of the server sends the authorization information (Auth) to the I/O 307 of the device 300 (corresponding to S12, S23). The server then returns to S51 and continues to maintain the database (DB).

Thereby, each component of the system operates independently, by establishing whether its safety requirements have been satisfied. Each vehicle verifies individual components, with this verification being based on receipt of an authorization information by an external server. Each component has monitoring means to determine whether it can be operated safely, which includes the component checking its authentication status with the device in which the component is installed.

A threshold of confidence determines the level of functionality that can be performed by the component. A consequence of a device or a component being restricted is chosen by the owner, for example, by an operator of a fleet of Arrival vehicles, with consequences limiting the level of functionality based on the security and safety requirements.

The threshold of confidence is based on internal factors of the component, and also environmental factors that the component is exposed to. For example, if the components are changed, or if the vehicle is moved to an unusual location, this indicates that the component should be more skeptical of its external environment. Accordingly, bespoke security levels can be selected, while ensuring compliance with safety regulations. As an example, a batter pack for an electric vehicle can be configured so that if it is not authenticated, then it will operate with reduced functionality, for example, with a limited power provision to the vehicle, allowing the vehicle to be safely controlled, rather than abruptly stopping functionality while the vehicle is in motion.

Restrictions of functionality that are technically feasible comprise the following:
operation of the device/component being completely prevented,
operation of the device/component being reduced or limited, and
a central alarm being triggered allowing a remote user to intervene in operation of the device/component.

Individual Hardware Security Modules and Distributed Authentication Base

Depending on the applicable requirements, the Arrival cyber security approach can involve different solutions and levels of security. Another solution within the Arrival cyber security approach is based on the usage of hardware security modules (HSMs) in each hardware components as described below.

In the given implementation of Arrival cyber security system, each Arrival's hardware E/E component is provided with a HSM for verification, registration, or authentication, for example, using the processes similar to the ones described above where HSMs operate as dedicated controls with memory storing respective identity information. In contrast to this, a conventional approach provides a single HSM in a whole vehicle.

In further implementation, the Arrival cyber security system provides for a distributed verification or authentication of some or each component of a vehicle before the component is permitted to be fully operational. The distributed verification or authentication envisages that several components, modules and/or systems (hereinafter—components) of the vehicle external to a component subject to the verification or authentication shall verify or authenticate said component. In such a way, the vehicle security is increased with the increase of the number of components involved into the verification or authentication (hereinafter—an authentication base).

This aspect of the Arrival cyber security approach is highly flexible: different components of a vehicle can be included into the authentication base, and the authentication base can include different numbers of the vehicle components, depending on current environment, circumstances and/or requirements.

In case of successful verification or authentication, the components of the authentication base can jointly generate an encryption key which is transmitted to the verified or authenticated component to enable said component to take part in an encrypted communication with the rest components of the vehicle using said key.

Thereby, the Arrival cyber security system implements the Shamir's Secret Sharing algorithm where a secret (the key) is divided into parts, giving each participant (each component of the authentication base) its own unique part. With this implementation, it is possible to set a minimum number of parts (components of the authentication base) required to reconstruct the original secret (to generate the key). In such a way, a security level of the vehicle system can be set and varied depending on current circumstances and requirements.

Furthermore, the Arrival cyber security system envisages a two-way verification or authentication: in parallel to the above-described procedure, each Arrival component shall verify or authenticate a vehicle, a device or a system that the component is installed in before the component is permitted to be fully operational. In line with the above disclosure, the installed component can be configured to verify or authenticate several components, modules and/or systems of the vehicle to successfully verify or authenticate the vehicle.

All the described verification or authentication procedures can be implemented with HSMs integrated in Arrival's components.

Besides, the distributed verification or authentication of components in a vehicle can be achieved even if the vehicle comprises components without integrated HSMs, such as conventional OEM's modules. For example, a register of such conventional modules can be distributed among several components of the vehicle serving an authentication base for the conventional modules, so that the verification or authentication of the conventional modules is conducted by several component of said authentication base, for example, in a blockchain-like manner.

Component Binding

In yet another implementation, the Arrival cyber security system envisages binding a component to an intended installation such as specific vehicle. A component can be intended for usage in specific installation such as specific vehicle and thereby can be pre-configured or bound to said installation. The component bound to the installation will be disabled in the event of removal from the intended installation. In order to enable the component bound to one (first) installation to operate in another (second) installation, it is required to properly un-bind the component before its removal from the first installation.

A newly produced Arrival's component can be configured for automated binding to the first installation it is plugged in, for example, in result of the first successive verification or authentication procedure of this component. Correspondingly, every Arrival's component can be bound to an authorized installation such as specific vehicle and a proper un-binding can be required before removal of the bound component from the authorized installation to enable the component to operate in another installation.

At that, every Arrival component, including bounded components and a whole vehicle, can be configured to have service mode in which the component is fully operational in any installation, including unauthorized ones. Such service mode is required for easy and uninterrupted service of Arrival vehicles and components. Still, the service mode shall have a set of limitations such a limited time of the service mode, a maximum range of movement of a vehicle in the service mode, etc.

In addition to the above, the Arrival cyber security system includes proximity sensor-based solutions for enhancing security of vehicles.

Key Fob and Secure Touch Point

In an implementation, a vehicle is provided with a proximity-sensitive sensor used by a user to access the vehicle. The proximity-sensitive sensor can be also referred to as “Secure Touch Point”. The user has a key which includes a transmitter configured to emit a signal that is detected by the sensor. The signal includes authentication data, which is checked by a security processor in the vehicle, for example, by one or more HSMs. If the authentication information is found to correspond to an authenticated user, then the processor permits access to the vehicle. If the user is authenticated, then the door is unlocked, so that the user can gain access to the vehicle.

The sensor is sensitive to receive Bluetooth Low Energy (BLE) signals and/or ultra-wideband (UWB) signals and/or Near Field Communication (NFC) signals. It is also possible to use any other types of remote communication. Thus, a plurality of channels is provided for communicating between the key and the vehicle. In an implementation, the UWB serves as a default channel, with NFC serving as a backup channel. Once the key is within certain range, the vehicle status changes, so the vehicle is able to unlock. Therefore, the driver does not need to find their keys to access the vehicle interior.

The key is a phone or a fob. If the key is a phone, then the driver does not need to carry a separate fob. Also, a key can be provided to a number of keys that are in the possession of different drivers. A digital key can be transferred from one key device to another. This is useful for fleets, where a number of drivers are given access to the vehicle. The authentication data is associated with the key, with the vehicle recognizing which key has been used to access the vehicle.

Optionally, a localized touch sensor is provided on certain or each door of the vehicle. Touch detection is in addition to key detection. As a consequence, a driver walking past the vehicle will not cause the vehicle to unlock by mistake.

The proximity-sensitive sensor and/or touch sensor can be integrated into a glass side window of the vehicle. For example, during building time, the entire side window, with integrated sensor, can be readily installed into a vehicle frame by a robotic installation system. The sensor is generally a large panel in a prominent position that can be easily reached by the van driver; it does not need to be integrated into a door handle and is not meant to be grasped, unlike conventional touch or contact based vehicle access control systems.

Secure Touch Point Network

In yet another implementation, Arrival's vehicle comprises a network of connected Secure Touch Points (STP) that are configured to authenticate the user of the vehicle using radio interfaces.

In addition to the authentication function, STP network can have a user feedback (like LED or haptic feedback), and one or more touch sensors. STPs in the network are located at positions close to the doors of the vehicle. It allows locating the user near the door using UWB, as well as to use NFC as a backup interface.

FIG. 44 illustrates an example topology of the STP network.

In the shown implementation, there are four STPs 314, 315, 316 and 317 in a vehicle to enable locating the user 318 position close to one of the doors 319, 320, 321 and 322 of the vehicle 323, and around the vehicle 323. It shall be understood that the STP network can comprise other number of STPs, starting from two STPs (for example, one STP can be arranged in the front part of the vehicle and another one—in the rear).

At that, STPs in the network can differ from each other. Not all STPs need to have all communication interfaces. Specifically, in most scenarios, it is enough to have a BLE interface in one STP only, such as a primary STP 314 in the present example. NFC, as a backup method, can be provided in all STP or some of the STPs in the network.

An HSM is provided with the STP network for strong authentication of a user to the STP system. At that, the HSM is integrated in just one STP of the network—the primary STP 314 in the present example. Thereby, the primary STP 314 comprises all the available interfaces, including BLE, UWB and NFC, and has the HSM for conducting the user authentication procedure inside the STP network. All the other STPs 315-317 in the network are referred to as secondary, they have a simplified structure and functions: they have no HSM and are provided with UWB and NFC interfaces only.

In the vehicle 323, the STP network is connected to a CAN bus 324 only that enables the STPs to communicate with each other and a vehicle security controller/ECU 325 using one secure protocol. In operation, the primary STP 314 is configured to use the CAN bus 324 for sending control signals 326 to each secondary STP 315-317, for example, to control an UWB ranging, and for reporting to the vehicle security controller/ECU 325.

When the user 318 with the corresponding authenticator (for example, a key fob) approaches the vehicle 323 the STP network locates the user 318 position using available communication interfaces. For example, in case the user 318 approaches the right side of the vehicle 323, as shown in FIG. 44, the STP network uses the UWB ranging signals 327 detected by both the primary STP 314 and the secondary STP 317, as well as the BLE signals 328 detected by the primary STP 314 and the NFC signals 329 detected by the secondary STP 317 to locate the user position. In this scenario, the secondary STP 317 sends data of the detected UWB and BFC signals to the primary STP 314 through the CAN bus communication 330.

The primary STP 314 is then configured to authenticate the user, by the integrated HSM based on all the detected signals, and to report the authentication status 326 to the vehicle security controller/ECU 325.

The STP network is further configured to monitor the user 318 position and unlocks a door to which the user approaches either directly or through the ECU 325. For example, in the case shown in FIG. 44, the user 318 can, with equal probability, move towards the driver's door 319 or the back door 322. The direction of the user movement is determined by monitoring how the user position changes over time based on the signals detected by each of the STPs 314-317.

The present STP network implementation provides for easy integration into a vehicle CAN network:
STP network is self-contained; it is connected with the only CAN interface and does not need an external HSM somewhere else in the vehicle/network (the STP network is configured to rely on its own HSM).
STP network has one protocol to communicate with the vehicle Security Controller/ECU.
STP is configured for secure communication between STPs which reduces physical security requirements for harnesses and requirements for network isolation.

In result, the present STP network is mostly a Plug and Play solution, which can be retrofitted in any vehicle including conventional OEM's vehicles.

Interaction with the Authenticator

There are several stages of an authentication process between the STP system and the user with the authenticator, such as the key fob, using BLE/UWB signals:
1. STP system first identifies the user, as the user approaches the vehicle, and pre-authenticates the user, using any proper fast cryptography methods. It happens as soon as the BLE connectivity is established. At this stage, user is not able to access the vehicle, but is “recognized” by the system.
2. STP system starts Secure Ranging the authenticator distance relative to the vehicle and its position, using UWB technology for Smart Ranging and BLE as a communication channel to coordinate an UWB behavior.
3. Results of the Secure Ranging are reported to the vehicle ECU, once the user is entering some radius (with thresholds set at 2 or 3 radiuses, for example: 1 m, 3 m, 10 m) or leaves it. Reporting is done with secure communication protocol via CAN bus.
4. If the user presses a button to explicitly unlock or lock the vehicle at any range, the STP system authenticates the user with any proper strong cryptography methods. At this stage, a full interaction between the Authenticator Secure Domain and the STP Secure Domain is performed. Secure Domains are typically implemented with the HSM Integrated Circuits (ICs).
5. Once the user is in the close proximity range of the vehicle, STP system authenticates the user with any proper strong cryptography methods. At this stage, full interaction between Key Fob Secure Domain and STP Secure Domain is performed. Secure Domains are typically implemented with HSM ICs.
6. User authentication status is reported to the vehicle ECU responsible for vehicle access control, using the secure communication protocol and the CAN bus.

These are the stages of the authentication process using NFC signals:
1. One of the STPs senses the proximity of a key card of the user (using inductive or capacitive sensor).
2. That STP enables NFC reader and performs authentication of the user with the key card. Interaction between Key Card Secure Domain and STP Secure Domain is performed. Secure Domain of an STP is typically implemented with HSM ICs. Secure Domain of the Key Card is implemented inside the card IC.
3. User authentication status is reported to the vehicle ECU responsible for vehicle access control, using the secure communication protocol and the CAN bus.

Section D: The Arrival Technology Platform: Creating a New Vehicle Design Using the Vehicle Builder Tool

Introduction to this Section D

The Arrival Technology Platform (ATM) combines the Hardware Modularity implemented in the Arrival Unified Hardware Platform as described in Section A and the Software Modularity implemented in the Arrival Unified Software Architecture as described in Section B that both adopted and used by Vehicle Builder so as to enable Plug and Play functionality of Arrival products including vehicles.

Plug and Play is a framework and toolchain striving to simplify and automate a process of designing vehicle's electric and electronic (E/E) architecture. Vehicle Builder provides for automated configuring wiring, networks and allocation of software components for a vehicle model that further allow generating a firmware for Electronic Control Units (ECUs) in the vehicle along with release for Over-The-Air (OTA) Update and diagnostics profile. Vehicle Builder thereby allows to dramatically minimize manual operations in a vehicle design process so as to enable engineers creating optimal vehicle E/E configuration in hours instead of weeks.

Vehicle Builder is an automated vehicle design tool that is configured to create an optimal E/E configuration for a vehicle model based on input requirements including desired system features, define an optimal software allocation, and ultimately generate a complete vehicle model specification. In an implementation, Vehicle Builder can be a web-based application.

In operation Vehicle Builder uses the Functions Library being a database of all System Features and System Functions (or simply Features and Functions) that are used for defining and describing Arrival's vehicles as provided by ATP. Vehicle Builder further uses the Components Library being a database of all electrical (hardware) Components that can be used in Arrival's vehicles as provided by ATP. For example, the Components Library comprises such components as Air Pressure Sensor, Camera, Cooling Fan, Water Pump etc. These databases are developed on the basis of the hardware and software modularity using the unified hardware platform and the unified software architecture as described above.

Vehicle Builder comprises a User Interface (UI) in which a user, such as a vehicle designer or engineer, is able to select desired system features for a vehicle model to be designed from a menu with available options such as a car or a bus etc.; an electric park brake or not; self-levelling suspension or not; e-mirrors or not, heated windows, heated seats, heated steering wheel, a wi-fi hotspot, fully autonomous; self-parking; collision avoidance; any other ADAS features; a ticketing system (if it is a bus) etc. Alternatively, a set of desired features for a vehicle model can be provided outside Vehicle Builder, for example, obtained from a remote resource or server.

The Vehicle Builder then displays all desired features, together with functions inherited from these features that are provided by the Functions Library of ATP. In case of the semi-automated operation of Vehicle Builder, the user can approve the displayed features, add or delete one or more of the displayed features. If any changes are made to the set of features, Vehicle Builder will repeatedly access the Functions Library to update the functions required for implementing the updated set of features.

Next, the Vehicle Builder assigns electrical components to perform all of the functions based on the Components Library of ATP. So, for example, if the feature of self-levelling suspension is selected, then required components comprise a hydraulic pressure creating system, a hydraulic pressure sensing system, an Electronic Level Control (ELC) ECU and a vehicle level sensing system.

The functions as provided by ATP include complete information on required hardware components, including name, supplier, description, model number, weight, voltage, interfaces, documentation. The vehicle designer is able to review and accept the options as appropriate; giving a location in the vehicle where there are several options and assigning it to other components (for example, that are interfaced with) where there are several options.

At this stage, Vehicle Builder is able to generate a complete list of hardware components for the vehicle model depending on the required features and functions. Vehicle Builder further selects a set of modular software components to control the components for performing all the functions, as provided by ATP.

Vehicle Builder then uses the Auto Wiring tool and algorithm to solve an optimization problem and determine: a number, types and an arrangement of ECUs, an optimal allocation of the software components on the ECUs and a configuration of vehicle data layer—networks. At that, Vehicle Builder is configured to automatically fill out all pinouts with the hardware components pins according to the pin specifications and component locations. The resultant wiring, software allocation and networks configuration are optimized, in combination, in terms of required pin types, computational capabilities, network loads and cost of wiring harness. In other words, Vehicle Builder automatically generates an optimal system configuration of the vehicle model. Manual adjustments in the generated configuration are also possible through the UI.

At the final stage, Vehicle Builder creates an entire vehicle model specification and generates a firmware to be applied to vehicles of this model to enable its Plug and Play functioning. The specification defining the vehicle model configuration can then be sent to a production system, including automated inventory ordering and logistics, as well as supplies and actual robotic production systems.

ATP provides for having all Arrival vehicles described in a single manner at one place. Based on ATP, the Vehicle Builder simplifies defining and configuring a vehicle; provides all necessary data in context; supports design and integration stages; helps, verifies and automates all involved processes, where possible.

Benefits of Vehicle Builder: All the vehicle models' data is stored in one place and used in designing new vehicle models; specifications, documents and CADs for all the components are at hand; the system provides auto suggestions on the components to use; clear pinouts; automated wiring with optimal networks configuration and software components allocation across ECUs.

Vehicle description or model in Vehicle Builder: Vehicle is defined at first by Features to be provided in the vehicle. The vehicle is further defined with Functions that are required to support the Features; all Features and Functions, and its interconnections are stored in the Functions Library. Yet further the vehicle is defined by Components assigned to each of the Functions based on the Components Library. Thereby, in the Vehicle Builder the vehicle is described as a set of Features with Functions supporting the Features plus Components that perform these Functions.

When Vehicle Builder configures electrical (hardware) components including ECUs and creates an optimal wiring to connect them with each other, it conducts a simulation with virtual installation of the components to a vehicle to obtain and verify the virtual hardware topology of the vehicle model. Furthermore, Vehicle Builder conducts another simulation when virtually allocate software components on virtual ECUs to verify that the allocated software components are able to communicate with each other through virtual vehicle networks and enable proper control of the hardware components in the virtual hardware topology.

As a result, the vehicle system configuration as well as the firmware generated by Vehicle Builder are already tested and verified during the automated design process.

Further the Auto Wiring tool is described in detail to explain how the optimization problem mentioned above is solved by Vehicle Builder.

### BRIEF SUMMARY OF THE FIGURES RELATING TO THIS SECTION D

Some features, implementations and examples of the following disclosure are illustrated in the accompanying figures, in which:

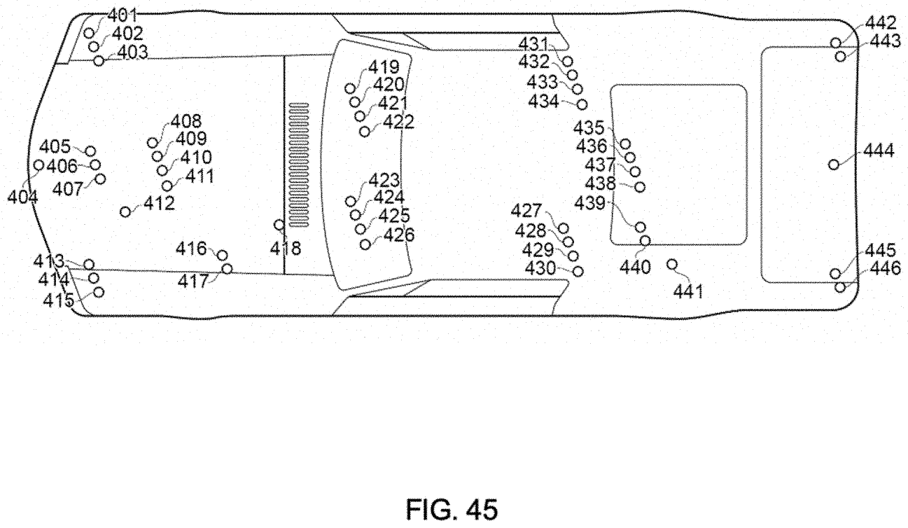

FIG. 45—is a schematical vehicle model layout with E/E components pins' locations.

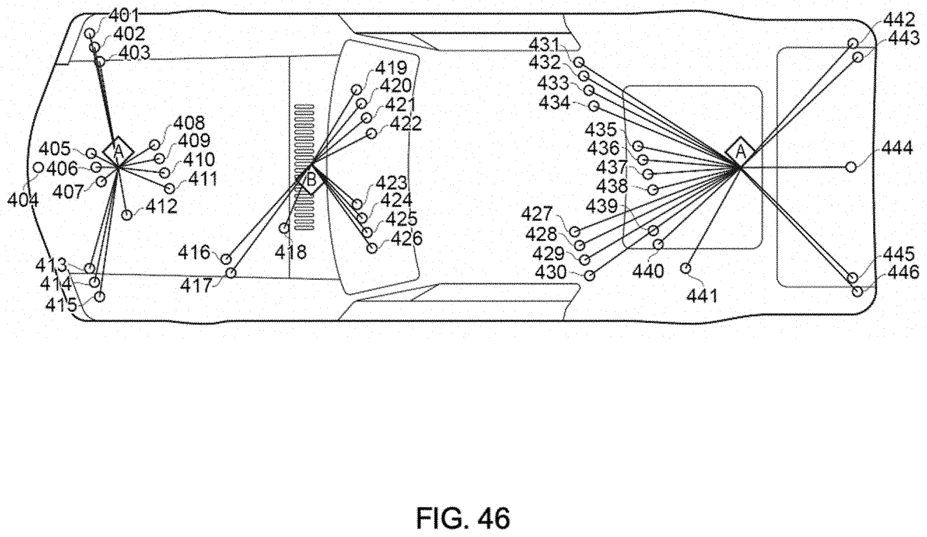

FIG. 46—is the schematical vehicle model layout from FIG. 45 with an E/E topology including ECUs and its connections to all pins of the E/E components.

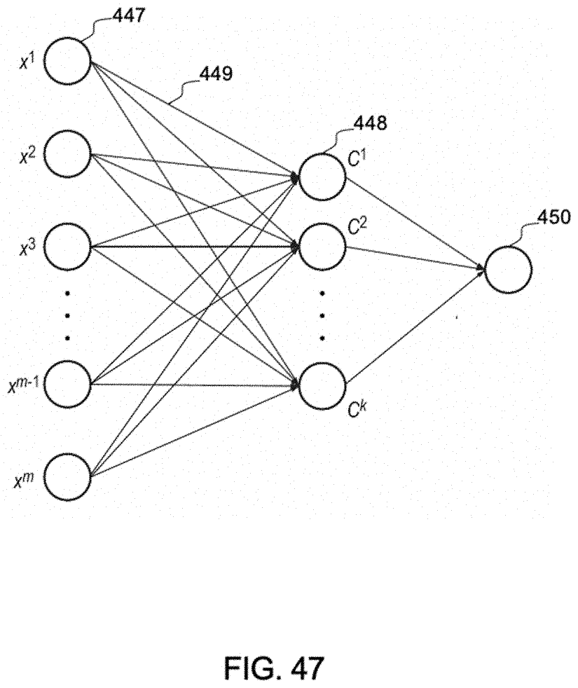

FIG. 47—is a weighted bipartite graph of a wiring optimization problem.

### DETAILED DESCRIPTION RELATING TO THIS SECTION D

### Technical Problem

It is known that deciding how to connect a great number of pins from dozens of components to ECUs in a vehicle to enable the vehicle functioning properly is as issue for designers and engineers creating the vehicle. Number of options to consider in this case is growing exponentially with a number of available configurations.

Auto Wiring Tool allows to automate creation of wiring diagrams for these configurations, achieve an optimal solution and eliminate any human errors.

### SUMMARY

Auto Wiring Tool is based on a new algorithm that is configured to provide automatically generated wiring diagrams for connections between selected vehicle systems (comprising of modules and components) and ECUs (or Input-Output (TO) Modules) to enable their operation as a part of a vehicle system controlled by software. The tool is further configured to allocate Composite and Atomic Software Components on the ECUs to control the hardware components for performing selected functions that provide selected features. Yet further, the tool is configured to create an optimal Networks (e.g. CAN, LIN or Ethernet) configuration in the vehicle that enable all the software components to communicate with each other.

Thereby, the Auto Wiring Tool is configured for:
designing an optimal wiring harness;
allocating appropriate configuration software (in the form of firmware) for all ECUs; and
creating an optimal Networks configuration for the vehicle.

The following terminology is used for describing the Auto Wiring Tool and Algorithm:

Vehicle—set of Modules communicating with each other via a Network protocol (e.g. CAN or any other system protocol).
Module—set of Components performing a function.
Component—a part of a Module.
Pin—terminal in Component's connector, each pin is described with Parameters (voltage, current, direction, connection type) and Function (e.g. Left High Beam Lamp or Front EC Water temp).

Components' Pins' Connection Types:
Analogue output (demand connection to Analogue input type pin of ECU);
Digital output (connects to Digital input);
Low side input low current (up to 1 A) and high current (up to 5 A) (connects to Low side output);
High side input low current (1 A) and high current (5 A) (connects to High side output);
Other types are also possible.
   ECU—a device configurable to control or monitor Modules parameters via Network such as CAN network; if the Module has no connection to Networks, i.e. it has analogue connections, the ECU will basically be operable to:
get signals from input pins and translate their value in Network (e.g. CAN); and
turn on or off relevant output pins based on received Network (e.g. CAN) messages.
   Connection—a link between a pin of Component with a pin of ECU.
   Vehicle Layout—a 3D schematic arrangement of all Components and Pins in a vehicle.

Input for the Auto Wiring Tool

Auto Wiring Tool and Algorithm requires a Vehicle Configuration in the form of the vehicle layout with a list of Modules as an input. The list of Modules comprises a full list of corresponding Component Pins with parameters, functions, and its locations in the vehicle layout. The Algorithm further requires a complete information about types (models) of ECUs available for the use in the vehicle.

Requirements or Rules for the Auto Wiring Tool

The following requirements or rules have been defined in the development of the Auto Wiring Algorithm to enable finding an optimal solution of the problem set above.

1. All Connected—All Pins of all Components (if a connection is required) are to be connected to Pins of ECUs
2. Pin Types—Pins of Components are to be connected to Pins of ECUs of relevant type, wherein both connection type and current value are to be considered.
3. Optimal number—optimal set of ECUs is selected (for example, a smallest set or a cheapest one).
4. ECUs Types—Appropriate ECU is selected depending on Component's pin type.
5. Optimal wiring—Optimal arrangement of ECUs in the layout is defined to reduce the wiring harness length.
6. Nearest ECU—Components strive to connect to the nearest available ECU to reduce the wiring harness length.
7. Pins Grouping—Certain pins, that can belong to different components or modules, are connected to one ECU.

The latter type of requirements or rules allow gathering system functions and/or features within one ECU so as to optimize the networks configuration, for example, by reducing an amount of network (e.g. CAN) messages by applying some logic (e.g. switching outputs on some sensors signal) locally, in the same ECU, to avoid transmitting heavy or sensitive data via vehicle networks.

Auto Wiring Algorithm Overview

As an input, the Auto Wiring Algorithm receives descriptions of all Components' Pins with Types and Functions defined, and their arrangement in a vehicle layout, for example, as illustrated in FIG. 45.

The vehicle layout in FIG. 45 comprises the following Components' Pins: Front Right (FR) Turn Indicator Pin 401, RF High Beam Pin 402, FR Low Beam Pin 403, Ambient Temperature Sensor Pin 404, Front (F) Fog Sensor Pin 405, F Position Indicator Pin 406, F Daytime Running Lights (DRL) Indicator Pin 407, Power Front (PF) Water Temperature Pins 408, 409, PF Water Pressure Pins 410, 411, Cooling Fan Pulse Width Modulation (PWM) Pin 412, Front Left (FL) Turn Indicator Pin 413, FL High Beam Pin 414, FL Low Beam Pin 415, F Brakes Pressure Pin 416, Rear (R) Brakes Pressure Pin 417, Vacuum Pressure Pin 418, FR Airbag Potentiometer Pin 419, FR Airbag Pressure Sensor Pin 420, FR Airbag Exhaust Solenoid 421, FR Airbag Inflate Solenoid 422, FL Airbag Exhaust Solenoid 423, FL Airbag Inflate Solenoid 424, FL Airbag Pressure Sensor Pin 425, FL Airbag Potentiometer Pin 426, Rear Left (RL) Airbag Exhaust Solenoid 427, RL Airbag Inflate Solenoid 428, RL Airbag Pressure Sensor Pin 429, RL Airbag Potentiometer Pin 430, Rear Right (RR) Airbag Potentiometer Pin 431, RR Airbag Pressure Sensor Pin 432, RR Airbag Exhaust Solenoid 433, RR Airbag Inflate Solenoid 434, Power Rear (PR) Water Temperature Pins 435, 436, PR Water Pressure Pins 437, 438, Air Tank Pressure Sensor Pin 439, Air Compressor Solenoid Pin 440, Rear Brake Solenoid Pressure Sensor Pin 441, RR Position Indicator Pin 442, RR Stop Signal Pin 443, Reverse Signal Pin 444, RL Stop Signal Pin 445, and RL Position Indicator Pin 446.

As one can see, even on the simplified example of FIG. 45 it is a complicated task to determine an optimal number and locations of ECUs to connect with all the Components' Pins 401 to 446.

Advantageously, the algorithm allows automatically defining an optimal set of ECUs for a given set of Pins with taking into account Types of Pins and Pins Grouping Requirements.

For example, the algorithm output at this stage can be as follows: optimal set consists of two ECUs of A type and one ECU of B type.

Then the optimal arrangement of the defined set of ECUs with minimal sum of wiring harness length of all the connections is calculated by the algorithm. For example, the output of this stage for the layout of Components' Pins of FIG. 45 is illustrated in FIG. 46.

In particular, FIG. 46 shows that one ECU of A type is to be arranged in the front part of the vehicle body, one ECU of B type is to be arranged in a dashboard and one ECU of A type is to be arranged in the rear part of the vehicle body.

Auto Wiring Algorithm Description

The auto wiring algorithm has five tasks to solve or objectives to achieve based on the input data and set requirements:

1. Defining an optimal set of ECUs
2. Defining an optimal assignment of Components' Pins to ECUs' Pins
3. Defining an optimal arrangement of ECUs
4. Defining an optimal allocation of Software Components to control Components and perform logic required by Functions and Features
5. Defining an optimal configuration of Networks so that all the ECUs with required software can communicate with each other.

Each task is an optimization problem with its own optimal solution that has a strong influence on the other objectives as the objectives are interconnected with each other. The algorithm solves the tasks, step by step, in the given order, instead of solving a complex optimization problem with multiple objectives. This approach proved to be highly effective while reducing the computational complexity dramatically.

Step 1: Defining an Optimal Set of ECUs

The objective of that step consists in defining the cheapest set of some predefined elements (ECUs) that matches given constraints (enough capacity for all Components, all requirements are satisfied). That definition allows us to treat given task as a combinatorial optimization problem (COP). Though there are some (very narrow) subclasses of COPs that have well-known and fast heuristic-based solutions, in general, the only way to obtain an optimal solution of COP is an exhaustive search which is not an option in most cases because of its extremely high computation complexity. However, there are still some general approaches and heuristics that might reduce the space of possible solutions and therefore make an exhaustive search feasible.

The auto wiring algorithm uses an approach called Constraint Programming (CP). Constraint Programming is a paradigm that allows describing a COP as a set of variables with specific domains and constraints by some kind of formal language (which depends on used CP framework). An objective to optimize and some heuristics about search order can also be added. Search over a space of possible variables assignments is performed inside a CP framework using so-called decision tree. The auto wiring algorithm solution is based on the CP solver from the open-source Google Optimization Tools library.

Variables

Assuming that we have T different ECUs, we define variables C[1 . . . T], with variable C[i] representing a number of ECUs of i-th type in our configuration.

### Objective

The objective is quite simple: cost of each ECU is known so the algorithm defines the objective as a scalar product of the variables vector and the costs vector.

Constraints

Capacity

At first, it is to be ensured that a result configuration has a feasible solution. In other words, there is to be a necessary and sufficient condition of existing a maximum bipartite matching between all Components' Pins and ECUs' Pins. For that, the algorithm uses a so-called Hall's Condition based on the Hall's marriage theorem. It allows to ensure problem feasibility without solving it.

Added are Hall's condition constraints which looks as follows: For each Components' Pins subset there are enough suitable ECUs' Pins.

In fact, knowing that there is a limited set of different Pins' types, the algorithm does not have to check exactly all 2n subsets, because the most of them are symmetrical to each other.

Rules and Groups

Building constraints for Rules and Groups is more difficult. There is no way to check if all Pins from all Groups can be assigned to the same ECU without an actual assignment. On the other hand, a full assignment cannot be conducted on that step because it will dramatically increase the computational complexity of the algorithm. For this reason, the algorithm performs a partial assignment.

All Consumers' Pins are split into two groups: ones that used by any of Groups and/or Rules (they are called Super Pins, or SP) and ones that are not used by any of Groups and/or Rules (they are called Normal Pins, or NP).

Partial assignment is required only for the SP. Subclusters are introduced for this partial assignment: a subcluster is a set of Pins that belongs to the same ECU and have the same Pin Type. For example, an ECU with 16 Pins of Type ANAIN and 8 Pins of Type ANAOUT can be split into two subclusters: a subcluster of type ANAIN with size 16 and a subcluster of type ANAOUT with size 8. At that, ANAIN and ANAIN/ANAOUT are considered as different types.

Variables are introduced to represent the partial assignment. There is no final ECUs configuration yet, so two variables for each SP are declared: subcluster ID (SI[i]) and cluster number (CN[i]). SI[i] represents an ID (identifier) of subcluster which i-th SP assigned to. CN[i] is the number of that cluster, at that the numeration goes from 1 for each cluster type, not subcluster. That way of numeration allows adding a constraint that ensures that CN[i] cannot be more than C[cluster type of(SI[i])]. Some simple symmetry breakers for those assignments are added as well.

Constraints are introduced for all the Rules and Groups, i.e. a constraint that ensures that SI and CN variables for all Pins from the same Group are equal.

Capacity revision: the partial assignment affects the capacity constraints, and the following modification is added.

Knowing what types of ECUs' Pins are going to be taken by the SP, it is required to ensure that there are enough remaining ECUs' Pins to connect all NP.

To this end, the following capacity constraints are added: for each Normal Pins subset there are enough ECUs' Pins which are not occupied by the partial assignment of the Super Pins.

Search

Finally, the algorithm runs the CP Solver to define the optimal set of ECUs that serves as an input for Step 2.

Step 2: Defining an Optimal Assignment of Components' Pins to ECUs' Pins

The objective of that step is to define an assignment of Components' Pins to ECUs' Pins that has the smallest cost (the shortest total wire length) and matches given constraints. It is assumed that there is an appropriate set of ECUs found at the Step 1, thereby the assignment step feasibility with said set is guaranteed.

Given that, the task of this step can be treated as a variation of Constrained Clustering Problem (though, it differs from the classic constrained clustering problem definition which allows only Must-Link and Cannot-Link constraints).

Although known are some approaches for finding a global optimum, because of NP-hardness of the clustering problem, they have a lot of serious restrictions and not suitable for the given case.

Clustering problems are usually solved by heuristic algorithms that expected to have a good convergence rate to some local optimum. The auto wiring tool uses a common K-Means clustering algorithm as a base for solving the given task because it is simple, efficient, and easy to modify.

Constrained K-Means Algorithm

Each iteration of the classic K-Means algorithm consists of two consecutive steps:
1. Assign points to clusters with the lowest cost (cost is a sum of distances (metrics) between points and corresponding clusters' centroids)
2. Update clusters' centroids

At some point, assignments become stable which means that algorithm has converged to a local optimum.

Centroids update does not require any modifications since it does not affect any assignments and cannot increase total cost.

As for points assignment, classic K-Means algorithm assigns each point to the closest cluster, which is not an option given the capacity constraints of the auto wiring algorithm. The given assignment task with capacity constraints (which is also a combinatorial optimization problem) is NP-Hard so it is solved with heuristic methods.

Min Cost Flow (MCF) Approach

The assignment task can be described as a problem of finding maximum matching in a weighted bipartite graph. With capacity added, the problem turns into Minimal-cost flow problem and can be solved with a very efficient existing solutions, in particular, the auto wiring tool uses the MinCostFlow solver from the Google Optimization Tools library. The main idea of problem definition in terms of MCF is shown in FIG. 47 illustrating the corresponding weighted bipartite graph.

In the drawing of FIG. 47, x[i] nodes 447 represent Pins, C[j] nodes 448 represent subclusters. If i-th Pin can be connected to the j-th subcluster, there is an arc 449 connecting x[i] and C[j] nodes. There is also an artificial demand node D 450 which is connected to all C[j] nodes.

Each x[i] node has +1 supply. (x[i], C[j]) arc has a cost equal to a distance between i-th Pin and j-th subcluster. (C[j], D) has a capacity equal to j-th subcluster capacity. Finally, to make this net balanced, D node has −N supply (or +N demand).

Thus, the MCF problem solution can be interpreted as following: if Flow(x[i], C[j])==1 then i-th point should be assigned to the j-th cluster.

The described MCF approach looks very promising, but it can handle only linear constraints while some of the constraints set before (i.e. Must-Link rules) are nonlinear. These cases require another assignment algorithm that can handle nonlinear constraints.

Constraint Programming (CP) Approach

For the cases that cannot be resolved by the MCF approach, Constraint Programming is used. It handles nonlinear constraints but requires a lot of additional optimizations and heuristics. And even after that it is way slower than the MCF approach processing.

Following sections describe the main ideas of that approach.

Variables

Assignment variables are introduced: A[1 . . . N].

A[i]==j means that i-th Pin is assigned to the j-th cluster.

Constraints

For capacity constraints Hall's condition is used (see Step 1 for more details). Capacity of each subset can be calculated directly from the clusters set. To calculate demand, a CP constraint named Count is used. For example, Count[A[1 . . . N], k, D[k]] counts the number of variables in A[1 . . . N] that assigned to value k and stores it to an auxiliary variable D[k] which then can be used directly in Hall's conditions.

Constraints for Rules and Groups can be easily defined in a similar way as at Step 1.

### Objective

Objective is a plain sum of distances between points and corresponding clusters' centroids.

Heuristics

Because of the significant size of the decision tree, different assignment order can dramatically increase (or decrease) overall search time. The auto wiring tool uses the following heuristics for subclusters assignment:
try to assign point to the same cluster it was assigned at the previous iteration; and
try to assign point to the closest available cluster.

Another important heuristic is based on that updating clusters' centroids does not affect feasibility. Therefore, a solution obtained on the previous iteration can be used as a baseline for an objective value.

Finally, Pins are assigned to clusters instead of subclusters. That makes domains smaller and significantly impacts performance but requires an additional In-cluster Assignment phase that will be described later.

Convergence

One of the biggest problems of CP approach is about search time. Having an objective to optimize makes the solver to perform an exhaustive search on each iteration, as it is impossible to check whether there is any better solution available without visiting all branches of the decision tree.

On the other hand, having any better (not the optimal) solution is enough to make another step to the local optimum. Hence, it might be useful to stop an exhaustive search at some point and update centroids with the best solution found so far.

Therefore, a timeout is added to the solver. Meaning of the timeout value is somehow close to a learning rate of a gradient descent and can be regulated by different heuristic strategies. Though even a constant timeout impacts the convergence time very well: there are more iterations, but they go faster. Moreover, an idea of making descent steps with any feasible solution that better than a baseline gives us another way to improve a convergence time.

Greedy CP/MCF (GCM) Approach

The main idea of this approach is about combining two approaches: first, we assign SPs with the CP method (with some modifications described below) and then assign NPs to the remaining Pins with the MCF method. Because of the greedy strategy (SPs are always assigned first), optimal solution is not guaranteed, but as mentioned above that is not always necessary. The only thing left to consider is feasibility. Using the CP method to assign SPs at first does not guarantee that NPs can be always assigned to the remaining Pins. To avoid that, extra feasibility constraints are added. These constraints are also based on the Hall's condition and defined in the same way as in the partial assignment at Step 1.

In this approach a so-called two-pass strategy is used. At first pass, an optimal solution is not searched at all, the algorithm descends to the optimum with a GCM solutions only. And only after the GCM fails, the full CP search is used. That allows to decrease the number of the full CP iterations.

Problem Decomposition

Another way to simplify assignment problem is to analyze variables domains. It is possible that full connection graph can be split into some smaller components that can be optimized independently. Moreover, that may lead to some subproblems having no nonlinear constraints which can be solved by the MCF solver or even subproblems with a trivial solution (all points have only one cluster in their domains).

In-Cluster Assignment

The CP and GCM approaches provide the auto wiring tool with an assignment between Components and ECUs with the guaranteed feasibility but do not actually define the exact Pins assignment.

The auto wiring algorithm conducts an in-cluster assignment once, after the K-Means convergence. To assign pins inside a cluster, the algorithm searches for another bipartite maximum matching, running the search for each cluster separately. Because all nonlinear constraints are already set, this task is solved by the MCF solver as described above.

Global Strategy

In result, the overall algorithm is as follows:

1. Define domains of pins. If problem can be split into several subproblems, do it.
2. Randomly initializing clusters centers
3. Run K-Means. On each step, run an optimization for each subproblem:
If subproblem has a trivial solution, use it
If subproblem does not have nonlinear constraints, use the MCF solver
If subproblem has nonlinear constraints, use two-pass GCM-CP strategy:
   At first, run only the GCM solver
   When GCM fails, continue with the CP solver still using the GCM solutions as a baseline
      4. On convergence, save the best pins-to-clusters assignment
      5. For each cluster, do in-cluster assignment using MCF
      6. Return the result

Step 3. Defining an Optimal Arrangement of ECUs

Restrictions on positions of ECUs are low and the auto wiring algorithm uses the centroids of the clusters from the Step 2 with some small adjustments to eliminate possible collisions with another Components and ECUs in a final configuration.

Step 4. Defining an Optimal Allocation of Software Components

With the connections and wiring configuration including ECUs positions, the Vehicle Builder further selects, configurates and automatically allocates Composite and Atomic Software Components to be embedded in ECUs in the vehicle to enable proper operation of the components performing all the functions and providing all the features.

Constraints

The following constraints or rules are defined to enable finding an optimal solution of the task in the given step:
All Software Components are allocated in accordance with their specifications so as to match the parameters of the available ECUs. The specification is included into a description of each Software Component by software engineers in accordance with the Arrival Plug and Play Methodology.
Driver Software Components are allocated on Hardware Components they are intended to control as prescribed in the specifications of the Driver Software Components.
Automotive Safety Integrity Level (ASIL) of all Software Components are to be matched with the ASIL of Features they are performing and the ASIL of the Hardware Components they operate on. Thereby, for example, Software Component requiring certain level of safety cannot be allocated on an ECU with lower level of security.
Application Software Components, that can be located and operate between Composite or Driver Software Components (in terms of communication), can be allocated on different ECUs performing their functions.

Algorithm

Based on the above-mentioned constraints, the Auto Wiring Tool is configured to allocate the Software Components by searching for an allocation with a minimum volume of Network communications between the Software Components in the vehicle. In other words, the allocation algorithm of the Vehicle Builder is configured to allocate Software Components that need to communicate with each other to the same ECU, as far as possible, minimizing communications through networks (e.g. CAN) within the vehicle.

Step 5. Defining an Optimal Configuration of Networks

The final step of the Auto Wiring algorithm is closely connected with the previous one as the software allocation is already planned so as to achieve the minimum Network communications in the vehicle.

Constraints

There are further defined the following constraints or rules related to the Network configuration:
Load of the Networks should be minimal or at least reasonable.
High ASIL communications are to be separate from any lower ASIL ones.
Potential addresses conflicts should be resolved, for example, by creating private networks.

Algorithm

Based on the above-mentioned constraints and the result of the software allocation step, the Auto Wiring Tool is configured to search for a Networks configuration with minimal number of networks (such as CAN Networks) to support all the required communications between the Software Components.

Auto Wiring Tool Output

In result of performing the above steps of the algorithm, the Auto Wiring tool outputs the following results:

1. Connections and Wiring Diagram of a vehicle model defining a connection of each Pin of each Component with a Pin of an ECU.
2. List of Functions for each occupied Pins of each ECU in the vehicle model configuration.
3. Position for each ECU.
4. Allocation scheme for Software Components on ECUs to operate connected Components.
5. Networks (e.g. CAN, LIN, Ethernet) configuration for the vehicle.

Thereby, the described Auto Wiring Tool provides automation of wiring design for modular vehicles in the Vehicle Builder and eliminates any human errors in wiring harness. At that, all the results output from the Auto Wiring Tool are optimized to achieve higher efficiency at minimum costs for of the vehicle model design and production.

We can generalise to the following:

Feature 1: Automated Design of a Vehicle with Vehicle Builder

1: A method of designing a vehicle, wherein an automated vehicle design tool is used for:
(a) obtaining data on a vehicle hardware topology, the topology comprising modular hardware components, and desired system features of the vehicle,
(b) determining system functions and a set of ECUs required to provide the desired system features in the vehicle based on the data,
(c) assigning pins of the modular hardware components to pins of the ECUs,
(d) defining an arrangement of the ECUs in the vehicle and a wiring plan to connect the modular hardware components with the ECUs based on the assignment of the pins,
(e) selecting modular software components to enable performing the system functions and allocating the modular software components on the ECUs, and
(f) defining a networks configuration for the vehicle to enable communications of the modular software components allocated on different the ECUs with each other as required for performing the system functions with providing the desired system features.

Optional Sub-Features
The automated vehicle design tool includes a user interface (UI) that accepts inputs defining customer's requirements for the vehicle including the desired system features.
The automated vehicle design tool is configured for determining the required set of ECUs optimized in terms of a number and/or costs of the ECUs.
The automated vehicle design tool is configured for determining the required set of ECUs by solving a combinatorial optimization problem (COP) with a constraint programming approach.
The automated vehicle design tool is configured for assigning the pins and defining the arrangement of the ECUs in a way optimized in terms of a length of wiring harness required to connect the modular hardware components with the ECUs.
The automated vehicle design tool is configured for assigning the pins by solving a constrained clustering or minimal-cost flow problem.
The modular software components are allocated on the ECUs in accordance with their specifications to match the ECUs' type and parameters.
The modular software components are allocated on the ECUs to match Automotive Safety Integrity Level (ASIL) of the software components, of the system features and functions and of the ECUs.
The automated vehicle design tool is configured for defining the networks configuration optimized in terms of network loads.
The automated vehicle design tool is configured for defining the networks configuration in which high ASIL communications are separated from low ASIL communications.
The automated vehicle design tool is configured to access to and use data from libraries of modular hardware components and modular software components.
The automated vehicle design tool is configured to display all desired system features, together with functions inherited from the features and modular hardware components required to perform all the functions and provide the features, and to list parameters of each modular hardware component such as name, supplier, model number, weight, voltage, interfaces etc.
The automated vehicle design tool is configured to complete and store the entire wiring specification of the vehicle.

Feature 2: Vehicle Robofacturing Workflow with Vehicle Builder Front End

2: A method of producing a vehicle in a robotic production environment, comprising:
(i) an automated vehicle design tool (a) obtaining data on a vehicle hardware topology, the topology comprising modular hardware components, and desired system features of the vehicle, (b) determining system functions and a set of ECUs required to provide the desired system features in the vehicle based on the data, (c) defining an arrangement of the ECUs in the vehicle and a wiring plan to connect the modular hardware components with the ECUs, and (d) defining a networks configuration for the vehicle to enable communications of the modular hardware components with each other as required for performing the system functions with providing the desired system features;
(ii) the automated vehicle design tool sending the wiring plan and the network configuration to an operations control system of an autonomous production environment;
(iii) the operations control system controls the autonomous production environment for producing the vehicle in accordance with the wiring plan and the network configuration.

Optional Sub-Features
The autonomous production environment includes robotic agents that are organised as a group of workcells, each workcell with up to 10 fixed robots, served by autonomous mobile robots (AMRs), wherein the group of workcells operate together to produce or assemble substantially an entire, complete vehicle.
The autonomous production environment is sited in a factory that hosts at least the robotic agents of the autonomous production environment, and is less than 100,000 square meters in area, preferably between 10,000 and 50,000 square meters.

Feature 3: Modular Components Suitable for Vehicle Builder

3: A vehicle component that is modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power.
4: A vehicle including components that are modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power.
5: A fleet of vehicles, each vehicle including components that are modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power;
wherein an operator of the fleet defines a specific set of requirements it has for one or more vehicles in the fleet, and those requirements are used by the automated vehicle design tool to select which hardware and software modular components are to be used in each vehicles in the fleet.

Section E: Robofacturing: Robotic Data-Driven Continuous Delivery Production

Introduction to this Section E

Arrival's ‘Robofacturing’ addresses the major problems with the conventional design and production process. A conventional design and production process is a linear process, moving from initial design layout to operations-based design review, then to commissioning, and to the final factory production stage. This is in effect a conveyor belt process, in which a single failure can stop the entire process, design changes can have a major negative impact, and the output is a single product type (e.g. if you are designing and making a small passenger car, then you cannot re-purpose that design and production process to also make a van or a bus).

Robofacturing proposes autonomous data-driven continuous delivery environments or factories that can make any type of product (e.g. small passenger car, large passenger car, small van, large van, specialist vans, truck and lorries of different lengths and capacities, buses of different lengths and capacities; any other sort of device). An autonomous robotic production environment (which we shall refer to as a ‘factory’) includes machines (robots) and systems that are capable of performing a series of operations where a sequence of the performance is determined by an outcome of the previous operation or by reference to external circumstances that are monitored and measured within the robotic production environment itself. These autonomous factories deliver serial production efficiency, have the best time to market, are distributed, scalable and fault tolerant, open and extendable. They can implement semantic (ontology driven) decision making to be self-learning and self-controlled.

Arrival Robofacturing involves an internally developed technological platform comprising robotic workcells, robotic equipment and tooling, mobile robots (AMRs), a logical, semantic-based language for robotic process management and control, and a robotic operations control system and software to plan, manage and control all processes in an autonomous robotic production environment. One of the implementations of Arrival Robofacturing is a microfactory.

On the other side, as mentioned before, Arrival Robofacturing is based on and widely uses that Arrival components and systems are adopted to robotic handling and assembly: hardware (see Section A) and software modularity (see Section B) are important enablers of Arrival Robofacturing.

The below Sub-sections will cover main aspects of the Arrival Robofacturing.

Section E.1: Multi-agent robotic environment
Basics of the Arrival Robofacturing model

### Section E.2: Arrival Process Language

Unified programming language for robotic process management and control.
Section E.3: Robofacturing Services (rServices) and rServiceHub
A library of equipment and pre-developed robofacturing services, which can be used to design a production process.
Section E.4: Robofacturing Process (rProcess) Studio
A tool for creating a variety of possible processes that satisfy input constraints for producing any given goods by robots, humans, or both.

### Section E.5: Factory Layout Studio

A system for creating a robotic production environment layout and performs discrete event simulation of the same.

### Section E.6: Factory Control Model and Operations Control System

A master model of a robotic production environment and data-driven control system for autonomous robotic environments and factories.

### BRIEF DESCRIPTION OF FIGURES RELATING TO THIS SECTION E

Some features, implementations and examples of the following disclosure are illustrated in the accompanying figures, in which:

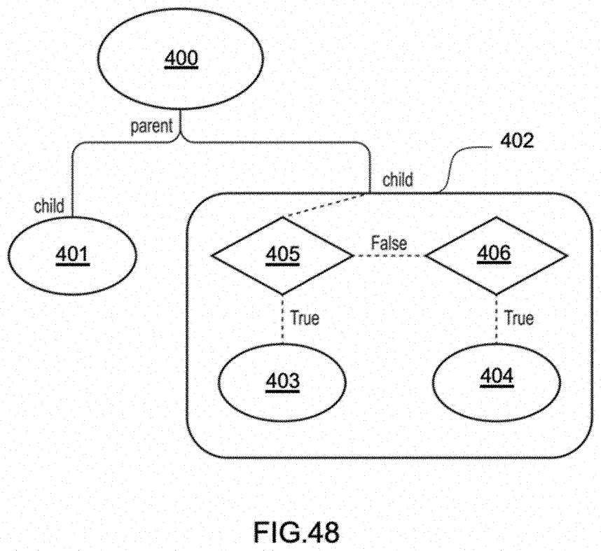

FIG. 48—is a diagram of an APL program structure with alternative child abilities;

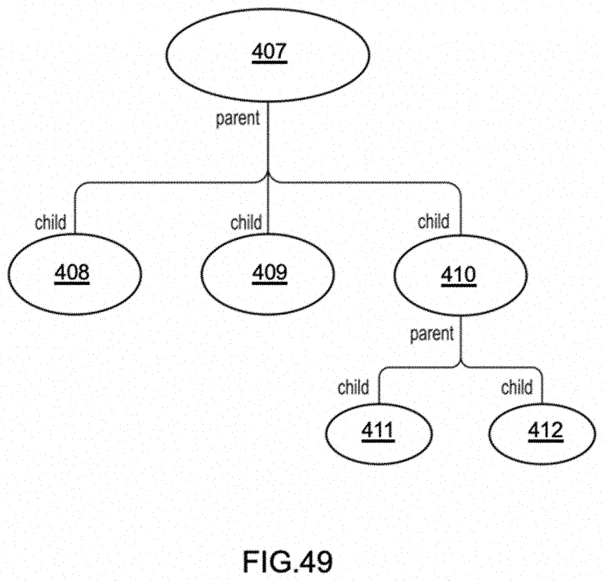

FIG. 49—is a diagram of an APL program structure with a child operation being a parent;

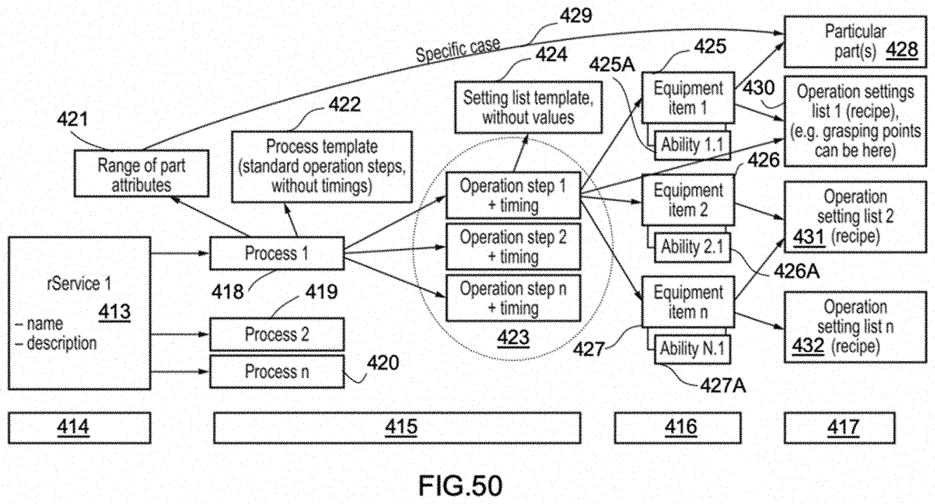

FIG. 50—is a diagram of a layered structure of rService;

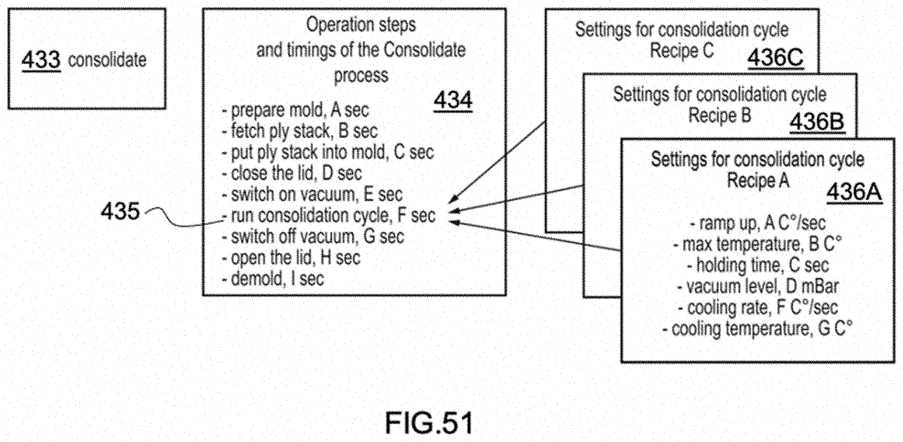

FIG. 51—is a diagram of a part of rService “Consolidate” structure;

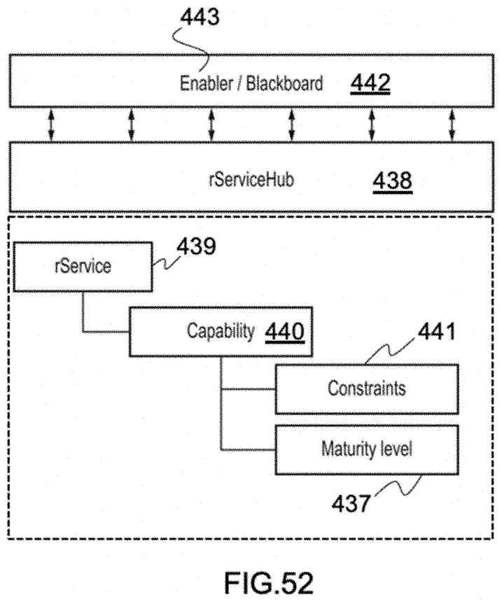

FIG. 52—is a scheme of interaction of rServiceHub and Operations Control System (OSC);

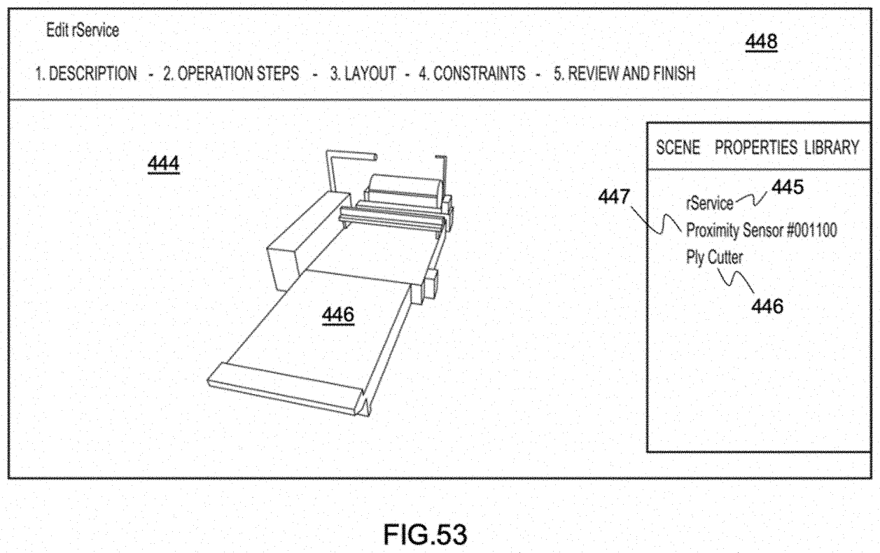

FIG. 53—is a 3D view of an rService layout;

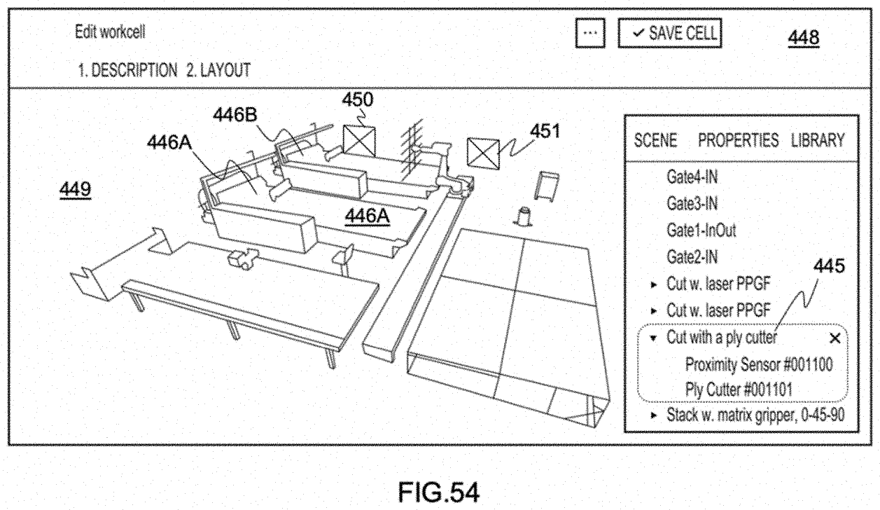

FIG. 54—is a 3D view of a workcell layout;

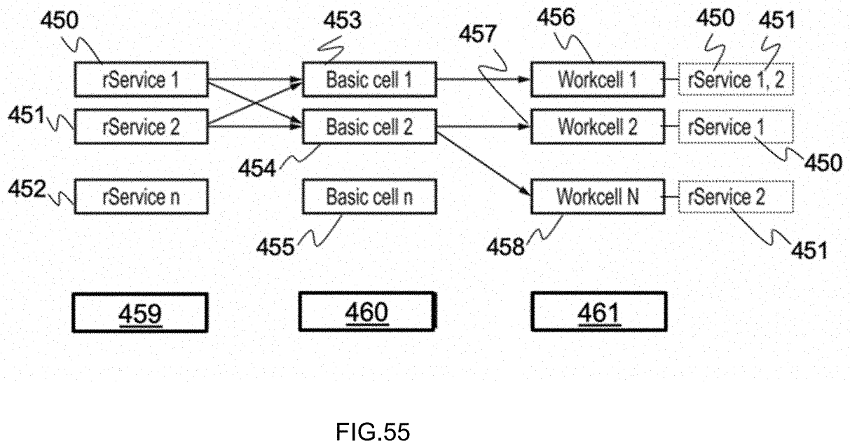

FIG. 55—is a scheme of allocation of rServices into basic workcells;

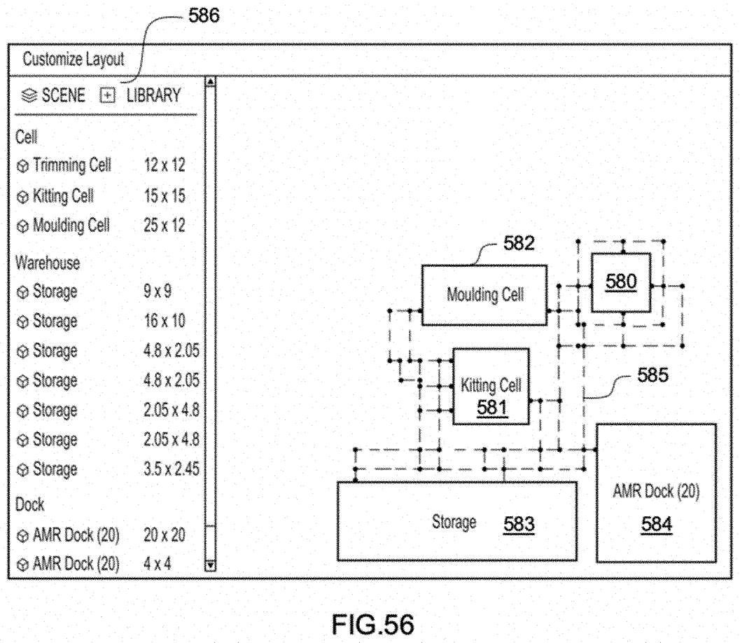

FIG. 56—is a view of a 2D simulation of a microfactory layout;

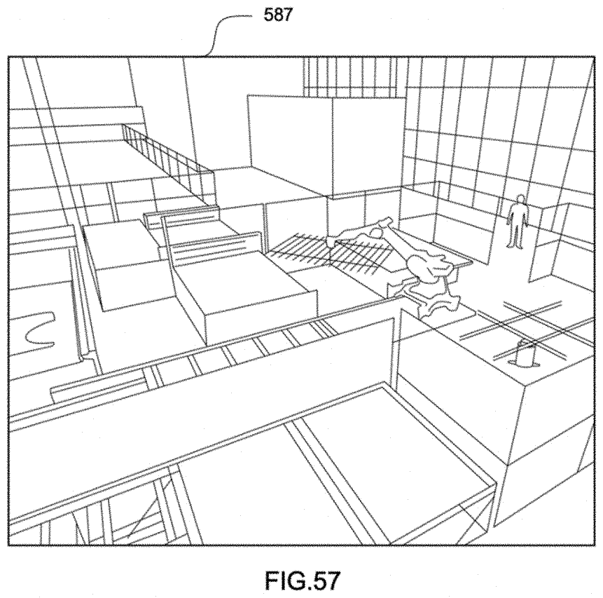

FIG. 57—is a view of a 3D simulation of a microfactory environment and operations;

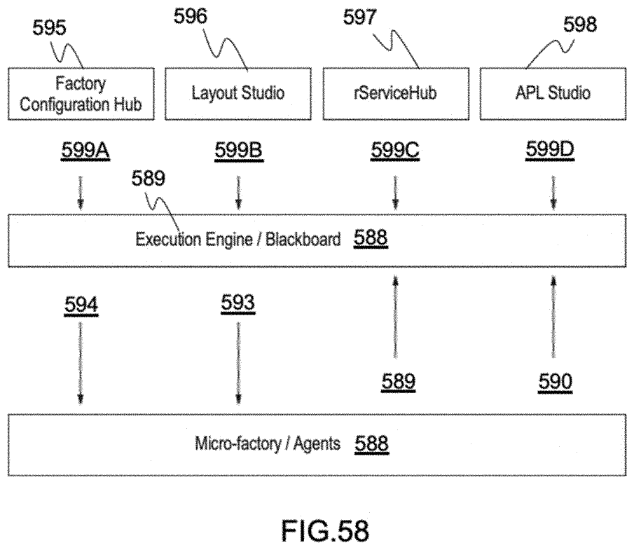

FIG. 58—is a scheme of main types of interactions provided through Blackboard OCS.

### DETAILED DESCRIPTION RELATING TO THIS SECTION E

Section E.1: Multi-Agent Robotic Environment

Arrival Robofacturing leverages a multi-agent model of a robotic production environment. Principles and features of this model are described below.

All active tangible (physical) and intangible (virtual) objects in a robotic production environment, as a system, are “agents” that provide “abilities” to the system. Ability is a is a simple, separate action performed by an agent including physical agent or virtual entity.

Agents comprise robotic agents such as workcells, machines, mobile robots, cameras etc., non-robotic agents such as human workers and operators, and virtual entities such as control programs, algorithms, data objects etc. For example, a robotic manipulator agent can provide an ability of “execute trajectory”.

Thereby, abilities can be divided into two groups by the type of agents they deal with:
abilities provided by physical agents; and
abilities provided by virtual agents, these abilities are also referred to as “services”.

Some abilities can be grouped in sets with sequential or parallel execution by one or several agents; such sets of abilities are referred to as “operations”.

One agent can provide different abilities, while the same ability can be provided by different agents including robotic agents (workcells, robots) and non-robotic agents (operators). For example, such an ability as “bring_part_to_cell” can be provided by an autonomous mobile robot (AMR) or by a human operator.

Non-active tangible and intangible objects in the robotic production environment are “resources”. Tangible resources are certain parts, workpieces, semi-assemblies, assemblies, etc. Intangible resources are software components and data.

To achieve flexible and autonomous production, a control system of the robotic production environment is to have a knowledge of state of the robotic production environment environment, agents, abilities, and resources to dynamically decide what agent to involve in each ability execution, when and how.

To this end, the control system of the Arrival robotic production environment, called Operations Control System (OCS), comprises a common communication layer of the robotic production environment, called “Blackboard”, that is a shared storage and data bus for all agents in the robotic production environment. In other words, Blackboard is a structured, shared global memory of the robotic production environment. Data about every object, resource and process in the robotic production environment is recorded on Blackboard.

In the Arrival Robofacturing model agents and abilities are logically separated and can be considered as objects of different levels of abstraction. The model is fully agent-agnostic as one ability can be provided by different agents. On the process's level of abstraction, it makes no difference what agent provides certain ability to the system. Consequently, abilities are defined and handled as independent objects of the system.

Some abilities need initial data and change the system's state. Such abilities can read from and/or write to Blackboard https://wiki.arrival.com/display/TRD/Blackboard. For example, an “open_gripper” ability needs information about a gripper, its availability, and its current state. After the ability has been successfully executed, it notifies the system about its state—for example, that the gripper is opened now. To do so, the ability sends a request via Blackboard application programming interface (API).

Thus, abilities can be also divided into two groups by their interaction with Blackboard:
abilities that read from and/or write to Blackboard; and
abilities that neither read from nor write to Blackboard.

It is worth noting that some abilities can relate to actions lasting certain time or even continuous processes or services. For example, a “post_image_data_from_cv” ability, once started, posts data from a camera until it is stopped. Such characteristic of the abilities fully complies with the Arrival's multi-agent model and does not affect the normal describing and handling the ability.

Resources, agents and abilities define the lowest level of abstraction of the Arrival Robofacturing model. More detailed disclosure of the OCS and Blackboard is provided in the following sections.

Section E.2: Arrival Process Language

Arrival Robofacturing is further based on a new, flexible, and dynamic approach for operations/process control and management in a robotic production environment.

All conventional MESs (manufacturing execution systems) control high-level operations in a robotic production environment in terms of separate PLCs/stations, using hard-coded workflow management programs, i.e., a production process (or a production plan) is always strictly pre-defined (pre-coded), and no dynamic changes in the process are possible.

Conventional software solutions for generic operations/process control can be divided into two types: Workflow Management Systems (WMSs) and Business Process Management Systems (BPMSs).

In general, WMSs apply either one of the following control approaches:
a control-flow approach when a process is defined as sequential/parallel operations each having a dependency on a finish state of previous operations; and
a data-flow approach when a process is defined as a set of actions and triggers to start new action, wherein each trigger is set by a state of certain data.

Similarly to the known MESs, all processes in WMSs and BPMSs are strictly pre-defined and hard-coded that does not allow making any changes in the process dynamically. Existing WMSs and BPMSs are hard to scale, and they are not fault tolerant as based on single central control unit.

To solve problems and address deficiencies of the prior art mentioned above, a new programming language for robotics operations/process management and control has been developed for Arrival Robofacturing, called Arrival Process Language (APL), which is a logic process language supporting both data and control flows and decision making.

In contrast to the conventional systems, the Arrival Robofacturing comprises Operations Control System (OCS) that is based on this new programming language for robotics, APL, enabling, by its unique structure, logic and features, a dynamic robotic process management (autonomous control), which is distributed, fault tolerant and highly scalable.

APL is based on multi-agent approach described above and provides for creating logic or semantic rules, described in APL programs, for dynamic, event- and data-based control of the robotic workflow. This allows effectively combining of control and data flows in the same management system. APL is the first and only logical, semantic-based language for robotic process management and control. With APL, an execution graph can be built to serve as a basis for a logic solver to control and manage a robotic production process or any other process in robotics, as described in more detail in the following sections.

APL is designed for defining tasks for agents and interactions between agents in the robotic environment by means of “rules”. In case of a task involving more than one agent, rules can rollout as a multivariate process to execute.

APL, by its design, provides for canonical data description of any robotic production process: it provides for a single form of data for all participants of any interaction and an unambiguous understanding of the context of the interaction.

The following concepts are defined and used in the level of abstraction of APL:
Ability—is a simple action performed by an agent including physical agent or virtual entity;
Operation—is a sequence of Abilities and/or other Operations; and
rService—is a physical system with an ability or an operation that this system can provide or perform;

The above-mentioned and other features and advantages of APL are provided by the design of the language as disclosed in detail below.

An APL program describes an operation defining rules for the operation execution in a robotic environment. This description must be sufficient to execute the program, thereby it contains all necessary information about rules, their parameters, an order of execution, preconditions, and any other conditions of execution of the operation.

Each APL program is structured in sections. Normally, an APL program description comprises the following sections:
signature
preconditions
rules
seq|parallel|flow { . . . }
constraints

The description of the operation begins with the operation signature. The operation signature represents a name of the operation and a list of its input and output parameters.

If, while running, the operation uses (reads) data from Blackboard, this data is input parameter(s) of the operation.

If the operation writes new data to Blackboard in result of execution, this new data is output parameter(s) of the operation.

An operation can have any number of input and/or output parameters or not have them at all. All parameters are listed in the operation signature.

Operation signature syntax is as follows. The signature comprises a name of the operation and its parameters listed in parentheses. To distinguish input and output parameters, add a service word out and a space before the name of each output parameter:

operation_name (input_parameter1, input_parameter2, out output_parameter)

Preconditions are conditions that must be satisfied before the execution; they can serve as criteria that an Execution Engine (EE) of the OCS checks to select an alternative. Preconditions can be used to check if Blackboard has the required data or if a particular field has a required value.

A precondition is represented by an expression that includes one operator and two operands. There are 8 types of operators that can be used in preconditions (they also can be used in constraints) to define the following conditions: match (syntax: %%), not match (syntax: !%), equal to (syntax: ==), not equal to (syntax: !=), greater than (syntax: >), greater than or equal to (syntax: >=), less than (syntax: <), less than or equal to (syntax: <=).

An operation can contain any number of preconditions joined by the following logical operators: AND, OR, NOT( )

Syntax: the preconditions section of an APL program contains the list of conditions enclosed within the curly brackets. If the section contains more than one precondition, all listed preconditions must be satisfied before the execution starts. Each precondition expression starts with the tilde ˜ character and has the following format:

˜<@path.to.parameter_value>[operator]<value>

The left part of a precondition is usually represented by a path starting from a variable or an explicit BB ID (Blackboard identifier) or a variable defined in the operation signature.

The right part can be represented by a constant, a variable defined in operation signature, or a path.

A path is a sequence of IDs and fields that describe how to find a specific structure or a value in Blackboard. A path consists of variables and fields. Variables refer to the ID of a structure in Blackboard. Fields describe how to find a particular value within the structure.

Syntax: all fields and variables within the path are separated by periods; to distinguish fields from variables, variables are marked with $ before the name, for example, as follows:

@varNamefield.@field_containing_id.another_field

Preconditions are usually used as a tool for selecting alternatives. However, it is also possible to use preconditions for a single function: in this case, the function will be executed if the preconditions are satisfied and fail to start otherwise.

Alternatives are abilities or operations that are interchangeable parts of the same execution flow. Abilities are selected by the Execution Engine, which is a part of the OCS, by checking their preconditions as shown in FIG. 48. As one can see, a parent operation 400 has a child ability 401 and a child 402 with alternative abilities 403 and 404, which selection in the execution is conditioned by preconditions 405 and 406. The selection of any alternative does not break the execution flow.

APL allows using multiple preconditions which is a powerful tool for defining complicated execution flows with multiple alternatives.

For example, an operation can be described so as it can be executed only if three preconditions are satisfied. To this end, it is needed to list all these expressions in the preconditions section, for example, as follows:

operation_name (param) {
preconditions {

~ @(<BB ID>).value.index != 0
~ @var1.field.value == “ready”
~ @var2.field1 %% {“type”: “my_type”}
}

All preconditions listed in the section must be satisfied one by one.

If we want to describe more complicated cases, for example, only the third and one of two first preconditions satisfied to start the operations, we can use logical operators, for example, as follows:

operation_name (param) {
preconditions {

~ (@(<BB ID>).value.index != 0 OR @var1.field.value == “ready”)

AND @var2.field2 %% {“type”: “my_type}

}

A common scenario is when one alternative is selected only if specific preconditions are satisfied, and another alternative is selected otherwise. This situation implies two mutually exclusive sets of preconditions. In APL, you can describe only one set of preconditions and use the service word default for the second alternative, as in the following example.

// Alternative1
operation_name (param) {
preconditions default
rules { ~ rule1 (param = param) }
seq };
// Alternative2
operation_name (param) {
preconditions { ~ @param.value.index == 0 }

rules { ~ rule3 (param = param) }

};

The above example defines that Alternative 2 is executed if the preconditions are satisfied and Alternative 1 is executed in any other case.

Moreover, the preconditions can be used to check for non-existent data. If an operation or an alternative can start only if Blackboard does not contain particular data, preconditions can be described with an insoluble path and the operator not_match-!%.

For example, we want to make sure that the structure in Blackboard related to variable var does not contain non-existent_field. To check it, we can write the following expression:

operation_name (param) {
preconditions { ~ @var.non-existent_field !% { } }
rules { ~ rule3 (param = param) }
}

If non-existent_field does not exist, the path is insoluble and cannot be matched even to an empty object { }, so this precondition is true.

Finally, if the preconditions section is empty or default for more than one alternative, the Execution Engine will select an alternative randomly.

To understand how a complex operation is described in APL, we need to disclose the concept of Parents and Children provided in APL design for describing relationships between different operations and abilities.

An operation that comprises other abilities or operations is called a parent operation for all these abilities and operations.

Abilities and operations that are parts of another operation are children of this operation. An operation can be both a child of other operation and a parent of other operations and abilities, as shown in FIG. 49. FIG. 49 illustrates a parent operation 407 that has child abilities 408 and 409, as well as a child operation 410, which in turn is a parent for child abilities 411 and 412.

Let us now describe Rules. A rule is a call of an ability or an operation within the APL program. While discussing the structure of APL programs, we can refer to a rule and to an ability/operation it represents interchangeably. All rules are listed in the section rules.

There are two types of rules:

internal rules—represent internal abilities, which are out-of-the-box, built-in abilities provided by the OCS platform.
external rules—represent all other abilities that performed by agents, resources, or services.

The rules can also be combined in blocks and have a nested structure when a child rule is a parent of other rules, which, in turn, can have their own children.

APL supports the concepts of Calls and Instances supplementing and extending the concept of Rules. Some operations can comprise the same ability/operation twice or more times. Each rule appears in the section Rules as many times as the ability or operation represented by it must be executed. Each appearance of the rule in the operation description is called a rule call.

To distinguish different calls of the same rule in one operation, we use instances. An instance is an identifier of a call added after the name of a rule.

Syntax: each call is marked with the tilde ˜ character before the rule name. By definition, a rule is an ability signature, so all rules are listed with their parameters within parentheses. In contrast to parameters in operation signatures, the parameters of a rule must be not just listed but also defined in its signature.

Setting Parameters: input parameters of a rule are set as follows:

˜<rule_name>(<parameter_name>=value>)

Input parameter values can be of the following types: constants, variables, paths.

To define input parameters, you can also use arithmetic expressions, accessing elements of an array, and accessing fields of TaskDescription.

Output parameters of a rule require a service word out before the parameter name:

˜<rule_name (out<parameter_name>=value>)

Output parameter values can be only of the variable type.

In an APL program, the section ‘rules’ contains rules' signatures enclosed within the curly brackets:

rules {

~ rule1(params = param_in)
~ rules2(out block_out = param_out)

}

An input parameter of a rule must be either defined in its parent's signature or be an output parameter of another rule that is already executed. If an output parameter is listed in an operation's signature, it must be defined as an output parameter of one of its children.

Instance is separated from the rule name by the hash # character. If a rule has an instance, we can refer to this rule only by combination of its name and instance.

rules {

~ rule#instance1(params = param_in)
~ rule#instance2(params = param_in)

}

Furthermore, if it is required to execute the same rule several times in a row, APL provides for the use of loops to make your program shorter.

There are two types of loops:

repeat(<number>) - the execution of the rule repeats a certain number of
times;
while(<condition>) - the execution of the rule repeats while the described
condition is true.

The number of repetitions in the loop repeat can be presented by a constant if it refers to a positive integer value, or by a path if its resolved value is a positive integer.

The flow (seq, parallel) section of an APL program defines the order in which rules must be executed.

If an APL program contains only one rule, this section can be omitted, but if the script contains two or more rules, this section must be present in one of the following formats:

seq—all rules are executed sequentially, i.e, in the order in which they appear in the script;
parallel—all rules are executed in parallel, i.e., they start at the same moment;
flow { . . . }—some rules must be executed only in a specific order as specified in the section; at that, rules not mentioned in the section are executed in parallel.

The section flow is enclosed within the curly brackets; each dependency expression starts with the ˜ character. The section cannot be empty.

func(param_in, out param_out){
rules{

~ rule1(some_in = param_in)
~ rule2( )
~ rule3(out var = param_out)

} flow {

~ rule2 <− rule1(started)
}

};

In the above example, the rule2 is ready for execution only after rule1 gets the state started. Rules rule1 and rule3 do not have any dependencies on other rules' states, so they will be executed in parallel.

Let us now describe the constraints section of an APL program.

Constraint (a constraint expression) is a condition that must be fulfilled to execute an ability.

Constraints are often used to describe requirements for agents. For example, the sequential execution of abilities pick and place makes sense only if both abilities are executed by the same robot and gripper. Constraints are also used to ensure technical requirements; for example, a part can be picked only by a particular robot model because others have insufficient load capacities.

Apart from resources (agents), constraints can also describe any other conditions required for execution.

Syntax: the section constraints of an APL program contains the list of constraint expressions enclosed within the curly brackets. If the section contains more than one constraint expression, all listed constraints must be satisfied to execute the operation The section contains constraints for all rules of the function; the section cannot be empty.

The same 8 types of operators as in preconditions (described above) can be used in constraints. Logical operators AND, OR, NOT( ) can also be used in constraints, similarly to preconditions.

A constraint expression includes one operator and two operands. The operands in constraints can be represented by a constant, variable defined in a rule signature, variable which is an out parameter of another rule, path starting from a variable or an explicit BB ID, and reference to the TaskDescription.

Each expression starts with the tilde ˜ character and has the following format:

˜<@path.to.the.resource>[operator]<value>

A constraint expression usually contains the reference to the TaskDescription of a rule to which the constraint is applied.

For example, let us consider an operation that has three children—rule1, rule2, rule3, which must be executed with the fulfilment of the following constraints:
rule1 must be executed by a particular agent (a robot);
rule2 and rule1 can't be executed by the same agent;
rule3 and rule1 must be executed by the same agent.

All these expressions in the constraints section can be written as follows:

operation(param1, param2, robot) {

rules {

~ rule1(param1 = param1, robot = robot)
~ rule2(param2 = param2)
~ rule3( )

} seq
constraints {

~ rule1.@provider_id.@resource_id.name %% @robot.name
~ rule2.@provider_id.@resource_id.name !=
rule1.@provider_id.@resource_id.name
~ rule3.@provider_id.@resource_id.name ==
rule1.@provider_id.@resource_id.name

}};

By default, all constraints listed in the section must be satisfied one by one.

In APL it is possible to select the same/different resources (agents) for different rules. To select the same (or different) resources to execute particular abilities, one can use rule names in the left and right parts of the constraint expression, for example, as follows:

operation(param1, param2, robot) {

rules {

~ rule1(param1 = param1, robot = robot)
~ rule2(param2 = param2, robot = robot)

} seq
constraints {

~ rule1.@provider_id.@resource_id.name ==
rule2.@provider_id.@resource_id.name

}};

At that, it is not possible to set such constraints for parallel rules.

The design of APL described above leverages the multi-agent model as well as agent-agnostic approach. At that, APL, by its design, provides for creating logical rules of any degree of complexity for dynamic, event- and data-based control of any robotic workflow.

Thereby, APL allows effectively combining of control and data flows in the same management system which is one of the enablers of the Arrival Robofacturing.

As one can see from the above, the design of APL enables to program a logic of the robotics operations flow and answer to questions as follows:
What to execute—by describing operations,
How to execute—by defining the operations flow dependencies,
When to execute—by defining preconditions when the operations could be started,
Who to execute—by defining constraints to particular executors of the operations.

Section E.3: Robofacturing Services (Rservices) and Rservicehub

A robofacturing service or rService is a combination of manpower, hardware and software components working together and integrated with OCS of a robotic production environment to perform a certain set of atomic operations on certain objects.

The objects can be tangible or intangible. The tangible objects are certain parts, workpieces, semi-assemblies, assemblies. The intangible objects are software components and data. A rService may be applicable for operations on very specific objects or on a range of objects.

A rServiceHub is a library of robofacturing services including equipment and layouts required for them.

The rServiceHub allows owners of rServices (operators, service providers) or its parts to publish and maintain trustworthy information about their products so that this information can be used for robofacturing process planning as well as to get feedback about their rServices or its parts.

In order to support the robofacturing process planning, rServiceHub is configured (comprises an application programming interface (API) configured) for automatic selection of suitable rServices for the provided operation and resources.

In the Arrival Robofacturing, the following information is defined for each rService:
Description, which contains basic properties of the rService: Name, Category, Operation name etc.
Operation (process) sequence and operation steps.

Each operation of the rService should have an operation sequence description, which contains one or more operation steps. For each of the operation steps, required resources are assigned so that the rServiceHub is able to calculate and present to a user a cost of certain step or of the whole operation. An APL script can be used to define each operation step or the operation sequence.

In general, the following principles are defined for the operation sequence:
a. To create an operation sequence it is required to add operations steps to it.
b. An operation step may be repeated one and more times.
c. Operation sequence can comprise parallel operation steps.
d. One or more operation steps can be added to the operation sequence automatically, using an existing operation template. An operation template contains some predefined operation steps with default operation times.
e. A process sequence can combine operations added manually and those added automatically, from a template.

Each operation step description can contain the following fields:
a. Sequence number of the operation step in the current operation sequence.
b. Operation step name.
c. List of equipment, which is required for this operation step. The equipment can be presented in the form of links to particular equipment units, for example, as listed in an Equipment Library, or in the form of a layout.
d. (optional) List of workers, which are required for the operation step, containing a worker tag and/or a worker skill for each worker.
e. Operation step time. At that, if an operation step is linked to one or more recipes, its step time may depend on timing parameters given in the recipes.
f. List of recipes. Each operation step may have zero or more recipes.

Recipe is a description of one set of operation step parameters and their values.
a. Each recipe has a condition of its applicability. The applicability may depend on material of the parts, bolt size, bolt length or other parameters.
b. A decision, what recipe of the available ones should be used for the operation step, is taken during the product design to rService matching. For example, for a welding operation defined in the metadata of the product design, an rService “Welding” will be selected. But if there are aluminium parts in the product design, then the recipe “Welding of aluminium” will be used. For steel parts the recipe “Welding of steel” will be used.
c. Parameters of a recipe, comprising temperature, speed of heating, speed of cooling, heating duration etc.
d. If the recipe defines any durations, they will affect the operation step time and overall process time.
Layout of the rService, which can be used as a template for creation of a workcell layout or of rServices of a higher level.
Applicability constraints of the rService.

Applicability constraints for an rService define conditions and requirements of an application of the rService. The applicability constraints are used to find a suitable rService for a given operation and parts.

For an rService comprising operation on parts (workpieces), the applicability constrains usually comprise supported part attributes to define that each process in the rService is applicable for a range of parts (workpieces) with specific attributes.

The part attributes can be:
a. Either specific part numbers (one or more part numbers).
b. Or a set part attributes, not bound to specific part numbers.
Example of such attributes are:
   i. maximum part weight, e.g. in kg;
   ii. maximum part bounding box (width, length, height/thickness), e.g. in mm;
   iii. material of parts.

In addition, the applicability constraints can be operation specific. For example, for a “Fasten” operation the applicability constraints can comprise a “bolt type” constrain, for a “Screwing” operation—a constrain of “bolt size”, and for a “FDS-fastening” operation—a “FDS size” constrain can be set.

The description of the rService further comprises:

ID—a unique identifier of the rService, which is used to address this particular rService, and
Revision—an identifier of the version of the rService. When a rService created, its revision can be set in a default value such as ‘AA’. Revision of the rService is incremented automatically after any change of the rService.

The above-described structure of an rService is illustrated in FIG. 50. FIG. 50 illustrates a layered structure of the rService 413 consisting of a description layer 414, Processes/Operations layer 415, Equipment layer 416 and Settings layer 417. The processes/operations layer comprises data about all processes 418, 419, 420 comprised in the rService, a range of part attributes 421, a process template 422, and a complete set of operation steps 423 including timing of each step for each of the processes 418-420. In addition, the set of operation steps 423 or an individual operation step of the set can comprise a setting list template 424 defining a content and formal of the setting list for the operation step or steps.

The equipment layer 416 comprises a list of equipment items 425, 426, 427 required for performing each operation step of each process 418-420 of the rService. At that, each equipment item is assigned with a particular ability 425A, 426A, 427A provided on the basis of the equipment item and the operation step. Finally, the settings layer 417 comprise a list of particular parts 428 required for performing the operation steps of the rService, which is to be matching 429 with the range of parts attributes 421, and all available recipes 430, 431, 432 for each operation step of each set of operation steps 423 of the rService.

FIG. 51 illustrates a part of a structure of the rService 433 providing the operation “Consolidate”, wherein one of the operation steps 434, the step 435 of “running consolidation cycle”, has several available recipes 436A, 436B and 436C, each providing different settings for the consolidation cycle.

The rServiceHub uses constraints of the rServices to match rServices to operations defined in a product design metadata, i.e. to determine those rServices that support for operations identified in or from the metadata of the product design.

The rServiceHub is configured to define exact input items coming from the product design metadata and match them with constraints of the rServices.

To perform the matching, the parameters defined in a product design metadata are checked against the corresponding constraints defined in the rService.

The equipment used by an rService is not considered for matching. It can only be used by the front end to provide suggestions to a user while defining constraints for the rServices.

Each parameter of metadata of the product design, or of a part of the product design, is checked against one or more corresponding constraints that are defined for an rService.

For each input parameter defined in the product design metadata, if there is the rService comprising a corresponding constraint, then =>the parameter is validated against the constraint; if it is not matching, then the rService is “filtered out” from the result; if it is matching—the rService is included into the result.

By way of example:
1) If an rService comprises part bounding constraints say height=100, and product design input parameters contain a part bounding constraint value height=100, then the rService would be MATCHED
2) If an rService comprises part bounding constraints say height=100, and product design input parameters contain part bounding constraint value height=101, then the rService would be NOT MATCHED

The rServices define the next level of abstraction of the Arrival Robofacturing model, above the levers of abstraction of resources, agents, and abilities.

As follows from the above, an rService consists of hardware (equipment+layout), software (operation sequence description, for example, an APL script) and/or manpower and provides one or more production capabilities.

A production capability corresponds to a particular operation on one or more parts, workpieces, assemblies, and other resources. In addition, a maturity level 437 can be assigned to each rService. FIG. 52 illustrates an interaction scheme between the rServiceHub 438 storing a library of rServices 439 and Operations Control System (OCS) of a microfactory.

The rServiceHub 438 comprises a plurality of rServices 439, each defining production capability 440 provided by operations of the rService, in accordance with relevant constraints 441. The rServiceHub is communicatively connected with Blackboard 442 and an Enabler 443 (such as an Execution Engine) of the OCS of the microfactory or another robotic production environment. An information about any updates or modifications of the available rServices, for example, when a new rService is created, is posted by the rServiceHub 438 on Blackboard 442 so as the information becomes automatically available for the OCS of the microfactory. In such a way, the OCS is able to use the new rService in the microfactory almost simultaneously after the rService is registered in the rServiceHub.

In the Arrival Robofacturing system, an rService can be simulated to prove its operation feasibility and determine KPIs of the same, for example, through writing a model of the rService on Blackboard and running a Simulator engine to simulate the rService layout and an execution of the operation of the rService in a virtual environment, as shown in FIG. 52.

The possibility of estimating KPIs of the rServices in the rServiceHub, for example, by simulations, is an important feature of the Arrival Robofacturing.

For example, the following KPIs can be estimated using an rService description.

### 1. Operation Step Cost

Operation_step_cost=Operation_step_CAPEX+Operation_step_OPEX

Operation_step_cost_per_second=Operation_step_cost/Operation_step_time

### 2. CAPEX of One Operation Step

Operation_step_CAPEX=Step_equipment_cost_per_second*Operation_step_time

Step_equipment_cost_per_second=((Sum of equipment_cost)/(CAPEX_YEARS*WORKING_DAYS_PER_YEAR*WORKING_HOURS_PER_SHIFT*60 minutes*60 seconds*SHIFTS_PER_DAY))

wherein the following values can be used:

### CAPEX_YEARS=5

### WORKING_DAYS_PER_YEAR=254

### WORKING_HOURS_PER_SHIFT=8

### SHIFTS_PER_DAY=1

### 3. OPEX of One Operation Step

Operation_step_OPEX=(Electricity_cost_per_second+Manpower_cost_per_second)*Operation_step_time=(Sum of Equipment_unit_power_consumption_cost_per_second+Sum of Worker_cost_per_second)*Operation_step_time

Equipment_unit_power_consumption_cost_per_second=(Power_consumption*ELECTRICITY_PRICE_PER_kWh)/(60 minutes*60 seconds)

Worker_cost_per_second=ANNUAL_GROSS_SALARY/(WORKING_DAYS_PER_YEAR*WORKING_HOURS_PER_SHIFT*60 minutes*60 seconds)

### 4. Operation Cost

Operation_cost=Sum of Operation_step_cost

Operation_CAPEX=Sum of Operation_step_CAPEX

Operation_OPEX=Sum of Operation_step_OPEX

Total_cost_of_rService_Equipment=Sum of Equipment_cost

The rServices implement and extend the concept of modularity of the Arrival system. The rServices are independent modules, including individual layouts of the services, from which a robotic production environment can be composed. An exemplary 3D view 444 of a layout of the rService 445 “Cut with a ply cutter” is illustrated in FIG. 53 as it can be displayed in a user interface (UI) 448 of the rServiceHub. As one can see the given layout comprises quite a limited set of equipment, consisting of a ply cutter 446 and a proximity sensor 447 (ID #001100) only, which is enough for providing the operation of the given rService.

Thereby, an rService is self-contained object and can be included directly into the production environment layout. On the other side, the rService approach and rServiceHub allow optimizing the layout of the production environment by grouping up different rServices to different workcells.

Indeed, in the Arrival Robofacturing model, we have several entities—workcells, rServices, equipment items that are dependent on each other. For instance, a workcell definition can rely on the equipment items contained in the linked rService.

Correspondingly, the rServiceHub includes a library of workcells with developed layouts and rServices assigned thereto. In a workcell editing tool of the rServiceHub, it is possible to define a new workcell based on the information about rServices, which are parts of this cell. It is also possible to review and edit existing cells.

In an edit mode of a workcell it is possible to add rServices to it and position them on the cell layout as predefined building blocks. It is also possible to define here gates of the workcell and to specify gate type (input, output or both). Information about workcell layout and gates is used further in Layout Studio of the Arrival Robofacturing which is described below, in order to create a production environment layout and to simulate internal logistics.

The rServiceHub further provides for simulation and visualization of the workcells and operations of the rServices assigned to the workcells. In this way, the rServiceHub enables to create fully tested and ready-to-deploy workcells including cell layouts and rServices.

FIG. 54 shows a 3D visualization 449 of a workcell layout in the UI 448 of the rServiceHub. It is shown that the workcell layout has two gates 450, 451 and the rService 445 “Cut with a ply cutter” is assigned to two ply cutters 446A and 446B in the workcell layout. In can be seen that the workcell layout of FIG. 54 is much more complicated and developed than the individual rService layout of FIG. 53.

At the same time, it is necessary to understand that the rServices, the workcells and the equipment items reside on different levels of abstraction of the Arrival Robofacturing model. Workcells can host different rServices at the same time and can change the hosted rServices over time, depending on current tasks and the equipment items provided in each workcell.

Thereby, the production environment layout can be effectively optimized based on the knowledge of the production requirements and the rServices as provided by the Arrival Robofacturing model.

For example, rServices that are executed consequently can be assigned to the same workcell or adjacent workcells in the production environment layout to decrease inter-operations time and simplify routing of AMRs delivering workpieces to the workcells.

An example scheme of allocation or assignment of different rServices 450, 451, 452, into basic workcells 453, 454, 455, in a production environment is shown in FIG. 55. In result of the allocation a workcells 556, 457 and 458 are defined so as the workcell 456 hosts two rServices 450 and 451, while each of the workcells 457 and 458 hosts one rService. Thus FIG. 55 illustrates three different levels of abstraction in a microfactory description: level 459 of rServices, level 460 of basic cells, and level 461 of workcells.

With the developed rServiceHub, a product design can be analysed and decomposed into an operation sequence and a set of rServices can then be selected to handle and assemble the product accordingly.

If an appropriate rService required by the product design is not present in the rServiceHub, a new service can be requested from production engineers and/or robotic service providers.

The rServiceHub is an important part of an internally developed technological platform comprising robotic workcells, robotic equipment and tooling, mobile robots (AMRs), robotic operations control system and software that serves an a basis of Arrival Robofacturing system.

Section E.4: Robofacturing Process (rPROCESS) Studio

The rServiceHub described in the preceding section is in essence a smart library of rServices, pre-developed and described according to the Arrival Robofacturing model and principles, that allows to select proper technology base quickly and effectively for each product element and each production action. The rServiceHub comprises a plurality of rServices that can be used in production of any product especially vehicles and vehicle components.

Each rService in the rServiceHub comprises service description with full information about an operation performed by the rService, applicable constraints, equipment, resources and a layout of the equipment required for the operation performance.

Thereby, the rServiceHub facilitates quick and effective matching the available rServices to each operation identified in or from a Bill of Process (BOP) of the subject product, metadata of the product design or directly from the product design analysis.

The rServiceHub is used by the following tool of the Robofacturing system called Robofacturing process (rProcess) studio to create production processes for producing the subject product by means of the rServices.

Robofacturing process (rProcess) studio is a tool for creating a variety of possible production processes that satisfy all input constraints for producing any given products or goods by robots, humans, or both. The rProcess studio is configured to create production processes in automated or semi-automated manner based on the plurality of applicable rServices provided by the rServiceHub.

In particular, the rProcess studio is configured to implement the following steps:
1. Receive a product configuration data, preferably, in the form of an Engineering Bill of Materials (eBOM) reflecting the product as designed by engineering.
2. Obtain requirements and constraints for a production process to be created, such as maximum total assembly cost, time etc. The requirements and constraints are obtained from a database or inputted by a user.
3. Generate a Manufacturing Bill of Materials (mBOM) of the product containing all the parts and assemblies required to produce the product, by analyzing the product configuration (eBOM) and splitting it into parts and subassemblies.
   The mBOM is generated in the form of a tree structure such as the following:

Product=subassembly A+subassembly B+ . . . =(subassembly A.1+subassembly A.2)+(subassembly B.1+subassembly B.2+)+ . . . .
Another example of the mBOM is as follows:

1) Product=subassembly A+subassembly B;

2) subassembly A=subassembly A.1+part A.2+subassembly A.3;

3) subassembly B=part B.1+subassembly B.2.
At that, the rProcess studio is configured to considers not only assembly operations (such as part1+part2=part3), but also different production (transformation) operations (such as part1+cut_edges=part1′).
In particular, to generate the mBOM, the rProcess studio is configured to:
   a. define connections (mates or joints) between parts and subassemblies, which are to be connected, including operations required to implement the connections.
   The connections are referred to as “mates” or “joints” and can be defined based on the eBOM and/or metadata of the product design, or directly from the product design analysis. Each mate includes an operation which is required to implement the connection.
   b. define dependencies of mates between each other, including dependencies that relate to an order of performing the connections (what parts are to be connected at first and what parts can be connected later).
4. Create one option of the production process.
5. For each mate in the production process, determine an appropriate technology by selecting a matching rService which can execute the required operation. If two or more rServices are matching to the mate, all of them are “attached” to the mate as options.
6. Calculate KPIs for the production process including minimum production cost, minimum production time etc.
7. Repeat steps 4 to 6 for all possible production processes.
8. Output the result in the form of n descriptions of options of the production process, each including data about required rServices, equipment and time of the production. In other words, the rProcess studio outputs a data object being a combination of the mBOM, a Bill of Process (BOP) and a Bill of Equipment (BOE). In the Arrival Robofacturing model, such production process description provided by the rProcess studio is referred to as Robofacturing Bill of Materials (rBOM).

The output of the rProcess studio (rBOM×n times) can be directly used in a Layout Studio for designing a robotic production environment layout.

In addition, the rProcess studio is configured to provide a feedback about a feasibility and KPIs of the production process of the given product to all interested parties such as designers, engineers, production managers etc. This feature is especially valuable for enabling a quick and automated feedback to a designer about the production feasibility and KPIs of all design solutions almost at the time of creation the design of the product.

In the automated mode, the rProcess studio conducts the above-mentioned steps automatically, without any user input, based on the plurality of applicable rServices, the product configuration and design data and all production requirements and constraints that can be obtained from a database.

In the semi-automated mode, the rProcess studio provides a user with options available at different steps, including separate production operations, sequences of production operations, related rServices and technical base (equipment and equipment options), through a user interface (UI), preferably a graphical UI. The UI is configured to allow the user to manually choose preferred options, define and/or correct production requirements, constraints, and dependencies between mates. The rProcess studio can then generate or update options of the production process based on the user's input. In alternative or in addition to the above, the user can fully define one or more production processes through the UI of the rProcess studio.

Thereby, the rProcess studio provides at least the following benefits:
it enables instant feedback on robofacturing feasibility and KPIs, such as costs, for a product or assembly being designed so that the design process can be accelerated and be more cost-effective.
it provides rBOM including all robofacturing processes data required to design an optimal robotic production environment layout for producing the product.

We can generalise the above to:

An automated or semi-automated system for creating a Robofacturing Bill of Materials (rBOM) that describe a process of production of a product of given design, including data about robofacturing services, equipment and time required for the production, wherein an Engineering Bill of Materials (eBOM) and a Manufacturing Bill of Materials (mBOM) are used for the creating of the rBOM that satisfies input constraints.

An automated or semi-automated system for creating a Robofacturing Bill of Materials (rBOM) that describe a process of production of a product of given design, including data about robofacturing services, equipment and time required for the production, wherein the system is configured to provide a feedback on robofacturing feasibility and costs of producing the product, its part or subassembly.

Section E.5: Factory Layout Studio

A mentioned above an rBOM created by the rProcess studio can be used in the next tool of the Robofacturing system—Factory Layout Studio (or Layout Studio), to design a layout of an autonomous robotic production environment or a Microfactory, including a complete production process description, logistics and a Bill of Equipment.

Factory Layout Studio (FLS) is a tool for planning a configuration (layout) of a new microfactory and reconfiguration of existing factories. FLS is configured to find the best possible microfactory layout to meet user-defined target values and optimality criteria. FLS is further configured to output the right layout metrics to make the decision process smooth and convincing for a user or an automated tool/system. Factory layout consists of geometric and logic specifications of the robotic production environment including production logistics provided by AMRs.

During the layout design process, FLS provides, in an automated or semi-automated mode, for:
defining a rule of the creating/reconfiguration of a robotic production environment layout;
gathering required data in dashboards with robotic production environment statuses;
monitoring a progress of the robotic production environment creation and related KPIs.

With FLS, the following benefits and advantages are achieved:
speed up layout feedback cycles from months to days, to support a radically rapid production design process of about 6 months to SOP for a new vehicle.
provide rapid layout evaluation to layout engineers with simple and fast layout and simulation logic modelling and fast simulation of production, assembly, and logistics processes.
seamless transition between layout engineering phase and operational phase by providing layout data to downstream tools.

For proper operation of FLS it is required that eBOM and rBOM for a product design to be produced in a microfactory are available for FLS (for example, provided by rProcess studio), and that all rServices and related workcell layouts are available for FLS in the rServiceHub.

In FLS, the layout design process comprises modelling and simulating a layout by the following steps:
1. Creating a new robotic production environment project and giving it a name.
2. Selecting or imputing eBOM and rBOM of the desired product to import the production process and workcells needed for the layout modelling and simulation.
3. Selecting or uploading parameters of a robotic production environment facility.
4. Generating a possible robotic production environment layout and modelling it by means of an automated layout design tool.
The robotic production environment layout generation is conducted by the automated layout design tool using an optimization algorithm, that is, by setting and solving an optimization problem, in a similar way to the auto wiring algorithm as disclosed in Section D.
In the given case at least the following constraints and rules as defined:
   The layout is to comprise at least one storage buffer and at least one AMR docking station of a type compatible with each type of AMRs used in the layout.
   One-way roads for AMRs movement between the workcells are to be used in a road network wherever possible to reduce congestion and logistical bottlenecks.
   If one-way roads are used, it is required that all AMRs can always reach the docking station, any required workcell gates, and, optionally, the storage buffer through the road network.
   At least two AMRs per workcell are to be used.

AMR docking stations are used to charge the AMRs and park them. As defined, there must be at least one AMR docking station present in any robotic production environment layout. Each docking station is assigned with certain type and quantity of AMRs to be used in the following simulation.

Storage buffers are used to buffer safety stock of semi-finished goods, workpieces, and assemblies. For each storage buffer it is specified from what workcells the semi-finished products, workpieces, and assemblies can be buffered. Optionally, an output batch size is specified for the storage buffer.
5. Editing the model layout, if necessary, including:
   specifying the exact coordinates of one of more workcells and/or other elements within the model layout.
   adding or removing workcells and/or other elements from the model layout.

The editing can comprise both above options, for example, a new workcell from the rServiceHub can be added and then its position (coordinates) within the model layout can be specified.
6. Initiating a simulation of the production process with the model robotic production environment layout by a simulation tool of FLS to obtain KPIs of the production process in this layout.

If any error occurs, changes to the model layout can be made automatically or manually to fix the error. A new cycle of modelling and simulation of the updated layout is initiated afterwards.

Preferably, the simulation tool of FLS is configured to implement a two-dimensional (2D) simulation of the layout and the production process, for example, as illustrated in FIG. 56.

By way of example, FIG. 56 shows a 2D simulation view of the microfactory layout comprising three workcells, a trimming cell 580, a kitting cell 581 and a moulding call 582, a storage 583, an AMR docking station 584 and an AMR road network 585. On left side of the drawing in FIG. 56 shown in a list 586 of available workcells and other elements from the rServiceHub that can be used in the given robotic production environment layout; all the elements in the list 586 are provide with their dimensions in the layout to enable a user estimating initially whether each element is applicable to the current layout or not.

2D layout simulations in FLS provide for not only geometric simulation of the layout but also for simulation of the production process logic including logistics. At that, 2D simulations are simplified and require less computing power that allows essentially accelerating the simulation process at step 6. Furthermore, FLS is configured to realize both layout design and simulation within the same system which further facilitates and accelerates the layout design and validation process.
7. Repeating the steps 4 to 6 for all possible robotic production environment layouts that can be generated by the automated layout design tool.
8. Comparing the resultant KPIs of all the possible robotic production environment layouts to select an optimal layout.

The optimization problem of the given case is much more complicated and non-linear than the one solved by the auto wiring algorithm of Vehicle Builder as disclosed in Section D.

In the given case required is an optimization of a robotic production environment configuration (layout) with a given production process for a product or multiple products in terms of all the variety of options of arrangements of the workcells, warehouse interfaces, charging stations, AMR road network configurations etc. Simultaneously, it is required to find an optimal solution in terms of all the robotic production environment KPIs and metrics, such as workcells, equipment and resources utilization, production time, production rate, CAPEX, OPEX etc.

That is why the automated layout design tool is configured to find a partial optimum of the problem in each cycle and generate a plurality of possible robotic production environment layouts.

To this end the automated layout design tool is configured to use at least one the multiple known techniques including linear programming, metaheuristics, e.g. genetic algorithms, machine learning such as reinforcement learning and graph neural networks, with taking into account the above-defined constraints and rules. In addition, or in alternative to this, the automated layout design tool can be configured to use several of the know techniques applied sequentially to different sub-problems, in a similar way to the auto wiring algorithm.

Thereby, the above-described layout design process allows determining an optimal robotic production environment layout and testing it by means of 2D discrete event simulations.

As follows from the aforesaid, Layout Studio is configured to provide the following functions:
design a microfactory layout that meets demand requirements and cost targets;
automatically create layout options and propose an optimal option;
streamline the decision and approval process, so that production can start earlier;
analyse all design and production data for a product (BOP, eBOM, mBOM, rBOM);
test material flow and the KPIs of a layout by initiating a layout simulation;
automatically generate of a big number of applicable layouts to select an optimal one;
explore different layouts and compare their KPIs with each other; and
determine the optimal robotic production environment layout for the given production process.

After that stage, the Robofacturing system has a complete information about the product design, required production process, rServices and equipment, and up to an optimal robotic production environment layout. Thereby, at this stage it becomes possible to generate the complete Factory Configuration Model (FCM) including all information and logic required for production of a desired product or products in a robotic production environment such as a microfactory.

Section E.6: Factory Control Model and Operations Control System

As mentioned above, after the layout design process for a microfactory to produce a target product or products of given design, a Factory Control Model (FMC) can be build.

FCM is a master robotic production environment model in the form of production graph build in APL that is intended for usage by Operations Control System of a microfactory to enable production of the target product or products.

Considering all the above subsections, it can be seen that FCM is iteratively obtained in result of the production planning process stages, from product design to process design, to workcell design, and finally robotic production environment layout design.

The FCM generation process in the Robofacturing system comprises the following steps:
1. Loading the production process and the robotic production environment layout obtained at the previous stages.

The robotic production environment layout is needed to get default values for workcell operations to be overridden by a production sequence defined in the production process. In result only production sequence will be used with set missing default values.
2. Extending the production sequence.

The extending comprises adding an initial loading from warehouse operation in the beginning of the sequence and a final unloading to warehouse operation in the end.
3. Building production graph using operation step and predecessor steps fields to define the sequence of operation steps in APL.

The production graph builds like this:

production_graph: Dict[str, List[str]]={op.operation_step: op.predecessor_steps for op in operations}
4. Reversing the production graph to have a graph with direct child operations for each operation step:

reversed: Dict[str, List[str]] = {step: [ ] for step in
production_graph.keys( )}
for step in production_graph:

for predecessor_step in production_graph[step]:

reversed[predecessor_step].append(step)

5. Finding a terminal operation step being the step with no child operations in the reversed graph.
6. Translating production sequence via recursion from terminal step into the FCM.
   At that, on each recursion step:
   a) Recursion starts for each predecessor step of the current operation step and returns partial-FCMs (graphs) for these steps and last operation ids for dependency linking.
   b) First operation of the current step gets all final operation ids from predecessor recursions as dependencies.
   c) Sequence of operations for current operation step is built.
   d) Recursion returns a concatenation of partial-FCMs (graphs) from predecessors and current step's partial FCM (graph) and also last operation id for this step.
7. At the end of recursion for the terminal step, obtained is a partial-FCM (graph) for the terminal step. A header with the operation name is added to that partial-FCM to get the final FCM (graph).

Having FCM built based on the selected robotic production environment layout and the production process, the system can use FCM directly for logical control of the microfactory operations by writing the FMC into Blackboard and updating the FMC by the Operations Control System (OCS) with all data from the robotic production environment in the factory and from outside elements of the system, such as rServiceHub, Layout Studio, external designing systems (in case of modifications of the product design) to enable data and event-driven control of the robotic production environment operations.

Furthermore, the use FCM being the single unified graph-based model of the production process in the robotic production environment, built as described above, allow conducting a comprehensive 3D simulation of the microfactory environment and the whole production process prior to any real-life deployment of the model.

To this end, the 3D simulation can be conducted by an external simulator system. But preferably, the simulation can be conducted by OCS accessing FCM written to Blackboard and processing the same by mean of an Execution Engine (EE) comprised in OCS of any existing microfactory. With FCM written on Blackboard, the EE of the OCS is configured to create a complete virtual model or “twin” of the microfactory for testing, validation and optimization of the production process in a safe virtual environment prior to deployment of any modifications to the real factory systems.

FIG. 57 illustrate an example 3D simulation view 587 of a microfactory environment and operations as can be provided by the OCS creating and operating the virtual twin of the robotic production environment and the production process defined by FCM.

OCS is configured as a universal control system.

Blackboard is one of the main elements of the OCS that has two basic functions:
Universal structured global data storage that implements both key-value storage and publish/subscribe messaging system. Both robotic and non-robotic agents are configured to read and/or write to Blackboard.
Data bus for fast data transfer among other components.

Blackboard is to be developed gradually so as every new functionality be backwards-compatible to all the previous versions. Furthermore, Blackboard shall be configured to ensure persistent of data stored thereon.

Blackboard can implement a data lake repository format storing data in its natural/raw format. In a non-limiting implementation, Blackboard can use a cross-platform database program, such as a NoSQL database program, for example, MongoDB database, as external data storage which ensures persistent data storage.

OCS is configured to control both the production process or workflow and the logistics processes, for example, by means of management of an AMR fleet logistics through FMC and Blackboard as described above.

Blackboard is a common communication medium of Arrival's microfactory system. OCS and all agents in the robotic production environment use Blackboard, being a structured, shared global memory of the robotic production environment.

FIG. 58 schematically illustrates main type of interactions provided through Blackboard and the OCS.

OCS enables event or data-driven control. As noted above, OCS is event or data-driven: all actions, operations, abilities of all agents 588 and OCS itself produce events and change data recorded on Blackboard 588, for example, sensor data 589, such as camera pictures/stream, and ground truth data 590 from agents 588. The EE 592 residing on Blackboard 588 is configured to processes all the data on Blackboard 588 to generate control signal 589 and, inter alia, update the factory scene configuration 594 for agents 588.

All other systems and tools in the Arrival Robofacturing system, such as Factory configuration Hub 595, Layout Studio 596, rServiceHub 597 and APL studio 598 are also configured to interact with OCS by sending their data 599 to Blackboard 588.

Thereby, OCS is configured to control and manage the production process depending on the current state of FCM written in Blackboard, wherein the OCS is further configured to update or instruct agents to update FCM written on Blackboard with data and events from the robotic production environment.

We can generalise the above to:

OCS provides for multi-agent, logical control of operations in a robotic production environment.
OCS provides for dynamic decision making on all aspects of the control: what operation to choose for execution, what agent to choose for executing the operation.
OCS implements the two-step operations control:
(1) building a production graph, FMC, using the robotic production environment layout and the production process description including rBOM, and
(2) dynamically choosing agents in runtime execution of operations in the FMC graph.
OCS provides for implementing any execution scenario in a distributed transaction format.
OCS is a single system for control and management of the whole robotic production environment and all related objects and processes.

Arrival Robofacturing system and OCS use the same language, APL, for describing and controlling any process inside the robotic production environment, such as the production process, the fleet management, the maintenance, etc. Such processes as supply chain management, maintenance, failure avoidance, error recovery, can be equally described in APL and added to the knowledge base as an agent, an ability or a service.

OCS is agent agnostic: abilities can be provided by any agent including robotic and non-robotic agents.
OCS provides for unified control for both robotic and manual operations. Thereby, OCS can control both automated and semi-automated factories and support any percentage of automation in a robotic production environment.
OCS is a distributed, scalable, fault-tolerant solution.

Section F: The Arrival Microfactory

Introduction to this Section F

In previous Section E, we have seen how Arrival's Robofacturing system enables autonomous, data-driven, continuous delivery environments that can make any type of product; a microfactory is an example of such an environment.

An Arrival microfactory is much simpler and cheaper to plan and construct compared to a conventional vehicle factory—typically taking 6 months to commission, compared to 3 years for a conventional vehicle factory, and costing 1/10th the CapEx. It includes multiple robotic production cells (typically 20 or 30) that each include one or more robots (which may be autonomous or semi-autonomous) and that can specialise or be optimised for one specific function or type of function, or be general purpose. Cells are not connected by a moving production line, but instead autonomous mobile robots (AMRs) move the vehicle components being assembled from cell to cell until the vehicle is fully assembled.

A logical, semantic-based language underlies robotic process management and control and enables a robotic operations control system, with software and a catalogue of Robofacturing services or micro-services. Cells operate to assemble together various sub-assemblies (e.g. adding composite panels to a body frame) and also assemble together various elements (e.g. chassis, drivetrain, wheels, HVBMs, body) to form parts of an individual vehicle, and to assemble all of these elements to form a complete vehicle.

So microfactories implement Robofacturing techniques (see Section E); assemble vehicles using build instructions generated by the Vehicle Builder tool (see Section D); the Vehicle Builder tool in turn depends on software modularity (see Section B) and hardware modularity (see Section A).

The Arrival autonomous, robotic, cell-based production approach removes any dependency on the conventional linear vehicle design paradigm, based on large (1M+m²), high CapEx ($2Bn+) factories with metal stamping presses for body panels and long, linear moving production lines; the conventional approach is inherently limited to producing in essence just a single vehicle model over several years. The Arrival system instead enables small, low-CapEx microfactories (generally conventional 10,000 SqM to 20,000 SqM factories) that are able to operate with a high degree of robotic automation, able to re-configure what they build and how those vehicles are constructed in days rather than months, and without the significant downtime and CapEx associated with re-designing the (a) tooling (e.g. the tooling for the metal stamping presses) and (b) the moving production line that would be needed in the conventional approach.

Compared to the conventional linear production line vehicle design paradigm, the Arrival system is cheaper to build, faster to build, and faster to adapt to new designs of vehicles and faster to re-configure. More specifically, because the Arrival microfactory approach is significantly cheaper in CapEx than moving production line factories, it means that much lower annual production volumes can still be profitable, in turn enabling fleet customer specific designs. So the Arrival system enables low runs of vehicles, highly customised to meet the requirements of a specific customer or region, to be built cost-effectively: for example a $50M CapEx, 20,000 m² Arrival microfactory can cost-effectively build 1,000 buses a year using 25-30 robots, or 10,000 vans a year using 75-100 robots. It deliberately rejects the scale economies that come from conventional mass production techniques using moving production lines, replacing them with the scale economies that come from highly automated, autonomous design and build processes based on the pervasive re-use of modular, standardised components (See Section A), and the pervasive re-use of modular, standardised software components (see Section B), all handled by the Robofacturing based, pervasive re-use of standardised production techniques (see Section E).

An Arrival microfactory will still make a large aggregate volume of vehicles, perhaps 10,000 a year, but they will be more diverse (tailored to specific applications or customer) because the microfactory is flexible enough to make any product which fits within the native or supplemented abilities of the installed robots; microfactories enable production of entirely new vehicle designs at far lower cost than the conventional paradigm. With microfactories, model volumes (number of each vehicle type made) is less important than the total volume of all vehicles made; because the design and commissioning is largely automated, the costs for changing between models are low,

Because Arrival microfactories are small and low CapEx, they enable a distributed approach to vehicle production, in contrast to the highly centralised, high CapEx approach conventionally used: producing vehicles in a microfactory can be especially relevant where a local city or public transportation region has a requirement for buses with specific attributes, and that microfactory can be built in that actual city or region.

Because a microfactory is much smaller than a conventional vehicle factory and can re-purpose an existing conventional large warehouse, they can be built in areas of demand, anywhere in the world, establishing a local presence quickly, with shorter supply chains, enhanced local employment, enhanced local tax base, and no requirement for ocean container shipping, further reducing the carbon footprint. Microfactory networks are resilient in the face of change and uncertainty: if a particular microfactory proves not to be in the best location, then its robots (the main CapEx) can be relocated to a different microfactory. Microfactories can be located where demand is merely speculative; if the demand does not materialise as anticipated, then again the robots can be re-located to another microfactory.

An Arrival microfactory might have just approximately 50-100 robots, organised into approximately 20-50 cells of robots, with each cell having between 1-10 robots. A microfactory can be readily scaled up by adding additional cells, or scaled down if needed, or switched to different designs of buses, or vans or cars, or modified by adding in new specialised cells, or existing cells supplemented with new abilities. The microfactory is inherently flexible since many cells will be able to provide many different kinds of functions and can switch between functions as and when the need arises. The microfactory is inherently dynamic; cells alter their function (e.g. robotic end-effectors can be changed under software control, hence enabling a cell to alter its function in a matter of minutes). Further, the organisation and flow of AMRs serving the cells can be altered in real-time to optimise productivity and avoid bottlenecks. A conventional vehicle production line in effect hard-codes a linear production sequence into the organisation of people and robots along a loving production line, and has to be entirely stopped for any significant changes, production failures or supply problems. In contrast, the Arrival microfactory can re-configure what cells do, and how the internal logistics flow works within the microfactory, under dynamic software control: in the limit, this implies real-time autonomous adaptation of the functioning of all cells, robots and AMRs in the microfactory. For example, an Arrival microfactory can be rapidly re-configured to use cells in a different sequence (e.g. if components are running low in one cell, or if one cell needs maintenance, then the flow can be re-configured to compensate for that virtually instantaneously; further, the same cell can be re-used several times for different assembly operations for the same vehicle. If the microfactory needs to switch to building a different type or design of vehicle (instead of or in addition to the vehicle currently being built), then that can be achieved rapidly by in essence re-programming the operations performed by each cell and the components provided to each cell.

In the Arrival system, just a small number (e.g. just seven) different types of robotic cells are able to produce an entire vehicle; different cells of the same type can be used in different sequences; cells can be rapidly re-purposed from one specific task to another. This approach gives a degree of flexibility and scalability that is impossible with a conventional moving production line system. The microfactory receives data defining a vehicle to be assembled from the Vehicle Builder and can then automatically complete all steps needed to assemble that vehicle. Because the Unified Software Architecture and the Unified Hardware Platform has been designed to ensure that all compliant software and hardware will work together reliably, the key elements of the vehicle should work with each other as predicted, once all hardware and software components are properly installed in a vehicle and communicating with each other.

Microfactory production using small cells of robots requires radical re-thinking of how a vehicle should be designed: design for robotic production is at the heart of the Arrival system and requires the vehicle being designed to implement a range of Arrival technologies—for example: hardware modularity (see Section A), software modularity (see Section B), a unified security framework (see Section C), implementing build instructions from an automated vehicle design toll (see Section D), in a Robofacturing system (See Section E).

The Arrival vehicles themselves are designed using aluminium extrusions and panels that are readily handled and assembled by robots (see the Arrival Bus build sequence in Section J). Single large structural castings are used, like the large structural aluminium wheel arch castings used in the Arrival Van (see Section I) and the Arrival Bus (see Section J); these single large castings can be handled and installed robotically, replacing multiple conventional, complex, structures that are costly and difficult to assemble using robotic production techniques.

An Arrival vehicle microfactory includes a specific set of cells dedicated to high performance thermoplastic composite body panel production (see Section H); making vehicle body panels from thermoplastic composites has some very specific advantages: it eliminates the huge expensive and very heavy stamping presses that need specialised foundations and require considerable and costly support services. Further, there is no large, costly and complex paint shop requiring specific environmental permits; there are no costly and complex spot welding robots. To expand on this, and as noted earlier, the conventional vehicle production paradigm requires the use of stamped steel or aluminium panels. Stamping requires huge matched-steel tools (moulds used to press sheet metal into shape); often several pairs are required for a single part in a process known as progressive stamping. Designing these tools can take a year or more; because of their weight and the considerable forces (e.g. 200+ tons) they apply, specially strengthened and costly structural foundations are needed. It typically costs tens of millions of dollars to set up a production line; it then takes many months to tune the line. To pay back the investment, metal stamping lines are dedicated to a single product for many years. Once complete, the stamped metal body is welded together to form the familiar body in white (BIW). The welding jigs and robots are dedicated to a single product; further increasing time and investment. Next, metal has to be protected from the atmosphere. This requires a large paint setup, starting with an e-coating line, which may be the most significant investment in the paint shop due to the size of the tanks required to fully submerge the BIW. Subsequent paint layers are built up on top to produce the finished vehicle. Automotive factory paint shops are hence very costly, and require environmental permits which can significantly slow down the factory build process and limit the locations in which factories can be built.

This conventional approach therefore locks in a specific vehicle design for many years, so that vehicle design is able to react only slowly to the new acute environmental and urban transportation challenges we are now facing, and equally slowly to users' increasing demands for transportation environments that are engaging, safe and zero emission. Low volume production runs of vehicles designed to meet emerging, specific customer needs (e.g. a fleet buyer who wants to buy 100 buses, or 1,000 delivery vans, customised to their specific requirements) are not possible with the current vehicle design and production paradigm.

Attempting to re-purpose the existing vehicle design and vehicle production paradigms to zero emission vehicles has resulted in vehicles that are generally more expensive than their internal combustion engine equivalent, are low margin (and frequently loss making), require huge initial investments and capital expenditure, need very high mass production levels to generate a profit, and yet are often poorly suited to the specific demands of fleet customers and individual users because they are mass-produced products which have not been tailored to meet specific requirements. The Arrival system addresses these problems.

A single Arrival microfactory can be thought of as an autonomous, distributed network of production nodes or cells, where the cells themselves are made up of autonomous, self-managing robots, all served by AMRs. Decentralised autonomy in a distributed architecture is a theme that permeates not just Arrival's thinking about how to efficiently produce a vehicle, but also how that vehicle itself is architected: we have seen in earlier sections how this approach is fundamental to the software modularity and plug and play techniques used in Arrival vehicles themselves (see Section B).

Returning to the Arrival approach to vehicle production, the core approach of autonomous, distributed production is scale invariant: at one level, it is implemented in a single robot in a single cell, which can determine for itself or in combination with a larger control system what tasks to perform, what end effectors to choose, what paths to trace in space, what resources and components to call up, what AMRs to summon. Moving up the physical size scale, it covers a cell, made up of multiple robots, where the cell determines for itself or in combination with a larger control system what tasks to perform, what robots in the cell are to perform what tasks and how.

Moving further up the scale, it covers a group of cells in a microfactory that work together to deliver a specific item: for example, the different kinds of cells that work together to take thermoplastic yarn and turn it into a finished body panel for vehicle. Moving even further up the scale, it covers the microfactory itself.

The Meta-Factory

And moving higher still, we introduce the Meta-Factory: when you have a number of microfactories, they do not sit in isolation from one another, each with dedicated inbound supply chains, but are instead connected to form a higher level of autonomous, distributed production network nodes, where each microfactory is itself a node in this network. The Meta-Factory could therefore encompass hundreds or thousands of individual microfactories across countries and around the world, and enables globally optimal production of vehicles (or any other produced item) across the nodes. The Meta-Factory system becomes particularly relevant when you have microfactories that produce parts and subassemblies for other microfactories; different microfactories in the network might specialise in the production not only of certain final vehicles, but of (knock-down) subassemblies for other microfactories to build up, or specific parts (such as batteries, composites, structural components, headlights etc.) which they then share with the local network of other microfactories. The reciprocal sharing between semi-specialised microfactories has the added benefit of improved logistics load factor—lorries etc. between microfactories are always full: e.g. deliver headlights, return with heat pumps.

The nodes of the Meta-Factory are not limited to microfactories: any production or supply entity can be encompassed, even conventional moving production line entities: the Meta-Factory takes the core control theory and software developed for Robofacturing at a single microfactory, and re-purposes it to control multiple microfactories, conventional factories, suppliers, and logistics; in essence, any and all elements of the entire production eco-system can be governed by the Meta-factory. As new forms of nodes become available (for example, cost-effective autonomous delivery trucks or drones that reduce delivery times or reduce delivery costs), then these can be included into the global Meta-Factory control system. The Meta-Factory control system can also respond dynamically to changes in material availability and commodity pricing.

In practical terms, within the Meta-Factory, the core technology designed for Robofacturing in a single microfactory is used at a higher level to control microfactories, conventional factories, suppliers, and logistics, treating them as nodes in an autonomous, distributed production network.

This Robofacturing technology includes: (a) Arrival Process Language (a logical language for robotic process management and control); (b) rServices and rServiceHub (a catalog of equipment and Robofacturing services, which can be used to design an assembly/production process); (c) rProcess Studio (automatically creates all the variety of possible processes that satisfy input constraints for producing any given goods by robots, humans or both); (d) Layout Studio (creates a factory layout and performs discrete event simulation of it); (e) Factory Control Module (a master factory model iteratively obtained as a result of the production planning process stages, from product design to process design, cell design, and factory layout design); and (f) Operations Control System (OCS). Robofacturing (see Section E) has been specifically described in relation to the microfactory, but these core technologies can apply equally to implement the Meta-Factory.

We use the term ‘robotic production environment’ in this text: this should be expansively construed as scale independent: it includes a cell made up of one or more robots; it includes a group of cells in a factory, such as a microfactory; it includes the complete set of cells in a factory, such as a microfactory; it includes the microfactory; it includes a distributed network of production nodes, where a node is a single microfactory; it includes all elements of the entire production eco-system that we call the Meta-Factory.

Emergent behaviour is a characteristic of autonomous entities and we anticipate emergent behaviour in the Arrival robotic production environment, whether at the cell level, or the microfactory or the Meta-Factory level. For example, in a microfactory, one emergent behaviour could well be cells and AMRs self-organising into a linear production process, with each cell maintaining a specific specialisation, just like a conventional, liner production line with deterministically programmed robots. That may well be optimal, given certain stable conditions. Equally, entirely novel emergent behaviours that optimise productivity or cost of production may appear, whether transiently or in more established forms. Similarly, at the Meta-Factory level, it may be globally optimal for some microfactories to specialise in just commercial vans, and for there to be some conventional factories (e.g. factories producing lithium ion batteries). Resilience to unexpected shocks, through rapid re-configuration of the functions of various autonomous, distributed production network nodes, is a key advantage of the Meta-Factory.

This Section F describes a number of features implemented in the Arrival microfactory or robotic production environment.

A. Designing the Arrival Microfactory
Feature 1: Microfactory making composite panels and assembling complete vehicles
Feature 2: Robotic cell-based factory designed by simulation tool

B. Building the Arrival Microfactory
Feature 3: Microfactory under 25,000 m²
Feature 4: Microfactory without a moving production line
Feature 5: Microfactory without a paint shop

C. Building Arrival Vehicles in the Arrival Microfactory
Feature 6: Robotic small cells assemble entire vehicle
Feature 7: All vehicle components are designed for robotic handling
Feature 8: Vehicle with customer-specified configuration
Feature 9: Vehicle with customer-specified battery capacity
Feature 10: Vehicle with Integrated, Customer-Specified Sensors

D. Autonomous Operations in the Arrival Microfactory
Feature 11: Robotic assembly that is autonomous at the robot level
Feature 12: Robotic assembly that is autonomous at the cell level
Feature 13: Robotic assembly that is autonomous at the factory level
Feature 14: Autonomous agent based production
Feature 15: Semantic model
Feature 16: Takt time agnostic production

Taking each in turn:

A. Designing the Arrival Microfactory

We can generalise to the following:

Feature 1: Microfactory Making Composite Panels and Assembling Complete Vehicles

A vehicle robotic production environment, in which the environment hosts robotic agents that are organised as groups of cells, each cell with no more than 10 robots, served and (i) one group of cells is responsible for one or more stages in transforming fabric into vehicle composite panels and other parts, eliminating the need for steel panel pressing equipment; (ii) other cells assemble at least portions of a vehicle together, and each cell is served by AMRs (autonomous mobile robots), eliminating the need for a moving production line in the production environment.

Feature 2: Robotic Cell-Based Factory Designed by Simulation Tool

A robotic production environment comprising a number of robotic production cells for vehicle production, each cell comprising a group (e.g. 2 to 10, but typically 4 to 6) of robots that are programmed to assemble, using robotic services, at a fixed location and not a moving production line, at least part of the vehicle by joining together multiple, modular components designed or selected for robotic production, handling or assembly;
and in which the layout or arrangement of cells in the environment has been designed by an automated simulation tool which takes into account parameters including: production cost; production time; production quality; component availability; use of AMRs to transport components and sub-assemblies.

B. Building the Arrival Microfactory

Feature 3: Microfactory Under 25,000 m²

A robotic production environment that is configured to assemble vehicles, in which the environment (i) hosts robotic agents that are organised as groups of cells, each cell with no more than 10 fixed robots, served by AMRs (autonomous mobile robots), and each cell is responsible for production or assembly of at least portions of a vehicle, the portions having been designed or selected for robotic production, handling or assembly; and (ii) the groups of cells are located in a factory that is a less than 25,000 square meters in area.

Feature 4: Microfactory without a Moving Production Line

A method of constructing a vehicle robotic production environment, including the following steps:

(i) selecting or constructing a warehouse or factory of under 25,000 square meters with a conventional flat concrete floor that has not been strengthened for a vehicle body panel stamping press;
(iii) installing a number of robotic cells configured to assemble least portions of a vehicle together, without also installing a moving production line.

Feature 5: Microfactory without a Paint Shop

A method of constructing a vehicle robotic production environment, including the following steps:

(i) selecting or constructing a warehouse or factory of under 25,000 square meters with a conventional flat concrete floor that has not been strengthened for a vehicle body panel stamping press;
(ii) installing a number of robotic cells configured to transform thermoplastic yarn into coloured vehicle composite panels and other parts, without also installing a paint shop of the kind needed to paint conventional pressed steel parts.

C. Building Arrival Vehicles in the Arrival Microfactory

Feature 6: Robotic Small Cells Assemble Entire Vehicle

A robotic production environment comprising a number of robotic production cells for vehicle production, each cell comprising a group of robots that are programmed to assemble, at a fixed location and not a moving production line, at least part of the vehicle by joining together multiple, modular components, each component designed or selected for robotic production, handling or assembly; and the cells together assemble substantially the entire vehicle.

Feature 7: All Vehicle Components are Designed for Robotic Handling

A robotic production environment comprising a number of robotic production cells for vehicle production, each cell comprising a group of robots that are programmed to assemble, at a fixed location and not a moving production line, at least part of the vehicle by (a) joining together multiple components to form a structural chassis, and a body structure, and (b) adding body panels and roof panels to the body structure, and all of the components and the panels are designed or selected for robotic production, handling or assembly.

Feature 8: Vehicle with Customer-Specified Configuration

An electric vehicle design and production process, the vehicle available in multiple different configurations that differ by one or more of the following variables: length, width, height, presence of specific sensors, presence of specific driving aids, presence of any customer-specified option;
and an automated vehicle design tool then automatically selects components required for the specified configuration; and automatically generates build instructions for that vehicle or a fleet of those vehicles;
and a robotic production environment then automatically builds or assembles the vehicle or vehicles, as designed by the automated vehicle design tool, with the specified configuration, using the build instructions.

Feature 9: Vehicle with Customer-Specified Battery Capacity

An electric vehicle design and production process, the vehicle including multiple batteries; vehicle or fleet of vehicles, and an automated vehicle design tool then automatically selects battery-related components required for the specified battery capacity or range; and automatically generates build instructions for that vehicle or fleet of vehicles;
and a robotic production environment then automatically builds or assembles the vehicle as designed by the automated vehicle design tool, including a battery pack that meets the specified battery capacity or range, using the build instructions.

Feature 10: Vehicle with Integrated, Customer-Specified Sensors

An electric vehicle design and production process, the vehicle including multiple sensor based systems, such as ADAS, LIDAR, computer vision based driver monitoring, computer vision based passenger monitoring, load or weight sensors, that each conform to a standardised plug and play model;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicles as designed by the automated vehicle design tool, integrating the sensor based systems into the vehicles, using the build instructions.

D. Autonomous Operation in the Arrival Microfactory

Feature 11: Robotic Assembly that is Autonomous at the Robot Level

A robotic production environment comprising a number of robotic production cells for vehicle production, each cell comprising a group of robots that are autonomously capable, at an individual robot level, to assemble, at a fixed location and not a moving production line, at least part of the vehicle by joining together multiple, modular components, each selected or designed for robotic handling or installation.

Feature 12: Robotic Assembly that is Autonomous at the Cell Level

A robotic production environment comprising a number of robotic production cells for vehicle production, each cell comprising a group of robots that are autonomously capable, at an individual cell level, to assemble, at a fixed location and not a moving production line, at least part of the vehicle by joining together multiple, modular components, each selected or designed for robotic handling or installation.

Feature 13: Robotic Assembly that is Autonomous at the Factory Level

A robotic production environment comprising a number of robotic production cells for vehicle production, each cell comprising a group of robots that are autonomously capable, at the factory level, to assemble, at a fixed location and not a moving production line, at least part of the vehicle by joining together multiple, modular components, each selected or designed for robotic handling or installation.

Feature 14: Autonomous Agent Based Production

A robotic production environment that is configured to determine by itself, dynamically, (i) what steps to perform, (ii) when to perform those step, (iii) by what agents, including both robotic agents and also non-robotic agents, those steps should be performed and (iv) how those agents are to interact with each other to build or assemble a device; and in which the robotic agents are organised as cells, each with no more than ten robots, served by autonomous mobile robots (AMRs).

Feature 15: Semantic Model

A robotic production system that is configured to assemble vehicles in a robotic production environment, in which the robotic production system (i) hosts robotic agents that are organised as groups of cells, each cell with no more than 10 fixed robots, served by AMRs (autonomous mobile robots), and each cell is responsible for production of, transforming, handling or assembling some part of a vehicle;
and the robotic production system is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle;
and the robotic production system uses a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.

Feature 16: Takt Time Agnostic Production

A robotic production environment for production of a vehicle, in which the environment operates with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.

### BRIEF SUMMARY OF THE FIGURES RELATING TO THIS SECTION F

Some implementations of the Arrival microfactory are shown in the accompanying figures, in which:

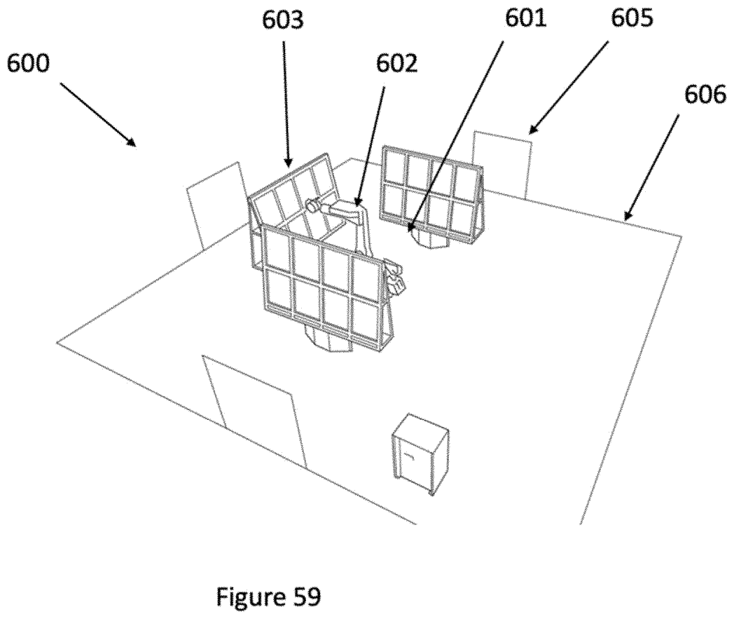

FIG. 59 shows a robotic cell in a microfactory; the cell is a composite panel trimming cell.

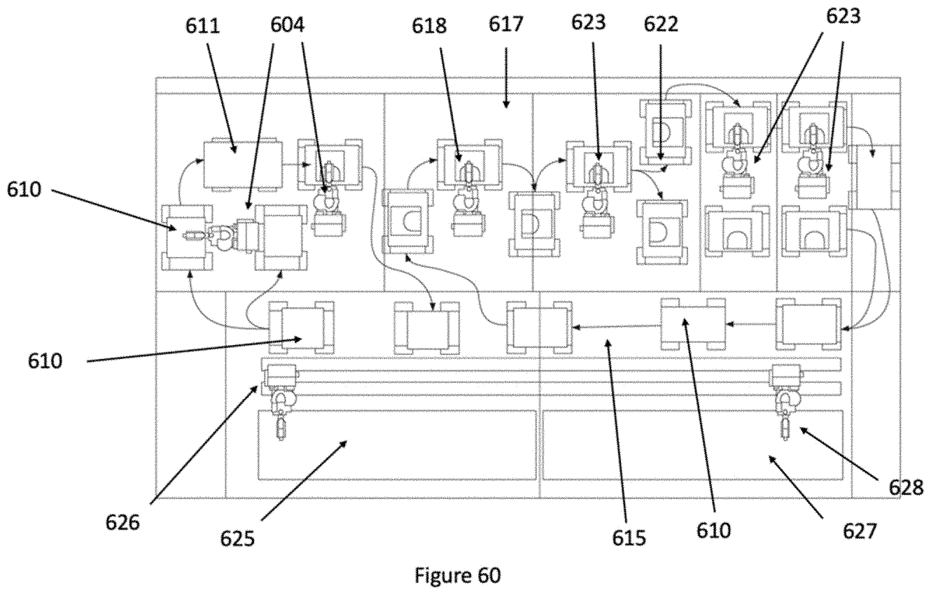

FIG. 60 shows a schematic view of the part of a microfactory producing composite parts.

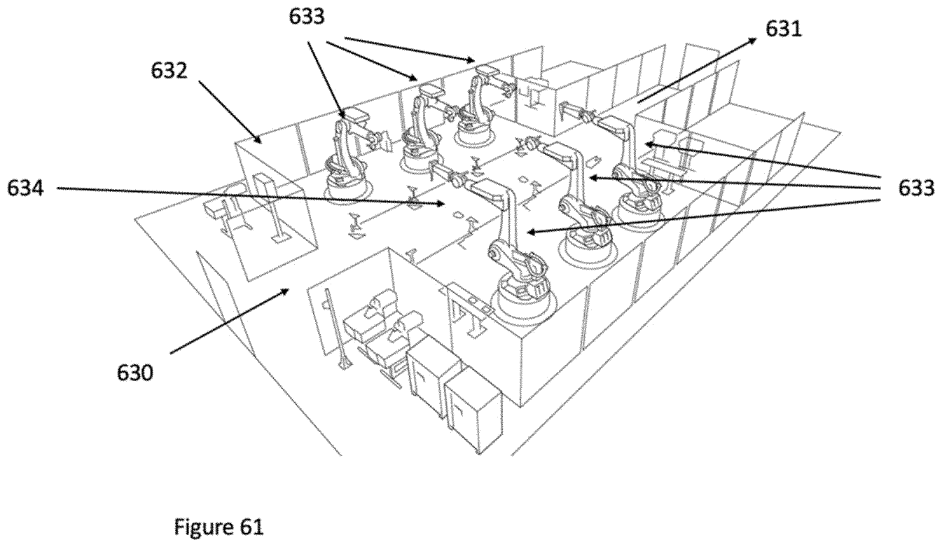

FIG. 61 shows a schematic view of a six robot cell used for assembling a vehicle.

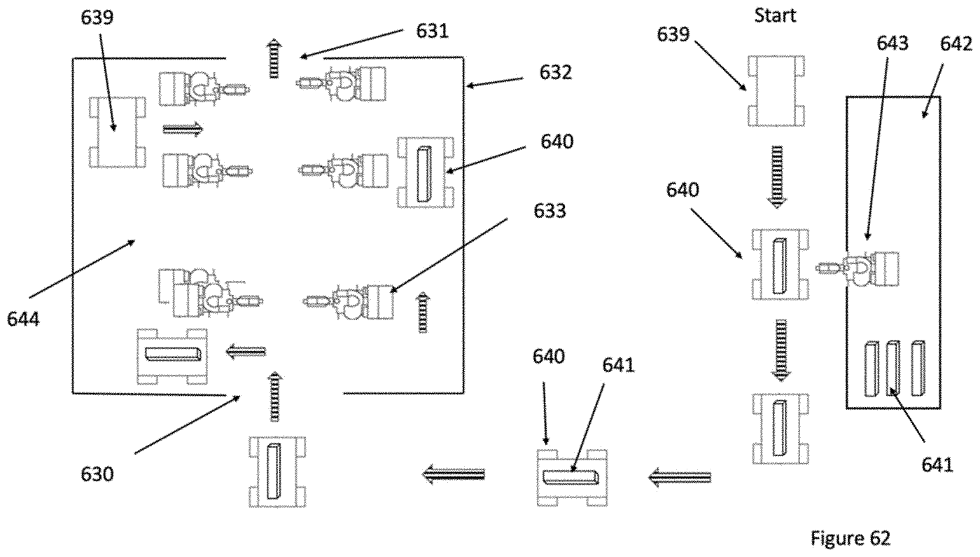

FIGS. 62-67 shows a build sequence in the six robot cell.

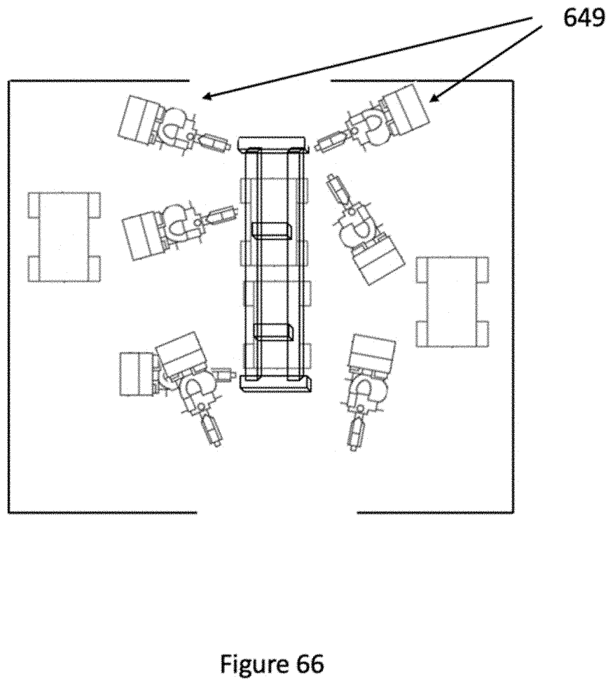

FIG. 68 shows a schematic view of an eight cell production environment.

### FIGS. 59-68 Index

| Reference | |
|---|---|
| numeral | Description of item |
| 600 | cell |
| 601 | trimming cell |
| 602 | 6DoF robot |
| 603 | rotating A frames |
| 604 | 6DoF robot in trimming cell |
| 605 | cell safety barriers |
| 606 | cell boundary for planning purposes |
| 610 | AMR |
| 611 | moulding cell |
| 615 | AMR flow path |
| 617 | trimming cell |
| 618 | trimming cell robot |
| 622 | assembly cell |
| 623 | assembly cell robot |
| 625 | tool loading store |
| 626 | tool loading robot |
| 627 | jig loading store |
| 628 | jig loading robot |
| 630 | entrance for AMRs |
| 631 | exit for AMRs |
| 632 | safety screening around the cell |
| 633 | 6 DoF robot |
| 634 | production bay |
| 639 | unloaded AMR |
| 640 | loaded AMR |
| 641 | aluminium extrusion |
| 642 | parts store |
| 643 | robot in parts store |
| 644 | technology cell |
| 646 | part assembled chassis |
| 647 | pair of AMRs |
| 648 | pair of AMRs carrying the part assembled chassis |
| 649 | robot with adhesive gun |

### DETAILED DESCRIPTION FOR THIS SECTION F

We will now look at each of these features in more depth.

Feature 1: Microfactory Making Composite Panels and Assembling Complete Vehicles

We have seen how Arrival vehicles include thermoplastic composite body panels and other parts; Section H describes this more fully, as well as the part of the microfactory that specialises in transforming textile raw materials into finished composite panels. We will start this more detailed description of microfactories by looking at one of the cells used in composite panel, since it includes just a single robot. FIG. 59 shows a robotic cell indicated generally at 600, in this case a trimming cell 601 that trims the rough edges off composite panels. In the trimming cell 601, a single 6DoF robot 602 is configured first with a suction gripper that enables it to pick up a panel delivered by an AMR (not shown); the panel has just finished the moulding process, but has rough edges. The 6DoF robot 602 picks up the panel and places it on one of the ‘A’ frames 603 which includes a jig with the precise, required edge shape that the panel needs to be given. The 6DoF robot 602 changes it's end-effector from a suction gripper to a high-speed drill bit and it then removes all unwanted material from the edge of the panel, following the jig. The 6DoF robot 602 then returns the drill bit, attaches the suction gripper and moves the now-trimmed panel to an AMR in the cell; the AMR then moves the panel to the next stage in processing.

In FIG. 59, the boundary 606 of the cell is shown, as are some of the cell protective walls 605; in practice, these walls 605 fully surround the cell for personnel safety, including only entrance and exit pathways for AMRs. The boundary of the cell 606 is part of how the Arrival microfactory builds and organises the shape, and/or size and/or location of these cells on a grid-based architecture (see Section A).

A schematic of the entire group of cells involved in thermoplastic panel production process is shown in FIG. 60. FIG. 60 shows the general overall flow, from moulding cell 611 with 6DoF robot 604 lifting textile kits from AMR 610, to trimming cell 617 (as in FIG. 59) with trimming cell robot 618, to assembly cell 622 with assembly cell robot 623. In addition, FIG. 60 shows the tool loading store 625 that stores the different end-effector tools that robots might need; these are retrieved predictively by tool loading robot 626 and placed onto an AMR 610, which transports the required too to the requesting or appropriate robotic cell 617, 618, 622. The jig loading store 627 hold the jigs that are used in the trimming cells 617 and is served by jig loading robot 628; these jigs are retrieved predictively by jig loading robot 628 and placed onto an AMR 810, which transports the required jig to the requesting trimming cell system for use by trimming robot 618. Section H provides more detail of the complete flow.

FIG. 61 shows another type of cell in the microfactory: in this type of cell, the chassis and superstructure of the Arrival vehicle can be produced (see Section J for a description of the robotic build process undertaken in this sort of cell, for the chassis and superstructure of the Arrival Bus). FIG. 61 shows a cell with an array of six 6DoF robots 633 arranged in two lines around a production bay 634. The robots 633 in an Arrival cell operate with a degree of autonomy and are able to arbitrate amongst themselves what operations to perform and how to sequence them; whilst there is central supervisory awareness of all robots and their actions, control is decentralised in a hierarchical manner, with some autonomous operations owned and implemented by each individual robot 633, some autonomous operations owned and implemented by a cell, some autonomous operations owned and implemented by a group of cells, and some autonomous operations owned and implemented by the microfactory.

An AMR will enter the cell via cell entrance 630 and be locked in position in production bay 634. The AMR will be carrying parts of the vehicle that require further assembly—for example a part of the vehicle chassis or skateboard platform to which further metal extrusions need to be added. The robots 633 are supplied the necessary parts from other AMRs that have entered the cell; the robots then complete the required production actions on the chassis and the AMR carrying the chassis then leaves the cell from exit 631. This process is further described in the following FIG. 62-FIG. 67.

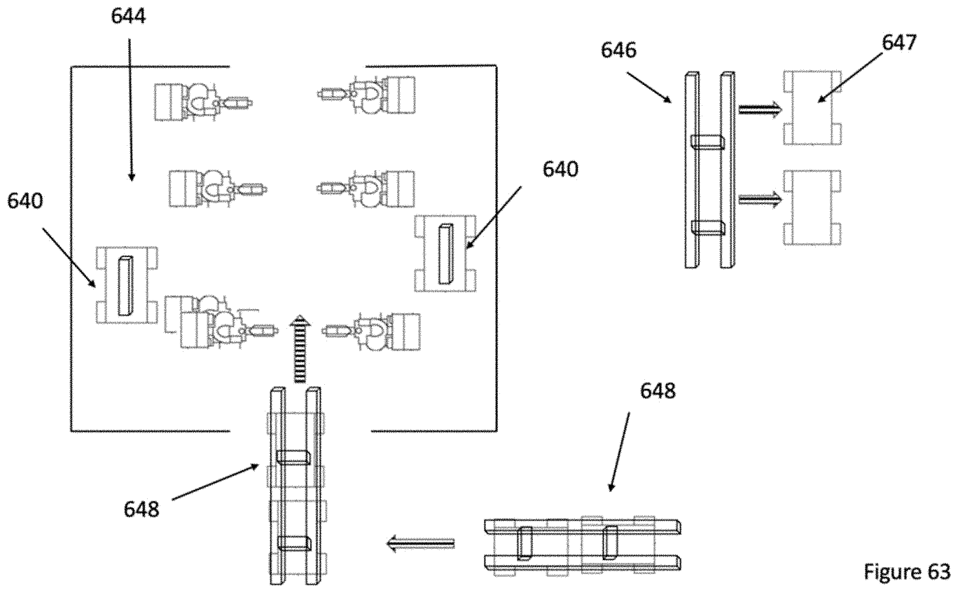

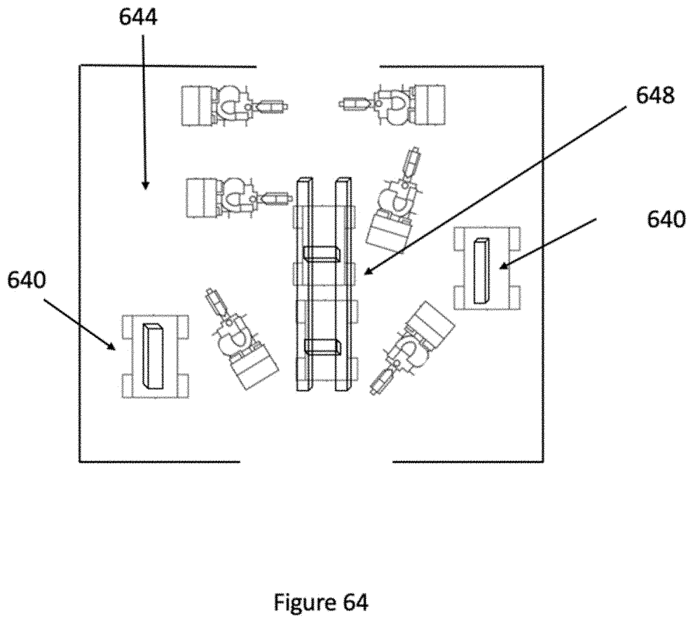

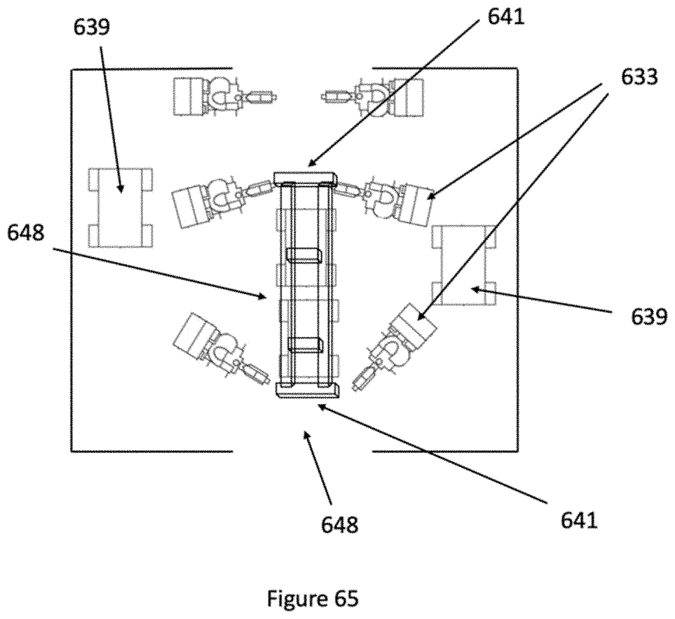

In FIG. 62, at the ‘Start’ position, we see an unloaded AMR 639 approaching parts store 642, which stores all structural components for the vehicle, including aluminium extrusions 641. A robot 642 in parts store 642 selects the kind of extrusion required by the cell indicated generally at 644 and made up of six 6DoF robots 633 and loads it onto to waiting AMR 640. The AMR 640, now carrying metal extrusion 641 takes a path to the cell 644, using its autonomous navigation capabilities. It enters cell 644 at entrance 630 and then waits by the appropriate robot 633 to unload the extrusion. FIG. 63 shows a part assembled chassis 646 which has been assembled earlier at another assembly cell. The part assembled chassis 646 is too large to be carried by a single AMR, so two AMRs autonomously couple up to form a pair and the part assembled chassis 646 is loaded on to this pair of AMRs; the pair of AMRs 648 carrying the part assembled chassis then enters the cell shown in FIG. 62 The cell will join two metal extrusion to the front and rear of the chassis 646. FIG. 63 shows two waiting AMRs 640, each carrying a single extrusion, in the cell 644. FIG. 64 shows the pair of AMRs 648 carrying the part assembled chassis 646 into the production bay 634 of the cell 644. FIG. 65 shows that the bottom four robots 633 have worked together, unloading the metal extrusions 641 from the AMRs 640, leaving the AMRs 639 unloaded. The bottom four robots have worked together to attach each of the metal extrusions 641 to the front and rear of the part assembled chassis 646; for example, a robot on one side may have grippers to grip and move the extrusion; the opposite robot may then have a screwdriver to attach the extrusion to the chassis. Note that all end-effectors are swappable for the task at hand (just as in FIG. 60 we saw that there was a tool store that could supply the appropriate tools or end-effectors to a cell, via an AMR. Looking now at FIG. 66, we see that the pair of AMRs 648 have moved up in the cell, presenting the front extrusion to a pair of dedicated robots with adhesive guns 649; these robots inject glue into the joints of the newly attached metal extrusion 641. In FIG. 67, we see the AMR 648 with chassis leaving the cell 644. This AMR 648 will loop around to cell 644, but will reverse itself so that the metal extrusions can be presented to the glue robots 649. FIG. 67 shows the next AMR with a part assembled chassis waiting to enter the cell 644.

FIG. 68 shows a grid of eight cells 644, each with six DoF robots. Unloaded AMRs 639 approach the parts store 642 and robot 643 loads the required part on to the AMR, which then continues to its requesting cell. Loaded AMRs 640, e.g. with part-assembled structures like the part assembled chassis 646 in the preceding FIG. 67, also enter the grid of cells for further production processes. The entire process is controlled by the Robofacturing system described earlier.

A typical vehicle microfactory might have the dedicated composite parts section shown in FIG. 60, and the more general grid of cells shown in FIG. 68. Eight cells are shown, but the number is arbitrary: in the limit, just a single cell could in theory construct an entire vehicle, but that would require a huge number of loops around the single cell, with each loop incrementally adding to the production process. So, whilst the CapEx would be small, with just a single cell, the throughput would be unfeasibly low. A typical microfactory in a 10,000 SqM building might have twenty to thirty cells, which delivers economically viable throughputs with reasonable CapEx.

We can generalise to: A vehicle robotic production environment, in which the environment hosts robotic agents that are organised as groups of cells, each cell with no more than 10 robots, served and (i) one group of cells is responsible for one or more stages in transforming fabric into vehicle composite panels and other parts, eliminating the need for steel panel pressing equipment; (ii) other cells assemble at least portions of a vehicle together, and each cell is served by AMRs (autonomous mobile robots), eliminating the need for a moving production line in the production environment.

Feature 2: Robotic Cell-Based Factory Designed by Simulation Tool

One of the advantages of the Arrival microfactory approach is that it is possible to retrofit a complete microfactory into an existing warehouse; so, given the size and shape of the warehouse, it is possible to simulate different layouts and numbers of cells, with the layout simulation tool calculating the CapEx and throughput of different numbers and arrangements of cells. The automated simulation tool can take into account parameters including: production cost; production time; production quality; component availability; use of AMRs to transport components and sub-assemblies. So it becomes possible to explore through simulation the financial viability of retro-fitting a vehicle microfactory into an existing, standard warehouse; this is possible there is no need for a steel stamping plant with strengthened foundations, nor a dedicated paint shop with costly environmental permits, nor the need to install a conventional moving production line.

We can generalise to: A robotic production environment comprising a number of robotic production cells for vehicle production, each cell comprising a group (e.g. 2 to 10, but typically 4 to 6) of robots that are programmed to assemble, using robotic services, at a fixed location and not a moving production line, at least part of the vehicle by joining together multiple, modular components designed or selected for robotic production, handling or assembly;
and in which the layout or arrangement of cells in the environment has been designed by an automated simulation tool which takes into account parameters including: production cost; production time; production quality; component availability; use of AMRs to transport components and sub-assemblies.

B. Building the Arrival Microfactory

Feature 3: Microfactory Under 25,000 m²

We have seen earlier that a complete vehicle production facility that is economically viable can be located within a conventional factory that is far smaller than the 1M+ SqM normally required. Typical Arrival microfactories can occupy less than 25,000 SqM, and are generally in the 10,000 SqM to 20,000 SqM range, and so can be deployed in conventional large warehouses with conventional flat concrete floors (i.e. not specially strengthened), which are both numerous and also far cheaper to construct than the 1M+ SqM normally required for an economically viable vehicle factory.

We can generalise to: A robotic production environment that is configured to assemble vehicles, in which the environment (i) hosts robotic agents that are organised as groups of cells, each cell with no more than 10 fixed robots, served by AMRs (autonomous mobile robots), and each cell is responsible for production or assembly of at least portions of a vehicle, the portions having been designed or selected for robotic production, handling or assembly; and (ii) the groups of cells are located in a factory that is a less than 25,000 square meters in area.

Feature 4: Microfactory without a Moving Production Line

As noted earlier, Arrival microfactories uses AMRs as opposed to conventional moving production lines; this delivers flexibility, rapid reconfigurability and resilience.

We can generalise to: A method of constructing a vehicle robotic production environment, including the following steps:

(i) selecting or constructing a warehouse or factory of under 25,000 square meters with a conventional flat concrete floor that has not been strengthened for a vehicle body panel stamping press;
(iii) installing a number of robotic cells configured to assemble least portions of a vehicle together, without also installing a moving production line.

Feature 5: Microfactory without a Paint Shop

One important feature of the Arrival system is the use of thermoplastic composite panels and other parts; as explained earlier, it removes the need for vastly heavy steel stamping tools and the associated paint shop required to paint the ‘body-in-white’ stell monocoques that are produced. Further details are in Section H.

We can generalise to: A method of constructing a vehicle robotic production environment, including the following steps:

(i) selecting or constructing a warehouse or factory of under 25,000 square meters with a conventional flat concrete floor that has not been strengthened for a vehicle body panel stamping press;
(ii) installing a number of robotic cells configured to transform thermoplastic yarn into coloured vehicle composite panels and other parts, without also installing a paint shop of the kind needed to paint conventional pressed steel parts.

C. Building Arrival vehicles in the Arrival microfactory

Feature 6: Robotic Small Cells Assemble Entire Vehicle

We have given a very simple example of a single build process in FIG. 62 to FIG. 67. Section J has a more extensive example.

We can generalise to: A robotic production environment comprising a number of robotic production cells for vehicle production, each cell comprising a group of robots that are programmed to assemble, at a fixed location and not a moving production line, at least part of the vehicle by joining together multiple, modular components, each component designed or selected for robotic production, handling or assembly; and the cells together assemble substantially the entire vehicle.

Feature 7: All Vehicle Components are Designed for Robotic Handling

Section A has described some of the characteristics required of components and parts used in Arrival vehicles.

We can generalise to: A robotic production environment comprising a number of robotic production cells for vehicle production, each cell comprising a group of robots that are programmed to assemble, at a fixed location and not a moving production line, at least part of the vehicle by (a) joining together multiple components to form a structural chassis, and a body structure, and (b) adding body panels and roof panels to the body structure, and all of the components and the panels are designed or selected for robotic production, handling or assembly.

Feature 8: Vehicle with Customer-Specified Configuration

Section D has described the Vehicle Builder Tool; Section I describes how buses of different length can be automatically configured and then built in a microfactory; Section J describes how buses of different length can be automatically configured and then built in a microfactory.

We can generalise to: An electric vehicle design and production process, the vehicle available in multiple different configurations that differ by one or more of the following variables: length, width, height, presence of specific sensors, presence of specific driving aids, presence of any customer-specified option;
and an automated vehicle design tool then automatically selects components required for the specified configuration; and automatically generates build instructions for that vehicle or a fleet of those vehicles;
and a robotic production environment then automatically builds or assembles the vehicle or vehicles, as designed by the automated vehicle design tool, with the specified configuration, using the build instructions.

Feature 9: Vehicle with Customer-Specified Battery Capacity

Section G describes the Arrival modular battery system, including the HVBM, and how its modularity makes it possible for a customer to specify the battery capacity or range required for a vehicle and for the automated Vehicle Builder Tool (Section D) to then configure that vehicle, for production in an Arrival microfactory.

We can generalise to: An electric vehicle design and production process, the vehicle including multiple battery modules; in which an automated vehicle design tool automatically selects battery-related components required for a specified battery capacity or range; and automatically generates build instructions for that vehicle or fleet of vehicles;
and a robotic production environment then automatically builds or assembles the vehicle as designed by the automated vehicle design tool, including a battery pack with the number of battery modules required to meet the specified battery capacity or range, using the build instructions.

Feature 10: Vehicle with Integrated, Customer-Specified Sensors

One area where the configurability of Arrival vehicles is especially valuable is with sensors, such as ADAS, LIDAR, computer vision based driver monitoring, computer vision based passenger monitoring, load or weight sensors. Arrival sensors conform to the Plug and Play model described in Section B, which makes it far simpler to configure a vehicle with potentially unique sensor combinations; with conventional vehicle design, choice in sensors is very limited, and using an entirely new generation of sensor to replace a current generation of sensor is very difficult.

We can generalise to: An electric vehicle design and production process, the vehicle including multiple sensor based systems, such as ADAS, LIDAR, computer vision based driver monitoring, computer vision based passenger monitoring, load or weight sensors, that each conform to a standardised plug and play model;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicles as designed by the automated vehicle design tool, integrating the sensor based systems into the vehicles, using the build instructions.

D. Autonomous Operation in the Arrival Microfactory

Feature 11: Robotic Assembly that is Autonomous at the Robot Level

Robotic autonomy is a key attribute of the Arrival production system and is expanded on in Section E. As noted above, in a microfactory, control is decentralised in a hierarchical manner, with some autonomous operations owned and implemented by each individual robot, some autonomous operations owned and implemented by a cell, some autonomous operations owned and implemented by a group of cells, and some autonomous operations owned and implemented by the microfactory.

We can generalise to: A robotic production environment comprising a number of robotic production cells for vehicle production, each cell comprising a group of robots that are autonomously capable, at an individual robot level, of assembling, at a fixed location and not a moving production line, at least part of the vehicle by joining together multiple, modular components, each selected or designed for robotic handling or installation.

Feature 12: Robotic Assembly that is Autonomous at the Cell Level

We can generalise to: A robotic production environment comprising a number of robotic production cells for vehicle production, each cell comprising a group of robots that are autonomously capable, at an individual cell level, to assemble, at a fixed location and not a moving production line, at least part of the vehicle by joining together multiple, modular components, each selected or designed for robotic handling or installation.

Feature 13: Robotic Assembly that is Autonomous at the Factory Level

We can generalise to: A robotic production environment comprising a number of robotic production cells for vehicle production, each cell comprising a group of robots that are autonomously capable, at a factory level, to assemble, at a fixed location and not a moving production line, at least part of the vehicle by joining together multiple, modular components, each selected or designed for robotic handling or installation.

Feature 14: Autonomous Agent Based Production

Section E describes the agent-based model used in Robofacturing, and implemented in a microfactory.

We can generalise to: A robotic production environment that is configured to determine by itself, dynamically, (i) what steps to perform, (ii) when to perform those step, (iii) by what agents, including both robotic agents and also non-robotic agents, those steps should be performed and (iv) how those agents are to interact with each other to build or assemble a device; and in which the robotic agents are organised as cells, each with no more than ten robots, served by autonomous mobile robots (AMRs).

Feature 15: Semantic Model

Section E describes the semantic model used in Robofacturing, and implemented in a microfactory.

We can generalise to: A robotic production environment that is configured to assemble vehicles in a robotic production environment, in which the robotic production system (i) hosts robotic agents that are organised as groups of cells, each cell with no more than 10 fixed robots, served by AMRs (autonomous mobile robots), and each cell is responsible for production of, transforming, handling or assembling some part of a vehicle;
and the robotic production environment is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle;
and the robotic production environment uses a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.

Feature 16: Takt Time Agnostic Production

Section E describes the takt-time production model used in Robofacturing, and implemented in a microfactory.

We can generalise to: A robotic production environment for production of a vehicle, in which the environment operates with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.

The following optional sub-features are relevant to all Section F Features above.

Context
the factory is a ‘microfactory’ that is between approximately 5,000 and 25,000 square metres in size.
the microfactory is between approximately 10,000-25,000 square metres in size.
the microfactory does not have a moving production line along which the vehicle is incrementally assembled, but instead fixed cells served by AMRs.
the microfactory does not have a metal body panel pressing plant, or use pressed metal body panels, but instead a composite panel production environment.
the microfactory does not have a paint shop configured to paint pressed metal body panels, but instead a coloured composite panel production environment.
the microfactory is a conventional warehouse with a flat concrete floor that has not been strengthened for a metal body panel pressing plant.
the microfactory is a conventional warehouse that does not have environmental systems required for a paint shop configured to paint pressed metal body panels.
the robotic production environment includes both the factory and computing resources that are external to the factory, e.g. cloud-based.
the robotic production environment includes multiple such factories and is a distributed system.

Robotic Production Environment or System Operation
the robotic production environment or system is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle.
the robotic production environment or system implements semantic (ontology driven) decision making.
the robotic production environment or system uses a semantic (ontology driven) model of physical features, such as the location and function of agents, including robots, end-effectors used by robots, AMRs, cells served by AMRs, and fixed static objects.
the robotic production environment or system implements self-learning or automatically adapts and improves its operations.
the robotic production environment or system enables re-configurable, just-in-time vehicle production.
the robotic production environment or system includes a model or map of the physical environment that is generated or augmented or refined in real time by AMRs and robots using at least SLAM computer vision techniques.
the robotic production environment or system includes a master semantic model of the physical environment that enables AMRs and robotic agents to relate at a semantic level to the function or other attributes of objects, both fixed and dynamic they detect.
the robotic production environment or system is automatically reconfigurable through software-implemented changes to automatically: make different components, to assemble different types of vehicles, to assemble different configurations of the same type of vehicles, to use different assembly techniques, to use different components, or to transport vehicle parts or structures through the physical environment of the factory using alternate physical routes.
the robotic production environment or system is automatically reconfigurable through software-implemented changes that alter one or more of: the function of robotic agents, the physical location or arrangement of robotic agents, the number of operative robotic agents; the routes taken by AMRs.
there is no pre-defined Takt time in relation to the completion of any robotic services, or the completion of a set of robotic services.
robotic production environment implements semantic (ontology driven) decision making, self-learning and is self-controlled.
robotic production environment builds or assembles a device as designed by the automated vehicle design tool and using modular hardware components and modular software components.
robotic production environment is instructed to build a device using data sent from the automated vehicle design tool.
robotic agents are configured for some or all of: pick and place, insert, glue, screw, welding.
robotic agents are served by AMRs for parts delivery.
robotic production environment includes multiple cells, each with no more than 10 fixed robots, served by AMR (autonomous mobile robots).
The robotic production environment is configured to produce or assemble vehicles.
robotic production environment builds or assembles a vehicle as designed by an automated vehicle design tool.

Cell Operation
the robotic production environment includes robotic agents that are organised as a group of cells in the factory, each cell with no more than 10 fixed robots, such as 6DoF robots, served by AMRs (autonomous mobile robots), and the group of cells works together to assemble substantially an entire, complete vehicle.
the totality of cells in the factory are responsible for assembling substantially an entire, complete vehicle.
each cell is responsible for assembling at least portions of a vehicle and is configured to automatically determine dynamically and in real-time, autonomously or in conjunction with other computing resources in the robotic production environment (i) what steps or robotic services to perform, (ii) when to perform those steps or robotic services, (iii) by what agents, including both robotic agents and also non-robotic agents, those steps or robotic services should be performed and (iv) how those agents are to interact with each other, to build or assemble a vehicle.
cells exchange data with other cells in the factory, directly, or over a network.
each cell of robots is configured to dynamically and in real-time work out amongst themselves, arbitrating as required, and execute, the optimal production process for each vehicle sub-assembly or components they assemble.
a cell undertakes the assembly and joining of modular transverse chassis sections together for a specific vehicle.
a cell undertakes the joining of frames or modular body parts to modular transverse chassis sections.
a cell undertakes the joining of modular drivetrains to modular transverse chassis sections.
a cell undertakes the joining of modular wheel housings to modular transverse chassis sections
a cell undertakes the joining of, or insertion, of modular battery packs to the chassis.
a cell undertakes the assembly and joining of modular components to the chassis.
the assembly of the chassis and the addition one or more of the drivetrain, suspension, battery packs for a specific vehicle is all completed by a single cell.
using components that conform to enables low volume (e.g. 10,000 or fewer vehicles per year) yet economically viable production of vehicles in the microfactory.
the cells work co-operatively to enable low volume, customer specific production of vehicles.
adding further cells in a microfactory enables scaling of production capacity.

Vehicle Builder
the robotic production environment receives data from an automated vehicle design tool defining the production of a vehicle.
the automated vehicle design tool defines all components needed to assemble a vehicle, and the location of all components and the power and/or data network for components.
the robotic production environment then produces, or controls the production of, the vehicle, by (a) using the data sent by the automated vehicle design tool and (b) using robotic services, as defined by the automated vehicle design tool or a different tool.
the automated vehicle design tool is configured to enable a range of different vehicles to be designed.
the automated vehicle design tool is configured to enable vehicles to be designed that specifically meet a customer's (e.g. B2B customer) set of requirements.
the automated vehicle design tool analyses a design for the vehicle and plans an optimal, automated production of that vehicle using a catalogue of available robotic services.
the robotic production environment receives a list of selected components from the automated vehicle design tool, the automated device design tool having automatically generated the list of the components to optimally meet requirements, e.g. customer requirements.
the automated vehicle design tool is configured to design any of the following: small passenger car, large passenger car, small van, large van, specialist vans, truck and lorries of different lengths and capacities, buses of different lengths and capacities.

Robotic Services
robotic services are the services available from all agents in the automated robotic production environment.
robotic services include any of the following, in relation to a component or item: storing; retrieving; moving; delivering; gripping; rotating; pick and placing;
assembling; gluing; inserting; joining; welding; any other handling operation.
robotic services include locating a component or item using a machine vision system.
robotic services include identifying a component or item using a machine vision system.
each cell implements a specific sub-set of all available robotic services.
different fixed robots each have specialised end-effectors for providing specific robotic services.
robotic services are defined by an extensible and standardised list or schema of capabilities, enabling any supplier to provide services for the automated robotic production environment, provided that those services conform to the list or schema of capabilities.
robotic services are used in the automated robotic production environment to perform actions on components, and the components are each optimised for robotic handling.
robotic services include any of: identifying the pose of a component; reading the unique ID of a component; picking up the component; moving the component to a target position; attaching the component to another component; fastening the component to another component; screwing a standardised fastener; punching a standardised fastener; connecting standardised electrical interfaces.
robotic services includes gluing and some robots include glue delivery effectors that are configured to inject glue into glues holes in chassis sections of a vehicle platform to join those sections together.
the vehicle includes a structural chassis made up of transverse sections that are configured to be glued together, and in which each section includes one or more glues holes and channels to enable glue from the glue delivery effectors to flow under pressure around tenons or other joints that are themselves optimised in shape to ensure effective and complete glue coverage.
each section includes one or more glue channels and a foam bung configured to seal a channel.

Agents
agents include: fixed robots (e.g. with 6 degrees of freedom); cells of robots; groups of cells of robots; and mobile robots or AMRs.
agents include: fixed robots (e.g. with 6 degrees of freedom); cells of robots; groups of cells of robots; and mobile robots or AMRs, and humans equipped with wireless information terminals.
robotic agents are configured for some or all of: pick and place, insert, glue, screw, welding.
robotic agents are served by AMRs for parts delivery.
AMRs and robots use SLAM based computer vision systems to generate a map of their local environment.
AMRs and robots use a semantic (ontology driven) model of physical features, such as the location and function of other AMRs, robots, end-effectors used by robots, targets being handled or modified by the robotic end-effectors.

Factory Layout
the physical layout or arrangement of cells in the robotic production environment is optimised by an automated layout design tool that determines the optimal layout or arrangement of cells and the robotic services they each perform.
automated layout design tool determines the optimal layout or arrangement of cells and the robotic services they each perform, taking into account parameters such as: production cost; production time; production quality; component availability; use of AMRs to transport components to cells and sub-assemblies to and from cells.
automated layout design tool determines the distribution of component stores in the production environment.
automated layout design tool determines the arrangement of paths or tracks for AMRs to reach component stores and provide components to cells in the production environment.
automated layout design tool determines the layout or arrangement of cells and the robotic services they each perform using simulation, including simulation using a robotic services control system.
automated layout design tool plans the optimal layout or arrangement of cells on a standardised rectilinear grid.
the robotic services control system used in the simulation is also used to control robotic services in the real-world.

Vehicle Variants
the robotic production environment is configured to assemble at least one of the following: small passenger car, large passenger car, small van, large van, specialist vans, truck and lorries of different lengths and capacities, buses of different lengths and capacities.
the robotic production environment is configured to assemble several of the following: small passenger car, large passenger car, small van, large van, specialist vans, truck and lorries of different lengths and capacities, buses of different lengths and capacities.
vehicle can be any of a car, van, bus, truck.
single robotic production environment can produce any of the following: a car, van, bus or truck.
each cell can be re-purposed to be part of a set of cells that produce any of a car, van, bus or truck.
vehicle can have a range of different battery modules (HVBMs), for example 12, 18, 24, 30 and 36 for a van, giving 44 kWh, 67 kWh, 89 kWh, 111 kWh, 133 kWh respectively.
using the automated vehicle design tool, van length can be selected from at least two different lengths, and a van of each length can have a height selected from at least two different heights, and a van of a given length and height can have a number of HVBMs selected from at least three different numbers of HVBMs.
using the automated vehicle design tool, bus length can be selected from at least two different lengths, and a bus of each length can have a number of HVBMs selected from at least two different numbers of HVBMs.

Specific Vehicle Assembly Operations in the Factory
the robotic production environment assembles a specific type of body module.
for a bus, the body module types are: a front module, a wheel housing module, a door module, a window-only module, a rear module.
further body module types include: a driver module, a driverless cab module, a passenger module, a rear module, a cargo module, or any task specific module, and all are configured to be fixed to the chassis sections in substantially the same manner e.g. by a robotic production system.
Each body module is configured to be glue bonded together, e.g. using a robotic production system.
the robotic production environment assembles a vehicle with a skateboard chassis.
vehicle includes a structural chassis made up of transverse sections that are configured to be joined together by a robotic production system to provide a substantially flat-topped platform.
vehicle includes a structural chassis made up of transverse sections that are configured to be glued together by a robotic production system to provide a substantially flat-topped platform.
vehicle includes a substantially flat-topped platform onto which different modules can be placed, such as a driver module, a driverless cab module, a rear module, a cargo module, or any task specific module, and all are configured to be fixed to the flat-topped platform in substantially the same manner by a robotic production system.
vehicle includes a substantially flat-topped platform including shaped channels into which modules are configured to be slotted by a robotic production system.
vehicle includes a suspension spring for a wheel that is attached to the apex of a structural wheel housing (e.g. a single large aluminium casting) that is attached to the skateboard chassis, and the spring is positioned substantially vertically within the wheel housing.
vehicle has an internal floor that is substantially flat and sits over the skateboard chassis.
vehicle includes wheel arches made as a large single casting onto which the motor or IDU, and suspension mounts are directly attached and the wheel arches are attached to the skateboard chassis.
the robotic production environment or cell assembles a chassis or platform configured to receive multiple integrated drive units (IDU).
each IDU conforms to one of the following types: an IDU including a motor and control electronics; an IDU including a motor, control electronics and a differential; an IDU including two motors and a gearbox; and in which each type of IDU is configured to be bolted or attached to the chassis or platform or a structural wheel arch (e.g. a single large cast aluminium wheel arch) by a robotic assembly system.
the robotic production environment assembles modular transverse chassis sections.
   modular transverse chassis sections have a fixed length, e.g. 1.5 m.
   modular transverse chassis sections for wheel housings have the same fixed length as modular transverse chassis sections for the main body of the vehicle.
   modular transverse chassis sections have a structural one piece bottom plate.
   modular transverse chassis sections are configured to support an extruded aluminium frame.
   vehicles of different length are assembled using a different number of modular transverse chassis sections.
   modular transverse chassis sections are joined together when oriented horizontally, so that additional chassis sections extend the vehicle longitudinally.
   The modular transverse chassis sections, when joined together, provide a substantially flat-topped chassis or platform.
   modular transverse chassis sections include a central rigid beam that connects to a rigid structure in an adjacent chassis section.
   modular transverse chassis sections for wheel housings include a flat, extruded aluminium panel with a cut-out on opposite sides, shaped to receive a wheel housing.
   an integrated drive unit (IDU) is attached to a modular transverse chassis section.
   a modular transverse chassis section is configured to receive multiple different types of integrated drive unit (IDU), which each conform to one of the following types: an IDU including a motor and control electronics; an IDU including a motor, control electronics and a differential; an IDU including two motors and a gearbox; and in which each type of IDU is configured to be bolted or attached to a modular transverse chassis section or a structural wheel arch (e.g. a single large cast aluminium wheel arch).
   the modular transverse chassis sections are glued together, e.g. using a robotic production system.
   each modular transverse chassis section includes one or more glues holes and channels to enable glue to flow under pressure around tenons or other joints that are themselves optimised in shape to ensure effective and complete glue coverage.
   each modular transverse chassis section includes one or more glue channels and a foam bung configured to seal a channel.
   battery pack modules of a standardised size are assembled into or onto a modular transverse chassis section.
      the robotic production environment assembles frames
each modular transverse chassis section includes a channel or socket into which body frames are configured to be slotted, e.g. by a robot.
the body frames are made of extruded aluminium beams or poles.
the body frames are made of extruded aluminium beams or poles that have male/female friction fit joints that are glue bonded together.
some body frames are configured to receive and retain body panels.
body panels are made of a composite material.
body panels are made of aluminium skimmed thermoplastic.
body panels are glued to the frames by a robot.
some body frames are configured to receive and retain display panels (e.g. LED displays).
some body frames are configured for a specific type of body module.
   the robotic production environment assembles modular vehicle components
the vehicle component is modular or standardised by virtue of having a size that conforms to regular size intervals and is part of a family of other types of components, all with sizing that also conforms to the same size intervals.
the vehicle component is modular or standardised by virtue of being part of a family of other types of components, all being configured to be positioned or installed in the vehicle in a regular, rectilinear grid or installation pattern.
the vehicle component is modular or standardised by virtue of being part of a family of other types of components, all having an external casing feature or features that are optimised for robotic handling, installation or assembly, such as autonomous robotic handling, installation or assembly.
the vehicle component is modular or standardised by virtue of being part of a family of other types of components, all having the same overall type of shape (e.g. box type shape), the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.
the vehicle component is modular or standardised by virtue of being part of a family of other types of components, all designed for an installation path to a final position, in which the installation path is optimised for robotic handling, installation or assembly, such as autonomous robotic handling, installation or assembly.
the vehicle component is modular or standardised by virtue of being part of a family of other types of components, that each use the same, standardised physical installation systems, that are each optimised for robotic handling and use.
the vehicle component is modular or standardised by virtue of being part of a family of other types of components, that each use the same, standardised identification system that gives each individual component a unique identification that is (i) computer readable; and (ii) enables each individual component to be tracked from initial production to initial installation, and subsequent servicing and end-of-life.
the vehicle component is modular or standardised by virtue of being part of a family of other types of components, that each use the same, standardised physical connectors.
the vehicle component is modular or standardised by virtue of being part of a family of other types of components, that each use the same, standardised data and/or power interface.
the vehicle component is modular or standardised by virtue of being part of a family of other types of components, that each use the same, standardised security system or protocol.
components are defined by grid-based modular shape and sizing to assist computer vision analysis and robotic handling.
components include flat surfaces to facilitate robotic gripping.
components include extrusions, such as aluminium extrusions.
components include one or more structural wheel arch castings, each configured with mounting features for an integrated drive train to be mounted against.
components include structural wheel arch castings, each configured with mounting features for a suspension system to be mounted against.
components include composite panels.
components are not spot welded together but mechanically attached, with adhesive binding.

Section G: The Arrival Battery Module and the Flex Connector

Introduction to this Section G

In this Section G, we gave a high-level walk-through of the Arrival battery module system. The Arrival system uses a vehicle battery pack made up of a number of battery modules that are modular, scalable, and designed for robotic assembly—key enabling attributes for the Arrival system.

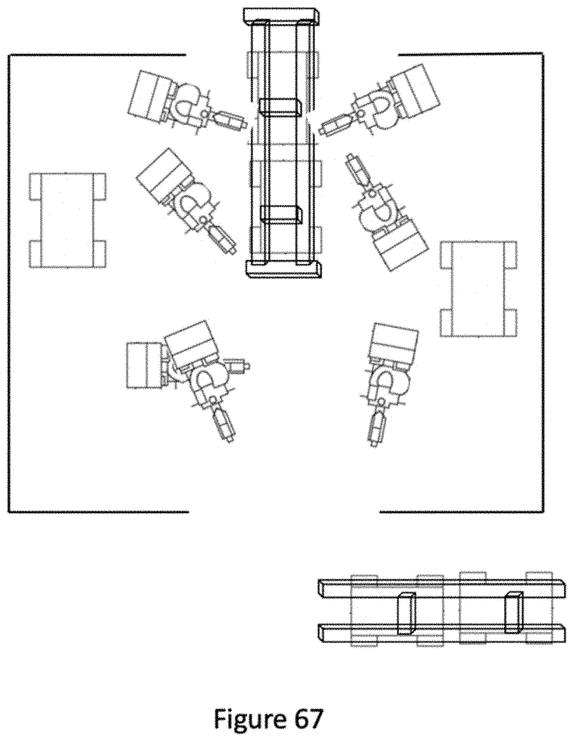

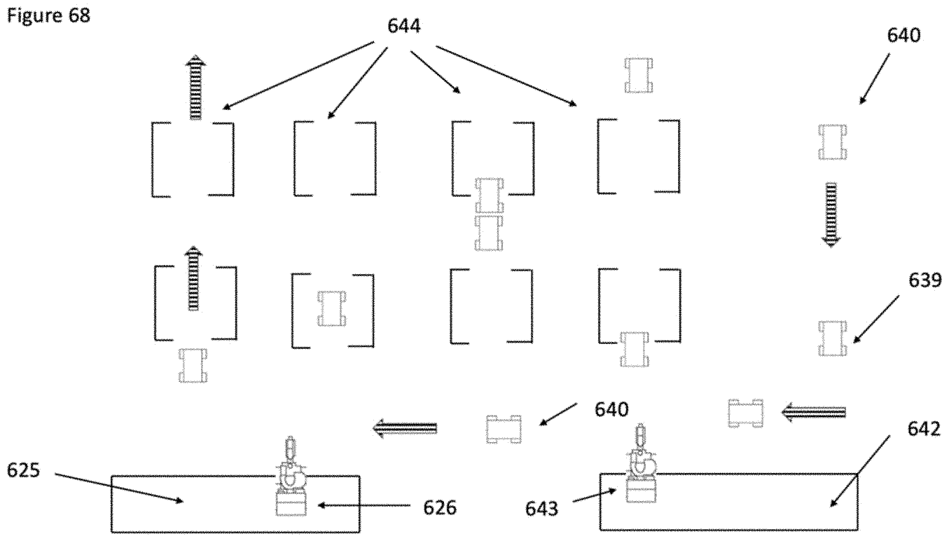

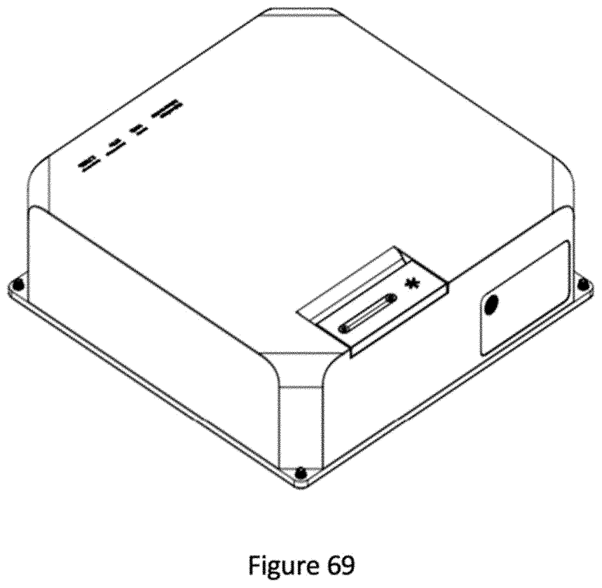

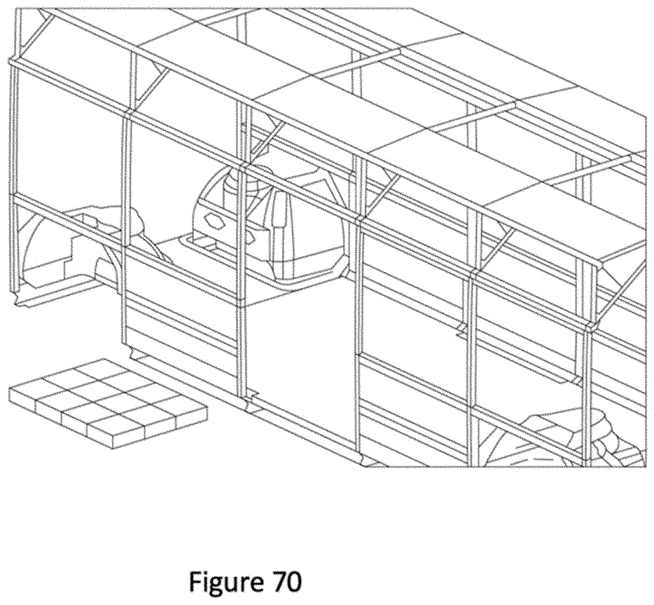

In one implementation, these modules are High Voltage Battery Modules (HVBMs): Arrival's High Voltage Battery Module or HVBM is designed as a self-contained battery module with internal safety systems and an isolated high voltage output of 350V to 400V nominal. Each HVBM is capable of operating as an independent or autonomous unit and of receiving charge, e.g., during regenerative braking and charging from an external power source. FIG. 69 shows an Arrival HVBM; this battery module includes 204 individual 21700 Li-Ion cells arranged in a 102S2P configuration. Each cell in a HVBM generates 3.63V (nominal) and 4.2V (max), has 5 Ah capacity, stores 18.2 Wh. Each HVBM provides a high output voltage (ranging from 428V with 100% SOC down to 255V at 0% SOC), facilitating low output current, low weight harnessing, and the capability to power High Voltage components using one module. More modules in parallel increases energy storage/range. Two HVBMs can be connected in series to deliver approximately 800V. The module is designed for efficient robotic production. It is designed for efficient robotic installation in a vehicle: an array of these modules can be connected together in any arbitrary number, since they are parallel connected. HVBMs are in robust packaging designed for robotic handling (e.g. designed with easy to grip surfaces; are not individually heavy, weighing under 20 Kg; are compact, with dimensions: 350×350×100 mm). FIG. 70 shows an array of twelve modules being slid into the side of the Arrival Bus (see Section J). HVBMs can not only provide power for vehicle traction, but can also be used for domestic and industrial energy storage, and as part of a renewable energy system.

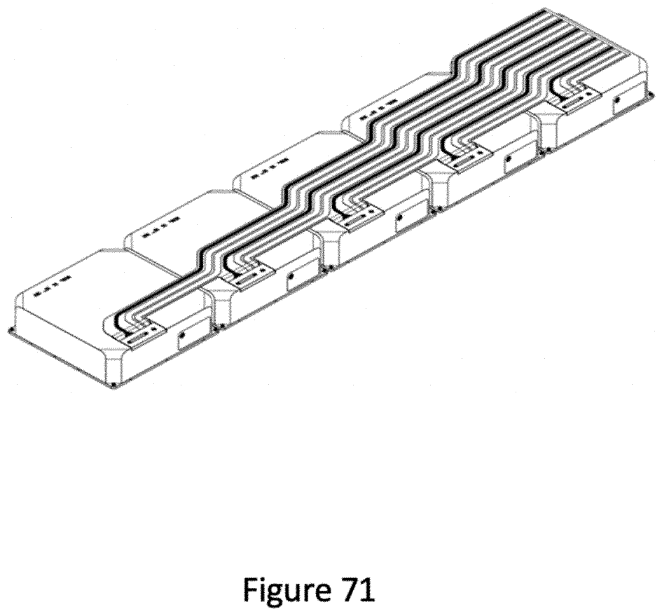

Because the HVBM is a self-contained, modular device, and each HVBM outputs at the voltage required by the vehicle's DC bus (e.g. 400V), HVBMs are connected together in parallel and also connected to the high voltage bus using a flexible, thin PCB-based connected called Flex which is designed to be robotically handled and installed into a vehicle. Because the Flex PCB conductor is flat, light and flexible, it can be handled and installed robotically far more easily than conventional electrical cabling. FIG. 71 shows a group of five HVBMs connected together using this flexible, thin PCB conductor.

The HVBM approach leads to easy scalability: more HVBMs can be parallel connected using Flex connections to give whatever battery pack capacity is needed for a specific vehicle. For conventional series connected battery modules, this straightforward scalability is not possible. Because the HVBM is both modular and also scalable without significant changes to the overall battery pack architecture, the automated Vehicle Builder system (see Section D) can automatically create a build definition for vehicles with entirely different numbers of HVBMs and battery pack capacities, since it requires typically just extending the length of the array of parallel-connected HVBMs used to deliver a required pack capacity. The Robofacturing system (see Section E) in the Arrival Microfactory (see Section F) can then readily build different vehicles, with very different battery pack capacities, all at the same time, without any need to re-configure the Microfactory layout or its operations, since it is fundamentally merely a question of adding in the required number of HVBMs into a given vehicle and connecting them appropriately.

This ability to efficiently customise to a specific requirement is one of the defining attributes of the Arrival system and the HVBM is one of the enabling technologies that makes it possible.

The features described in this Section G apply irrespective of battery chemistry: whilst current implementations use Li-ion cells, the same principle applies equally well to solid-state batteries, such as Lithium-metal batteries and Lithium-sulfur batteries. Solid-state batteries are inherently safer and lighter than Li-ion batteries; the Arrival battery module is designed to be readily stackable for storage, easily and safely manually carried, and readily robotically installed into a battery pack, even with conventional Li-ion cells. These advantages will be even greater with a battery module that uses light and stable solid-state batteries.

There are advantages flowing from making the battery module a high voltage module (i.e. the battery module output matches the device's main DC bus voltage—typically 300V to 400V for a DC bus driving traction motors for a vehicle). But the principle of a self-contained, battery module, capable of operating as an independent or autonomous unit that forms a part of a larger battery pack, is not limited to the module delivering a high voltage; it applies also to modules that are not high voltage, e.g. modules that need to be series-connected to deliver the required DC bus voltage.

In the following sections, we will focus on specific features of the Arrival Battery Module, organised into four main groupings:

### Group A: Core Battery Module Principles

Group B: Battery Module Physical Structure features
Group C: Battery Module internal component features
Group D: Battery Module and the complete power system, including BMS and the battery

### Group E: Battery Module Operational Features

Starting with Group A:

Group A: Core Battery Module Principles

Feature 1. Battery Module Generates an Output at a 300V+ DC Bus and is Connected in Parallel to Other Battery Modules to Form a Battery Pack

A battery module configured to operate as part of a vehicle battery pack that includes multiple, identical such battery modules, in which each battery module (i) generates at least 300V nominal output and (ii) is electrically connected in parallel with at least 2 other substantially similar battery modules to form the battery pack.

Feature 2. Battery Module Operates as an Autonomous Module in a Battery Pack

A battery module that (i) includes an array of rechargeable cells and monitoring and control systems configured to enable the battery module to operate using autonomous monitoring and control; and (ii) is configured to be electrically connected to further battery modules, to form a complete battery pack.

Group B: Battery Module Physical Structure Features

Feature 3. Battery Module with Standard Grid Sizing

A battery module configured to operate as part of a vehicle battery pack that includes multiple, identical such battery modules, in which each battery module has a size that conforms to a regular size interval scale and is part of a family of other types of components with sizing that also conforms to the same size interval scale.

Feature 4: Modular Components Installed Using the Same Regular, Rectilinear Grid or Installation Pattern

A battery module configured for robotic installation or assembly into a device or system by virtue of being configured to be positioned in a regular, rectilinear grid or installation pattern.

Feature 5. Battery Module Configured for Robotic Assembly

A battery module configured to operate as part of a vehicle battery pack that includes multiple, identical such battery modules, in which each battery module is configured for robotic installation or assembly to the battery pack by virtue of having a shape that is optimised for robotic installation or assembly.

Feature 6. Battery Module that Sits on a Rigid Base Plate that in Turn Sits on a Liquid Cooled Plate

A vehicle battery module including multiple cylindrical form-factor rechargeable cells, in which the battery module includes a base on which the rechargeable cells are positioned, in which the base provides a structurally rigid support for the cells and also provides thermal cooling for the cells.

Feature 7. Battery Module in which all Rechargeable Cells have the Same Polarity Orientation

A vehicle battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation.

Feature 8. Battery Module that has its Own Cover, and Connects to Other Similar Modules to Form a Battery Pack

A vehicle battery module that generates at least 300V output at maximum charge, and (i) includes a single outer shell or lid that is configured to enclose an array of rechargeable cells and seal against a rigid base of the module, and (ii) is configured to be electrically connected to further, substantially similar, battery modules, to form a complete battery pack.

Feature 9. Battery Module that Slides into Chassis Void

A vehicle battery module, configured to operate as part of a battery pack that includes multiple, identical such battery modules, in which one or more battery modules are configured to be inserted, either individually or when part of a battery pack, into a void sitting over a substantially flat chassis base of the vehicle.

Group C: Battery Module Internal Component Features

Feature 10. Battery Module with Internal Isolation Switch

A vehicle battery module configured to operate as part of a battery pack that includes multiple, identical such battery modules, in which each battery module (i) includes rechargeable cells configured to generate, at a pair of output terminals, at least 300V nominal and (ii) includes an internal isolation switch system, configured to isolate all cells from one or both of the output terminals.

Feature 11. Battery Module with a Bypass Series Switch

A vehicle battery module configured to operate as part of a battery pack that includes multiple, identical such battery modules, in which each battery module (i) includes rechargeable cells configured to generate, at a pair of output terminals, at least 300V nominal and where at least some of the cells are connectable in series to form a string of cells, and the module includes a switch that is configured to either connect two or more cells in series or to bypass those cells.

Feature 12. Battery Module with Layered Component Architecture

A vehicle battery module with a layer construction in which, sitting over battery cells, are one or more separate layers with components or systems that enable the battery module to manage its internal operation, each layer each occupying substantially the entire width or cross-section area of the battery module.

Group D: Battery Module and the Complete Power System, Including BMS and the Battery Pack

Feature 13. Battery Module with Flexible PCB Power Cable

A vehicle battery module configured to operate as part of a battery pack that includes multiple, identical such battery modules, and which delivers power over a substantially low profile, printed circuit board (PCB) flexible electrical conductor.

Feature 14. Battery Module that Delivers HV Direct to the HV Bus

A vehicle battery module configured to deliver HV output directly into the HV power bus of a vehicle.

Feature 15. Battery Module that Connects to Integrated Power Cables

A vehicle battery module configured to electrically engage with a conductor that is integrated into a vehicle component or other vehicle structure that has a purpose in addition to conducting power, such as a structural component or panel.

Feature 16. Battery Pack Including Battery Modules and a BMS

A vehicle battery pack comprising multiple battery modules, where the battery pack is configured to be assembled from multiple parallel connected battery modules, each module generating a high voltage output at a voltage magnitude that is used in a system powered by the module and that is at least 300V nominal;
and a battery management system is distributed across each individual battery module and is also in a master BMS that is external to all battery modules, so that each individual battery module is able to galvanically isolate itself, and the master BMS is also able to independently galvanically isolate any battery module.

Group E: Battery Module Operational Features

Feature 17. Battery Module Implementing Plug and Play Software Components

A vehicle battery module, configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer.

Feature 18. Battery Module with Decentralised Autonomy, Operating in a Distributed Architecture

A vehicle battery module, configured to operate as part of a battery pack that includes multiple, identical such battery modules, in which each battery module is provisioned with modular software components that monitor and control battery systems to enable the battery module to operate autonomously and individual modular software components exchange data with modular software components on other battery modules to provide a distributed architecture.

Feature 19 Battery Module with Performance Reporting

A battery module configured to operate as part of a battery pack that includes multiple, identical such battery modules, in which each battery module is part of a data-network that establishes a network of modules, and each battery module includes an internal performance monitoring and management sub-system that autonomously manages the battery module and reports data to an external BMS.

Feature 20. Battery Module that Autonomously Negotiates with Other Battery Modules

A battery module configured to operate as part of a battery pack that includes multiple, identical such battery modules, in which each battery module is part of a data-connected network of modules, and each module is configured to autonomously negotiate with other modules to determine power or performance compatibility.

Feature 21. Battery Module with Crypto-Network

A battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in.

Feature 22. Battery Module that Self-Initialises

A vehicle battery module configured to operate as part of a battery pack that includes multiple, identical such battery modules, in which each battery module is part of a data-connected network of vehicle battery modules, and in which each battery module configures itself or otherwise self-initialises to operate with the network when it is added to the network or is turned on.

Feature 23: Battery Module with Ambient Pressure Equalisation Vent

A battery module with ingress protection of at least IP 65, in which the battery module includes an air pressure equalisation vent configured to enable air pressure equalisation inside the module to ambient or external air pressure whilst maintaining ingress protection.

Feature 24: Battery Module with Gas Escape Vents

A battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

Feature 25: Battery Module with Internal Monitoring or Control Systems

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture.

### BRIEF SUMMARY OF THE FIGURES RELATING TO SECTION G

One implementation of the Arrival HVBM system is shown in the accompanying figures, in which:

FIG. 69 is a perspective view of a single battery module, the Arrival HVBM

FIG. 70 is a schematic view of a pack of twelve HVBM battery modules being slid into the side of an Arrival Bus chassis or skateboard platform.

FIG. 71 is a perspective view of five HVBM battery modules connected together with Flex PCB connectors

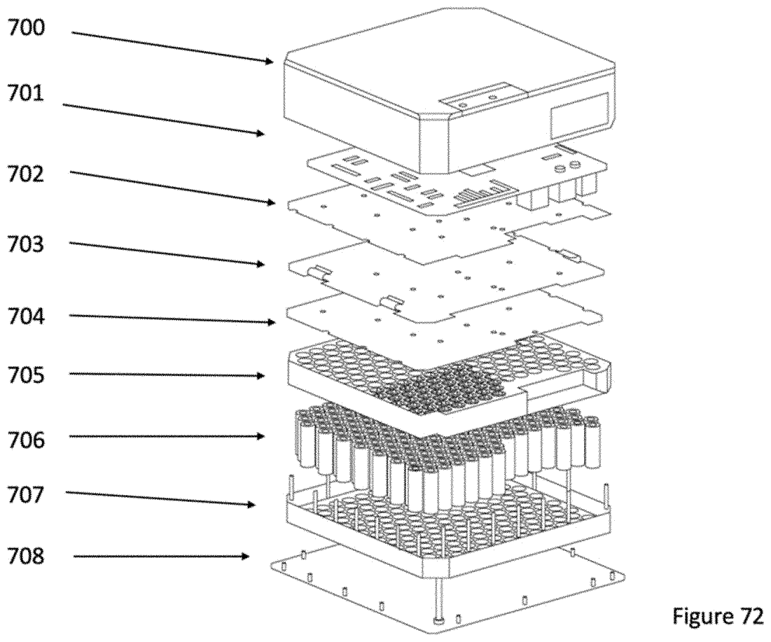

FIG. 72 is an exploded view of the HVBM battery module showing the multi-later structure optimised for robotic production;

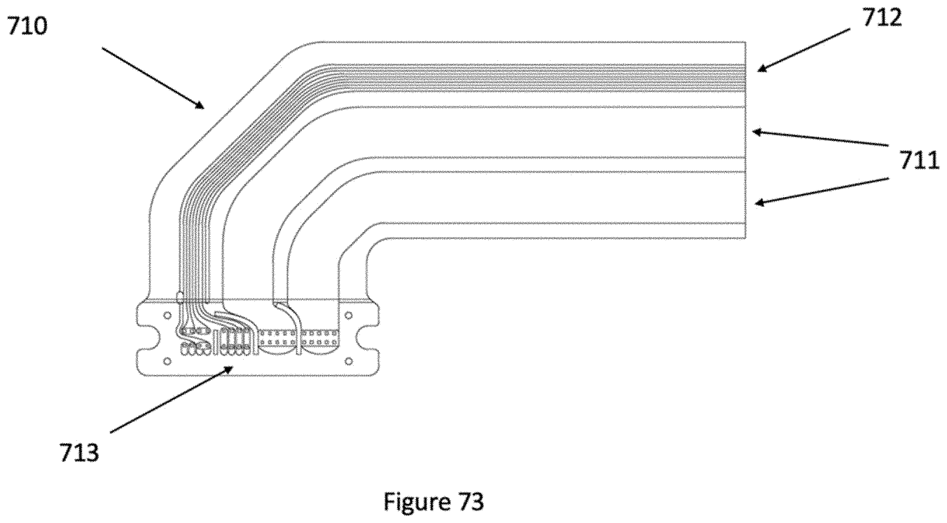

FIG. 73 is a top down view of the end of a Flex PCB connector that connects to a HVBM battery module

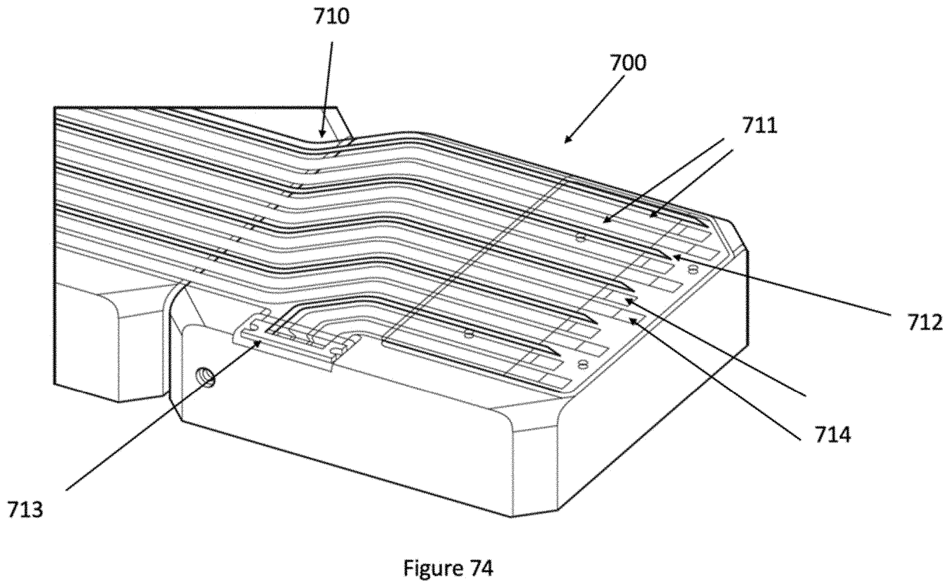

FIG. 74 is a perspective view an HVBM battery module with Flex PCB connector

FIG. 75 is a top down view of a group of five HVBM battery modules connected together with Flex PCB connectors

FIG. 76, adjacent to FIG. 75, shows a perspective view of those modules with Flex PCB connectors.

### Index to FIGS. 69-76

| Reference | |
|---|---|
| numeral | Description of item |
| 700 | HVBM |
| 701 | lid |
| 702 | PCB |
| 703 | dielectric separator |
| 704 | balancing flex |
| 705 | upper cell carrier |
| 706 | cells |
| 707 | lower cell carrier |
| 708 | base plate |
| 710 | Flex PCB conductor |
| 711 | pair of high voltage tracks |
| 712 | data track |
| 713 | standard electrical connector to HVBM |
| 714 | HV bus connectors |

### DETAILED DESCRIPTION FOR THIS SECTION G

Group A: Core Battery Module Principles

Feature 1. Battery Module Generates an Output at a 300V+DC Bus Voltage and is Connected in Parallel to Other HVBMs to Form a Battery Pack

The conventional approach is for a vehicle battery module to produce 90V-100V nominal, and to series connect these battery modules to reach the required output voltage (e.g. 350V-400V) and to then package these modules into a large, sealed battery pack that outputs 350V-400V. The 350V-400V is hence only generated at the latest possible point it can be generated. The Arrival HVBM turns this approach on its head: instead of generating the 350V-400V output at the latest possible point, it is generated at the earliest point—namely at each individual battery module. Arrival's HVBM is a battery module that outputs approximately 350V to 400V nominal when it is designed for use in a vehicle with a 400V DC bus and other load components. A number of HVBMs are connected in parallel and not series to form a 350V-400V battery pack; for example, for a small Arrival car, ten HVBMs could be connected in parallel. For a van, twenty modules could be connected in parallel. The highly modular Arrival HVBM system offers far greater flexibility than earlier battery modules and battery packs in enabling the specific cost, range, power and lifetime needs of customers to be met, and for their evolving needs to be met as well. For example, the conventional vehicle design paradigm locks in certain vehicle attributes: if you have designed a large 350V-400V battery pack made up of say four series connected battery modules, each producing 90V-100V, then the fixed dimensions and power profile of that battery pack essentially constrain its use into the vehicles of very similar dimensions and power requirements as the parent vehicle: if that parent vehicle is a medium sized car, then the battery pack can only feasibly be used in other medium sized cars, and not, for example, in a large bus. Yet with the Arrival HVBM, the same battery module could be used on its own, e.g. to power a small motorbike, or assembled into a pack of 10-20 battery modules for a car, or 100+ modules for a bus. In the Arrival system, a customer e.g. of a van, might specify a battery pack with range that can be met with 40 HVBMs; another customer for the same type of van might specify a battery pack with range that requires 60 HVBMs. Because the HVBM is both modular and also scalable without significant changes to the overall battery pack architecture, the automated Vehicle Builder system can automatically create the build definition for both types of vans since it requires typically just extending the length of the array of parallel-connected HVBMs used; the Robofactoring system in the Arrival Microfactory can then build both vans at the same time, without any need to re-configure the microfactory layout or its operations.

We can generalise to:

A battery module configured to operate as part of a vehicle battery pack that includes multiple, identical such battery modules, in which each battery module (i) generates at least 300V nominal output and (ii) is electrically connected in parallel with at least 2 other substantially similar battery modules to form the battery pack.

Feature 2. Battery Module Operates as an Autonomous Module in a Battery Pack

We have also seen above that the Arrival HVBM is a self-contained module capable of independent or autonomous operation; this feature results in considerable flexibility when designing a vehicle (e.g. using the automated Vehicle Builder to provision a broad range of numbers of HVBMs to meet a specific customer's requirements for a specific vehicle or fleet of vehicles) since it makes it much easier to use the optimal number of HVBMs for the specific customer requirements of range, cost and lifetime: the Arrival battery module is modular and scalable and the control architecture of the battery pack is decentralised (whether or not it is a HVBM or outputs a lower voltage and need to be series connected to other similar battery modules). Without those attributes, it would be very difficult to be able to produce such a broad range of vehicles, at the same time and in the same Microfactory. Battery module provisioning for a specific vehicle at build time is made easier since each module is capable of independent or autonomous operation; this is especially important where your flexible Robofacturing system is able to scale to install any arbitrary number of battery modules into different vehicles, all of which could be being simultaneously produced in the same microfactory.

We can generalise as follows:

A battery module that (i) includes an array of rechargeable cells and monitoring and control systems configured to enable the battery module to operate using autonomous monitoring and control; and (ii) is configured to be electrically connected to further battery modules, to form a complete battery pack.

Group B: Battery Module Physical Features

Feature 3. Battery Module with Standard Grid Sizing

The Arrival battery module has a standard size of 350×350×100 mm; this size is defined by a size architecture number system (see Section A) that is a simple and compatible system to accurately cover size intervals defining a wide range of sizes for a wide variety of different components. The word ‘size’ should be interpreted broadly. In many cases it will refer to a dimension of length, but it may also refer to an area, weight, capacity to perform, rating and so forth.

By conforming the size of the battery module to the standard size architecture, which is used for many different components in the vehicle, it becomes much more reliable and also faster to design the packaging for those components, since all packaging and mounting interfaces conform to the standard size architecture. This is especially useful when the vehicle has a standard ‘skateboard’ platform, like the Arrival Car described in Section K.

It is also much easier to provide or machine position mounting holes on various structures in the vehicle, knowing that any component designed using the standard size architecture should fit into those mounting holes. Robotic handling and installation of components is also facilitated, since we have reduced significantly the possible sizes of different components and where they can be located or installed. The standard size architecture can also be used to define a regular grid such as a rectilinear grid; mounting interfaces for an array of battery modules can be positioned on a mounting plate, defining a rectilinear grid of these mounting interfaces. Each battery module can then be positioned onto this grid; the array of battery modules is then known to be accurately positioned and other related components, such as the flexible PCB power bus, also conforming in size to the standard size architecture can then be neatly and accurately positioned on the battery modules.

The standard size architecture is an example of the physical modularity that is a consistent theme in the Arrival System: Using the standard size architecture across not just the battery modules but more generally across many other components; this family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; it can also include non-electronic components, such chassis beams, side panels, and even the overall vehicle dimensions.

This approach leads to simplicity, fast and efficient design (such as automated design using the Vehicle Builder system described in Section D and more reliable robotic handling, as described above. It leads also to a consistent appearance for these components, which makes for easier and faster designing of the layout of those components, more efficient use of space, as well as a more aesthetic vehicle or other installation; the aesthetic value or design language of internal components in a vehicle, such as the HVBM or MBMS, is not to be underestimated: where the individual internal components are themselves things of beauty, then the overall engineering quality of the total system will be higher; customers also appreciate quality and aesthetic design that is more than superficial and extends to even normally concealed components that are normally seen only at design and build time by engineers. The standard size architecture can also lead to better product quality for functional reasons: for example, computer vision systems can readily and rapidly determine whether a component complies exactly with the standard size architecture requirements and that can be part of the quality control that is applied when producing a vehicle or installing new components in a vehicle; poor quality counterfeit products that do not conform to these exacting requirements can be automatically detected.

We can generalise as follows:

A battery module configured to operate as part of a vehicle battery pack that includes multiple, identical such battery modules, in which each battery module has a size that conforms to a regular size interval scale and is part of a family of other types of components with sizing that also conforms to the same size interval scale.

Feature 4: Modular Components Installed Using the Same Regular, Rectilinear Grid or Installation Pattern

As noted above, the standard size architecture is applied not just to the battery modules, but more generally throughout the vehicle, across many different components. This makes robotic handling and installation more reliable since you are limiting, for example, the possible physical layout variables, which makes an automated vehicle design system like Vehicle Builder, feasible. Further, it limits the possible locations of the multiple mounting points which have to be targeted for correct installation of a component, which again makes the automated vehicle design system Vehicle Builder, feasible, as well as robotic assembly. Also, when tracing the movement of components through the air, robots need to know the dimensions and full path through the air and to the final destination that those components will take, so that collisions can be avoided; by standardising component size, it makes computing these paths to avoid collisions much faster and more reliable. Arrival battery modules can be square e.g. 350 mm square) in plan view; a grid of substantially adjacent battery modules can readily be assembled and fixed into position. Because Arrival battery modules can be square, they can be assembled into rectangular arrays in the batter pack—e.g. 4 modules wide, and 4 long for a car, or 4 modules wide and 6 long for a van.

Other types of components include one or more of the following: battery modules; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform

We can generalise as follows:

A battery module configured for robotic installation or assembly into a device or system by virtue of being configured to be positioned in a regular, rectilinear grid or installation pattern.

Feature 5. Battery Module Configured for Robotic Assembly

We have touched above on how the standardised shape and size of components helps both automated design using Vehicle Builder and also robotic assembly. The Arrival battery module exemplifies this, with its 350×350×100 mm dimensions. The battery module also has other physical features which facilitate robotic handling. For example, it is packaged with a lid that a large flat top: this enable reliable handling by a robotic suction cup end effector. It may also have chamfered edges for auto-alignment when being installed by a robot; edges are rounded—there and no sharp edges that could otherwise jam on installation.

We can generalise as follows:

A battery module configured to operate as part of a vehicle battery pack that includes multiple, identical such battery modules, in which each battery module is configured for robotic installation or assembly to the battery pack by virtue of having a shape that is optimised for robotic installation or assembly.

Feature 6. Battery Module that Sits on a Rigid Base Plate that in Turn Sits on a Liquid Cooled Plate

Battery modules typically have complex liquid cooling structures running past the upright, cylindrical faces of the rechargeable batteries (where cylindrical form factor batteries are used). This is inherently complex to scale since the liquid cooling structure has to be significantly re-designed for different arrangements of battery modules: it is an inherently complex and bespoke piece of engineering. Cooling the upright cylindrical surfaces is also inefficient because heat transfer radially out of an individual rechargeable battery is 25× less than the axial heat transfer.

The Arrival battery module takes advantage of this because the supporting base of the battery module (which is 6 mm thick) not only provide structural rigidity but also cooling functionality. For example, the supporting base may be positioned in thermal contact with an external rigid base plate that provides support for the entire battery pack, and a liquid cooled plate or system is then positioned under or integrated inside the external rigid base plate. High thermal conductivity gels may be used on all interface surfaces to enhance heat transfer. By providing a liquid cooling system that is wholly external to the battery module, but typically forms the integral base of the battery module, the construction of the battery module and the battery pack is simplified and robotic assembly (e.g. Robofactoring in a Microfactory) becomes feasible. This cooling approach is inherently scalable; no additional hard plumbing is needed as the number of battery modules increases. Also, repairs and upgrades to the liquid cooling system are far easier since it is not inside the battery module or the battery pack, but instead forms the external base of the battery module. And the integrated metal cooling plate also reduces the risk of penetration.

All cells have their negative end contacting the supporting base of the battery module and a negative electrode leads from the rim or edge at the opposite end of the cell. This ensures maximum and consistent thermal contact between all cells and the base of the battery module. The supporting base is hard anodised on both major surfaces to provide electrical insulation. Each battery module uses 4 mechanical mounting points in each of its corners, for minimum M6 bolts, with an 8 mm thru-hole.

We can generalise as follows:

A vehicle battery module including multiple cylindrical form-factor rechargeable cells, in which the battery module includes a base on which the rechargeable cells are positioned, in which the base provides a structurally rigid support for the cells and also provides thermal cooling for the cells.

Feature 7. Battery Module in which all Rechargeable Cells have the Same Polarity Orientation

We noted above that all cells in an Arrival battery module have their negative end contacting the supporting base plate and a negative electrode leading from the rim or edge at the opposite end of the cell; all cells in a battery module share the same polarity orientation. In a conventional battery module, adjacent cells generally have the opposite polarity orientation. But keeping the same polarity orientation facilitates fast and reliable construction of the battery module; this is especially important for robotic assembly (e.g. Robofactoring in a Microfactory), since all battery cells are inserted in the same orientation; a robotic end effector can simply take a rack of 102 cells, all oriented in the same direction, and place them into a chassis or holder designed to retain all cells and them position the entire chassis, with a complete set of cells, on to the base of the module.

We can generalise as follows:

A vehicle battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation.

Feature 8. Battery Module that has its Own Cover, and Connects to Other Similar Modules to Form a Battery Pack.

Because the Arrival battery module is designed to be readily configured in different arrangements (e.g. a set of five battery modules could form the complete battery back for a vehicle; or a set of twenty five could be needed for the same vehicle) it is very useful if each individual battery module can be safely stored, handled, and installed into a vehicle, whether by man or machine. Safe handling of each battery module is also particularly important because each battery module includes safety-critical electronic components, including multiple microcontrollers, residing on one or more circuit boards sitting over the rechargeable cells in each battery module. Neither of these constraints apply to conventional battery modules.

In order to protect these safety-critical electronic components, and to facilitate safe storage, handling, and installation of individual battery modules, each individual battery module is packaged in an outer shell or lid that is configured to enclose the array of rechargeable cells and the safety-critical electronic components inside each battery module. The lid is made using a four gate valve system injection moulding system.

We can generalise as follows:

A vehicle battery module that generates at least 300V output at maximum charge, and (i) includes a single outer shell or lid that is configured to enclose an array of rechargeable cells and seal against a rigid base of the module, and (ii) is configured to be electrically connected to further, substantially similar, battery modules, to form a complete battery pack.

Feature 9. Battery Module that Slides into Chassis Void

Because each battery module is packaged with a flat topped, rigid lid, and a flat rigid base, it is possible to readily insert battery modules, either individually or when part of a battery pack, into a void sitting over a substantially flat chassis base of the vehicle.

We can generalise as follows:

A vehicle battery module, configured to operate as part of a battery pack that includes multiple, identical such battery modules, in which one or more battery modules are configured to be inserted, either individually or when part of a battery pack, into a void sitting over a substantially flat chassis base of the vehicle.

Group C: Battery Module Internal Component Features

Feature 10. Battery Module with Internal Isolation Switch

Safety is designed into each battery module through a number of features. Each battery module is an integrated battery module safely delivering e.g. high voltage (nominally 450 VDC) for electric vehicles (EV), domestic energy storage and renewable generation. Switches integrated into the battery module decouple cell string(s) from module terminals, rendering the module safe for handling and transportation and removing the need for external contactors. Isolation of individual modules allows for safe switch out and hot-swap of modules within an array. Example switching devices include but are not limited to transistor, FET, MOSFET, IGBT, relay or contactor. The switching devices offer galvanic isolation and rapid switching capability. Control of internal switching device(s) may be by any or a combination of the following mechanisms:

1. Data signal from ‘intelligent’ load (e.g. EV on-board-controller): module only delivers voltage output after successful two-way data handshake.
2. Voltage from connector interlock loop (akin to HVIL), holding closed the internal switch whilst module is connected.
3. Bridging loop within module terminal connector, using internal signal voltage to detect connector mating; disabling module output upon decoupling.

Isolation of the battery module, except for after a successful data handshake, allows for control of module use, protecting against abuse and disabling module in the event of removal from intended installation/vehicle:
Preventing module use as power source in unauthorised applications/installations
Protecting against module charging from unknown sources
Enabling battery remote disablement; e.g. theft immobiliser or product safety recall
Enforcing subscription/rental/leasing of battery module
Enabling timed ‘shelf life’ expiration or cycle based ‘end of life’ control

We can generalise as follows:

A vehicle battery module configured to operate as part of a battery pack that includes multiple, identical such battery modules, in which each battery module (i) includes rechargeable cells configured to generate, at a pair of output terminals, at least 300V nominal and (ii) includes an internal isolation switch system, configured to isolate all cells from one or both of the output terminals.

Feature 11. Battery Module with a Bypass Series Switch

In the Arrival battery module, cells are connected in series, each with a ‘double throw’ switch, controlled by a switchable signal. When the signal is high, the switch closes the circuit through the cell, connecting the cell in series. When the signal is low, the switch opens on the cell closing the bypass loop and isolating the cell. By varying the duty of each cell (the ratio of time each cell is in use compared to the time the cell is in bypass), this technique can be used to balance the charge between cells. For example, cells with a higher state of charge (SOC) can be used for a greater portion of time than cells with lower SOC; bringing all cells closer to equilibrium. This same technique can be used to take care of cells with lower state of health (SOH) or which have a higher temperature.

We can generalise as follows:

A vehicle battery module configured to operate as part of a battery pack that includes multiple, identical such battery modules, in which each battery module (i) includes rechargeable cells configured to generate, at a pair of output terminals, at least 300V nominal and where at least some of the cells are connectable in series to form a string of cells, and the module includes a switch that is configured to either connect two or more cells in series or to bypass those cells.

Feature 12. Battery Module with Layered Component Architecture

We have seen above that each Arrival battery module is able to manage its internal operation independently of any control system external to the module. That requires various control components inside each module. In the Arrival battery module, we adopt a layer construction in which, sitting over the battery cells, are one or more separate full width layers with these components or systems. For example, there may be a single PCB layer providing (i) power handling; (ii) cell balancing within each module; (iii) performance monitoring (voltage (including contactor weld detection), current and temp). By placing these components onto a layer, it becomes much easier to service or replace the battery module; the lid is removed and that exposes the main PCB layer; individual components can then be readily tested, or replaced. Equally, the entire PCB layer can be removed for testing or replacement with a new or upgraded PCB layer.

FIG. 72 shows the HVBM, indicated generally at 700, in an exploded view, exposing the layer structure: moving from the top down, there is a lid 701, a pcb 702, a dielectric separator 703, a balancing flex 704, an upper cell carrier 705, the Li-Ion cells 706, a lower cell carrier 707, and a base plate 708.

The layered component construction is also faster and easier to robotically assemble since all components can be vertically raised or lowered into the battery module as it is being constructed.

We can generalise as follows:

A vehicle battery module with a layer construction in which, sitting over battery cells, are one or more separate layers with components or systems that enable the battery module to manage its internal operation, each layer each occupying substantially the entire width or cross-section area of the battery module.

Group D: Battery Module and the Complete Power System, Including BMS and the Battery Pack

Feature 13. Battery Module with Flex™ PCB Power Cable

Because each HVBM outputs at least 300V nominal, it is possible to connect all HVBMs together, and also all HVBMs directly to the main DC power bus, using a light weight, low profile, printed circuit board (PCB) type electrical connector. Because each HVBM outputs at least 300V, the current supplied by each HVBM is much lower than the current that would be supplied by a conventional battery module, generating say 50V or 70V. Consequently, the parallel electrical connections between HVBMs carry much lower current than would flow between conventional, series connected modules generating say 50V or 70V. This opens up the possibility of using light weight, low profile, printed circuit board (PCB) type electrical connector; these would be unsuitable for the levels of current delivered by conventional modules; instead, conventional modules are typically connected using bulky and heavy cable harnesses.

PCB connectors offer significant advantages over conventional cable harnesses in terms of packaging, weight and design freedom: We refer to the PCB power connector used in the Arrival system as the Flex™ connector. Flex connectors can be used not just to connect HVBMs together and for the DC power bus, but can also be used inside a HVBM to connect cells to each other. critically, because Flex PCB connectors have a large flat surface, they can be readily gripped by robotic grippers and, because they are flexible, they can be positioned and fixed in place robotically. FIG. 73 is a top-down view of the end of a Flex connector that connected to an HVBM. The Flex connector, indicated generally at 710, includes a pair of printed high voltage conductors 711, a data connection path 712, and a low profile, standardised electrical interface 713 to the HVBM. FIG. 74 shows this PCB connector mounted on an HVBM 700; four additional PCB connectors, from parallel connected HVBMs, are shown laid on top of HVBM 700. The five Flex connectors terminate in connections 714 to the HV bus at one end, and at their other end at an HVBM at standardised interface 713.

FIG. 75 is a top down view of this entire group of five parallel connected HVBMs, showing how each of the five separate Flex PCB conductors 710 are connected to a single HVBM 700, and the entire high voltage connection is laid over the top of the five HVBMs 700. The shape of each Flex connector 710 can be seen to be the same, the only difference being in their length; this simplifies Flex production, logistics and handling. FIG. 76 is a perspective view of this arrangement, showing how low profile the PCB conductors are.

We can generalise as follows:

A vehicle battery module configured to operate as part of a battery pack that includes multiple, identical such battery modules, and which delivers power over a substantially low profile, printed circuit board (PCB) flexible electrical conductor.

Feature 14. Battery Module that Delivers HV Direct to the HV Bus

We have seen above how each individual battery module can output high voltage at the voltage magnitude used in a system powered by the module, e.g. each outputs current at between 350V and 450V for a 400V typical automotive traction system. Consequently, each battery module can be connected directly to the 400V DC power bus. Power distribution to the DC bus can be over the Flex connected described earlier.

We can generalise as follows:

A vehicle battery module configured to deliver HV output directly into the HV power bus of a vehicle.

Feature 15. Battery Module that Connects to Integrated Power Cables

We have described the Flex connector being formed on a flexible substrate; this is possible using continuous reel to reel manufacture and enables the Flex connector to be laid over battery modules and folded around corners etc. It is also possible to add the electrical conduction paths (for HV power, data, as well as low voltage) not to a conventional PCB substrate but instead directly to a component or other structure that has a purpose in addition to conducting power, such as a structural component or panel. Hence, for example, a bus might include an array of these panels running along the entire length of both the outside and internal sides, just below the roof. Power and data for these LCD panels could be delivered using separate Flex connectors running along and up the side body panels. But alternatively, the body panels themselves could include integrated power and data tracks, for example printed directly on to the interior surface of the body panels.

We can generalise as follows:

A vehicle battery module configured to electrically engage with a conductor that is integrated into a vehicle component or other vehicle structure that has a purpose in addition to conducting power, such as a structural component or panel.

Feature 16. Battery Pack Including Battery Modules and BMS

The Arrival battery pack includes a battery management system that is distributed across each individual battery module and is also in a master BMS that is external to all battery modules. Each individual battery module is able to galvanically isolate itself, and the master BMS is also able to independently galvanically isolate any battery module. This approach increases the safety of the overall battery pack.

We can generalise as follows:

A vehicle battery pack comprising multiple battery modules, where the battery pack is configured to be assembled from multiple parallel connected battery modules; and a battery management system is distributed across each individual battery module and is also in a master BMS that is external to all battery modules, so that each individual battery module is able to galvanically isolate itself, and the master BMS is also able to independently galvanically isolate any battery module.

Group E: Battery Module Operational Features

Feature 17. Battery Module Implementing Plug and Play Software Components

The modular software components described in Section B above are deployed to the vehicle ECUs. But in addition, the same software modularity approach can be used in other vehicle hardware devices, including in a battery module.

We can generalise as follows:

A vehicle battery module, configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer.

Feature 18. Battery Module with Decentralised Autonomy, Operating in a Distributed Architecture

The general principle of decentralised autonomy, described earlier, also in relation to vehicle ECUs, applies also to other vehicle hardware devices, including in a battery module.

We can generalise as follows:

A vehicle battery module, configured to operate as part of a battery pack that includes multiple, identical such battery modules, in which each battery module is provisioned with modular software components that monitor and control battery systems to enable the battery module to operate autonomously and individual modular software components exchange data with modular software components on other battery modules to provide a distributed architecture.

Feature 19 Battery Module with Performance Reporting

Decentralised autonomy for a hardware device (like an HVBM) can be based on an internal performance monitoring and management sub-system in the device that autonomously manages the device and reports data to an external monitoring system. We can apply that approach to the battery module as follows:

We can generalise as follows:

A battery module configured to operate as part of a battery pack that includes multiple, identical such battery modules, in which each battery module is part of a data-network that establishes a network of modules, and each battery module includes an internal performance monitoring and management sub-system that autonomously manages the battery module and reports data to an external BMS.

Feature 20. Battery Module that Autonomously Negotiates with Other Battery Modules

Decentralised autonomy also applies to how battery modules negotiate with other modules to determine power or performance compatibility.

We can generalise as follows:

A battery module configured to operate as part of a battery pack that includes multiple, identical such battery modules, in which each battery module is part of a data-connected network of modules, and each module is configured to autonomously negotiate with other modules to determine power or performance compatibility.

Feature 21. Battery Module with Crypto-Network

Following Plug and Play principles (see Section B) of the Arrival system and components, once an Arrival component is plugged into an Arrival vehicle, device or system, it will start functioning easily and automatically without configuration or modification of the existing system. As mentioned above, this is fully applicable to an Arrival battery module and its functioning once it is plugged into an Arrival vehicle. Cyber security requirements might conflict with providing Plug and Play functionality for vehicle components. The Arrival system envisages a unique approach to cyber security of Arrival vehicles and vehicle components (see Section C).

The conventional approach is based on a vehicle network being treated as a trusted environment, whilst everything outside the vehicle is treated as untrusted. The Arrival system, instead, treats the vehicle network as untrusted one. Thereby, all communications between components using the vehicle network are encrypted, and components do not accept commands from other components without verification or authentication. As a result, vehicles and vehicle components are prevented from an unauthorized use, and personal data as well as valuable analytics or diagnostics data of the vehicle are prevented from an unauthorized access.

We can generalise to:

A battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in.

And we can generalise further to:

A vehicle component configured to operate on a vehicle data network, and where the component treats the vehicle data network as an untrusted one and all communications from and to the component using the vehicle network are encrypted, and the component does not accept commands from other components without verification or authentication.

Feature 22. Battery Module that Self-Initialises

Another facet of decentralised autonomy is that components, like battery modules, must form part of the vehicle data network so that they can send and receive data across that network. Instead of passively configuring or initialising when instructed to do so by an external device, each battery module instead autonomously self-initialises to operate on the network.

We can generalise as follows:

A vehicle battery module configured to operate as part of a battery pack that includes multiple, identical such battery modules, in which each battery module is part of a data-connected network of vehicle battery modules, and in which each battery module configures itself or otherwise self-initialises to operate with the network when it is added to the network or is turned on.

Feature 23: Battery Module with Ambient Pressure Equalisation Vent

Each battery module includes at least one air pressure vent that ensures that the air pressure inside the battery module can rapidly equalise to ambient air pressure; hence changes in ambient air pressure that arise in normal use, for example associated with changes in ambient air temperature, or environmental factors, such as changes in altitude or entering or exiting a tunnel, do not lead to damage to the battery module, such as damage to environmental seals that may occur if the pressure differential between air pressure internal to the module and ambient exceeds a threshold.

The air vent is made from an air permeable, oleophobic membrane that also keeps water, dust and dirt out of the battery module and preserves the IP 65 ingress protection rating of the sealed battery module and hence protects the sensitive electronics inside the battery module; Gove Vent PolyVent AS 200 is suitable. The air pressure equalisation vent can be positioned in a side wall of the battery module, typically below one of the main PCBs and above, and in between the cell contactors. A second air pressure equalisation vent can be positioned in the battery module lid.

We can generalise as follows:

A battery module with ingress protection of at least IP 65, in which the battery module includes an air pressure equalisation vent configured to enable air pressure equalisation inside the module to ambient or external air pressure whilst maintaining ingress protection.

A vehicle including a battery module with ingress protection of at least IP 65, in which the module includes an air pressure equalisation vent configured to enable air pressure equalisation inside the module to ambient or external air pressure.

Feature 24: Battery Module with Gas Escape Vents

In a serious failure of one or more cells in a battery module, gases can be released and can rapidly build to dangerous pressures; even where the battery module includes an ambient air pressure equalisation valve, gases can build to pressures that can ultimately cause the entire module to fail in an uncontrolled manner. To avoid this, each battery module lid includes multiple small holes through which high pressure gases caused e.g. by cell failure can rapidly vent. A label covers all of these holes to preserve the IP 65 ingress protection rating of the sealed battery module in normal use and operation of the battery module. The label is releasably secured to the lid, for example stuck to the lid with adhesive around its perimeter, so that the portion of the label lying directly over the gas escape vents has no adhesive. In the event of a failure leading to the build up of pressurised gases inside the module, the adhesive label balloons outward over the gas escape vents, and this causes the adhesive to rapidly de-bond; the label no longer covers the gas escape vents and hence gases can rapidly escape from the gas escape vents.

The battery module includes an internal gas sensor. Thus, in the event of gas being released, this gas is detected. This provides an opportunity for the failure to be mitigated, with the HVBM being automatically switched off, and a warning being automatically transmitted. battery module

We can generalise as follows:

A battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

A vehicle including a battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

Feature 25: Battery Module with Internal Monitoring or Control Systems

In some of the preceding sections, the battery module has been a high voltage module (e.g. delivering 300V+). For example, Feature 1 describes various features that make this form of high voltage module especially useful. Many of these features can be usefully used in battery modules that are not high voltage modules as such, but more conventional modules outputting a voltage that is significantly less than 100V and hence have to be series connected with other similar modules to reach the typical 300V-400V operational voltage required for traction power in an electric vehicle. In this Feature 25, we define those features that can be usefully deployed in a battery module that can form part of a decentralised battery pack architecture, i.e. an architecture in which there is an element (ranging from partial to complete) of monitoring and/or control distributed down to the battery module level.

We can generalise as follows:

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes an internal precharge capability.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a current sensor.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a current sensor and over current protection system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a gas sensor.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a contactor health monitoring system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a connector cap integrity monitoring system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes an isolation monitoring system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a HVIL system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a low voltage power monitoring system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes an internal short circuit protection fuse.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes redundant networking capability.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured to be connected directly or indirectly to a cloud-based system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured for OTA software updates.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured for continuous or 24/7 cell monitoring.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured to automatically detect when a cell or cells disconnect from an internal circuit.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured with a MCU-based cell monitoring and cell balancing system.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured to estimate the degradation level of individual cells.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured to enable prediction of short-term and long-term battery performance prediction.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module is configured with operational modes that differentially balance cell degradation and battery module performance.

A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture; and in which the battery module includes a wireless connectivity system.

Section H: The Arrival Composites System

Introduction to this Section H

Conventional metal body vehicles are produced from stamped steel or aluminium. Stamping requires huge matched-steel tools (moulds used to press sheet metal into shape); often several pairs are required for a single part in a process known as progressive stamping. This is why it costs tens of millions to set up production—and takes many months to tune the line. To pay back the investment, metal stamping lines are dedicated to a single product for many years.

Once complete, the stamped metal body is welded together to form the familiar body in white (BIW). The welding jigs and robots are dedicated to a single product; further increasing time and investment. Next, metal has to be protected from the atmosphere. This requires a large paint setup, starting with an e-coating line, which may be the most significant investment in the paint shop due to the size of the tanks required to fully submerge the BIW. Subsequent paint layers are built up on top to produce the finished vehicle.

Overcoming these limitations means that Arrival can change its designs rapidly and scale its Microfactories (see Section F) to meet local demand. In place of metal bodywork, Arrival vehicles use thermoplastic composite material. A combination of high-strength reinforcement and polymer matrix, it can be shaped and reshaped many times.

Using an in-house-developed moulding process we call ‘Arrival Multiform™’, we produce finished parts straight from the tool—including high-gloss, textured and textile-covered—so there is no need for a paint shop or costly finishing and laminating processes. And the colour is throughout the part, which means that minor scratches and damage are not visible; greatly reducing the cost of repairs and replacement.

The demands on weight and cost mean that every material Arrival puts into the vehicle has to perform several functions. It must be lightweight, to increase payload and reduce demand on energy source; durable to provide long term endurance and minimise the cost and impacts of replacement parts; beautiful; scalable, so the designers and engineers are inspired to play, prototype with, and seamlessly transfer ideas to full-production; and low-cost, because it must be competitive to succeed.

The Arrival Multiform process uses material that is easy to form—this makes automation easier and enables a low pressure process that reduces the equipment and tooling costs. Our proprietary composite material is brought together as layers; each one providing the necessary performance required, such as strength, resistance to ultraviolet light and scratch durability. This approach allows us to build optimised structures tailored to the application, putting strength and endurance where they are needed most. At the end of its useful life, recycling converts all these properties into a single, versatile material.

All of these materials are available for the designers to utilise during prototyping. Our Arrival Multiform process allows for parts to be converted from CAD to physical sample in less than two weeks, which allows us to rapidly design and develop concepts to production readiness. This is in stark contrast to the typical three to six month lead time for developing metallic parts for the same applications. We aim to reduce this further still, to less than a week, by using 3D printing technology to produce recyclable moulds.

In addition to thermoplastic composite, we use lightweight aluminium alloy in the chassis and structural parts, load-bearing sandwich panels to span large flat areas such as floors, and glazing to maximise natural light and visibility.

Our material developments support a fundamentally new approach to production: building things autonomously at low and high volumes, with robots. We do not require heavy presses, such as used for metal stamping. Instead, we use grippers, vacuum, lasers and other robot-mounted hardware. Things must be easy to handle and fabricate, without the need for human intervention. This allows us to be flexible in our approach to production, deploying factories close to where the products will be used, and in only a matter of months.

A conventional warehouse can be used to produce Arrival's composite panels and parts—all that is needed are power and services; there is no need for any huge metal stamping presses that are normally used, nor the reinforced, deep concrete floors needed to support those presses; no need for specialist paint shops, nor the complex environmental treatment plants and waste permits normally used. Instead, a conventional warehouse, with ordinary flat concrete floors can be used, for significantly lower CapEx. Arrival can turn a conventional warehouse into a composite panel microfactory in a matter of just a few months. The microfactory is made up of a number of discrete technology cells, each performing a largely automated, and in many cases robotically implemented process, such as handling rolls of composite fabric; cutting the fabric into a required shape for a specific panel or other part; forming a kit or number of layers of cut fabric for a specific panel or other part; moulding the kit of layers of cut fabric into the panel or part; trimming the moulded panel part; assembling moulded panel parts together.

Autonomous mobile robots (AMRs) transfer materials between these technology cells: there is no conventional, fixed, high CapEx production line that needs to be planned and constructed and that rigidly constrains the layout of processes within the factory; instead, the various technology cells can be positioned flexibly, and re-positioned, or replaced with different sorts of technology cells, as demand alters and grows, or as new production processes are devised. Many of the technology cells are designed so that they can be lifted and re-positioned within the microfactory using a conventional fork-lift truck; this enables rapid re-configuration of the layout of technology cells within the factory, to optimise and to scale up and down e.g. capacity, processing throughput, processing capacity, to accommodate even fundamental changes in the processing steps.

The Arrival microfactory is essentially a flexible, re-configurable, just-in-time production process in which all production systems (e.g. technology cells) are fully integrated with the other parts of the automated, software controlled vehicle production system. For example, the Arrival vehicle production system might determine that for vehicles being assembled that week, additional van roof panels need to be produced to keep sufficient numbers in the factory store or for direct supply into the assembly process. The automated system then selects the appropriate rolls of textile fabric for these roof panels so that the finished roof panels can be finished in time. The entire process flow withing the microfactory is software controlled and can be re-configured according to need rapidly, and in some cases in real time. For example, the entire microfactory could re-configure in real-time from processing fabric rolls and outputting say only lightweight rectangular, flat, translucent van roof panels to switching say half the factory capacity to processing entirely different fabric rolls and outputting soft-touch car dashboards with very complex shapes.

In the pursuit of radical performance at low cost, we have moved progressively up the supply chain. Not only do we produce the vehicle; but in the case of our composites we produce the panels, the fabrics and the fibres. This creates the opportunity to make improvements at every step, and take advantage of trade-offs that would otherwise not be possible. For example, by adjusting the chemistry of the composite, we can improve the efficiency of our moulding cycle, and reduce cycle time and factory cost.

This Section H describes a number of features implemented in the Arrival composites production system. We organise these features into the following five groups:

Group A: Production of the composite parts or panels
Group B: Properties of composite parts and panels
Group C Smart composite parts or panels
Group D Factory integration; Vehicle Assembly using Composite Parts or Panels
Group E Automotive vehicles with composite parts or panels

Within each group are a number of Key Features:

Group A: Production of the Composite Parts or Panels

Feature 1: Fibre and Yarn Brought Together Only at Weaving

A system for the production of automotive composite parts or panels, the system including a moulding cell with a tool to mould a fabric structure, made of fibre and a thermoplastic matrix, into a composite part or panel, in which separate fibre and matrix yarns are brought together only immediately prior to, or as an integral part of, combining the fibre and matrix yarns together to form the fabric structure, using a weaving or a non-weaving process.

Feature 2: Fibre and Yarn Relative Proportions are Fixed Only at Weaving

A system for the production of automotive composite parts or panels, the system including a moulding cell with a tool to mould a fabric structure, made of fibre and a thermoplastic matrix, into a composite part or panel, in which separate fibre and matrix yarns are brought together in relative proportions chosen to give required material properties only at the point of weaving or otherwise combining the fibre and matrix yarns together to form a fabric.

Feature 3: Fabric Structure with Co-Moulded Core

A system for the production of automotive composite parts or panels, the system including a moulding cell with a tool to mould a fabric structure, made of fibre and a thermoplastic matrix, into a composite part or panel, in which the fabric structure is automatically provided with a core by an automatic or robotic system, and is co-moulded in the moulding cell with that core, and that core has been automatically selected to impart required properties to the part or panel.

Feature 4: AMR Supplies Fabric Structures to the Moulding Cell

A system for the production of automotive composite parts or panels, the system including a moulding cell with a tool to mould a fabric structure, made of fibre and a thermoplastic matrix, to form a composite part or panel, in which an autonomous mobile robot (i) supplies the fabric structure to the moulding cell and an autonomous mobile robot then (ii) moves the composite part or panel formed by the cell away from the cell, for example to a trimming cell to trim and shape the composite part or panel to a final shape.

Feature 5: Multi-Use Flexible Membrane for Arrival MultiForm

A system for the production of automotive composite parts or panels, the system including a moulding cell with a tool to mould a fabric structure, made of fibre and a thermoplastic matrix, into a composite part or panel, in which the cell includes a flexible membrane that is configured to press the fabric structure against the tool surface to enable an automotive composite part or panel to be formed;
and the flexible membrane is a multi-use membrane configured to produce multiple different parts or panels.

Feature 6: Automated Sliders for Tooling

A system for the production of automotive composite parts or panels, the system including a moulding cell with a tool to mould a fabric structure, made of fibre and a thermoplastic matrix, into a composite part or panel, in which the tool includes one or more automated sliders configured to enable tooled features, such as undercuts, to be created automatically.

Feature 7: Direct Heating of Vacuum Forming Tool with Modular Replaceable Skin

A system for the production of automotive composite parts or panels, the system including a moulding cell with a tool to mould and heat a fabric structure, made of fibre and a thermoplastic matrix, into an automotive composite part or panel, in which the tool is a modular tool that includes a tooling skin that is a modular replaceable tooling skin that is configured to be swapped in and out of the tool, and is configured to sit on or otherwise attach to a substrate which remains in or part of the tool when the skin is replaced.

Feature 8: Pitch Fibre Mould Skin

A system for the production of automotive composite parts or panels, the system including a moulding cell with a tool to mould and heat a fabric structure, made of fibre and a thermoplastic matrix, to form a composite part or panel, in which the tool includes a support, and a mould or mould skin that rests on the support and which shapes the fabric structure;
in which the mould or mould skin is made of thermally conductive carbon fibre combined with matrix resin.

Feature 9: Underside of Mould is Vented to the Atmosphere

A system for the production of automotive composite parts or panels, the system including a mould that heats a fabric structure, made of fibre and a thermoplastic matrix, into an automotive composite part or panel, in which the fabric structure sits in or against a mould, and the mould is retained by a mould support;
and the mould support is configured to be vented to the atmosphere when a vacuum is applied to press a membrane against the fabric structure.

Feature 10: Pressure Applied by a Heated Silicone Tool

A system for the production of automotive composite parts or panels, the system including a moulding cell to mould and heat a fabric structure, made of fibre and a thermoplastic matrix, into a composite part or panel, in which the cell includes a flexible silicone tool that is configured to expand when heated to press the fabric structure against a mould and to melt the thermoplastic matrix, in order to form the composite part or panel.

Feature 11: Robotic Arrangement of the Fabric in the Mould

A system for the production of automotive composite parts or panels, the system including a cell with a tool to mould a fabric structure, made of fibre and a thermoplastic matrix, into a composite part or panel, in which the fabric structure is arranged in the mould by a robotic system that includes one or more end-effectors configured to form the fabric structure into the correct shape or position in the mould.

Group B: Properties of Composite Parts and Panels

Feature 12: Fabric Structure that is Moulded into a Soft-Touch Panel

A method of producing automotive composite parts or panels, the method using a moulding cell with a tool to mould a fabric structure, made of fibre and a thermoplastic matrix, to form a composite part or panel, in which at least some of the fabric structure includes a compressible or elastomer region so that the part or panel is a soft-touch part or panel.

Feature 13: Fabric Structure that is Moulded into a Textile-Surfaced Panel

A method of producing automotive composite parts or panels, the method using a moulding cell with a tool to mould a fabric structure, made of fibre and a thermoplastic matrix, to form a composite part or panel, in which the top-most region of the fabric structure has a textile-like surface, so that the part or panel has a textile-like surface.

Feature 14: Fabric Structure that is Moulded into a Panel with a Grain or Patterned Surface

A method of producing automotive composite parts or panels, the method using a moulding cell with a tool to mould a fabric structure, made of fibre and a thermoplastic matrix, to form a composite part or panel, in which the surface of the tool includes a pattern or grain that is imparted or transferred to the top layer of the composite part or panel.

Feature 15: Fabric Structure that is Moulded into a Panel with a Scratch-Concealing Structure

A method of producing automotive composite parts or panels from a fabric structure, made of fibre and a thermoplastic matrix, and in which a finish layer or a top layer to that structure has a specific colour;
and in addition one or more underlying portions of the fabric structure has a colour that is the same as, or is sufficiently similar to, the specific colour of the finish layer or the top layer, so that scratches that penetrates the finish layer or the top layer, or other damage that affects the finish layer or the top layer, are concealed or not readily noticeable.

Feature 16: Fabric Structure that is Co-Moulded with Polymer Objects

A method of producing automotive composite parts or panels, in which a moulding cell moulds a fabric structure, made of fibre and a thermoplastic matrix, into an automotive composite part or panel, and in which one or more plastic or other polymer objects are added to one or more layers and are co-moulded into the composite part or panel.

Feature 17: Fabric Structure that is Co-Moulded with Integral Locator Feature

A method of producing automotive composite parts or panels, in which a moulding cell moulds layers of a fabric structure, made of fibre and a thermoplastic matrix, to form the composite part or panel; in which the part or panel is moulded with an integral locator feature that is configured to define a precise location on the part or panel.

Group C Smart Composite Parts or Panels

Feature 18: Composite Panel with Integrated Electronics

An automotive composite part or panel that includes one or more electronic components formed directly in or on the composite part or panel during the production process of the part or panel.

Feature 19: Composite Panel with Co-Moulded Electronic Components

A system for producing automotive composite parts or panels, the system including a mould that moulds a fabric structure, made of fibre and a thermoplastic matrix, to form an automotive composite part or panel, in which one or more electronic components are added to the fabric structure and are co-moulded into the composite part or pane during the moulding process.

Feature 20: Composite Panels with Integral Identification Tags

Vehicle with composite parts or panels that include, integrated within the body of at least one part or of at least one panel, an identification tag, such as a RFID tag, formed into the part or panel during a moulding process that moulds a fabric structure, made of fibre and a thermoplastic matrix, to form the automotive composite part or panel, and in which one or more identification tags are added to the fabric structure to enable identification and tracking of the part or panel in warehousing and in production operations.

Feature 21: Composite Panels with Electrically Conductive Tracks

An automotive composite part or panel formed from a fabric structure, made of fibre and a thermoplastic matrix, in which one or more electrically conductive lines, tracks or other structures, are formed directly in or on the fabric structure and have defined borders that are inside, or within the edges the fabric structure.

Feature 22: Composite Panels with Networked Sensors

Vehicle with composite parts or panels that include a distributed array of sensors whose output is collectively analysed to provide environmental information, with no individual sensor providing data of sufficient trustworthiness to be solely acted on, but which, when combined, is sufficiently reliable to be acted on.

Feature 23: Composite Panels where Outputs from Multiple Low Accuracy Sensors are Combined

A composite part or panel including a distributed array of sensors, each sensor being configured to contribute phase and magnitude information of limited accuracy, wherein the phase and magnitude information from individual sensors can be combined so that the composite part or panel serves as a sensor having an enhanced level of accuracy.

Group D Factory Integration; Vehicle Assembly Using Composite Parts or Panels

Feature 24: Composite Panel with Integral Fixing Features

An automotive composite part or panel that is produced using a moulding cell that moulds a fabric structure, made of fibre and a thermoplastic matrix, to form the composite part or panel;
in which the part or panel is moulded with an integral fixing feature that is configured to enable the part or panel to be attached or fixed to another part or panel or other structure by a robotic device.

Feature 25: Composite Panel with Auto-Aligning Features

A method of producing automotive composite parts or panels, the method using a moulding cell with a tool to mould a fabric structure, made of fibre and a thermoplastic matrix, to form a composite part or panel, in which the composite part or panel is shaped to include features that, when assembled with another structure, correctly aligns the part or panel, e.g. in the X, Y and/or Z directions, in relation to the other structure.

Feature 26: Automated System for the Production of Automotive Composite Parts or Panels from Fibre and a Matrix

An automated system for producing automotive composite parts or panels, the system including the following sub-systems:
a loom to weave or otherwise combine fibre and matrix yarn into fabric;
a moulding cell to mould the fabric into a composite part or panel;
a trimming cell to trim and shape the composite part or panel to a final shape, and in which all sub-systems are connected together in a data network and form a single, integrated system for the creation of automotive composite parts or panels from source fibre and a matrix.

Feature 27: Integrated Control System for Production and Assembly of Panels or Parts

A factory including an automated system for the production of automotive composite parts or panels from source fibre and a matrix; in which production of composite parts or panels is determined by the requirements of a control system that also controls robotic cells that assemble the parts or panels into vehicles.

Feature 28: Matrix Production of Composite Parts or Panels

A factory including multiple robotic cells that use matrix assembly operations controlled by a matrix assembly software system, and not a conventional production line, to produce composite parts or panels, where the cells are not restricted from handling materials in a sequence defined by their physical location;
in which the robotic cells include cells for some or all of the following: a spinning machine to spin fibre and yarns, a loom to weave the fibre and yarns into a fabric structure, a moulding cell to mould the fabric structure into a composite part or panel, a trimming cell to trim and shape the composite part or panel to a final shape, and a bonding cell to bond different part or panel sections together.

Feature 29: Matrix Production Integration

A factory including multiple robotic cells that use matrix assembly operations controlled by a matrix assembly software system, and not a conventional production line, to assemble vehicle sub-systems and vehicles and in which at least some of the body parts or panels for the vehicle are not made of stamped or pressed metal but instead from composite parts or panels made from fibre and a matrix in an automated production system;
and in which the matrix assembly software system sends demand data to the production system and the production system sends supply data to the matrix assembly software system.

Feature 30: Composite Panels that are Mechanically Attached Using Robots

An automotive composite part or panel that is produced using a moulding cell that moulds a fabric structure, made of fibre and a thermoplastic matrix, to form the composite part or panel; in which the part or panel is configured for robotic attachment to structural members in a vehicle during the building of the vehicle.

Group E Automotive Vehicles with Composite Parts or Panels

Feature 31: Vehicle Side Panels are all Non-Stressed Composite Panels

Automotive vehicle with composite body panels that make up substantially all side panels of the vehicle and are non-stressed, providing no substantial torsional rigidity for the vehicle.

Feature 32: Vehicle Side Panels are Coloured (not Painted) Composite Panels

Automotive vehicle with composite body panels that make up substantially all side panels of the vehicle and are coloured during the panel production process.

Feature 33: Vehicle Skateboard Platform Supports Different Composite Panel Top Hats

Automotive vehicle skateboard platform configured to receive composite body panels that make up substantially all side panels of the vehicle and which are available or can be produced in a number of different shapes to enable various different vehicle types, such as van, car, pick-up truck, to be produced with substantially the same type or design of vehicle skateboard platform.

Feature 34: Vehicle Skateboard Platform Supports Different Top Hats Comprising Composite Parts

Automotive vehicle skateboard platform configured to receive a frame structure formed from composite parts, the frame structure being available in a number of different shapes to enable various different vehicle types, such as van, car, pick-up truck, to be produced with the same vehicle skateboard platform.

### BRIEF SUMMARY OF THE FIGURES RELATING TO THIS SECTION H

One implementation of the Arrival composites production process is shown in the accompanying Figures, in which:

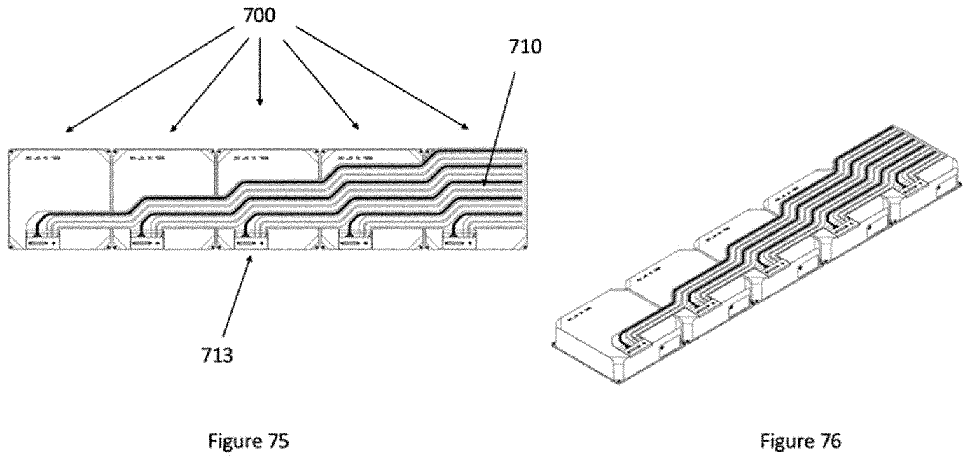

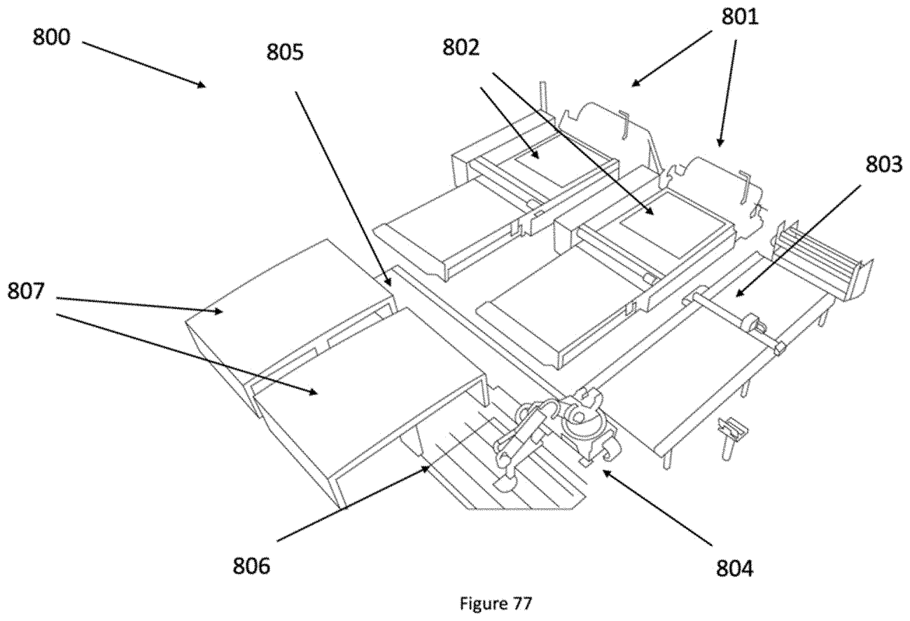

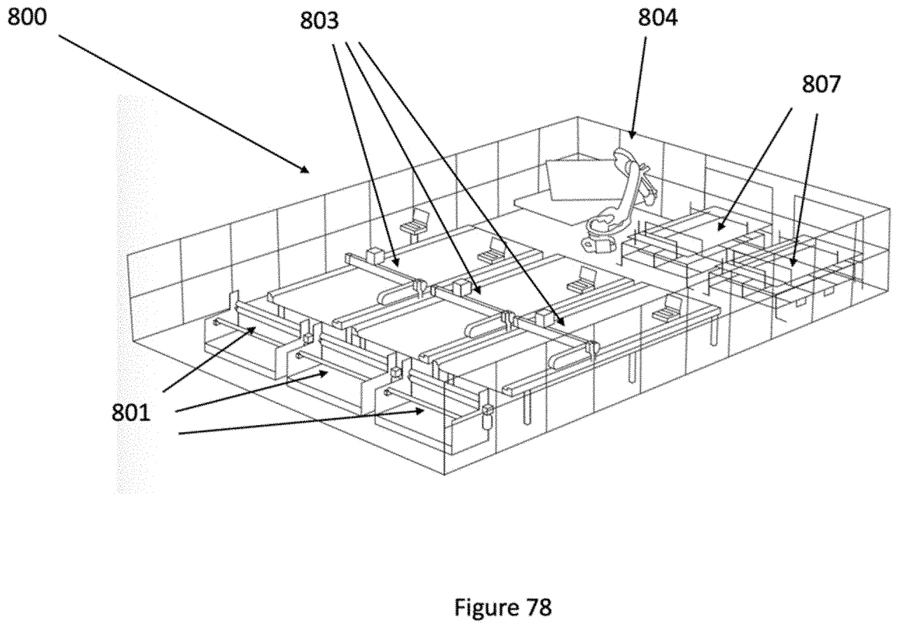

FIG. 77 and FIG. 78 shows schematics of a kitting cell.

FIG. 79 shows a moulding cell.

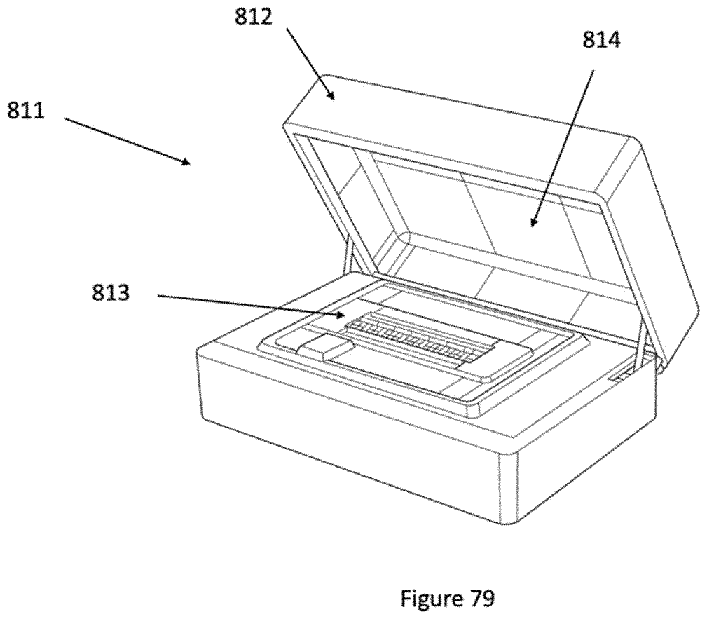

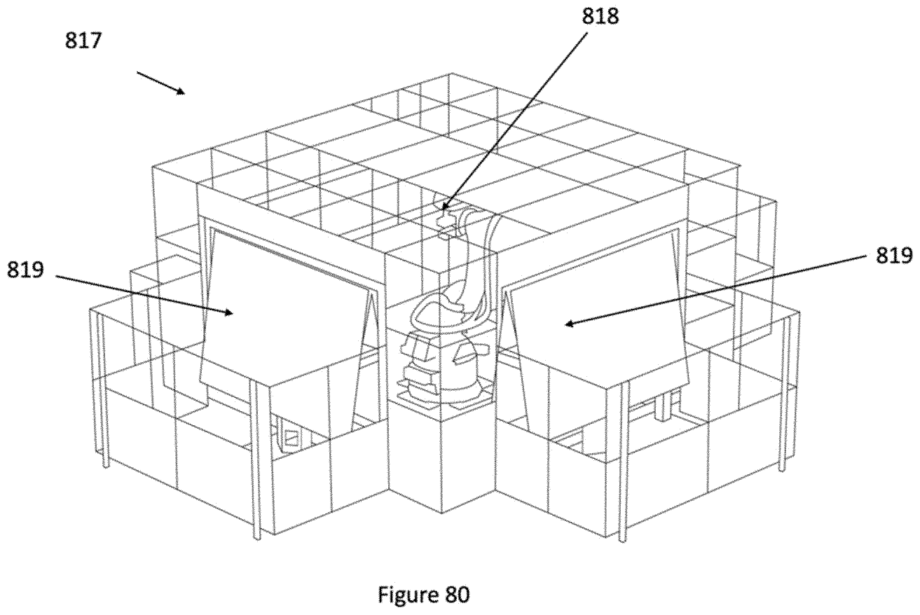

FIG. 80 shows a trimming cell.

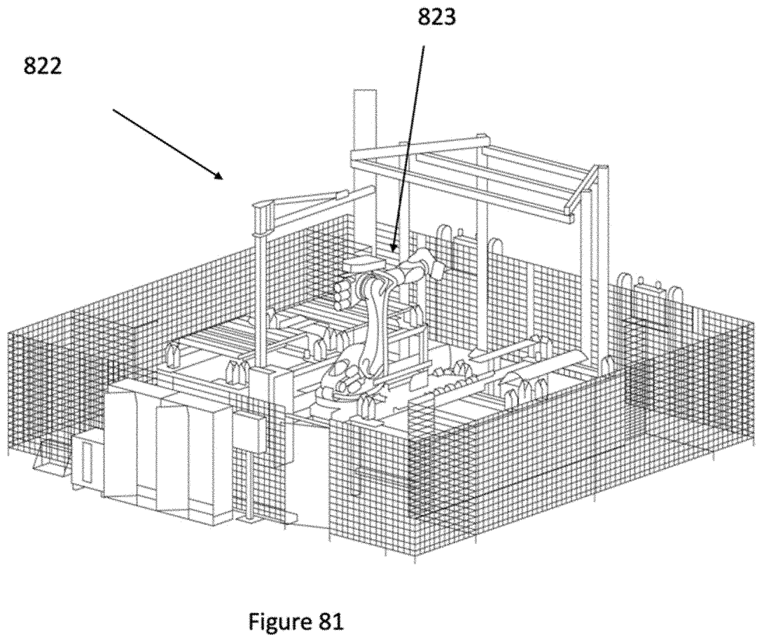

FIG. 81 shows an assembly cell.

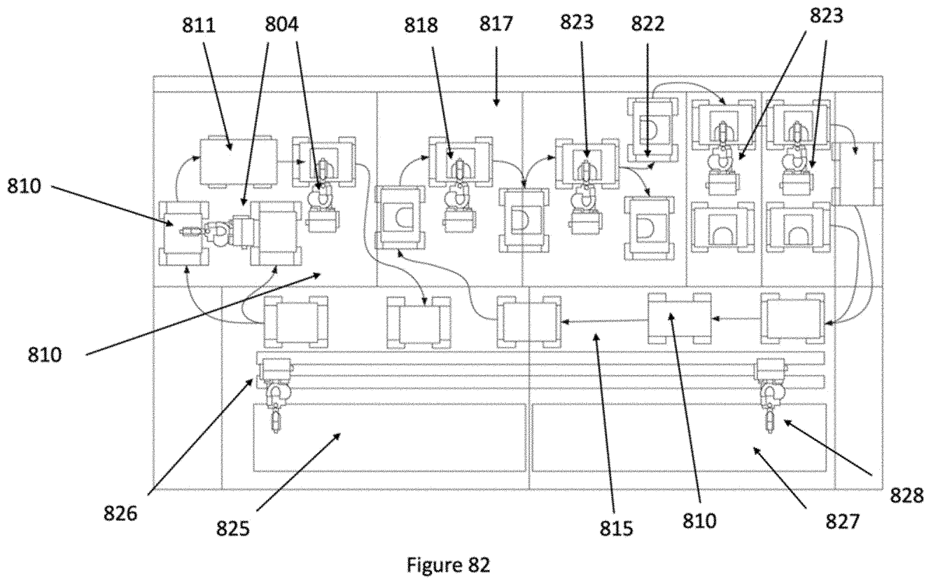

FIG. 82 is a layout for the Arrival composites part production section of a microfactory.

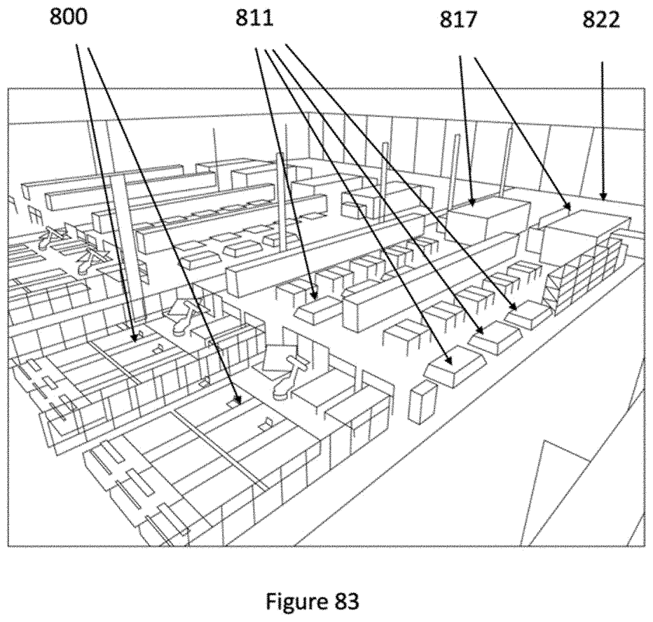

FIG. 83 is a schematic perspective view of the composites microfactory.

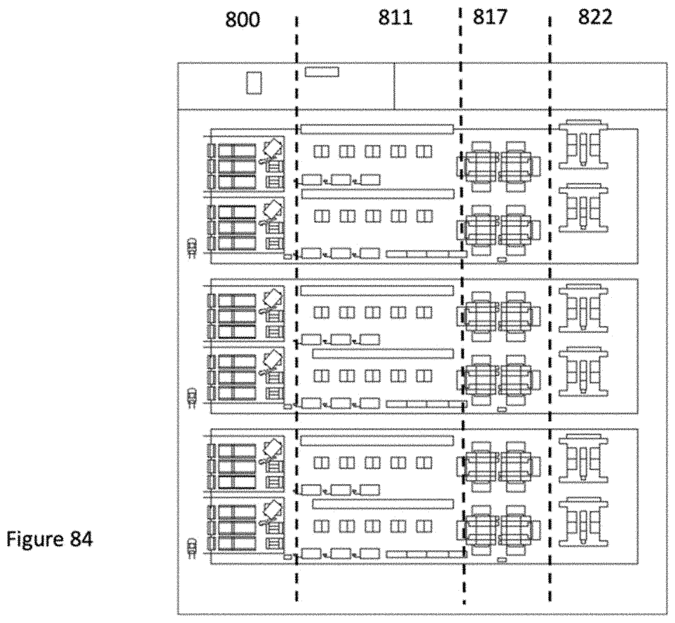

FIG. 84 is a layout view of the FIG. 83 microfactory.

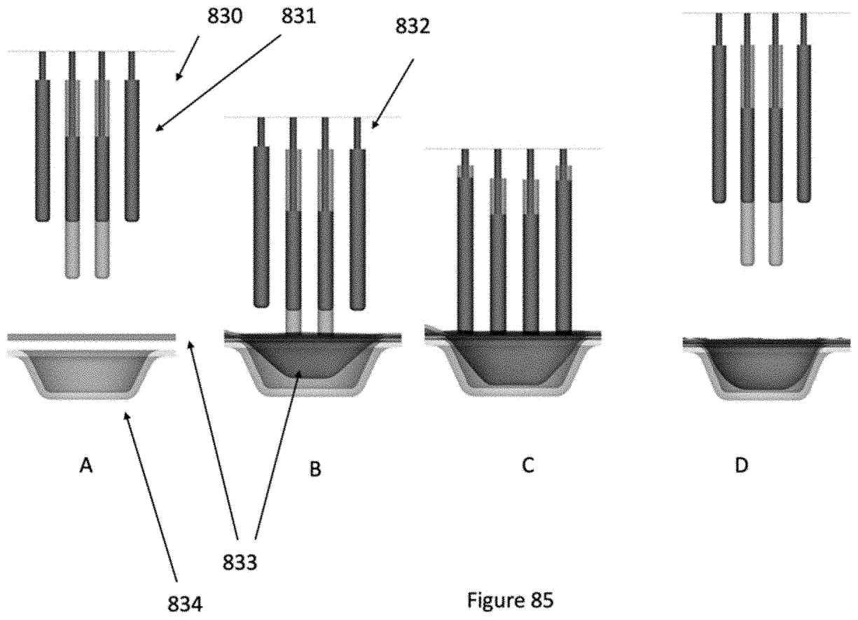

FIG. 85 shows a robotic tool for automatically shaping a material kit to conform to a mould.

### Index to FIGS. 77-85

| Reference | |
|---|---|
| numeral | Description of item |
| 800 | kitting cell |
| 801 | fabric or textile roll |
| 802 | fabric or textile unrolling system |
| 803 | automated fabric shape cutting system |
| 804 | 6DoF robot |
| 805 | linear track for 6DoF robot |
| 806 | textile piece pick up unit |
| 807 | kitting table |
| 810 | autonomous mobile robot (AMR) |
| 811 | moulding cell |
| 812 | hinged lid |
| 813 | shaped mould over which textile kit is laid |
| 814 | flexible silicone membrane |
| 815 | AMR path (curved single headed arrow) |
| 817 | robotic trimming cell |
| 818 | 6DoF robot in trimming cell |
| 819 | ‘A’ frame trimming jig support frame |
| 822 | robotic assembly cell |
| 823 | 6DoF robot in assembly cell |
| 825 | tool loading store |
| 826 | tool loading robot |
| 827 | jig loading store |
| 828 | jig loading robot |
| 830 | autoforming robot |
| 831 | autoforming robotic extensible rods |
| 832 | autoforming central shaft |
| 833 | textile fabric kit |
| 834 | mould |

### DETAILED DESCRIPTION FOR THIS SECTION H

Summary of the Arrival Composite Panel Production Process

We start by giving a simplified walk-though of one example of the Arrival composite panel production process. We begin with bobbins of polypropylene yarn and glass fibre rovings. The specific thickness, type, any additives and any other variable for the polypropylene yarn and glass fibre rovings are selected to be optimal for the specific composite panel being moulded. The glass fibre rovings and polypropylene yarn are brought together at the point at which they are combined into a fabric or textile, for example, just before the start of the weaving loom or in the weaving loom. Whilst glass fibre and yarn could be co-mingled together to form a co-mingled glass fibre/polypropylene yarn, which is then sent to the loom, by keeping the glass fibre rovings and polypropylene yarns separate, we can then select the specific bobbins or glass fibre, each with different thicknesses and other properties, as are appropriate for that specific textile fabric; it enables much greater flexibility.

A long roll of fabric is produced by the weaving loom; different sorts of fabrics, each with different properties are produced in this process, so you end up with multiple rolls of different kinds of textile fabric.

When a specific composite panel (or other part) is to be made, then an automated process selects the appropriate rolls of fabric needed for that specific panel; a typical side panel for an Arrival Van might be made from 5 layers of different fabric, each stored on a different roll, with each fabric contributing specific properties to the finished panel; multi-dimensional fabrics are also possible; in the limit, all of the required material properties for the fabric could be met by a single, carefully engineering, 3D woven fabric. A 3D woven fabric includes multiple layers of fabric; individual fabric layers can, for example, combined by inserting the weft yarn through adjacent layers so as to combine them together into a single piece of textile.

Long rolls of fabric are transferred to a ‘kitting cell’; this is the first robotic production cell used in the production of composite parts from fabric rolls. FIG. 77 shows a robotic kitting cell, indicated generally at 800. Two large fabric rolls 801 are shown, each at the end of a fabric unrolling system or table 801. The kitting cell includes a 6DoF robot 804 mounted on a linear track 805. The 6DoF robot 804 includes a textile piece pick up unit 806, here shown as including six tracks that each support an array of individual textile pick-up heads. Robot 804 picks up, using textile piece pick up unit 806, rectangular strips of fabric, automatically cut to length on fabric unrolling system 801, and transfers them to an automated fabric shape cutting system 803 that cuts fabric into the required, complex shapes. Robot 804 then picks up, using textile piece pick up unit 806, the pieces of textile that have been cut to the appropriate shape by the fabric shape cutting system 803, and transfers these on to a table of AMR, re-arranging their order until they are in the correct sequence to be moulded. FIG. 78 shows an another design of kitting cell; the fundamental processes are however the same as the system shown in FIG. 77.

So in the kitting cell, an automated system selects the appropriate roll or rolls 801 of textile fabric that are needed for a specific composite part, and unrolls sufficient fabric for the part on fabric unrolling system 802; this can be done as part of a just-in-time production process because this automated system is fully integrated with the other parts of the automated, software controlled vehicle production system. As the rolls of material come through, the factory software is indicating to the automated system, just in time, exactly what it wants made out of that piece of fabric. So the entire Arrival microfactory and all of the technology cells within it, are highly responsive, because they are being driven by the Arrival software, so the microfactory can be re-purposed to make different composite components almost instantaneously; the factory automatically reconfigures itself according to need.

After roll selection and simple cutting to length of a piece of textile, an automated shape cutting system 803 would then cut out the required detailed shape of fabric, including any required darts etc to enable the fabric to lie correctly in a mould. So, the fabric comes through, and is cut to the required shape using e.g. a conventional computer-controlled textile shape cutting system 803.

A robotic end effector 806, at the end of a conventional 6DoF robot 804, collects the material from the textile shape cutting system 803 and places that textile to form the base of a stack of similarly shaped textile pieces. The process is then repeated, with different textiles, and a stack of similarly shaped textile pieces is gradually built up to form a stack or ‘kit’: this is what we call a ‘kit’, and that ‘kit’ forms the foundation of the moulding process—it is this ‘kit’ or stack of materials that will be moulded into the finished part.

The end-effector has multiple rows of aluminium extrusions, and each row has a number of (e.g. ten) individually controllable fabric pick-up units (these may be suction based, or use small pins, or any other way of gripping the fabric). The software that controls the fabric pick-up units is provided with the exact shape of the cut textile piece so the software activates only those pick-up units needed to pick up that piece; a computer vision system ensures accurate positioning of the end effector over the textile piece.

The textile pick up units are positioned over a textile piece, which is itself on a chain flatbed that can position the textile piece as required under software control.

The 6DoF robot then lowers the textile pick up unit on to the textile piece; the fabric pick-up units then grip the textile piece, lift it, and move it to the stack of textile pieces that will form a specific kit. The robotic unit with a textile handling end effector will hence pick up a bottom layer textile piece and position it to form the base of the kit, then pick up the next layer textile piece and position it over the bottom layer, and so on until all layers are present; the ‘kitting’ process is complete.

So the pieces of fabric are assembled together to form a stack or fabric stack or fabric structure by a robotic kitting cell. The robotic unit with a textile handling end effector can then pick up the entire stack or structure and transfer it to an AMR (autonomous mobile robot). Alternatively, the robotic unit with the textile handling end effector can assemble the stack or structure directly onto a platform on an AMR.

The autonomous mobile robot (AMR) transfers the assembled fabric stack or structure to the moulding cell; the moulding cell (in one implementation) has a mould onto which the fabric is lifted and then positioned onto, using a robotic system.

Arrival has developed solutions for the materials, the moulding process and the mechanisms of moulding, to achieve a low Capex, light footprint, production concept in a warehouse. These steps come together without having to invest in heavy presses, heavy machinery and all of the Capex implications and complications that come with doing that. So, the Arrival composites microfactory is versatile, flexible, and is significantly cheaper to build than a conventional steel panel vehicle pressing plant.

AMRs (Autonomous Mobile Robots) are a fundamental part of microfactory operations because they allow sequential processes to be carried out at cells that are not necessarily physically adjacent: a conventional moving production line necessarily requires that sequential production processes occur in physically adjacent parts of the moving production line. AMRs break that dependence since AMRs move components or parts between cells as required: the AMR will bring the kit from the kitting cell into the moulding cell, wherever those cells are located; that may be a grid type arrangement, placing kitting cells close to moulding cells, to which further adjacent kitting and mould cells can be added as demand increases; if there is no space for further new cells in the part of the factory where the existing kitting and moulding cells are, then the new cells can be located in a different part of the factory; the AMRs will reach them where the kitting and moulding cells are located. AMRs are not restricted to moving along just pre-planned paths, but can autonomously navigate through the factory and can arbitrate or dynamically re-plan to prevent collisions or congestion with other AMRs, or people or other potential obstructions. The moulds may be on static tables, but they can also be mounted on AMRs, for even greater locational flexibility.

FIG. 79 shows a typical Arrival moulding cell, indicated at 812. The moulding cell may be served by a 6DoF robot that picks up a textile kit (or stack of material) provided by an AMR and then places that textile kit onto a shaped mould 813 positioned in the that is specific to the part or panel to be moulded. So in the moulding step, the fabric kit is placed or draped over the shaped mould 813 in the moulding cell. The mould has the precise shape of the panel or part to be made; the mould can be lifted from the moulding cell 812 by the 6DoF robot that serves the moulding cell and a different mould positioned in its place. Computer vision systems can assess whether the fabric structure is correctly draped or positioned in the mould and adjust accordingly.

Once the fabric structure is correctly positioned, then the hinged lid 812 is lowered and a flexible silicone membrane 814 inside the hinged lid is brought down over the fabric structure; a vacuum pump in the base of the moulding cell 811 evacuates air from above the mould, sucking the thick flexible silicone membrane 814 against the fabric structure, which is then heated by a heating system in the base of the moulding cell 811 to melt or fuse the thermoplastic polypropylene matrix around the glass fibres and to hence form the composite part or panel.

The composite part is cooled and the 6DoF robot then withdraws the finished part from the mould and transfers it to an AMR for transport to the next production cell. The entire process, from delivery of the fabric structure to the mould, to withdrawing the finished panel, takes just a few minutes. The moulding cell will carry out the entire consolidation cycle. The finished composite panel needs no painting.

Whilst we have described a fully automated process, some or all of the steps in this process can also be performed manually.

The moulding cell can be rapidly re-purposed to make different shapes and designs of panels by replacing the mould with a different, suitable mould; the silicone membrane can be re-used multiple times, unlike conventional single use vacuum bags; we refer to this as the Arrival Multiform system.

When a moulded part is taken from the moulding cell, it will have excess material at its edges that needs to be trimmed off. A 6DoF robot moves the moulded part from the moulding cell onto an AMR, which then moves it to the trimming cell, shown in FIG. 80. Another 6DoF robot 818, in the trimming cell, then moves the part to the trimming jig, e.g. using a gripper device; the 6DoF robot then selects a high speed rotary drill to trim the excess material from the part, following the edges of the jig. The correct drill bit for a specific task can be automatically selected from a rotating tool changer, one 6DoF robot can hence carry out many functions: different end effector tools are stored in the rotary tool changer and the robot can readily swap out different tools (e.g. different sizes of drill bits for different trimming tasks). The rotary tool changer rotates to meet the end-effector, presenting an empty slot into which the robotic arm slots the no longer needed end-effector and dis-engages from it. The robotic arm withdraws, the rotary tool changer rotates to present the required new end-effector; the robotic arm moves to and engages the new end-effector, withdraws and performs the required task.

The trimmed part is then removed by the 6DoF robot 818 and placed into an AMR for transportation to another cell. The trimming robot may include a computer vision system programmed to ensure that the excess material has been correctly and neatly removed. The excess material can be recycled, for example by first being mechanically shredded and then used as injection moulding feedstock.

With Arrival's cell-based approach, cell, we get as much utilisation out of the footprint of the cell as possible and avoid tool changeovers. One way this is achieved is by mounting trimming jigs and fixtures on double-sided A-frames 819 which can rotate: one side of the A-frame 819 can include one or more jigs for a composite panel or part; the jig provides the exact shape for a finished panel or part. Then, moulded parts, awaiting trimming, can be positioned on the jigs on both sides of the A-frame 819. The trimming robot 818 can then trim the parts that are held in the jigs on one side; the A-frame 819 then rotates and the trimming robot 818 can then trim the parts held in the jigs on the other side. So, the trimming robot 818 is in full utilisation, and the jigs and fixtures are in full utilisation and we get maximum throughput with the minimum footprint possible.

So, as with everything Arrival does, the goal is to try and keep the tooling costs as low as possible and the process as dynamic and flexible and as environmentally responsible as possible. As more composite parts are produced, Arrival learns how those parts need to adapt and evolve to improve safety, fit and finish on the vehicle for ergonomics, gaps and tolerances. The way Arrival approaches tooling jigs, fixtures, and processes, allows it to make changes very fast and without significant cost.

The various cells (kitting cell 800, moulding cell 811, trimming cell 818) evolve and improve over time: they can be readily improved without having to be moved, since the AMRs can simply route around a cell that is being maintained or improved to reach operational cells. If entirely new cells need to be installed, then that can be done without affecting the normal operation of the other cells, since the AMRs can again simply route around the new cells being installed to reach operational cells. AMRs can intelligently collaborate with one another, e.g. forming connected clusters or chains of AMRs where very large objects need to be transported; if cells are modified to create very large composite panels that are too large for a single AMR to transport, then multiple AMRs can join together to form an AMR cluster that is sufficiently large.

The trimming process in trimming cell 818 may be the last step in the sequence of events for part production, but in some cases the part requires assembly either to another composite part or to a metallic or a structure: we go onto the next and final cell to see the assembly process. The final cell, the assembly cell 822, shown in FIG. 81 is the last stage in the composite part production; not every part has to go through this cell, just those that are turned into an assembly. The 6DoF robot 823 in the assembly cell 822 works with tool changes and hence allows us to go from single panels to complex multi-part assemblies that are ready for assembly onto the vehicle.

The composite parts come from the trimming cell 818 or assembly cell 822 as substantially finished parts: there is no need to install paint lines or any other surface preparation. Composite parts are taken by AMRs from here to vehicle assembly (or stores). The cells can run in sequence as part of a software controlled just-in-time composite part process that turns rolls of textile into finished composite parts.

This process can be flexibly and rapidly re-configured according to dynamically changing requirements, for example by changing any one or more of: the types of textile material selected, the shapes of the textile parts that are cut, the constituents of the multi-layer kit of textiles assembled; the consolidation parameters; the finishing; any assembly. Scale efficiency can be readily achieved—for example, it may turn out that the moulding process is faster than expected, but trimming is slower; then additional trimming cells can be added to the factory, serving the same number of moulding cells, with perhaps additional numbers of AMRs moving the moulded parts from the moulding cells to the trimming cells. Or perhaps a small number of prototype vehicles with an entirely new body shape, using entirely new textile composites, are being built urgently: the factory can then be re-purposed almost immediately to focus entirely on creating the panels and parts required for these prototypes.

The finished composite panel is then made available for assembly with other panels or onto a vehicle frame, or moved by AMRs into a storage warehouse.

The Arrival microfactory also builds and organises the shape, and/or size and/or location of these technology cells on a grid-based architecture (see Section A). A schematic of this process, showing the extensive role played by the AMRs (the rectangles with the grey rectangles at each corner) is shown in FIG. 82; the flow path of the AMRs through the microfactory is shown by single headed curved arrow paths 815. FIG. 82 shows the general overall flow, from moulding cell 811 with 6DoF robot 804 lifting textile kits from AMR 810, to trimming cell 817 with trimming cell robot 818, to assembly cell 822 with assembly cell robot 823. In addition, FIG. 82 shows the tool loading store 825 that stores the different end-effector tools that robots might need; these are retrieved predictively by tool loading robot 826 and placed onto an AMR 810, which transports the required too to the requesting or appropriate robotic cell. The jig loading store 827 hold the jigs that are used in the trimming cells 817 and is served by jig loading robot 828; these jigs are retrieved predictively by jig loading robot 828 and placed onto an AMR 810, which transports the required jig to the requesting trimming cell system for use by trimming robot 818.

FIG. 83 is a perspective schematic of the entire composites production part of a microfactory. FIG. 84 is a plan view; it is separated into regions for the kitting cells 800, moulding cells 811, trimming cells 817 and assembly cells 822.

The flexible, re-configurable, just-in-time production approach described here is therefore used not just in composite part production, but applies to many other areas of the Arrival microfactory: for example, say the microfactory is currently working on building vans of the sort described in Section I but an urgent need arises to produce a small number, say 100, of the Arrival Buses, as described in Section J. The microfactory then accesses all the build data for the Arrival Buses, automatically adapts the selection of raw materials for the composite panels (if we assume that the buses uses a different, perhaps heavier, side panel that requires a different mix of raw materials). Bus panels may differ from van panels in any of: types of textile material selected, the shapes of the textile parts that are cut, the constituents of the multi-layer kit of textiles assembled; the consolidation parameters; the finishing; any assembly. The microfactory automatically re-configures itself so that it can start the bus production and assembly process.

The OCS (Operation Control System) of the microfactory allows for dynamic, event and data-driven control of the production process; it has been described in more detail in Section E and is a key element in Robofacturing. But to re-cap:
OCS provides for multi-agent, logical control for a robotic factory
OCS provides for dynamic decision making on all aspects of the control: what operation to choose for execution, what agent to choose for executing the operation
OCS implements the two-step operations control: (1) building an execution graph using the developed catalogue of micro services (rules, operations, constraints) described in FCL; and (2) dynamically choosing agents in runtime execution of operations in the graph.
OCS provides for implementing any execution scenario in a distributed transaction format.
OCS is a single system for control and management of the whole factory and all related objects and processes.
OCS uses the same language, FCL, for describing and controlling any process inside the factory, such as the production process, the fleet management, the maintenance, etc. Such processes as supply chain management, maintenance, failure avoidance, error recovery, can be equally described in FCL and added to the knowledgebase as additional Rules.
OCS is agent agnostic: abilities can be provided by any agent including robotic and non-robotic agents.
OCS provides for unified control for both robotic and manual operations. Thereby, OCS can control both automated and semi-automated factories and support any percentage of automation in a factory.
OCS is a distributed, scalable, fault-tolerant solution

The OCS will automatically adapt for the new production requirements. Namely, the change in CAD of products to be produced will trigger successive re-configuration of MBoM (Manufacturing Bill of Materials), MBoP (Manufacturing Bill of Process), PCM (Product Configuration Model), rBoM (Robofacturing Bill of Materials), rBoP (Robofacturing Bill of Process) and finally—a Factory Configuration Model (FCM).

The FCM is a master graph model of the microfactory physical environment and all features in that environment. The FCM is based on Factory Control Language (FCL) and thereby is a semantic model. The FCM is changed in accordance with and based on semantic rules and logic provided by the FCL.

As noted in Section E, Robofacturing is based on FCL, a new programming language for robotics, enabling, by its unique structure, logic and features, a dynamic robotic process management (autonomous control), which is distributed, fault tolerant and highly scalable. FCL is based on a multi-agent approach and provides for creating logic or semantic rules for dynamic, event and data-based control of the robotic workflow; it allows effectively the combining of control and data flows in the same management system. FCL is the first and only logical language for robotic process management and control. With FCL an execution graph can be built to serve as a basis for a logic solver to control and manage a robotic production process or any other process in robotics.

The FCM is written on the Blackboard, being a shared communication medium or layer of the microfactory, through which all agents of the microfactory communicate all their data and statuses, including computer vision data of AMR fleet and robotic agents. Any changes of the microfactory physical environment (data about the changes) written to the Blackboard will dynamically change the FCM, in accordance with semantic rules and logic provided by the FCL, as mentioned above. This allows for dynamic re-configuration of the OCS and the microfactory itself. Let us present an example of the latter for the discussed case of a new request for production of the Arrival P1 vehicles in the microfactory.

The OCS defines the entire workflow and components/materials required to build Arrival vehicles, and automatically determines that an optimum solution (in terms of speed, current component stock levels, reconfiguring the technology cells, impact on current van production obligations, overall costs etc.) is to cause immediately different rolls of textile fabric to be selected for processing, since the composite panels for say Arrival Vans are different from the composite panels currently being made for the Arrival Buses.

Let us assume that the OCS decides that it needs to re-allocate 50% of all the technology cells involved with composite part production to this new Bus project; that requires replacing the tooling jigs in 50% of the trimming cells with Bus related tooling jigs; the OCS organises for a fleet of AMRs to be sent to the jig stores and for them to be loaded up by local robots with the Bus related tooling jigs; at the same time, the OCS sends another fleet of AMRs to the trimming cells that are to be switched to Bus panel production, and instructs a local robot in each cell to remove and transfer the Van tooling jigs to these AMRs, and the AMR fleet then transports all of the Van tooling jig to storage; robots at the storage facility then remove these jigs and position them into storage. The fleet of AMRs loaded with the new Bus jigs passes the AMRs with the Van jigs and takes the Bus jigs to the trimming cells assigned to P1 panel trimming.

The robots in these cells use computer vision techniques to locate (e.g. using SLAM computer vision techniques) and to identify these new jigs, and to automatically locate (again using SLAM computer vision techniques) and select the different type of trimming tools or end-effectors, from a tool storage arrangement, such as the rotary tool changer, that are needed for trimming these Bus panels. The whole process is monitored by the computer vision system of the microfactory, including cameras on the AMRs and robots, its status is dynamically communicated to the Blackboard and reflected in the FCM.

Now let's suppose that the OCS has determined that the optimum resource allocation requires that a new trimming cell be set up, taking up factory floor space that was otherwise not used. Then, it is possible that humans move (e.g. with a forklift) a new robot into place and position the trimming jigs in position. All of the AMRs moving through the factory are automatically aware of the location and function of this new technology cell since the exact location, shape, properties and functions of all cells and other physical features in the factory space (e.g. power outlets, human work stations, lighting rigs, roof supports etc.) are communicated to the Blackboard and then are captured in the FCM. AMRs are themselves equipped with LIDAR, radar, depth sensors, SLAM computer vision etc, so that they are able to individually create a local map of their immediate environment, compare and update that with the master semantic representation of the FCM, enabling them to not only navigate successfully through the physical environment, but to attribute functions and properties to the physical features they detect in the environment.

So, for example, when an AMR detects another AMR approaching it, their mutual movement is reflected in the FCM on the Blackboard, then the AMR can automatically take optimal action; that may be, if there is only limited space and the approaching AMR is detected carrying a wide load which the software-based production system has flagged for urgent delivery (e.g. a large moulded panel that needs to be taken for urgent trimming), to move out of the way so the approaching AMR with the wide load can progress unimpeded.

Another example: installing the new trimming cell might affect the optimal routes taken by AMRs, as they now have to divert around the new trimming cell which will be reflected in the FCM on the Blackboard. Anyway, each AMR is able autonomously and in real time to determine its optimal path through the factory, taking into account new obstacles or features; it shares this route planning with the OCS, through the Blackboard, and updates the FCM which hence has a complete record of the planned routes of all AMRs, the location of all AMRs both now and at any future moment, as well as the sequence of all operations to be performed by all agents (both AMRs, robots and humans) to undertake all planned operations.

A key enabling technology for this degree of flexible, re-configurable, just-in-time vehicle production in a robotic factory is the FCM, a dynamic master semantic graph model of the physical environment of the microfactory and all features in that environment; the environment is mapped in real time by AMRs and robots using SLAM computer vision techniques (as well as e.g. LIDAR etc) to the Blackboard and that data are captured into this master semantic model in accordance with semantic rules and logic provided by FCL, so that the AMRs and robots understand at a semantic level the function and other attributes of objects (both fixed and dynamic) they detect; this enables real-time control of robots and robot end effectors that can be dynamically re-configured.

This enable the microfactory to be reconfigured (e.g. in a matter of a few hours, or indeed in real-time) to make different components (e.g. different types of composites, different types of composite panels), as well as, more generally, different types of vehicles, different configurations of the same type of vehicles, different assembly techniques, different components, even where the reconfiguration involves altering the function of robotic cells or the end effectors used, or the physical location or arrangement of the cells, or by adding or removing robotic cells to the microfactory, or re-routing routes taken by AMRs through the microfactory.

We will return now to the specifics of composite part production. Careful selection of the glass fibre and polypropylene yarn, the weave design, the combination of fabrics in different layers, and the selection of any core material to go between layers, results in automotive panels that are very lightweight, strong, yet ductile: Because the composite panels are very lightweight (and far lighter than equivalent pressed steel panels), they are easily and safely handled by robotic systems and accurately positioned and assembled to the structural frames used in the Arrival vehicles; their lightweight contributes to the overall lightweight of Arrival vehicles, which in turn leads to greater battery-powered range and lower energy consumption.

Because the panels are strong yet ductile, they should last a long time in the field and rarely need replacing; the panels will generally deform and return to their original shape after an impact that would permanently deform a similar steel panel. The panels can also be coloured not just in a surface layer, but throughout multiple layers of the fabric structure; scratches and deformations that would normally fully penetrate a superficial paint surface are hence concealed, increasing the useable lifetime of the composite panels. All of these contribute to Arrival's core goals of designing automotive vehicles that are environmentally responsible and yet offer low cost of ownership.

We have seen earlier how the microfactory uses groups of autonomous cells of robots instead of a continuous production line, with AMRs moving raw materials and vehicle components and assemblies between cells. The composite panel production process also uses separate production cells (e.g. moulding cells, and also cells for processes up-stream of moulding, like fabric cutting and kitting, and also down-stream of moulding, like trimming) instead of a continuous production line for the same reasons of flexibility (e.g. ease of initial planning and set-up or organisation of the various cells and materials stores; ease of re-configuring to make different panels or parts; ease of altering the flow through the factory if any specific cell should fail or experience raw material supply problem etc).

Each moulding cell is controlled by an automated control system that controls the AMR that supplies the fabric structure to the moulding cell, the robot that automatically loads and positions the fabric in the moulding cell, the robot that automatically withdraws the finished part to an AMR that moves the finished part to a trimming cell and any other post-moulding steps.

In the section above we have described the systems in terms of fibre, a matrix, a fabric structure, the moulding cell and re-cycling. In this next section, we give more colour and detail to the range of possibilities for each of these terms.

The Fibre
the fibre is, or includes, glass fibre, e.g. formed as a glass fibre roving
the fibre is, or includes, carbon fibre, or silicon carbide, or boron, or basalt
the fibre is a mix or combination of different types of fibre, or fibre with different properties
the fibre is, or includes, is PP (polypropylene), PET (polyethylene terephthalate), PA (polyamide), UHMWPE (ultra-high molecular weight polyethylene), PLA (polylactic acid)

The Matrix
the thermoplastic matrix is a thermoplastic polymer, such as polypropylene, polyester or polyethylene terephthalate, that has been formed into the thermoplastic matrix yarn
the thermoplastic matrix is an adhesive or thermosetting resin, such as an epoxy resin
the thermoplastic matrix is fused with the fibre by any of: consolidating, fully or partially melting, sintering, activating a chemical reaction, such as a polymerisation reaction.

The Fabric Structure
the fabric structure is formed from glass fibre roving and thermoplastic matrix yarns that are woven together
the fabric structure is a fibre reinforced polymer, such as glass-reinforced plastic (GRP) or carbon reinforced plastic, or a combination of different
the fabric structure is any one or more of the following: a woven fabric, a non-woven fabric, a knitted fabric, a laid fabric, a flat fabric, a flat weave fabric; a 3D weave fabric, a multi-layer fabric made using a 3D weaving process
the fabric structure is any one or more of the following: a fabric structure made by interweaving; a fabric structure made by intertwining; a fabric structure made by inter-looping.
the fabric structure is made up of a single layer of fabric
the fabric structure is made up of multiple layers of fabric
the fabric structure is a multi-dimensional or 3D structure, such as a 3D woven structure
the fabric structure is a 3D structure combined with one or more layers of fabric
the fabric structure comprises two or more sub-layers, for example sub-layers formed from a mesh of structural fibres, alternating layers of polymer and fibres, or
multiple layers of woven or non-woven composite fabric.
the performance properties (e.g. one or more of strength, stiffness, ductility, durability, weight, scratch resistance, appearance, UV light resistance) of the finished composite part or panel is achieved through the appropriate choice, applied to regions of the fabric structure, separate layers of fabric making up the fabric structure, or the entirety of the fabric structure, of one or more of the following: type of the fibre; type of the glass fibre; thickness of the fibre; type of the matrix yarn; thickness of the matrix yarn; relative proportions of the fibre and the matrix; weaving pattern of the fabric; type of weave of each fabric layer or of the fabric structure; choice of fabric for each layer in a stack of layers that is moulded in the moulding cell; choice of additives applied to the fibre; choice of additives applied to the matrix yarn; choice of additives applied to one or more of the fabric layers; choice of additives applied to the fabric structure; type of layers or coatings applied to the top of the fabric structure.
the performance properties (e.g. specific strength, impact strength), stiffness, ductility, durability, weight, scratch resistance, appearance, UV light resistance) are optimised or customised for one or more regions of the part or panel
the ductility of the part or panel is configured such that the part or panel rebounds or reforms after impacts that are below a threshold
a colour layer, free of any fibres, sits over the fabric structure
the colour layer is formed from a polymer yarn
the colour layer includes a coloured layer sandwiched between the fabric structure and an outermost, clear protective layer.
the colour layer includes one or more of: a pigment, a dye, a flame retardant a UV-absorbing additive
the colour layer is painted
the colour layer is a foil layer
a veil layer sits over the fabric structure and underneath the colour layer
the veil layer is configured to reduce print-through of the underlying fibres in the fabric structure
the diameter of the fibres in the veil layer is less than the diameter of the fibres in the fabric structure
the fabric structure is configured so that the part or panel is able to store and provide electrical power.

The Moulding Cell
the moulding cell produces a finished part
the moulding cell produces a finished part that needs only trimming of excess material
the moulding cell is a vacuum moulding cell
the moulding cell includes a multi-use silicone membrane to form a vacuum seal around the fabric structure
the moulding cell includes a heat source and combines vacuum and heat moulding of the fabric structure
the moulding cell does not include a heat source and there is a separate heating system that heats the fabric structure before the fabric structure is moulded by the moulding cell
the moulding cell is a pressure moulding cell that applies pressure to mould the fabric structure
the mould in the moulding cell is positioned above the fabric structure and the fabric structure is forced up against the mould.
the mould in the moulding cell is positioned below the fabric structure and the fabric structure is forced down against the mould.
the mould is replaceable by an automated process that enables parts or panels with different shapes to be sequentially and automatically moulded by the moulding cell
the moulding cell uses a 3D printed mould
the 3D printed mould is recyclable
the moulding cell raise the temperature of the fabric structure (composite precursor material above a reaction threshold temperature to fuse the fabric structure; and then actively or passively cools the fabric structure to below the reaction threshold temperature to set the composite part or panel
the moulding cell is capable of moulding (e.g. sequentially) multiple different shapes of parts or panels
robots automatically replace the moulds in the moulding cell with the required moulds, when different shapes of parts or panels need to be formed
the fabric structure is cut into shape (e.g. laser cut, or any other textile cutting technique); multiple pieces of cut fabric structure are then assembled to form the fabric structure, or precursor material, and the fabric structure or precursor material are then sent to the moulding cell for moulding into parts or panels
the moulding cell is controlled by an automated control system that controls the AMR that supplies fabric to the moulding cell, the robot that automatically loads and positions the fabric in the moulding cell, the robot that automatically withdraws the finished part to an AMR that moves the finished part to a trimming cell and any other post-moulding steps.

Re-Cycling
offcuts from the fabric structure are recycled or re-used to make injection moulded feedstock or for other processes
offcuts from the fabric structure are combined together (e.g. by needle punching or stitching) to form a part (e.g. a core) of new fabric structure from which new composite parts or panels can be made
trimmings from moulded parts are recycled or re-used, e.g. for injection moulded feedstock
trimmings from moulded parts are chemically processed and used to make composite parts or panels

In this next section, we will outline a number of specific key Features of the Arrival Composites system. We organise these key Features into the following five groups:

Group A: Production of the composite parts or panels
Group B: Properties of composite parts and panels
Group C Smart composite parts or panels
Group D Factory integration; Vehicle Assembly using Composite Parts or Panels
Group E Automotive vehicles with composite parts or panels

Within each group are a number of key Features:

Group A: Production of the Composite Parts or Panels
Feature 1: Fibre and yarn brought together only at weaving
Feature 2: Fibre and yarn relative proportions are fixed only at weaving
Feature 3: Fabric structure with co-moulded core
Feature 4: AMR supplies fabric structures to the moulding cell
Feature 5: Multi-use flexible membrane for Arrival MultiForm
Feature 6: Automated sliders for tooling
Feature 7: Direct heating of vacuum forming tool with modular replaceable skin
Feature 8: Pitch Fibre Mould Skin
Feature 9: Underside of mould is vented to the atmosphere
Feature 10: Pressure applied by a heated silicone tool
Feature 11: Robotic arrangement of the fabric in the mould

Group B: Properties of Composite Parts and Panels
Feature 12: Fabric structure that is moulded into a soft-touch panel
Feature 13: Fabric structure that is moulded into a textile-surfaced panel
Feature 14: Fabric structure that is moulded into a panel with a grain or patterned surface
Feature 15: Fabric structure that is moulded into a panel with a scratch-concealing structure
Feature 16: Fabric structure that is co-moulded with polymer objects
Feature 17: Fabric structure that is co-moulded with integral locator feature

Group C Smart Composite Parts or Panels
Feature 18: Composite panel with integrated electronics
Feature 19: Composite panel with co-moulded electronic components
Feature 20: Composite panels with integral identification tags
Feature 21: Composite panels with electrically conductive tracks
Feature 22: Composite panels with networked sensors
Feature 23: Composite panels where outputs from multiple low accuracy sensors are combined

Group D Factory Integration; Vehicle Assembly Using Composite Parts or Panels
Feature 24: Composite panel with integral fixing features
Feature 25: Composite Panel with auto-aligning features
Feature 26: Automated system for the production of automotive composite parts or panels from fibre and a matrix
Feature 27: Integrated control system for production and assembly of panels or parts
Feature 28: Matrix production of composite parts or panels
Feature 29: Matrix production integration
Feature 30: Composite panels that are mechanically attached using robots

Group E Automotive Vehicles with Composite Parts or Panels
Feature 31: Vehicle side panels are all non-stressed composite panels
Feature 32: Vehicle side panels are coloured (not painted) composite panels
Feature 33: Vehicle skateboard platform supports different composite panel top hats
Feature 34: Vehicle skateboard platform supports different top hats comprising composite parts

We will now look at each Group in turn.

Feature 1: Fibre and Yarn Brought Together Only at Weaving

We have seen above how the glass fibre rovings and polypropylene yarn are brought together only at the point at which they are combined into a fabric or textile, for example, just before the start of the weaving loom or in the weaving loom. By keeping the glass fibre rovings and polypropylene yarns separate, we can automatically select the specific bobbins or glass fibre, each with different thicknesses and other properties, as are appropriate for that specific textile fabric; it enables much greater flexibility and highly targeted customisation of the properties of the textile fabric.

We can generalise to: A system for the production of automotive composite parts or panels, the system including a moulding cell with a tool to mould a fabric structure, made of fibre and a thermoplastic matrix, into a composite part or panel, in which separate fibre and matrix yarns are brought together only immediately prior to, or as an integral part of, combining the fibre and matrix yarns together to form the fabric structure, using a weaving or a non-weaving process.

Optional Sub-Features:
fibre rovings or yarn and thermoplastic matrix yarn are brought together in a loom that weaves the fibre rovings or yarn and the matrix yarns together into the fabric structure
the fibre and the matrix yarn are not co-mingled and are separate strands, yarns or filaments prior to being woven together

Feature 2: Fibre and Yarn Relative Proportions are Fixed Only at Weaving

By combining the glass fibre rovings and polypropylene yarns only immediately prior to combining them into a textile fabric, we can control very precisely the relative proportions of glass fibre to polypropylene yarn: these relative proportions are a key determinant of the properties of the textile fabric. And we can vary this proportion in real time, as the loom or weaving device creates the fabric; this enables us to give the fabric different properties as you move across a piece of fabric. For example, take a typical large, 1 m square side panel for a van; that panel is attached to structural supports arounds its edge, but is unsupported in the middle of the panel. We can now alter the fabric that is woven in the loom so that the relative proportions of fibre to matrix alter, peaking every 1 m along the length of the roll of textile fabric in a way that results in maximum impact strength in the finished composite. When the fabric is selected for cutting, then the cutter is automatically positioned so that the maximum strength region is in the centre of the piece.

We can generalise to: A system for the production of automotive composite parts or panels, the system including a moulding cell with a tool to mould a fabric structure, made of fibre and a thermoplastic matrix, into a composite part or panel, in which separate fibre and matrix yarns are brought together in relative proportions chosen to give required material properties only at the point of weaving or otherwise combining the fibre and matrix yarns together to form a fabric.

Optional Sub-Features:
The required material properties include one or more of: strength (e.g. specific strength, impact strength), stiffness, ductility, durability, weight, scratch resistance, appearance, UV light resistance
The required properties are varied along the length of the fabric
The required properties are varied along the length of the fabric to optimise the performance of the composite part or panel which the fabric is going to be used for
The required properties are varied across the width of the fabric
The required properties are varied along the width of the fabric to optimise the performance of the composite part or panel which the fabric is going to be used for
The required properties are varied across the thickness of the fabric
The required properties are varied along the thickness of the fabric to optimise the performance of the composite part or panel which the fabric is going to be used for

Feature 3: Fabric Structure with Co-Moulded Core

The fabric structure may need to be supplemented with a core to increase the thickness of the composite part or panel, or to impact specific material properties (e.g. increased stiffness). In the Arrival system, it is important that the vehicle designers can design the external appearance of the vehicle in a way that best meets customers aesthetic and usability preferences; the engineering properties of the composite panels are then automatically analysed using a software design system; this system can then determine how to create the composite panels that meet safety, regulatory and engineering integrity requirements: for example, the system can automatically specific how many layers of textile fabric are need for a specific composite, what specific types of fabric are needed for each layer, and what sort of core (if any) is needed.

We can generalise to: A system for the production of automotive composite parts or panels, the system including a moulding cell with a tool to mould a fabric structure, made of fibre and a thermoplastic matrix, into a composite part or panel, in which the fabric structure is automatically provided with a core by an automatic or robotic system, and is co-moulded in the moulding cell with that core, and that core has been automatically selected to impart required properties to the part or panel.

Optional Sub-Features:
The core confers selected or required properties to the part or panel, or specific regions of the part or panel
The core confers selected or required properties including any one or more of: thickness, stiffness, weight, durability, strength, sound absorption
The core is, or includes a honeycomb, foam or other low density structure, to increase the thickness of the part or panel without adding substantially to its weight.
The core is formed of recycled composite material (e.g. PPGF)
The core is attached to the fabric structure before the fabric structure is moulded to form the panel or part
The core is arranged on, under or between layers of fabric that are made of fibre and thermoplastic matrix.
The core is made from one or more of: polyester or polyethylene terephthalate; high-performance fibres; thermoplastic matrix materials, balsa
The fabric structure includes multiple, separate cores

Feature 4: AMR Supplies Fabric Structures to the Moulding Cell

We have noted earlier that the composite panel production system uses separate production cells (e.g. moulding cells, and also cells for processes up-stream of moulding, like fabric cutting and kitting, and also down-stream of moulding, like trimming) instead of a continuous production line. This results in ease of initial planning and set-up or organisation of the various cells and materials stores; ease of re-configuring to make different panels or parts; ease of altering the flow through the factory if any specific cell should fail or experience raw material supply problem etc.

Because there is no conventional production line leading from one cell to the next in a pre-set, ordered sequence, the Arrival composites system uses a software-based control system that controls AMRs to pick up (e.g. from a fabric store, or fabric cutting cells) the fabric pieces assembled into a fabric structure and to supply the fabric structure to the moulding cell. The combination of software controlled AMRs and a network or matrix of moulding cells in effect replaces the fixed and inflexible production line system; the former is entirely flexible and can be re-configured to create a new production path through the factory in real-time, taking into account for example defects in some moulding cells, or the need to run simultaneous production of both composite panels for an existing vehicle and an entirely new prototype vehicle, or to optimise the time it takes to create the maximum number of complete, finished and trimmed composite panels, or to re-route the physical work-flow because the factory has been re-designed to move the stores from one side of the factory to another side etc; this degree of flexibility is of course entirely impossible with a conventional fixed production line, where the production logic is in effect permanently hard-wired in the physical production lines.

In the Arrival system, a robot in or operating with the kitting cell loads the fabric structure from the kitting cell to an upper surface of an AMR. Layers of precursor composite material are transferred from the kitting cell to the AMR, thus building up the stack of precursor composite material. The kitting cell robot and the AMR move independently, such that the layer of precursor composite material is brought into position as part of the stack of precursor material that is assembled on the upper surface of the AMR. The upper surface of the AMR accommodates multiple stacks of precursor material, and is configured to accommodate different stacks having different shapes, to be moulded into different components. The robot of the kitting cell is configured to load layers of fabric having different shapes. During loading of the layers into stacks, the robot of the kitting cell and the AMR move relative to one another so that the layers of different shapes are positioned in the correct stack. Thus, the kitting cell forms a number of layers of different shapes, each of which is loaded into position in the appropriate stack. The AMR then travels from the kitting cell to a moulding cell.

A robot in or operating with the moulding cell then automatically off-loads the fabric structure from the delivery AMR and positions the fabric structure in the moulding cell; the robot then automatically withdraws the finished part to an AMR that moves the finished part to a trimming cell or any other post-moulding steps.

We can generalise to: A system for the production of automotive composite parts or panels, the system including a moulding cell with a tool to mould a fabric structure, made of fibre and a thermoplastic matrix, to form a composite part or panel, in which an autonomous mobile robot (i) supplies the fabric structure to the moulding cell and an autonomous mobile robot then (ii) moves the composite part or panel formed by the cell away from the cell, for example to a trimming cell to trim and shape the composite part or panel to a final shape.

Optional Sub-Features:
An autonomous robot (e.g. in or operating with the kitting cell) and an autonomous mobile robot (AMR) are configured to move relative to one another to build up one or more stacks of layers of composite material on an upper surface of the autonomous mobile robot (AMR).
An autonomous robot or other robot removes the fabric structure from the autonomous mobile robot into the moulding cell
An autonomous robot (e.g. in or operating with the moulding cell) or other robot removes the composite part or panel formed by the cell away from the cell and on to an autonomous mobile robot.
The autonomous robot or other robot and the autonomous mobile robot are controlled or report to a shared computer system that tracks the operation of the robots and autonomous mobile robots, and also the moulding cells.
The shared computer system can re-program the selection of which moulding cells are used and when those moulding cells are used, and can control or direct the operation of the robots and autonomous mobile robots.

Feature 5: Multi-Use Flexible Membrane for Arrival MultiForm

If a moulding cell were limited to moulding only a single shape of panel over any extended period of time, then that would be equivalent to a stamping tool that is only able to stamp out one shape of pressed steel panel. The Arrival system has a far greater degree of production flexibility; specifically, the mould used in each moulding cell can be readily and automatically replaced with a different mould, for an entirely different panel or part; the silicone membrane is a multi-use membrane that does not have to be replaced after each vacuum forming process.

We can generalise to: A system for the production of automotive composite parts or panels, the system including a moulding cell with a tool to mould a fabric structure, made of fibre and a thermoplastic matrix, into a composite part or panel, in which the cell includes a flexible membrane that is configured to press the fabric structure against the tool surface to enable an automotive composite part or panel to be formed;
and the flexible membrane is a multi-use membrane configured to produce multiple different parts or panels.

Optional Sub-Features:
the membrane is made of silicone
a robotic system automatically changes the mould to enable parts or panels of different shape to be sequentially and automatically moulded in the same moulding cell

Feature 6: Automated Sliders for Tooling

Complex tooled shapes with features like undercuts require moulding tools to have sliders; these are moved out of position to enable the finished part to be withdrawn from the tool. In the Arrival system, the sliders are slid automatically in and out of position by robotic end-effectors, giving fast and consistent slider control.

We can generalise to: A system for the production of automotive composite parts or panels, the system including a moulding cell with a tool to mould a fabric structure, made of fibre and a thermoplastic matrix, into a composite part or panel, in which the tool includes one or more automated sliders configured to enable tooled features, such as undercuts, to be created automatically.

Optional Sub-Features:
An autonomous robot or other robot moves the sliders in and out of position in the tool.

Feature 7: Direct Heating of Vacuum Forming Tool with Modular Replaceable Skin

The outer surface of the mould that actually contacts or is closest to the fabric surface can be equipped with a skin that has the exact shape or profile to be given to the composite panel; the skin can be replaceable, enabling it to be replaced by a robotic system with a different skin; different skins are modular, in the sense that all are configured to sit on or against the same substrate. Changing just the modular skin is naturally cheaper and faster than having to replace the entire substrate. The skin can also be 3D printed for rapid production. In the Arrival system, there is a library of modular skins for a broad range of different parts and panels; some skins are made of a composite material and are suitable for low volume production runs; other skins are metal, e.g. nickel skins, and are suitable for high volume production runs.

We can generalise to: A system for the production of automotive composite parts or panels, the system including a moulding cell with a tool to mould and heat a fabric structure, made of fibre and a thermoplastic matrix, into an automotive composite part or panel, in which the tool is a modular tool that includes a tooling skin that is a modular replaceable tooling skin that is configured to be swapped in and out of the tool, and is configured to sit on or otherwise attach to a substrate which remains in or part of the tool when the skin is replaced.

Optional Sub-Features:
replaceable tooling skin is a composite skin for low volume production runs
replaceable tooling skin is 3d printed
replaceable tooling skin is a nickel skin for high volume production runs
replaceable tooling skin is a modular skin and part of a set of modular skins, all configured to sit on or against the same substrate in the tool
replaceable tooling skin is a modular skin and part of a set of modular skins for different parts or panels
replaceable tooling skin is configured to be robotically handled, e.g. withdrawn from the tool substrate and placed against the tool substrate

Feature 8: Pitch Fibre Mould Skin

One example of a mould skin is thermally conductive carbon fibre combined with matrix resin; this can sit on a mould support made of low thermal conductivity material, such as basalt. A carbon fibre mould skin could be 3D printed and could be replaceable.

We can generalise to: A system for the production of automotive composite parts or panels, the system including a moulding cell with a tool to mould and heat a fabric structure, made of fibre and a thermoplastic matrix, to form a composite part or panel, in which the tool includes a support, and a mould or mould skin that rests on the support and which shapes the fabric structure;
in which the mould or mould skin is made of thermally conductive carbon fibre combined with matrix resin.

Optional Sub-Features:
the mould or mould skin is set into shape by an adhesive, such as epoxy or epoxy resin.
the support is made of low thermal conductivity material, such as basalt.

Feature 9: Underside of Mould is Vented to the Atmosphere

A vacuum is applied to one side of the mould in order to enable atmospheric pressure to force the silicone membrane against the fabric structure; the other side of the mould (i.e. the mould support) is however vented to the atmosphere so that it does not to be strengthened to resist atmospheric pressure, as it would need to be if a vacuum was also generated inside the mould support.

We can generalise to: A system for the production of automotive composite parts or panels, the system including a mould that heats a fabric structure, made of fibre and a thermoplastic matrix, into an automotive composite part or panel, in which the fabric structure sits in or against a mould, and the mould is retained by a mould support;
and the mould support is configured to be vented to the atmosphere when a vacuum is applied to press a membrane against the fabric structure.

Feature 10: Pressure Applied by a Heated Silicone Tool

In the processes described above, the thermoplastic fabric structure is heated in some conventional manner (e.g. the moulding cell includes an integral heating element, such as an induction heater, or the moulding cell includes an external heating system that heats the fabric structure immediately prior to it being placed in the mould). An alternative scheme is for there to be a flexible tool that is itself heated indirectly; as the heated tool expands, it presses the fabric structure against the mould skin and also melts the thermoplastic matrix.

We can generalise to: A system for the production of automotive composite parts or panels, the system including a moulding cell to mould and heat a fabric structure, made of fibre and a thermoplastic matrix, into a composite part or panel, in which the cell includes a flexible silicone tool that is configured to expand when heated to press the fabric structure against a mould and to melt the thermoplastic matrix, in order to form the composite part or panel.

Feature 11: Robotic Arrangement of the Fabric in the Mould

Composite panel production must be fast, efficient and reliable; one of the more delicate aspects to using textile fabrics to make composite parts is to ensure that the fabric is laid correctly in the mould. In the Arrival composite system, this process is robotically automated: an autoforming robot 830, shown in FIG. 85, made up of extensible robotic end-effectors 831, can automatically shape or form the fabric structure into the correct shape or position in the mould 834. A computer vision system may also assess whether the fabric structure is correctly positioned in or over the mould.

The robotic end-effectors include an array of extensible rods 831 that can each move up and down along a central shaft 832; these rods 831 are positioned over the fabric structure 833 and are automatically extended (e.g. by pneumatic or electrical actuators) to conform the textile 833 to the shape of the mould 834. FIG. 85 shows a sequence of operations: in step A, the textile 833 is positioned over the mould 834 and the array of extensible rods 831 is also positioned over the mould 834. In step B, the array 831 is lowered onto the fabric structure 833, partly pushing the fabric 833 into the mould. The rods 831 are pushed back up their respective shafts 832 as the array of rods 831 is fully lowered into the mould, fully conforming the textile to the shape of the mould 834, as shown in step C. The array of rods 831 is then, in step D, lifted back off the mould, leaving the fabric 833 correctly shaped inside the mould 834. After the fabric 833 has been correctly formed, a foil, shaped using the same process as described above to conform to the mould 834, may then be added as the colour layer. As described earlier, a flexible silicone membrane is then brought down over the correctly draped fabric structure; a vacuum pump evacuates air from above the mould, sucking the thick flexible silicone membrane against the fabric structure, which is then heated to melt or fuse the thermoplastic polypropylene matrix around the glass fibres and to form the composite part.

We can generalise to: A system for the production of automotive composite parts or panels, the system including a cell with a tool to mould a fabric structure, made of fibre and a thermoplastic matrix, into a composite part or panel, in which the fabric structure is arranged in the mould by a robotic system that includes one or more end-effectors configured to form the fabric structure into the correct shape or position in the mould.

Optional Sub-Features:
the end-effectors include extensible sections configured to push the fabric structure into the correct shape or position in the mould.
extensible sections are rods that each slide up and down a shaft.
robotic system includes a computer vision system configured to determine if the fabric has been correctly draped or positioned in the mould.

For all the systems defined above in preceding Features 1-11, we can also generalise to:

A method of producing an automotive composite part or panel using the above system.

An automotive composite part or panel made using the above system or method.

A vehicle including one or more composite parts or panels made using the above system or method.

Group B: Properties of Composite Parts and Panels

Feature 12: Fabric Structure that is Moulded into a Soft-Touch Panel

Automotive interiors are becoming increasingly premium; soft-touch materials for interior parts, such as dashboards and door trims, are attractive; to ensure Arrival vehicle designers can readily specify these sorts or premium materials, and do so without adding prohibitive extra costs, the Arrival composite system enables composite parts to be moulded with soft-touch—i.e. from the moulding cell come finished soft-touch parts. This is achieved by including within the fabric structure a compressible or elastomer region; this region is hence formed inside the part or panel during the moulding process.

We can generalise to: A method of producing automotive composite parts or panels, the method using a moulding cell with a tool to mould a fabric structure, made of fibre and a thermoplastic matrix, to form a composite part or panel, in which at least some of the fabric structure includes a compressible or elastomer region so that the part or panel is a soft-touch part or panel.
the fabric structure is made up of layers of fabric, and one of those layers is the compressible or elastomer layer
the part is a dashboard, door trim or other internal automotive part
the panel is an exterior panel

Feature 13: Fabric Structure that is Moulded into a Textile-Surfaced Panel

Another attractive feature for automotive parts, such as headliners or footwells, boots/trunks is a textile-like surface—for example, one with a short, dense coat of fibres. As above, to ensure Arrival vehicle designers can readily specify these sorts or premium materials, and do so without adding prohibitive extra costs, the Arrival composite system enables composite parts to be moulded with a textile-like surface—i.e. from the moulding cell come finished parts with a textile-like surface. This is achieved by including within the fabric structure a top region with a textile texture or surface; this region is hence formed as an integral element of the part or panel during the moulding process.

We can generalise to: A method of producing automotive composite parts or panels, the method using a moulding cell with a tool to mould a fabric structure, made of fibre and a thermoplastic matrix, to form a composite part or panel, in which the top-most region of the fabric structure has a textile-like surface, so that the part or panel has a textile-like surface.

Optional Sub-Features:
the fabric structure is made up of layers of fabric, and the top layer has a textile surface
the part is a headliner, or a footwell, boot/trunk wall or other interior surface
the panel is an exterior panel

Feature 14: Fabric Structure that is Moulded into a Panel with a Grain or Patterned Surface

Adding grains or textures to parts or panels, such as dashboard or door trims is another popular design feature: the Arrival composite system enables composite parts to be moulded with a grained or textured surface—i.e. by giving the surface of the mould (e.g. the mould skin) a grained or textured pattern, finished parts with a grained or textured surface can come directly from the moulding cell.

We can generalise to: A method of producing automotive composite parts or panels, the method using a moulding cell with a tool to mould a fabric structure, made of fibre and a thermoplastic matrix, to form a composite part or panel, in which the surface of the tool includes a pattern or grain that is imparted or transferred to the top layer of the composite part or panel.

Optional Sub-Features:
the fabric structure is made up of layers of fabric, and the top layer is given the patterned or grained surface
the part is a dashboard or other interior surface
the panel is an exterior panel

Feature 15: Fabric Structure that is Moulded into a Panel with a Scratch-Concealing Structure

One of the major advantages of composite panels over pressed steel panels is their high ductility; on an impact, they deform, but can then return to their original shape. But impacts often cause scratches that remove the layer of surface paint, revealing an unsightly composite material underneath. So the panel, even though it has returned to its original shape, still has to be replaced because it has unsightly scratches or crease lines. Arrival composites have a scratch-concealing structure which results in panels that not only return to their original shape after an impact, but also conceal any scratches; panels do not need to be replaced, reducing repair costs and the time in a repair garage (which is especially important for commercial vehicles). Arrival parts and panels achieve this by giving not just the outer surface a specific colour, but also giving some (or all) of the interior of the part of panel a matching colour. So the finished part or panel that comes from the moulding tool is coloured through at least part of its bulk.

We can generalise to: A method of producing automotive composite parts or panels from a fabric structure, made of fibre and a thermoplastic matrix, and in which a finish layer or a top layer to that structure has a specific colour;
and in addition one or more underlying portions of the fabric structure has a colour that is the same as, or is sufficiently similar to, the specific colour of the finish layer or the top layer, so that scratches that penetrates the finish layer or the top layer, or other damage that affects the finish layer or the top layer, are concealed or not readily noticeable.

Optional Sub-Features:
one or more fabric layers in the structure has a colour that is the same as or sufficiently similar to the colour of the finish layer or the top layer, so that scratches that penetrate the finish layer or the top layer are concealed or not prominent.
the finish layer or the top layer is an integral part of the fabric structure
the finish layer or the top layer is formed from the fabric structure.
the colour in the fabric structure is conferred by one or more pigments.
   The matrix yarn includes one or more pigments before it is woven together into the fabric structure.
the finish or top layer includes a first pigment, and the fabric structure includes a second pigment:
   The first pigment and the second pigment are the same.
   The first pigment and the second pigment are different.

Feature 16: Fabric Structure that is Co-Moulded with Polymer Objects

The fabric structure moulded by the moulding cell does not have to made solely of textile fabric; we have seen earlier how cores (e.g. balsa and other materials) and elastomers can be incorporated into the fabric structure and hence moulded into the finished part or panel. Discrete objects, small in relation to the overall size of the part or panel, and made of plastic or another polymer, can also be added to the fabric structure and perform a variety of functions, such as imparting a specific localised shape or feature to the part or panel which is hard to achieve through a tooling feature.

We can generalise to: A method of producing automotive composite parts or panels, in which a moulding cell moulds a fabric structure, made of fibre and a thermoplastic matrix, into an automotive composite part or panel, and in which one or more plastic or other polymer objects are added to one or more layers and are co-moulded into the composite part or panel.

Optional Sub-Features:
the object is shaped and positioned to impart a specific localised shape or feature to the part or panel

Feature 17: Fabric Structure that is Co-Moulded with Integral Locator Feature

One specific example of a feature which can be co-moulded directly into the composite part or panel is a locator feature, which defines a precise location on the part or panel, e.g. to enable the part or panel to be accurately located with respect to another part or panel, or other type of structure.

We can generalise to: A method of producing automotive composite parts or panels, in which a moulding cell moulds layers of a fabric structure, made of fibre and a thermoplastic matrix, to form the composite part or panel; in which the part or panel is moulded with an integral locator feature that is configured to define a precise location on the part or panel.

Optional Sub-Features:
the locator feature is configured to enable the part or panel to be accurately located with respect to another part or panel, or other type of structure.

For all the methods defined above, we can also generalise to:

A system for the production of an automotive composite part or panel configured to use the above method.

An automotive composite part or panel made using the above system or method.

A vehicle including one or more composite parts or panels made using the above system or method.

Group C Smart Composite Parts or Panels

Feature 18: Composite Panel with Integrated Electronics

Arrival's composite panels are designed to be ‘smart’ panels—i.e. for the finished parts or panels that come out of the moulding cell to include electronic components and power/data tracks so that the parts and panels are not just physical surfaces but instead can, for example, play a part in sensing the environment, in collecting and transmitting data through the vehicle, and in storing power.

We can generalise to: An automotive composite part or panel that includes one or more electronic components formed directly in or on the composite part or panel during the production process of the part or panel.

Optional Sub-Features:
the composite part or panel is made using a fabric structure, made of fibre and a thermoplastic matrix,
the composite part or panel is made from a fabric structure with several fabric layers, such as layers of glass fibre-reinforced polypropylene (PPGF), or a 3D weave of thermoplastic glass fibre and a matrix, and the electronic component is formed or positioned on one of these layers or in the 3D weave.
the electronic component is a RFID component used to identify the part or panel
the electronic component is an active component, such as a battery, integrated circuit, or sensor
the electronic component is a passive component, such as an antenna, capacitor or inductor

Feature 19: Composite Panel with Co-Moulded Electronic Components

By including these components and tracks during the actual moulding of the composite part or panel, we have a finished item that (after trimming) can be installed directly into a vehicle; there is no further time or cost involved in adding these components and their associated wiring harnesses.

We can generalise to: A system for producing automotive composite parts or panels, the system including a mould that moulds a fabric structure, made of fibre and a thermoplastic matrix, to form an automotive composite part or panel, in which one or more electronic components are added to the fabric structure and are co-moulded into the composite part or pane during the moulding process.

Optional Sub-Features:
the composite part or panel is made using a fabric structure, made of glass fibre and a thermoplastic matrix,
the composite part or panel is made from a fabric structure with several fabric layers, such as layers of glass fibre-reinforced polypropylene (PPGF), or a 3D weave of thermoplastic glass fibre and a matrix, and the electronic component is added to one or more fabric layers or in the 3D weave and is then co-moulded into the composite part or panel.
the electronic component is a RFID component used to identify the part or panel
the electronic component is an active component, such as a battery, integrated circuit, or sensor
the electronic component is a passive component, such as an antenna, capacitor or inductor

Feature 20: Composite Panels with Integral Identification Tags

One important use case is for the electronic component to be an identification tag, such as a passive RFID tag. Being able to uniquely identify each composite part or panel is very useful in the production process since it enables each composite part or panel to be tracked right from production, through all assembly operations and throughout the life of the vehicle and through to its eventual recycling; it enables an accurate assessment of the durability and environmental profile of each part or panel.

We can generalise to: Vehicle with composite parts or panels that include, integrated within the body of at least one part or of at least one panel, an identification tag, such as a RFID tag, formed into the part or panel during a moulding process that moulds a fabric structure, made of fibre and a thermoplastic matrix, to form the automotive composite part or panel, and in which one or more identification tags are added to the fabric structure to enable identification and tracking of the part or panel in warehousing and in production operations.

Optional Sub-Features:
the identification tag provides a unique identifier
the identification tag is a passive device
the identification tag can be written to and has read/write capability
the identification tag is formed into the part or panel during a vacuum forming process
the identification tag is used by robotic devices to identify the part or panel during vehicle assembly
the identification tag includes data that relates to the production batch and/or production process
the identification tag is used to authenticate a part or panel as being from an authorised source
the identification tag is used to identify the part or panel throughout its lifetime, including to end-of-life recycling.
the composite part or panel is made from a fabric structure with several fabric layers, such as layers of glass fibre-reinforced polypropylene (PPGF), or a 3D weave of thermoplastic glass fibre and a matrix, and the passive identification tag is formed or positioned on one of these layers or in the 3D weave.
the composite part or panel is made from a fabric structure with several fabric layers, such as layers of glass fibre-reinforced polypropylene (PPGF), or a 3D weave of thermoplastic glass fibre and a matrix, and the passive identification tag is added to one or more fabric layers or in the 3D weave and is then co-moulded into the composite part or panel.

Feature 21: Composite Panels with Electrically Conductive Tracks

As noted earlier, the finished parts or panels that come out of the moulding cell can include electronic components and power/data tracks so that the parts and panels are not just physical surfaces but instead can, for example, play a part in transmitting power and/or data through the vehicle.

We can generalise to: An automotive composite part or panel formed from a fabric structure, made of fibre and a thermoplastic matrix, in which one or more electrically conductive lines, tracks or other structures, are formed directly in or on the fabric structure and have defined borders that are inside, or within the edges the fabric structure.

Optional Sub-Features:
electrically conductive lines, tracks or other structures are formed directly in or on the fabric structure as part of the process for forming the fabric structure
electrically conductive lines, tracks or other structures are formed directly in or on the fabric structure as part of the weaving process for forming the fabric structure
fabric structure is made up of layers of a thermoplastic glass fibre and matrix fabric, and at least one of the layers includes one or more of the electrically conductive lines, tracks or other structures formed directly in or on that layer.
lines, tracks or other structures are discrete or bounded structures in or on the layer
lines, tracks or other structures are predetermined or specifically designed
electrically conductive lines or structures carry data
electrically conductive lines or structures carry power
electrically conductive lines or structures are tapes
electrically conductive lines or structures are flexible PCBs
electrically conductive lines or structures are made of conductive glue, such as silver doped epoxy resin
electrically conductive lines or structures are embedded conductive fibres
electrically conductive lines or structures are embedded optical fibres
electrically conductive lines or structures are created or added during the production process of the part or panel
electrically conductive lines or structures form a grid or array to which components are added during vehicle production
electrically conductive lines or structures include fuse areas that can be blown to configure the electrically conductive lines or structures into a desired pattern
electrically conductive lines or structures replace vehicle wiring harnesses

Feature 22: Composite Panels with Networked Sensors

Arrival's composite parts and panels can also include a distributed array of sensors; these can, individually, be low-cost sensors, but when combined in sufficient numbers provide data that can be processed to give information of sufficient trustworthiness. This approach exploits the ability to integrate multiple sensors into the part or panel during the composite moulding process, and to include, again during the composite moulding process, the data and power tracks needed to support the sensors. As above, the finished part or panel coming from the moulding cell can therefore include a sensor array, plus the data and power tracks for these sensors.

We can generalise to: Vehicle with composite parts or panels that include a distributed array of sensors whose output is collectively analysed to provide environmental information, with no individual sensor providing data of sufficient trustworthiness to be solely acted on, but which, when combined, is sufficiently reliable to be acted on.
sensors are integrated within the body of at least one part or at least one panel
composite panels are exterior vehicle body panels
composite parts comprise a frame of the vehicle
multiple panels include sensors that form part of the distributed array
sensors are configured for robotic assembly into a body panel
sensors connect to data and/or power lines or other structures that are integrally formed on or in the part or panel
sensors include computer vision sensors
sensors include people or device proximity sensors
sensors are low-cost sensors that individually do not provide data of sufficient trustworthiness to be solely acted on

Feature 23: Composite Panels where Outputs from Multiple Low Accuracy Sensors are Combined

We can generalise to: A composite part or panel including a distributed array of sensors, each sensor being configured to contribute phase and magnitude information of limited accuracy, wherein the phase and magnitude information from individual sensors can be combined so that the composite part or panel serves as a sensor having an enhanced level of accuracy.

Optional Sub-Features:
the sensors serve as passive detectors or active detectors.
the sensors are configured to measure attributes of at least one of the external environment of the vehicle, the internal environment of the vehicle, and the condition of the vehicle itself.
each sensor is configured to withstand a temperature at which the part or panel is moulded into shape.
the sensors are configured to measure attributes of one or more other vehicle in the vicinity of the sensors (e.g. the position of the vehicle, the speed of the vehicle, and the direction of motion of the vehicle).
each sensor is part of a MEMS device which is integrated within the part or panel
each MEMS device includes at least one of a microphone, a pressure sensor, a load sensor, a fibre optic sensor, a lidar sensor, a radar sensor, a force sensor, a strain sensor, and a stress sensor.
the part or panel comprises one or more piezo devices configured to emit or receive sound waves at subsonic frequency.

Group D Factory Integration; Vehicle Assembly Using Composite Parts or Panels

Feature 24: Composite Panel with Integral Fixing Features

Arrival composite panels are optimised for the robotic assembly workflow implemented in the microfactories described earlier (see also Section F). One enabling feature is to include fast and reliable integral fixing features in the composite parts and panels themselves; in the Hardware Modularity section (see Section A), we have described various physical fixing and fastening devices that are optimised for robotic handling and that can be directly integrated into composite parts during the moulding process, greatly simplifying and speeding up the process of attaching a part to the vehicle.

We can generalise to: An automotive composite part or panel that is produced using a moulding cell that moulds a fabric structure, made of fibre and a thermoplastic matrix, to form the composite part or panel;
in which the part or panel is moulded with an integral fixing feature that is configured to enable the part or panel to be attached or fixed to another part or panel or other structure by a robotic device.

Feature 25: Composite Panel with Auto-Aligning Features

Accurate self-alignment features in the composite parts and panels greatly facilitate robotic assembly.

We can generalise to: A method of producing automotive composite parts or panels, the method using a moulding cell with a tool to mould a fabric structure, made of fibre and a thermoplastic matrix, to form a composite part or panel, in which the composite part or panel is shaped to include features that, when assembled with another structure, correctly aligns the part or panel, e.g. in the X, Y and/or Z directions, in relation to the other structure.

Feature 26: Automated System for Producing Automotive Composite Parts or Panels from Fibre and a Matrix

Arrival vertically integrates the key steps in composite panel production, from spinning and weaving to moulding and final trimming. All sub-systems are connected together in a data network and form a single, integrated system for the creation of automotive composite parts or panels from source fibre and a matrix; this enables efficient software based control and management of the entire process and also enables multiple looms, moulding cells and trimming cells to be distributed in an array around the factory floor, with AMRs moving material between the cells. As explained earlier, this in turn enables the low CapEx, yet highly scalable and fault tolerant microfactory architecture of a matrix array of robotic cells.

We can generalise to: An automated system for producing automotive composite parts or panels, the system including the following sub-systems:
a loom to weave or otherwise combine fibre and matrix yarn into fabric;
a moulding cell to mould the fabric into a composite part or panel;
a trimming cell to trim and shape the composite part or panel to a final shape, and in which all sub-systems are connected together in a data network and form a single, integrated system for the creation of automotive composite parts or panels from source fibre and a matrix.

Feature 27: Integrated Control System for Production and Assembly of Panels or Parts

Feedback loops are a key element of the microfactory architecture, enabled by the efficient software based control and management system. In the Arrival system, it is possible to go from raw glass fibre and polypropylene yarn, to finished composite panels, in a fast and scalable process. Because these panels are finished panels, they can be taken straight into the vehicle assembly process. The Arrival system can implement not merely just-in-time delivery of these composite panels, but also just-in-time production—i.e. eliminating the need to build panels and warehouse store them, but instead to build them to order.

We can generalise to: A factory including an automated system for the production of automotive composite parts or panels from source fibre and a matrix; in which production of composite parts or panels is determined by the requirements of a control system that also controls robotic cells that assemble the parts or panels into vehicles.

Feature 28: Matrix Production of Composite Parts or Panels

We have noted earlier that in the Arrival system, we have robotic cells for all key processes that are distributed in an array around the factory floor, with AMRs moving material between the cells. As explained earlier, this in turn enables the low CapEx, yet highly scalable and fault tolerant microfactory architecture of a matrix array of robotic cells.

We can generalise to: A factory including multiple robotic cells that use matrix assembly operations controlled by a matrix assembly software system, and not a conventional production line, to produce composite parts or panels, where the cells are not restricted from handling materials in a sequence defined by their physical location;
in which the robotic cells include cells for some or all of the following: a spinning machine to spin fibre and yarns, a loom to weave the fibre and yarns into a fabric structure, a moulding cell to mould the fabric structure into a composite part or panel, a trimming cell to trim and shape the composite part or panel to a final shape, and a bonding cell to bond different part or panel sections together.

Optional Sub-Features:
robotic cells are configured to perform matrix assembly operations using computer vision to identify, track, and perform tasks.
the moulding cell is configured to perform moulding and demoulding using matrix assembly operations controlled by the matrix assembly software system.

Feature 29: Matrix Production Integration

The Arrival matrix-based system, as noted earlier, can implement not merely just-in-time delivery of composite panels, but also just-in-time production—i.e. eliminating the need to build panels and warehouse store them, but instead to build them to order. The vehicle assembly software system can send its requirements for composite panels to the composite panel production system, for just-in-time production. Panels are hence made to order, and supplied just-in-time, with the vehicle assembly system fully informed of the status and delivery schedule of newly built composite panels, so that it can automatically schedule its vehicle build operations.

We can generalise to: A factory including multiple robotic cells that use matrix assembly operations controlled by a matrix assembly software system, and not a conventional production line, to assemble vehicle sub-systems and vehicles and in which at least some of the body parts or panels for the vehicle are not made of stamped or pressed metal but instead from composite parts or panels made from fibre and a matrix in an automated production system;
and in which the matrix assembly software system sends demand data to the production system and the production system sends supply data to the matrix assembly software system.

Feature 30: Composite Panels that are Mechanically Attached Using Robots

The final step for the composite panels (e.g. produced on a just-in-time basis in one part of the microfactory, and delivered to the robotic vehicle assembly part of the microfactory on a just-in-time basis) is for the composite panels to be grasped by robotic assembly systems and fitted to a vehicle. The panels are designed to enable fast and reliable robotic handling and installation or assembly into the vehicle.

We can generalise to: An automotive composite part or panel that is produced using a moulding cell that moulds a fabric structure, made of fibre and a thermoplastic matrix, to form the composite part or panel; in which the part or panel is configured for robotic attachment to structural members in a vehicle during the building of the vehicle.
parts or panels are flat, curved, or have any required shaped or thickness or variable thickness
panels are non-stressed
panels are configured for mechanical attachment to parts or panels using clips
parts or panels are configured for chemical or glue attachment
parts or panels are removable and recyclable as a feedstock for injection moulding
parts comprise a frame of the vehicle
structural members include a skateboard platform
structural members include vertical frames, such as aluminium extruded frames
composite parts or panels are produced using reinforcing glass fibres and a thermoplastic polymer, such as polypropylene
composite parts or panels are a glass-reinforced plastic (GRP)
composite parts or panels are made from woven thermoplastic composite yarns
composite panels make up substantially all side panels of the vehicle
composite panels make up substantially all roof panels of the vehicle
composite panels make up substantially all front and rear panels of the vehicle
composite parts make up substantially all of the frame of the vehicle
vehicle is an electrically powered vehicle
vehicle is a car, van, or bus

Group E Automotive Vehicles with Composite Parts or Panels

Feature 31: Vehicle Side Panels are all Non-Stressed Composite Panels

In this final section, we look at some of the properties of the vehicles using Arrival's composite panels. Arrival's composite panels are designed to complement other aspects of Arrival vehicle design; for example, Arrival vehicles include structural members (e.g. aluminium extrusions) which are designed for robotic assembly onto the skateboard platform and which provide the structure to which the composite panels can be attached. Because the vehicle's structural performance comes from these structural members, it means that the composite body panels can be non-stressed, which in turn lead to a simpler, lighter, cheaper design for these body panels.

We can generalise to: Automotive vehicle with composite body panels that make up substantially all side panels of the vehicle and are non-stressed, providing no substantial torsional rigidity for the vehicle.

Feature 32: Vehicle Side Panels are Coloured (not Painted) Composite Panels

We have seen earlier how the Arrival composite body panels can be coloured not just in a surface layer, but also through a substantial depth of the panel, rending the panel scratch-concealing.

We can generalise to: Automotive vehicle with composite body panels that make up substantially all side panels of the vehicle and are coloured during the panel production process.

Feature 33: Vehicle Skateboard Platform Supports Different Composite Panel Top Hats

Arrival vehicles can be rapidly designed with different bodies, and hence body panels, all sitting on the same type of skateboard platform. We have seen earlier how the Arrival composite panel moulding system enables different body panels to be made with no alteration to the factory layout, and in essence the creation only of suitable mould skins (which can be 3D printed) for the new body panels, which can then be used in the existing moulds.

We can generalise to: Automotive vehicle skateboard platform configured to receive composite body panels that make up substantially all side panels of the vehicle and which are available or can be produced in a number of different shapes to enable various different vehicle types, such as van, car, pick-up truck, to be produced with substantially the same type or design of vehicle skateboard platform.

Feature 34: Vehicle Skateboard Platform Supports Different Top Hats Comprising Composite Parts

We have described earlier the production of composite body panels and other parts. It is possible also to produce structural composite elements using the same process—these structural composite elements can be used to replace some of the structural elements that would otherwise be made of extruded aluminium. Materials for the structural composite elements include any one or more of the following: Polyetherimide; Polyamide 6/66/4.10/4.12; Polyphenylene Sulphide; Polyetherether ketone; Polyarylethreketone.

We can generalise to: Automotive vehicle skateboard platform configured to receive a frame structure formed from composite parts, the frame structure being available in a number of different shapes to enable various different vehicle types, such as van, car, pick-up truck, to be produced with the same vehicle skateboard platform.

In the following section, we give a miscellaneous list of various optional sub-features relevant to all preceding Feature 1-34:
glass fibre and matrix yarns are only brought together at the time of weaving and are not co-mingled or plied
yarn is formed from glass fibre and a matrix that are not co-mingled
yarn is formed from glass fibre and a matrix that are co-mingled
thermoplastic matrix is polypropylene
proportions of glass fibre to the matrix in the yarn are chosen to give the final composite part or panel redefined properties
yarn is glass fibre-reinforced polypropylene (PPGF)
a kitting cell assembles a stack of layers of fabric together, in which different layers provides specific material properties
offcuts of fabric, e.g. from any kitting cell (if used), are re-used as core layers
autonomous mobile robot (AMR) transfers fabric, or the stack of layers (e.g. from the kitting cell, if used) to the moulding cell.
stack of layers includes a colour layer and a veil layer sitting over the layers of fabric.
The veil layer confers surface texture, minimising pattern show through, and contributing to the binding of the colour layer to the layers of composite material.
the moulding cell is a vacuum moulding cell
the moulding cell is a pressure moulding cell
composite panels are side panels of a vehicle
composite panels are roof panels of a vehicle
composite panels are door panels of a vehicle
composite panels are interior panels of a vehicle
composite parts comprise a frame of a vehicle

Composite Precursor Material
the moulding cell forms a stack of precursor material
A stack of precursor material comprises a plurality of fabric layers, with the number and/or thickness of the layers being selected according to the part to be produced.
A layer of precursor fabric material is formed by glass fibre roving and matrix yarn being woven together in a loom.
   the matrix is a thermoplastic
Each layer of the stack of precursor material has one or more attributes that are customised for the part that is to be produced.
   the layer comprises a selected fibre (e.g. glass fibre)
   the layer comprises a selected matrix (e.g. polypropylene)
   the layer comprises a selected proportion of fibre to matrix (e.g. 60:40).
The stack of precursor material further comprises one or more finish layers
   the finish layer is a laminated layer
   the stack comprises a colour layer
   the stack comprises a veil layer (e.g. an elastomer veil, e.g. chemically compatible with matrix so that the composite material is suitable for recycling)
   finish layers confer a class A finish, a gloss finish, a non-woven finish, or a tactile finish.
   finish layers applied to both sides of the stack.
Each layer of precursor material in the stack has a colour that is substantially similar to the colour of the finish layer.
A layer of the precursor material is formed of recycled composite material (e.g. PPGF)
A layer of the precursor material is configured to conduct electricity.
   The conductive composite layer comprises conductive particles

Kitting of the Precursor Material:
The precursor material is cut into shape, and formed into a stack of fabric layers

Electronic Components
Electronic components are integrated within the stack of precursor material (e.g. RFID tags; alternative to cassette)
Electrical contacts are integrated within the stack of precursor material

Transfer of Precursor into Mould:
the stack of precursor material including the finish layer is transferred into the mould
the finish layer is transferred into the mould, and then the precursor material is transferred into the mould
a release layer is provided in the mould, fabric, veil or film, to facilitate removal of the consolidated composite material
the mould is coated with the release layer, and the fabric structure is then positioned in the mould
the fabric structure is coated with the release layer, and is then positioned in to the mould
Transfer of the precursor material to the mould is performed autonomously
Transfer of the precursor material to the mould is performed by an autonomous robot.
The precursor material is arranged in the mould by an autonomous robot system with a computer vision system configured to assess whether the precursor material is correctly positioned in the mould and one or more end-effectors configured to form the precursor material into the correct shape or position in the mould.

Attributes of the Mould:
The mould is hollow and is formed by a moulding process
   The mould comprises a valve configured to maintain air pressure outside the mould, so that it is not crushed due to the vacuum.
A mould skin is inserted into a mould support
   The mould skin is formed from the pattern
   The mould skin comprises pitch fibre (e.g. carbon fibre, which has a high thermal conductivity)
   The mould skin comprises high-temperature tooling resin (e.g. epoxy, which improve efficiency by reducing the heating time)
   The surface of mould skin has a durable coating (e.g. a 95% aluminium gel coat or deposition)
The mould is configured to engage with a membrane to form an air-tight seal.
   The membrane is configured to dissipate heat quickly (e.g. a thin layer of rubber or silicone).

The Mould is Single Sided:
A single sided mould is brought into contact with a first side of the stack of precursor material
   A vacuum bag is brought into contact with a second side of the precursor material
   A membrane is brought into contact with a second side of the precursor material
   A plug is brought into contact with a second side of the precursor material
   A tool formed from silicone is brought into contact with a second side of the precursor material
The second side of the stack of precursor material comprises a release layer
The second side of the stack of precursor material comprises a breather layer

The Mould is Produced from a Pattern:
The pattern is created from CAD that specifies the shape of the finished part
The finished part is designed so that panel is draped over a frame, which ensures that the panel is non-stressed

Pressure Differential:
One or more fluid conduits are configured to remove or supply fluid
Consolidation of the composite is performed at low pressure
   Negative pressure is achieved by pumping air out of the mould via the one or more fluid conduits
Consolidation of the composite is performed by application of positive pressure

Heating Device:
Heating is local
   heating is provided by an induction technique
   heating is provided by a resistive technique
   heating is provided by a conductive technique
The heating device is integrated into the mould
The heating device is integrated into the composite precursor material
The precursor material is vacuum formed before being heated (this technique makes it easier to handle precursor).
The precursor material is heated before being vacuum formed
   pre-heating material between 2 diaphragms, and then forming

Cooling of the Consolidated Material:
The apparatus for producing the composite part further includes a cooling device
   The cooling device is a fan
   cooling is introduced via the membrane
   cooling is introduced via the mould
Heat dissipates well from thin film of silicone.
Pitch fibre is a conductor of heat.
Basalt is an insulator of heat, so cooling adapted to accommodate for this.

For the Case of the Mould being Positioned Below the Composite Material:
The precursor composite material is brought into position within the mould, before a vacuum seal is formed on the other side.

Mould Support:
The mould support is hollow, and comprises a valve which is used to vent the mould support to air pressure during the vacuum seal process.
The mould support comprises a table, onto which the mould is placed.
The mould support comprises a buck, into which the mould is placed.
   The buck is formed of basalt.
   The mould is formed of pitch fibre.

Composite Support:
The composite is transferred from the kitting cell to the moulding cell by an autonomous vehicle.
The mould itself provides the composite support during the moulding process.
The precursor material is positioned within the mould autonomously by a machine.

Transfer Mechanism:
Pressure differential is a vacuum:
   Thin film of air tight membrane (e.g. a thin film of Silicone)
   Air tight membrane brought into position from above (therefore, this serves as a diaphragm, holding the composite precursor material in place as a flat surface)
Pressure differential applies positive pressure:
   A plug which is pushed into the mould (e.g. a plug of Silicone).
   The shape of the plug is selected that accommodates the thermal expansion of the plug.

For the Case of the Mould Positioned Above the Composite Material:
A vacuum is formed raising the composite precursor material into position within the mould.

Mould Support:
In use, the mould is disposed above the composite material
The mould is held in position above the composite material by the mould support

Composite Support:
The composite support comprises a table, onto which the composite precursor material is placed.
The composite support comprises a diaphragm, onto which the composite precursor material is placed.
The composite support comprises a first diaphragm onto which the composite precursor material is placed, and a second diaphragm which in use is positioned above the composite precursor material.

Transfer Mechanism:
The transfer mechanism is configured to actuate a pressure differential across the composite precursor material to confirm the precursor material to the mould.

Section I: The Arrival Van System

Introduction to this Section I

The commercial van market is fast growing, driven not least by the multi-year pivot away from high-street retailing to online shopping and direct-to-home delivery using vans. The demands placed on drivers of these vans are very acute. For example, a typical delivery driver can make 10 to 30 delivery stops an hour, and hence as many as 200-300 stops in a typical shift. That is 200-300 times the driver has to route to the correct destination, temporarily park without disrupting traffic, turn off the van ignition, stand up from their driver's seat, open the driver's door and step down two or more steps to the tarmac, then walk to the back of the van, open it up, climb up two or three steps, enter the cargo area, locate the correct parcels, and then exit the cargo area, climbing down two or three steps and locking the cargo area. After the package has been delivered, the driver has to unlock the van, open the driver's door, climb up two or three steps into the cabin, then (when parked kerbside) move across the cabin to the driver's seat, and then pivot into the driver's seat, avoiding the central part of the dashboard that typically contains a gear lever, control panels, air vents, radio etc. and protrudes into the driver cabin.

If you repeat that sequence 300 times a day, and you have tens of thousands of drivers replicating that sequence each day, then improvements to the ergonomic efficiency of this sequence are not only hugely beneficial to drivers (reducing stress and fatigue, leading to safer driving and fewer accidents) but also to the overall speed, efficiency and reliability of the package delivery or other logistics service.

The requirements of the major online retailers, and the dedicated logistics companies responsible for delivering hundreds of millions of packages a year, to improve the ergonomic efficiency of this sequence have however not been well served by conventional van designs, even electric van designs. Customisation to meet the specific requirements of specific online retailers and/or logistics companies has generally not been done because it is too costly and because the conventional vehicle production paradigm (very large, high CapEx factories with large steel pressing plants and moving production lines) is too inflexible.

As we have seen earlier in this document, the Arrival system is especially well suited for the design and assembly of vehicles that are customised to the specific requirements and challenges of business users, even at relatively low volumes (e.g. 10,000 vehicles or less). The Arrival system is a vehicle design and production system that aims to enable vehicles to be designed and made to meet specific customer needs, with enhanced user engagement, lower environmental impact and total cost of ownership that is as good as, and in many cases better, than conventional vehicles.

Arrival vehicles implement hardware and software modularity concepts (see Section A and Section B earlier, with the security architecture described in Section C), and are configured using the Vehicle Builder (see Section D). Arrival vehicles can be brought from design to production in 12 months, as opposed to 3-5 years, with no price premium for being zero emission, and are produced using small cells of robots, with each cell producing both sub-assemblies and the entire vehicle (see Section E for more on Robofactoring) in relatively small and low capital expenditure (CapEx) microfactories (see Section F) that are not based on conventional long moving production lines. Arrival vehicles use modular high voltage battery modules (see Section G); a scalable system which enable battery packs to be made for the entire range of Arrival vehicles, providing to a customer a far broader choice of battery pack capacity than is conventionally possible. Microfactories do not need huge steel panel presses because Arrival vehicles use body panels that are not made of pressed steel, but instead lightweight composites (see Section H). Composite panels and other parts can be made for the entire range of Arrival vehicles, from the Arrival Van (this Section I), to the Arrival Bus (see Section J) and to the Arrival Car (see Section K).

Producing vans in a microfactory can be especially relevant where a delivery or logistics company has a requirement for vans with specific attributes to serve a specific city or region, or has a major logistics hub in that city or region, and that microfactory can be built in that actual city or region. The microfactory approach is significantly cheaper in CapEx than conventional moving production line factories, meaning that much lower annual production volumes can still be profitable, in turn making possible designs and features that are specific to just a single fleet customer. Microfactories can be readily scaled up by adding additional robotic production cells, or scaled down if needed, or switched to different designs of buses, or vans or cars. Because a microfactory is much smaller (e.g. 10,000 to 20,000 square metres) than a conventional vehicle factory (1M+ square metres), many such microfactories can be built in areas of demand, anywhere in the world, establishing a local presence quickly, with shorter supply chains, enhanced local employment, enhanced local tax base, and no requirement for ocean container shipping, further reducing the carbon footprint. Microfactory production using small cells of robots requires radical re-thinking of how a vehicle should be designed: this design for robotic production is at the heart of the Arrival system and is exemplified by the Arrival Van.

This Section I describes a number of features, adopted variously in the Arrival Van implementations of the invention. We categorise these features into the following five groupings:
A. Arrival Van: Driver Ergonomic Features
B. Arrival Van: Physical Construction Features
C. Arrival Van: Automated Customer Configuration using Vehicle Builder and Automated Production using Robofactoring in a Microfactory

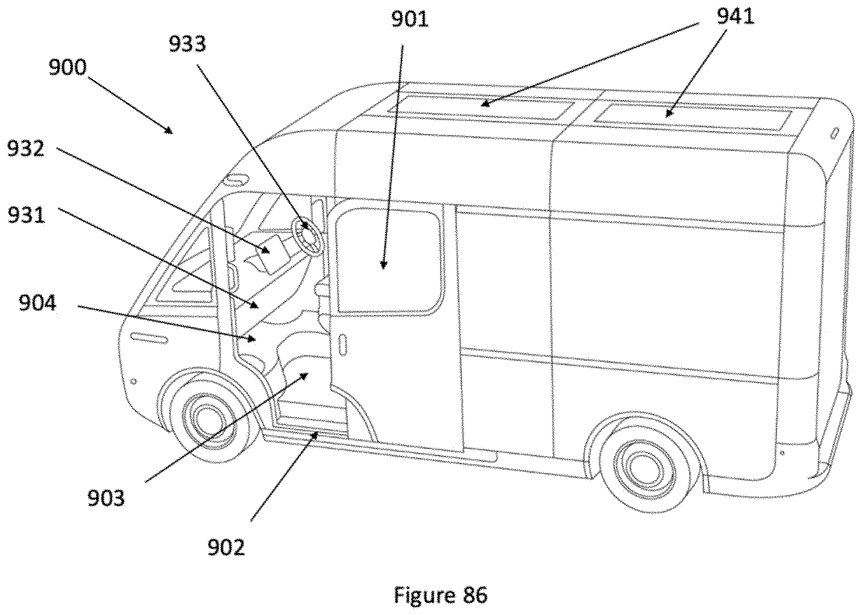

The walk-in variant of the Arrival Van is shown in FIG. 86.

A. Arrival Van: Driver Ergonomic Features

The Arrival Van is designed to deliver significantly better driver ergonomics compared to a conventional diesel van. Optimising driver ergonomics is a key benefit, especially for logistics or delivery vans, where a driver may have to stand up from the driver's seat, exit the van, enter the cargo space to retrieve a package, deliver that package, re-enter the van and drive to the next stop—and to repeat that process, under time constraints, several hundred times a day. Improved ergonomics leads to less tired drivers, who have fewer accidents and injuries, and perform their jobs more efficiently with higher levels of job satisfaction.

Inside the Arrival Van, there is a single, flat, uninterrupted floor that runs from the driver's seat, through a wide bulkhead that separates the driver cabin from the cargo area, and then right through to the end of the cargo area. So the driver can stand up in the driver cab and walk straight through to the back of the cargo area without having to step over the usual obstructions found in a typical diesel van. And the level of the flat, uninterrupted floor is much lower (typically 200 mm lower) than the internal floor level in a typical diesel van too: the driver can easily step up from the ground into the van using just a single internal step, making entry and exit from the van faster and easier—key benefits when that movement has to be repeated several hundred times a day, under time pressure.

This is all made possible because the Arrival Van has a low skateboard-type platform or chassis that includes a large battery pack, and has an internal, flat floor surface no more than 480 mm from the ground (approximately 200 mm lower than a conventional diesel van, as noted above), making it much easier for the driver to enter and leave the van. Ground clearance of the van is approximately 180 mm, so is not compromised. The Arrival Van hence resolves two competing and contradictory requirements: for a van chassis to have sufficient ground clearance, even when fully laden, yet to support an internal floor that is very close to the ground. And because the centre of gravity of the Arrival Van is much lower than a conventional diesel van, handling is better than a conventional van. Actual dimensions of the Arrival Van are: height of internal floor above the ground: 460 mm. Height of driver cabin step above the ground: 300 mm. Height of floor above the driver cabin step: 160 mm.

The low, skateboard type chassis and the absence of a diesel engine at the front of the van leads to a windscreen that is much larger than in a conventional van, starting much lower to the ground and hence making the driver cabin very light and also giving the driver a very large cone of view, for enhanced awareness, reduced driver stress and improved road safety.

Maximising cargo space can be achieved by placing the driver as far forward in the van as possible, but driver safety is enhanced if the driver is set back from the front of the van. Finding the ideal compromise is challenging; the Arrival Van has a specific geometry designed to optimise these competing factors.

Delivery drivers are very security conscious and need to know that their van is locked and secure, but they also need ready access to and from the van, even when carrying packages. The Arrival Van resolves these two competing requirements using two-factor unlocking: for the van to unlock a specific door, a sensor by that door has to both detect the presence of a wireless key or fob within range and also to detect a gesture in front of, or a touch to, the sensor; this is far more convenient and secure than having to manually lock and unlock with a physical key.

We can generalise to nine Arrival Van key features in this Group A:

Feature 1: Van with Single Uninterrupted Internal Floor from Driver Seat Through to Cargo Area, Sitting on a Low Level Chassis with a Battery Pack

An electric van with (i) a flat floor mounted on a chassis, and (ii) a battery pack or packs that is in, or part of, or mounted on, the chassis; and where the flat floor is a single, flat uninterrupted floor surface that is no more than 480 mm up from the ground and is configured to provide a pathway that leads from the driver's seat, into and through a cargo area in the van.

Feature 2: Van with Single Uninterrupted Internal Floor from the Driver Seat Through to the Cargo Area, Sitting on a Low Level Chassis with a Battery Pack, and with a Single Walk-In Step Up from the Ground to the Driver Cab

An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and where the driver cabin includes a single internal step down to a lower area, or walk-in step, that is adjacent to a door to the driver cabin, and the walk-in step is no more than 350 mm above the ground, and the height of the single step up to the single, flat uninterrupted floor surface is no more than 180 mm.

Feature 3: Van with Single Uninterrupted Internal Floor from the Driver Seat Through to the Cargo Area, Sitting on a Low Level Chassis with a Battery Pack and with a Single Walk-in Step Up from the Ground to the Cargo Area

An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and there is a single internal or external step down to a lower area, or walk-in step or ramp that is in or adjacent to the cargo area, and the walk-in step or ramp is no more than 350 mm above the ground at its lowest point, and the height of the single step or ramp from that lowest point up to the single, flat uninterrupted floor surface is no more than 180 mm.

Feature 4: Van with Single Uninterrupted Internal Floor from Driver Seat Through to Cargo Area, Sitting on a Low Level Chassis with a Battery Pack and with the Single Uninterrupted Floor Continuing to a Raised Platform the Driver's Seat is Mounted on

An electric van with (i) a flat floor mounted on a chassis, and (ii) a battery pack or packs that is in, or part of, or mounted on, the chassis; and where the flat floor is a single, flat uninterrupted floor surface and is configured to provide a pathway that leads from the driver's seat, into and through a cargo area in the van;
and in which the driver's seat is mounted on a platform that is raised above the single, flat uninterrupted floor surface and that also provides a footrest for the driver whilst driving, and the footrest is configured so that the driver can pivot across or turn on the seat to put his or her feet on the uninterrupted floor surface and to then move up and out from the driver's seat to the passenger exit without any hindrance or obstruction from the footrest.

Feature 5: Van with a Low Level Chassis with Large Driver Cone of View

An electric van with (i) a flat floor mounted on a chassis, and (ii) a battery pack or packs that is in, or part of, or mounted on, the chassis; and where the flat floor is no more than 480 mm up from the ground;
and in which the bottom and top edges of the windscreen and the driver's seat are configured to give the driver a cone of view that is at least 45 degrees.

Feature 6: Van with a Low Level Chassis, with a Driver Seat Positioned at an Optimal Distance from the Front of the Van

An electric van with a platform configured to provide a single, flat uninterrupted floor surface and pathway from the driver's seat, into and through the length of a cargo area in the van;
and in which the driver's seat is mounted on a seat column and the top of that seat column is no more than 800 mm above the ground; and the driver's seat positions the driver's face between 2000 mm and 2400 mm from the front of the van.

Feature 7: Van with a Landscape Mode Touchscreen Positioned Above the Bottom Edge of the Dashboard

An electric van with a platform configured to provide a single, flat uninterrupted floor surface that extends from the driver cabin, into and through a cargo area in the van, and to the rearmost end of the cargo area, and a dashboard, a steering wheel mounted over the dashboard and a landscape format touchscreen that enables the driver to control vehicle functions, and to display navigation and routing information;
and in which the bottom edge of the landscape format touchscreen is positioned sufficiently above the bottom edge of the dashboard that a driver can approach the driver's seat from the passenger side and move his or her legs across to sit down in the driver's seat without any hindrance or obstruction from the touchscreen.

Feature 8: Vehicle with UWB Proximity Sensor that Provides Secure Vehicle Access

A vehicle access control system including a touch or proximity sensor (such as a capacitive touch sensor) integrated into an external or internal surface of the vehicle by each door to the vehicle and which controls the unlocking of a specific vehicle door, and not a general opening of all doors to the vehicle, only if (i) a wireless key approved for that vehicle is present sufficiently close to a sensor that is adjacent to that specific door and (ii) the sensor is manually activated by a driver's touch or proximity or specific gesture.

Feature 9: Steering Wheel with Integral Touch Pads

Vehicle with a steering wheel including one or more directional touch sensors integrated into the steering wheel and each including a substantially flat top surface configured to operate as a touch pad.

B. Arrival Van: Physical Construction Features

In the preceding section, we focused on features in the Arrival Van that improve driver ergonomics. The physical construction or structure of the Arrival Van also differs from the physical construction of a conventional diesel van too. We have noted earlier how the Arrival Van uses a low chassis or platform that incorporates the battery pack, and has a flat floor mounted on this platform. The Arrival Van (like other Arrival vehicles) has body panels (and other parts, such as roof panels, front and rear sections, dashboards, door trims) made from lightweight composites; light weight extruded aluminium struts are connected to the chassis, which is itself made up of long aluminium extrusions that provide the main structural components of the chassis. There is generally no welding to attach components; instead, mechanical fasteners and adhesives are used. The composite panels attach to these aluminium extrusions using a simple clip and fastener system designed for robotic manipulation and handling. The composite body panels are strong yet ductile, and should last a long time in the field and rarely need replacing; the panels will generally deform and return to their original shape after an impact that would permanently deform a similar steel panel. The panels can also be coloured to a Class A finish not just in a surface layer, but throughout multiple layers of the fabric structure; scratches and deformations that would normally fully penetrate a superficial paint surface are hence concealed, increasing the useable lifetime of the composite panels. Arrival's composite parts (e.g. body panels, doors, roller shutters, roofs) can be highly thermally insulating—especially useful for refrigerated vans. The Arrival system enables high performance automotive composite panels to be made rapidly and cheaply, doing away with the need for costly metal stamping presses and conventional painting setups.

The Arrival Van has unrivalled cargo capacity; this arises in part by positioning the bulkhead that separates the driver cabin from the cargo area closer to the front of the van than is possible in a conventional diesel van. The capacity and shape of the cargo area in the Arrival Van can be customised to a specific customer requirement by extending the length of longitudinal members that define sides of the platform; the height of the cargo area can be increased by extending the height of extruded aluminium structural pillars that are themselves attached to the platform and that composite body panels attach to. The cargo area can be equipped with shelves that are cantilever mounted on these structural side pillars, keeping the floor clear.

The Arrival Van is designed for easy daily or regular maintenance: a logistics company may run several hundred vans from a single large depot and the Arrival Van is designed to make regular checks on consumable fluids, such as coolant, brake fluid, and windshield cleaner, fast and easy: the Arrival Van has a hinged flap, which is opened by pushing down on the flap, and is positioned just below the windshield, located at waist height, and which enables just the levels of these consumable fluids to be checked easily and topped up, without the need to bend down.

The Arrival Van is optimised for fast and efficient robotic assembly: the robotic build process is essentially similar to the build process described for the Arrival Bus (see Section J), in that there is robotic assembly of a large number of identical components that join to one another in the same way, using the same fasteners; for example, the chassis or skateboard platform is made up of multiple longitudinal extruded aluminium sections of identical length, joined by a number of transverse extruded aluminium sections of identical length; large aluminium single piece wheel arch castings are used to mount the suspension components. Unlike the Arrival Bus, the Arrival Van is not however constructed by joining together a series of identical transverse chassis sections; instead, the Arrival Van is more like the Arrival Car (see Section K) in starting the Van production by assembling the two main longitudinal chassis beams that run the entire length of the skateboard platform. The Arrival Van also includes a self-contained drop-down window unit that forms part of the driver's side window; this can be easily robotically installed and is much simpler that installing a conventional electric window mechanism into a door.

The Arrival Van mounts the electric motors (and other drive train elements—i.e. the integrated drive unit) against the front two structural wheel arches, or all four wheel arches. Each wheel arch comprises a single, structural aluminium casting to which an independent suspension system is attached. This makes robotic assembly of the entire drive and suspension system much simpler than if the suspension system and motors were mounted on the chassis. And because there are no suspension rods running across the chassis, this means that the battery pack can continue past the axles if necessary; in any event, the low, flat floor can continue through the entire cargo area.

We can generalise to the following nine Arrival Van key features in this Group B:

Feature 10: Van with Lightweight Body Made from Composite Panels

An electric van with (i) a flat floor mounted on a chassis, and (ii) a battery pack or packs that is in, or part of, or mounted on, the chassis; and body panels made of composite material mounted on light weight extruded aluminium struts or members that are connected to the chassis.

Feature 11: Van with Composite Exterior and Interior Side Panels, Each with a Class A Surface

An electric van with composite exterior side panels, each with a Class A surface.

Feature 12: Van with Side Door In-Between Structural Pillars

An electric van in which the sides of a cargo area are formed using substantially straight, vertical structural pillars that are attached to the platform, with composite panels fitted between at least some of the structural pillars, and a cargo door is positioned between two of the vertical, structural pillars.

Feature 13: Van with Forward Bulkhead

An electric van with a platform configured to provide a single, flat uninterrupted floor surface and pathway from the driver's seat, into and through the length of a cargo area in the van; in which the floor surface is no more than 480 mm from the ground; and the bulkhead that separates the driver cab from the cargo area is no more than 2500 mm from the front of the van.

Feature 14: Van with Fully Customisable Cargo Area

An electric van in which the length of the cargo area defined by a customer for that van, determines, when the van is being automatically configured for production by an automated vehicle design tool, a required length for extruded aluminium longitudinal members that define the sides of the chassis or platform;
and the height of the cargo area defined by the customer determines, when the van is being automatically configured for production by the automated vehicle design tool, determines a required height of extruded aluminium structural pillars that are themselves attached to the chassis or platform.

Feature 15: Van with Shelves Cantilevered to Structural Pillars, and the Pillars are Fixed to the Chassis

An electric van with shelves fitted in a cargo area of the van, in which the shelves are mounted on cantilever arms and the cantilever arms are themselves fixed to vertical structural frames or pillars that form the structural skeleton of the sides of the cargo area and the vertical structural frames or pillars are themselves attached to a platform that provides a substantially flat floor for substantially the entire cargo area through which a driver passes in normal use when selecting and picking up packages that are stored on the shelves.

Feature 16: Van with Skylights

A electric van with roof panels made of composite material mounted on light weight extruded aluminium struts or members, and each including a central clear or transparent section configured to form part of a skylight running over some or all of the cargo area.

Feature 17: Vehicle with Service Hatch

A vehicle with a single region for all service connections for consumable fluids, such as coolant fluid, brake fluid, and windscreen cleaner fluid, and which is accessed by opening a hinged flap or other cover that is located at waist height or above.

Feature 18: Van with Independent Suspension System Mounted in Each Structural Wheel Arch

An electric van in which an independent suspension system is mounted directly to a structural wheel arch.

Feature 19: Van with Side Window Including a Drop-Down Glazing Unit

Van with side window including a drop-down glazing unit that is integrated within the side window.

C. Arrival Van: Automated Customer Configuration Using Vehicle Builder and Automated Production Using Robofactoring at a Microfactory

The Arrival Van can be readily customised to the specific requirements of a purchaser, typically a logistics or delivery company looking to buy a fleet of vans. Purchasers can have a broad spectrum of requirements for their van fleets, such as battery pack capacity, van length, van height, driver monitoring systems, ADAS etc. There are numerous variants of the Arrival Van: the walk-in-van (described above), and also a cargo van, a chassis cab van and a passenger van. There are three heights of vehicle: a 2.7 m, again built around that process of walking on and off the vehicle 200 times a day, a 2.4 m and then a sub 2 m metre roof height for customers that need vehicles in urban areas or that need to use multi storey car parks. There is a narrower version of the Van for cities with narrow streets. There are different lengths of Arrival Van: (a) an external length of approximately 5.1 m or less and configured to accommodate 3 standard size pallets on a flat floor; (b) an external length of approximately 5.5 m or less and configured to accommodate 4 standard size pallets on the flat floor; (c) an external length of approximately 5.8 m or less and configured to accommodate 4 standard size pallets on the flat floor; (d) an external length of approximately 6.6 m or less and configured to accommodate 5 standard size pallets on the flat floor.

Battery pack capacity can be especially useful to customise: a conventional electric van might have at best a choice of two different battery capacities: with the modular battery system used in Arrival vehicles, it becomes possible to offer far more choice (e.g. three, four, five or more different battery capacities for the Arrival Van); since the battery pack is the single most expensive item in the vehicle, being able to offer a broad range of potential battery packs is very useful, especially to a fleet customer providing logistics or package delivery services: these customers will know with a high degree of accuracy the range they need their vans to be able to cover on a single over-battery night charge, and provisioning vans with batteries that deliver significantly more than that range leads to vans that are unnecessarily heavy and costly. We have seen earlier how the Arrival HVBM system (see Section G) enables increments of battery capacity that can be as low as 3.7 kWh (corresponding to the capacity of a single battery module, the autonomous HVBM), although in practice HVBM-based battery packs are likely to be produced in variants such as a 12 module pack, 20 module pack, a 30 module pack and a 36 module pack (with capacity ranging from 44 kWh to 133 kWh).

So a fleet operator may decide that the optimal mix is for 60% of the fleet to use the 20 module pack (giving a 100 km to 120 km range), and for 40% of the fleet to use a 30 module pack (giving a 150 km to 180 km range), and for there to be no need for any vans to have a 36 module pack (giving a 200 km to 240 km range), but if some longer range routes do need to be served, then the battery packs in some vans can be altered, in a service facility, by adding in new battery modules to the pack, e.g. so that it becomes a 36 module battery pack. The van, once built, is hence not permanently limited to using only the battery modules that it was factory provisioned with, but can be modified by adding in further modules (or taking away some battery modules). The modified battery pack will immediately work with existing van systems; this exemplifies the hardware modularity of the Arrival system (described in Section A) and the Arrival ‘plug and play’ functionality (described in Section B).

The Arrival software-based and highly automated vehicle design system (Vehicle Builder—see Section D) is in any event flexible enough to automatically configure the layout and all power/data connections required for different factory-built configurations. Robofacturing and Microfactories (See Section F) are flexible enough to put into production a wide range of different vehicle types without requiring re-organisation or re-tooling; efficient customisation to meet a purchaser's exact requirements is therefore possible. The highly modular Arrival system therefore offers far greater flexibility than earlier systems in enabling the specific van configuration needs of customers to be met. With the highly modular Arrival system, it becomes straightforward to design and produce even relatively low volumes of vans that have configurations that are optimal for the specific requirements of customers.

We can generalise to the following six key features in this Group C:

Feature 20: Vehicle with Customer-Specified Battery Capacity

An electric vehicle design and production process, the vehicle including multiple batteries;
in which a customer specifies the battery capacity or range required for a specific new vehicle or fleet of vehicles, and an automated vehicle design tool then automatically selects battery-related components required for the specified battery capacity or range; and automatically generates build instructions for that vehicle or fleet of vehicles;
and a robotic production environment then automatically builds or assembles the vehicle as designed by the automated vehicle design tool, including a battery pack that meets the specified battery capacity or range.

Feature 21: Vehicle with Integrated, Customer-Specified Sensors

An electric vehicle design and production process, the vehicle including multiple sensor based systems, such as ADAS, LIDAR, computer vision based driver monitoring, computer vision based cargo monitoring, load or weight sensors;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicle as designed by the automated vehicle design tool, integrating the sensor based systems into the vehicle.

Feature 22: Van with Configurable Cargo Area

An electric van design and production process, the van including a cargo area;
in which a customer specifies the requirements for the cargo area; and an automated vehicle design tool then automatically selects components required for that specification; and automatically generates build instructions for that van or fleet of vans;
and a robotic production environment then automatically builds or assembles the vehicle as designed by the automated vehicle design tool, including a cargo area that meets that specification.

Feature 23: Robotic, Cell Based Production

A method of producing a vehicle, in which a robotic production environment assembles, at a fixed location and not a moving production line, at least the chassis, composite body panels and supporting structures for those panels using instructions generated by an automated vehicle design tool from a customer specification for that vehicle.

Feature 24: The Microfactory

A vehicle production factory comprising a number of robotic production cells for vehicle production, each cell comprising a group of robots that are programmed to assemble, at a fixed location and not a moving production line, at least the chassis, composite body panels and supporting structures for those panels using instructions generated by an automated vehicle design from a customer specification for that vehicle.

Feature 25: Post Production Change to a Different Battery Pack Capacity

An electric vehicle with an original factory-installed battery pack, including multiple battery modules, with a specific battery capacity;
in which the vehicle is configured to enable the original battery pack to be altered by adding one or more further battery modules to the battery pack, or removing one or more battery modules from the battery pack.

Feature 26: Post Production Update of Integrated, Customer-Specified Sensors

An electric vehicle with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the vehicle's data and security network and systems.

### BRIEF SUMMARY OF THE FIGURES RELATING TO THIS SECTION I

Some implementations of the Arrival Van are shown in the accompanying figures, in which:

FIG. 86 shows a perspective view of the Arrival Van.

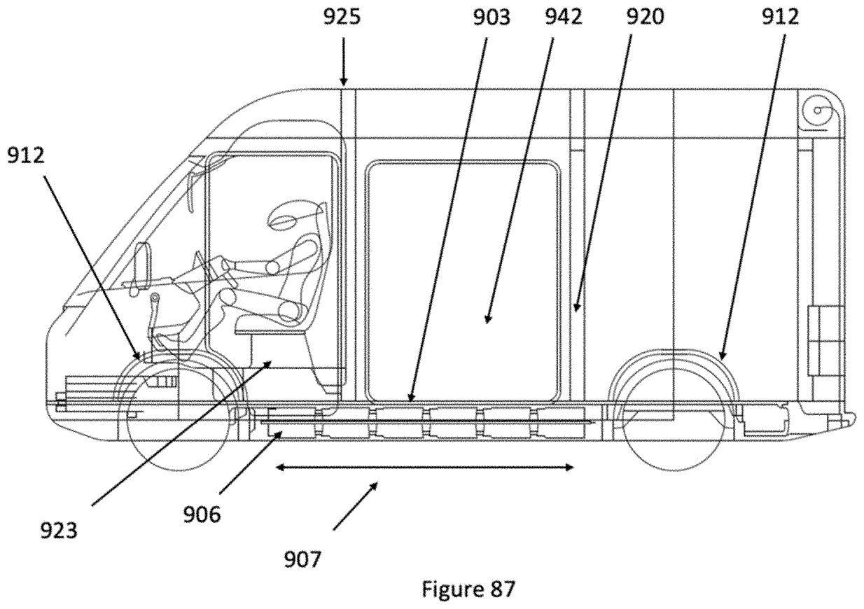

FIG. 87 shows a cross-sectional view through the entire Van.

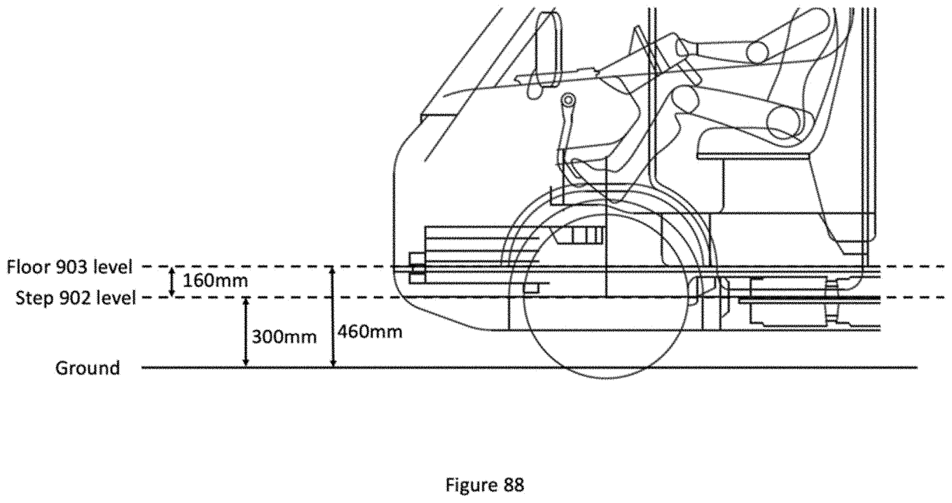

FIG. 88 shows a cross-sectional view through the front of the Van, showing the heights off the ground from the internal flat floor and the single step

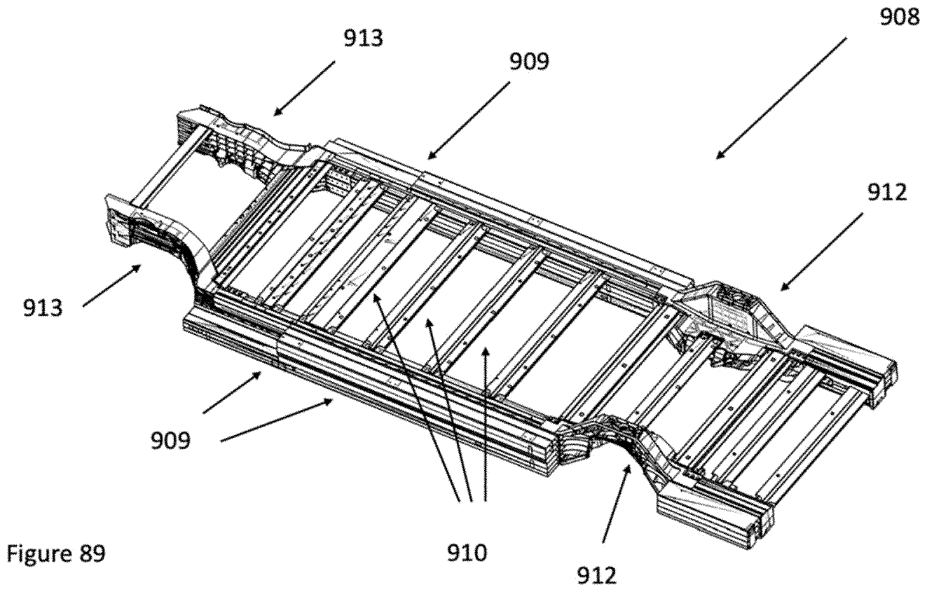

FIG. 89 shows the structural chassis

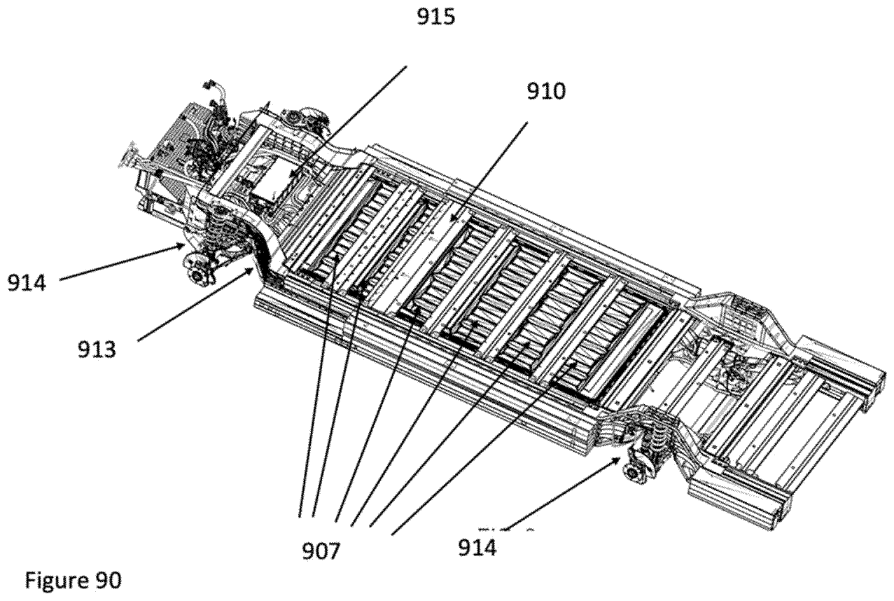

FIG. 90 shows the structural chassis, with battery modules and other components

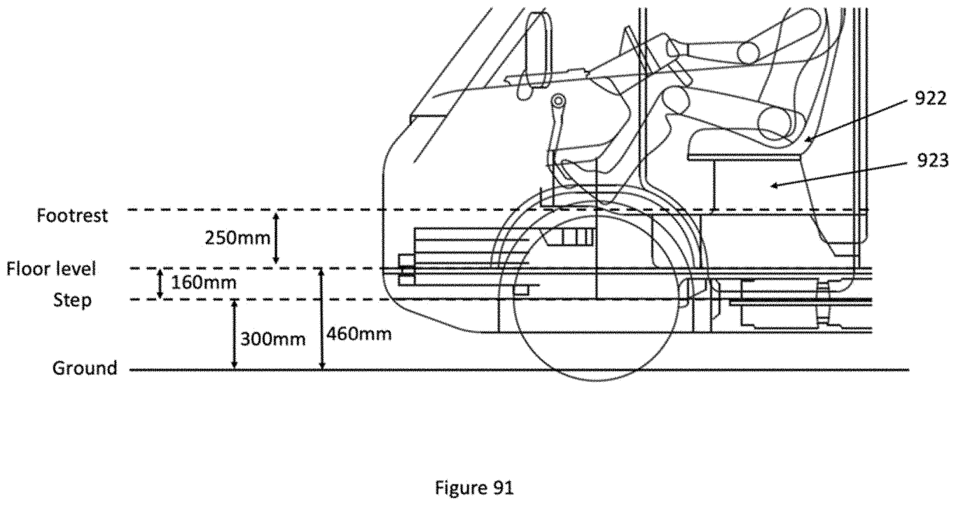

FIG. 91 shows a cross-sectional view through the front of the Van, including the footrest height above the internal flat floor

FIG. 92 shows the internal flat floor and footrest in the driver cabin

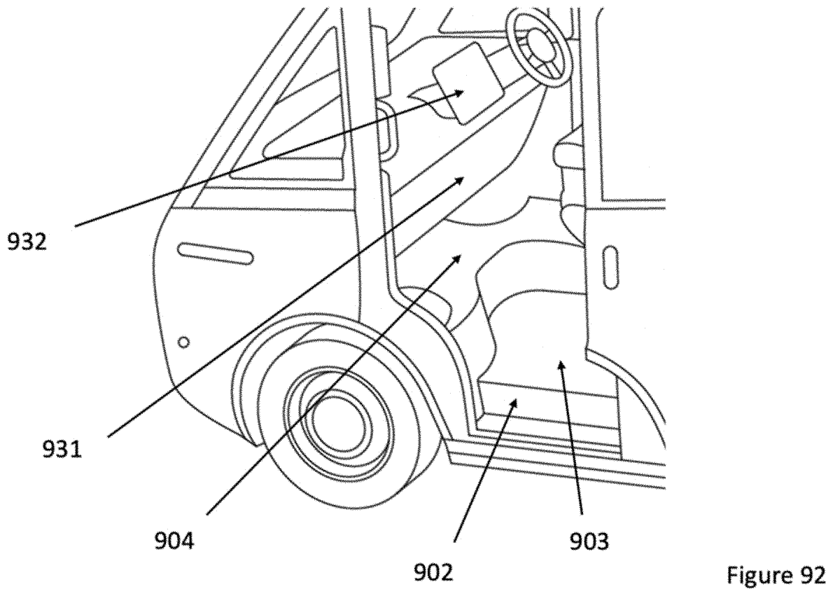

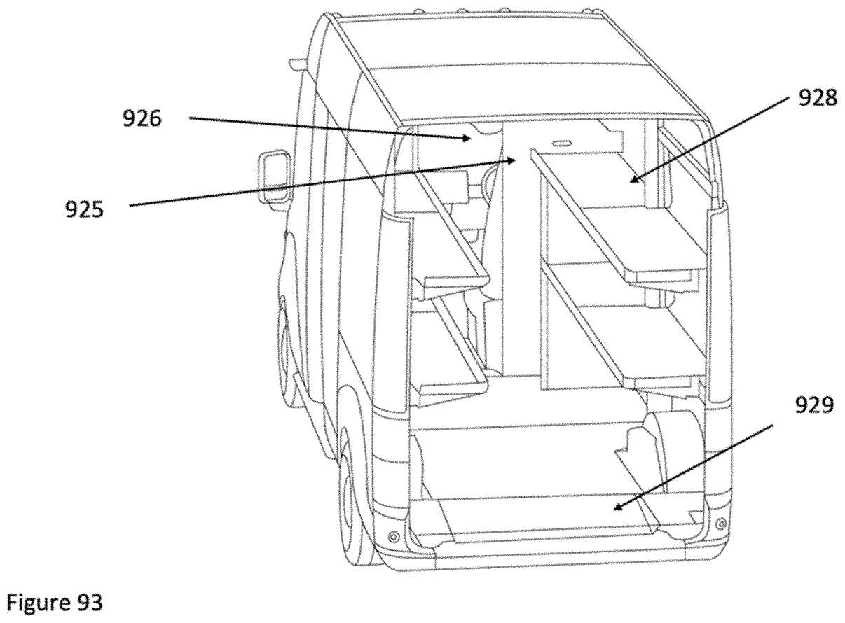

FIG. 93 shows a view into the open, rear of the van

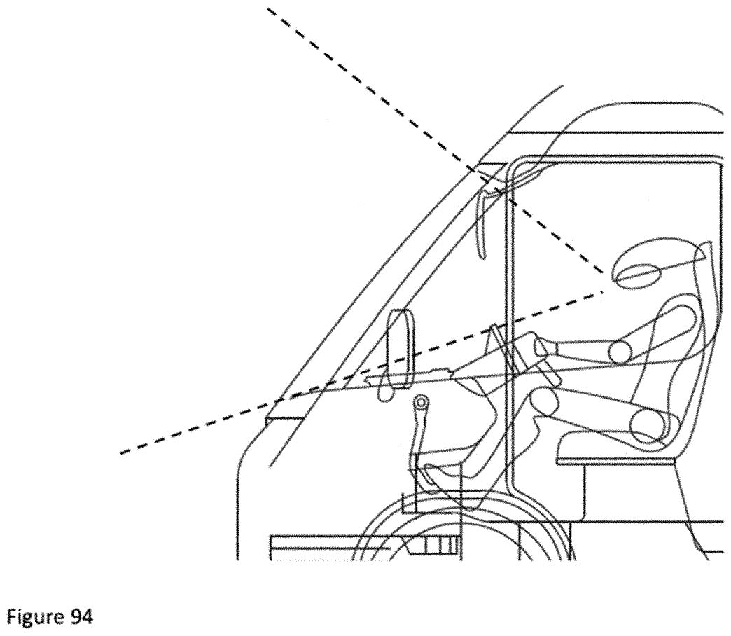

FIG. 94 shows the large field of view for the driver

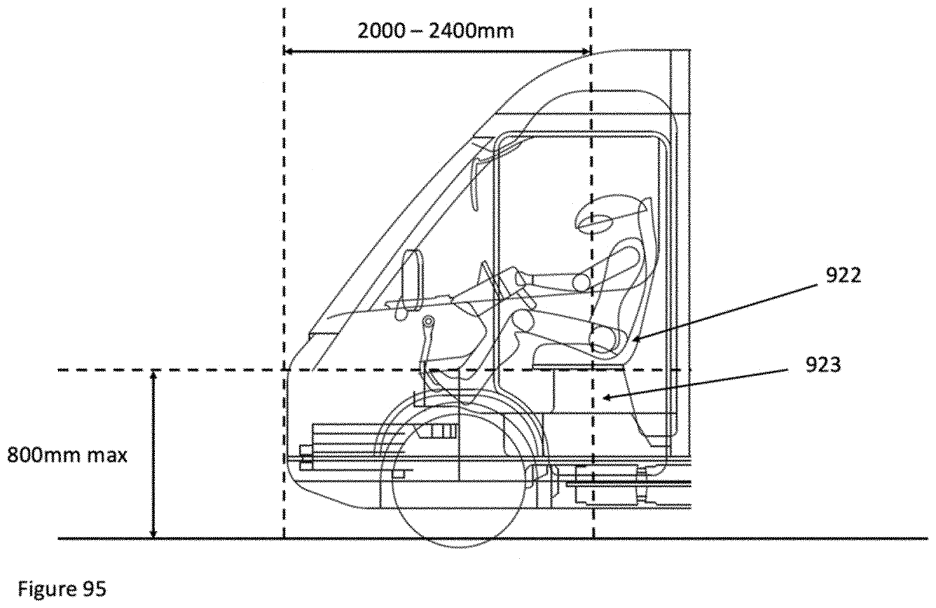

FIG. 95 shows the position of the driver in relation to the front of the van

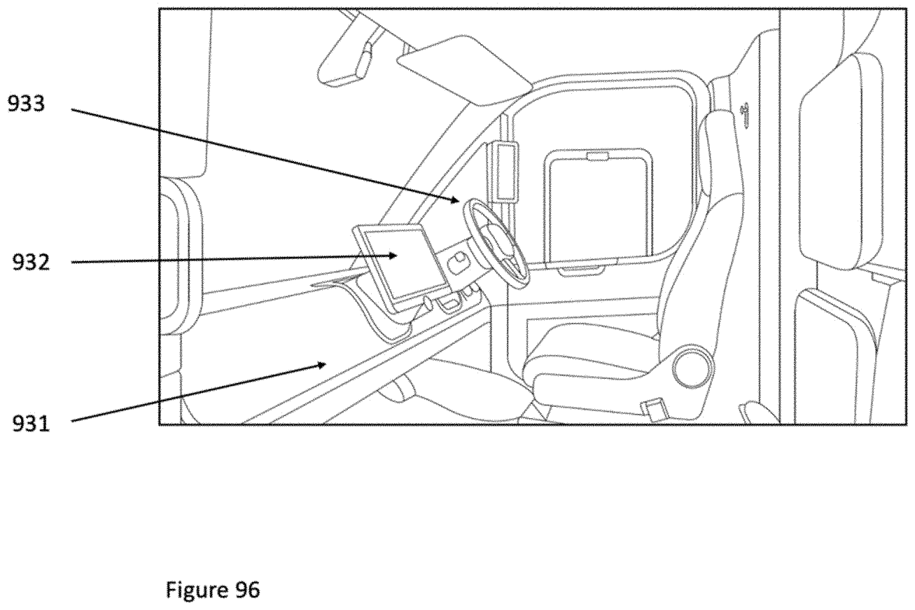

FIG. 96 shows the dashboard and display screen in the driver's cabin

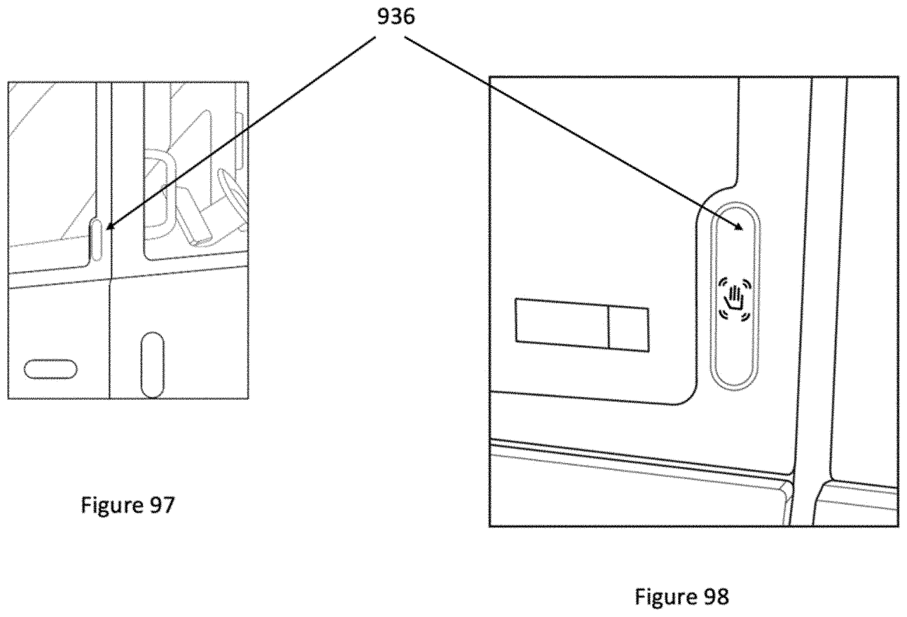

FIG. 97 and FIG. 98 shows the touch sensor

FIG. 99 shows the touchpads on the steering wheel

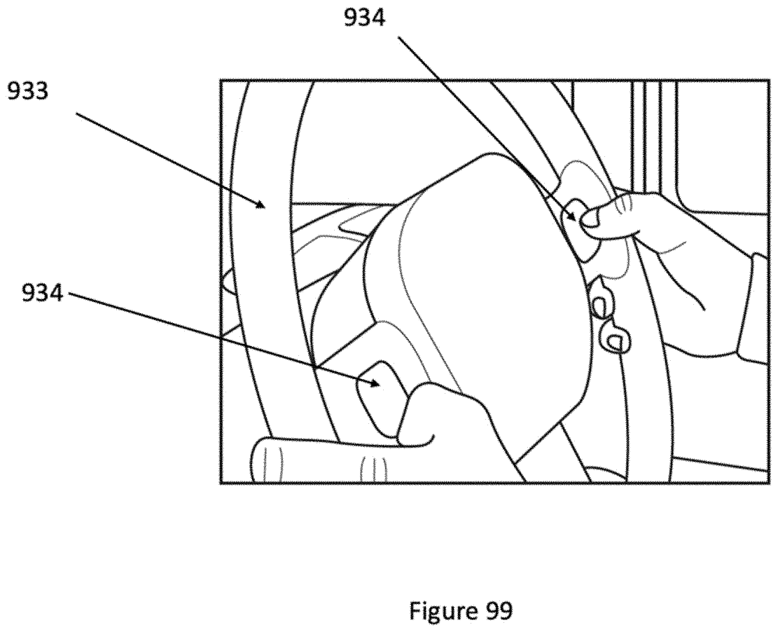

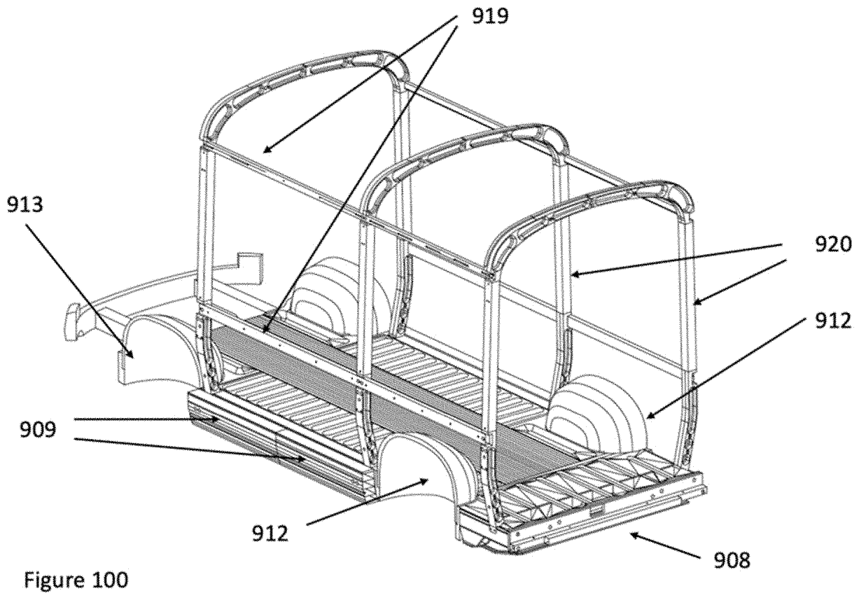

FIG. 100 shows the structural hoops that make up the superstructure, mounted on the chassis or platform

FIG. 101 shows the van with its composite panels

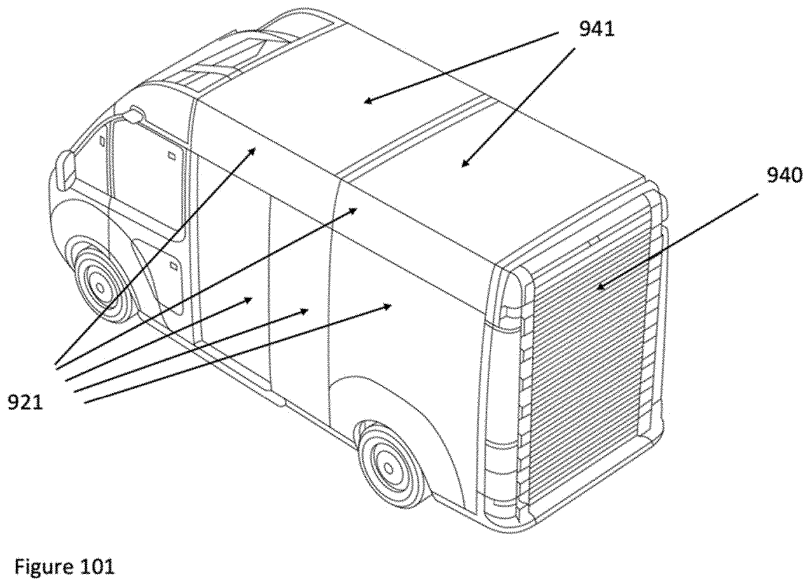

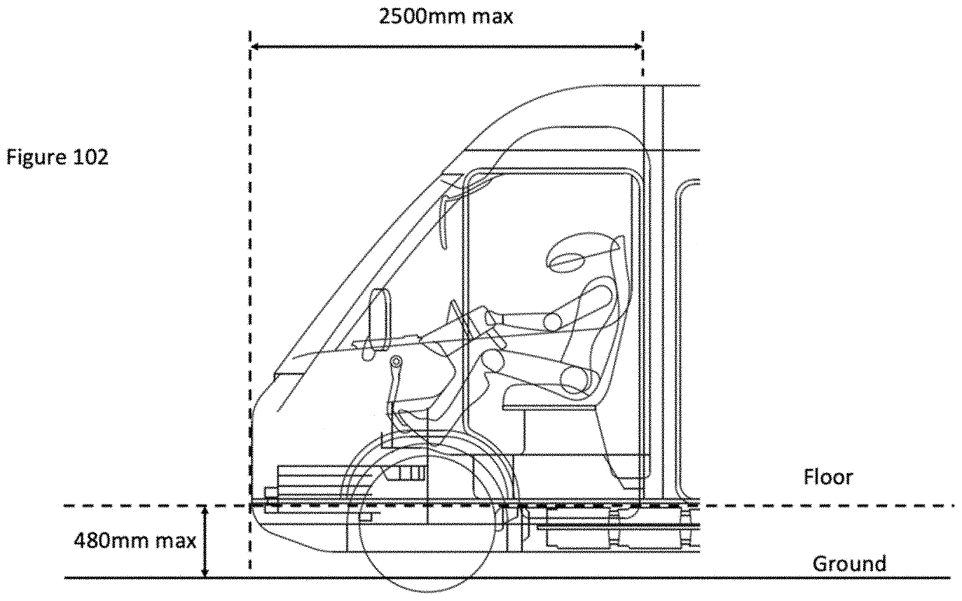

FIG. 102 shows a cross-sectional view through the front of the Van, including the front bulkhead

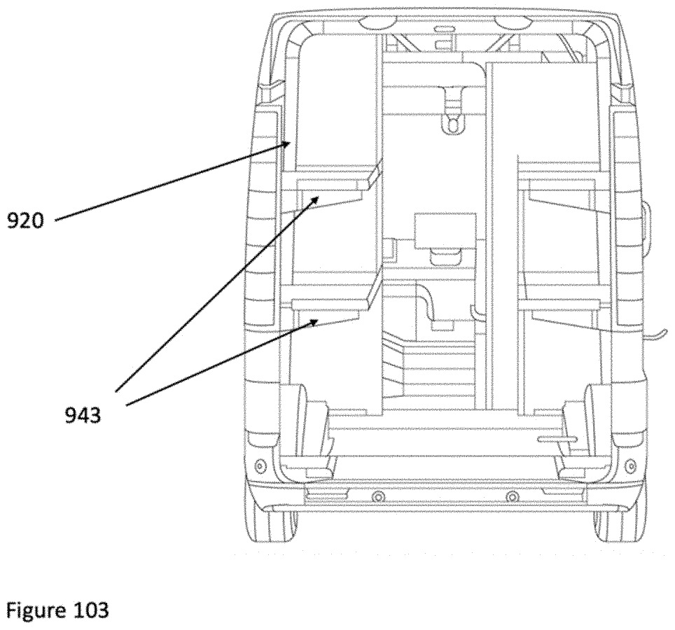

FIG. 103 shows the cantilevered shelf supports in the van cargo area

FIG. 104 shows the hinged service hatch

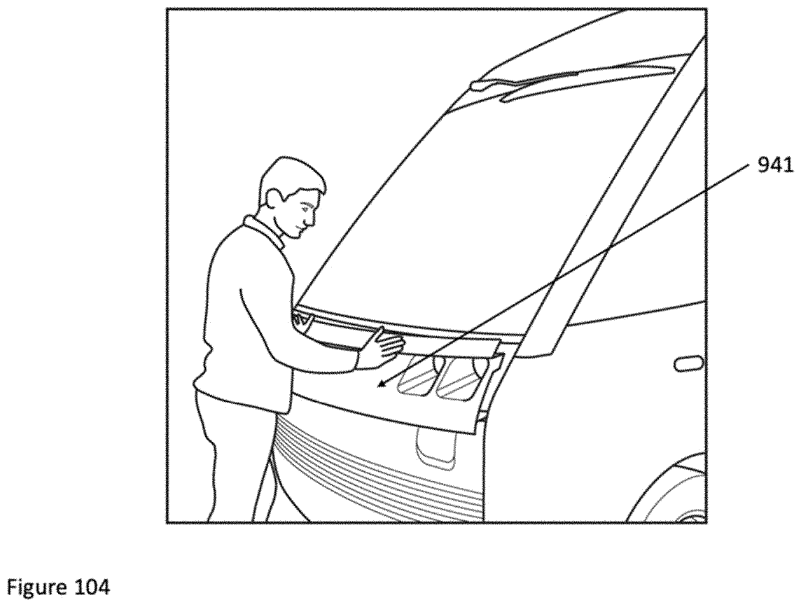

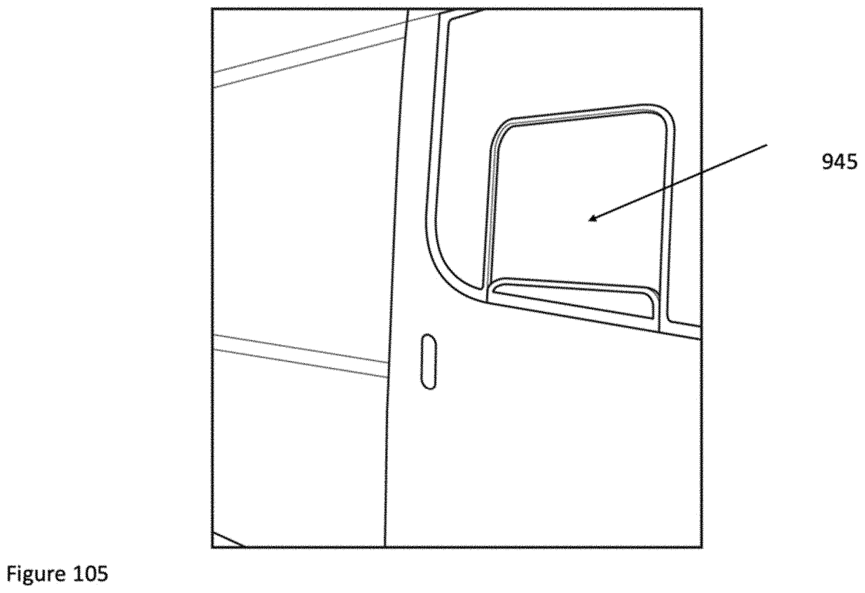

FIG. 105 shows the integrated drop-down window

### FIGS. 86-105 Index

| Reference | |
|---|---|
| numeral | Description of item |
| 900 | Van (right hand drive, walk-in van variant) |
| 901 | Sliding door |
| 902 | single step |
| 903 | single, level flat floor |
| 904 | footrest |
| 906 | battery module |
| 907 | battery pack in chassis |
| 908 | low level skateboard platform of chassis |
| 909 | extruded aluminium longitudinal chassis sections (main) |
| 910 | extruded aluminium transverse chassis sections |
| 911 | extruded aluminium longitudinal chassis sections (rear) |
| 912 | single large aluminium cast rear wheel arch |
| 913 | single large aluminium cast front wheel support |
| 914 | suspension system |
| 915 | drive unit |
| 919 | horizontal aluminium struts or superstructure |
| 920 | vertical aluminium struts or superstructure |
| 921 | composite body panel |
| 922 | driver's seat |
| 923 | driver's seat column |
| 925 | forward bulkhead between driver cabin and cargo area |
| 926 | opening in forward bulkhead |
| 928 | cargo area |
| 929 | ramp at back of cargo area |
| 931 | dashboard |
| 932 | landscape format touchscreen |
| 933 | steering wheel |
| 934 | steering wheel touchpads |
| 936 | touch sensor |
| 940 | rear roller shutter door |
| 941 | semi- translucent composite roof panel |
| 942 | Side access door |
| 943 | Cantilever supports for shelves |
| 944 | hinged service hatch |
| 945 | drop-down glazing unit |

### DETAILED DESCRIPTION FOR THIS SECTION I

We will now look at each of these features in more depth.

A. Arrival Van: Driver Ergonomic Features

Feature 1: Van with Single Uninterrupted Internal Floor from Driver Seat Through to Cargo Area, Sitting on a Low Level Chassis with Battery Pack

We have described above the considerable physical challenges facing drivers of conventional delivery vans; even quite simple improvements in van design can make a considerable difference to drivers. The Arrival van includes a single, flat uninterrupted floor surface and pathway that leads from the driver's seat, into and through the length of a cargo area in the van. The single, flat uninterrupted floor surface enables us not only to get more cargo capacity given the length of a vehicle compared with other competitors, but also to make sure that the user experience of getting on and off and moving from the driver's seat into the cargo area and back again is as seamless as possible.

The driver no longer needs to wait for a gap in the traffic, open the driver's door, step down several steps, walk around the van and then walk up several steps, open the van door and then enter the cargo area. Instead, there is a flat, fast and safe path directly from the driver's cabin into the cargo area using a floor surface mounted on the flat skateboard platform described earlier.

By using the flat top of the skateboard platform in this way, production is greatly simplified: a conventional box truck delivery van might on the other hand use a chassis, and then mount a flat platform onto the chassis to form the base of the cargo area, and then create a floor over this platform. That is far more complex and costly. Further, it leads to the cargo floor typically being mounted at least 600 mm above the ground to accommodate the drivetrain, meaning that the driver has to climb down several steps when leaving the van, and climb back up several steps—repeating that process 300 times a day is naturally tiring.

But the Arrival van has a low skateboard platform, so that floor surface is usually approximately 460 mm from the ground (and generally no more than about 480 mm from the ground) making it much easier for the driver to enter and leave the van—and approximately 200 mm lower than a conventional diesel van. Ground clearance of the van is approximately 180 mm, so is not compromised.

The Arrival Van resolves two competing and contradictory requirements: for a chassis to have sufficient ground clearance, yet to support an internal floor that is very close to the ground, and that also includes a battery pack. This approach prioritises driver ergonomics and also, because the centre of gravity of the Arrival Van is much lower than a conventional diesel van, leads to better handling.

FIG. 86 shows a perspective view of the Arrival Van 900. Through opened sliding door 901 we can see a single, low step 902 into the van and then a flat floor 903 in the driver cabin running up to the driver's seat; that flat floor 903 continues through to the cargo area of the van. To the front of the flat floor 903 is a footrest 904 that the driver rests his feet on when driving; this foot rest runs the width of the driver cabin (FIG. 92 shows the footrest in more detail). Above the footrest is a full width dashboard 931; note that the space under the dashboard 931 is completely clear, making driver access and exit fast and safe. On the dashboard is mounted a wide touchscreen display 932.

FIG. 87 is a cross-section view of the Arrival Van 900, showing a battery pack 907 made up of a double height grid of battery modules (such as the HVBM units described in Section G) sitting in low-level skateboard platform or chassis 908, which will be described in more detail in FIG. 88 and FIG. 89. One of the reasons the skateboard platform or chassis 908 can sit low to the ground is that the top of the suspension mounts are higher than the top of the skateboard platform or chassis 908; this is achieved by using a large, aluminium structural casting 912 for each wheel arches or supports and rigidly attaching those castings to the skateboard platform or chassis 908, and then positioning the suspension mounts at the top of these castings. That way, we have a simple and rigid way of securing the suspension units to the chassis that is well suited to robotic production steps, but that enables the chassis to be lower to the ground than is normally possible. The same approach is used in the Arrival Bus to give that vehicle a very low height passenger floor; reference may be made to the more detailed description of the structural wheel arches in the Arrival Bus (see Section J).

FIG. 88 shows the relevant heights measured up from the ground: the single internal floor 903 that extends from the driver cabin through to the cargo area is approximately 460 mm up from the ground. The single step 902 is approximately 300 mm up from the ground. So a driver has to step up approximately 300 mm, which is about the same as two normal domestic steps, and then step up approximately a further 160 mm, which is about the same as a single domestic step. The aim here is to make this process feel as natural, easy and familiar as possible, to minimise driver strain and reduce the risk of accidents.

We have talked in the preceding paragraph about the low-level skateboard platform or chassis 908: FIG. 89 and FIG. 90 shows this in more detail. FIG. 89 shows the structural components; in FIG. 89, battery modules, wheel hubs, suspension units, and the drive units are added. In FIG. 89, we see that the chassis is made of a number of extruded aluminium longitudinal chassis sections 909 defining the two longs sides of the chassis; these two side beams are joined using a number of extruded aluminium transverse chassis sections 910. A pair of structural cast aluminium rear wheel arches 912 is fitted at one end of the extruded aluminium longitudinal chassis sections 909 and a final rear extruded aluminium longitudinal chassis section 911 added. At the front of the van, we have a pair of single large cast aluminium front wheel supports 913. Drive units 915 (each with an inverter, motor and drive shaft) are attached under each support.

FIG. 90 shows how the battery pack 907 sits under the extruded aluminium transverse chassis sections 910, and how drive units 915 sit between and under the front wheel supports 913, with suspension units 914 attached to the front wheel supports 913 and rear wheel arches 912. The entire chassis is designed for robotic production, based on repetitively handling and assembling a number of identical components: for example, the extruded aluminium transverse chassis sections 910 are largely identical; the extruded aluminium longitudinal chassis sections 909 are constructed from layers of identical extrusions. This approach leads to flexibility: for example, if a narrower van is needed, then that requires using shorter extruded aluminium transverse chassis sections 910, but the overall production process remains unchanged; a longer van requires extruded aluminium longitudinal chassis sections 909, and again the overall production process remains unchanged. So an Arrival microfactory can readily switch between production of different van or indeed vehicle types (since all Arrival vehicles are built using essentially the same structural components, using essentially the same robotic production process); similarly, an Arrival microfactory could be making Arrival Vans and Buses etc at the same time, using the same robotic production cells.

Returning now to the detail of Arrival Van, FIG. 91 shows how the driver rests their feet whilst driving on a footrest 904 that runs the full width of the driver cabin; it can be seen in FIG. 92. The brake and accelerator pedals are mounted in a footwell above footrest 904. The footrest 904 sits approximately 250 mm-260 mm above the single, flat uninterrupted floor surface 903, so the driver can readily and rapidly swivel or pivot in the driver's seat and place their feet on the flat, uninterrupted floor surface 903 and stand up. When that action is repeated 300 times a day, saving even a second on this action is surprisingly beneficial.

The footrest extends to under the driver's seat 922 and supports a driver's seat column 923 that enables the driver's seat 922 to be positioned to give the driver good visibility over the road ahead.

The single, flat uninterrupted floor surface 903 has a surface configured for cleaning; because it is flat and uninterrupted, running all the way through to the whole of the cargo area, cleaning the entire van is made faster easier.

The walk-in variant of the van provides standing height above the floor surface 903 of at least 2200 mm, so that a typical driver can stand up in the drivers cabin, on the flat uninterrupted floor surface 903, and then walk through an opening 926 in the forward bulkhead 925 into and through to the rear of the cargo area 928, without bending down (see FIG. 93). The van includes driver doors and a side door for the cargo area, the side door being approximately 1700 mm high and 1350 mm wide, again giving fast and easy entry and exit. It includes a full width roller door at the rear of the van.

We can generalise to:

An electric van with (i) a flat floor mounted on a chassis, and (ii) a battery pack or packs that is in, or part of, or mounted on, the chassis; and where the flat floor is a single, flat uninterrupted floor surface that is no more than 480 mm up from the ground and is configured to provide a pathway that leads from the driver's seat, into and through a cargo area in the van.

Optional Sub-Features:
single, flat uninterrupted floor surface covers substantially the entire cargo area through which a driver passes in normal use when selecting and picking up packages that are stored in the cargo area
single, flat uninterrupted floor surface continues to an internal step that leads to a rear door
single, flat uninterrupted floor surface continues to a rear door
skateboard platform includes multiple battery modules, such as HVBMs
floor surface is approximately 460 mm from the ground
the ground clearance of the van is approximately 180 mm
driver's footrest is approximately 250 mm-260 mm above the single, flat uninterrupted floor surface.
the driver's seat raised platform extends into a footwell and the brake and accelerator pedals are mounted above the raised platform
floor surface has a surface configured for cleaning
height of the van above the floor surface is at least 2200 mm so that a typical driver can walk through the driver's cabin into and through the cargo area, without bending down.
the van includes driver doors and a side door for the cargo area, the side door being approximately 1700 mm high and 1350 mm wide.
side and roof panels are made from lightweight composites
the van is at least in part configured using an automated vehicle design tool that automatically selects components required for a customer's specification; and automatically generates build instructions for that van or fleet of vans;
the van is produced in a microfactory

Feature 2: Van with Single Uninterrupted Internal Floor from the Driver Seat Through to the Cargo Area, Sitting on a Low Level Chassis with Battery Pack and with a Single Walk-in Step Up from the Ground to the Driver Cab

We have seen above that the low skateboard platform is inherently easier to climb down from and enter. Because the main internal surface 903 in the Arrival Van is so close to the ground (and much closer to the ground than a conventional diesel van), the Arrival van includes just a single walk-in step 902: the driver steps up approximately 300 mm from the ground to reach this walk-in step, which is approximately 650 mm wide. From this walk-in step, the main internal floor surface of the van is just approximately another 160 mm step up, as shown in FIG. 88.

This is considerably easier for drivers than in current vehicles; a typical box van with a chassis typically has at least two internal steps, so the driver has to take a large first step up from the ground to the first step, then walk up two steps: with the Arrival van, the driver makes only one relatively small step up (i.e. about 300 mm, as noted above) from the ground to the single walk-in-step in the driver cabin, and then an even smaller step up (i.e. about 160 mm) into the main flat surface of the van. That motion is faster, less tiring, and less likely to lead to slips or accidents than the equivalent motion in a typical box truck. Once standing on the single, flat uninterrupted surface that extends into the main cargo area, the driver can also readily move into that cargo area, and also easily and rapidly move across to the driver's seat and sit down.

Perhaps surprisingly, professional van drivers for some logistics companies are taught simplified, precisely choreographed movements that enable them to enter their truck and sit on the driver's seat safely and quickly; if this movement sequence saves just 1 second from a non-choreographed sequence, that can make a real difference over a typical day with 300 stops; the Arrival van enables even greater savings in time and muscle effort.

We can generalise to:

An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and where the driver cabin includes a single internal step down to a lower area, or walk-in step, that is adjacent to a door to the driver cabin, and the walk-in step is no more than approximately 350 mm above the ground, and the height of the single step is no more than approximately 180 mm.

Optional Sub-Features:
single, flat uninterrupted floor surface covers substantially the entire cargo area through which a driver passes in normal use when selecting and picking up packages that are stored in the cargo area
single, flat uninterrupted floor surface continues to an internal step that leads to a rear door
single, flat uninterrupted floor surface continues to a rear door
the walk-in step is approximately 300 mm above the ground
the height of the single step is approximately 160 mm
the lower area, or walk-in step, is approximately 650 mm wide
single, flat uninterrupted floor surface covers substantially the entire cargo area through which a driver passes in normal use when selecting and picking up packages that are stored in the cargo area
driver's footrest is approximately 250 mm-260 mm above the single, flat uninterrupted floor surface.
floor surface is approximately 460 mm from the ground
floor surface is no more than approximately 480 mm from the ground
the driver's seat raised platform extends into a footwell and the brake and accelerator pedals are mounted above the raised platform
skateboard platform includes multiple battery modules, such as HVBMs.
floor surface has a surface configured for cleaning

Feature 3: Van with Single Uninterrupted Internal Floor from the Driver Seat Through to the Cargo Area, Sitting on a Low Level Chassis with Battery Pack and with a Single Walk-in Step Up from the Ground to the Cargo Area

We have discussed earlier in this section how important it is to make the process of entering and exiting the driver's cabin as fast and efficient as possible. The same applies to entering and exiting the cargo area from the rear exit of the van; making entry and exit as fast, easy and safe as possible is especially important since the driver will generally be carrying packages or moving a trolley out of the van. The Arrival van uses a low skateboard platform with a floor surface that is approximately 460 mm from the ground; at the rear of the van, by a full height rear exit (e.g. with a roller shutter door), there is an internal, single step down or ramp 929 (see FIG. 93) from the cargo area of approximately 160 mm in height that leads to a stair tread or surface by the exit, so the driver, when leaving the van, first steps or moves down approximately 160 mm from the main floor surface to the internal tread or surface and then takes a further step out of the van and down approximately 300 mm to the ground. This sequence is faster and less strenuous than the three or more steps required for a conventional box van. In this variant, the low, flat internal floor 903 continues from the driver cabin, through the cargo area 928, and ends only at the start of the internal step or ramp 929. The lower area or walk-in step 929 could also be external: then, the flat floor continues to the rear door itself.

We can generalise to:

An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and there is a single internal or external step down to a lower area, or walk-in step or ramp that is in or adjacent to the cargo area, and the walk-in step or ramp is no more than approximately 350 mm above the ground at its lowest point, and the height of the single step or ramp from that lowest point up to the single, flat uninterrupted floor surface is no more than approximately 180 mm.

Optional Sub-Features:
single, flat uninterrupted floor surface covers substantially the entire cargo area through which a driver passes in normal use when selecting and picking up packages that are stored in the cargo area
single, flat uninterrupted floor surface continues to an internal step that leads to a rear door
single, flat uninterrupted floor surface continues to a rear door
the internal step down is no more than 200 mm in height
the internal step down is approximately 160 mm in height
the internal step down lies beyond one end of the skateboard platform
a roller door covers the full height exit
stair tread or surface is at the base of a full height exit from the rear of the van.
floor surface is approximately 460 mm from the ground
floor surface is no more than 480 mm from the ground

Feature 4: Van with Single Uninterrupted Internal Floor from Driver Seat Through to Cargo Area, Sitting on a Low Level Chassis with a Battery Pack and with the Single Uninterrupted Floor Continuing to a Raised Platform the Driver's Seat is Mounted on

We have seen above how the Arrival van makes it easier for the driver to enter the driver's cabin from the road and to reach the driver's seat, and how valuable it can be to reduce the time taken for this process and to make it a simple, choreographed sequence of efficient movement. In the Arrival van, there is an extended footrest 904 (see FIG. 92) that runs uninterrupted across the width of the driver cabin; the footrest 904 is higher than the single, flat uninterrupted floor surface 903, so that on entering the driver cabin, the driver can readily walk along this single, flat uninterrupted floor surface 903 and does not have to be concerned with avoiding the normal obstructions you find—in the Arrival van, there is no handbrake or gear shift or dashboard with ventilation/radio/display etc that typically protruded the floor of the driver's cabin. Instead, the shape and position of the extended footrest 904 enables a driver to rapidly step across the flat floor 903 of the cabin and sit down on the driver's seat, and then pivot around, with legs moving up and onto the extended footrest without any hindrance or obstruction. The footwell that sits over the extended footrest 904 is substantially flat and includes no features or obstructions, other than the accelerator and brake pedal; it can be readily accessed and cleaned.

The driver's seat 922 sits on a column 923 (see FIG. 91); that column 923 is part of a raised platform that extends from under the driver's seat and continues to the footrest 904; the drivers feet hence rest on the extended footrest 904, and not on the main flat, uninterrupted floor surface 903: the top of the footrest 904 is approximately 250 mm-260 mm above the single, flat uninterrupted floor surface 903. This enables the driver's position to be raised, given better visibility through the side windows and windscreen.

We can generalise to:

An electric van with (i) a flat floor mounted on a chassis, and (ii) a battery pack or packs that is in, or part of, or mounted on, the chassis; and where the flat floor is a single, flat uninterrupted floor surface and is configured to provide a pathway that leads from the driver's seat, into and through a cargo area in the van;
and in which the driver's seat is mounted on a platform that is raised above the single, flat uninterrupted floor surface and that also provides a footrest for the driver whilst driving, and the footrest is configured so that the driver can pivot across or turn on the seat to put his or her feet on the uninterrupted floor surface and to then move up and out from the driver's seat to the passenger exit without any hindrance or obstruction from the footrest.

Optional Sub-Features:
the rear surface of the footwell is substantially flat or includes no features or obstructions, other than the accelerator and brake pedal.
footwell runs uninterrupted across the width of the driver cabin to a raised platform;
and an accelerator and a brake pedal is mounted in the footwell.
there is no handbrake or gear shift or bulkhead protruding into the footwell.
a dashboard or runs across the width of the driver cabin, lying over the footwell
the dashboard has a substantially flat surface facing into the driver cabin
the dashboard has a substantially flat and straight surface facing into the driver cabin
the dashboard includes or has mounted on it a rectangular touch screen display that shows normal van operational data, such as speed, range, sat nav with route guidance, and also integrates all driver work or task information, such as information on packages to be delivered, whether the delivery schedule is being met, voice call or text function to let package recipients know when the driver will deliver their package, reporting delays in delivering packages to recipients and to a central office.
raised platform includes a seat post on which the driver's seat is mounted
driver's footrest is approximately 250 mm-260 mm above the single, flat uninterrupted floor surface.
skateboard platform provides a substantially flat floor for substantially the entire cargo area through which a driver passes in normal use when selecting and picking up packages that are stored in the cargo area
skateboard platform includes multiple battery modules, such as HVBMs.
floor surface is approximately 460 mm from the ground
floor surface is no more than 480 mm from the ground
floor surface has a surface configured for cleaning

Feature 5: Van with a Low Level Chassis with Large Driver Cone of View

In the Arrival van, the driver has exceptionally good forward visibility with a very large cone of view of at least 45 degrees, as shown in FIG. 94. This is due to the driver sitting much closer to the front of the van, as shown in FIG. 95: the driver's seat positions the driver's face approximately 2200 mm from the front of the van. In addition, the base of the windscreen is much closer to the ground, compared to a conventional diesel van: approximately 1100 mm from the ground and much closer to the front of the van: approximately 125 mm. This gives much better ‘down vision’ for the driver—in particular, in a typical diesel van, the drive can see a small child of 1 m height only if that child is further than approximately 1400 mm from the front of the van; any closer, and the small child cannot be seen. But in the Arrival Van, because of the enhanced down vision, a 1 m tall child can be seen as close as 730 mm to the Van. These features are in turn made possible because the Arrival van is an EV that uses a low skateboard platform.

We can generalise to:

An electric van with (i) a flat floor mounted on a chassis, and (ii) a battery pack or packs that is in, or part of, or mounted on, the chassis; and where the flat floor is no more than approximately 480 mm up from the ground;
and in which the bottom and top edges of the windscreen and the driver's seat are configured to give the driver a cone of view that is at least 45 degrees.

Optional Sub-Features:
the driver's seat positions the driver's face approximately 2200 mm from the front of the van;
base of the windscreen is approximately 1100 mm from the ground
base of the windscreen is approximately 125 mm from the front of the van
the base of the windscreen is no more than approximately 140 mm from the frontmost part of the van
the base of the driver's seat is no more than approximately 800 mm above the ground;
the driver's seat is mounted on a seat column and the top of that platform is approximately 730 mm-740 mm above the ground;
the height of the top of the skateboard platform is approximately 460 mm from the ground;
the cone of view enjoyed by the driver is approximately 46 degrees.
cone of view from the top of the cone to the horizontal, or the forward-up vision, is approximately 29 degrees
cone of view from the top of the cone to the horizontal, or the forward-up vision, is at least 27 degrees
cone of view from the bottom of the cone to the horizontal, or the forward-down vision, is approximately 17 degrees
cone of view from the bottom of the cone to the horizontal, or the forward-down vision, is at least 15 degrees
the bulkhead that separates the driver cab from the cargo area is no more than 2500 mm from the front of the van and the back of the driver's seat is adjacent to that bulkhead.

Feature 6: Van with a Low Level Chassis with a Driver Seat Positioned at an Optimal Distance from the Front of the Van

An electric van can give a car-like driving position and feel by placing the driver closer to the ground than is possible with a conventional diesel van. But that can compromise forward visibility, which benefits by raising the driver as high as possible. Maximising cargo space can be achieved by placing the driver as far forward as possible; but driver safety is enhanced if the driver is set back from the front of the van. Finding the ideal compromise is challenging. As we have seen above, the driver's seat 922 has to be positioned to enable fast and efficient movement into the cabin and on to the driver's seat, and movement off the seat and out of the cabin. The Arrival van has a specific geometry designed to optimise these competing factors. The driver's seat 922 is mounted on a seat column 923 and the top of that column 923 is no more than 800 mm above the ground; and the driver's seat 922 positions the driver's face between 2000 mm and 2400 mm from the front of the van, as shown in FIG. 95.

We can generalise to:

An electric van with a platform configured to provide a single, flat uninterrupted floor surface and pathway from the driver's seat, into and through the length of a cargo area in the van;
and in which the driver's seat is mounted on a seat column and the top of that seat column is no more than approximately 800 mm above the ground; and the driver's seat positions the driver's face between approximately 2000 mm and 2400 mm from the front of the van.

Optional Sub-Features:
the base of the windscreen is approximately 125 mm from the frontmost part of the van.

Feature 7: Van with a Landscape Mode Touchscreen Positioned Above the Bottom Edge of the Dashboard

A dashboard 931 runs across the width of the driver cabin, lying over the footwell; the dashboard has a substantially flat and straight surface facing into the driver cabin, as shown in FIG. 92 and FIG. 96. The dashboard 931 includes or has mounted on it the steering wheel 933 and also a rectangular touch screen display 932 that shows normal van operational data, such as speed, range, sat nav with route guidance, and also integrates all driver work or task information, such as information on packages to be delivered, whether the delivery schedule is being met, voice call or text function to let package recipients know when the driver will deliver their package, reporting delays in delivering packages to recipients and to a central office. The touchscreen 932 (approx. 15 inch size) is in landscape mode and sits wholly above the base of the dashboard 931, so it does not impede the movement of the driver past the touchscreen 932, when the driver is pivoting off the driver's seat to enter the cargo area of the van (via the bulkhead door) or to leave the van via the passenger door, or to reach to the driver's seat when entering the vehicle through the passenger door. The lower edge of the touchscreen 932 is above the lower edge of the steering wheel 933; visually, from the driver's point of view, the mid-height of the touchscreen 932 aligns with the middle of the steering wheel 933; because the touchscreen 932 is generally at the same height as the steering wheel 933, it is faster and less distracting for the driver to look across to the touchscreen 932 and to interact with it, compared to a conventional touchscreen, which is not generally aligned with the steering wheel. That alignment is especially useful in the Arrival Van because the steering wheel includes touchpads 934 that control icons and menu options shown on the touchscreen display 932 (see also Feature 9).

We can generalise to:

An electric van with a platform configured to provide a single, flat uninterrupted floor surface that extends from the driver cabin, into and through a cargo area in the van, and to the rearmost end of the cargo area, and a dashboard, a steering wheel mounted over the dashboard and a landscape format touchscreen that enables the driver to control vehicle functions, and to display navigation and routing information;
and in which the bottom edge of the landscape format touchscreen is positioned above the bottom edge of the dashboard so that a driver can approach the driver's seat from the passenger side and move his or her legs across to sit down in the driver's seat without any hindrance or obstruction from the touchscreen.

Optional Sub-Features:
The lower edge of the touchscreen is above the lower edge of the steering wheel
the mid-height of the touchscreen aligns with the middle of the steering wheel
the touchscreen is generally at the same height as the steering wheel

Feature 8: Vehicle with UWB Proximity Sensor that Provides Secure Vehicle Access

A localised touch sensor is provided on the outside of the vehicle, on or adjacent to each door of the vehicle, and inside the driver's cab, adjacent to the driver and passenger door and also the cargo doors. FIG. 97 and FIG. 98 show the touch sensor 936 by the door (non-driver's side). Touch detection is in addition to key detection: as a consequence, a driver walking past the vehicle will not cause the vehicle to unlock by mistake, even if the key is in the driver's pocket; the driver must deliberately touch or very closely approach the touch sensor, with a key nearby, for the door to unlock.

A customer can specify the use of a mobile phone or a key fob or an NFC or UWB device and specify the use of capacitive touch point sensors 936 on the Arrival Van. With this system, the driver's proximity is detected, coming in and touching the touch point sensor; this releases the door (and may also auto-open the door). When a driver is carrying a box, wearing gloves, and it's raining, this access control system is far simpler than having conventional keys.

So the Arrival vehicle includes a proximity-sensitive sensor 936 used by a user to unlock a door and hence access or exit the vehicle. The user has a key which includes a transmitter configured to emit a signal that is detected by the sensor. The signal includes authentication data, which is checked by a processor of the vehicle. If the authentication information is found to correspond to an authenticated user, then the processor permits access to the vehicle. If the user is authenticated, then the door is unlocked, so that the user can gain access to the vehicle.

The sensor 936 is sensitive to receive UWB signals and/or NFC signals; multiple comms channels can be provided for communicating between the key and the vehicle. The UWB serves as a default channel, with NFC serving as a backup channel. Once the key is within range, the vehicle status changes, so the vehicle is able to unlock. Therefore, the driver does not need to find their keys to access the vehicle interior. The key can be a phone or a fob. If the key is a phone, then the driver doesn't need to carry a separate fob. Also, a key can be provided to a number of keys that are in the possession of different drivers. A digital key can be transferred from one key device to another. This is useful for fleets, where a number of drivers are given access to the vehicle. The authentication data is associated with the key, with the vehicle recognising which key has been used to access the vehicle.

One form of the rear door is a powered roller shutter door; this is also activated by a capacitive touch point, 936 so the driver does not need to have their hands free to pull down the roller shutter door 940. There is also a 270 degree hinge door for full loading into the back of the vehicle.

We can generalise to:

A delivery van or other vehicle access control system including a touch or proximity sensor (such as a capacitive touch sensor) integrated into an external or internal surface of the vehicle by each door or opening to the vehicle and which triggers the unlocking of a specific vehicle door or other opening, and not a general opening of all doors and openings to the vehicle, only if (i) a wireless key (e.g. as provided by a NFC fob or smartphone or other personal device, using Bluetooth, LTE or UWB communications, e.g. using PKE—passive keyless entry) approved for that vehicle is present sufficiently close to a specific sensor that is adjacent to that specific door or opening and (ii) the sensor is manually activated by a driver's touch or proximity or specific gesture. Automatic opening of the vehicle door or other access may then follow.

We can also generalise to:

A vehicle access control system including a touch or proximity sensor integrated into an external or internal surface of the vehicle by each door to the vehicle and which controls the unlocking of a specific vehicle door, and not a general opening of all doors to the vehicle, only if (i) a wireless key approved for that vehicle is present sufficiently close to a sensor that is adjacent to that specific door and (ii) the sensor is manually activated by a driver's touch or proximity or specific gesture.

Optional Sub-Features:
The sensor is sensitive to the hand of a user.
The sensor is sensitive to a signal emitted by an electronic device (e.g., a phone or fob).
The sensor is a touch or proximity capacitive sensor
The sensor receives UWB signals and/or NFC signals.
The sensor is integrated into an exterior panel of the vehicle.
The exterior panel of the vehicle is formed from composite material.
The door is a hinged door, sliding door, roller shutter door or other form of closure.

Feature 9: Steering Wheel with Integral Touch Pads

The Arrival Van is designed to make sure that the driver has as few distractions as possible and is required to take as few interaction steps as possible. On the steering wheel 933, shown in FIG. 99, are directional touch pads 934 and they are used for audio, GPS, voice control and other functions. The directional pads 934 can control menus and functions shown on the large touchscreen display that is next to and broadly aligned with (i.e. at the same height as) the steering wheel. Because the driver may momentarily glance down at the touchpads 934 when touching them, the driver then simply has to look across from the steering wheel (i.e. an essentially horizontal gaze change, and not looking down) to view the large touchscreen display 932 that is at the same level as the touchpads to see how touch inputs to the touchpad are influencing the selection of menu items etc displayed in the display 932 (see FIG. 96); this is faster and less distracting than having to look down and across, which is the conventional approach.

We can generalise to:

Vehicle with a steering wheel including one or more directional touch sensors integrated into the steering wheel and each including a substantially flat top surface configured to operate as a touch pad.

Optional Sub-Features:
the mid-height of the touchscreen aligns with the middle of the steering wheel
the touchscreen is generally at the same height as the steering wheel

B. Arrival Van: Physical Construction Features

In the preceding section, we focused on features in the Arrival Van that improve driver ergonomics. The physical construction or structure of the Arrival Van also differs from the physical construction of a conventional diesel van too. Reference may be made to EP19210147.5, the contents of which are incorporated by reference.

Feature 10: Van with Lightweight Body Made from Composite Panels

The Arrival Van (like other Arrival vehicles) has body panels (and other parts, such as roof panels, front and rear sections, dashboards, door trims) made from lightweight composites (See Section H); light weight extruded aluminium struts are adhesive bonded and mechanically fastened to the chassis or platform and the composite panels attach to these struts using simple clip and fastener system designed for robotic installation.

The thermoplastic composite body structure plays a number of different roles. First, it enables Arrival to bring a number of different vehicle lengths, heights and configurations to customers around the world quickly; where traditional vehicles are using complex, expensive, high-pressure stamped metals, which are then painted, Arrival has devised a new body structure system and a new thermoplastic composite material. Any panel or part that is attached to the vehicle strut structure is designed for fast easy replacement. So, even when a panel is damaged, it is very fast for a company to take this panel off the struts it is attached to, replace it, and get the vehicle back on the road as quickly as possible. All of these panels are fully recyclable. So, at end of life or in the instance that we do need to replace the panel, we are taking this part, putting it through a recycling process and bringing a circular economy to body structures.

The composite body panels are not only strong yet also ductile, and should last a long time in the field and rarely need replacing; the panels will generally deform and return to their original shape after an impact that would permanently deform a similar steel panel. Arrival's composite parts (e.g. body panels, doors, roller shutters, roofs) can be highly thermally insulating—especially useful for refrigerated vans. The Arrival system enables high performance automotive composite panels to be made rapidly and cheaply, doing away with the need for costly metal stamping presses and conventional painting setups.

FIG. 100 shows an Arrival Van low level skateboard platform of chassis 908 on which is mounted a superstructure of lightweight structural columns, including horizontal aluminium struts or superstructure 919 and vertical aluminium struts or superstructure 920. FIG. 101 shows this van, no clothed in composite side body panels 921 and semi-translucent composite roof panels 941; the panels are attached to the horizontal aluminium struts or superstructure 919 and vertical aluminium struts or superstructure 920.

We can generalise to:

An electric van with (i) a flat floor mounted on a chassis, and (ii) a battery pack or packs that is in, or part of, or mounted on, the chassis; and body panels made of composite material mounted on light weight extruded aluminium struts or members that are connected to the chassis.

Optional Sub-Features:
composite exterior and interior side panels are attached to the aluminium struts or members
aluminium struts or members are substantially straight
aluminium struts or members are made of extruded aluminium
aluminium struts or members are fixed using glue to the skateboard platform
aluminium struts or members extend across the roof
one or more transparent or partially transparent composite panels are used for the roof

Feature 11: Van with Composite Exterior and Interior Side Panels, Each with a Class A Surface Composite Exterior and Interior Side Panels, Each with a Class A Surface

In the preceding section, we described how the Arrival van uses composite, exterior side panels. The Arrival van also uses composite side panels for the inside of the cargo area too; the side panels are hence a multi-layer structure with both exterior side panels and also interior side panels. All panels are attached to the extruded aluminium frames we have described earlier. The composite material is designed to handle deflection and abrasion before showing any signs of damage. So, there is no need to paint this material as it has an in-mould finish: the panel or part comes off the tool with its body colour already present. The parts can be coloured to a Class A finish not just in a surface layer, but throughout multiple layers of the structure (as described in Section H); scratches and deformations that would normally fully penetrate a superficial paint surface are hence concealed, increasing the useable lifetime of the composite panels. Any scratches you get along the Arrival vehicle will not show a contrasting colour underneath. In addition, the panels have a Class A surface that is configured to be washed or wiped clean of dust and dirt: that is especially useful for the interior of the van: traditionally, van interiors have been just pressed steel or sheet metal panels, which are far harder to wash and wipe clean.

We can generalise to:

An electric van with composite exterior side panels, each with a Class A surface.

Optional Sub-Features:
composite exterior and interior side panels are also attached to structural pillars.
structural pillars are substantially straight
structural pillars are made of extruded aluminium
structural pillars are fixed using glue to the skateboard platform
structural pillars extend across the roof
one or more transparent or partially transparent composite panels are used for the roof

Feature 12: Van with Side Door In-Between Structural Pillars

We have seen in earlier sections how the Arrival system uses hardware modularity, including standardised extruded aluminium frames or pillars that are attached (e.g. with mortice and tenon type joints that are then glued) into the skateboard platform and that form the structural skeleton of the sides of Arrival vehicles. Typically, these frames are each formed as hoops that define the sides and roof structure; the Arrival van uses the same extruded aluminium structural frames or pillars, as shown in FIG. 100. Lightweight, non-stressed, non-structural composite panels are fixed between these frames; composite side panels hence form the external sides of the van.

But because the gap between pairs of structural pillars or hoops is approximately 1500 mm (and that can be adjusted to be larger) it is possible to include in the side or roof of the van features such as cargo doors and access hatches that do not compromise the structural integrity of the van. For example, the van shown in FIG. 87 includes a side cargo door 942 positioned in between the vertical struts defining the front bulkhead 925 and the vertical structs 920 defining the middle structural hoop.

A company purchasing vans could hence specify that some of their vans should have no side cargo doors and only the driver cabin doors, and other vans have a left-hand side cargo door, and other vans a right-side cargo door, and some vans a double pair of cargo doors etc: all of these variants can be made at the same time, in the same production facility (e.g. microfactory) using the same basic structural systems of frames or pillars. With a conventional van, with stamped steel monocoque sides, this degree of flexibility is impossible because of the cost and investment that it takes to make these stamped steel pieces.

We can generalise to:

An electric van in which the sides of a cargo area are formed using substantially straight, vertical structural pillars that are attached to the platform, with composite panels fitted between at least some of the structural pillars, and a cargo door is positioned between two of the vertical, structural pillars.

Optional Sub-Features:
the side door for the cargo area is approximately 1700 mm high and 1350 mm wide.
the cargo door is non-structural
the skin of the cargo door is a lightweight composite panel
structural pillars are approximately vertical
structural pillars are inclined at no more than 10 degrees to the vertical
structural pillars are made from extruded aluminium
the gap between pairs of structural pillars is approximately 1500 mm
there are three sets of structural pillars
there are four sets of structural pillars
the side door for the cargo area, the side door being approximately 1700 mm high and 1350 mm wide.
a bulkhead separating the driver cabin from the cargo area is formed from substantially straight structural pillars
the panels are made of composite material
skateboard platform configured to provide a single, flat uninterrupted floor surface and pathway from the driver's seat, into and through the length of a cargo area in the van

Feature 13: Van with Forward Bulkhead

Maximising cargo carrying volume is key for any van. We discussed above how maximising cargo volume can be achieved by having a low skateboard platform and placing the driver as far forward as possible so that the cargo area can be as long as possible; but driver safety is enhanced if the driver is set back from the front of the van. Finding the ideal compromise is challenging. In the Arrival van, as shown in FIG. 102, the top of the skateboard platform is no more than 480 mm from the ground; and the bulkhead that separates the driver cab from the cargo area is no more than 2500 mm from the front of the van. This leads to a cargo volume that is significantly larger than for conventional vans of a similar length.

We can generalise to:

An electric van with a platform configured to provide a single, flat uninterrupted floor surface and pathway from the driver's seat, into and through the length of a cargo area in the van; in which the top of the floor surface is no more than 480 mm from the ground; and the bulkhead that separates the driver cab from the cargo area is no more than 2500 mm from the front of the van.

Optional Sub-Features:
the bulkhead that separates the driver cab from the cargo area is approximately 2300 mm from the front of the van
the bulkhead is formed from substantially straight structural pillars
the height of the top of the skateboard platform is approximately 460 mm from the ground.

Feature 14. Van with Fully Customisable Cargo Area

We have seen how the Arrival system uses standardised extruded aluminium frames or pillars that are mechanically attached and glued to the skateboard platform to form the structural skeleton of the sides of Arrival vehicles. Because the Arrival Van uses the same construction approach as the Arrival Car, the length of the skateboard platform in the Arrival van can also be extended in the same manner—e.g. by increasing the length of the extruded aluminium longitudinal chassis sections 909 and/or by increasing the length of the rear cradle sections defined by the extruded aluminium longitudinal chassis sections 911 or impact absorbing bumper sections at the rear of the van.

As noted above, and shown in FIG. 100, the Arrival van uses extruded aluminium structural frames or pillars 919, 920, attached to the skateboard chassis or platform 908, and forming a series of structural hoops to which lightweight, non-stressed, non-structural composite panels 921, 941 can be fixed to form the external sides and the roof of the van. The length of these extruded aluminium structural frames or pillars can be readily changed, enabling vans of greater height to be made. There are three heights of vehicle: a 2.7 m, again built around that process of walking on and off the vehicle 200 times a day, a 2.4 m and then a sub 2 m metre roof height for our customers that need vehicles in urban areas, multi storey car parks etcetera.

The Arrival van can hence be readily customised in both length and height, enabling different cargo volumes or areas, yet still be made at the same time, in the same production facility (e.g. microfactory) using the same basic structural systems of frames or pillars and also the same system of composite panels fitted to these pillars. With a conventional van, with stamped steel monocoque sides, this degree of flexibility is impossible because of the cost and investment that it takes to make these stamped steel pieces.

We can generalise to: An electric van in which the length of the cargo area defined by a customer for that van, determines, when the van is being automatically configured for production by an automated vehicle design tool, a required length for extruded aluminium longitudinal members that define the sides of the chassis or platform;
and the height of the cargo area defined by the customer determines, when the van is being automatically configured for production by the automated vehicle design tool, determines a required height of extruded aluminium structural pillars that are themselves attached to the chassis or platform.

Optional Sub-Features:
the bulkhead that separates the driver cab from the cargo area is no more than 2500 mm from the front of the van
the bulkhead that separates the driver cab from the cargo area is approximately 2300 mm from the front of the van
the bulkhead is formed from substantially straight structural pillars
structural pillars are substantially straight
structural pillars are made of extruded aluminium
structural pillars are fixed using glue to the skateboard platform
structural pillars extend across the roof
composite exterior and interior side panels are also attached to structural pillars.
translucent roof panel is also attached to structural pillars
skateboard platform provides a substantially flat floor for substantially the entire cargo area through which a driver passes in normal use when selecting and picking up packages that are stored on the shelves

Feature 15: Van with Shelves Cantilevered to Structural Pillars, and the Pillars are Fixed to the Chassis

The Arrival Van is very well suited for transporting the large numbers of cardboard boxes and packages used for online retail purchases: these boxes and packages are normally placed on shelves in a typical box van and dedicated structural supports are needed for these shelves. In the Arrival van, as shown in FIG. 100, there are structural frames or pillars 920 that form the structural skeleton of the sides of the cargo area; these structural frames or pillars 920 are themselves attached to the skateboard platform 908. The Arrival van re-uses these existing structural frames or pillars 920 to provide the structural support to which cantilever arms 943 are attached; shelves, hooks etc. are then mounted on these cantilever arms 943. This approach saves weight, and reduces production time.

The cargo space is designed to be as flexible and universal for as many fleets as possible. It includes pick up points in the floor, in the pillars, and the roof, for flooring systems, off the shelf shelving systems, interior roof racks, ladders etc.

We can generalise to:

An electric van with shelves fitted in a cargo area of the van, in which the shelves are mounted on cantilever arms and the cantilever arms are themselves fixed to vertical structural frames or pillars that form the structural skeleton of the sides of the cargo area and the vertical structural frames or pillars are themselves attached to a platform that provides a substantially flat floor for substantially the entire cargo area through which a driver passes in normal use when selecting and picking up packages that are stored on the shelves.

Optional Sub-Features:
structural pillars are substantially straight
structural pillars are made of extruded aluminium
structural pillars are fixed using glue to the skateboard platform
structural pillars extend across the roof
composite exterior and interior side panels are also attached to the structural pillars.
the vertical position of the cantilever arms on the straight, structural pillars is set when the van is assembled
the vertical position of the cantilever arms on the straight, structural pillars is adjustable after the van is assembled
skateboard platform
the shelves are coated in a material that facilitates cardboard packages being slide along the length of the shelves.

Feature 16: Van with Skylights

Just as the Arrival driver cabin is exceptionally light, due to the very large windshield, the cargo area in the Arrival Van is itself also very light and airy since it features extensive skylights 941 (see FIG. 86): this makes navigating through the cargo area safer and more pleasant, and locating packages easier. It also reduces the need for internal lighting, and hence saves battery charge. The roof panels in the Arrival Van are made of lightweight composites; these can be translucent. Alternatively, the side panels of the roof can be made of opaque, coloured composite panels, much like the side body panels, and a clear transparent plastic insert provides the skylight.

We can generalise to:

A electric van with roof panels made of composite material mounted on light weight extruded aluminium struts or members, and each including a central generally clear or transparent section configured to form part of a skylight running over some or all of the cargo area.

Optional Sub-Features:
the central clear or transparent section is itself made of composite material
the central clear or transparent section is itself made of translucent plastic

Feature 17: Vehicle with Service Hatch

The Arrival Van is designed for easy daily or regular maintenance: a logistics company may run several hundred vans from a single large depot and the Arrival Van is designed to make regular checks on consumable fluids, such as coolant, brake fluid, and windshield cleaner, fast and easy: the Arrival Van has a hinged flap, located just below the windshield and hence at or above waist height, and which is opened by pushing down on the flap, and which enables just the levels of these consumable fluids to be checked easily and topped up, without the need to bend down. The hinged flap covers just the filling tubes for these consumable fluids; it may also cover other non-consumable items that do not need regular replacement, such as the headlights, but does not cover any traction components, unlike a conventional van bonnet. FIG. 104 shows a service technician pushing on the hinged flap 941 to de-latch it; the hinged flap 941 can then be hinged open to expose the openings for re-filling consumable liquids. The service hatch allows checks and maintenance of the vehicle to be performed as quickly as possible, without the need to bend down, since the hatch is at least 1 m above the ground. This is particularly valuable for technicians having to service very large numbers of vehicles in a short period of time.

We can generalise to:

A vehicle with a single region for all service connections for consumable fluids, such as coolant fluid, brake fluid, and windscreen cleaner fluid, and which is accessed by opening a hinged flap or other cover that is located at waist height or above.

Optional Sub-Features:
the hinged flap is positioned underneath and substantially adjacent to the windscreen.
the hinged flap runs across the width of the vehicle
the hinged flap exposes the vehicle headlights

Feature 18: Van with Independent Suspension System Mounted in Each Structural Wheel Arch

In the Arrival Van platform, the drive units are integrated into the front axles; in a 4WD variant, the drive units are integrated into both axles. The van has a sub frame at the front, with fully independent front suspension, and a sub frame at the rear, with fully independent rear suspension. This brings passenger vehicle driveability and experience to robust commercial vehicles.

As shown in FIG. 90, the Arrival Van positions the electric motors (and other drive train elements 915) within the front two rear wheel arches (single large aluminium cast front wheel support 913), or all four wheel arches. Each wheel arch comprises a single, structural aluminium casting to which an independent suspension system 914 is directly attached. This makes robotic assembly of the entire drive and suspension system much simpler than if the suspension system and motors were mounted on the chassis. And because there are no suspension rods running across the chassis, this means that the battery pack can continue past the axles. The Arrival Bus uses the same approach of one-piece structural wheel supports that include suspension mounts.

We can generalise to:

An electric van in which an independent suspension system is mounted directly to a structural wheel arch.

Optional Sub-Features
suspension mounting point is at the top or apex of the structural wheel arch, which is substantially symmetrical.
a motor is mounted directly to the structural wheel arch.

Feature 19: Van with Side Window Including a Drop-Down Glazing Unit

The Arrival van has large, fixed side windows for ease of robotic installation and reduced cost. For driver ventilation and access, the driver-side side window has a drop-down glazing unit 945, shown in FIG. 105 with the drop-down window in the down or fully lowered position; this drop down window 945 is integrated within the side window; this combined side-window with integral drop-down glazing unit is installed as a single item into the door frame; this is a much easier process for robotic handling and installation than the conventional process of installing an electrically sliding window directly into a door frame. It also enables an exceptionally large side window to be installed—far larger than would be possible if the entire side window could slide up and down. Also, because the drop-down glazing unit is relatively small, the motor needed to move it up and down does not have to be as powerful as a motor used for a much larger window. A manual over-ride, so that the drop-down glazing unit can be simply pushed down and pulled up, is also much easier to engineer.

We can generalise to:

Van with side window including a drop-down glazing unit that is integrated within the side window.

C. Arrival Van: Automated Customer Configuration Using Vehicle Builder and Automated Production Using Robofactoring at a Microfactory

The Arrival Van can be readily customised when being configured for factory-build to the specific requirements of a purchaser, typically a logistics or delivery company looking to buy a fleet of vans. A single purchaser, as well as different purchasers, can have a broad spectrum of requirements for their van fleets, such as van length, van height, battery pack capacity, driver monitoring systems, ADAS etc.

As noted above, the Arrival software-based and highly automated vehicle design system (Vehicle Builder—see Section D) is flexible enough to automatically configure the physical layout (e.g. structural members, hardware, sensors), the software and all power/data connections required for different configurations of vehicles. Robofacturing and Microfactories (See Section F) are flexible enough to put into production a wide range of different vehicle types without requiring re-organisation or re-tooling; efficient customisation to meet a purchaser's exact requirements is therefore possible. The highly modular Arrival system therefore offers far greater flexibility than earlier systems in enabling the specific van configuration needs of customers to be met. With the highly modular Arrival system, it becomes possible to design and produce even relatively low volumes of vans that have configurations that are optimal for the specific requirements of customers

Feature 20: Vehicle with Customer-Specified Battery Capacity

Battery pack capacity can be especially useful to customise: a conventional electric van might have at best a choice of two different battery capacities: with the modular battery system used in Arrival vehicles, it becomes possible to offer far more choice (e.g. three, four, five or more different battery capacities for the Arrival Van—for example, the Arrival Van will launch with four different battery packs: 67 kWh, 89 kWh, 111 kWh, 133 kWh). Since the battery pack is the single most expensive item in the vehicle, being able to offer a broad range of potential battery packs is very useful, especially to a fleet customer providing logistics or package delivery services: these customers will know with a high degree of accuracy the range they need their vans to be able to cover on a single over-night charge, and provisioning vans with batteries that deliver significantly more than that range is unnecessary, and leads to vans that are unnecessarily heavy and costly.

We have seen earlier how the Arrival HVBM system (see Section G) enables increments of battery capacity that can be as low as 3.7 kWh (corresponding to the capacity of a single autonomous HVBM), although in practice HVBM-based battery packs are likely to be produced in variants such as a 20 module pack, a 30 module pack and a 40 module pack. So a fleet operator may decide that the optimal mix is for 60% of its fleet to use the 20 module pack (giving a 100 km to 120 km range), and for 40% of the fleet to use a 30 module pack (giving a 150 km to 180 km range), and for there to be no need for any vans to have a 40 module pack (giving a 200 km to 240 km range), but if some longer range routes do need to be served, then the battery packs in some vans can be altered, in a service facility, by adding in new battery modules to the pack, e.g. so that it becomes a 40 module battery pack. The van, once built, is hence not permanently limited to using only the battery modules that it was factory provisioned with, but can be modified by adding in further modules (or taking away some battery modules). The modified battery pack will immediately work with existing van systems; this exemplifies the hardware modularity of the Arrival system (described in Section A) and the Arrival ‘plug and play’ functionality (described in Section B).

We can generalise to:

An electric vehicle design and production process, the vehicle including multiple batteries;
in which a customer specifies the battery capacity, or range required for a specific new vehicle or fleet of vehicles, and an automated vehicle design tool then automatically selects battery-related components required for the specified battery capacity or range; and automatically generates build instructions for that vehicle or fleet of vehicles;
and a robotic production environment then automatically builds or assembles the vehicle as designed by the automated vehicle design tool, including a battery pack that meets the specified battery capacity or range.

Feature 21: Vehicle with Integrated, Customer-Specified Sensors

Arrival vehicles include a broad range of sensors, measuring and reporting on the status and of many different vehicle sensors, such as cargo weight sensors, thermal management sensors, battery management and health sensors, power train performance sensors etc. This connectivity give Arrival and its customers the ability to monitor these key health aspects and also forecast any issues for predicative maintenance, avoiding breakdowns in the field and hence providing a better service to customers.

Arrival Vans include a set of fully integrated hardware safety and driver assistance sensors (e.g. ADAS related sensors; sensors to give full environmental information to a driver; sensors that detect crashes or bumps; sensors to provide telematics data to a central control system supervising a large fleet of vans for delivery schedule compliance data) and devices to enable driver monitoring (e.g. AI-based computer vision systems monitoring compliance with road signs, speed limits, lane adherence, safe stopping, no tail-gating, staying awake, keeping eyes on the road, regular use of rear-view mirrors or e-mirrors, not using a mobile phone), and cargo monitoring features (e.g. AI-based computer vision systems that monitor access to the cargo area, detect abnormal behaviour, trigger and alarm and send alerts if intrusion is detected). These are useful in commercial vehicles, but in a conventional delivery vehicle, these are after-market installed, and are hence not an integral part of the vehicle when produced.

The Arrival Van integrates these sensors and devices into a van as part of the factory build, but because these sensors and devices are (like the HVBM battery modules described in Section G) designed using the principles of hardware modularity of (described in Section A), the Arrival ‘plug and play’ functionality (described in Section B), the Arrival security features (described in Section C) they can be selected and automatically configured for a specific vehicle build using the Arrival Vehicle Builder Tool (described in Section D) and built using the Robofactoring techniques (described in Section E).

This gives three key advantages: first, it enables new types and designs of sensors to be rapidly incorporated into a vehicle factory build: since these types of sensors (especially AI-based computer vision based systems) are subject to rapid evolution, Arrival Vans have the ability to readily be built using new and improved versions of these systems, without having to implement significant changes to the vehicle design or production process. This ensures that Arrival Vans can be natively built at the microfactory with the latest available technology. The second advantage is this: some of these sensors raise complex privacy and regulatory issues: the Arrival system provides the ability to incorporate these sensors into a build for a specific vehicle just prior to the build taking place, even where doing so may require different ECU firmware components, different wiring, different hardware (sensors, mounting points, body panels); this gives much greater agility in responding to the changing privacy and regulatory environment. Since microfactories are inherently local, the Arrival system is especially well suited to building vehicles at a microfactory that meet the specific privacy and regulatory environment relating to the region or country where that microfactory is located.

The third advantage is that, even several years after an Arrival vehicle has been built, it is possible to add these new sensors to a vehicle and for them to automatically become a fully integrated part of the vehicle's data and security infrastructure. A conventional design and build process in effect locks in a specific set of sensors and the related software, physical fixings etc. that appear relevant at a specific time.

The Arrival Van typically is built with two cameras at the front, two on either side, one at the back, combining that with a set of ultrasonic sensors around the vehicle and radars front and rear. The data coming from these cameras can be used by fleets in many different ways, such as security warnings, and insurance claims. Effectively, we have a fully updateable black box in the vehicle. This also means that for fleets, where insurance claims and damage is a major problem, Arrival Vans have the ability to warn the driver and the fleet when something is happening in the vehicle, whether it is a crash or security threat. Actual video footage and sensor data can be generated and used in different ways. The Arrival Van includes E-mirrors, with two cameras either side of the vehicle, so the driver is always seeing their vehicle in its surroundings, with a live feed of the environment around the vehicle being shown on displays inside the vehicle. As more sophisticated driver assistance systems become available, these can be readily incorporated into new vehicle builds and also retro-fitted to existing vehicles in the field, and automatically become a fully integrated part of the vehicles' data and security infrastructure.

We can generalise to:

An electric vehicle design and production process, the vehicle including multiple sensor based systems, such as ADAS, LIDAR, computer vision based driver monitoring, computer vision based cargo monitoring, load or weight sensors;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicle as designed by the automated vehicle design tool, integrating the sensor based systems into the vehicle.

Feature 22: Van with Configurable Cargo Area

We have seen in the preceding sections how an Arrival Van customer can specify the specific requirements for battery capacity and various sensors and these requirements are automatically used by the Vehicle Builder system (see Section D) to generate the build instructions for that specific vehicle, which are then implemented in a microfactory (see Section F) to actually assemble that specific vehicle. For a van, this vehicle specific customisation can extend to any one or more of the following variants for the cargo area:
type of van: such as walk-in-van, cargo van, chassis cab van, passenger van, camper van.
length, height, of the van
cargo volume
number and type of access doors
shelving system, number and size of shelves
whether the cargo area is refrigerated,

We can generalise to:

An electric van design and production process, the van including a cargo area;
in which a customer production the requirements for the cargo area; and an automated vehicle design tool then automatically selects components required for that specification; and automatically generates build instructions for that van or fleet of vans;
and a robotic production environment then automatically builds or assembles the vehicle as designed by the automated vehicle design tool, including a cargo area that meets that specification.

Feature 23: Robotic, Cell Based Production

The Arrival Van is designed to be built using the Robofactoring techniques described in Section E at a microfactory as described in Section F.

We can generalise to:

A method of producing a vehicle, in which a robotic production environment assembles, at a fixed location and not a moving production line, at least the chassis, composite body panels and supporting structures for those panels using instructions generated by an automated vehicle design tool from a customer specification for that vehicle.

Feature 24: The Microfactory

The microfactory itself as at the heart of the Arrival system; all Arrival vehicles, including the Arrival Van, are designed from the ground up to be optimised for production using the Robofactoring techniques described in Section E at a microfactory as described in Section F.

We can generalise to:

A vehicle production factory comprising a number of robotic production cells for vehicle production, each cell comprising a group of robots that are programmed to assemble, at a fixed location and not a moving production line, at least the chassis, composite body panels and supporting structures for those panels using instructions generated by an automated vehicle design from a customer specification for that vehicle.

Feature 25: Post Production Change to a Different Battery Pack Capacity

As noted earlier, the Arrival Van uses battery modules (e.g. the HVBMs described in Section G) that are modular and extensible—i.e. further modules can be added to the battery pack at factory build time to give the customer-specified battery capacity, without having to re-design the battery pack, other than implement the additional current busbars or connectors and data connectors for the additional modules. The battery pack is hence inherently designed to be scalable, i.e. provide different capacities through the inclusion of different numbers of battery modules in the battery pack. Because the battery modules implement at least some of the hardware modularity features described in Section A, and at least some of the plug and play functionality described in Section B, it is possible to add additional modules to a vehicle even after the vehicle has been built: for example, say three years after a vehicle has been built, it becomes economic to deploy solid-state batteries (with improved power to weight and improved safety compared to conventional lithium ion batteries) then battery modules with these improved batteries can be replace the modules in an existing battery pack. Similarly, the entire battery pack could be replaced: the pack itself conforms to at least some of the hardware modularity features described in Section A, and at least some of the plug and play functionality described in Section B and hence can also be replaced, ensuring that Arrival Vans have a greatly extended life compared to conventional vehicles.

We can generalise to:

An electric vehicle with an original factory-installed battery pack with a specific battery capacity; in which the vehicle is configured to enable the original battery pack to be altered by adding one or more further battery modules to the battery pack, or removing one or more battery modules from the battery pack.

Feature 26: Post Production Update of Integrated, Customer-Specified Sensors

As noted earlier, the Arrival Van uses sensors such as ADAS, LIDAR, computer vision based driver monitoring, computer vision based cargo monitoring, load or weight sensors that are modular and implement at least some of the hardware modularity features described in Section A, and at least some of the plug and play functionality described in Section B. It is possible to change existing sensor system in a vehicle and add additional sensor modules to a vehicle even after the vehicle has been built: for example, say three years after a vehicle has been built, there are far more advanced AI-based computer vision sensors that implement GPUs in a SoC that are part of the actual sensor itself; with the Arrival approach, the existing sensors can be removed from a vehicle and replaced with the new, more powerful sensors, which immediately become part of the vehicle's data and security network and systems.

We can generalise to:

An electric vehicle with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the vehicle's data and security network and systems.

Optional features:
The sensors include one or more of the following: ADAS, LIDAR, computer vision based driver monitoring, computer vision based cargo monitoring, load or weight sensors

Note that the vehicles described above can utilise any and all the Features and related optional sub-features described in this specification. For example, the Arrival Van can incorporate or otherwise use the hardware modularity and Robofacturing Features described in Section A above; can incorporate, or otherwise use the Unified Software Architecture, Plug and Play and decentralised autonomy Features described in Section B; can incorporate or otherwise use the security features described in Section C; can incorporate or otherwise use the ATP and Vehicle Builder-related Features described in Section D; can be built using the Robofactoring robotic production environment described in Section E and be built in the microfactories described in Section F; can incorporate or otherwise use the HVBMs and Flex connected Features described in Section G; can incorporate or otherwise use the composite parts and panels described in Section H. The Arrival Van described in this Section I can also incorporate or otherwise use or be characterised by any of the Features and related optional sub-features for the Arrival Bus described in Section J and the Arrival Car platform described in Section K.

An interpretation point: Sections A-K describe a broad range of features and optional features; when we say, anywhere in this specification, that a vehicle or system uses or implements features and optional features described in any Section A-K, or that a Section A-K is relevant to an implementation, that should be interpreted as meaning that at least one or more or optional features are used or implemented; it should not be interpreted to mean that all features and optional features are necessarily used. So, for example, when we say that ‘Arrival vehicles implement hardware and software modularity concepts (see Section A and Section B)’, then that should be interpreted as meaning that at least one concept from Section A and Section B is implemented, but not necessarily more, nor all.

Section J: The Arrival Bus System

Introduction to this Section J

We have discussed earlier in this text that creating sustainable environments, especially urban environments, will require a broad range of vehicle innovations: vehicles will need to be zero or low-emission, yet will need to be designed to deliver purchase price parity with conventional internal combustion engine vehicles, despite including very costly battery packs or fuel cells. This new generation of vehicles would ideally be purpose-built for specific market needs or customer requirements.

If we take a specific vehicle segment, buses, then further compounding these challenges is the requirement that buses will need to become far more attractive environments, and at least as welcoming and engaging as private motor cars; bus travel will need to become, if sustainable transportation goals are to be met, more appealing, more sustainable and more financially viable than is currently possible.

None of this is feasible with the current bus design and production paradigm: The conventional approach locks in bus design for many years, so that bus design can react only very slowly to the acute environmental and urban transportation challenges we are now facing, and equally slowly to users' increasing demand for transportation environments that are engaging, safe and zero emission. Low volume production runs of vehicles designed to meet specific customer needs (e.g. a local transit authority buyer who wants to buy 500 buses customised to their specific blend of requirements) is not possible.

As noted earlier, the Arrival system is a vehicle design and production system that aims to meet these challenges: enabling vehicles to be designed for specific customer needs with enhanced user engagement. Arrival vehicles implement the hardware and software modularity concepts described in Section A and Section B earlier, with the security architecture described in Section C, and are configured using the Vehicle Builder system of Section D. Cross-product functionality is a key attribute of the Arrival system, giving economies of scale, agility in new vehicle design and simplifying the logistics supply chain (e.g. all vehicles, whether a small car, or a commercial van, or a large bus, can use the same battery modules, battery management system, motors, inverters, gearboxes etc., the same kinds of extruded aluminium superstructure for vehicle bodies; the same physical components all conforming to a standardised grid-based sizing, the same physical components that are all designed for robotic handling, the same software and firmware components, the same plug and play functionality etc.).

Arrival vehicles can be brought from design to production in 12 months, as opposed to 3-5 years, with no price premium for being zero emission, and are produced using small cells of robots, with each cell producing both sub-assemblies and the entire vehicle (see Section E for more on Robofacturing) in relatively small and low capital expenditure (CapEx) microfactories (see Section F) that are not based on conventional long moving production lines. Arrival vehicles use modular high voltage battery modules; a scalable system which enable battery packs to be made for the entire range of Arrival vehicles, from a small car to a large bus (see Section G). Microfactories do not need huge steel panel presses because Arrival vehicles use body panels that are not made of pressed steel, but instead lightweight composites; composite panels can be made for the entire range of Arrival vehicles, from a small car to commercial van to a large bus (see Section K for more on composites). These composite panels can be non-structural and mounted on a structural frame of lightweight aluminium extrusions that are optimised for robotic handling and attachment to the underlying chassis. This hybrid body approach applies across all vehicles in the Arrival range and is another example of cross-product functionality, delivering scalability.

Production of buses in a microfactory can be especially relevant where a local city or public transportation region has a requirement for buses with specific attributes, and that microfactory can be built in that actual city or region. The microfactory approach is significantly cheaper in CapEx than moving production line factories, meaning that much lower annual production volumes can still be profitable, in turn enabling fleet customer specific designs. Microfactories can be readily scaled up by adding additional cells, or scaled down if needed, or switched to different designs of buses, or vans or cars. Because a microfactory is much smaller (e.g. 20,000 square metres) than a conventional vehicle factory (1M+ square metres), they can be built in areas of demand, anywhere in the world, establishing a local presence quickly, with shorter supply chains, enhanced local employment, enhanced local tax base, and no requirement for ocean container shipping, further reducing the carbon footprint. Microfactory production using small cells of robots requires radical re-thinking of how a vehicle should be designed: design for robotic production is at the heart of the Arrival system.

This Section J describes a number of features, adopted variously in the Arrival Bus implementations of the invention. We categorise these features into the following five groupings:
A. Arrival Bus Physical Features
B. Arrival Bus Information Systems
C. Arrival Bus Ticketing Features
D. Arrival Bus Utilisation Measurement Features
E. Arrival Bus Automated Customer Configuration using Vehicle Builder and Automated Production using Robofacturing at a Microfactory

A. Arrival Bus Physical Features

Buses in widespread commercial use are six wheeled vehicles: two wheels on a single axle at the front of the bus, and four wheels at the rear (either two wheels on either side of a single axle; or a single wheel on each side of a pair of axles). The four rear wheels support the load of the heavy diesel engine at the rear of the bus. Electrically powered buses, despite having no heavy diesel engine at the rear, nevertheless still use a conventional six wheel layout because this is a robust and tested approach for heavy vehicles like buses. Conventional EV buses position the batteries in the roof because there is insufficient space in the chassis, given the need for the base of the chassis to be above a minimum height above the road, and for the internal floor to be as close to the road as possible.

The Arrival Bus subverts these assumptions: by careful positioning of the heavy battery modules in a skateboard-type chassis and careful design of a lightweight body (using lightweight composite panels and a lightweight extruded aluminium support structure), the Arrival Bus achieves an unladen weight (typically from 8000 Kg for a 12 m bus) that is substantially less than a conventional EV 12 m bus (which weights typically over 13,000 Kg) and also delivers 50:50 weight distribution over a front axle and a single rear axle, which in turn makes it possible to use just four wheels in total—two for each axle. Because the batteries are in or on the chassis, the centre of mass is very low down, giving a much more stable ride for passengers and a better handling for the driver.

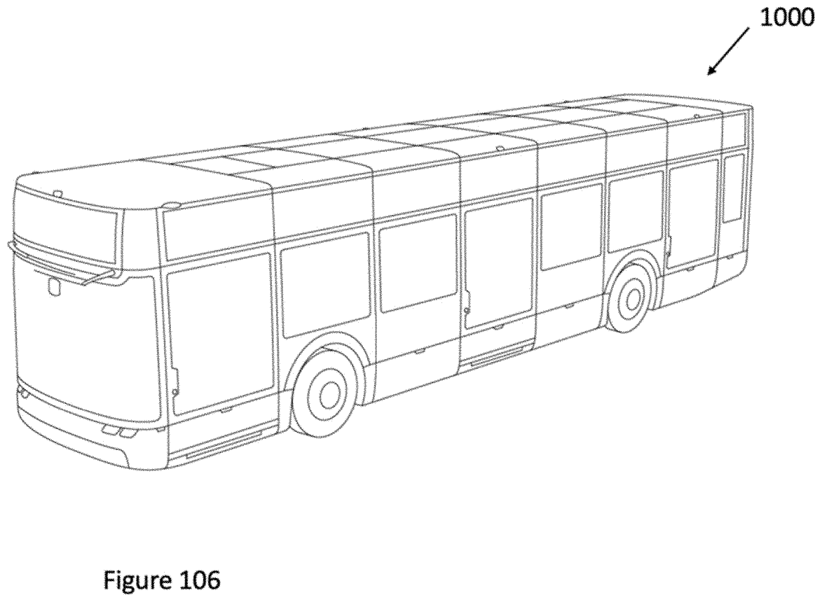

FIG. 106 shows an exterior view of the 12 m long variant of the Arrival Bus, indicated generally at 1000. A lightweight 12 m bus with 50:50 weight distribution and just 4 tyres has many advantages over conventional 12 m buses: reduced rolling resistance, reduced weight, increased power efficiency or range, improved handling, reduced cost, simplified production, simplified maintenance. Lightness in weight is mirrored in lightness inside the vehicle too: a full length panoramic glass roof gives the interior of the Arrival Bus unrivalled natural light levels.

In addition, the Arrival Bus has a low, flat floor, with a ride height approximately 360 mm above the ground, and an access height of just approximately 240 mm above the ground (and 450 mm/330 mm respectively for US buses); the low, flat floor runs from the front entrance of the bus all the way to the rearmost seats; this is possible because the entire drive train (a dual motor, dual input gearbox, with dual inverters and a drive shaft, inside each rear wheel arch) and the independent suspension systems (independent double wishbone air spring system, with telescopic dampers) are contained inside and mounted against each of the rear wheel arches; these wheel arches are each a very large, single, structural aluminium casting that replaces multiple different chassis parts and suspension mounts used in a conventional vehicle; by having a single large cast module that performs multiple different tasks, the robotic assembly process is greatly simplified, and fewer robots are needed. Further, there is no requirement to site a bulky drive train or suspension connection rod in between the driven wheels, enabling a low flat floor, even over the rear wheel axles. Passenger access into and through the bus is greatly enhanced. The Arrival Bus also features a configurable HV system, as well as a configurable ECU architecture. Finally, the Arrival Bus features a configurable seat mounting system using a cantilevered bracket that enables the floor underneath all seats to be kept entirely clear, to give the appearance of simplicity and to facilitate fast and effective cleaning.

There are nine Arrival Bus key features in this Group A:

Feature 1: Bus with 4 Tyres and Reduced Rolling Resistance

An electric bus (i) with only 4 tyres and (ii) a flat floor mounted on a chassis, and (iii) a battery pack or packs that is in, or part of, or mounted on, the chassis.

Feature 2: Bus with 50:50 Weight Distribution Improved Handling

An electric bus with two axles and 50:50 weight distribution over each axle and a flat floor mounted on a chassis, and a battery pack or packs that is in, or part of, or mounted on, the chassis.

Feature 3: Bus with Lightweight Composite Body

A bus with body panels made of composite material mounted on or including light weight extruded aluminium struts or members, delivering an unladen mass for a 12 m bus of not substantially more than 8,000 Kg-10,000 Kg.

Feature 4: Bus with Lightweight Composite Body and Panoramic Glazing

A bus with roof panels made of composite material mounted on light weight extruded aluminium struts or members, and each including a central clear or transparent section configured to form part of a panoramic roof running over substantially the entire length of the bus where passengers sit or stand.

Feature 5: Bus with a Low-Floor that is Fully Flat from the Front of the Bus to the Rearmost Seats

A low-floor bus with a flat floor running the entire length of the bus, the flat floor mounted on a chassis and extending from a front access door through the bus to the rearmost seats.

Feature 6: Bus with a Motor Mounted within a Wheel Arch

A low-floor bus, with a flat floor running the entire length of the bus, in which a drivetrain, including at least an electric motor, is mounted within a structural wheel arch.

Feature 7: Bus with Central HV Bus Bar

A bus with a central HV backbone including pre-installed connection interfaces for HV battery packs, traction inverters, and front and rear HV distribution systems.

Feature 8: Bus with Distributed ECUs

A bus with a distributed network of ECUs configured to enable de-centralised, distributed control and/or monitoring of ECUs by other ECUs

Feature 9: Bus with Seating Mounted Above a Flat Floor

A bus including passenger seats that are each cantilever mounted against a substantially vertical structural strut or beam system that forms part of the side of the bus and not the floor.

B. Arrival Bus Information Systems

The Arrival Bus is a rich information system; it uses a number of different sensors to deliver an enhanced experience for passengers, pedestrians and other road users. For example, the Arrival Bus can use internal vision or seat weight sensors to count the number of available seats and display that information on a wrap-around display panel running around the entire top of the bus, just below the roof; this can also display real-time traffic information and the predicted journey time between stops on its route, taking into account real-time traffic information. A computer vision system can be utilised as part of an input to the air suspension control system, enabling dynamic, real-time adjustment of the air suspension; for example, the computer vision system can analyse passenger behaviour and automatically alter the air suspension to improve passenger comfort; it can detect whether standing passengers are swaying excessively and automatically stiffen the air suspension. Weight sensors can be used to measure the total passenger weight and ensure that the bus is never operated when over-loaded. A capacitive touch-free ‘stop request’ sensor is used in the bus: a passenger merely has to place their hands over a sensor for a pre-set time, or until there is visual or haptic feedback. The Arrival Bus can also detect if children are leaving the bus and display an alert (e.g. on a display on the back of the bus) so that drivers can be made aware and take care.

All of this contributes to making bus travel safer, more comfortable, better informed and more convenient.

Key features for this Group B are:

Feature 10: Displaying Sensor-Derived Environmental Information

A vehicle with an exterior display system operable to display environmental information that (i) relates to the environment external to the vehicle, and (ii) has been derived from data sources that are external to and remote from the vehicle.

A vehicle with an exterior display system operable to display environmental information that (i) relates to the environment internal to the vehicle, and (ii) has been derived from data sources that are internal to or integral with the vehicle.

A vehicle with an exterior display system operable to display environmental information that (i) relates to the environment external to the vehicle, and the environment internal to the vehicle, and (ii) has been derived from data sources that are internal to or integral with the vehicle, as well as external to and remote from the vehicle.

Feature 11: Passenger Location Analysis

A bus with a passenger analysis system that automatically generates data on the location or other spatial distribution of passengers in the bus, or intended passengers for the bus, using one or more external and/or internal sensors located in or on the bus, such as a computer vision system.

Feature 12: Bus with Behavioural Modelling

A bus with a passenger analysis system that automatically generates data on the behaviour of passengers in the bus, or intended passengers for the bus, using a computer vision system; and automatically initiating a bus operation depending on data from the computer vision system.

Feature 13: Displaying Dynamic, Environment-Based Advertising Content

A bus with a display (e.g. external or internal) connected to a content server that generates or selects advertising content for the display; in which one or more dynamic parameters selected to be relevant to passengers on the bus or people outside the bus are tracked and the server generates or selects advertising content based on the real-time value of the parameters.

Feature 14: Contactless ‘Stop Request’ Sensor

A vehicle including a single function proximity-sensitive sensor that is tuned to (i) detect the proximity of a hand without the need to contact the sensor and (ii) to send a control input to a bus control system.

Feature 15: Wrap-Around Display Screen

A vehicle including a series of display screens that extend along substantially the entire length of the bus, over all doors, and runs along substantially all of the front and rear of the bus, giving the appearance of a display that substantially wraps around the bus.

Feature 16: Bus with Weight Sensors

A bus with weight sensors configured to measure the total passenger weight, e.g. axle weight sensors that generate an alert to the driver if the total passenger weight exceeds a threshold. Whilst this Section J focuses on the Arrival Bus, the same Group B features may also be deployed for other vehicle types, such as cars, especially ride-hailing vehicles or taxis. The term ‘bus’ can therefore be expansively construed to any vehicle type for these Group B features.

C. Arrival Bus Ticketing Features

The Arrival Bus uses sensors in the bus to deliver an enhanced ticketing experience for passengers. For example, the sensors (e.g. AI-based computer vision sensors; weight sensors on each seat; weight sensors on the vehicle axles) can detect if there are no seats available, or the number of standing passengers exceeds a threshold, and automatically lower the ticket pricing for new passengers. The sensors can detect which seats are available in real-time and enable a passenger (e.g. on the bus or waiting for it) to buy a ticket for a specific, available seat. If the bus activates air-conditioning, then tickets can be automatically re-priced. The display screens around the bus can indicate when reduced or premium pricing is being applied.

All of this contributes to making bus travel safer, more comfortable and more convenient.

The key features in this Group C are:

Feature 17: Differential Bus Ticket Pricing Based on Sensor Data.

A bus ticketing system configured to generate bus tickets with pricing dependent on real-time data from one or more sensors in the bus which determine the bus occupancy or number of standing or seated passengers. e.g. reduced pricing if numbers of standing passengers exceeds a threshold.

Feature 18: Bus Tickets Sold for Specific Unoccupied Seats Based on Real-Time Sensor Data

A bus ticketing system configured to generate a bus ticket for a specific seat dependent on real-time data from one or more sensors in the bus, which determine occupancy for that specific seat.

Feature 19: Dynamic Pricing of Seats Based on Real-Time Temperature Sensor Data

A bus ticketing system configured to generate a bus ticket with pricing dependent on real-time data from one or more sensors or control devices.

D. Arrival Bus Utilisation Measurement Features

Bus operators conventionally assess bus usage based on simple metrics like miles/km driven and tickets sold; these are important metrics, but can give a simplified and possibly distorted view of actual utilisation, especially where there are significant numbers of passengers that are riding illegally without a ticket. Regulatory compliance (e.g. ensuring that there is no illegal over-crowding) is also difficult and too readily ignored. The Arrival Bus directly addresses these problems with sophisticated automated people counting systems and bus usage systems. These enable: increased passenger comfort and safety; selection of a lower capacity battery pack (which is lighter than a larger pack, leading to a lighter and hence more energy efficient bus); more effective route planning and scheduling, based on actual usage data; reduction in fare non-compliance; enhanced advertising revenue based on actual passenger viewing data.

Because the Arrival bus has sophisticated bus usage systems that take into account the actual passenger weights being carried by the bus, this enables a more accurate assessment of the residual value of the batteries for second-life applications; more accurate predictive maintenance scheduling; and more accurate modelling of the predicted lifetime of the batteries in the bus.

The key features for this Group D are:

Feature 20: Bus with Ticketing System and Vehicle Weight Sensing

A bus configured with (i) a ticketing system that tracks the numbers of tickets issued to passengers and (ii) a weight sensor system to measure the weight of passengers in the bus and (iii) an analysis system to determine if the weight of passengers at a given time is consistent with the number of tickets issued to passengers travelling on the bus at that time.

Feature 21: Bus with Ticketing System and People Counting

A bus configured with (i) a ticketing system that tracks the numbers of tickets issued to passengers and (ii) a computer vision based passenger counting system and (iii) an analysis system to determine if the number of passengers counted at a given time is consistent with the number of tickets issued to passengers travelling on the bus at that time.

Feature 22: Bus with Sensors Recording Dynamic Usage

A bus with sensors in the bus that measure bus dynamic usage, such as how many stops/starts, acceleration data, deceleration data, load under acceleration, load under deceleration, range travelled, battery charging data, battery state of health data; and that data is used when determining a residual value for components in the bus.

Feature 23: Bus with Use-Based Maintenance Schedule

A bus generating maintenance schedule based on data from sensors in the bus that (i) measure vehicle weight and (ii) measure bus dynamic usage, such as how many stops/starts, acceleration data, deceleration data, load under acceleration, load under deceleration, range travelled, battery charging data, battery state of health data.

Feature 24: Method of Modelling the Predicted Lifetime of Components

A method of modelling the predicted lifetime of components in a bus using data from sensors in the bus that (i) measure vehicle weight and (ii) measure bus dynamic usage.

E. Bus Configurability—e.g. Automated Customer Configuration Using Vehicle Builder and Automated Production Using Robofacturing at a Microfactory

The Arrival Bus can be readily customised to the specific requirements of a purchaser, typically a city or county public transit or transportation authority. Different purchasers can have widely different requirements in terms of many features of the bus, such as length, number of seats, seating configuration, battery pack capacity, information screens, advertising screens, passenger monitoring etc. The Arrival software-based and highly automated vehicle design system (Vehicle Builder—see Section D) is flexible enough to automatically configure the layout and all power/data connections required for different configurations selected by different customers; Robofacturing and Microfactories (See Section F) are flexible enough to put into production the vehicle; efficient customisation to meet a purchaser's exact requirements is possible. The highly modular Arrival system therefore offers far greater flexibility than earlier system in enabling the vehicle dimensions (length, width, height), specific seating configuration, cost, range, power and lifetime needs of customers to be met, and for their evolving needs to be met as well. With the highly modular Arrival system, it becomes straightforward to design and produce even relatively low volumes of buses that have the configurations that are optimal for the intended requirements of the customer.

The key features for this Group E are:

Feature 25: Modular Transverse Chassis Sections

A vehicle that includes a structural chassis made up of multiple, modular transverse chassis sections that are configured to be joined together by a robotic production system to provide a vehicle of the required dimensions.

Feature 26: Robotic, Cell Based Production

A method of producing a vehicle, in which a robotic production system assembles, at a cell of robots at a fixed location, and not a moving production line, at least part of the vehicle by robotically attaching components together to form parts of the vehicle, and substantially an entire vehicle is assembled at multiple such cells.

Feature 27: Cell with Self-Governing Robots

A robotic production cell for vehicle production, comprising a group (e.g. 2 to 10) of self-governing robots that are programmed to dynamically work out amongst themselves, arbitrating as required, and execute the optimal production process for each new vehicle they build.

Feature 28: The Microfactory

A vehicle production factory comprising a number of robotic production cells for vehicle production, each cell comprising a group of robots that are programmed to assemble, at a fixed location and not a moving production line, at least part of the vehicle by robotically attaching components together to form parts of the vehicle, and substantially an entire vehicle is assembled at multiple such cells.

Feature 29: Bus with Customer-Specified Battery Capacity

An electric bus design and production process, the bus including multiple batteries;
in which a customer specifies the battery capacity or range required for a specific new bus or fleet of buses, and an automated vehicle design tool then automatically selects battery-related components required for the specified battery capacity or range; and automatically generates build instructions for that vehicle or fleet of vehicles;
and a robotic production environment then automatically builds or assembles the bus as designed by the automated vehicle design tool, including a battery pack that meets the specified battery capacity or range.

Feature 30: Vehicle with Integrated, Customer-Specified Sensors

An electric bus design and production process, the vehicle including multiple sensor based systems, such as ADAS, LIDAR, computer vision based driver monitoring, computer vision based passenger monitoring, load or weight sensors;
in which a customer specifies which sensor based systems or their related functionality are required for a specific new bus or fleet of buses, and an automated vehicle design tool then automatically selects components required for the specified sensor based systems or their related functionality; and automatically generates build instructions for that vehicle or fleet of vehicles;
and a robotic production environment then automatically builds or assembles the bus as designed by the automated vehicle design tool, integrating the sensor based systems into the bus.

Feature 31: Post-Production Change to a Different Battery Pack Capacity

An electric bus with an original factory-installed battery pack, including multiple battery modules, with a specific battery capacity;
in which the bus is configured to enable the original battery pack to be altered by adding one or more further battery modules to the battery pack, or removing one or more battery modules from the battery pack.

Feature 32: Post-Production Update of Integrated, Customer-Specified Sensors

An electric bus with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the bus' data and security network and systems.

### BRIEF SUMMARY OF THE FIGURES RELATING TO THIS SECTION J

Various implementations of the Arrival Bus are shown in the accompanying figures, in which:

FIGS. 106-108 are perspective, side and front views of the 12 m Arrival Bus.

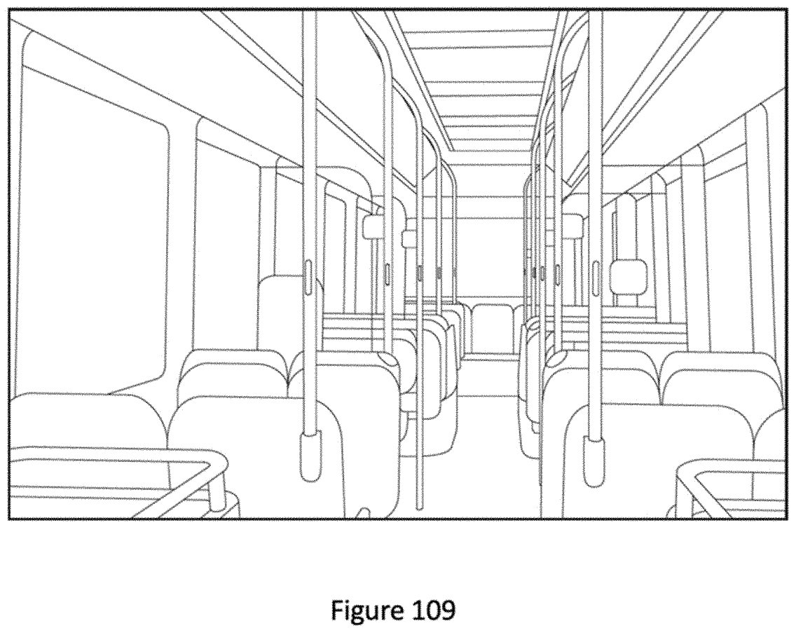

FIG. 109 is an internal view.

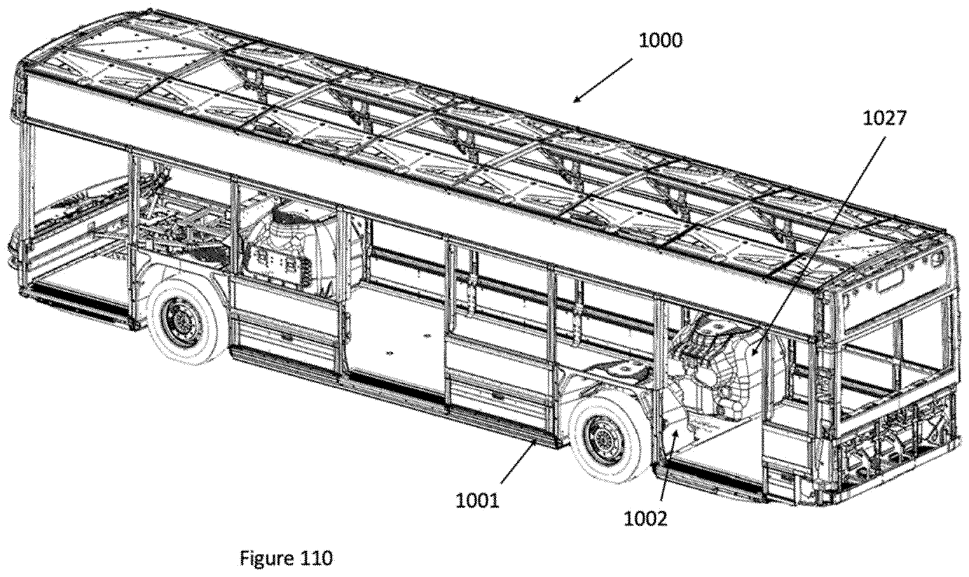

FIG. 110 is a cut-away showing the main structural elements

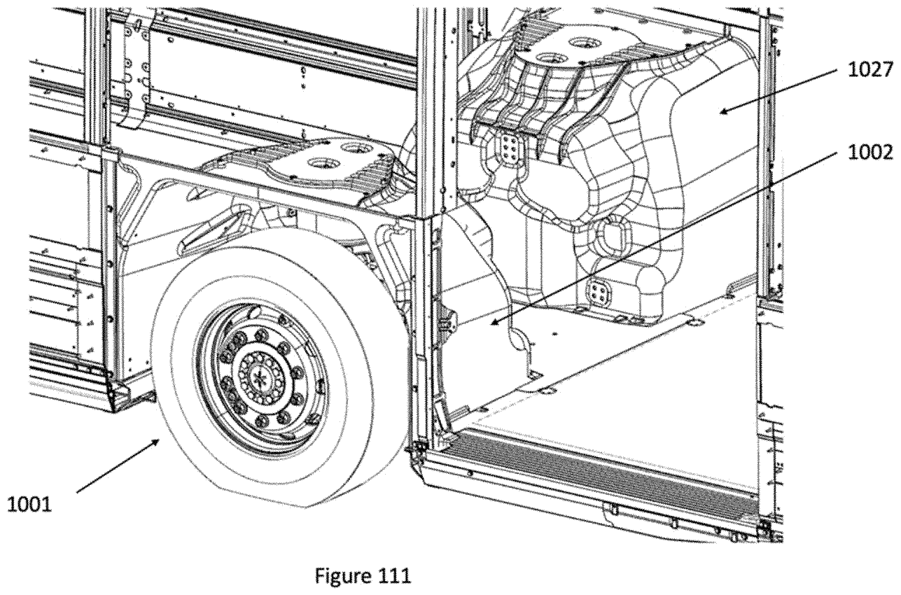

FIG. 111 shows the rear wheels and related structural wheel arches

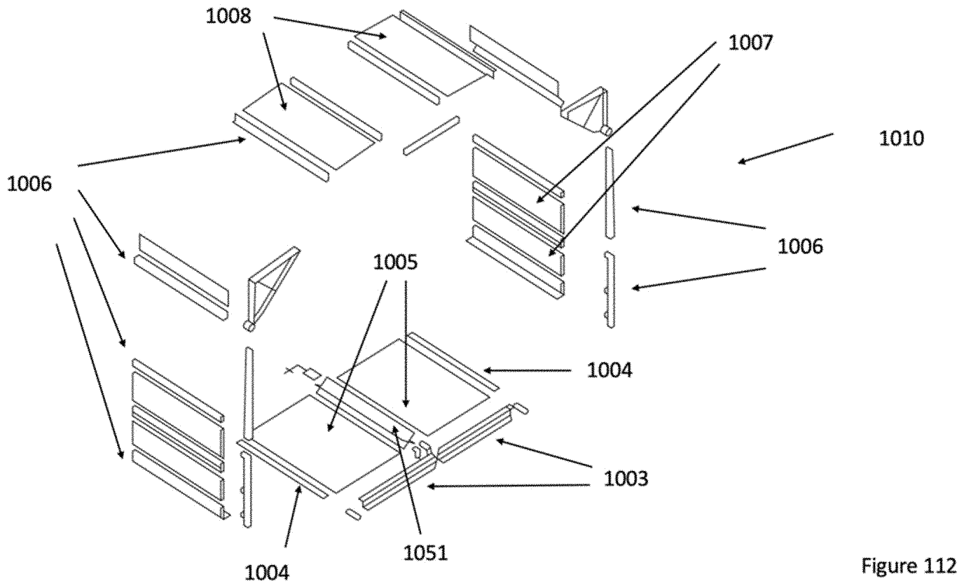

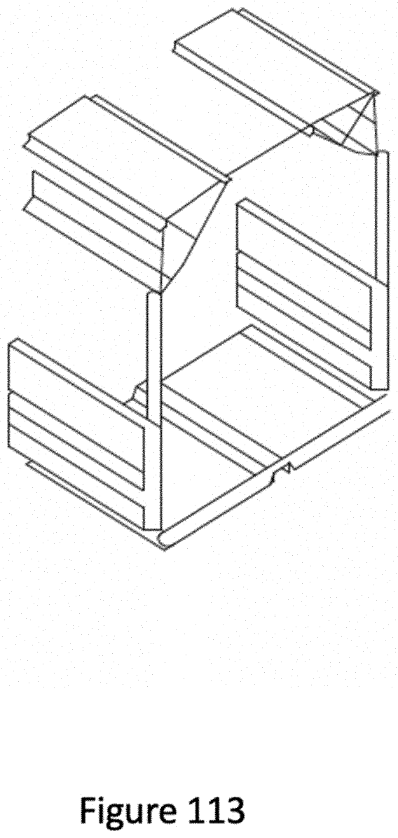

FIGS. 112-113 are exploded and non-exploded views of the main structural elements in a single transverse chassis section

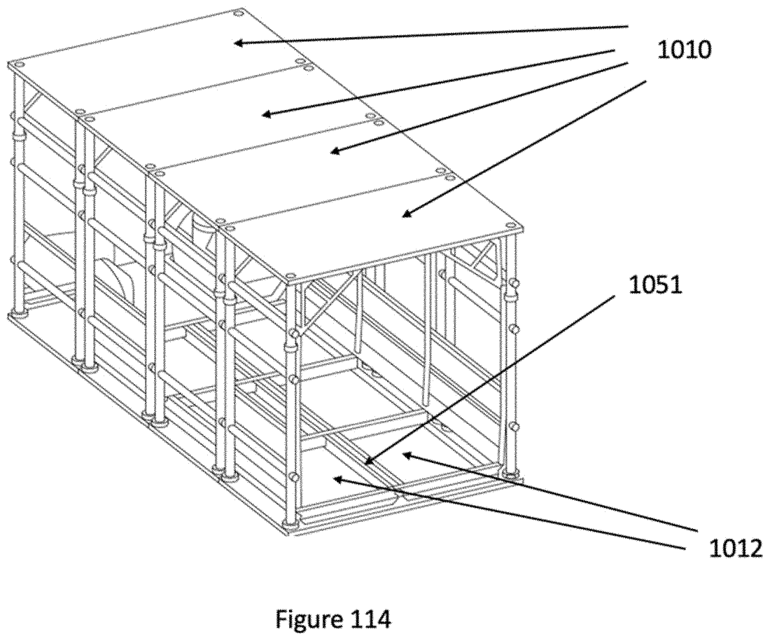

FIG. 114-FIG. 116 shows a build sequence in which several transverse chassis sections are joined together

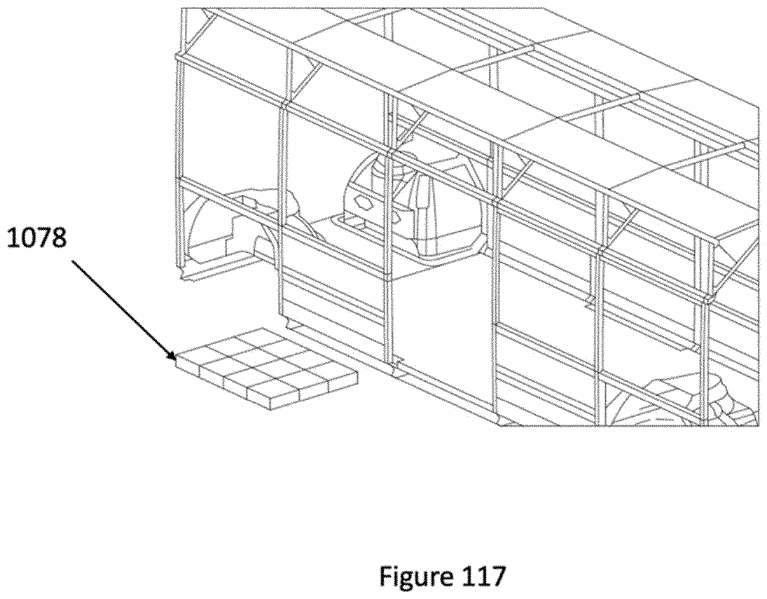

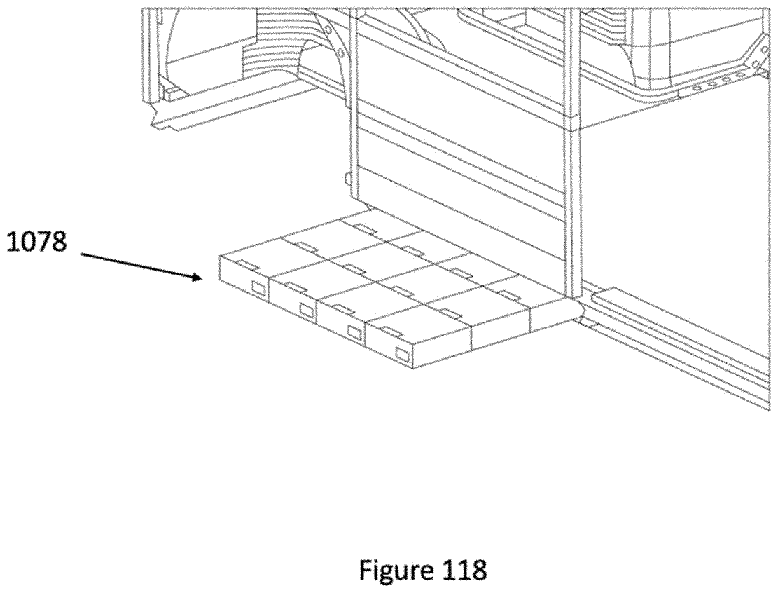

FIGS. 117-118 shows the battery pack insertion sequence

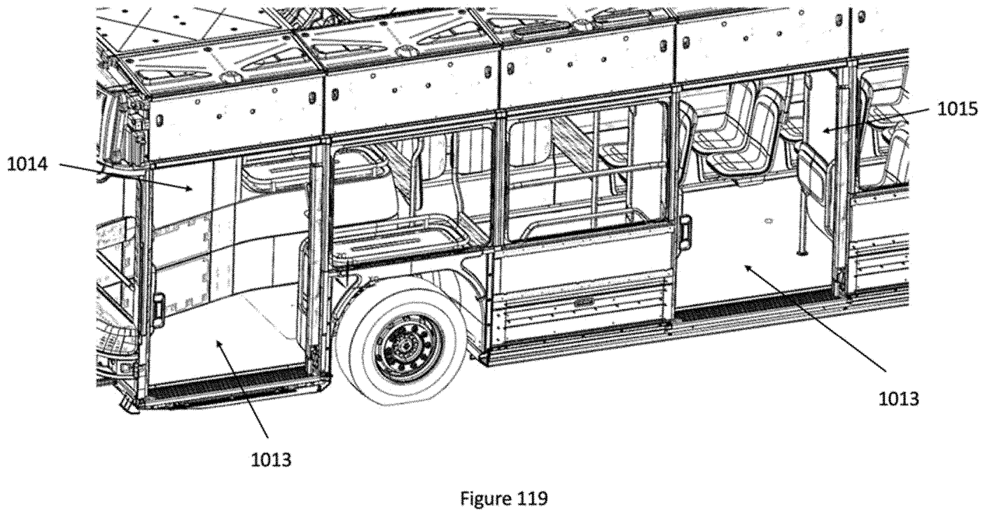

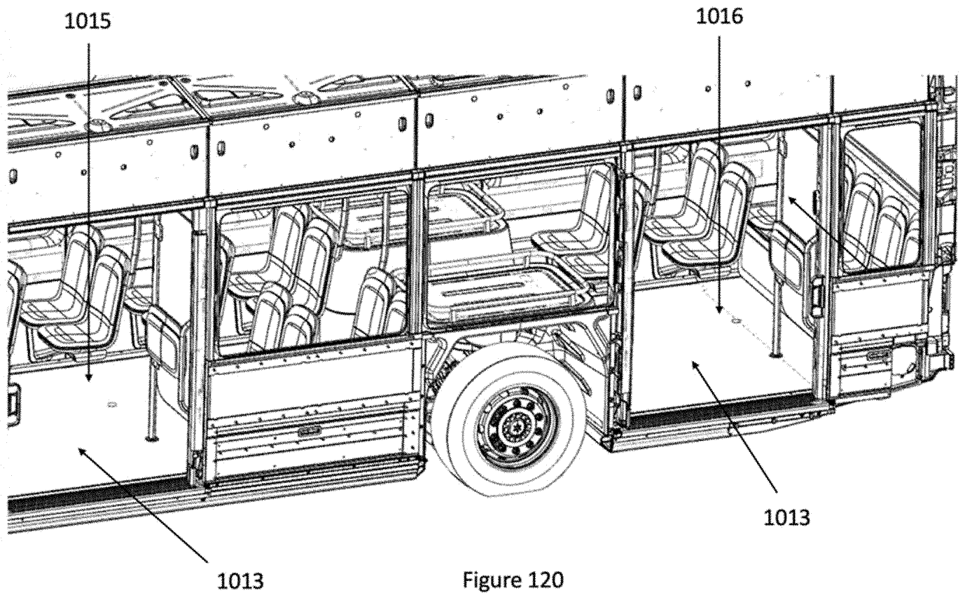

FIGS. 119-120 is a cut-away, showing the single level flat floor running through the bus

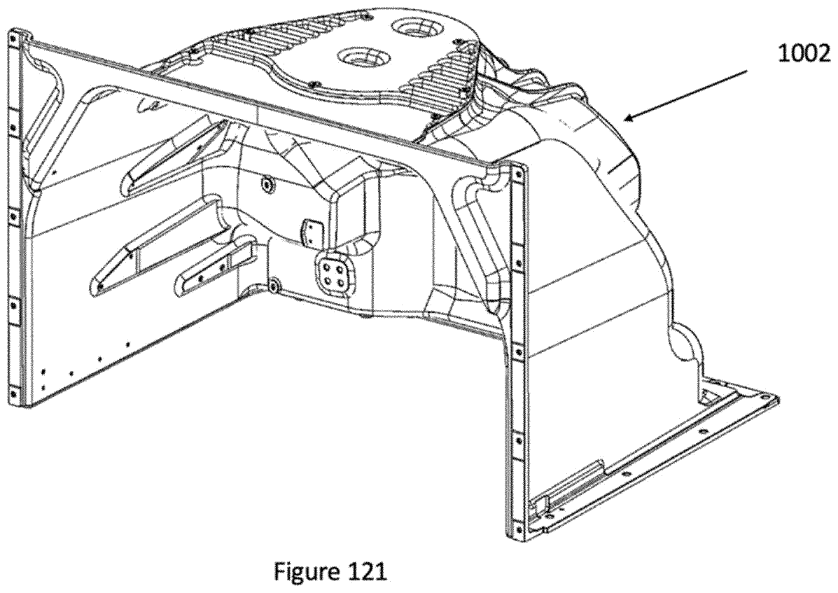

FIGS. 121-124 show the structural cast aluminium wheel arches and related components

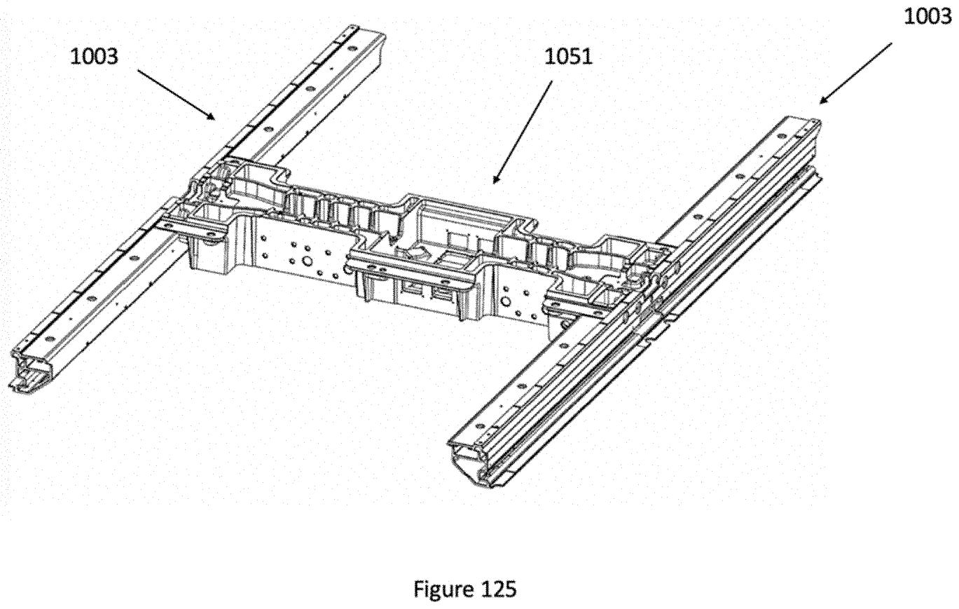

FIG. 125 shows the structural chassis transverse and longitudinal beams

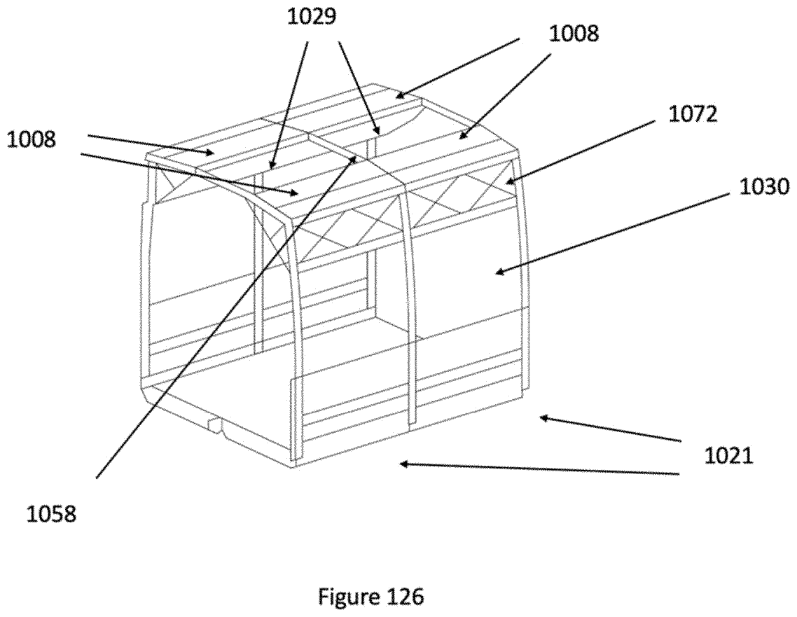

FIG. 126 shows the transverse chassis section including glass roof lights openings

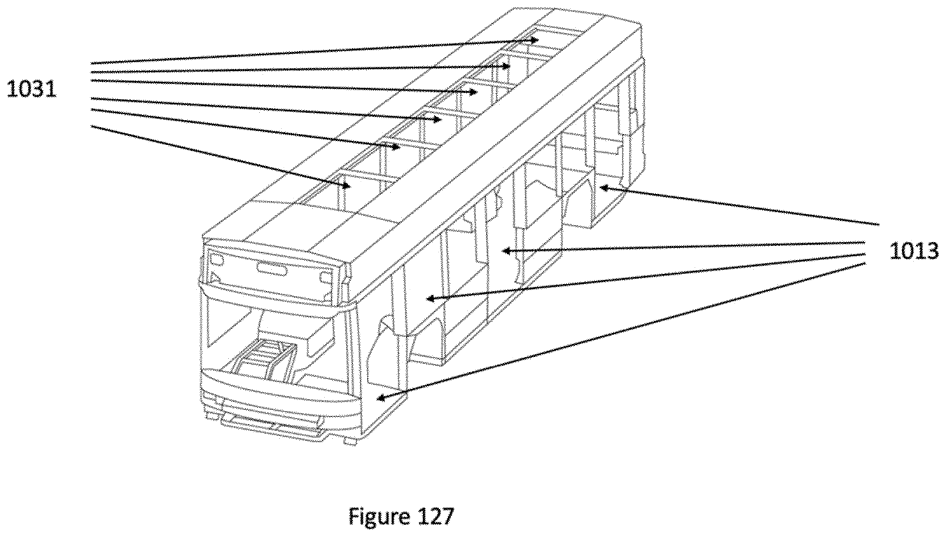

FIG. 127 shows the main structure of the Bus, with single, low flat floor and roof lights

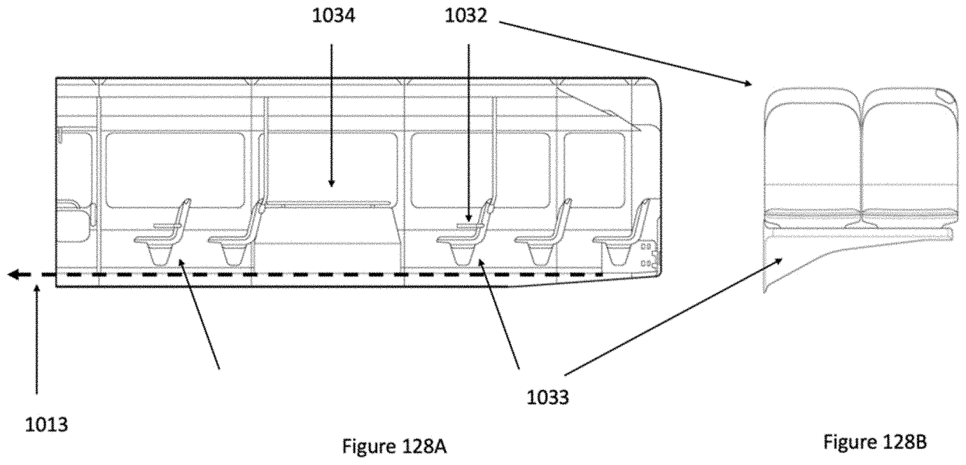

FIG. 128 shows the single, low flat floor and cantilever mounted seating

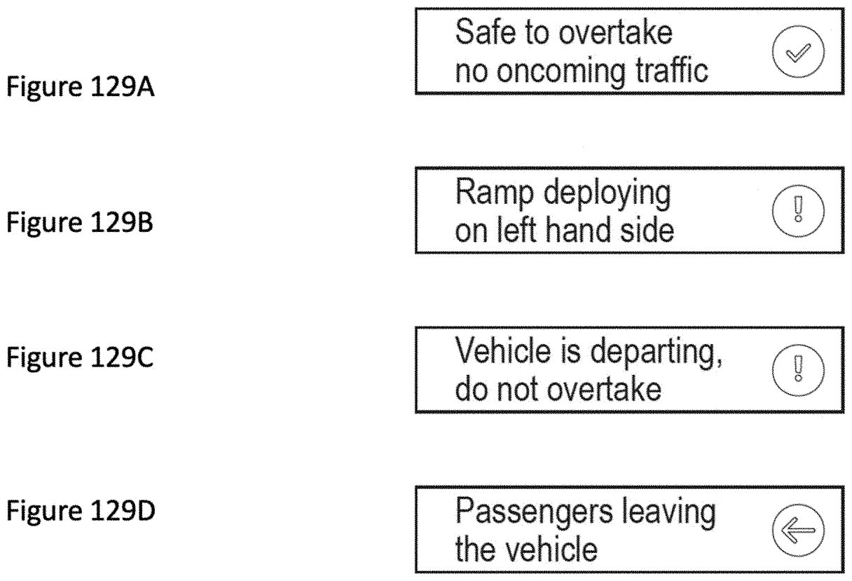

FIGS. 129-132 shows display screen content

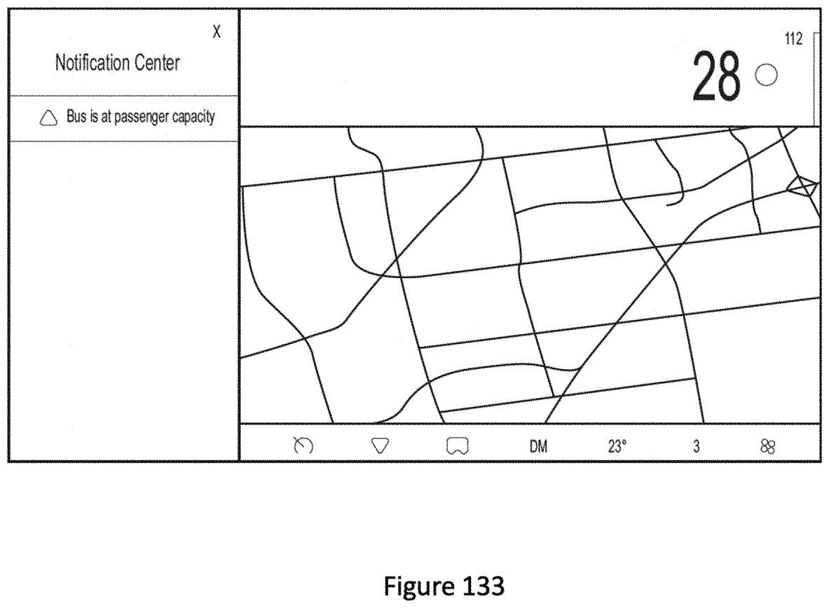

FIGS. 133-135 show driver display screen content

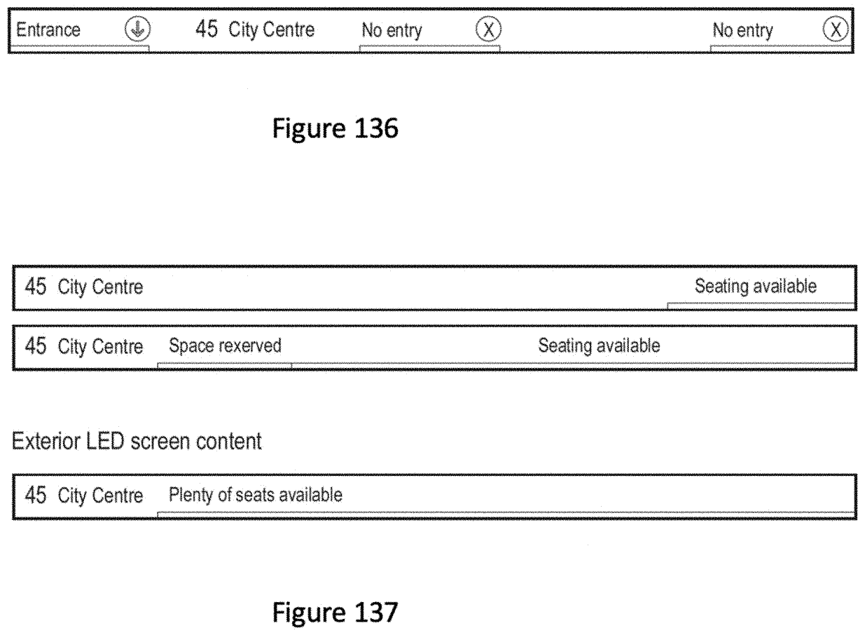

FIGS. 136-138 show display screen content

FIG. 139 shows mobile phone app content

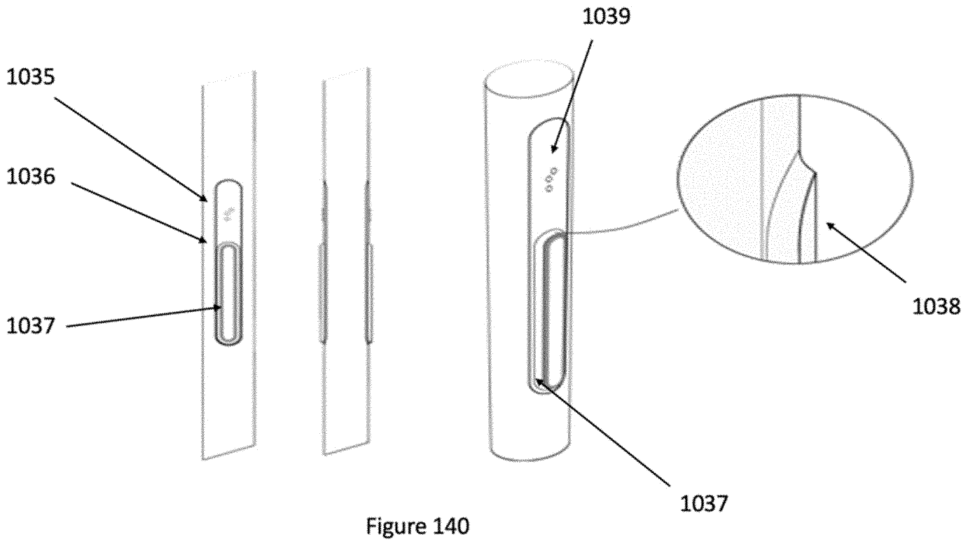

FIGS. 140-142 shows the ‘stop request’ sensor and related mobile phone app content

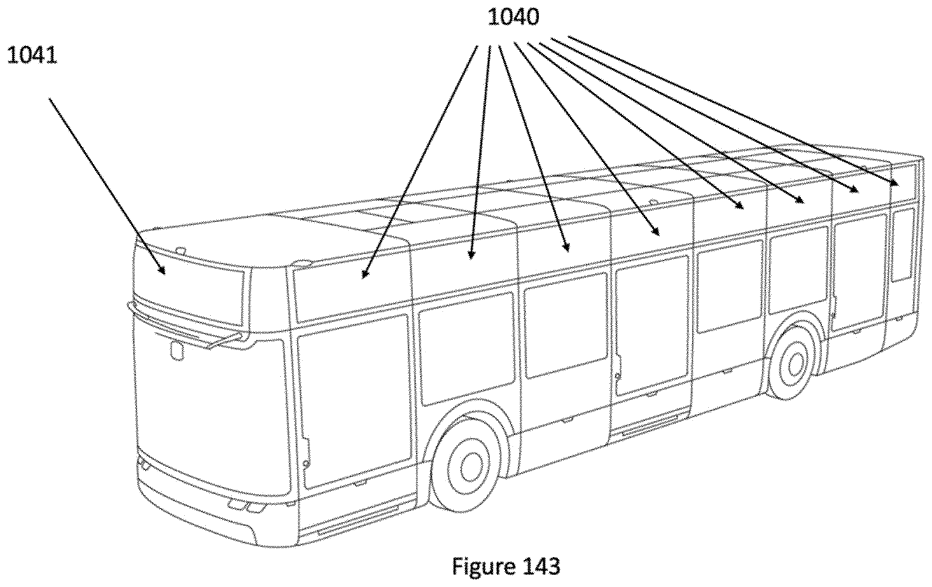

FIG. 143 shows the external full length display panels

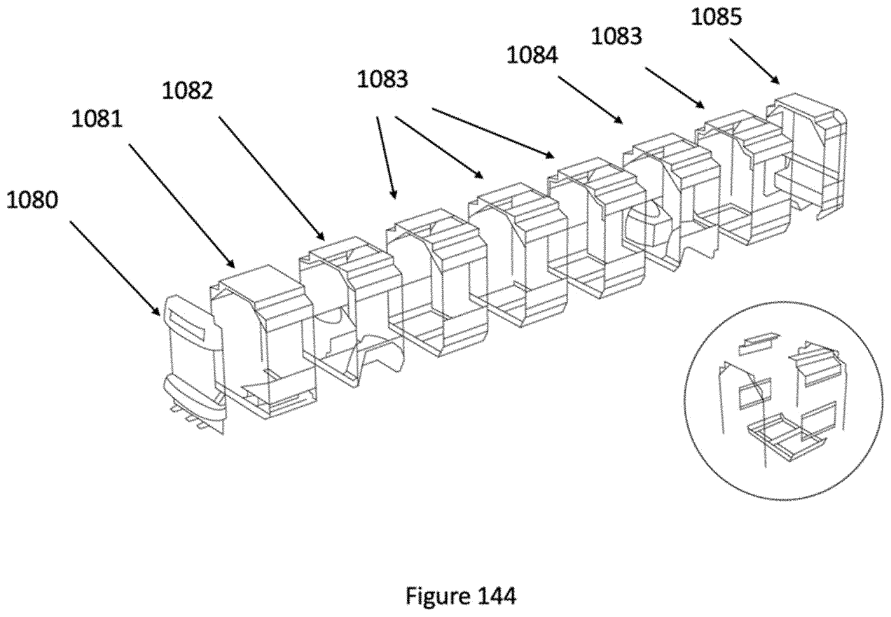

FIG. 144 starts the sequence of figures showing the robotic build sequence; this shows all of the transverse chassis sections that need to be assembled and brought together to form the Bus.

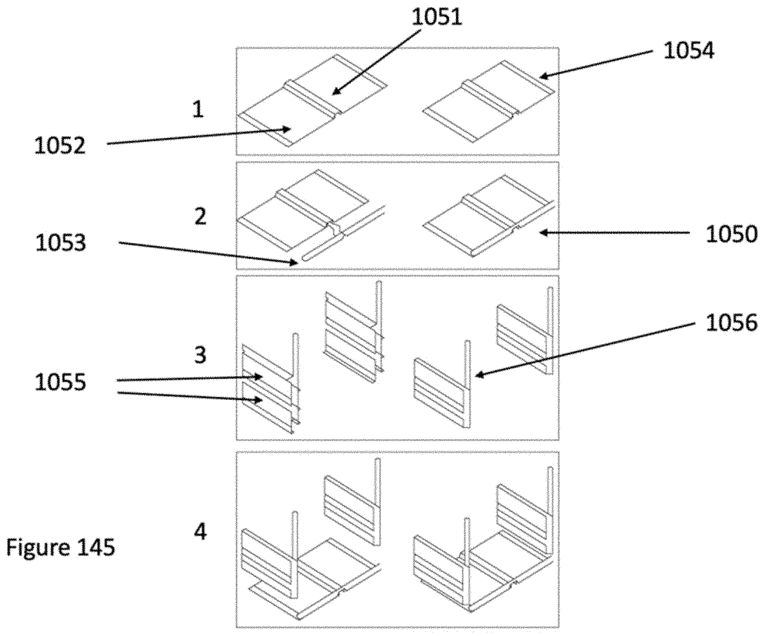

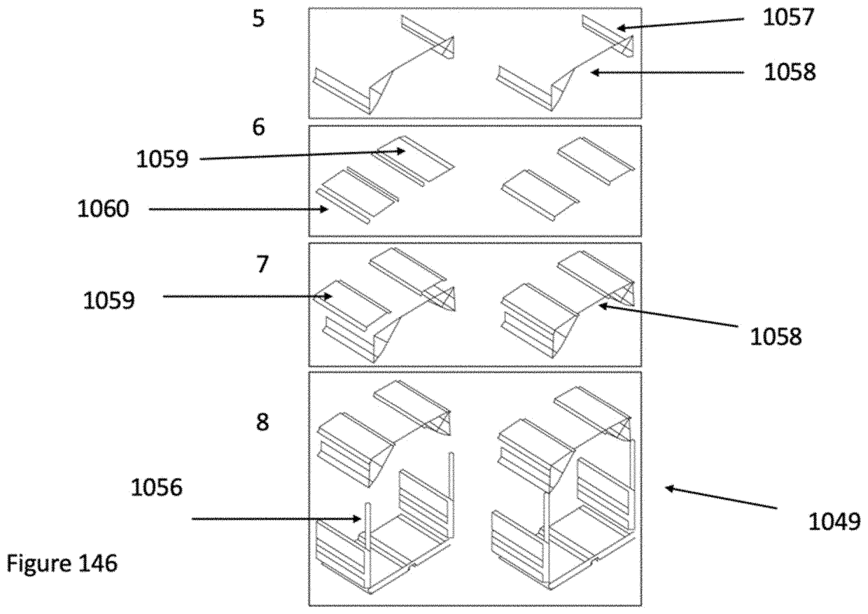

FIGS. 145-146 summarise the complete build sequence for a single transverse chassis section

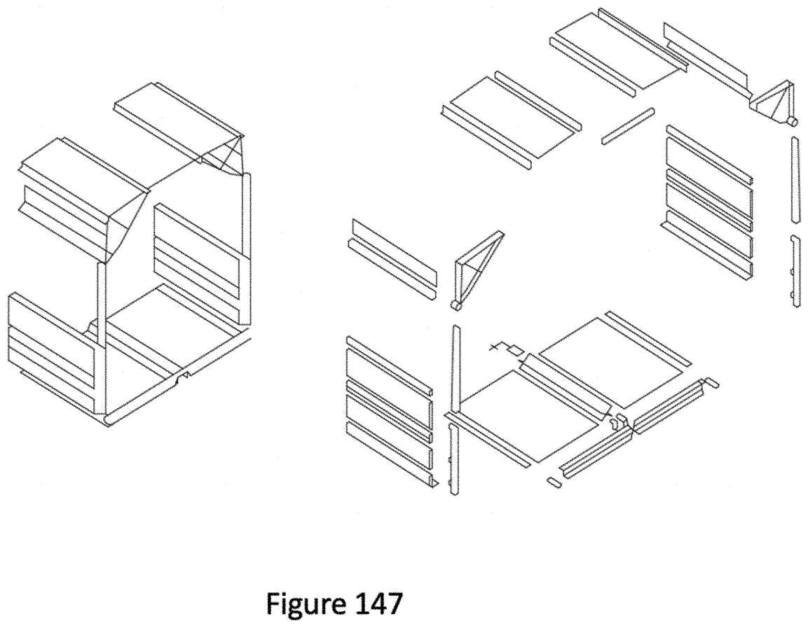

FIG. 147 shows the main parts of a transverse chassis section

FIG. 148 shows how some of the roof parts join together

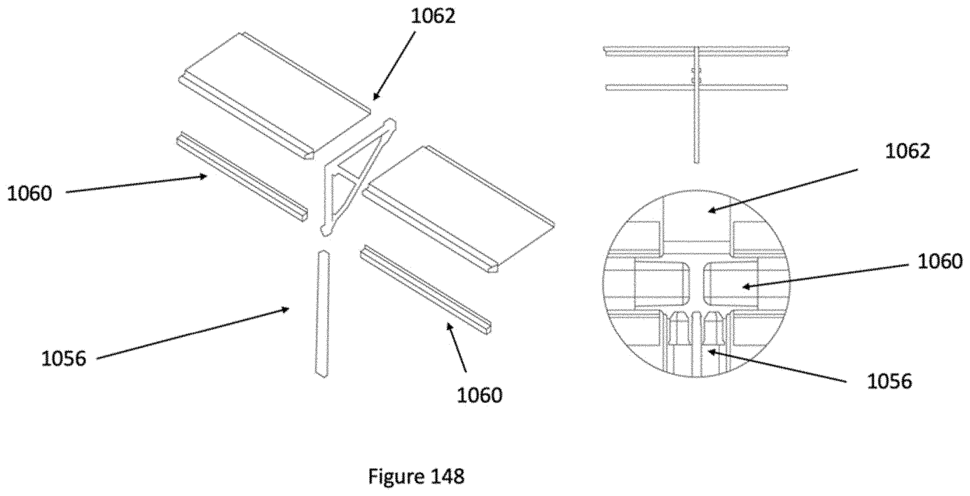

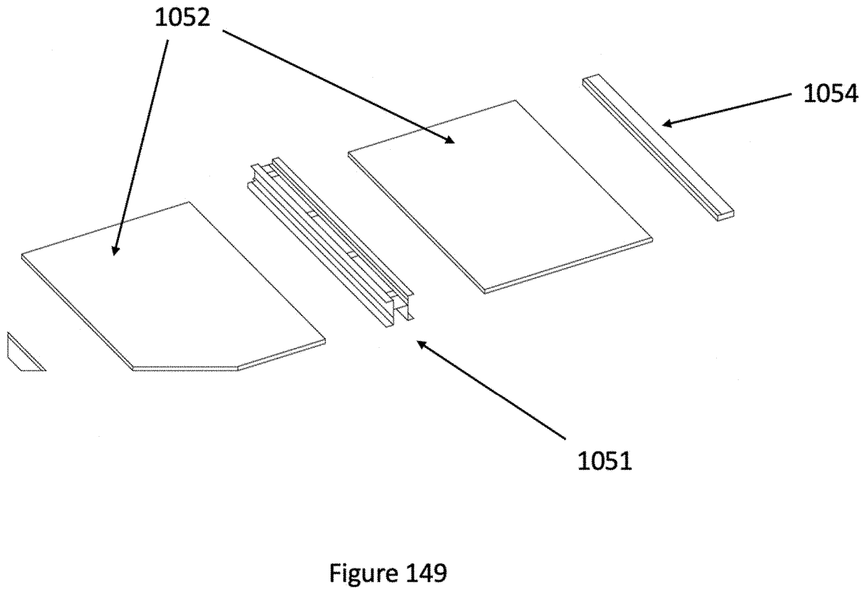

FIG. 149 starts the complete build sequence, starting with the central beam

FIGS. 150-156 continue the build sequence for the base of a transverse chassis section

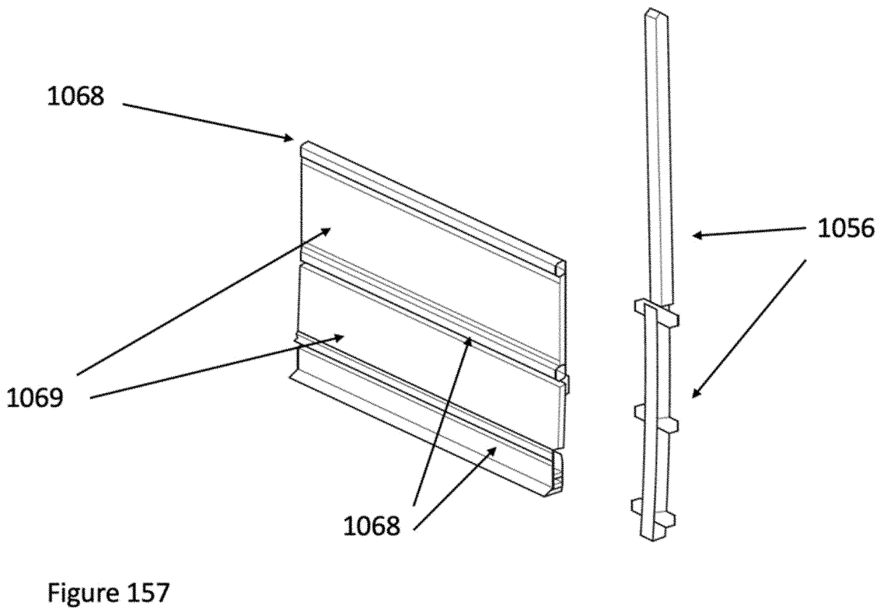

FIGS. 157-162 show the side and roof build sequence and the install on to the base

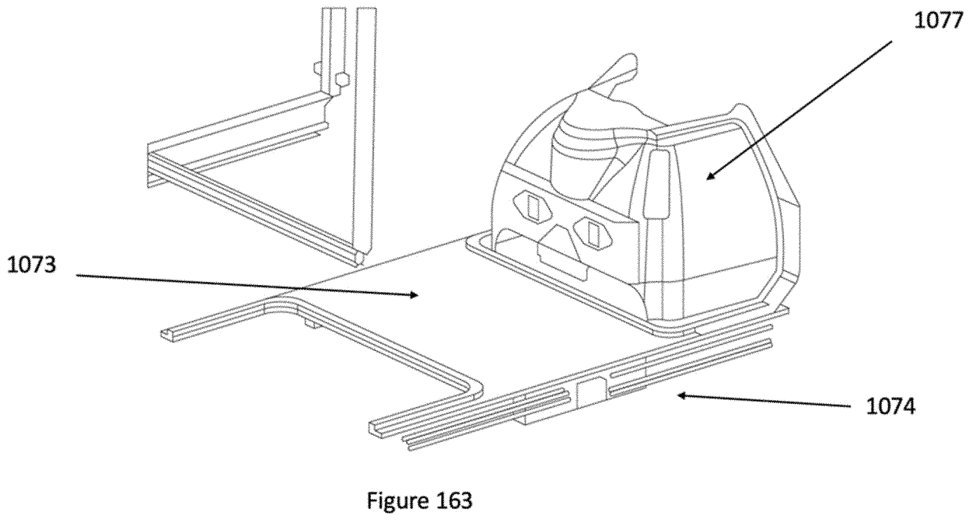

FIG. 163 shows a wheel arch base section

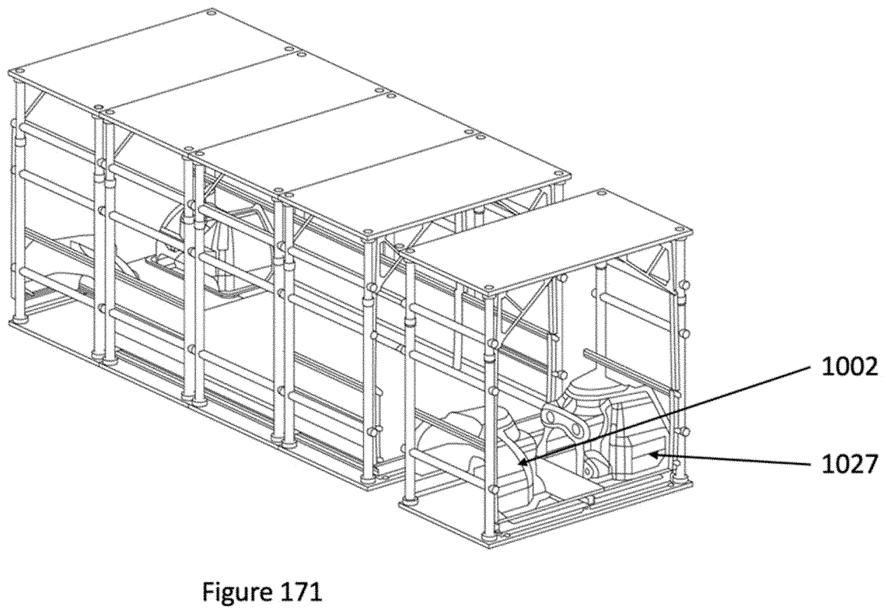

FIGS. 164-171 shows assembling together multiple transverse chassis sections

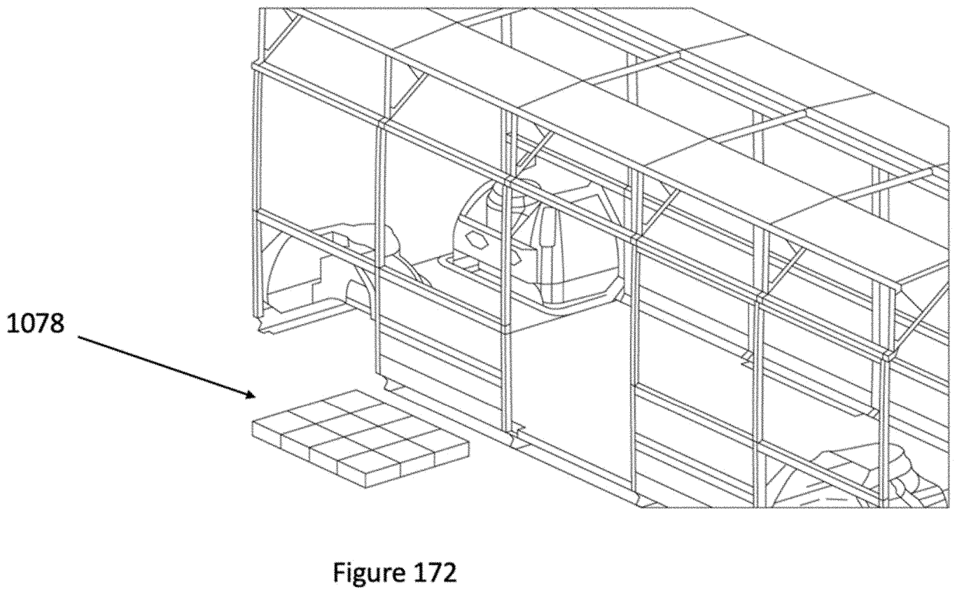

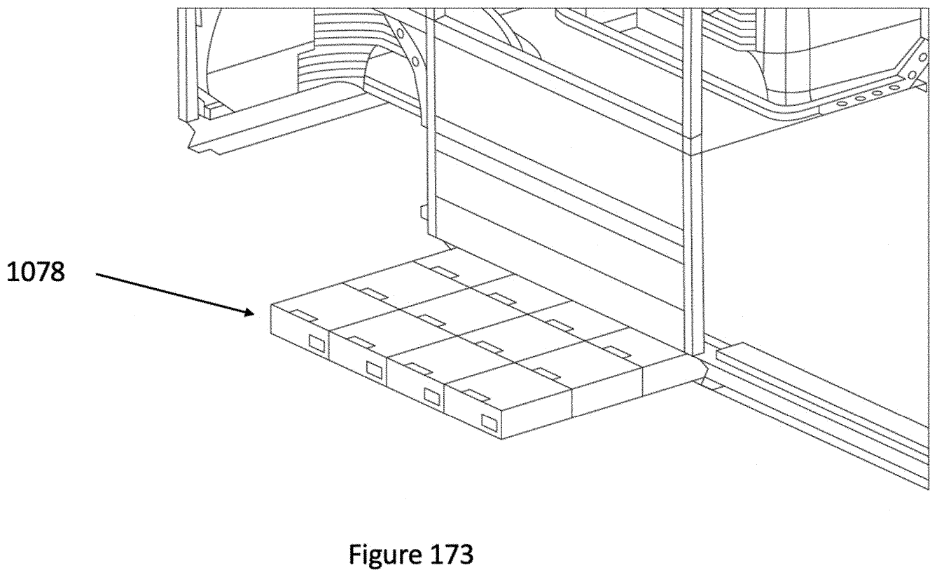

FIGS. 172-173 shows installing battery modules into the chassis

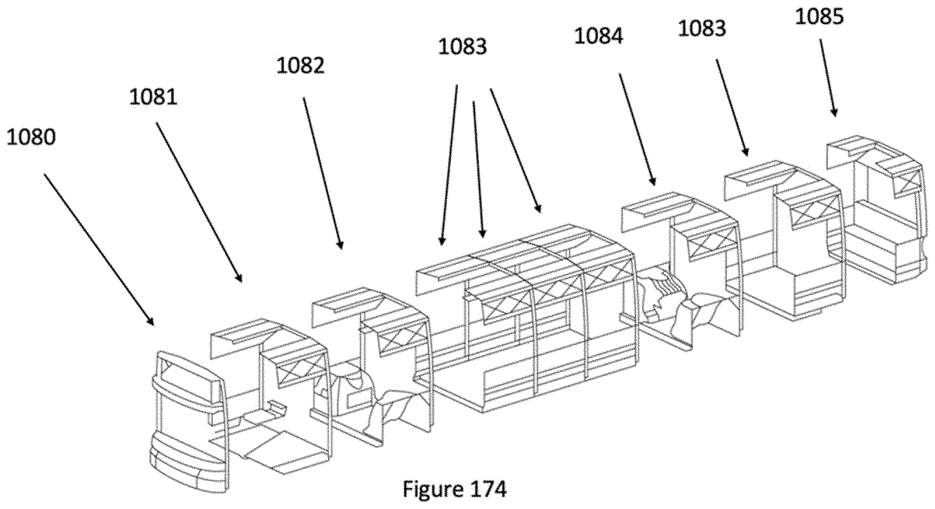

FIG. 174 shows an exploded view of all of the transverse chassis sections in a bus

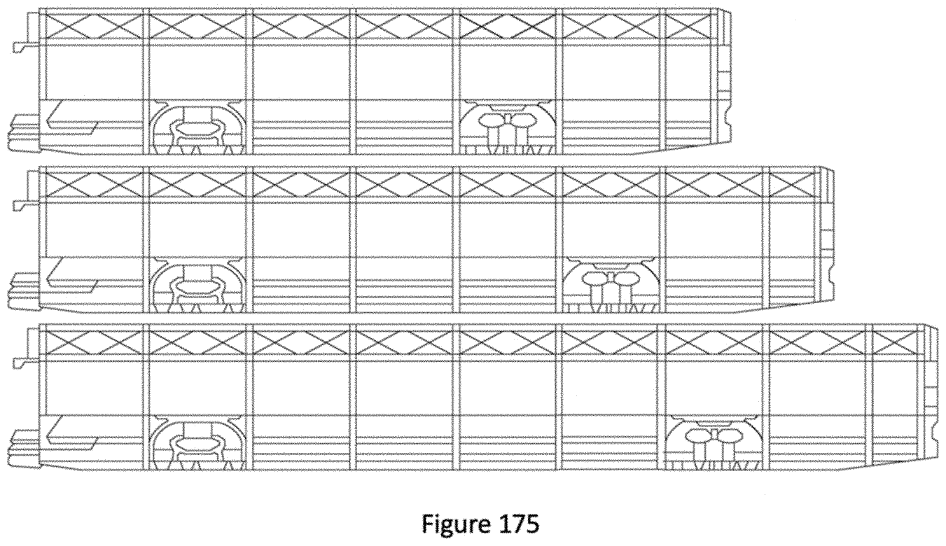

FIG. 175 shows the transverse chassis sections in three different lengths of Bus.

### FIGS. 106-175 Index

| Reference | |
|---|---|
| numeral | Description of item |
| 1000 | Bus |
| 1001 | tyre |
| 1002 | single large, structural aluminium wheel arch casting, left side |
| | rear |
| 1003 | transverse structural chassis beam |
| 1004 | longitudinal structural chassis beam |
| 1005 | floor panels |
| 1006 | lightweight extruded aluminium struts |
| 1007 | composite body panel |
| 1008 | composite roof panel |
| 1009 | chassis platform floor |
| 1010 | transverse bus section |
| 1012 | battery module bay |
| 1013 | full length single level, flat passenger floor |
| 1014 | front access door opening |
| 1015 | middle access door opening |
| 1016 | rear access door opening |
| 1017 | electric motor |
| 1018 | dual input gearbox |
| 1020 | suspension arms |
| 1021 | disc brake |
| 1022 | wheel mount or flange |
| 1023 | air suspension piston |
| 1024 | portion of wheel arch casing around left side motor |
| 1025 | portion of wheel arch casing around right side motor |
| 1026 | portion of wheel arch casing around gearbox |
| 1027 | right side rear wheel arch |
| 1029 | central roof void for roof light |
| 1030 | side window opening |
| 1031 | panoramic roof lights |
| 1032 | passenger seat |
| 1033 | cantilever support for passenger seat |
| 1034 | luggage store over wheel arch |
| 1035 | stop request sensor |
| 1036 | passenger hand pole |
| 1037 | stop request light ring |
| 1038 | raised part of stop request sensor |
| 1039 | braille markings |
| 1040 | Display panel module along side of the bus |
| 1041 | Display panel module at front of the bus |
| 1049 | modular transverse chassis section |
| 1050 | base of the modular transverse chassis section |
| 1051 | extruded aluminium central beam |
| 1052 | composite sandwich panel |
| 1053 | extruded aluminium transverse beam, chassis |
| 1054 | extruded aluminium longitudinal beam; chassis |
| 1055 | composite side panels |
| 1056 | vertical beams or struts |
| 1057 | roof longitudinal structural members |
| 1058 | roof transverse structural members |
| 1059 | composite roof panels |
| 1060 | roof longitudinal structural extruded aluminium section |
| 1061 | roof support ladder frame |
| 1062 | triangular roof corner structural aluminium casting |
| 1063 | structural aluminium base |
| 1064 | circular sockets in aluminium base |
| 1065 | high voltage bus bars |
| 1066 | HVAC conduit |
| 1068 | extruded aluminium longitudinal sections; bus side structure |
| 1069 | composite side panels |
| 1070 | extruded aluminium ladder frame |
| 1072 | display panel void in the side frame |
| 1073 | single extruded or cast aluminium sheet, with two large ‘C’ |
| | shapes for the wheel arches |
| 1074 | transverse side of the single extruded or cast aluminium sheet, |
| | with two large ‘C’ shapes for the wheel arches |
| 1075 | flat floor that covers battery module bays |
| 1077 | front structural wheel arch |
| 1078 | battery modules |
| 1080 | front of bus transverse chassis section |
| 1081 | driver and access door transverse chassis section |
| 1082 | front wheel arches transverse chassis section |
| 1083 | standard passenger transverse chassis section |
| 1084 | rear wheel arches transverse chassis section |
| 1085 | rear of bus transverse chassis section |

### DETAILED DESCRIPTION RELATING TO THIS SECTION J

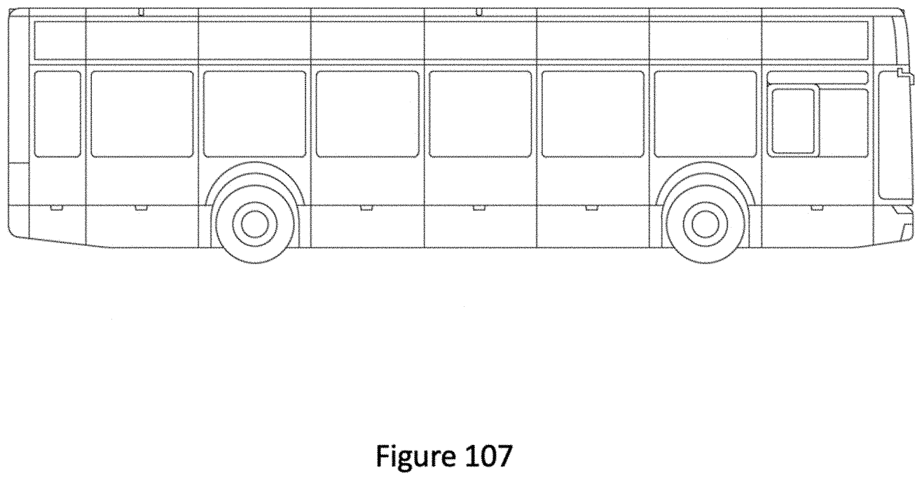

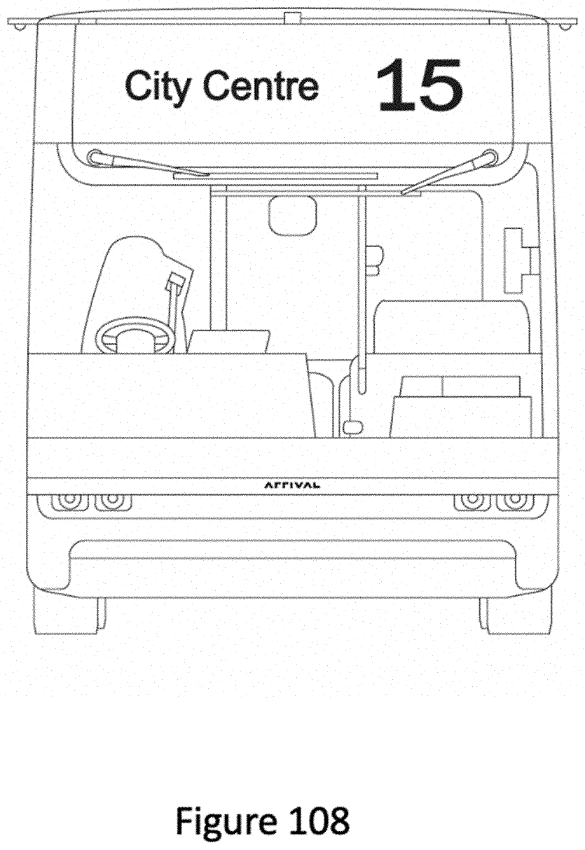

The Arrival system has been used to design and produce a number of different vehicles, including the Arrival Bus. FIG. 106 shows an exterior, perspective view of the 12 m long variant of the Arrival Bus, indicated generally at 1000; FIG. 107 is a side view and FIG. 108 is a front view. The Arrival Bus can be a single deck rigid vehicle, or a double deck vehicle or an articulated vehicle.

The Arrival Bus also has an enhanced passenger experience; the aim is to make public transportation desirable, rather than just a necessity, taking private cars off the road and leading to a more environmentally sustainable transportation system. Attractive design is key to this enhanced passenger experience; some of the key design features are:
360 degree fully integrated full length display screens wrapping around the exterior of the bus, protected behind a smooth form, glass or plastic surface; the screens supports advertising and passenger guidance on all sides.
Modular architecture for efficient and economical repeatable features and functions along the bus and mirrored left to right and front to back. This brings an ultra-clean and harmonised design approach.
Sleek flush form, with modular single leaf doors amplifying the modular architecture feel and spacious view of interior, inviting passengers.
Multiple (e.g. 6) skylight windows contribute to a light and bright, sleek feel.
Low to high glass line adding to a very sleek minimal and modern appearance.
Fully flush and integrated marker lamps, adding to a cleaner and minimal appearance. Dual front lamps spaced linearly in simple recessed scoops. Unified integrated rear lamp cluster designed to be rotatable (i.e. no left and right hand variant) with a distinctive brake light rotated “U” graphic.
Clean, purposeful intersecting lines give an architectural feel not usually prescribed for passenger buses.

FIG. 109 shows an interior view of the Arrival Bus, looking through the bus to the back of the bus.

We will look now at each of the above features in more detail.

Feature 1: Bus with 4 Tyres and Reduced Rolling Resistance

The Arrival bus is a zero emission vehicle, entirely powered by batteries. A 12 m long variant weighs approximately 9,000 kg unladen and has a gross combination mass of approximately 16,000 Kg. A conventional bus, and indeed any commercial vehicle with a gross combination mass of over 4 metric tons (approx. 4000 Kg) will typically have at least six tyres. A conventional bus has a rear engine and the standard arrangement is to have two tyres at the front and four at the rear, because of the weight of the engine; the four rear tyres are mounted on either two axles (with a single tyre on each side of each axle) or a single axle (with a pair of tyres on each side of the axle).

The Arrival bus is strikingly different because, even though it has an unladen weight of between 8000 Kg-10,000 Kg, it has only four tyres (and hence four wheels). Reducing the number of tyres and hence wheels reduced rolling resistance, reduced weight, increased power efficiency or range, improved handling, reduced cost, simplified production, simplified maintenance. Using only four tyres is possible because of the careful positioning of the battery packs as part of the chassis to provide near 50:50 weight distribution over the two axles and to provide a low centre of gravity and (ii) the lightweight construction of the bus body; essentially lightweight composite panels mounted on metal supports, such as lightweight extruded aluminium sections; there may be some heavier (e.g. pressed steel) supports, but overall the entire body is far lighter than a conventional bus body.

FIG. 110 shows an exploded view of the bus, indicated generally at 1000. The Arrival Bus 1000 has two tyres at the front, and only two tyres at the back: the left side, rear tyre 1001 just a single tyre. Likewise the right side, rear tyre (not shown) is also just a single tyre. The left rear wheel is mounted in a single large, structural aluminium wheel casting 1002, and the right rear wheel is mounted in substantially identical structural aluminium wheel casting 1027, shown in more detail in FIG. 111. FIG. 119-FIG. 122 will give more detail on the structural aluminium wheel arch 1002.

The Arrival Bus 1000 is assembled robotically from a number of standardised components that are optimised for robotic handling and assembly. A summary of the robotic build sequence is given later in this Section J, but in the meantime, we can summarise some elements; all process steps are carried out robotically and are designed for fast and reliable robotic production. The Arrival Bus is assembled from a number of individual transverse bus sections; one such section 1010 is shown in FIG. 112, which is an exploded view of the individual components. FIG. 113 shows these components assembled together. The section includes, forming the base of the section, a transverse structural chassis beam 1003, a longitudinal structural chassis beams 1004 that runs on either side of a pair of composite floor panels 1005, and an extruded aluminium structural central beam 1051. The superstructure that is mounted over this base includes: lightweight extruded aluminium struts 1006 forming the lightweight body superstructure, composite body panels 1007 and composite roof panels 1008. A number of these transverse bus sections 1010 are assembled together to form the bus: a driver section, door section, body panel section, wheel arch section and rear section are used.

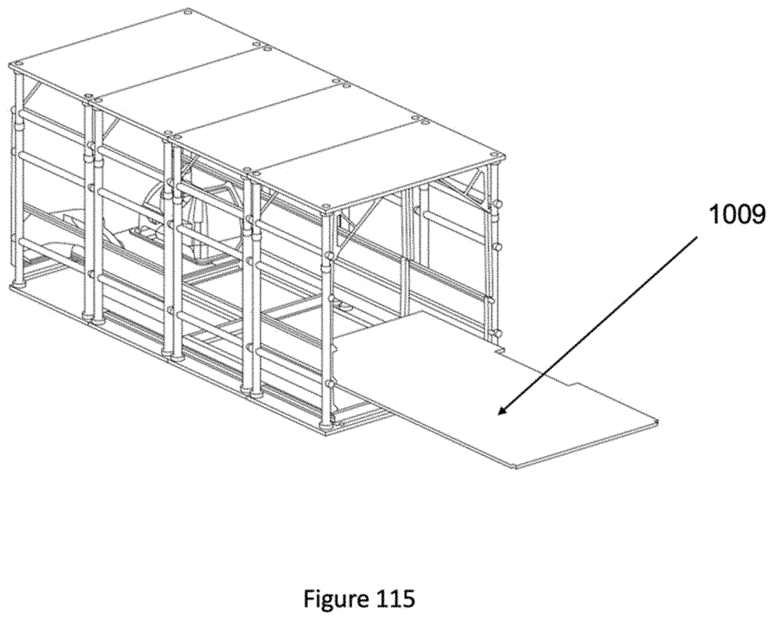

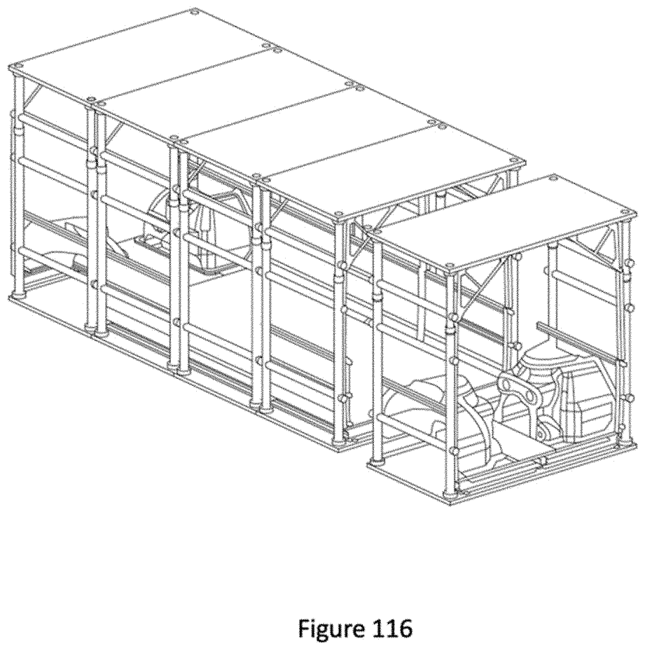

FIG. 114 shows four such transverse bus sections 1010 joined together, showing a pair of battery module bays 1012 formed in a transverse bus section 1010 on either side of an extruded aluminium central beam 1051; as we will see later, this extruded aluminium central beam 1051 forms a path for high voltage conductors, taking power from the batteries that are positioned in the battery module bays 1012 to the integrated drive units. FIG. 115 shows the chassis platform floor 1009 being inserted into this group of four transverse bus sections 1010. Chassis platform floor 1009 forms the top of the skateboard platform. FIG. 116 shows a fifth transverse bus sections 1010 about to be joined to this group of four transverse bus sections 1010.

The Arrival Bus has a battery pack mounted in the chassis, as with other Arrival vehicles; the battery pack includes an array of battery modules such as the battery modules 1078 described in Section G. FIG. 117 and FIG. 118 shows a group of twelve such battery modules 1078 being slid into one of the battery module bays 1012 in the chassis.

The Arrival Bus has, mounted on the skateboard or chassis platform, a single level, flat internal floor 1013 for passengers to pass along; this flat internal floor 1013 extends throughout the bus. FIG. 119 shows how this flat internal floor 1013 starts at the front access door opening 1014, and continues through the bus, past the middle access door opening 1015; FIG. 120 shows how the flat internal floor 1013 continues all the way past the rear access door opening 1016 to the rear seats.

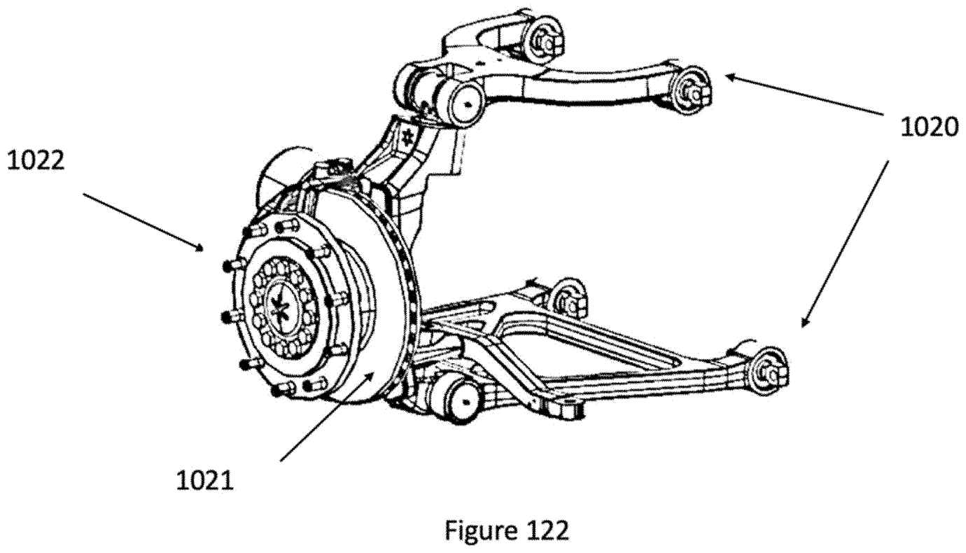

In the Arrival Bus, motors are mounted inside each of the rear cast aluminium rear structural wheel arches 1002. FIG. 121-FIG. 125 show this is more detail. In FIG. 121, we see the entire single rear arch (left side) 1002. This is a single, large aluminium casting, and includes features against which the entire suspension system mounts and also features against which a complete integrated drive unit mounts. By mounting the entire suspension system and integrated drive unit inside a structural wheel arch, construction is greatly simplified. FIG. 122 shows the independent suspension arms 1020, the disc brake 1021 and the wheel mount or hub flange 1022.

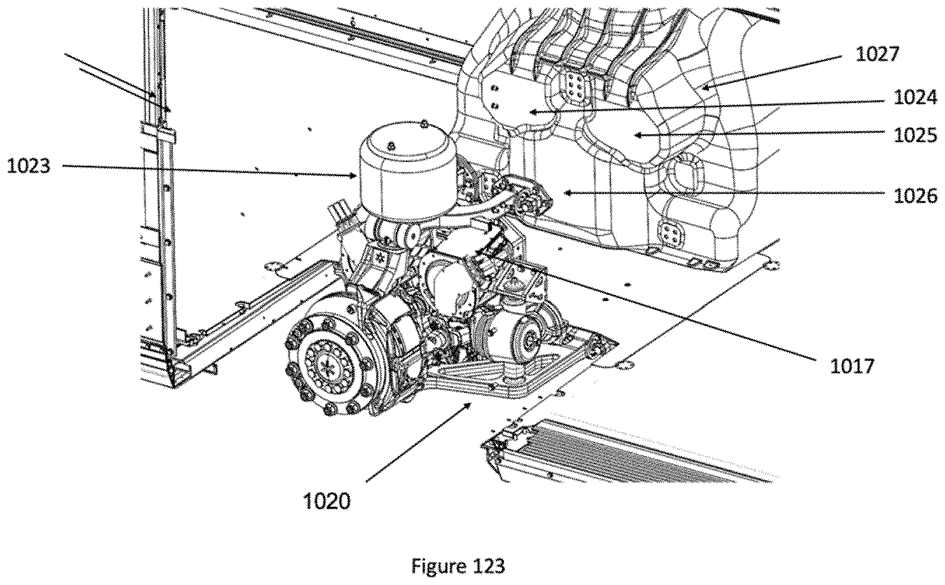

FIG. 123 shows how the suspension arms 1020, air suspension piston 1023, motors 1017 are positioned in the left side wheel arch; the actual left side wheel arch is removed for clarity. The right side wheel arch 1027 remains however: this shows how the wheel arch is shaped to contain the integrated drive unit. The portion 1024 of the wheel arch casing around the left side motor is shown, as is the portion 1025 of the wheel arch casing around the right side motor and the portion 1026 of the wheel arch casing around the dual input gearbox. The left and right side wheel arch castings 1002, 1027 and substantially identical and hence formed from the same casting mould: some cast features can be removed (e.g. ground out) where component mounting within a wheel arch is not symmetrical. Wheel arch castings for the front wheels do not need to include the integrated drive unit and are different from the rear wheel arch units 1002, 1027.

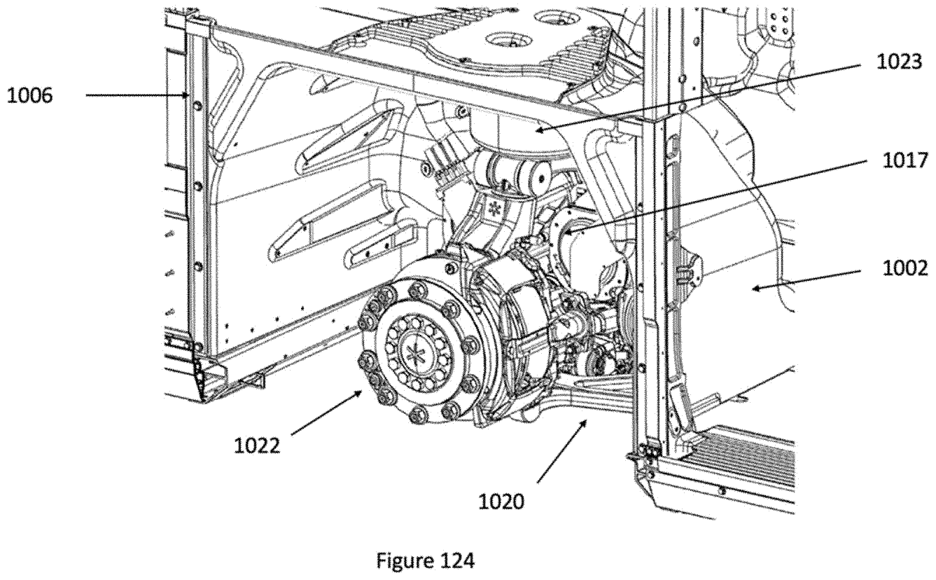

FIG. 124 shows the left side wheel arch with the suspension arms 1020, air suspension piston 1023, motors 1017, wheel flange 1022 in position. The superstructure, formed of lightweight extruded aluminium struts 1006, defines the body opening for the wheel arch 1002.

FIG. 125 shows the structural chassis members on which the left and right side wheel arch casings 1002 are mounted: this shows a pair of transverse structural chassis beams 1003; each beam is fixed to an end of the extruded aluminium central beam 1051. Directly mounting the structural wheel arches 1002, 1027 onto these structural chassis members 1003, 1051 facilitates simpler robotic construction. The entire Arrival Bus is produced using Robofacturing process (see Section E) in an Arrival microfactory (see Section F), as noted earlier.

In the Arrival Bus, only the rear left and rear wheel arches 1002 include drive units; it is possible to include drive units in all four wheel arches too. Each drive unit includes an invertor feeding two motors 1017, and a dual input gearbox 1018 with driveshaft.

We can generalise to: An electric bus (i) with only 4 tyres and (ii) a flat floor mounted on a chassis, and (iii) a battery pack or packs that is in, or part of, or mounted on, the chassis.

Optional Sub-Features:
Bus has a substantially 50:50 unladen weight distribution over the front and rear axles.
The bus has only 4 tyres.
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 2: Bus with 50:50 Weight Distribution and Improved Handling

As noted above, a conventional bus has a large, rear diesel engine and to cope with the substantial weight of the diesel engine requires four tyres at the rear of the bus. Because of the careful positioning of the battery packs in the chassis and the lightweight design of the bus body, the Arrival Bus has substantially or approximately 50:50 weight distribution over its two axles. This reduces uneven tyre wear and improves handling; improved handling leads to a better passenger experience and a better driver experience.

We can generalise this feature to: An electric bus with two axles and 50:50 weight distribution over each axle and a flat floor mounted on a chassis, and a battery pack or packs that is in, or part of, or mounted on, the chassis.

Optional Sub-Features:
The bus has only 4 tyres.
The bus is a 12 m long bus and has a gross combination mass of over 8000 Kg
The 12 m long bus has an unladen weight of approximately 8,000 Kg-10,000 Kg
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 3: Bus with Lightweight Composite Body

Because the Arrival Bus has body panels made of lightweight composite materials (see Section K) and these panels are fixed to lightweight extruded aluminium struts or members, the overall weight of the Arrival Bus is less than that of a conventional EV bus; the 12 m long variant has an unladen mass of between 8,000 Kg-10,000 kg. As noted above, minimising the weight of the bus is important in enabling the bus to have just two axles (saving weight and reducing cost over a four axle bus); and in enabling the bus to have just four tyres (again saving weight and reducing cost over a six tyre bus, and reducing rolling resistance, hence increasing range for a given battery charge). Minimising weight also reduces the power needed to accelerate the bus and to maintain speed, hence increasing range for a given battery charge; it also increases the acceleration/deceleration performance and reduces the brake wear. The centre of gravity of the bus is low because the bus has a chassis that includes a heavy battery pack or packs, and the body is made up of lightweight composite materials.

Arrival's composite panels can be given properties (e.g. through choice and design of the fabric and use of e.g. balsa wood cores that make up the panels) that make them especially useful for buses, such as thermal insulation that is better than conventional steel paneled buses; this reduces power on heating or cooling (EVs need to be as efficient as possible with heating and cooling to maximise their range). Noise insulation for the composite panels can be better than conventional steel paneled buses; sound deadening cores can be included in the panels. Composite panels can also be moulded with integral structural components too (e.g. integral extruded aluminium sections), simplifying robotic assembly.

We can generalise this feature to:

A bus with body panels made of lightweight composite material mounted on or including light weight extruded aluminium struts or members, delivering an unladen mass for a 12 m bus of not substantially more than 8000 Kg-10,000 Kg.

Optional Sub-Features:
the composite body panels have a Class A surface
the composite body panels are thermoplastic composite body panels that include a colour formed in the interior of the body panel
The bus has only 4 tyres.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a chassis and the light weight extruded aluminium struts or members are attached to the chassis to form the body superstructure to which the body panels are attached.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 4: Bus with Lightweight Composite Roof and Panoramic Glazing

It is not just the side body panels of the Arrival Bus that are made from composite material; in addition, the roof panels are also made of composite material mounted on light weight extruded aluminium roof struts, and each includes a central clear (e.g. or transparent glass) section that combine to form a continuous panoramic roof running over substantially the entire length of the bus. This contributes to any exceptionally light and airy interior.

The Arrival Bus is constructed from multiple transverse sections: for a 12 m variant, there are six internal transverse sections, and a driver cabin transverse section and a rear transverse section. Each of the six internal transverse sections has side and roof panels that are made from composite material (see Section K).

FIG. 126 shows two of these internal transverse sections 1010. Each transverse section 1010 includes composite left and right side roof panels 1008; there is a central roof void 1029 that receives a glass roof light, mounted in a rectangular frame that includes roof transverse structural aluminium strut 1058. Each of the internal transverse sections also has a side glazing fitting into a large side window opening 1030; some of these openings sit over a composite body panel; some sit over a wheel arch; for the door panels, the glazing runs to the floor level. Each glass roof void 1029 lines up with the corresponding side glazing opening 1030, since the extruded aluminium struts that define the edges of the glazing openings in the sides also continue up and across the roof. Above each side glazing opening 1030 is display panel void 1072 into which a high resolution, full colour display panel is inserted.

FIG. 127 shows how the six adjacent glass panels in the roof form a panoramic glass roof lights 1031 running over substantially the entire length of the bus where passengers sit or stand; a front section over the driver and a rear section at the rear of the bus may have a solid roof, but all of the other sections include a glazed roof light. This sort of extensive panoramic roof is normally only found in luxury cars; it makes the inside of the bus bright, inviting, with a premium feel. The full length single level, flat passenger floor 1013 adds to the sense of the interior of the bus being an inviting and easy to use space.

We can generalise this feature to:

A bus with roof panels made of composite material mounted on light weight extruded aluminium struts or members, and each including a central clear or transparent section configured to form part of a panoramic roof running over substantially the entire length of the bus where passengers sit or stand.

Optional Sub-Features:
The bus constructed from a number of transverse sections
Several transverse sections include a glass side window, and the central clear or transparent section is aligned to sit directly over this side window
The side windows of a transverse section are secured in an extruded metal frame structure that continues over the roof, and retain the roof panels for that transverse section.
the clear or transparent sections are each made of glass
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 5: Bus with a Low-Floor that is Fully Flat from the Front of the Bus to the Rearmost Seats

Low floor buses are popular because of their ease of access to passengers; in a diesel bus, the engine, at the rear of the bus connects to the rear axles through a drive system and to accommodate this drive system, the rear part of the floor of the bus has to be raised; the low floor does not therefore continue for the entire length of the area that passengers walk along, but is generally a flat low-floor only in front of the rear axles. In the Arrival Bus, we have a flat, low floor that extends over the entire length of the floor—e.g. from the front access door all the way past the rear axles and to the rear most seats (e.g. to under at least part of the rearmost seats, or to under the whole of the rear seats). So a passenger need make just a single step up from the ground through the door and from there, there is a single flat floor that continues right through the bus.

The low floor during normal driving has, for an EU variant, a height is approximately 360 mm above the ground; it can be lowered to an access height of 241 mm (and 450 mm/330 mm respectively for US buses). So it is very easy to access; further, because the floor is so low, a ramp for wheelchair or other users (where the ramp extends out from under the entrance door) is shallow and hence relatively easy to travel up.

The ground clearance of the Arrival Bus is approximately 177 mm-182 mm (approximately 270 mm for US buses), so is not compromised just because the floor is low: this requires careful design of the chassis, ensuring that it is both strong, able to contain the entire battery pack, yet not so tall that the bus is not a low floor bus. Packaging the drivetrain into the structural wheel arches (see Feature 6) is one of the ways that the Arrival Bus has managed to be both a low-floor bus, and yet also have a continuous low, flat floor, that runs from the doors throughout the entire bus, and still good ground clearance. Previous FIG. 119 and FIG. 120, and also FIG. 128 shows how the full length flat passenger floor 1013, indicated by the dashed forward pointing arrow, starts at the rear of the bus, adjacent to, and in some variants of the bus, under the rear row of seats, continues past the luggage store 1034 that sits over the rear wheel arches and right up to the front entrance of the bus.

We can generalise this feature to:

A low-floor bus with a flat floor running the entire length of the bus, the flat floor being mounted on a chassis and extending from a front access door through the bus to the rearmost seats.
The bus has a ride floor height of approximately 360 mm above the ground.
The bus has a ride floor height of approximately 340 mm-380 mm above the ground.
The bus has a ride floor height of approximately 450 mm above the ground.
The bus has a ride floor height of approximately 430 mm-470 mm above the ground.
The bus has an access floor height of approximately 240 mm above the ground.
The bus has an access floor height of approximately 220 mm-260 mm above the ground.
The bus has an access floor height of approximately 330 mm above the ground.
The bus has an access floor height of approximately 310 mm-350 mm above the ground.
The bus has only 4 tyres.
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 6: Bus with a Drivetrain Mounted within a Wheel Arch

Electric buses generally position an electric motor between the rear axles; since the motor is generally bulky, this necessitates raising the floor in the bus over the motor, which in turn means that the bus cannot have a flat floor that extends past the electric motor. But in the Arrival bus, a an integrated drivetrain unit (IDU), including the motor, is instead mounted within each of the structural, cast aluminium rear wheel arches; the IDU can includes not only the motor, but also an invertor, gearbox and driveshaft within the structural rear wheel arch; in some variants, the IDU includes two motors, two inverters, a twin input gearbox, and a driveshaft.

As shown earlier in FIG. 121-FIG. 125, the wheel arch 1002, 1027 itself is a single, very large aluminium casting; the single casting is designed to perform the functions of multiple separate parts (e.g. suspension mounts). The single, large cast wheel arch 1002, 1027 is shaped with a large, curved section that the wheel sits within, plus sections that configured for the drivetrain to mount to; for the rear wheel drive Arrival Bus, that means, for each of the two rear wheel arches, the drivetrain, made up of two motors, two inverters, a twin input gearbox, and a driveshaft, are all mounted inside each structural, cast aluminium rear wheel arch 1002, 1027.

In addition, an independent suspension system 1020 is attached to each of the four wheel arches, so there is no need for a connection rod across each axle; each single, large cast wheel arch is cast with mounting points for the suspension system. The independent suspension system is an independent double wishbone 1020 air spring system, with piston air dampers 1023.

Whilst the rear wheel arches intrude into the bus interior, it is nevertheless possible for the flat passenger floor 1013 to continue in between the rear wheel arches (which are fully enclosed or boxed in) so that the flat floor 1013 can run from the front of the bus all the way to the rear of the bus passenger area, past the rear axle. That would not be possible if a motor, drivetrain or connection rod were positioned between each suspension system. Mounting the drivetrain inside the rear wheel arches also gives easier access for servicing, repair and replacement. Mounting the drivetrain and suspension inside structural wheel arches also enables the bus to have not only a floor that is fully flat, for the entire length of the passenger area, but also a low floor: conventional bus suspension systems require the chassis suspension mounts to be significantly above the top of each wheel height, making a genuine low floor bus complex to engineer. By integrating the suspension mounts into the structural wheel arches themselves, we remove the need for the main longitudinal part of the chassis to include the suspension mounts, and that in turn means we can have a chassis with a genuinely low ride and access height.

We can generalise this feature to:

A low-floor bus, with a flat floor running past the rear axle, in which a drivetrain, including at least an electric motor, is mounted within a structural wheel arch.

Optional Sub-Features:
the drivetrain mounted within the wheel arch includes: two motors, two inverters, a twin input gearbox, and a driveshaft.
the drivetrain mounted within a wheel arch includes: a motor, an inverter, a gearbox, and a driveshaft.
each wheel arch comprises a single structural casting
each wheel arch comprises a single structural aluminium casting
each wheel arch comprises a single structural metal casting, such as a steel casting
each wheel arch includes a single structural aluminium casting and the drivetrain is attached to the casting
a fully independent suspension system is attached to each wheel arch
a motor is mounted within each of the rear wheel arches
a motor is mounted within each of the front and the rear wheel arches
a drivetrain is mounted within each of the rear wheel arches
a drivetrain is mounted within each of the front and the rear wheel arches
The bus has a ride floor height of approximately 360 mm above the ground.
The bus has a ride floor height of approximately 340 mm-380 mm above the ground.
The bus has a ride floor height of approximately 450 mm above the ground.
The bus has a ride floor height of approximately 430 mm-470 mm above the ground.
The bus has an access floor height of approximately 240 mm above the ground.
The bus has an access floor height of approximately 220 mm-260 mm above the ground.
The bus has an access floor height of approximately 330 mm above the ground.
The bus has an access floor height of approximately 310 mm-350 mm above the ground
The bus has only 4 tyres.
The bus is a 12 m long bus and has a gross combination mass of over 8000 Kg
The 12 m long bus has an unladen weight of approximately 8,000 Kg-10,000 Kg
The 10.5 m long bus has an unladen weight of approximately 8,000 Kg-9,000 Kg
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium structural struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 7: Bus with Central HV Bus Bar

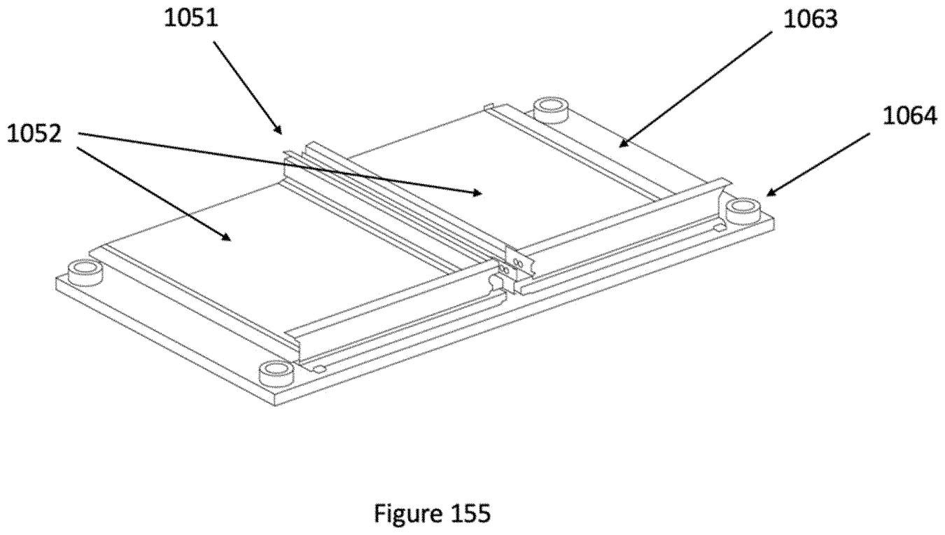

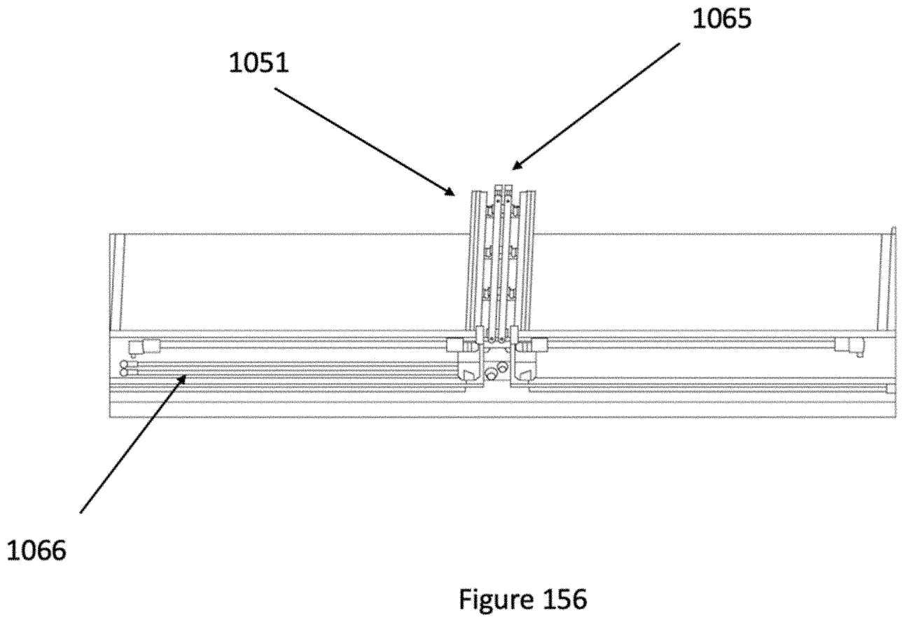

A conventional bus is typically designed and produced to a single specification, even though different potential customers may have widely differing requirements (e.g. differing requirements in terms of range, motor performance, climate control etc.). The Arrival Bus uses a central HV backbone with pre-defined connection points; this enables a configurable HV ESS (energy storage system). For example, it means that it is possible to change the number of battery packs during and after bus production, or to upgrade battery packs as new technology becomes available (e.g. as solid state battery packs become widely available). HV connection points allow for the installation other types of HV equipment; for example, it enables new or improved traction inverters to be fitted to the bus, after it has been produced, or for new HV climate systems to be added. FIG. 156 shows this backbone and will be described later in this section.

We can generalise this feature to:

A bus with a central or shared HV backbone including pre-installed connection interfaces for HV battery packs, traction inverters, and front and rear HV distribution systems.

Optional Sub-Features:
The bus has only 4 tyres.
The bus is a 12 m long bus and has a gross combination mass of over 8000 Kg
The 12 m long bus has an unladen weight of approximately 8,000 Kg
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 8: Bus with Distributed ECUs

A conventional bus has a very large number of dedicated ECUs (e.g. for lighting, thermal systems, braking, door opening and closing, passenger sensors, data connectivity systems, entertainment systems) each requiring some dedicated data wiring. These are embedded systems running firmware that has been written specifically for a given ECU: so a lighting ECU will be running dedicated firmware—i.e. permanent software running on read-only memory. This approach is rigid and hard to update.

In the Arrival system, a bus is designed for a specific customer (e.g. configured with the specific systems that are controlled by ECUs using the Vehicle Builder system described earlier); the optimal ECUs and connection plan is then automatically generated by Vehicle Builder and the appropriate firmware selected for writing to each of the ECUs. The actual physical bus is built and the physical ECUs and the data network they each sit on is installed; the appropriate firmware is installed on the ECUs. The ECUs form a connected network, and are not isolated from one another, as they would be in a conventional architecture. Instead, ECUs can be used to control and monitor the safe or correct operation of other ECUs: we have a distributed control and/or monitoring architecture; the software components that enable an ECU to monitor or control other ECUs are generated or selected when the bus is being configured by the automated Vehicle Builder system.

So in the Arrival system it is possible to optimally select software components for the various ECUs when a specific bus is being configured for a specific customer. This in turn requires the ECU to have a degree of modularity—for example, each ECU could have the same specification as all other ECUs and each ECU could connect to the data bus in the same way, and be augmented with the same kinds of software components in the same way. This enables customisation of ECU functionality to exactly meet the requirements of a specific customer; let's say that customer orders 50 buses with that set of requirements (e.g. long range, sophisticated ADAS, sophisticated climate control, sophisticated passenger entertainment systems, no internal advertising screens) and another set of 50 buses with a very different set of requirements (e.g. short range, no ADAS, simple climate control, no passenger entertainment systems, extensive internal advertising screens). Each set of 50 buses is configured using the Vehicle Builder system and each has a different organisation of ECUs, running different software and with a different control and monitoring system—i.e. different ECUs will have differing control and monitoring functions between the two sets of 50 buses.

We can generalise this feature to:

A bus with a distributed network of ECUs configured to enable de-centralised, distributed control and/or monitoring of ECUs by other ECUs.

Optional Sub-Features:
the software components that enable an ECU to monitor or control another ECU are generated or selected when the bus is being configured by an automated vehicle builder system.
the software components are written to the ECUs as firmware
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 9: Bus with Seating Mounted Above a Flat Floor

In the Arrival system, configuring systems to exactly match a customer's needs is not limited to software implemented functionality. In addition, it is possible to readily adapt the number of seats and their arrangement in the bus because each seat attached to the main structure of the bus with a single L shaped cantilevered bracket that extends from the side wall. So in the Arrival bus, passenger seats that are not floor mounted. This keeps the floor clear, greatly increasing the sense of spaciousness for passengers and also making cleaning faster, and cheaper. A composite and aluminium extrusion cantilever support is used to give a smooth, integrated and easy to clean (in a dust prone area) shape that fully supports the seat and the heaviest passengers. Cantilevering off the side also means that the floor does not need to be designed to support heavy seats, with solid seat mountings. That simplifies the floor construction, and also reduces its weight, leading to greater range or efficiency. FIG. 128A shows a cut-out side view of the bus, with all the side rows of seats 1032 mounted on cantilever supports 1033 that are mounted to structural side struts that form the superstructure of the bus (the side struts form the structural ladder frame 1070 which will be described later in this section). The cantilever 1033 can support two seats, as shown in FIG. 128B, or a single seat and a shelf, or a shorter cantilever can be used to support just a single seat.

The seat is also very slim, further increasing sense of spaciousness for passengers. A single unibody hard shell gives an ultra slim body, further increasing the sense of spaciousness for passengers.

Each seat has a flush fitting cushion; this supports easy cleaning and cushion replacement procedures. The cushion stops short of the top of the hard-shell unibody, so that the top of the unibody shell presents a grab-able area without resorting to an added pole or handle appendage.

We can generalise this to:

A bus including passenger seats that are each cantilever mounted against a substantially vertical structural strut or beam system that forms part of the side of the bus and not the floor.

Optional Sub-Features:
The cantilever is an L shaped cantilevered bracket that extends from the substantially vertical structural strut or beam system
the substantially vertical structural strut or beam system is attached to the bus chassis or skateboard platform
the substantially vertical structural strut or beam system continues to the roof of the bus
the substantially vertical structural strut or beam system is attached to a substantially horizontal structural strut or beam system to form the superstructure of the bus
The cantilever is a composite and aluminium extrusion cantilever
The seat is made from a single unibody hard shell.
Each seat has a flush fitting cushion that stops short of the top of the unibody shell, so that the top of the unibody shell presents a grab-able area without the need for providing an added pole or handle appendage.
the floor is a flat floor running the entire length of the bus that provides a single flat surface under all seats to facilitate cleaning, and the floor is mounted on a chassis that includes a battery pack or packs (e.g. a battery pack or packs is in, or part of, or mounted on the chassis).
The bus has a floor height of approximately 360 mm above the ground.
The bus has a floor height of approximately 300 mm-420 mm above the ground.
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

B. Arrival Bus Information Systems

Feature 10: Displaying Sensor-Derived Environmental Information

The Arrival bus includes a number of external and internal sensors, such as cameras and computer vision systems or any other sensor type, to collect relevant data, such as: Information about external (i.e. external to the bus) environmental conditions, road conditions, road traffic, pedestrian traffic, potential obstructions and obstacles. The Arrival bus can automatically use information from these sensors to display relevant information on an exterior display and, optionally, on an internal display as well.

For example, FIG. 129A shows typical relevant information that can be displayed on the destination screens on the front and back of the outside of the bus, such as ‘Safe to overtake—no oncoming traffic’; this information is automatically generated from the system scanning the road ahead (which may form part of an autonomous driving system, including computer vision, LiDAR, intra-vehicle data communications and other sensors) and then automatically displayed on the relevant display screen (in this case, the destination screen on the back of the bus).

Another example of environmental information that can be displayed is the external warning that the ramp is deploying on the left-hand side, as shown in FIG. 129B. Again, this is shown on the destination screen on the back of the bus and can be triggered automatically whenever the ramp is deployed; the message on the screen at the front of the bus would then say: ‘Ramp deploying on the right-hand side’.

The bus can determine that it is about to depart from a bus stop; this can be done automatically or autonomously, or, where there is a driver, by the driver selecting a turning indicator. A warning is then shown on the destination screen on the back of the bus: ‘Vehicle is departing, do not overtake’, as shown in FIG. 129C.

The bus can automatically detect that passengers are leaving the vehicle, for example using computer vision systems monitoring the bus exit(s); when departing passengers are detected, then the information ‘Passengers leaving the vehicle’, with an arrow indicating which side they are leaving from, can be shown, as shown in FIG. 129D. This sort of information can also be displayed internally within the bus, for the benefit of the driver and/or other passengers.

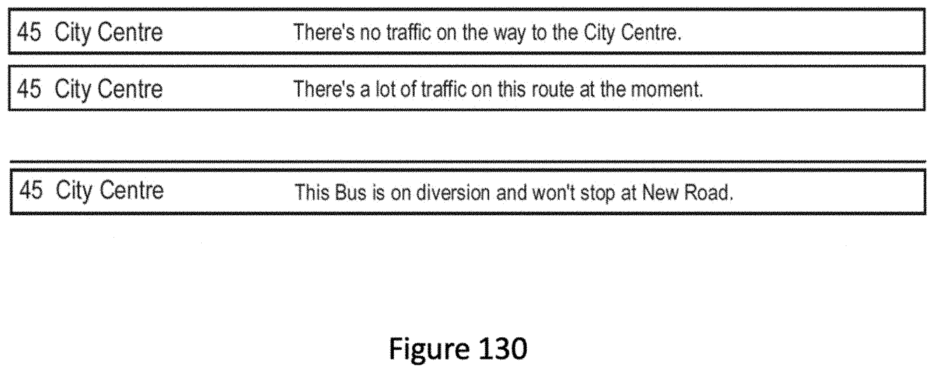

Other examples include displaying dynamic real-time traffic or diversion information for a specific route; this can be usefully shown on exterior displays that run along the side of the bus, so passengers waiting at a bus stop or other pickup location can decide whether to board the bus or not. Examples are shown in FIG. 130.

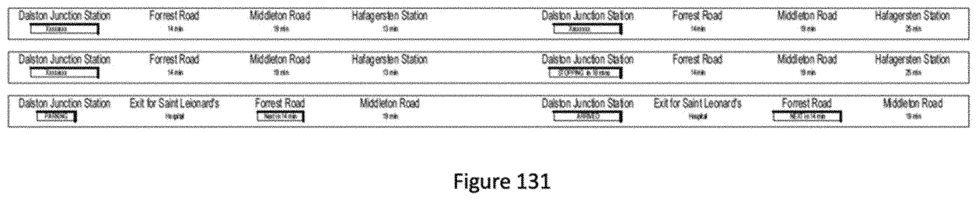

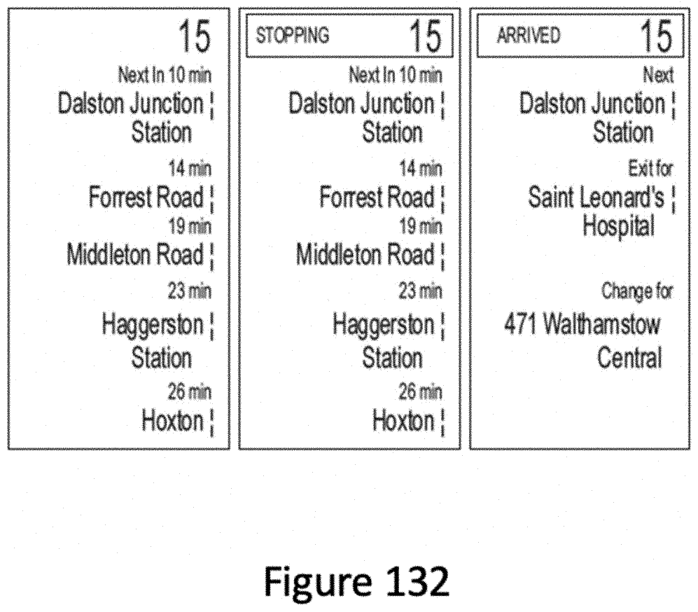

Equally, this information can be shown on internal displays, passengers on board the vehicle can decide whether or not they wish to leave the vehicle. Internal and external displays can also carry dynamic real-time route information with predictions on when different stops will be reached, taking into account real-time traffic information, as shown in FIG. 131 and FIG. 132.

Another example is where weight sensors (e.g. axle or suspension based sensor) for sensing the total passenger weight, and/or passenger counting sensors (e.g. computer vision based people counting systems) determine that the bus is at full capacity; then the display panel (or HMI) for the driver (if there is one) can include a notification that ‘The bus is at passenger capacity’, as shown in FIG. 133. The driver will then know that no further passengers can board, unless some leave. If none are due to leave at the next stop, the driver can continue to the next stop, increasing overall efficiency.

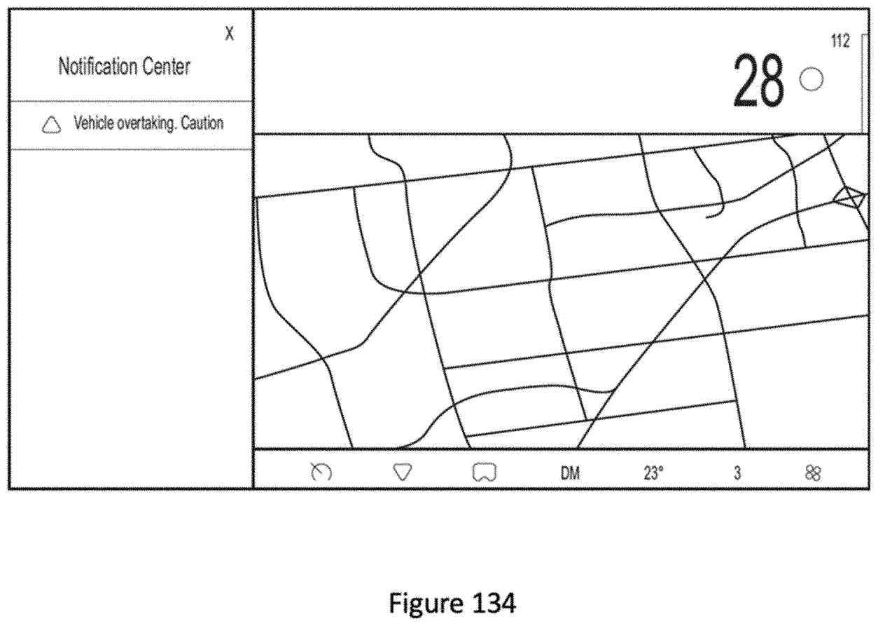

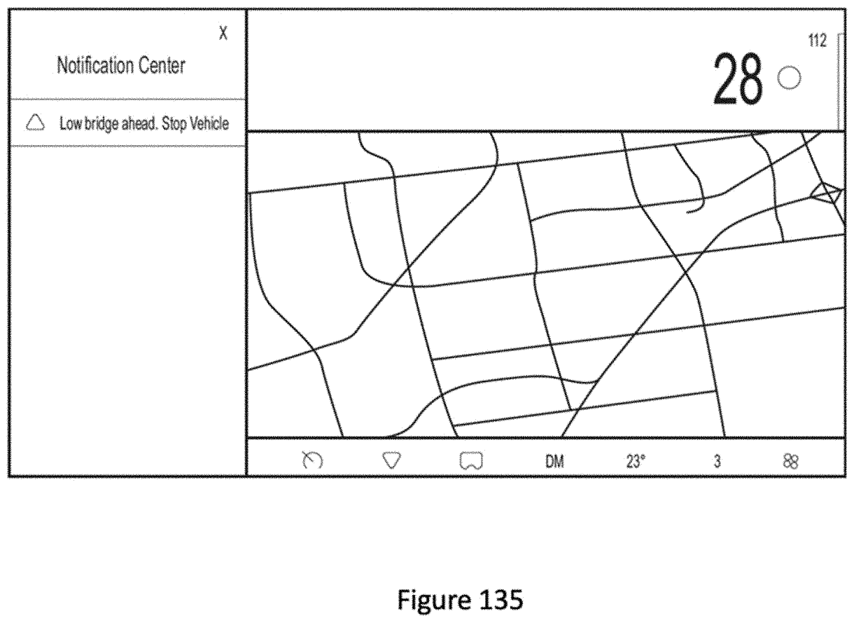

More generally, environmental information relevant to the driver is captured and displayed on the driver HMI; in the screen below, the warning ‘vehicle overtaking—caution’, as shown in FIG. 134. Similarly, if a cyclist is close to the side of the bus, the cyclist can be detected by an appropriate sensor (e.g. part of the autonomous or semi-autonomous driving and control systems in the vehicle, such as LiDAR and computer vision systems). If bus sensors (e.g. LiDAR and computer vision systems) detect a low bridge ahead, then a the HMI can display a warning, as shown in FIG. 135.

We can generalise this to:

A vehicle with an exterior display system operable to display environmental information that (i) relates to the environment external to the vehicle, and (ii) has been derived from data sources that are external to and remote from the vehicle.

A vehicle with an exterior display system operable to display environmental information that (i) relates to the environment internal to the vehicle, and (ii) has been derived from data sources that are internal to the vehicle.

A vehicle with an exterior display system operable to display environmental information that (i) relates to the environment external to the vehicle, and the environment internal to the vehicle, and (ii) has been derived from data sources that are internal and external to and remote from the vehicle.

Optional Sub-Features:

The Vehicle
Vehicle is a bus and the display system is operable also to display destination and/or route information

The Environmental Information

Environmental information includes road conditions, such as obstructions, roadworks, status of traffic lights, whether snow or ice is detected by the data sources
Environmental information includes road traffic conditions, including congestion information, such as congestion for the likely route of the vehicle
Environmental information includes information on pedestrians and cyclists in the vicinity of the vehicle
Environmental information includes whether it is safe or not for any other vehicle in proximity to the vehicle to perform an action in view of nearby road users or pedestrians detected by the data sources
Environmental information includes whether it is safe or not to overtake the vehicle in view of nearby road users or pedestrians, detected by the data sources
Environmental information includes whether passengers (including children) are waiting to board the vehicle, are entering into or alighting from the vehicle
Environmental information includes whether passengers (including children) are waiting to alight from inside the vehicle
Environmental information includes the number of passengers waiting to board the vehicle
Environmental information includes whether there are passengers seeking to board the vehicle or on the vehicle require assistance, such as wheelchair bound passengers, or people with walking or mobility issues, expectant mothers, or people with pushchairs or prams, and the exterior display then automatically displays a relevant message, for example a message indicating that the vehicle is automatically lowering an access ramp; or a message requesting that passengers are to give priority or make space or offer a seat or offer other assistance.
Environmental information includes the number of available seats in the vehicle
Environmental information includes the data connectivity speed available to passengers in the vehicle
Environmental information includes services available to passengers in the vehicle, such as food or drink
Environmental information includes movement and ‘sway’ of passengers, and the vehicle uses this information automatically to compensate driver (assist or autonomous) controls to optimise for passenger comfort and safety
Environmental information includes the ambient lighting or temperature in the vehicle
Environmental information includes solar loading, e.g. as detected using computer vision, and the vehicle uses this information to control zonal lighting and heating/cooling
Environmental information includes how heavily an area or different seats have been used, and the vehicle generates data from this that influences how and where the vehicle is cleaned
Environmental information includes bus journey location and times to future stops or destinations, using traffic flow and speed data that is specific to the bus and its specific route, including the use of bus priority lanes, and the vehicle displays this data in real-time to passengers using interior displays
Environmental information excludes the operational status of the vehicle, or the intent or actions of any driver, such as braking or indicating a turn
Environmental information excludes the number of passengers in the vehicle

The Data Sources
Data sources includes one or more cameras in the vehicle
Data sources includes one or more cameras external to the vehicle
Data sources includes one or more computer vision systems, such as computer vision systems that can detect whether passengers are waiting to board the vehicle, and/or entering into or alighting from the vehicle
Data sources includes one or more computer vision systems that can detect where passengers are sitting in the bus
Data sources includes one or more computer vision systems that can detect where passengers are standing in the bus
Data source can detect whether passengers require assistance, such as wheelchair bound passengers, or people with walking or mobility issues, expectant mothers, or people with pushchairs or prams, and take appropriate, pre-determined actions depending on the nature of assistance that is appropriate
Data sources includes one or more pose detection systems
Data sources includes road traffic data sources
Data sources include any vehicle control system, such as steering, accelerator, braking
Data sources include one or more voice or speech recognition data sources
Data sources include one or more weight or load sensors
   Weight or load sensors can establish whether the loading and load distribution is within safe limits and can generate a warning if it is not
Data sources include wi-fi or other wireless comms servers that determine the extent of use of those comms by passengers
Data sources includes one or more systems that can detect one or more of: age, sex, other demographic data, of individual passengers
Data sources includes one or more systems that can detect interactions between passengers, including interactions indicating potential or actual threatening or other undesirable behaviour.

Display UI
One or more interior displays mirror or replicate some or all of what is shown by the exterior display system
A display in a driver's cabin in the vehicle displays any of the environmental information
A display in a rear view mirror, whether reflective or a camera-based display, can display any of the environmental information.
The exterior display system includes one or more of: a display at the rear of the vehicle, a display at the front of the vehicle, a display running along the length of the vehicle; a display running along the length of the vehicle and above the side windows of the vehicle; a display wrapped around substantially all sides of the vehicle (e.g. at least 80% of the total linear length).
The exterior display system includes a display running substantially continuously around the perimeter of the vehicle, below the roof.
Vehicle can share any data that would be shown on the exterior display to a server and hence to a connected web browser, web app or app, to display the same or related data
   A potential passenger can view whether any seats are available on a specific vehicle from a web browser, web app or app
   A potential or actual passenger can view road traffic conditions, including congestion information, such as congestion for the likely route of the vehicle, from a web browser, web app or app
   A potential or actual passenger can view whether passengers are waiting to board the vehicle, are entering into or alighting from the vehicle from a web browser, web app or app

Feature 11: Passenger Location Analysis

Using the various external and internal sensors and cameras located on the bus (which includes use of computer vision systems), relevant data can be collected such as information about passengers boarding the bus and passengers within the bus (e.g. traffic and flow of passengers, location and positioning of passengers within the bus, passenger demographics, clothing and accessories worn). This can be useful where the sensors can track where passengers are to enter and leave the bus, based on dynamic or real-time data from the data sources, and the bus can then automatically display guidance information.

For example, FIG. 136 below shows a possible external screen that runs along the entire side of the bus, and sits over three doors of the bus. Because the internal sensors have assessed that there are many passengers inside the bus waiting to leave at the next stop (e.g. are waiting close to the exits, or have pressed a request stop button), and few people waiting to board the bus, the bus automatically determines that it is optimal to have the front door alone available for passengers boarding the bus, and to have both the middle and rear door available for passengers leaving the bus. So the external screen shows that the front entrance is available for use, and the middle and rear doors are ‘No entry’.

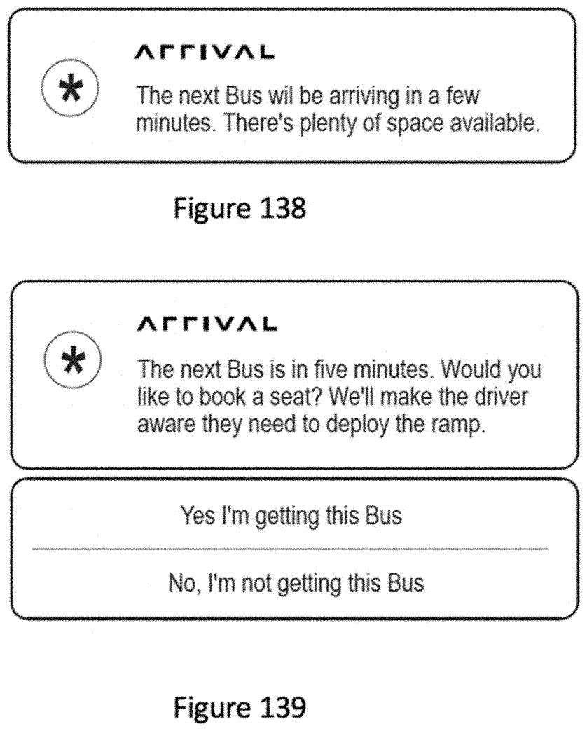

The computer vision system (or other sensors, such as weight sensors integrated into each seat) can be used to work out which seats are occupied and which are empty. This is useful information that can be sent to a remote load capacity analysis and management system, e.g. used by the urban transportation authority or bus company to ensure efficient deployment of buses. It can also be shown on the interior and exterior displays of the bus too, indicating the number of available seats and also their location, based on dynamic or real-time data from the data sources, as shown in FIG. 137. Relevant information can be sent to passengers' smartphone apps too, as shown in FIG. 138 (‘The next Bus will be arriving in a few minutes. There's plenty of space available.’)

The number and location of any available seats for priority passengers, such as pregnant mothers, passengers with mobility issues, can also be tracked and displayed, based on dynamic or real-time data from the data sources; app based booking of these seats is therefore possible, as shown in FIG. 139.

We can generalise this to:

A bus with a passenger analysis system that automatically generates data on the location or other spatial distribution of passengers in the bus, or intended passengers for the bus, using one or more external and/or internal sensors located in or on the bus.

Optional Sub-Features:

The Location or Other Spatial Distribution Data
Spatial distribution data includes whether or where there are passengers waiting near the bus exit(s) to alight from inside the vehicle
Spatial distribution data includes whether or where there are passengers waiting near the bus entrance(s) to board the vehicle
Spatial distribution data includes whether or where there are passengers waiting near the bus entrance(s) seeking to board the vehicle or on the vehicle that require assistance, such as wheelchair bound passengers, or people with walking or mobility issues, expectant mothers, or people with pushchairs or prams.
Spatial distribution data includes where there are occupied seats and where there are unoccupied seats
Spatial distribution data includes where and/or how many passengers are standing in the bus
Spatial distribution data includes how close passengers are to each other
Spatial distribution data includes whether reserved seats are in fact occupied
Spatial distribution data includes the number of passengers, determined by a people counting system

The Sensors/Computer Vision System
Sensors include a computer vision system.
Computer vision system includes one or more cameras in the vehicle
Computer vision system includes one or more cameras external to the vehicle
Computer vision system includes one or more computer vision systems that can detect whether passengers are waiting to board the vehicle, and/or are entering into or alighting from the vehicle,
Computer vision system includes one or more computer vision systems that can detect where passengers are sitting in the bus
Computer vision system includes one or more computer vision systems that can detect where passengers are standing in the bus
Computer vision system includes one or more computer vision systems that can count the number of passengers in the bus
Computer vision system includes one or more computer vision systems that can count the number of people waiting to board the bus.
Computer vision system includes one or more computer vision systems that can count the number of passengers waiting to leave the bus
Computer vision system includes one or more pose detection systems
   pose detection system can infer if, or probabilistically estimate whether, a passenger is intending to alight or intending to remain on the bus
Computer vision system can detect whether passengers require assistance, such as wheelchair bound passengers, or people with walking or mobility issues, expectant mothers, or people with pushchairs or prams, and take appropriate, pre-determined actions depending on the nature of assistance that is appropriate
   pre-determined actions include: automatically lowering an access ramp; automatically requesting that passengers are to make space or offer a seat or offer other assistance
Computer vision system includes one or more systems that can detect one or more of: age, sex, other demographic data, of individual passengers
Computer vision system includes one or more systems that can detect interactions between passengers, including interactions indicating potential or actual threatening or other undesirable behaviour.
Computer vision system includes one or more systems that can detect whether passengers are wearing hats, scarfs or face masks or coverings.
Computer vision system uses thermal analysis of passengers, e.g. to differentiate them from the vehicle when locating the positions of passengers to determine safe loading and distribution of passengers.

Other Data Sources
Bus also includes one or more voice or speech recognition data sources
Bus also includes one or more weight or load sensors
   Weight or load sensors can establish whether the loading and load distribution is within safe limits and can generate a warning if it is not
Bus also includes wi-fi or other wireless comms servers that determine the extent of use of those comms by passengers
A passenger's bus ticketing app is a data source; the passenger can open the app on their smartphone etc and send data, such as an alert if they feel in danger or are unwell, or wish to alert the driver or a service or help center for any reason; because the location of the passenger is known, a computer vision system in the bus can be controlled to view that location and the driver and/or a remote help centre can then assess the situation; if a passenger is being threatened or assaulted, then the driver can stop the bus and wait for police support.

Display UI
Bus includes one or more displays that generate and display information directing where passengers are to enter and leave the bus, based on dynamic or real-time data from the data sources
Bus includes one or more displays that generate and display information indicating the location of any available seats, based on dynamic or real-time data from the data sources
Bus includes one or more displays that generate and display information indicating the location of any available seats for priority passengers, such as pregnant mothers, passengers with mobility issues, based on dynamic or real-time data from the data sources
Bus includes one or more displays that generate and display information based on the data sources, such as guidance or warning information, images of passengers exhibiting potential or actual threatening or other undesirable behaviour, based on dynamic or real-time data from the data sources.
The display(s) are in the passenger area
The display(s) are in the driver area or cabin
Bus can automatically send data requesting assistance, including police or ambulance intervention
Bus can share any data that would be shown on a display on or in the bus to a server and a connected app, to display the same or related data on the app.

Other Uses Cases
Passenger analysis system automatically alters an operational parameter of the bus depending on the data
Passenger analysis system automatically stops the bus at the next request bus stop if there are passengers standing near the exit
Bus is configured to dynamically modify the conditions in the bus (e.g. lighting, thermal (HVAC), sound/music, displayed information etc.) depending on the location or spatial distribution or thermal profile of passengers within it.
   this can also be done zonally within the vehicle e.g. turn off heating in unoccupied parts of the bus which reduces power consumption;
Bus is configured to dynamically change the types of advertisements displayed within the bus depending on the location of the passengers within it.
Bus is configured to dynamically track one or more of the load, capacity, flow of passengers, types of passengers in the bus and display that information on a display in the driver's cabin.
Bus is configured to automatically detect if there are standing passengers and to recommend to the driver a gentle driving style if there are standing passengers.
Bus is configured to automatically detect if there are standing passengers and to implement a gentler driving style (e.g. reduce hard acceleration; reduce sharpness of hard braking, provided that safety is not compromised) if there are standing passengers.

Public Health

Computer vision based health monitoring systems, whilst known technologies, are also not offered as part of the Arrival system; however, due to the open nature of the Arrival system, architecture, third parties may seek to include these. For example, in some situations, it may, subject to compliance with applicable data privacy laws, be very useful for public health authorities to have data that tracks health related data. In cities, people's confidence in the safety of using public transport can be very important in minimising the use of private cars. Public health authorities may therefore seek unauthorised adaptations of the Arrival computer vision system in which:
The location of passengers wearing a face mask and passengers not wearing a face mask is detected
The location of passengers that maintain and/or fail to maintain more than a pre-set distance from other passengers is detected
The location of passengers with an abnormal body temperature, as measured by a remote infra-red computer vision system, is detected

Facial Recognition and Emotion Tracking

Facial recognition and emotion tracking systems, whilst known technologies, are also not offered as part of the Arrival system; however, due to the open nature of the Arrival system, architecture, public health authorities may seek to include these.

Feature 12: Bus with Behavioural Modelling

The Arrival bus includes a computer vision system that can detect specific behaviours, generally based on the movement or pose or trajectory of a passenger. Being able to detect specific behaviours can be very useful; for example, the computer vision system can detect if a passenger has a fall or trip inside the bus and then automatically bring the bus to a safe stop so that treatment can be provided; an ambulance might be automatically alerted in the case of what the computer vision system determines is a serious fall or injury. The computer vision system can detect whether a seat belt is being worn and can provide a general advisory message over its internal sound system (e.g. “Please wear your seat belt.”). The computer vision system can detect whether standing passengers are swaying excessively and automatically slow the bus down or advise the driver to slow the bus down. The computer vision system can detect whether a wheelchair or pram space is occupied by a non-priority passenger at a time when a wheelchair or pram user is nearby and provide a general advisory message over its internal sound system (e.g. “Please offer your seat to anyone in greater need”). The computer vision system can detect whether passengers are waiting near an exit, and then automatically stop the bus at the next stop. The computer vision system can detect whether standing passengers are swaying excessively and automatically stiffen the air suspension. There are a broad range of possible use cases.

We can generalise to:

A bus with a passenger analysis system that automatically generates data on the behaviour of passengers in the bus, or intended passengers for the bus, using a computer vision system; and automatically initiating a bus operation depending on data from the computer vision system.

Optional Sub-Features:

The Behaviour
The behaviour is a fall or trip or impact inside the bus and the bus operation is stopping the bus or advising the driver to stop the bus.
The behaviour is whether a seat belt is being worn and the bus operation is displaying or giving an advisory asking that seat belts be worn.
The behaviour is excessive swaying of standing passengers and the bus operation is slowing or reducing the acceleration/deceleration of the bus, or advising the driver to slow or reduce the acceleration/deceleration of the bus
The behaviour is excessive swaying of standing passengers and the bus operation is stiffening the air suspension
The behaviour is whether a wheelchair or pram space is occupied by a non-priority passenger at a time when a wheelchair or pram user is nearby and the bus operation is displaying or giving an advisory asking for the wheelchair or pram space to be clear.
The behaviour is approaching closely to another passenger when there is ample space on the bus not to approach so closely and the and the bus operation is displaying or giving an advisory that passengers should maintain a safe distance from other passengers.
The behaviour is anti-social, drunken or threatening behaviour and the bus operation is displaying or giving an advisory to stop such behaviour.
The behaviour is a fare payment action, such as presenting a contactless ticket to a card reader in the bus and bus operation is displaying or giving an advisory to confirm payment
The behaviour is a fare evasion action, such as never presenting a contactless ticket to a card reader in the bus, and the bus operation is displaying or giving an advisory that fare evasion has been detected.
The behaviour is a fare evasion action, such as appearing to present a contactless ticket to a card reader in the bus but without triggering a payment and the bus operation is displaying or giving an advisory that fare evasion has been detected
The behaviour is passenger flow through the bus and the bus operation is assessing whether the flow meets passenger safety or comfort standards.
The behaviour is data relating to where people are sitting or standing in the bus and the bus operation is modifying the bus HVAC for greater passenger comfort.
The behaviour is one or more of dwell time in different locations in the bus, and the bus operation is making multivariate adjustments of internal environment (such as lighting, temperature, displayed content)
   The multivariate adjustments are made to one or more of: the whole bus, or to zones within the bus, at different times of day, in different weather conditions, in different locations.
The behaviour is detected using frame to frame differencing (cameras and seats are fixed, whereas humans and luggage moves)
The behaviour is the type of clothing worn by passengers and the bus operation is automatically adjusting the internal environment depending on the type of clothing
The behaviour is whether a wheelchair, pram or luggage is moving without human control and the bus operation is giving an emergency warning.
The behaviour is whether passengers sing along with or move along with music played in the bus and the bus operation is to display or give encouragement.
   song lyrics scroll along or are shown on the displays
The behaviour is whether passengers are swaying excessively and the
Computer vision is supplemented with a speech recognition and analysis system
   the speech recognition and analysis system is programmed to detect threatening, drunken or anti-social behaviour.

Feature 13: Bus Displaying Dynamic, Environment-Based Advertising Content

As explained earlier, the Arrival bus has extensive internal and external display screens running along the length of the bus. These can provide useful passenger and route information, and also advertisements or other advertising content selected to make the journey engaging to the passengers on the bus and people outside the bus. A content server dynamically generates or selects this advertising content based on dynamically changing parameters, such as the bus location, the demographic and/or behaviour of passengers in the vehicle, the time of day, the weather, the route being taken, the traffic conditions, or any other dynamically changing parameter selected to be relevant to passengers on the bus or people outside the bus that can be automatically tracked or sensed.

For example, where the real-time location of the vehicle is tracked, the server generates or selects advertising content based on this real-time location; if the vehicle is a bus and the bus is approaching a major tourist attraction like the Louvre in Paris, then the internal (and possibly also external display screens) could show images of the Louvre, information on special exhibitions, information that the bus is stopping at the Louvre in 3 minutes. The time of day may be a relevant parameter here too: if the Louvre is open only for a further 1 hour, then that information can be included too.

Time may be the primary parameter: for example, before 9 am, then the advertising content could be generated or selected to be suitable for a passengers leaving for work, such as adverts for holidays, or news information; after 9 pm, then the content could be generated or selected to be suitable for an evening crowd (with greater or more colourful lighting, given the darker environment); joining time of day with location is then possible too: for example, at 10 pm in a city centre entertainment district, the displays could be showing music videos; as a bus approaches an entertainment venue, then information about that venue, specific bands performing, films being shown etc, could be shown instead. If microphone sensors in the bus pick up that some passengers are singing a specific song, then the content server could find that song and play it over the audio system that is part of the display.

Where the external weather is a parameter, and it's cold and wet outside, then the content could be adverts for warm coats and jumpers as the bus approaches a store where those coats and jumpers are sold. Offers or QR code links could be included in the displayed adverts, so that a passenger could scan the code with their smartphone etc., and then open a website on their smartphone etc; affiliate advertising revenue share is then possible with the bus operator.

Where microphone sensors in the bus pick up that there are people speaking a specific foreign language and those passengers are likely to be tourists, then the content can be changed to that foreign language; for example, if, as the bus approaches the Louvre, then a language analysis system in or connected to the bus could recognise that there are several Japanese and Korean passengers, and then information on the Louvre could be presented in Japanese and Korean.

The bus may include a Wi-fi hotspot; when a passenger logs on to the local Wi-Fi hotspot, then (subject to the explicit permission of that passenger), if they browse to or search for content related to an advertisement running inside or outside the bus, then that can be tracked and provide useful data to the advertiser.

Generalising, we have:

A bus with a display (e.g. external or internal) connected to a content server that generates or selects advertising content for the display; in which one or more dynamic parameters selected to be relevant to passengers on the bus or people outside the bus are tracked and the server generates or selects advertising content based on the real-time value of the parameters.

Optional Sub-Features:
Parameter is the location of the vehicle
Parameter is the time of day
Parameter is the weather or lighting or temperature
Parameter is the traffic conditions
Parameter is the specific demographic of passengers
Parameter is the behaviour of passengers
Parameter is the language spoken by passengers
Parameter is cookies or other data identifying preferences or behaviours and that is detectable from a smartphone, smartwatch, tablet, laptop or other electronic device used by a passenger
Parameter is detected or inferred or obtained by a sensor in the vehicle
content server that generates or selects content based on any combination of the above parameters
Sensor is a computer vision system
Sensor is a speech or language analysis system
Content is video advertising content
Content includes news content
Content includes entertainment content
Display is internal and/or external to the bus
Content is dynamically generated in real-time, as opposed to being stored and retrieved.
Content server can be local to the vehicle, or in the cloud, or distributed between the vehicle and the cloud

Feature 14: Contactless ‘Stop Request’ Sensor

The Arrival vehicles include a ‘stop request’ that is activated by a capacitive proximity sensor—e.g. a driver or passenger merely has to wave a hand over the surface of the sensor, or they can optionally touch the sensor (gloved or ungloved), which in turn causes the sensor to light up, or make a sound, or provide some other feedback, such as haptic feedback, when the sensor has been activated.

The sensor is principally a stop request sensor, but the same structure can be used for any other single function sensor where hands free activation is desirable, such as a sensor near the access door that is activated to deploy an access ramp for wheelchair users. Where the sensor is a stop request sensor in a bus, it is fully integrated into each hand pole in the bus, resulting in a sleek and easy to clean product, as shown in FIG. 140, which shows stop request sensor 1035 integrated into hand pole 1036. Four images are shown; moving from left to right, we have a front view, rear view, perspective view and close up view of the top of the stop request sensor 1035. Stop request sensor 1035 includes a ring or border 1037 surrounding the sensor plate, which is shaped as an elongated rectangle with rounded ends or lozenge; ring or border 1037 lights up when activated. A lozenge shaped surface face 1038 rises up subtly to present a simple surface of contact or proximity; this surface is part of a translucent plastic part that integrates and fits flush with the actual grab pole 1036. This part can appear on both sides of the pole, making it double sided and easy to see and reach for passengers. The stop request sensor 1035 included braille markings 1039. The sensor 1035 is a touch capacitive switch that requires no moving parts; the sensor 1035 housing therefore needs only a single exposed component (the capacitive sensing surface), making it simpler compared to conventional mechanical push buttons and easier to clean, since the surface is flush and sealed.

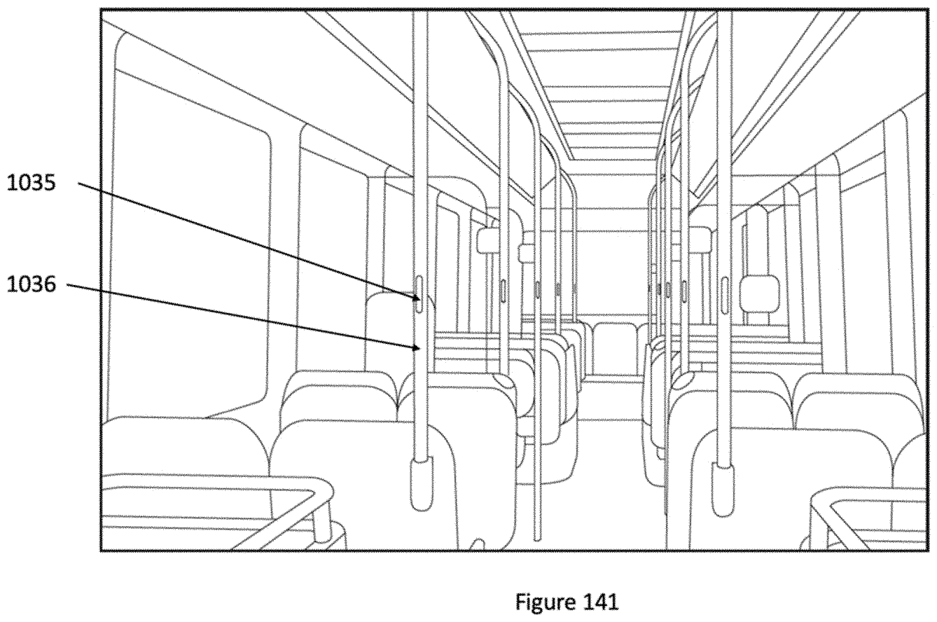

FIG. 141 is an interior view of the bus, showing a number of hand poles 1036, each with an integrated stop request sensor 1035.

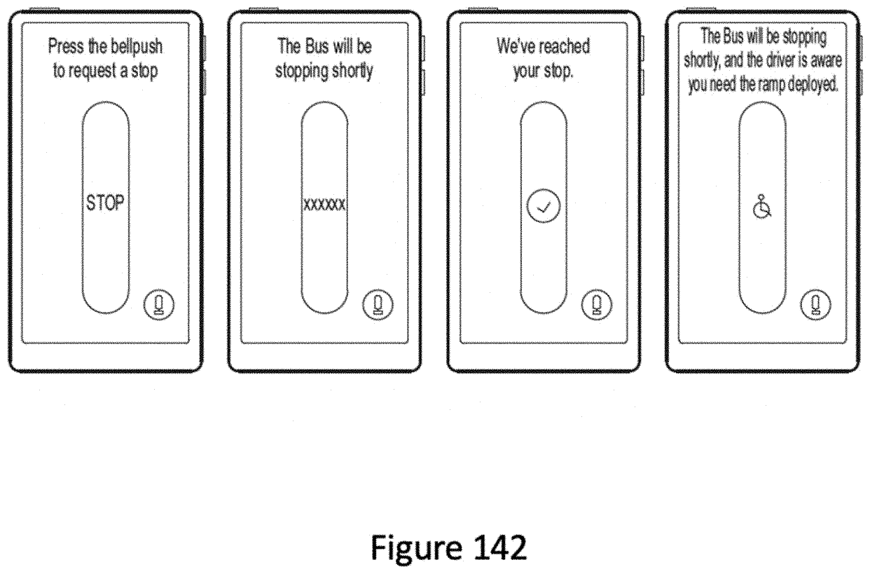

An image of the stop request sensor can also be displayed on a passengers smartphone app, as shown in FIG. 142. Then, touching the image of the stop request sensor, or speaking a voice command, sends a signal over the bus' local wi-fi to alert the driver that a stop has been requested, just as though the physical stop request sensor 1035 had been selected.

The sensor can also, for example, be a door open request sensor that the driver of the vehicle operates to open and close the door cabin using a hands-free operation.

Generalising, we have a bus including a single function proximity-sensitive sensor that is (i) tuned to detect the proximity of a passenger's hand without the need to contact the sensor and (ii) to send a control input to a bus control system.

Optional Sub-Features:
The vehicle is a bus and the sensor is a ‘stop request’ sensor and the control input is a request from a passenger that the bus stop at the next stop
The control input automatically opens or closes a door of the vehicle
the sensor is a ‘ramp request’ sensor and the control input is a request from a passenger that the bus stop deploy its access ramp.
The sensor is tuned to the specific electromagnetic environment it is in
The sensor provides visual, haptic or sound-based feedback when activated
The proximity-sensitive sensor is a capacitive sensor
One capacitive plate of the sensor is a conductive plastic member
An electrical connection between the conductive plastic member and the capacitance measurement circuit board is achieved by dual-purposing metallic fixing screws that attach the plastic member to the circuit board
Proximity trigger thresholds used by the capacitance measurement circuit can be modified using over-the-air updates
Proximity trigger thresholds used by the capacitance measurement circuit can be modified dynamically depending on environmental conditions in or outside the vehicle, as automatically measured by vehicle sensors
The proximity-sensitive sensor is integrated into a vertical support pole in the bus
The proximity-sensitive sensor is positioned on the outside of the bus near a door with an access ramp.
Each vertical support pole in the bus includes an integrated proximity-sensitive sensor
Passenger instead uses an app on the passenger's smartphone or smartwatch or other personal, connected device.
Passenger speaks a request that the bus should stop, and the bus includes a microphone and speech recognition and analysis system that detects the request passes that request to the bus control system.

Feature 15: Wrap-Around Display Screen

The Arrival bus vehicle is constructed by joining together separate modular transverse body sections (e.g. 8 sections). FIG. 143 shows how the upper section of each transverse section that sits over a window or door in each section includes a display panel module 1040 (e.g. LED, OLED or other high resolution, full colour display panel). Each display panel module 1040 is integrated into a modular transverse body section during bus production; each display screen module forms the outer surface of each upper section—i.e. there is no need to construct a glass or transparent window with its own frame and then position and secure a conventional LED panel behind it; instead each display screen module itself slots directly into a frame defined by a modular transverse body section, saving weight and decreasing build time; if a display panel fails or needs upgrading, then it can readily be swapped out and a replacement swapped in. This Arrival bus has eight, contiguous display panel modules 1040 running along the side of the bus. The display panels have thin bezels or edges to give the impression of a single, continuous display running the entire length of the bus.

At night, the full length display panels are especially striking, and are an effective and engaging way of presenting travel information since the available displays screen real estate is so large and dynamic, as well as advertising content. The outer surface of each display screen module is substantially flush with the window or glass or transparent material it sits over, and substantially flush with adjacent display screen modules, aiding aerodynamic efficiency and hence increasing range. The front of the bus also includes a similar display panel module 1041, as does the rear of the bus.

Each display screen module may also itself provide some structural rigidity. Each display screen module is connected to a content server that can generate multi-modal content—i.e. content of different types, namely route information, passenger information, and also advertisements. The content can be automatically selected based on parameters, such as proximity to a bus stop (e.g. the display content changes from advertisements to alternating between passenger guidance, such as which doors should be used to enter the bus, and route and traffic information); time of day (e.g. the display content changes to dim at night, or show advertisements more appealing to a night crowd, such as alcohol); cold weather (e.g. the display content alternates between showing advertisements and displaying the warm the ambient temperature in the bus); hot weather (e.g. the display content alternates between showing advertisements and displaying the cool, air-conditioned the ambient temperature in the bus).

The overall result is a display screen that appears to run substantially the entire length of the bus, yet is cheaper to provide, install and maintain than conventional displays that are fitted to the external skin of a vehicle and is also more aerodynamic than those conventional displays.

Each display screen module can include not only an outward-facing display panel, but also an inward-facing display panel as well; hence passengers inside the bus also experience a full length, apparently continuous display screen, running over all the windows and doors of the bus.

We can generalise to:

A vehicle including a series of display screens that extend along substantially the entire length of the bus, over all doors, and runs along substantially all of the front and rear of the bus, giving the appearance of a display that substantially wraps around the bus.

Optional Sub-Features:
the display is connected to a content server that can generate one or more of the following: route information, passenger guidance information and also advertisements.
The display screen is made up of separate display screen modules that are substantially flush with one another and the glass window or door panels they each sit over.
The display screen is made up of separate display screen modules occupying at least 75% of the length of the vehicle.
The display screen is made up of separate display screen modules occupying at least 75% of the width of the front and rear of the bus,
The display screen is made up of separate display screen modules that appear to form a continuous display band around the vehicle
The display screen runs in a band, of substantially constant height
The display screen runs in a band, of substantially constant height above the passenger windows of the vehicle
The display screen is made up of separate display screen modules that are each formed into a modular body section, and the vehicle is made up of multiple, transverse modular body sections that are joined, bonded or glued together.
The display screen includes flexible display screen modules that form curved edges of the vehicle.
The display screen is covered by a cover of glass, plastic or other translucent material, and that cover forms a single surface that appears continuous to a person viewing the vehicle from the roadside.
Each display screen module is connected to a content server that can generate multi-modal content—i.e. content of different types, namely route information, passenger information, and also advertisements.
The content can be automatically selected based on variable parameters,
The parameters include proximity to a bus stop (e.g. the display content changes from advertisements to alternating between passenger guidance, such as which doors should be used to enter the bus, and route and traffic information);
the parameters include the time of day (e.g. the display content changes to dim at night, or show advertisements more appealing to a night crowd, such as alcohol);
the parameters include cold weather outside the vehicle (e.g. the display content alternates between showing advertisements and displaying the warm the ambient temperature in the bus);
the parameters include hot weather outside the vehicle (e.g. the display content alternates between showing advertisements and displaying the cool, air-conditioned the ambient temperature in the bus).
Each display screen module includes not only an outward-facing display panel, but also an inward-facing display panel as well, so that passengers inside the bus also experience a full length, apparently continuous display screen, running over all the windows and doors of the bus.

Feature 16: Bus with Weight Sensors

The Arrival Bus is able to measure or estimate total passenger weight using load cells attached to one or more of: the axles, suspension system, seat or seat mounts, passenger floor. The weight data that is generated by the load cells is analysed to determine if the passenger weight exceeds a safe threshold; if that threshold is exceeded, then an alarm, such as a driver alarm, is generated. Computer vision-based people counting systems can also be used to estimate passenger weight, either on their own, or in combination with direct weight sensors, like load cells.

We can generalise to: A bus with weight sensors configured to measure total passenger weight.

Optional Sub-Features:
the weight sensors include weight sensors mounted on one or both axles.
the weight sensors include weight sensors mounted on or forming part of the bus suspension system
the weight sensors include weight sensors that are attached to the seats or seat mounts
the weight sensors include weight sensors that are attached to a floor that passengers stand on
the weight sensors include load cells
the weight sensors generate weight data which is stored in the bus
the bus includes or is connected to a weight analysis system which processes the weight data
the weight analysis system determines if the passenger weight exceeds a safe threshold and generates an alarm, such as a driver alarm, if the threshold is exceeded.
the bus includes a computer vision based people counting system and the output from the people counting system is compared or combined with the weight data to reach an estimate of the number of passengers travelling in the bus
the number of passengers travelling in the bus at any time is used by a bus scheduling system that schedules additional buses if that number exceeds a threshold.

C. Arrival Bus Ticketing Features

Feature 17: Differential Bus Ticket Pricing Based on Sensor Data.

The Arrival Bus has an array of sensors that enable dynamic ticket pricing based on data from the sensors. For example, where a bus is over-crowded, or there are no seats, then that is clearly an inferior service compared to a bus with available seats; with a conventional bus, a passenger simply has to put up with that inferior service and pays the same for a ticket irrespective of the quality of the experience. This in turn removes any direct financial incentive for bus operators to improve the quality of their service. But with the Arrival Bus, sensors in the bus automatically determine that there are no seats, or that there are more than a threshold number of standing passengers. New passengers can then be automatically offered tickets at a reduced rate; existing passengers who have paid electronically can be automatically refunded an amount so that they are also paying at a reduced rate.

A bus operator can hence choose to dynamically price tickets for a specific bus depending on real-time occupancy of that bus: this in turn encourages passengers to use this bus service, since they know that if the bus is not over-crowded then they will pay a reasonable fair, and that they will automatically pay less if e.g. no seats are available.

This can make bus travel more attractive to potential passengers; ultimately, the Arrival Bus system aims to encourage greater use of green public transport, and dynamic ticket pricing based on bus occupancy is an effective tool for achieving this.

We can generalise to: A bus ticketing system configured to generate bus tickets with pricing dependent on real-time data from one or more sensors in the bus which determine the bus occupancy or number of standing or seated passengers.

Optional Sub-Features:
the bus ticketing system is configured to issues tickets with reduced pricing if the numbers of standing passengers exceeds a threshold.
sensors are or include weight sensors or load cells attached to each seat
sensors are or include weight sensors or load cells attached to the floor of the bus
sensors are or include weight sensors or load cells attached to handrails in the bus
sensors are or include computer vision based people counting systems
the bus includes an external display that shows the bus occupancy, such as: the number of seats available, the number of passengers on board, the number of standing passengers

Feature 18: Bus Tickets Sold for Specific Unoccupied Seats Based on Real-Time Sensor Data

In the Arrival Bus, sensors determine whether a specific seat is occupied or not; for example, each seat could include a load cell and data from that load cell is then sent to the ticketing system in the bus and in the cloud; a passenger waiting for the bus, or in the bus, can then open a ticketing app and browse available seats and purchase a ticket for any unoccupied seats. Passengers can use this functionality to ensure that they are seated next to their friends, or to ensure they get a seat on a bus that could get crowded, or ensure that they sit in a preferred seat (e.g. at the front of the bus with an extra leg-room seat etc).

We can generalise to: A bus ticketing system configured to generate a bus ticket for a specific seat dependent on real-time data from one or more sensors in the bus, which determine occupancy for that specific seat.

Optional Sub-Features:
sensor is a weight sensor for an individual seat or seat mount
sensor is a load cell for an individual seat or seat mount
sensor is a computer vision system
each seat includes a light or other display to indicate whether it is reserved or not.
bus ticket is a virtual or e-ticket
the bus includes an external display that shows if any seats are available

Feature 19: Dynamic Pricing of Seats Based on Real-Time Data

In the Arrival Bus, sensors or control devices can be used to dynamically and automatically alter ticket pricing. For example, at certain times of day, pricing can be automatically altered; for example, during quiet afternoon periods, pricing can be reduced to encourage use and limit over-crowding during rush hour. At certain locations, pricing can be automatically altered; for example, when the bus reaches a low income area, then ticket prices can be reduced. Sensors can also measure temperature or climate; if the bus activates its AC control (e.g. because it is too hot outside the bus, or inside the bus), then a signal is sent to the ticketing system for that bus and the pricing of tickets is automatically increased.

We can generalise to: A bus ticketing system configured to generate a bus ticket with pricing dependent on real-time data from one or more sensors or control devices.

Optional Sub-Features:
sensors are temperature or climate sensors
sensor is a location sensor
control device is a clock
control device is a driver-activated HMI.
temperature sensor measures the internal temperature in the bus
temperature sensor measures the external temperature
control device is an A/C activation control device.
the bus includes an external display that shows when AC is turned on
the bus includes an external display that shows when discounted fares are available
bus ticket is a virtual or e-ticket

D. Arrival Bus Utilisation Measurement Features

The Arrival Bus includes sophisticated passenger number estimation systems and bus usage systems that enable: increased passenger comfort and safety; selection of a lower capacity battery pack (which is lighter than a larger pack, leading to a lighter and hence more energy efficient bus); more effective route planning and scheduling, based on actual usage data; more effective predictive maintenance, based on actual bus usage; enhanced residual value of buses and key components, such as batteries; reduction in fare non-compliance; enhanced advertising revenue based on actual passenger viewing data.

This in turn makes alternative bus purchasing mechanisms feasible: a conventional outright purchase of a bus puts the buyer's focus on achieving the lowest possible purchase price, which in turn means avoiding features that would enhance passenger comfort and safety and long term bus residual value. Because the Arrival bus has sophisticated automated people counting systems and bus usage systems, this opens up the possibility of looking at the total cost of ownership of a bus over its entire lifetime, which in turn makes it possible to move the purchaser away from focusing on the lowest possible purchase price. Instead, alternative approaches, based on accurate usage tracking, and lowering the total cost of ownership by increasing residuals and deploying effective preventative maintenance, become possible.

Feature 20: Bus with Ticketing System and Vehicle Weight Sensing

The Arrival Bus has a ticketing system that tracks the number of tickets issued and combines that data with a passenger number estimation system, based on measuring the weight of passengers in the bus, e.g. using load cells on the bus floor, and suspension systems. An analysis system can then determine if the weight of passengers at a given time is consistent with the number of tickets issued to passengers travelling on the bus at that time: where there is a discrepancy, then that might indicate a problem with passengers not paying their fare; with bus routes that regularly have a high incidence of non-paying passengers, then remedial action can be taken.

We can generalise to: A bus configured with (i) a ticketing system that tracks the numbers of tickets issued to passengers and (ii) a weight sensor system to measure the weight of passengers in the bus and (iii) an analysis system to determine if the weight of passengers at a given time is consistent with the number of tickets issued to passengers travelling on the bus at that time.

Optional features or sub-features:
weight sensors are or include weight sensors or load cells attached to each seat
weight sensors are or include weight sensors or load cells attached to the floor of the bus
weight sensors are or include weight sensors or load cells attached to handrails in the bus
weight sensors estimate the weight of passengers on the bus before and after each bus stop
analysis system generates a driver alert if there is a discrepancy between the numbers of passengers estimated from the weight sensors and the tickets sold
bus includes a computer vision based passenger counting system
output from the computer vision based passenger counting system is combined with output from the weight sensors to generate a combined estimate of the number of passengers on the bus at any time

Feature 21: Bus with Ticketing System and People Counting

The Arrival Bus has a ticketing system that tracks the number of tickets issued and combines that data with data from a computer vision based passenger counting system. An analysis system can then determine if the numbers of passengers counted at a given time is consistent with the number of tickets issued to passengers travelling on the bus at that time: where there is a discrepancy, then, as above, then that might indicate a problem with passengers not paying their fare; with bus routes that regularly have a high incidence of non-paying passengers, then remedial action can be taken.

We can generalise to: A bus configured with (i) a ticketing system that tracks the numbers of tickets issued to passengers and (ii) a computer vision based passenger counting system and (iii) an analysis system to determine if the number of passengers counted at a given time is consistent with the number of tickets issued to passengers travelling on the bus at that time.

Optional Sub-Features:
analysis system generates a driver alert if there is a discrepancy between the numbers of passengers estimated from the computer vision sensor and the tickets sold by the ticketing system
bus includes a weight sensor system to measure the weight of passengers in the bus
weight sensors are or include weight sensors or load cells attached to each seat
weight sensors are or include weight sensors or load cells attached to the floor of the bus
weight sensors are or include weight sensors or load cells attached to handrails in the bus
weight sensors estimate the weight of passengers on the bus before and after each bus stop
output from the computer vision based passenger counting system is combined with output from the weight sensors to generate a combined estimate of the number of passengers on the bus at any time

Feature 22: Bus with Sensors Recording Dynamic Usage

The Arrival Bus records many parameters relating to how a specific bus is driven and used; some components in the bus, such as the battery modules or battery packs and the power inverters and motors, are very costly but have a significant residual value after they have reached the end of their service life in a bus. That is especially true of batteries, which are the single most expensive component in a bus and also have the greatest value in a second-life for non-transportation uses, such as domestic energy storage. The second-life value of a vehicle battery may depend significantly on the sort of use it has previously been put to; the Arrival Bus tracks and records a large number of relevant parameters over the course of each day's use, over the entire working life of the battery in the bus, that might be relevant to how much the battery has degraded and how well it will perform in its second life. Parameters include: how many stops/starts, acceleration data, deceleration data, load under acceleration, load under deceleration, range travelled, battery charging data, battery state of health data, extent of super-fast charging, frequency of being charged to maximum, maintenance; repairs. From this data, a residual value profile can be calculated. For example, a battery that has been very regularly subject to super-fast, very high kWh DC charging to maximum will degrade faster than one that has not. So the residual value profiles will differ significantly.

We can generalise to: A bus with sensors in the bus that measure bus dynamic usage, and that data is used when calculating a residual value profile for components in the bus.

Optional Sub-Features:
component is a battery module or battery pack
component is an inverter
component is a motor
usage includes any of: how many stops/starts, acceleration data, deceleration data, load under acceleration, load under deceleration, range travelled, battery charging data, battery state of health data, extent of super-fast charging, frequency of being charged to maximum, maintenance; repairs.
usage includes extent of super-fast, very high kWh DC charging
usage includes extent of charging to maximum capacity

Feature 23: Bus with Use-Based Maintenance Schedule

The Arrival Bus records many parameters that affect how the bus should be maintained, including preventative maintenance such as pro-actively replacing components because data across the entire fleet of buses suggests that replacement is timely and would avoid a costly failure in the field. Unusually, the Arrival Bus also records the weight of the Bus—for example, using load cells on the suspension system, passenger floor or axles that measure the weight of passengers. Passengers can easily increase the overall weight of the bus by 50% or more; because the total weight of the bus has a major bearing on how hard the batteries and motors need to work when accelerating the bus, it is useful to combine data, such as time since last maintenance, and distance driven since last maintenance, with weight data: a bus that is consistently driven fully loaded is likely to require maintenance sooner than a bus that is only ever driven lightly loaded. Likewise, a bus that has suffered sharp shocks or bumps (e.g. from hitting pot holes or kerbs) may require early maintenance. Extreme shocks may also compromise battery cell integrity and hence require battery pack replacement.

We can generalise to: A bus generating maintenance schedule based on data from sensors in the bus that (i) measure vehicle weight and (ii) measure bus dynamic usage.

Optional Sub-Features:
usage includes any of: how many stops/starts, acceleration data, deceleration data, load under acceleration, load under deceleration, range travelled, battery charging data, battery state of health data, extent of super-fast charging, frequency of being charged to maximum.
usage includes extent of super-fast, very high kWh DC charging
usage includes extent of charging to maximum capacity
bus includes an accelerometer to record shocks, pot holes or accidents.
bus includes a weight sensor system to measure the weight of passengers in the bus
weight sensors are or include weight sensors or load cells attached to each seat
weight sensors are or include weight sensors or load cells attached to the floor of the bus
weight sensors are or include weight sensors or load cells attached to handrails in the bus

Feature 24: Method of Modelling the Predicted Lifetime of Components

The Arrival Bus records many parameters that may affect the lifetime of components. As noted above, the Arrival Bus also records the weight of the Bus—for example, using load cells on the suspension system, passenger floor or axles that measure the weight of passengers. Passengers can easily increase the overall weight of the bus by 50% or more; because the total weight of the bus has a major bearing on how hard the batteries and motors need to work when accelerating the bus, it is useful to combine bus usage data with weight data: a bus that is consistently driven fully loaded is likely to have components that will wear out sooner than the components in a bus that is only ever driven lightly loaded. Likewise, a bus that has suffered sharp shocks or bumps (e.g. from hitting pot holes or kerbs) may have significantly reduced the lifetime of some components: for example, the lifetime for suspension components in a heavily laden bus that has repeatedly hit pot holes will be far shorter than the lifetime for suspension components in a very lightly laden bus that has never hit pot holes.

We can generalise to: A method of modelling the predicted lifetime of components in a bus using data from sensors in the bus that (i) measure vehicle weight and (ii) measure bus dynamic usage.

Optional Sub-Features:
usage includes any of: how many stops/starts, acceleration data, deceleration data, load under acceleration, load under deceleration, range travelled, battery charging data, battery state of health data, extent of super-fast charging, frequency of being charged to maximum.
usage includes extent of super-fast, very high kWh DC charging
usage includes extent of charging to maximum capacity
bus includes an accelerometer to record shocks, pot holes or accidents.
bus includes a weight sensor system to measure the weight of passengers in the bus
weight sensors are or include weight sensors or load cells attached to each seat
weight sensors are or include weight sensors or load cells attached to the floor of the bus
weight sensors are or include weight sensors or load cells attached to handrails in the bus

E. Bus Automated Customer Configuration Using Vehicle Builder and Automated Production Using Robofacturing at a Microfactory

The Arrival Bus can be readily customised to the specific requirements of a purchaser, typically a city or county public transit or transportation authority. Different purchasers can have widely different requirements in terms of many features of the bus, such as length, number of seats, seating configuration, battery pack capacity, information screens, advertising screens, passenger monitoring, ADAS sensors etc. And within a single fleet, it may be useful to have many different configurations, for example short buses for city centre routes with some narrow streets; some may have few seats since they are meant to serve very crowded peak time commuter routes; others may have many seats since they are meant to serve areas with a large elderly population. Some buses could be longer, with a much larger battery pack, and designed to cross city arterial routes. Other buses could be designed for airport to city centre transit routes: these could have a large battery pack for range, and have several large suitcase storage areas by the doors—areas that would normally be taken up by seats. The permutations are huge: previously, transport planners had a very limited range of bus configuration options open to them; perhaps just a single model and configuration of bus.

Since the battery pack is the single most expensive item in a vehicle, and also the heaviest, the ability for a customer to choose exactly the battery module configuration (e.g. the number of HVBMs) needed for their vehicle(s), and to have different battery packs in different vehicles, enables the customer to optimise across all relevant factors (initial cost, residual value, total cost of ownership, range, performance, recharging costs, recharging times etc.). This is especially valuable to a fleet operator, such as a public transportation authority. The Arrival software-based and highly automated vehicle design system (Vehicle Builder) is flexible enough to automatically configure the layout and all power/data connections required for any arbitrary number of HVBMs selected by the customer; Robofacturing and Microfactories are flexible enough to put into production the vehicle; efficient customisation to meet a purchaser's exact requirements is possible.

And as the needs of that purchaser evolve, the buses can be adapted as required: for example, if more long range buses are needed, then buses that previously only had sufficient battery pack capacity for a 100 mile range can, because of the wholly modular and self-contained design of the HVBM, have further batteries added during maintenance, without requiring replacing the entire battery pack, or indeed replacing the entire bus with a long range variant.

The highly modular Arrival system therefore offers far greater flexibility than earlier system in enabling the specific seating configuration, cost, range, power and lifetime needs of customers to be met, and for their evolving needs to be met as well. With the highly modular Arrival system, it becomes straightforward to design and produce even relatively low volumes of buses that have the configurations that are optimal for the intended requirements of the customer.

Bus Configurability; Automated Customer Configuration Using Vehicle Builder and Automated Production Using Robofacturing at a Microfactory

The Arrival Bus is Built Using a Modular Platform

We have earlier in this document stated that the Arrival system addresses the complex challenges in zero emission vehicle design and production, namely achieving purchase price parity with conventional internal combustion engine vehicles, yet enabling vehicles to be purpose-built for specific market needs or customer requirements, at relatively low volumes (e.g. 500 units a year), that provide an attractive and engaging user environment. The Arrival

Bus described earlier exemplifies this. Key is a platform approach to vehicle design and assembly, with a common platform able to support vehicles of varying type and size, ranging from small cars, trucks and city delivery vehicles and much larger vehicles, like the Arrival bus described above.

Feature 25: Modular Transverse Chassis Sections

What all of these vehicles share is a structural chassis made up of multiple, modular transverse chassis sections that are configured to be joined together longitudinally, for example by a robotic production system or (for very low quantities) manual assembly. There are typically three sorts of different transverse chassis sections: a front end, a rear end, and middle sections; a small vehicle might use a front end, a single middle section and an end section. An example of an Arrival bus (which is approximately 12 m long) is shown in FIG. 144, which has nine modular transverse sections—a front section, seven middle sections and a rear section. The transverse chassis sections are: front of bus transverse chassis section 1080; driver and access door transverse chassis section 1081; front wheel arches transverse chassis section 1082; standard passenger transverse chassis section 1083; rear wheel arches transverse chassis section 1084; rear of bus transverse chassis section 1085.

Each section, apart from the front of bus section 1080 and the rear of bus section 1085, is the same length and is approximately 1.5 m long, but different lengths are possible. Internal sections (i.e. behind the driver and access door transverse chassis section 1081 and in front of rear of the bus transverse chassis section 1085) can be added or removed at design time to vary the overall length of the bus, as shown in FIG. 175. For example, if the bus has nine internal sections then the bus will be approximately 15 m long and will be comprised of eleven modular sections overall (front section, nine middle sections, and the rear section). Also, the width of each section can be varied by choosing different lengths of the structural beams that run across the width of each section. Similarly, the height of each section can be varied by choosing different lengths of the vertical extruded beams that define the sides and hence the height of the bus.

Middle sections can be configured with different options: for example, one section could include an automatic door; since each section is 1.5 m long, it is possible to make the door opening exceptionally wide—1230 mm—for optimal accessibility. Also, the modular approach means that the door openings can be placed anywhere along the bus—e.g. only at the front, or at the front and middle etc.

In the rest of this Section J, we will look at the robotic build sequence that enables the robotic production of the structure of an Arrival bus from a number of standardised physical components. As we have seen in Section A, standardising on physical components that are (a) capable of efficient and reliable robotic handling, assembly and bonding/attachment and (b) capable of being re-used across many different parts of the vehicle, is key to the Arrival system. Each transverse modular section is not a standard pressed steel monocoque, but instead a structural, transverse modular chassis section or platform made of standardised physical components that are assembled by robots.

FIG. 145 sequence no. 1 and no. 2 shows the assembly of the base 1050 of the modular transverse chassis section, made from an extruded aluminium structural central beam 1051 with composite sandwich panels 1052 on each side of this central beam, and a pair of structural extruded aluminium transverse beams 1053 at each end of the modular transverse chassis section 1050, as well as a pair of longitudinal structural extruded aluminium beams 1054 on each longitudinal edge of the modular transverse chassis section 1050.

A solid extruded aluminium plate (not shown here) is attached to form the underside of this to give structural integrity and to provide a strong platform on which the battery modules can be mounted. Build sequence no. 3 shows the composite side panels 1055 and vertical extruded aluminium side posts or struts 1056 being assembled together. Build sequence no. 4 shows the side panels 1055 and aluminium side posts 1056 being assembled onto the base 1050 of the modular transverse chassis section.

In FIG. 146, build sequence no. 5 shows the roof longitudinal structural members 1057 being assembled to the roof transverse structural members 1058. Build sequence no. 6 shows the composite roof panels 1059 and the roof longitudinal structural extruded aluminium bars 1060. In build sequence no. 7, the composite roof panels 1059 and the roof longitudinal structural extruded aluminium bars 1060 are attached to the roof transverse structural members 1058 to form the roof. Build sequence no. 8 shows the roof being attached to the vertical beams or struts 1056 to form a single transverse chassis section 1049. This build sequence will be described in more detail below. FIG. 147 shows a single modular transverse chassis section 1049 in complete (left side) and exploded (right side) formats.

The modular transverse chassis sections 1049, when joined together longitudinally, form a flat topped ‘skateboard’ platform, making it possible to design and configure virtually any arrangement of seats, or storage, or anything else, on that platform, hence enabling any type of vehicle to be designed and made using the same standard chassis platform.

This approach gives tremendous flexibility: different frame and body structures and styles can be added to the top of the chassis or platform for different customers, enabling vehicles addressing specific customer needs to be designed and brought into production within 12 months, compared to a typical 3-5 years using a more conventional approach. Vehicles of different length are created by adding more transverse modular chassis sections 1049—i.e. extending its length longitudinally to the extent required. For the Arrival bus shown above, which is about 12 m in length, as explained above, some of these standard modular transverse chassis sections support the wheel housings, and then the body includes a standard window panel and above that window panel, a standard display panel; other modular transverse chassis sections support a door, and then above the door is the same standard display panel; other modular transverse chassis sections support a standard window panel and above that window panel, a standard display panel.

Extruded aluminium frames are standardised for all of the modular, transverse sections, and are fixed to the chassis sections and to one another in the same, standardised manner, optimised for robotic assembly in that the access pathways for robotic end effectors are standardised, as are the joining/bonding materials and processes used to secure all elements in a single modular, transverse section together and to join/bond adjacent modular, transverse section together to form the entire shell of the vehicle. FIG. 148 shows one typical approach to assembling physical components together; in this case it shows how a vertical beam or strut 1056 and a pair of roof longitudinal structural extruded aluminium sections 1060 attach to a triangular roof corner structural extruded aluminium casting 1062. As the circular call-out shows, the sections include male and female mating parts that are pushed together; adhesive is then injected into the joint to permanently attach the components together.

So structural joints for the vehicle body can be provided with a male/female insertion structure (‘mortise and tenon’), for example to join extrusions to castings. The insertion structure is bonded together by robotically injecting adhesive; a foam or similar material bung may be provided in the female joint to control the adhesive flow path. The male and/or female parts may be tapered, as shown in FIG. 148, to enable increased tolerances for robotic production. As a result, joints of increased strength can be produced with simple steps that are particularly suitable for robotic production.

A frame for attachment of body panels is secured to the skateboard platform by specifically formed joints that facilitate robotic production. Specifically, an edge of the skateboard platform comprises a profiled portion that matches a profile of a free end of a frame member. Alignment may be aided by a conical locating pin. The joint may be secured by self-tapping bolts enabling rapid attachment and removal, facilitating repairs if needed.

In conventional vehicles, the suspension and other drive components are attached to the vehicle chassis by dedicated mounting structures together with non-structural parts. The Arrival system provides, as noted earlier, structural wheel arches that integrate a mounting point for the suspension, spreading the suspension load over the entire wheel arch. A wheel arch for housing at least one wheel of a vehicle and for attachment to a chassis of a vehicle is used. The wheel arch comprises a load bearing mounting point, and the wheel arch is configured to receive forces at the load bearing mounting point from a vehicle component mounted at the load bearing mounting point.

We can generalise to: A vehicle that includes a structural chassis made up of multiple, modular transverse chassis sections that are configured to be joined together by a robotic production system.

Optional Sub-Features:
the sides of the bus are formed using substantially straight, vertical structural pillars that are attached to a transverse chassis section of approximately 1.5 m in length,
multiple transverse chassis section are joined together to form the complete bus chassis or platform
a passenger door is positioned between two of the vertical, structural pillars and has an opening width of approximately 1210-1250 mm.
a structural wheel arch is attached to a transverse chassis section

Feature 26: Robotic, Cell Based Production

As noted above, the transverse modular chassis sections are designed to be joined together and handled by a robotic production system: specifically, not a conventional long moving production line system, but instead a small cell of robots, each fixed to the floor and each supplied with individual transverse chassis sections by robotic delivery devices; the cell-based robots then operate to join together the transverse chassis sections, which are each configured for fast and reliable robotic handling. In addition to the transverse chassis sections, each robotic cell can assemble all of the main components for a specific vehicle, which remains in the same cell throughout the main production steps; each cell therefore assembles the various components and elements (e.g. chassis, drivetrain, wheels, batteries, body) for an individual vehicle.

We can generalise this to:

A method of producing a vehicle, in which a robotic production system assembles, at a cell of robots at a fixed location, and not a moving production line, at least part of the vehicle by robotically attaching components together to form parts of the vehicle, and substantially an entire vehicle is assembled at multiple such cells.

Optional features or sub-features:
robots at a cell join together extruded aluminium sections to form a superstructure for the body of the vehicle
robots at a cell join extruded aluminium sections to parts of a chassis or skateboard platform
robots at a cell join composite body panels to extruded aluminium support structures for those panels
robots at a cell join together multiple, modular transverse chassis sections to form a structural chassis.
robots at a cell follow instructions generated by an automated vehicle design tool
each cell includes between two and ten robots

Feature 27: Cell with Self-Governing Robots

A cell of robots, programmed to assemble multiple, modular transverse chassis sections together to form the chassis of the vehicle, are self-governing robots that are programmed to dynamically work out amongst themselves, arbitrating as required, the optimal production process for each new vehicle they build.

All services (including glue lines) and components are brought to this cell, which is compact (e.g. 6 m×6 m) and rapidly scalable without the CapEx involved in building a conventional assembly line with dedicated, deterministic robots.

Each robot has access to the schedule of what other tasks all other robots in its cell will perform and the movement trajectory of all arms and effectors; autonomous co-operative task planning and scheduling and component assembly is achieved at the individual cell level; this may be through all robots sharing or accessing a common server or compute platform, which may be local to the cell, in the same factory as the cell, or cloud based, or distributed across any of those.

Each cell is hence able to dynamically work out how to build a vehicle; this is feasible because the vehicle has been designed for optimal autonomous or self-governing robotic production, through e.g. standardised sized parts (e.g. all main transverse chassis sections are 1.5 m long), frames are made from pieces of standardised length; standardised fitting processes (e.g. how one transverse chassis section fits to an adjacent section is the same for all chassis sections), and standardised joining (e.g. glue insertion) processes. Each robot in a cell has full environmental awareness, e.g. using a computer vision and/or depth sensing system that enables it to dynamically and in real-time understand the location of other robots and their effectors, the location and structure of the vehicle it is co-assembling; the location of any materials or sub-assemblies it needs to incorporate into the vehicle; the location of any supply robots providing components and sub-assemblies.

We can generalise to: A robotic production cell for vehicle production, comprising a group (e.g. 2 to 10) of self-governing robots that are programmed to dynamically work out amongst themselves, arbitrating as required, and execute, the optimal production process for each new vehicle they build.

Feature 28: The Microfactory

A low CapEx microfactory with even only 5-10 of these cells could economically produce 1,000 vehicles a year; even smaller numbers of cells could be useful, for example in producing prototypes or highly specialised vehicles required in low numbers.

We can generalise this to:

A vehicle production factory comprising a number of robotic production cells for vehicle production, each cell comprising a group of robots that are programmed to assemble, at a fixed location and not a moving production line, at least part of the vehicle by robotically attaching components together to form parts of the vehicle, and substantially an entire vehicle is assembled at multiple such cells.

Feature 29: Bus with Customer-Specified Battery Capacity

An electric bus design and production process, the bus including multiple batteries;
in which a customer specifies the battery capacity or range required for a specific new bus or fleet of buses, and an automated vehicle design tool then automatically selects battery-related components required for the specified battery capacity or range; and automatically generates build instructions for that vehicle or fleet of vehicles;
and a robotic production environment then automatically builds or assembles the bus as designed by the automated vehicle design tool, including a battery pack that meets the specified battery capacity or range.

Feature 30: Vehicle with Integrated, Customer-Specified Sensors

An electric bus design and production process, the vehicle including multiple sensor based systems, such as ADAS, LIDAR, computer vision based driver monitoring, computer vision based passenger monitoring, load or weight sensors;
in which a customer specifies which sensor based systems or their related functionality are required for a specific new bus or fleet of buses, and an automated vehicle design tool then automatically selects components required for the specified sensor based systems or their related functionality; and automatically generates build instructions for that vehicle or fleet of vehicles;
and a robotic production environment then automatically builds or assembles the bus as designed by the automated vehicle design tool, integrating the sensor based systems into the bus.

Feature 31: Post-Production Change to a Different Battery Pack Capacity

An electric bus with an original factory-installed battery pack, including multiple battery modules, with a specific battery capacity;
in which the bus is configured to enable the original battery pack to be altered by adding one or more further battery modules to the battery pack, or removing one or more battery modules from the battery pack.

Feature 32: Post-Production Update of Integrated, Customer-Specified Sensors

An electric bus with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the bus' data and security network and systems.

For Features 25-32, the following optional sub-features are relevant:
robots at a cell join together extruded aluminium sections to form a superstructure for the body of the vehicle
robots at a cell join extruded aluminium sections to parts of a chassis or skateboard platform
robots at a cell join composite body panels to extruded aluminium support structures for those panels
robots at a cell join together multiple, modular transverse chassis sections to form a structural chassis.
robots at a cell follow instructions generated by an automated vehicle design tool
each cell includes between two and ten robots
each cell comprises a group of robots that are programmed to assemble one or more of the chassis, composite body panels and supporting structures for those panels, drivetrain, and structural wheel arches, using instructions generated by an automated vehicle design system.

Modular Transverse Chassis Sections
Modular transverse chassis sections have a fixed length, e.g. 1.5 m
Modular transverse chassis sections for wheel housings have the same fixed length as modular transverse chassis sections for the main body of the vehicle
Modular transverse chassis sections have a structural one piece bottom plate
Modular transverse chassis sections are configured to support an extruded aluminium frame
Vehicles of different length are assembled using a different number of modular transverse chassis sections
Modular transverse chassis sections are joined together when oriented horizontally, so that additional chassis sections extend the vehicle longitudinally
The modular transverse chassis sections, when joined together, provide a substantially flat-topped chassis or platform.
Modular transverse chassis sections include a central rigid beam that connects to a rigid structure in an adjacent chassis section
Modular transverse chassis sections for wheel housings include a flat, extruded aluminium panel with a cut-out on opposite sides, shaped to receive a wheel housing
A drivetrain or integrated drive unit (IDU) is attached to a modular transverse chassis section
A modular transverse chassis section is configured to receive multiple different types of integrated drive unit (IDU), which each conform to one of the following types: an IDU including a motor and control electronics; an IDU including a motor, control electronics and a differential; an IDU including two motors and a gearbox; and in which each type of IDU is configured to be bolted or attached to a modular transverse chassis section
The modular transverse chassis sections are glued together, e.g. using a robotic production system
Each modular transverse chassis section includes one or more glues holes and channels to enable glue to flow under pressure around tenons or other joints that are themselves optimised in shape to ensure effective and complete glue coverage.
Each modular transverse chassis section includes one or more glue channels and a foam bung configured to seal a channel
Battery pack modules of a standardised size are assembled into or onto a modular transverse chassis section

Frames
Each modular transverse chassis section includes a channel or socket into which body frames are configured to be slotted, e.g. by a robotic production system
The body frames are made of extruded aluminium beams or poles
The body frames are made of extruded aluminium beams or poles that have male/female friction fit joints that are glue bonded together
Some body frames are configured to receive and retain body panels
Body panels are made of a composite material
Some body frames are configured to receive and retain display panels (e.g. LED displays)
Some body frames are configured for a specific type of body module

Body Modules
Each body frame forms a specific type of body module
For a bus, the body module types are: a front module, a wheel housing module, a door module, a window-only module, a rear module
Further body module types include: a driver module, a driverless cab module, a passenger module, a rear module, a cargo module, or any task specific module, and all are configured to be fixed to the chassis sections in substantially the same manner e.g. by a robotic production system
Each body module is configured to be glue bonded together, e.g. using a robotic production system.

Microfactory Cells
A cell includes no more than 10 robots
Each robot in a cell is statically floor mounted
Each robot in a cell undertakes multiple different types of assembly tasks
Each cell is also served by mobile robots
A cell undertakes the assembly and joining of modular transverse chassis sections together for a specific vehicle
A cell undertakes the joining of frames or modular body parts to modular transverse chassis sections
A cell undertakes the joining of modular drivetrains to modular transverse chassis sections
A cell undertakes the joining of modular wheel housings to modular transverse chassis sections
A cell undertakes the joining of modular battery packs to the chassis
A cell undertakes the assembly and joining of modular components to the chassis
the assembly of the chassis and the addition one or more of the drivetrain, suspension, battery packs for a specific vehicle is all completed by a single cell
Localising the assembly of the chassis and the addition one or more of the drivetrain, suspension, battery packs to a single production cell enables low volume (e.g. 1,000 or fewer vehicles per year) yet economically viable production of vehicles
Localising the assembly of the chassis and the addition one or more of the drivetrain, suspension, battery packs to a single production cell enables low volume, customer specific production of vehicles
Adding further cells enables scaling of production capacity
Each cell is connected to all other cells in a microfactory, over a data network
The microfactory is less than 100,000 square metres in size
Microfactory is less than 50,000 square metres
Microfactory is approximately 20,000 square metres

FIG. 149-FIG. 173 are a build sequence for the main structural elements that form the Arrival bus.

In FIG. 149, a single modular, transverse chassis section is formed initially from a central extruded aluminium beam 1051; a pair of flat sheets of composite material 1052 are joined (FIG. 150) to the central beam 1051, and extruded aluminium side bars 1054 added (FIG. 151) to the outer edges of the flat sheets 1052.

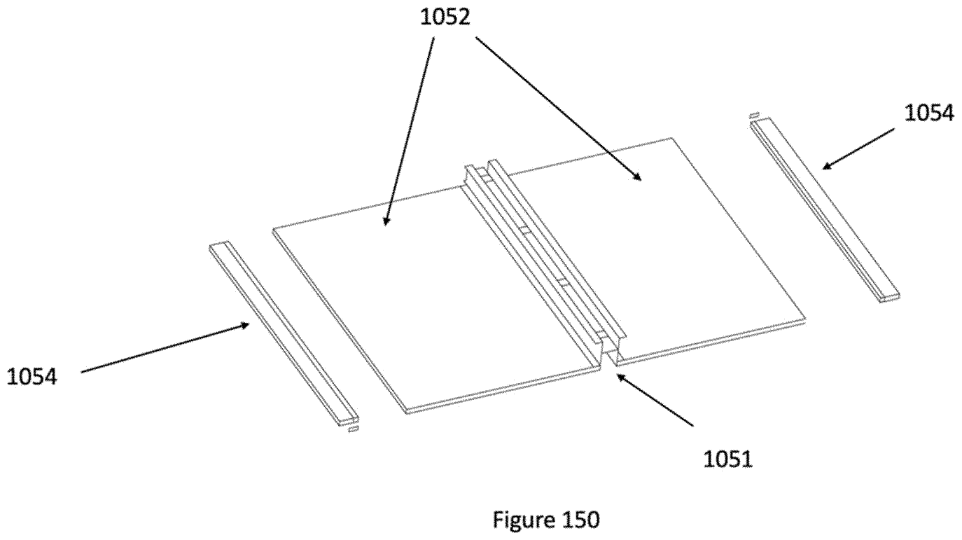

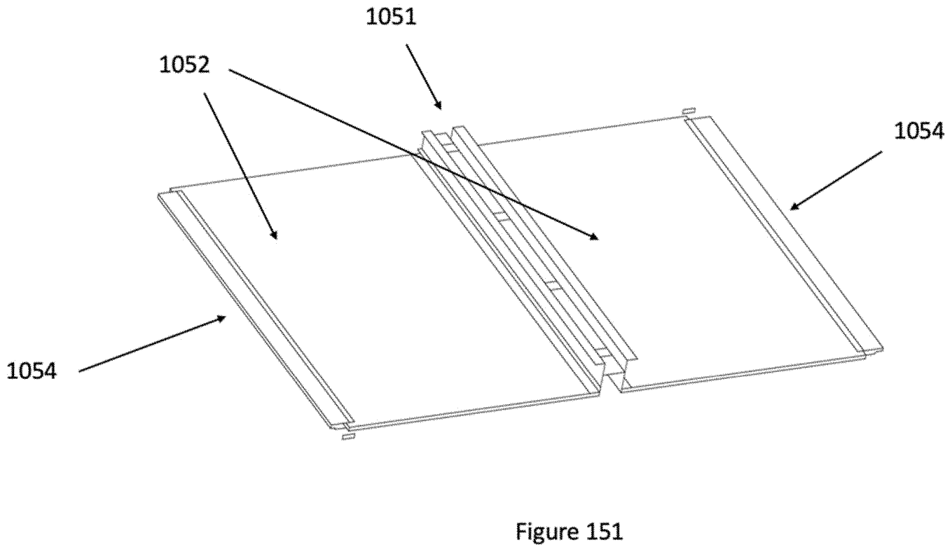

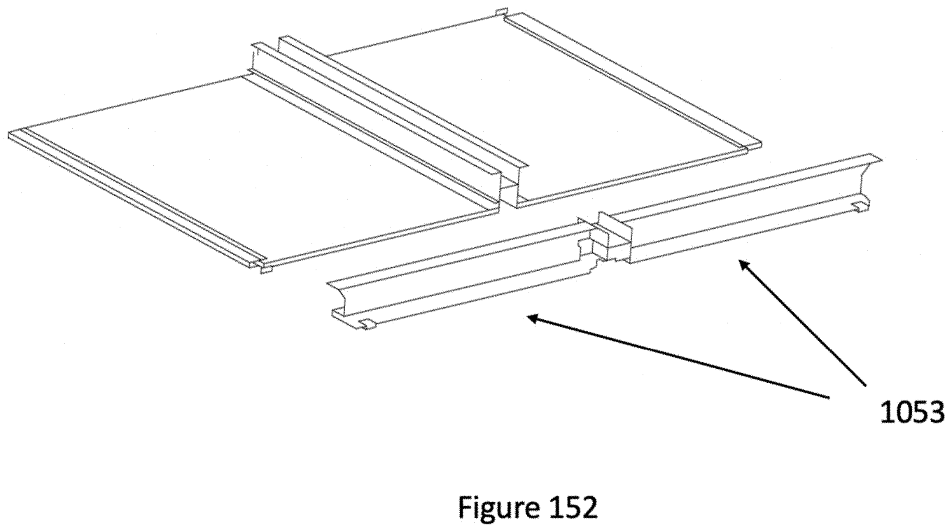

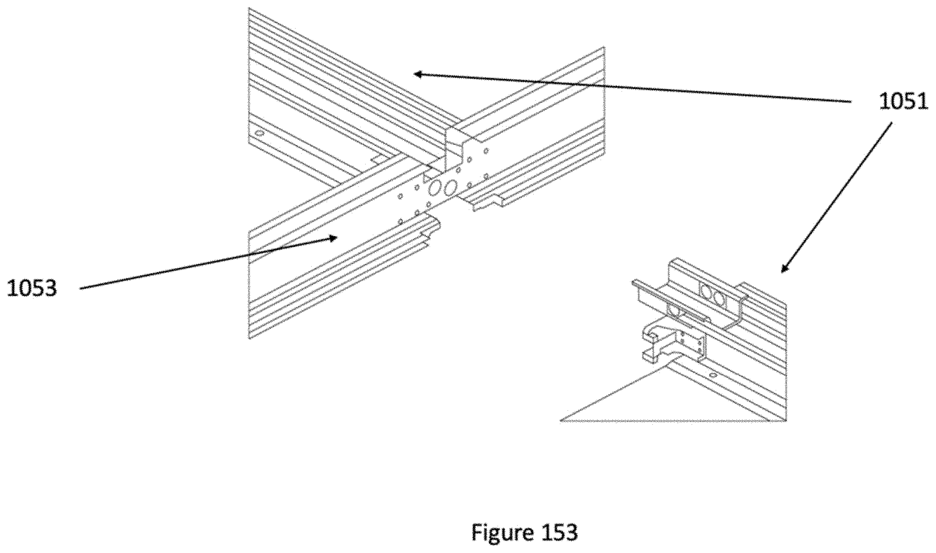

A pair of extruded aluminium transverse beams 1053 are added in FIG. 152. A close up, showing the mating structures that connect adjacent extruded aluminium central beams 1051 to the extruded aluminium transverse beam 1053 is in FIG. 153.

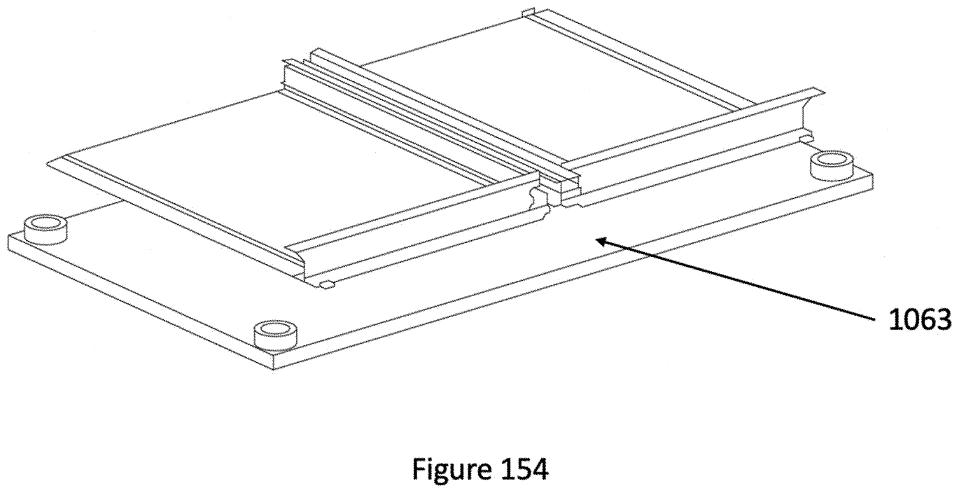

A flat, rigid, thick aluminium base 1063 is then brought up to the previously assembled structure, as shown in FIG. 154. The flat, rigid extruded aluminium base 1063 is then attached, as shown in FIG. 155 and this combined structure forms the base of the structurally rigid modular transverse chassis section. A series of these modular transverse chassis section, when joined together, form the platform of the chassis. The flat, rigid extruded aluminium base has circular sockets 1064 at each corner to receive a frame that will define the body or superstructure that sits on this rigid chassis.

Since battery modules will be added to sit on at least some of these transverse chassis sections, appropriate high voltage bus bars 1065, as well as conduits 1066 etc for other vehicle systems, such as the HVAC system, are added at this time, as shown in FIG. 156. These run down the extruded aluminium central beam 1051 and provide an extensible framework enabling battery modules and HVAC systems to be readily added to the vehicle. The HV backbone includes pre-installed connection interfaces for HV battery packs, traction inverters, and front and rear HV distribution systems.

FIG. 157 shows how sub-assemblies for the side of the modular section are assembled; the basic process is again to take extruded aluminium longitudinal sections 1068 and join composite side panels 1069 or other structures to them; and to then join this sub-assembly to a vertical extruded aluminium frame or strut 1056.

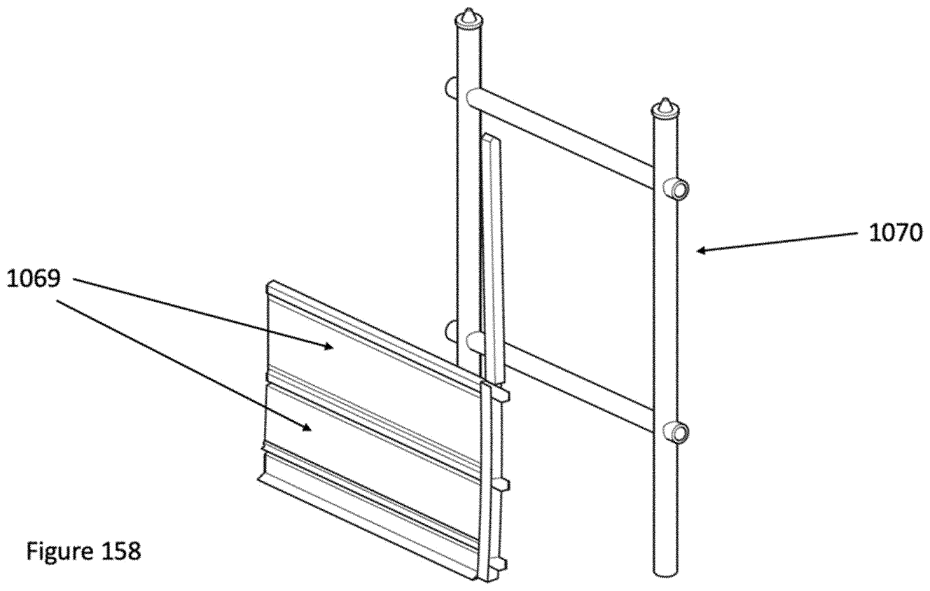

A structurally rigid side frame of extruded aluminium struts or rods (the ladder frame 1070 in FIG. 158) is then assembled and the side panel assembly is then brought to and joined to the ladder frame 1070; for a bus, the sides are generally vertical, so the frame is vertical. But different shapes of frame enable rapid customisation to different overall vehicle designs; the rods can be readily shaped and curved to form a desired shape.

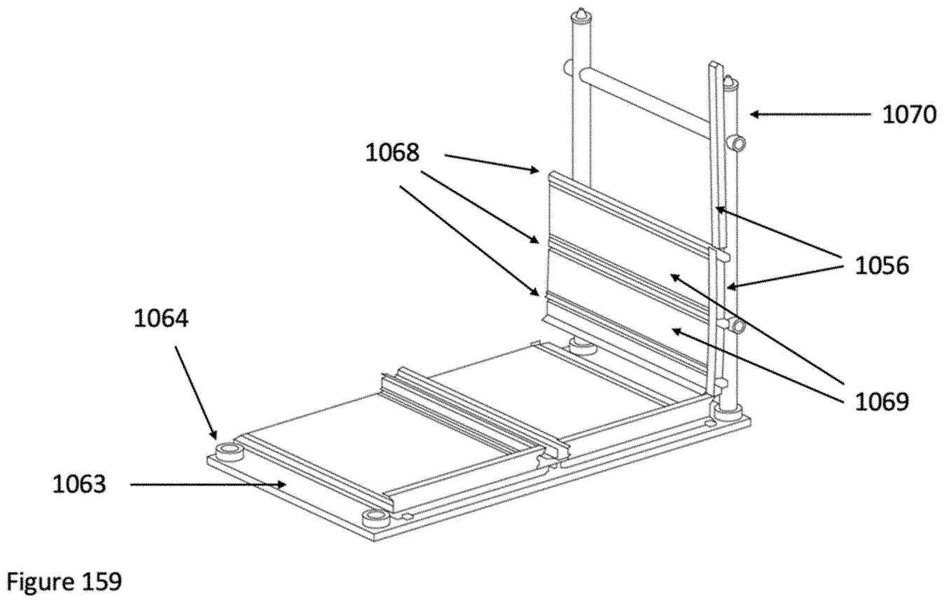

The beams or struts formed into a ladder frame 1070, side panels 1069 and extruded aluminium longitudinal sections 1068 form a sub-assembly that is then joined to the transverse modular chassis section, with the vertical rods of the side frame (generally with square or circular cross section male/female friction fit interfaces that can be glue joined) slotted into and joined to the circular sockets 1064 in the structural aluminium base 1063 that forms the base of the transverse modular chassis section, as shown in FIG. 159. The process is also carried out for the opposite side, as shown in FIG. 160.

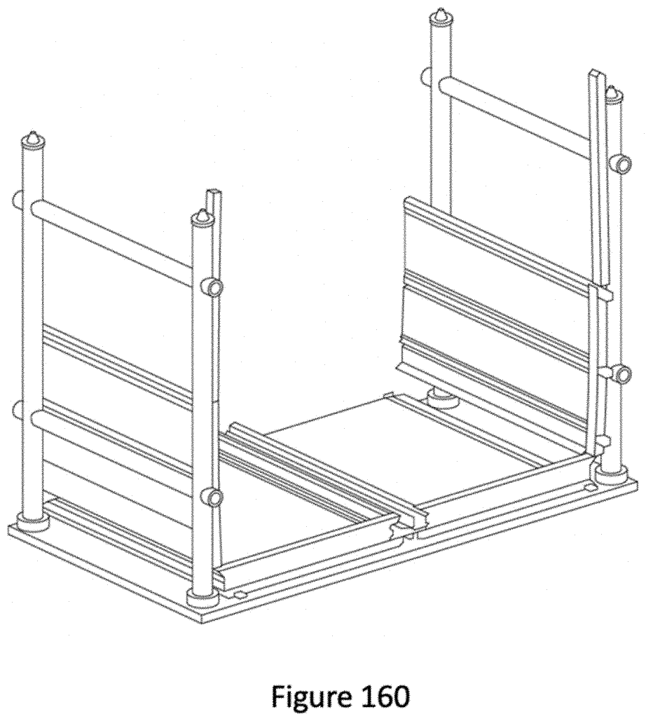

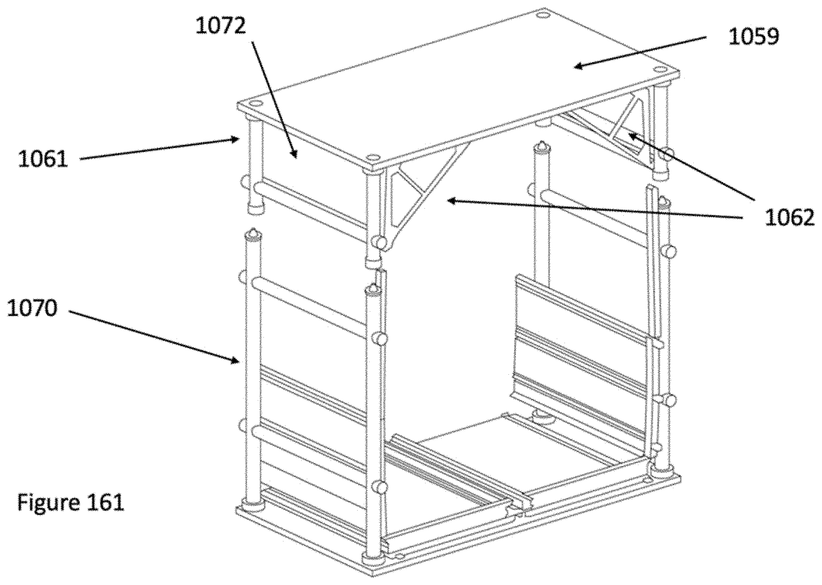

A roof section is then formed, again using extruded aluminium rods, as shown in FIG. 161. The roof section has a single, solid composite roof panel 1059; other sections of the bus have a pair of composite roof panels 1059 separated by a glazed central section. Angled reinforcing units 1062 are added to provide greater rigidity to the roof and transfer some of the roof loading to a roof support ladder frame 1061. Roof support ladder frame 1061 then mounts directly onto the side ladder frame 1070. Note also the rectangular void defined by the roof and the vertical frame and the first horizontal frame member; this is a standard sized display panel void 1072, common to all transverse sections (except the rear section). It is sized to receive a display panel and these display panels run along the length of the bus, appearing to form one long, contiguous display.

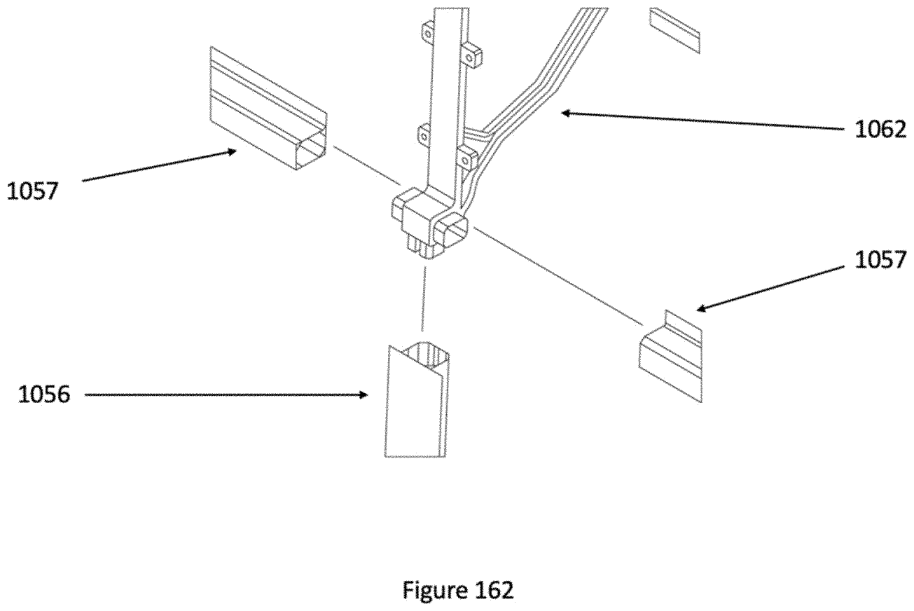

Note that the extruded aluminium sections 1056 and 1060, that sit internal to the roof support ladder frame 1061 and the side ladder frame 1070 attach as shown in FIG. 162. FIG. 162 show how the roof longitudinal structural members 1057 and the vertical beam or strut 1056 fits to the triangular roof corner structural aluminium casting 1062. Square cross section male/female friction fit interfaces that can be glue joined are shown.

The sections described above are typical middle sections of the bus. Note that each transverse chassis section includes structural members to which other parts in the bus can be added. For example, cantilever seats attach to the ladder frame 1070; doors attach to the ladder frame 1070; internal passenger poles can be secured to the roof transverse structural members 1058

The sections that include the wheel housings start off with a single large, extruded or cast aluminium sheet 1073, with two large ‘C’ shaped cut-outs at each end, to which a one piece front end, extruded structural aluminium wheel housing 1077 is bolted, as shown in FIG. 163. The transverse side 1074 of the single extruded or cast aluminium sheet, with two large ‘C’ shapes for the wheel arches will (not shown) be attached to the extruded aluminium transverse beams 1053 or the adjoining transverse chassis section.

FIG. 164 shows the single large, extruded or cast aluminium sheet 1073 is mounted on a structural aluminium base 1063, of the same size and dimensions as the structural aluminium bases 1063 that are used in the middle sections described above, to form the modular transverse chassis section (this time, configured for the wheel housings). The extruded aluminium rigid base includes at each corner a circular socket 1064 into which the rigid side ladder frame 1070 is attached.

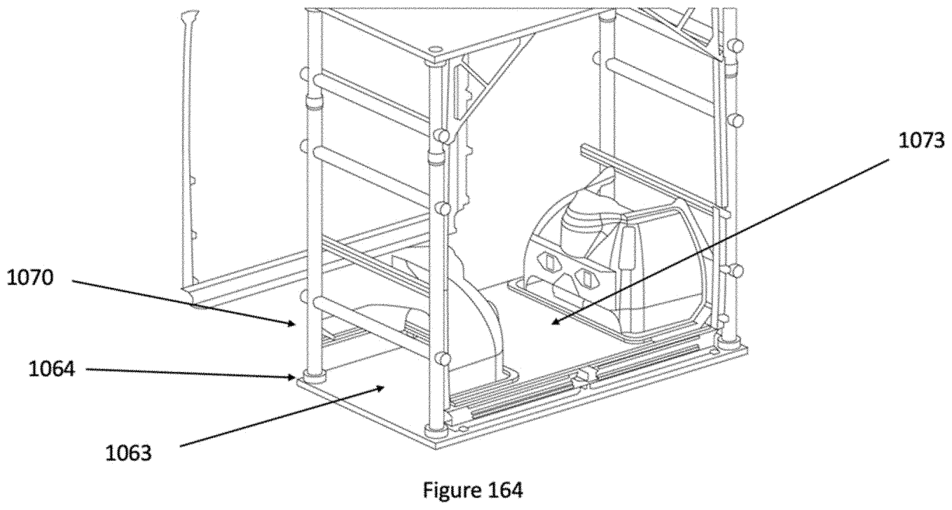

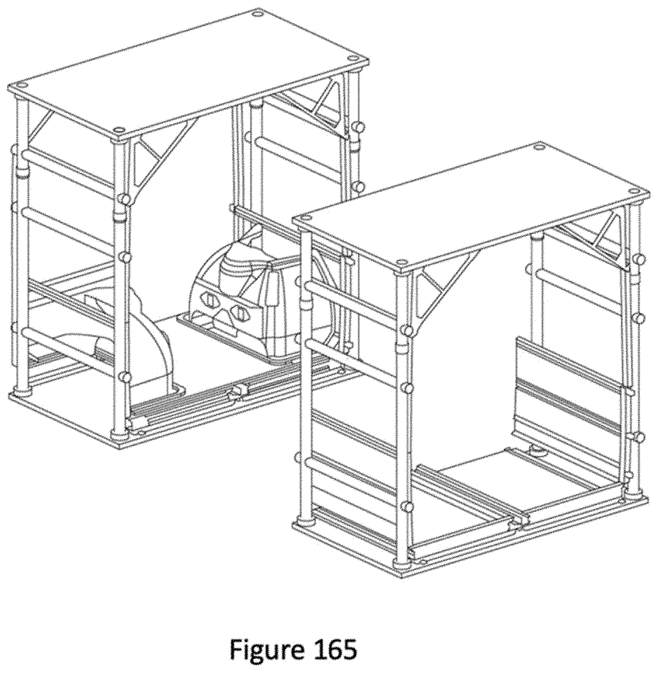

Two modular transverse sections (rigid base chassis and the side frame and roof frame and any sub-assemblies attached to the side and roof frame) are then brought together and joined, as shown in FIG. 165.

The process continues: the bus grows in length as further modular transverse sections are added. As with every step in the assembly process, this is designed to be efficient for robotic production, especially where the bus is not assembled as it moves along a production line, but instead is assembled in one location, with a number (e.g. 4 to 6) of robots positioned in and around that location; these robots form a cell of robots that work together to assemble the elements of the bus shown in this build sequence, growing it in length.

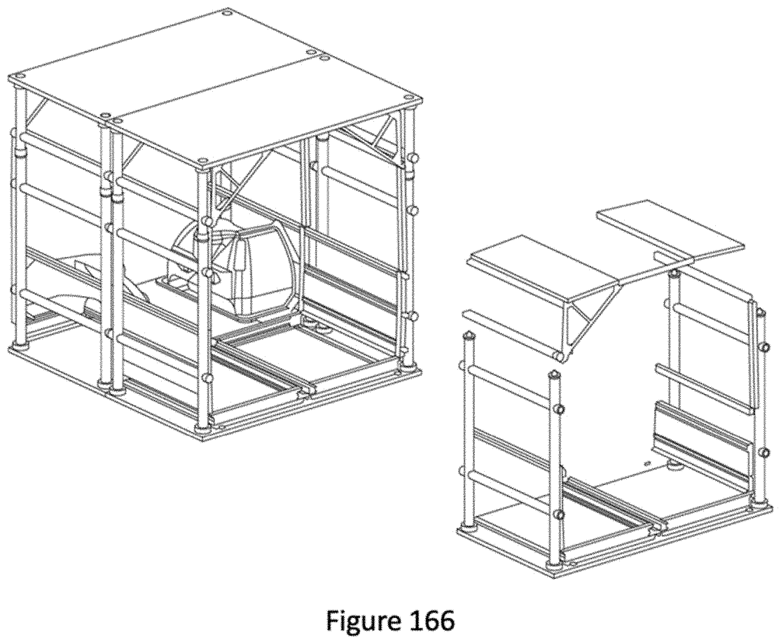

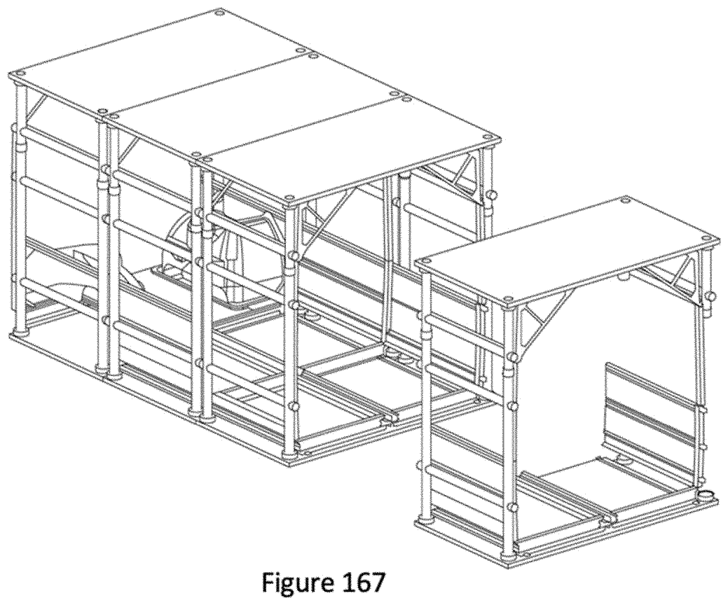

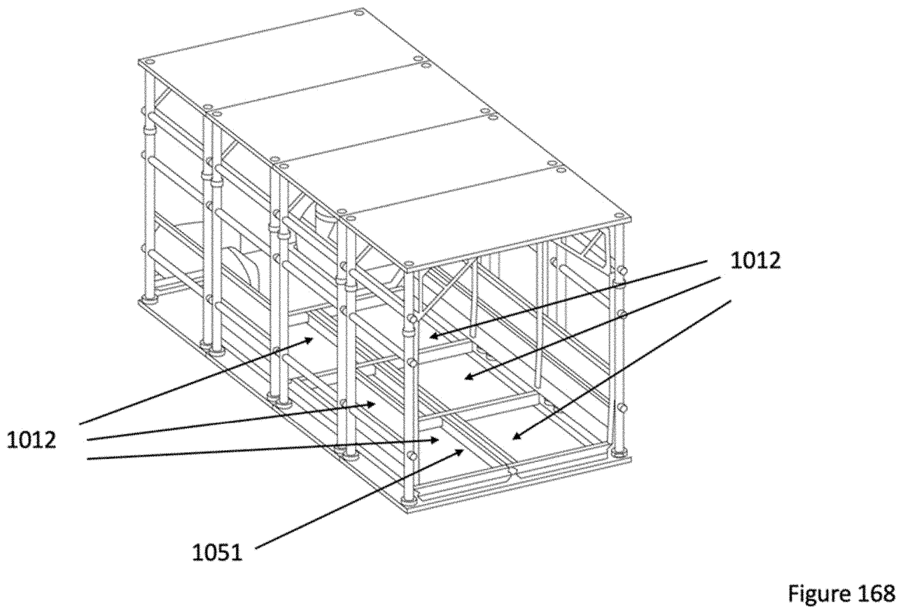

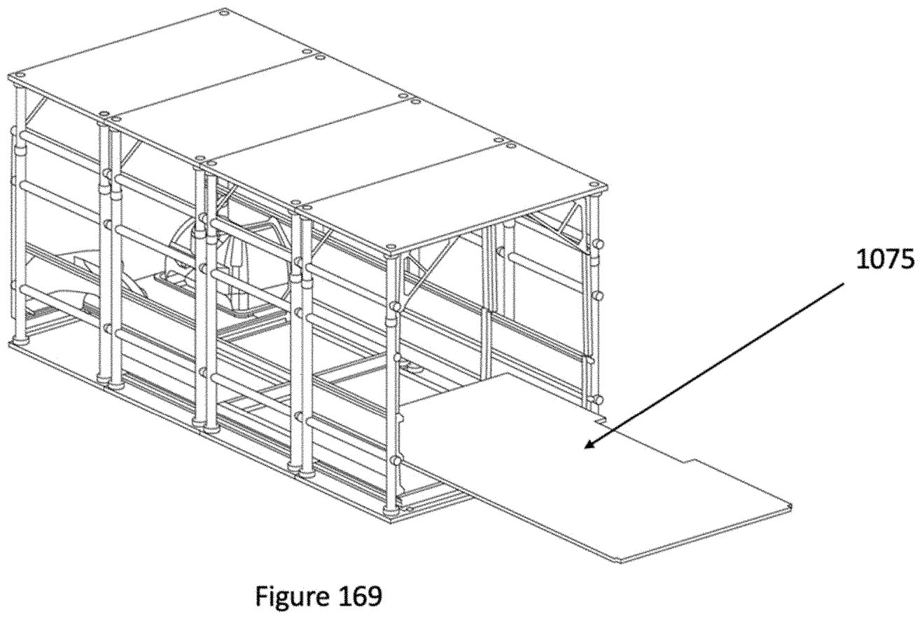

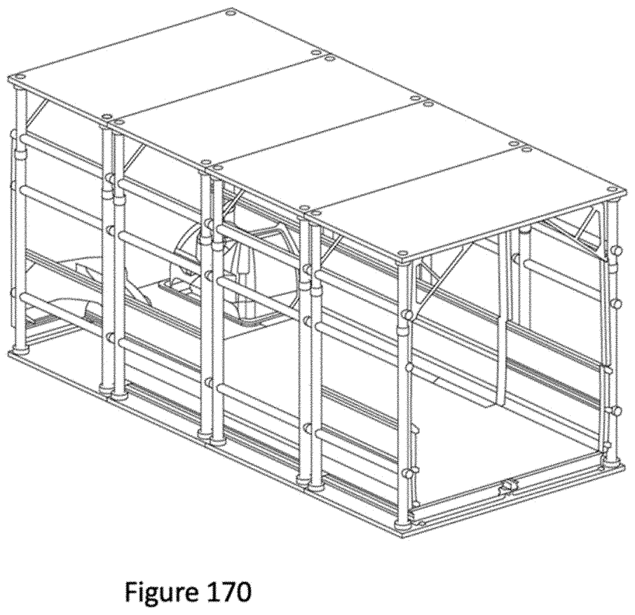

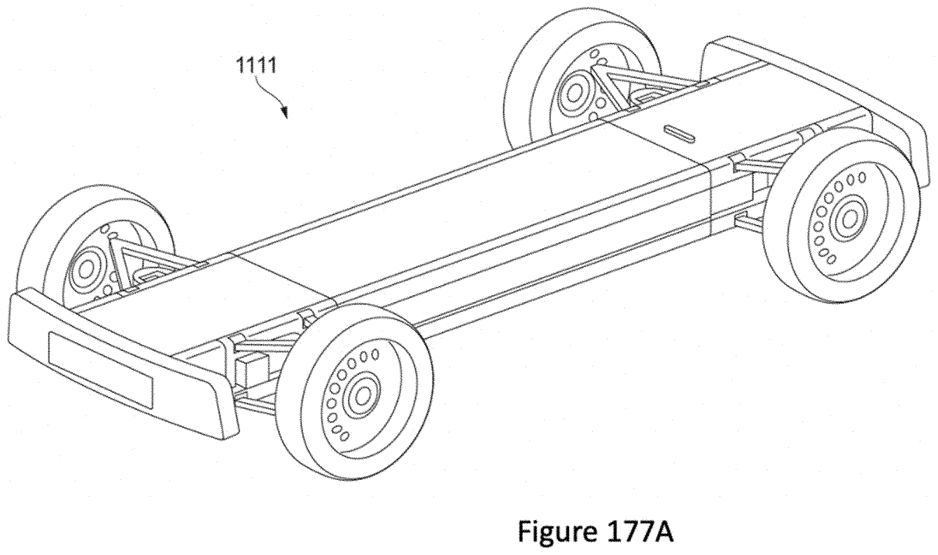

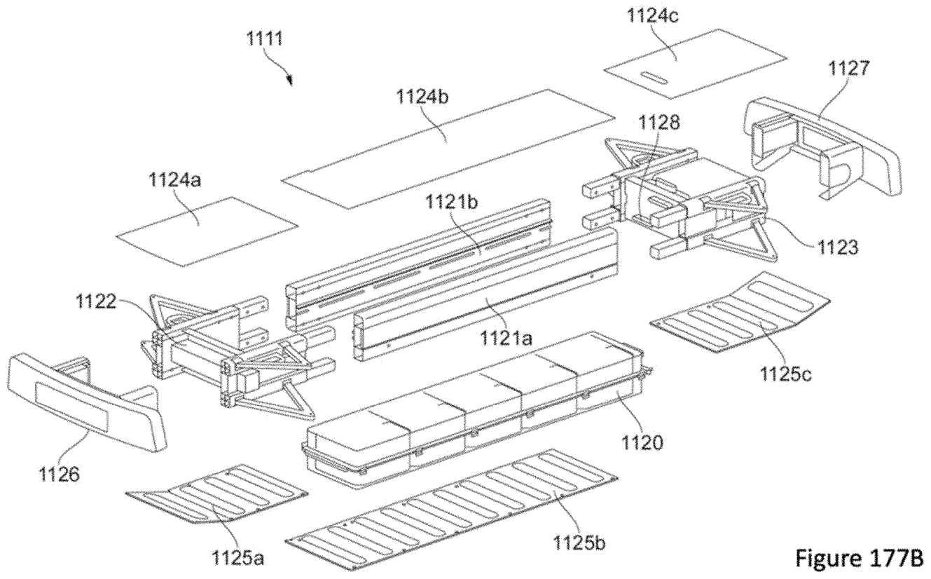

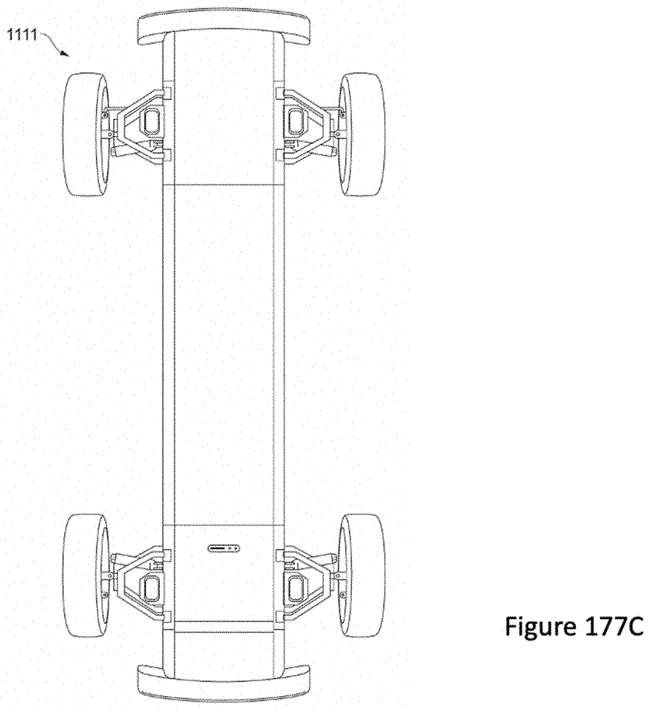

In FIG. 166 we show adding a modular transverse sections with a roof that has a slot for a glass panel. In FIG. 167 and FIG. 168, we show adding a fourth modular transverse section, where all four modular transverse sections have a single composite panel roof. Note that each transverse chassis section, other than sections that include the wheel arches, include left and right battery module bays 1012, on each side of the central extruded aluminium central beam 1051. A flat floor 1075 is then slid into the assembled group of sections to cover the battery module bays, as shown in FIG. 169. FIG. 170 shows the flat floor 1075 that covers battery module bays, fully slid into the three transverse sections. FIG. 177 shows the transverse section including the rear wheel arches 1002, 1027 being moved into position; these wheel arches differ in shape from the wheel arches at the front of the bus because they each include an integrated drive unit. But all wheel housings are identical in overall size to accommodate a single wheel and tyre and identical suspension components, and attach to the transverse chassis sections in the same manner. This theme of commonality in components and assembly is important in (i) enabling low cost, low volume but scalable production and also (ii) simplifying robotic handling and assembly.

Figure J72 and FIG. 173 shows sliding a pack of twelve battery modules 1078 into the chassis; the battery modules slide over the structural aluminium base 1063 and under the flat floor panel 1075. The pack includes (but not shown here) high voltage and data connections and these are connected to the high voltage bus bar running along the backbone (extruded aluminium central beam 1051) and the data connection points in the backbone from underneath the vehicle. Because the battery pack can be slid in and out of the side of the chassis, it is possible to swap out the battery pack when battery pack maintenance or replacement is needed. The Arrival Bus is designed for conventional fast DC charging at a charger; however, if battery swapping becomes established (i.e. battery swapping for when a freshly charged pack is needed), then the Arrival vehicle is well suited to this because of the way in which the battery pack slides in to the vehicle.

In FIG. 174, we show all 9 modular transverse chassis sections, with body module frames and side panels in place. The transverse chassis sections are: front of bus transverse chassis section 1080; driver and access door transverse chassis section 1081; front wheel arches transverse chassis section 1082; standard passenger transverse chassis section 1083; rear wheel arches transverse chassis section 1084; rear of bus transverse chassis section 1085. The middle three transverse chassis sections 1083 are shown joined together.

A shorter bus can readily be assembled using just two standard modular transverse chassis sections 1083 in the middle. A longer bus can be readily assembled using four standard modular transverse chassis sections 1083 in the middle. FIG. 175 shows these three variants in side view. The shortest bus has 6 main modular transverse chassis sections that are all of the same length (1.5 m), for maximum shared component use (to bring down price and increase quality); and maximum efficiency in robotic assembly (since production and assembly and joining processes will be largely common). So transverse chassis sections that include the wheel housings are the same length as the other main transverse chassis sections. Battery modules will be slotted into the middle two modular transverse chassis sections to ensure a. 50:50 unladen weight distribution. There is also a short front section and a short rear section.

The middle bus has 7 main modular transverse chassis sections that are all of the same length (1.5 m); adapting a bus assembly process from the shortest bus to this bus is very simple since it requires the addition of an extra modular transverse chassis sections and related frame/body/roof; the bus is simply grown longitudinally at build time in a specific robotic production cell. Battery modules will be slotted into the middle three modular transverse chassis sections to ensure a. 50:50 unladen weight distribution. There is also a short front section and a short rear section.

The final bus has one additional main (1.5 m) transverse chassis section: an additional wheel housing section; this enables the final (1.5 m) modular transverse chassis section to include a set of battery modules for even greater range and greater passenger capacity.

Note also that the build sequence described above is not the only possible build sequence; the modularity and simplicity of the Arrival system enables different build sequences. For example, it would be possible to construct the entire chassis or platform first, i.e. by joining together all of the modular transvers chassis sections to form a complete skateboard platform. Then, complete pre-assembled body modules (e.g. frames and panels that need to be in position as the frames are secured to the chassis) would be added to the chassis. That might be optimal where (i) some cells are optimised to solely join modular chassis sections together and to join fully pre-assembled body modules to the chassis and (ii) other cells (possibly adjacent) are optimised to assemble those body modules.

Variants are possible: the build sequence described above envisages a transverse section being completed and then joined to an existing section, growing the vehicle longitudinally, one transverse section at a time. It would also be possible to build two or more transvers sections and join them together; and then this group of pre-joined transvers sections can be joined to the rest of the vehicle (which could have been constructed by growing the vehicle longitudinally one transverse section at a time, or by growing the vehicle longitudinally by groups of two or more pre-joined transverse sections at a time.

Further, some transverse sections for a vehicle could be built up as described in the main build sequence described above, whereas other transvers sections could be assembled by adding a fully or partly pre-assembled body module on to a transverse chassis section, and then all transverse chassis sections are brought together to form the main shell of the vehicle. The Arrival system is inherently flexible.

Note that the vehicles described above can utilise any and all the Features and related optional sub-features described in this specification. For example, the Arrival Bus can incorporate or otherwise use the hardware modularity and Robofacturing Features described in Section A above; can incorporate, or otherwise use the Unified Software Architecture, Plug and Play and decentralised autonomy Features described in Section B; can incorporate or otherwise use the security features described in Section C; can incorporate or otherwise use the ATP and Vehicle Builder-related Features described in Section D; can be built using the Robofactoring robotic production environment described in Section E and be built in the microfactories described in Section F; can incorporate or otherwise use the HVBMs and Flex connected Features described in Section G; can incorporate or otherwise use the composite parts and panels described in Section H. The Arrival Bus described in this Section J can also incorporate or otherwise use or be characterised by any of the Features and related optional sub-features for the Arrival Van described in Section I and the Arrival Car platform described in Section K. An interpretation point: Sections A-K describe a broad range of features and optional features; when we say, anywhere in this specification, that a vehicle or system uses or implements features and optional features described in any Section A-K, or that a Section A-K is relevant to an implementation, that should be interpreted as meaning that at least one or more or optional features are used or implemented; it should not be interpreted to mean that all features and optional features are necessarily used. So, for example, when we say that ‘Arrival vehicles implement hardware and software modularity concepts (see Section A and Section B)’, then that should be interpreted as meaning that at least one concept from Section A and Section B is implemented, but not necessarily more, nor all.

Section K: The Arrival Car System

Introduction to this Section K

The automotive sector invests heavily in the design and production of vehicles, with profitability achieved by mass production of a large volume of vehicles. Economies of scale are relied on to produce vehicles in high volume that make use of shared components assembled in large factories that apply shared production processes. The production of a large number of vehicles of the same design restricts the variety of the available vehicles.

Costs are mitigated by making use of components that share their design with a number of different vehicles. Such vehicles are typically formed of a vehicle platform which supports a vehicle body or ‘top hat’, with the vehicle designer investing their efforts in creating a top hat. The top hat provides upper body vehicle structures that differentiate vehicle products. In the automotive sector, it is routing for top hats to be designed that each are supported by shared vehicle platforms, often with the same vehicle platform being shared by a number of different vehicle manufacturers.

There is a demand for a vehicle platform that enhances the degree of freedom of top hat design. This allows a class of vehicles to be created that are formed from a bespoke platform and a bespoke top hat. Thus, the variety of vehicles that are available within the class is enhanced, while continuing to mitigate design and production costs.

The Arrival Car System implements the hardware and software modularity concepts described earlier in Section A and Section B. It is designed to include the security architecture described in Section C, and configured using the Vehicle Builder system of Section D. The Arrival Car can be brought from design to production in 12 months, as opposed to 3-5 years, with no price premium for being zero emission, and are produced using small cells of robots, with each cell producing both sub-assemblies and the entire vehicle (see Section E for more on Robofacturing) in relatively small and low capital expenditure (CapEx) microfactories (see Section F) that are not based on conventional long moving production lines. The Arrival Car is configured to use modular high voltage battery modules (see Section G), a scalable system which enables battery packs to be made for the entire range of Arrival vehicles. Microfactories do not need huge steel panel presses because Arrival vehicles use body panels that are not made of pressed steel, but instead lightweight composites; composite panels can be made for the entire range of Arrival vehicles (see Section H). The Arrival Car System implements the principles of the Arrival Van System (see Section I) and the Arrival Bus System (see Section J).

The Arrival® System

The Arrival system has been used to design and produce a number of different vehicles, including the Arrival Car, which allows a bespoke vehicle to be created according to customised specifications.

Shared features of the vehicle design include a fixed front crash structure and a fixed rear crash structure. Similarly, skateboards of different vehicle variants share the same thermal architecture, front suspension, rear suspension, and drive unit. Some features of the platform are customised to the specific vehicle variant, including the battery pack, the fore/aft structure, and the side impact protection.

The vehicle platform consists of frame that is designed for maximum modularity and maximum platform flexibility. Specifications of the vehicle are selected, and then the vehicle platform is designed and produced to have the customised dimensions and installed with integral components.

The platform and its integral components are designed in accordance with regulatory specifications. The platform and each component are authorised for a variety of uses, which simplifies the process for demonstrating that each bespoke vehicle is in compliance with regulatory standards.

Below, we introduce a number of key features that facilitate the creation of bespoke vehicles as part of the Arrival System:

Key Features

This Section K describes a number of key features adopted by the Arrival Car System. The principles described relating to the Arrival Car are embraced by other vehicles in the Arrival range, including the Arrival Van System (see Section I) and the Arrival Bus System (see Section J).

Feature 1: Vehicle with Different Body Types and Customised Attributes

A vehicle selected from a vehicle system, in which the vehicle system includes vehicles with multiple different vehicle body types, each vehicle including a skateboard type platform with one or more attributes;
and in which different vehicle body types are all configured to attach to the same skateboard type platform.

Feature 2: Vehicle with Customised Length and Body Type

A vehicle selected from a vehicle system, in which the vehicle system includes vehicles with multiple different vehicle body types, each vehicle including a skateboard type platform with a configurable length;
and in which different vehicle body types are all configured to attach to the same skateboard type platform.

Feature 3: Different Vehicles have Different Lengths of Central Extrusion

A vehicle including a pair of longitudinal chassis beams or extrusions that are each joined to a front cradle and to a rear cradle, each cradle supporting at least one suspension wishbone;
and in which the overall length of the vehicle has been selected from a range of different possible lengths and the vehicle has been configured to that overall length by including a pair of longitudinal chassis beams or extrusions of the appropriate length.

Feature 4: Different Vehicles can have Different Battery Capacities

A vehicle including a skateboard type platform; in which the skateboard type platform includes an array of battery modules and, when the vehicle was being designed, then the battery capacity or required range of the vehicle was specified by a customer and then an appropriate number of battery modules was automatically assigned for use in the skateboard type platform of that vehicle by an automated vehicle design tool.

Feature 5: Double-Deck Battery Pack

A vehicle including a skateboard type platform; in which the skateboard type platform includes a double layer of battery modules.

Feature 6: Central Chassis Extrusion Supports Battery Modules

A vehicle including a skateboard type platform;
in which the skateboard type platform includes two longitudinal extruded beams and an array of battery modules positioned between these beams.

Feature 7: Central Chassis Extrusion Includes Torsion Bar

A vehicle including a skateboard type platform including two longitudinal beams; and in which a torsion bar passes through each beam.

Feature 8: Single Power and Data Connection Port Between Skateboard and Body

A vehicle including a skateboard type platform and in which different components or parts of the vehicle are attachable to the skateboard type platform;
and in which the skateboard type platform includes a universal data and power connection port that the different components of the vehicle are each configured to connect to.

Feature 9: Vehicle Assembly

A vehicle including:
a skateboard type platform with one or more attributes; and
a plurality of components which are designed for an installation path to a final position corresponding to the one or more attribute, in which the installation path is optimised for robotic handling, installation or assembly, such as autonomous robotic handling, installation or assembly.

### BRIEF SUMMARY OF THE FIGURES RELATING TO THIS SECTION K

Details of the Arrival System will be described, by way of example only, with reference to the accompanying drawings, in which:

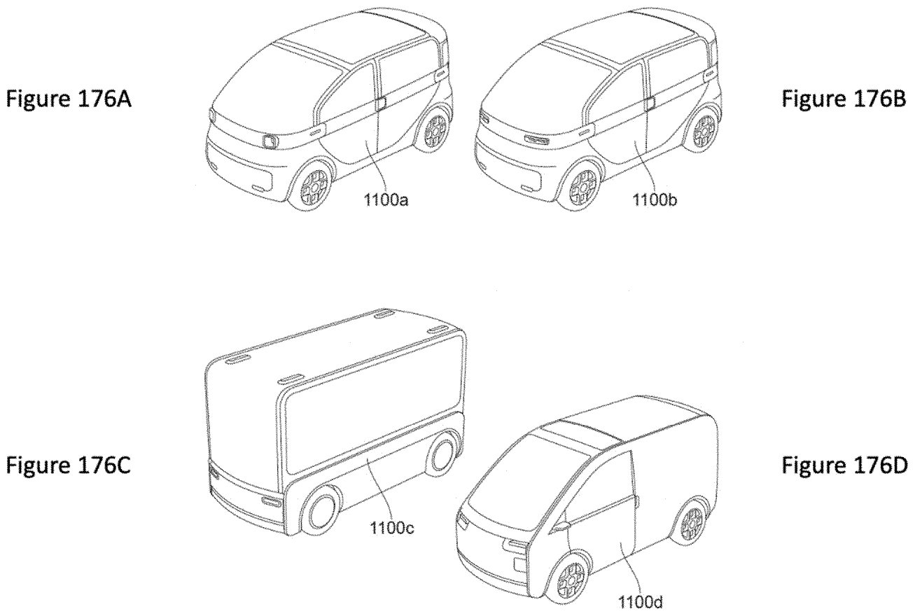

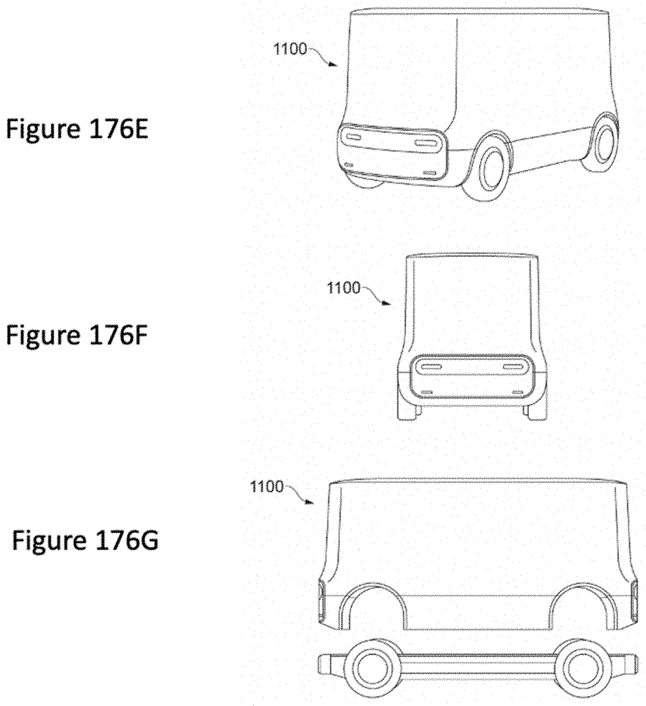

FIGS. 176A-176G provide images of vehicles designed in accordance with the Arrival System, with FIGS. 176A-176D showing perspective views of a number of variants; and FIGS. 176E-176G showing views of a schematic;

FIGS. 177A-177D provide views of a skateboard platform, with FIG. 177A showing a perspective view; FIG. 177B showing an exploded view; FIG. 177C showing a top view; and FIG. 177D showing a front view;

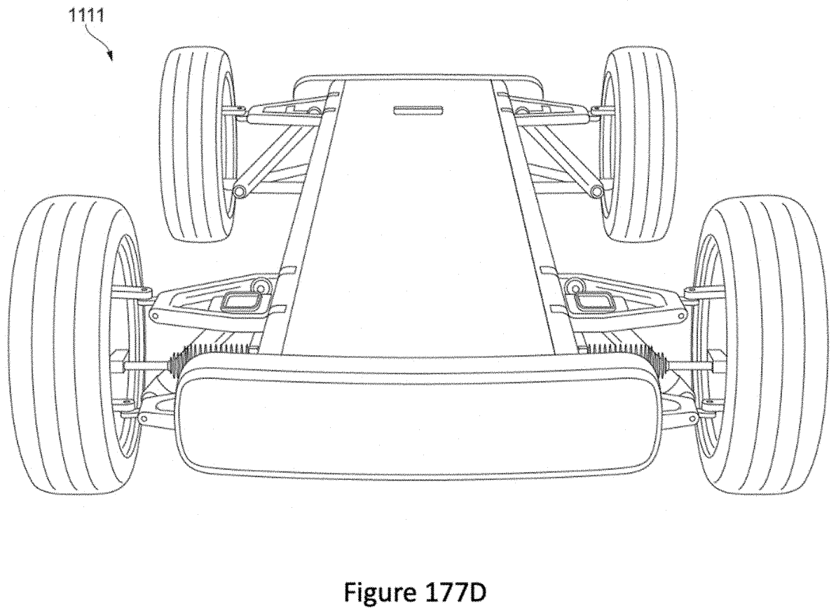

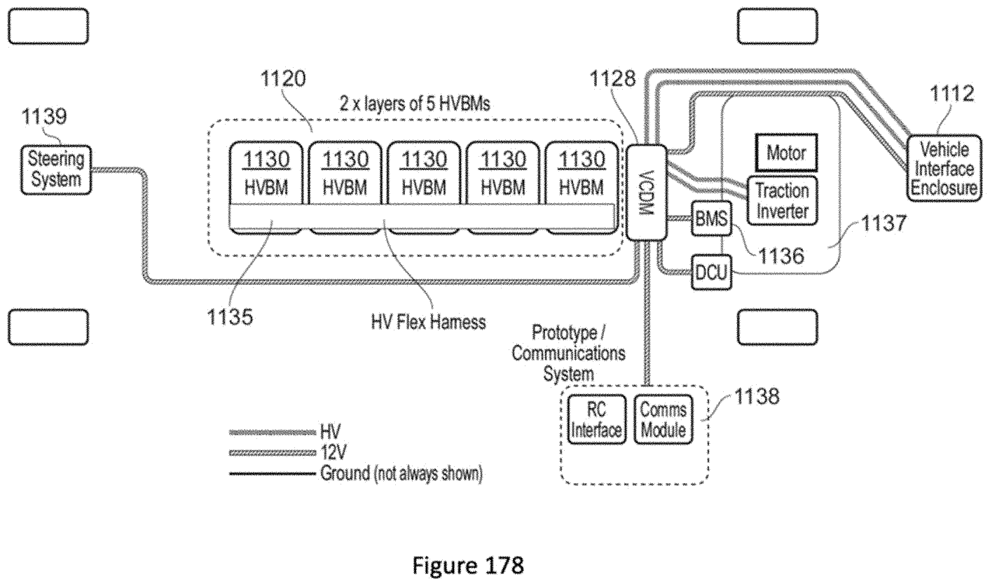

FIG. 178 provides a schematic of the electronics architecture of the skateboard platform;

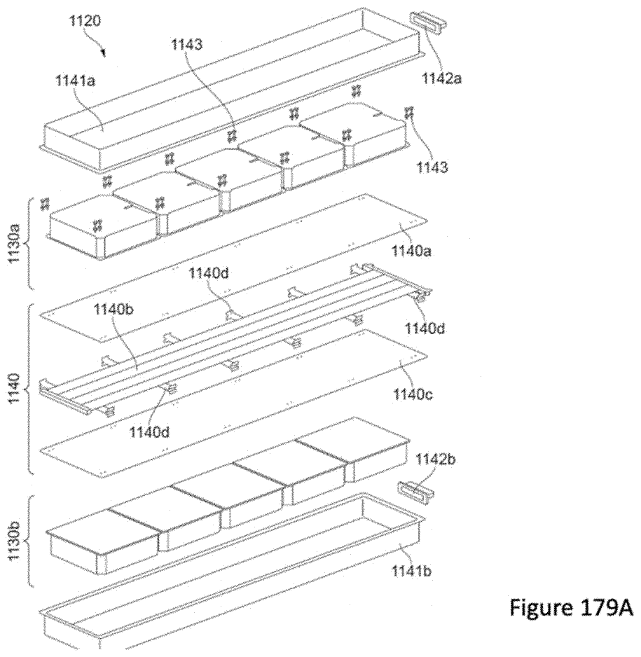

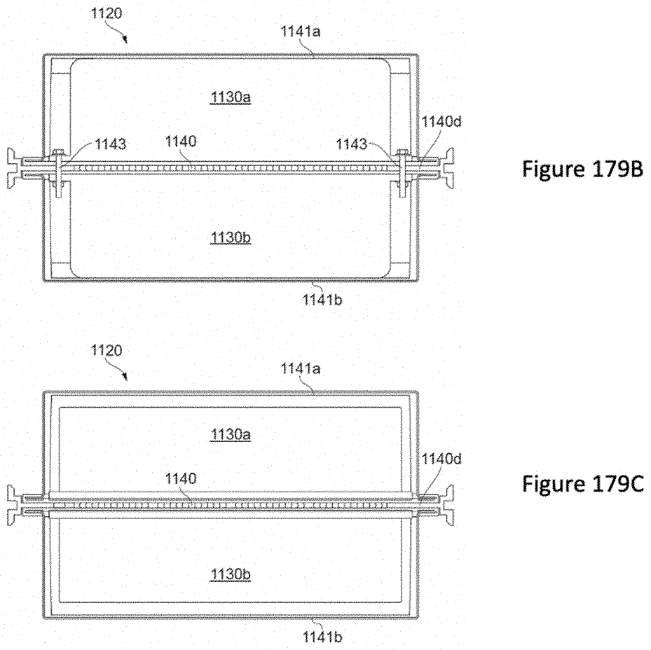

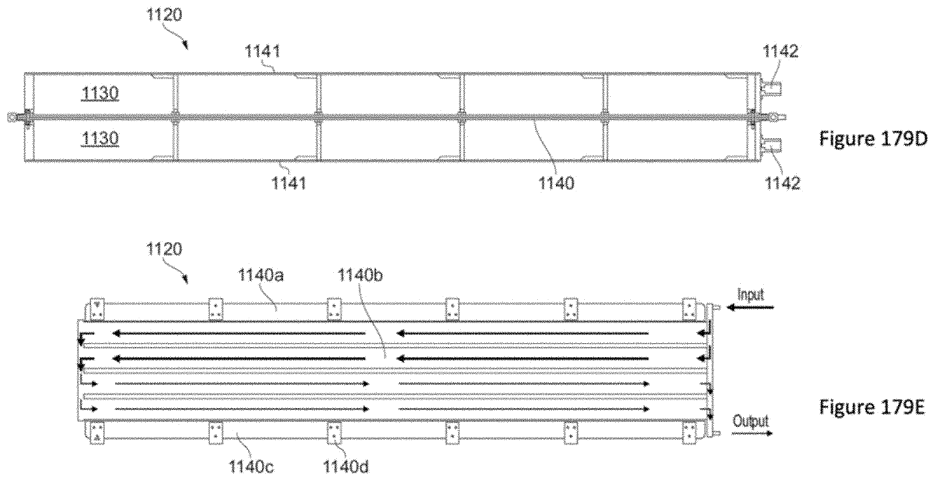

FIGS. 179A-179E provides views demonstrating a battery pack of a skateboard platform, with FIG. 179A showing an exploded view of the battery pack which includes a number of battery modules and a cooling circuit; FIG. 179B showing a cross-section view intersecting between the battery modules of the battery pack; FIG. 179C showing a cross-section view intersecting through the battery modules of the battery pack; FIG. 179D showing a cross-section view from the side, along the length of the battery pack; and FIG. 179E showing a cross-section view from above to provide details of the cooling circuit of the battery pack;

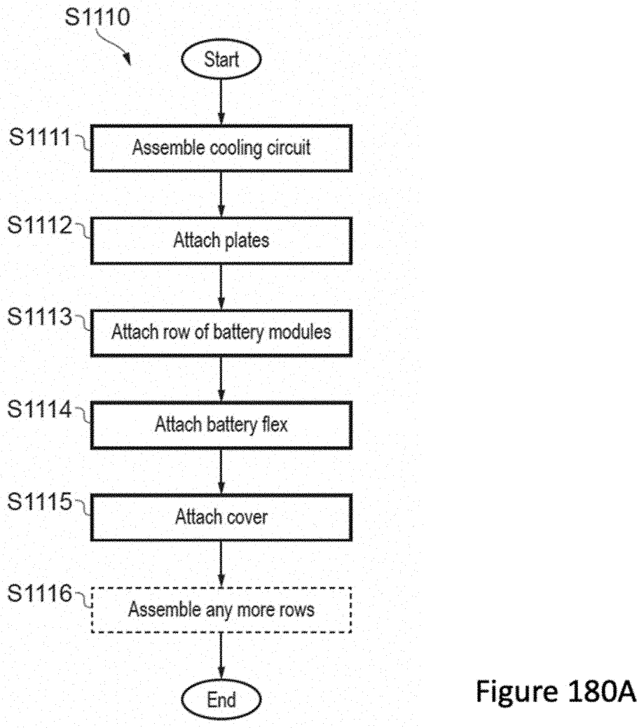

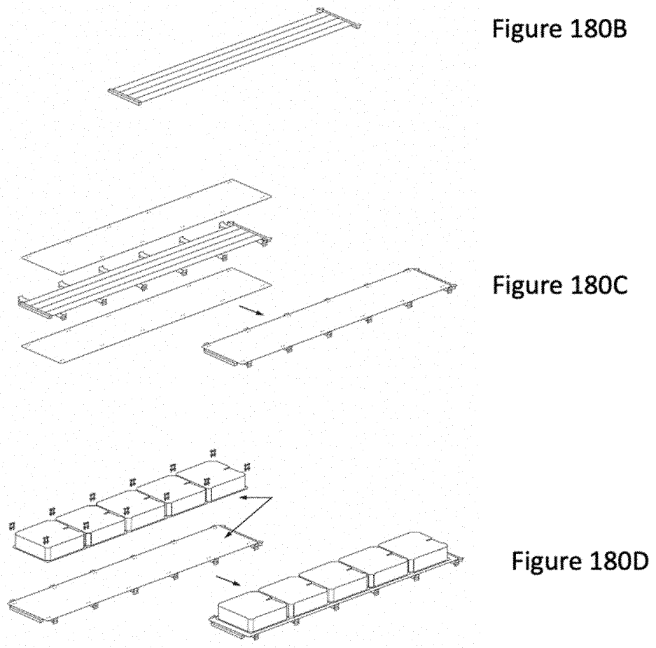

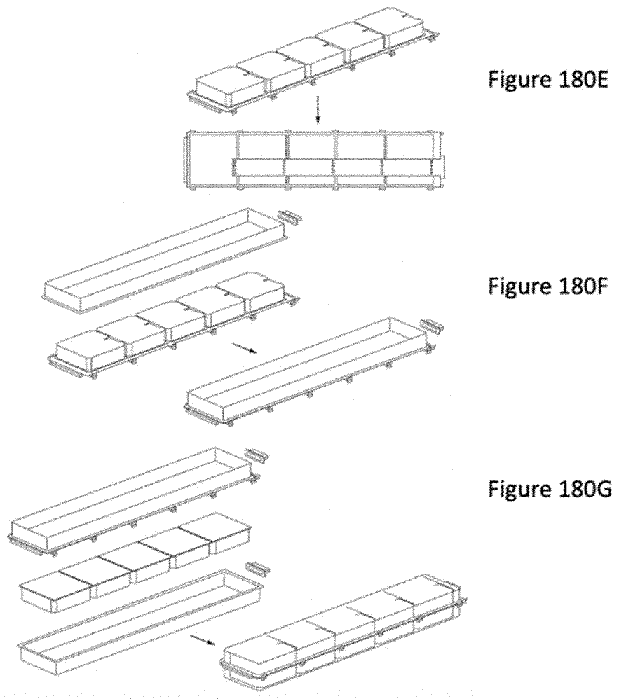

FIGS. 180A-180G provides details of a production process of a battery pack, with FIG. 180A showing a flow chart that details method steps of the production process; FIG. 180B showing a first step of assembling the cooling circuit; FIG. 180C showing a second step of assembling the cooling assembly which includes the cooling circuit; FIG. 180D showing a third step of assembling a first row of battery modules as part of the battery pack; FIG. 180E showing a fourth step of assembling a flexible printed circuit board to provide an electronic connection to the battery modules; FIG. 180F showing a fifth step of assembling a battery cover of the battery pack; and FIG. 180G showing a sixth step of assembling a second row of battery modules as part of the battery pack;

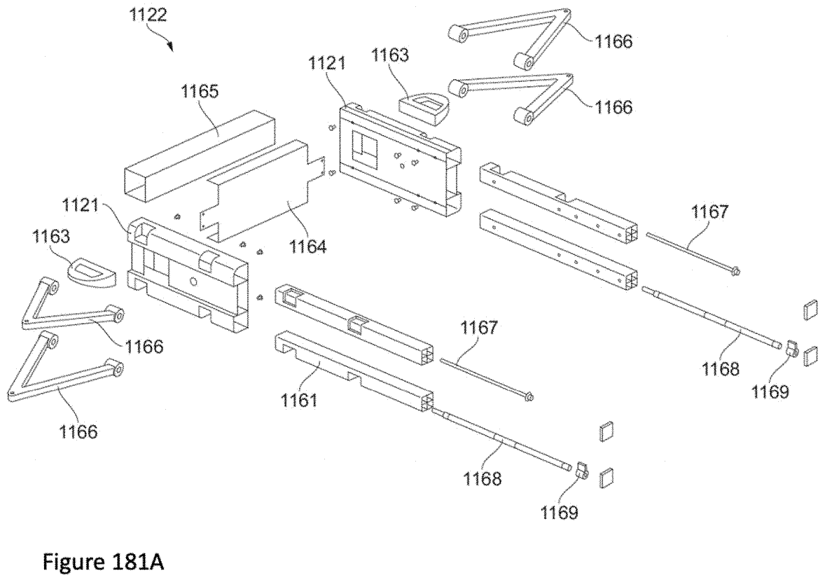

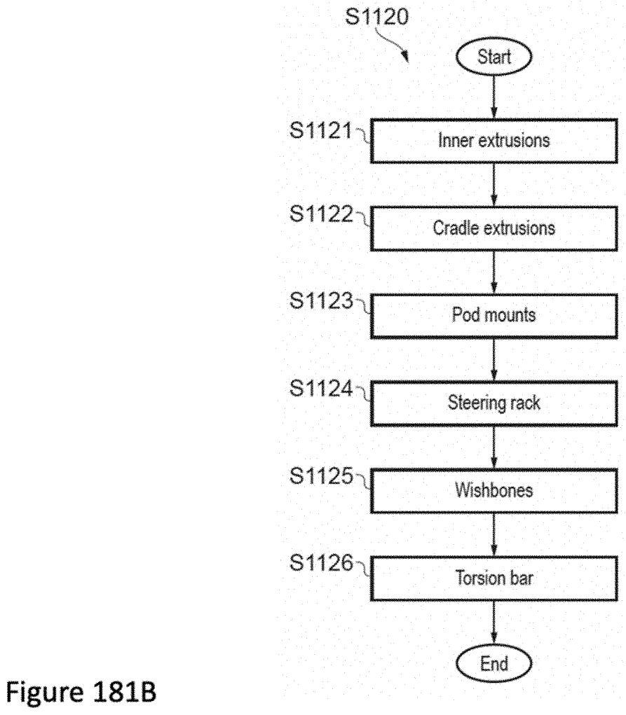

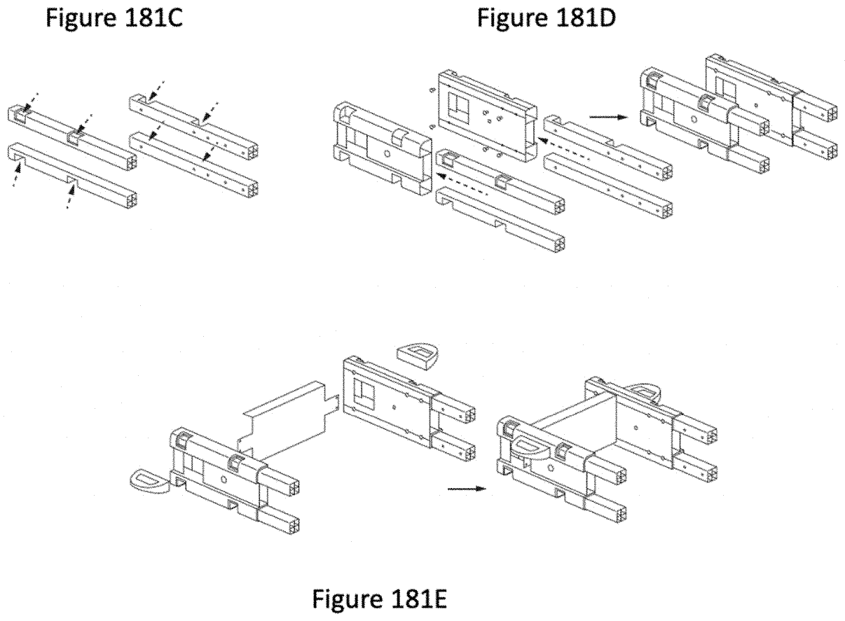

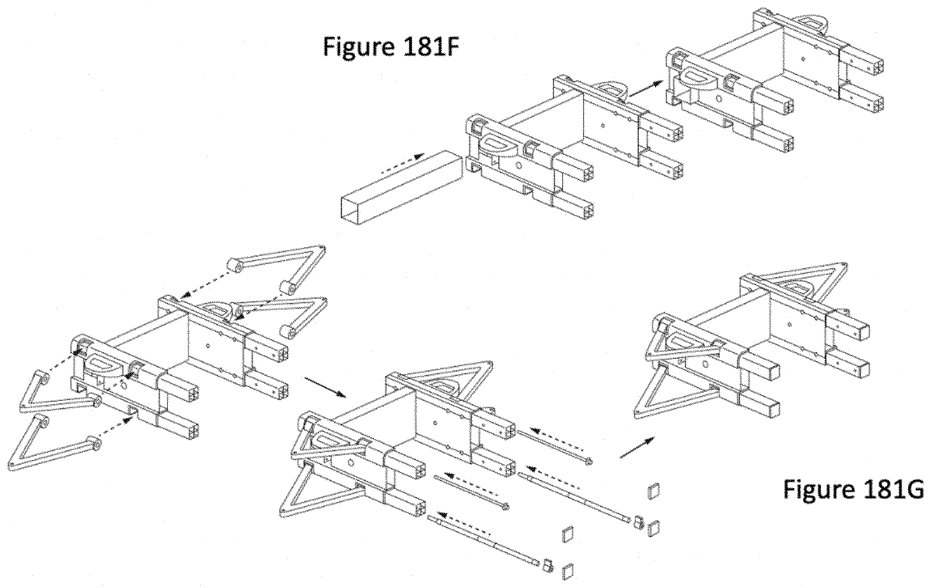

FIGS. 181A-181G provides details of a production process of a cradle of the skateboard platform, with FIG. 181A showing an exploded view of the cradle; FIG. 181B showing a flow chart that details method steps of the production process; FIG. 181C showing a first step of assembling inner extrusions; FIG. 181D showing a second step of assembling cradle extrusions that include the inner extrusions; FIG. 181E showing a third step of assembling the cradle extrusions with a cross plate and pod mounts; FIG. 181F showing a fourth step of assembling a cross plate as part of the cradle; and FIG. 181G showing a fifth step of assembling the cradle to include wishbones, together with a sixth step of assembling the cradle to include torsion bars;

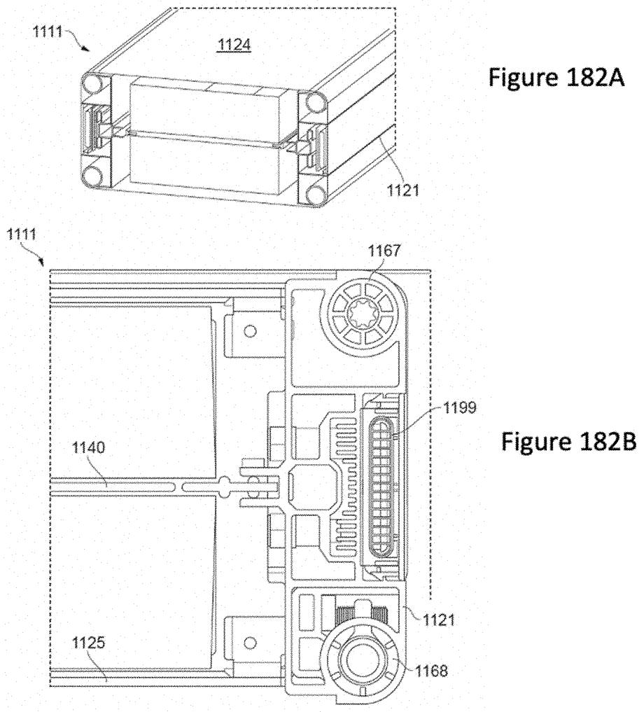

FIGS. 182A-182B provide views of a centre module of the skateboard platform; with FIG. 182A showing a perspective view with part cut away to reveal the internal components including the battery pack; and FIG. 182B showing a cross section revealing further details of these internal components;

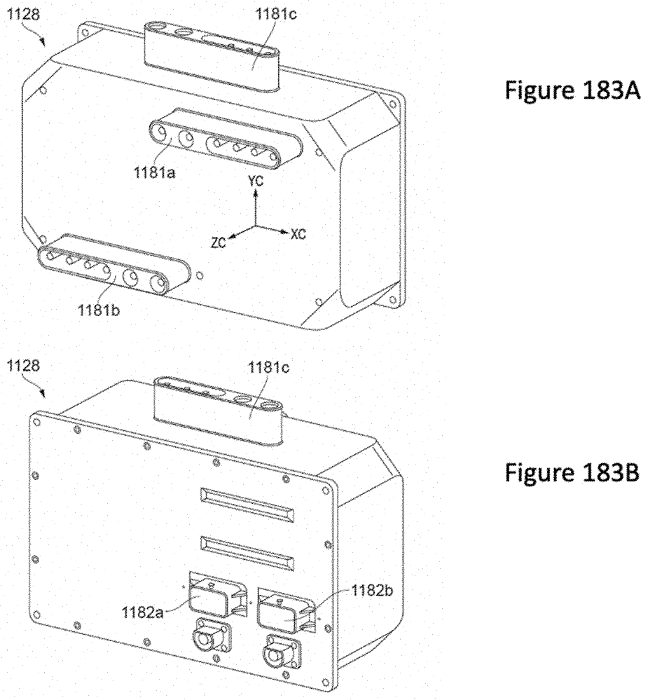

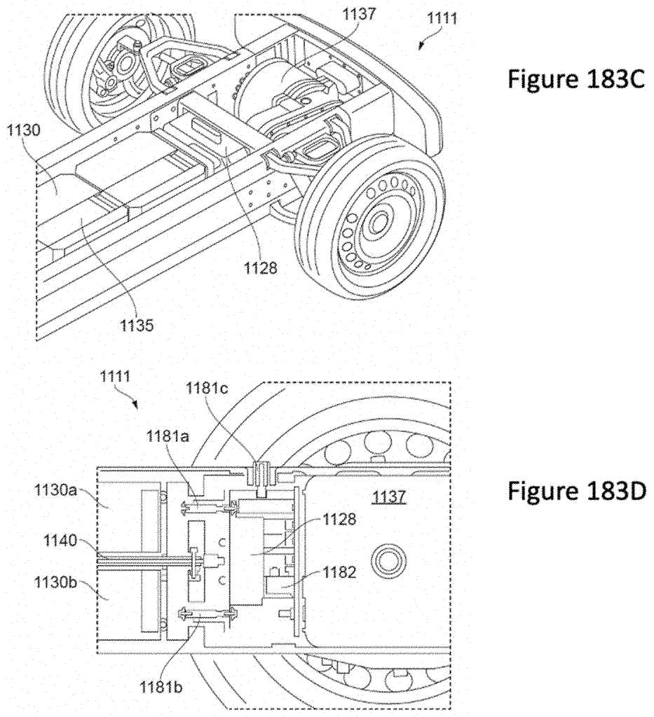

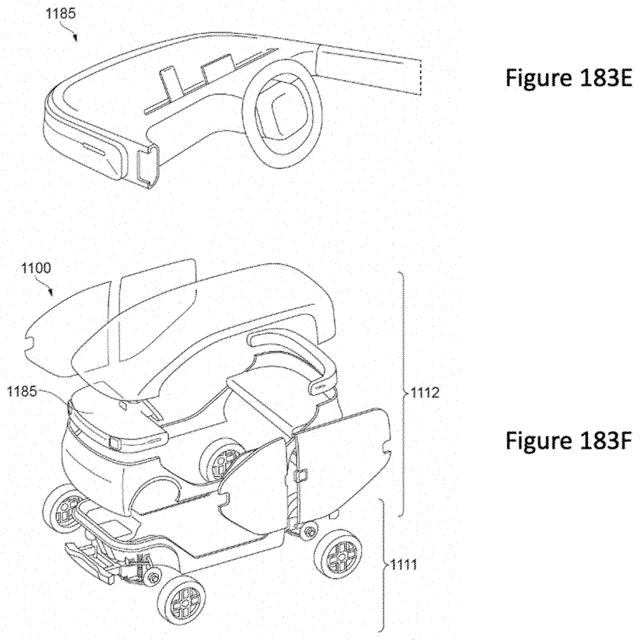

FIGS. 183A-183F provides details of the electronics architecture of the vehicle, with FIG. 183A showing a front perspective view of a super junction box of the skateboard platform; FIG. 183B showing a rear perspective view of the super junction box; FIG. 183C showing a perspective view of the skateboard platform installed with the super junction box; FIG. 183D showing a cross section from the side of the skateboard platform that is installed with the super junction box; FIG. 183E showing a perspective view of a cassette which is installed into a top hat of the vehicle; and FIG. 183F showing an exploded view of a vehicle including the cassette; and

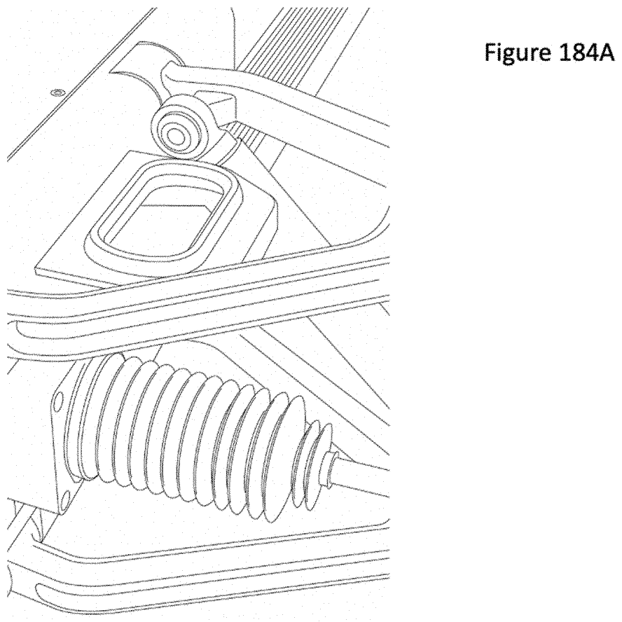

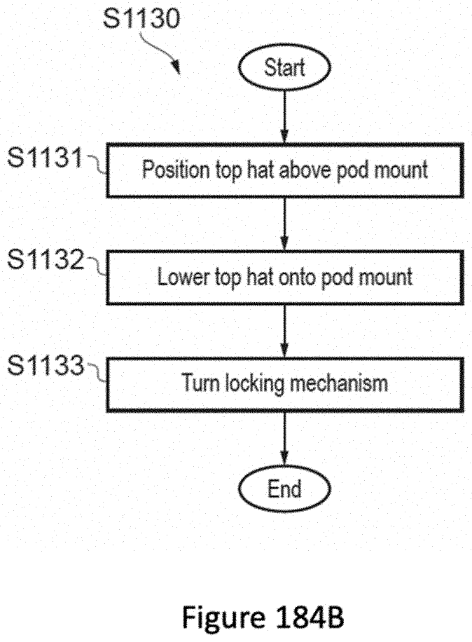

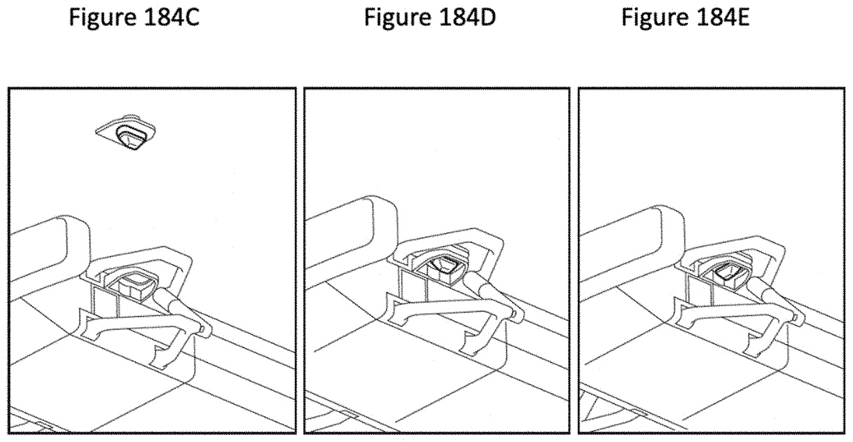

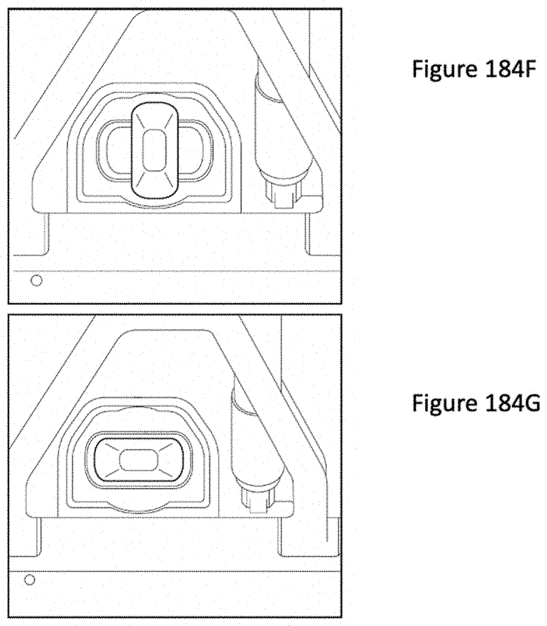

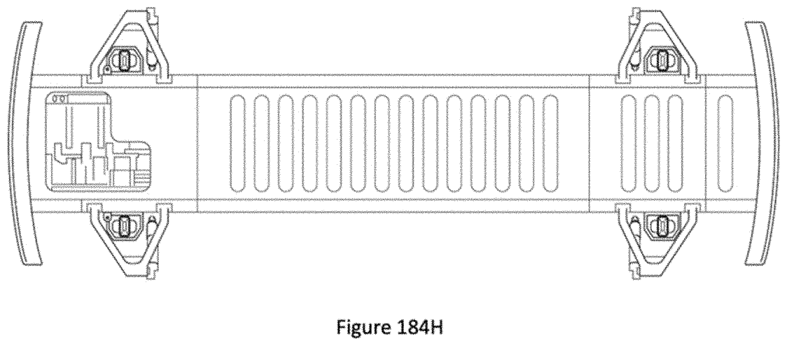

FIGS. 184A-184H provides details of a production process for mounting the top hat to the skateboard platform, with FIG. 184A provides a perspective view of the cradle including the wishbones and pod mount; FIG. 184B showing a flow chart that details method steps of the production process; FIG. 184C illustrating a first step of positioning the top hat above the pod mount; FIG. 184D illustrating a second step of lowering the top hat onto the pod mount; FIG. 184E illustrating a third step of locking the top hat into place; FIG. 184F showing a locking mechanism in an unlocked position; FIG. 184G showing a locking mechanism in an locked position; and FIG. 184H provides a view from below of the skateboard platform with the locking mechanism in the locked position.

### FIGS. 176-184 Index

| Reference | |
|---|---|
| Numeral | Description of item |
| 1100 | Vehicle |
| 1111 | Skateboard |
| 1112 | Top hat |
| 1120 | Battery Pack |
| 1121 | Centre Extrusions |
| 1122 | Front Cradle |
| 1123 | Rear Cradle |
| 1124 | Top Cover |
| 1125 | Bottom Cover |
| 1126 | Front bumper |
| 1127 | Rear bumper |
| 1128 | Super Junction Box (SJB) |
| 1130 | HVBMs |
| 1135 | Flex PCB |
| 1136 | BMS |
| 1137 | Motor |
| 1138 | Communication Module |
| 1139 | Steering System |
| 1140 | Cooling Assembly |
| 1140b | Cooling circuit |
| 1140a/c | Cooling plates |
| 1140d | T connectors |
| 1141 | Battery Pack Covers |
| 1142 | Battery Pack Electronic connector |
| 1143 | Battery module fasteners. |
| 1161 | Inner extrusions |
| 1163 | Pod mounts |
| 1164 | Cross plate |
| 1165 | Steering rack |
| 1166 | Wishbones |
| 1167 | Pivot pins |
| 1168 | Torsion bars |
| 1169 | Adjustment flag |
| 1181 | Universal Connector |
| 1182 | SJB connection ports |
| 1185 | Cassette |
| S1110 | Method of assembling the battery pack |
| S1120 | Method of assembly the cradle |
| S1130 | Method of joining the top hat and platform |

### DETAILED DESCRIPTION RELATING TO THIS SECTION K

Innovation is found in Arrival's design of vehicle platforms and vehicle top hats. The versatility of vehicle platform design facilitates an enhanced versatility of top hat design. A wealth of opportunities have been identified for the creation of vehicles that offer bespoke functionality. A broad variety of vehicle sub-classes are available, with individual customers being empowered to tailor vehicles that accommodate unique expectations. A key market for the Arrival Car System is to commercial vehicles that are customised to the ride hailing sector. It is possible to create bespoke vehicles on a single-vehicle scale, which allows vehicles to be offered to individuals who require a vehicle for a niche purpose. A vehicle is designed for ride-hailing drivers that serves both as their workplace, and also as their family car. Customers include the operators of fleets, with the Arrival Car System being scalable to any number of vehicles having a specific design, while facilitating variations to ensure that each vehicle within the fleet performs optimally.

FIGS. 176A-176G provide illustrations of a vehicle 1100 designed in accordance with the Arrival System. The vehicle 1100 is formed from a skateboard platform 1111 and a top hat 1112. The vehicle platform is sometimes referred to as “P1”, because it corresponds to a platform having a weight that is typically on the order of 1 tonne, although the principles described are not limiting to a P1 type of platform. The platform 1111 includes a chassis and wheels. The top hat 11112 includes a vehicle frame and the vehicle interior, with the customisation of both of these being facilitated by the creation of a bespoke platform 1111. The skateboard platform 1111 and P1 top hat 11112 are produced separately, and subsequently assembled.

The term “Car” refers to an assembled vehicle that comprises both the platform and a top hat, although this term is non-limiting, with the platforms 1111 described according to these principles being suitable for making a variety of vehicles (e.g., passenger vehicles, cargo pods, and vans, with this technology being suitable for autonomous vehicles). The Arrival Car is designed and produced to include a vehicle platform that is based on the principles described herein. The Arrival Van includes the P4 platform which is designed and produced using similar principles as for the P1 platform.

We will look now at each of the above Key features in more detail:

Feature 1: Vehicle with Different Body Types and Customised Attributes

A variety of vehicles within a vehicle class can be configured by customising specifications of the platform and the top hat. As a consequence, vehicle design is streamlined because vehicles of the same class share components and assembly processes. Accordingly, bespoke vehicles are designed and produced by applying the techniques disclosed herein. The sharing of components reduces the cost of the components, even for components that are subsequently customised to the specific vehicle. The sharing of assembly processes enhances efficient design and production. This is particularly beneficial when applying the principles of robofacturing described herein. This places each microfactory in a position to offer a suite of bespoke vehicles that are members the Arrival system.

FIGS. 176A-176D provide perspective views of a number of variants, with FIG. 176A showing a passenger car 1100a having a first top hat, FIG. 176B showing a passenger car 1100b having a second top hat, FIG. 176C showing an autonomous cargo pod 1100c having a third top hat, and FIG. 176D showing a small van 1100d having a fourth top hat. FIGS. 176E-176G provide views of a schematic, with FIG. 176E showing a perspective view of the vehicle 1100, FIG. 176F showing a front view of the vehicle 1100, and FIG. 176G showing an exploded view which depicts the skateboard 1111 and the top hat 1112.

Innovation can be found both in attributes that are customised, and attributes that are shared, because both of these serve to achieve a bespoke vehicle that makes optimal use of the resources available. Principles that have been developed for the Arrival Car are also implemented by many other Arrival vehicles and Arrival components. Therefore, the Arrival Car serves as an example of innovation that can be implemented by a broad range of vehicles.

FIGS. 177A-177D provide views of an example of a skateboard platform. The skateboard is customised to selected specifications, which facilitates the creation of bespoke vehicles. Examples of specifications that can be customised are provided below. Disclosure is provided of taking one or more of these selected specifications in combination. This includes the combination of any of the features or sub-features described in this section, and further includes the combination with any of the features described in the other sections of this disclosure.

We can generalise this feature to:

A vehicle selected from a vehicle system, in which the vehicle system includes vehicles with multiple different vehicle body types, each vehicle including a skateboard type platform with one or more attributes;
and in which different vehicle body types are all configured to attach to the same skateboard type platform.

A vehicle system including vehicles with multiple different vehicle body types, each vehicle including a skateboard type platform with one or more attributes;
and in which vehicle bodies of different body types are all configured to attach to the same skateboard type platform.

A fleet of vehicles, each vehicle selected from a vehicle system, in which the vehicle system includes vehicles with multiple different vehicle body types, each vehicle including a skateboard type platform with one or more attributes;
and in which different vehicle body types are all configured to attach to the same skateboard type platform;
and in which an operator of the fleet selects the body type or types and the one or more attributes of the skateboard type platform, to meet its requirements.

A method of designing and assembling a vehicle, the method including:

(i) selecting one or more attributes for the vehicle from a range of different available vehicle attributes using the vehicle design tool;
(ii) configuring a skateboard type platform for the vehicle according to the one or more attributes;
(iii) assembling the selected body type to the configured skateboard type platform.

Optional Sub-Features:

General:
different vehicle body types include several of the following: autonomous delivery drone; 2 seat passenger car; 3 seat passenger car; 4 seat passenger car; sports car;
roadster; van; pick-up truck, bus.
different vehicle body types include all of the following: autonomous delivery drone; 2 seat passenger car; 3 seat passenger car; 4 seat passenger car; sports car; roadster; van; pick-up truck.
vehicle bodies of different body types are all configured to attach to the same skateboard type platform
available attributes include: vehicle length, vehicle width, wishbone width, battery capacity, vehicle range, height of skateboard platform, number of electric motors, type of thermal architecture, suspension stiffness, ride height, charging capability (AC, DC or both).

Vehicle Length:
attribute is a configurable length of the skateboard type platform.
attribute is a configurable length of the skateboard type platform that is not limited to two or three available lengths, but can be any length within a defined maximum and minimum length.
attribute is a configurable length of the skateboard type platform that is not limited to two or three available lengths, but can be any length within a defined maximum and minimum length and the size increments separating available lengths is less than one of the following: 50 cm, or 40 cm, or 30 cm or 20 cm or 10 cm.
attribute is a configurable length of the skateboard type platform that is selected from a list of possible lengths, and there are at least 3, 4, 5, 6, 7, 8, 9 or 10 or more possible lengths a customer can choose from.
vehicles of different overall length can be configured by including a pair of longitudinal chassis beams or extrusions of different length in those vehicles.
length is configurable by altering the length of the longitudinal extruded beams and the vehicle can be configured with at least one of: 3, 4, 5, 6, 7, 8, 9 or 10 or more, different lengths.
length is configurable by increments of approximately the length of an individual battery module.
length of a battery module is 350 mm.
length is configurable by increments of approximately 355 mm.

Vehicle Width:
attribute is a configurable width of the skateboard type platform.
attribute is a configurable width of the skateboard type platform that is not limited to two or three available widths, but can be any length within a defined maximum and minimum width.
attribute is a configurable width of the skateboard type platform that is not limited to two or three available widths, but can be any width within a defined maximum and minimum width and the size increments separating available widths is less than one of the following: 50 cm, or 40 cm, or 30 cm or 20 cm or 10 cm.
attribute is a configurable width of the skateboard type platform that is selected from a list of possible widths, and there are at least 3, 4, 5, 6, 7, 8, 9 or 10 or more possible widths a customer can choose from.
vehicles of different overall width differ in having a front cradle and a rear cradle of different width.
vehicles of different overall width differ in having a one or more wishbones of different width.
width is configurable by increments of approximately the width of an individual battery module.
width of a battery module is 350 mm.
width is configurable by increments of approximately 355 mm.

Batteries:
the battery capacity or range of the vehicle is specified by a customer and then an appropriate number of battery modules is assigned for use in the skateboard type platform of that vehicle.
the skateboard type platform includes two longitudinal extruded beams and an array of battery modules positioned between these beams.
length is configurable by increments of the length of an individual battery module and the battery modules are each parallel connected and deliver a high voltage output that is the same as the high voltage output of the entire pack of battery modules.
width is configurable by increments of the width of an individual battery module and the battery modules are each parallel connected and deliver a high voltage output that is the same as the high voltage output of the entire pack of battery modules.
each individual battery module outputs between 300V and 450V.
the skateboard type platform includes a double layer of battery modules
battery modules are as defined in Section G.

Thermal Management:
the vehicle includes a thermal management system configured to perform at least one of passive cooling and active cooling, wherein passive cooling maintains a temperature that is above an ambient temperature, and wherein active cooling maintains a temperature that is below the ambient temperature.
the vehicle includes a thermal management system configured to perform both passive cooling and active cooling, where the active cooling includes a Peltier or solid state thermoelectric cooling system.
the vehicle includes a thermal management system that includes a Peltier or solid state thermoelectric cooling system.

Vehicle Design and Assembly:
vehicle is designed using an automated vehicle design tool.
available attributes include any variable that can be selected using an automated vehicle design tool.
available attributes include any variable that can be selected using an automated vehicle design tool as defined in Section D.
skateboard platform is optimised for robotic handling, installation or assembly, such as autonomous robotic handling, installation or assembly.
vehicle is optimised for robotic handling, installation or assembly, such as autonomous robotic handling, installation or assembly.
vehicle includes a pair of longitudinal chassis beams or extrusions and a torsion bar passes through each longitudinal beam.
the longitudinal chassis beams or extrusions are designed for robotic handling and assembly.
vehicle includes a pair of longitudinal chassis beams or extrusions and a front and rear cradle attached to the beams, with at least one wishbone attached to each side of each cradle, and each cradle includes a cut out section and each wishbone is then configured to attach through the cut out section to a torsion bar that passes through that cradle.
each cradle includes a cut out section there is an upper and a lower one wishbone attached to each side of each cradle, and each upper wishbone is configured to pivot in a cut out around a pin that passes through each cradle.
each cradle is designed for robotic handling and assembly.
the skateboard type platform includes a universal data and power connection port that a number of components in the vehicle body are configured to connect to.
all parts of the skateboard type platform are optimised or designed for robotic handling and/or assembly.
a body is moved vertically with respect to the skateboard type platform to join to the platform.
the body is moved by a robotic assembly system to join to the platform.
the skateboard platform and the vehicle body are secured together solely with mechanical fixing systems.
the skateboard platform and the vehicle body are secured together with mechanical fixing systems that are configured to mechanically lock together.
the mechanical fixing systems are configured for robotic handling and manipulation
skateboard type platform supports electric motors mounted to the platform.
a skateboard type platform is a vehicle platform that includes a chassis structure that supports an integral or internal battery pack and where a flat topped cover of the battery pack forms or supports a flat top of the skateboard type platform.
vehicle is assembled in a robotic production environment as defined in Section E.
vehicle is assembled in a microfactory as defined in Section F.

Feature 2: Vehicle with Customised Length and Body Type

An example of an attribute of the vehicle that can be customised is the length and body type of the vehicle. This is implemented by the design and production of a vehicle having a platform of bespoke length and a top hat of bespoke body type of a corresponding bespoke length.

A variety of lengths of vehicle are available because the length of the platform can be selected and the length of the top hat can be selected. The length of the platform is increased or decreased to accommodate the selected top hat, so that the Arrival system offers a bespoke vehicle that is directed to a specific business objective or user need.

We can generalise this feature to:

A vehicle selected from a vehicle system, in which the vehicle system includes vehicles with multiple different vehicle body types, each vehicle including a skateboard type platform with a configurable length;
and in which different vehicle body types are all configured to attach to the same skateboard type platform.

A vehicle system including vehicles with multiple different vehicle body types, each vehicle including a skateboard type platform with a configurable length;
and in which vehicle bodies of different body types are all configured to attach to the same skateboard type platform.

A fleet of vehicles, each vehicle selected from a vehicle system, in which the vehicle system includes vehicles with multiple different vehicle body types, each vehicle including a skateboard type platform with a configurable length;
and in which different vehicle body types are all configured to attach to the same skateboard type platform;
and in which an operator of the fleet selects the body type or types and the skateboard type platform length, to meet its requirements.

A method of designing and assembling a vehicle, the method including:

(i) selecting a length for the vehicle from a range of different available vehicle lengths using the vehicle design tool;
(ii) configuring a skateboard type platform for the vehicle by altering its length, in dependence on the selected vehicle length;
(iii) assembling the selected body type to the configured skateboard type platform.

Optional Sub-Features:
any applicable sub-feature from Feature 1 above.

Feature 3: Different Vehicles have Different Lengths of Central Extrusion

FIG. 177B shows an exploded view for the first example of the skateboard platform 1111. The vehicle platform 1111 comprises vehicle components which are supported by a cradle (1121, 1122, 1123). More specifically, the vehicle platform comprises a battery pack 1120, a front cradle 1122, a front bumper 1126, a rear cradle 1123, a rear bumper 1127, a left centre extrusion 1121a, a right centre extrusion 1121b, a top cover 1124, and a bottom cover 1125. The “cradle” is configured to support the vehicle components, and so this term describes the front cradle 1122, rear cradle 1123, and the pair of centre extrusions 1121.

The top and bottom covers comprise: top and bottom covers of the front cradle (1124a, 1125a); top and bottom covers of the battery pack (1124b, 1124b); and top and bottom covers of the rear cradle (1124a, 1124b). The cradle provides structural rigidity of the platform, enhancing safety of the vehicle by maintaining the shape of the vehicle. Thus, the cradle protects components installed within the platform 1111.

The front cradle 1122 and rear cradle 1123 are a collection of components preassembled as a module. The suspension, steering, and drivetrain can be built up and tuned to specification prior to attaching these cradles to the vehicle structure. A structural connection is made with interlocking extrusions. Electrical, fluid, hydraulic brake lines are connectorized and mate when the structural connection is made.

Detail of the electronics architecture is provided in FIG. 178, with the features shown being shared by the different variants of the skateboard platform. The battery pack 1120 is formed of HVBMs 1130 connected by a flexible printed circuit board (Flex PCB) 1135. The battery pack 1120 is configured to supply electrical energy to a Super Junction Box (SJB) 1128, from where it is distributed to other components of the vehicle, such as the drive unit 1137, the communication module 1138, the steering system 1139, and the top hat 1112. In this example, control of the battery pack 1120 is performed by a Battery Management System (BMS) 1136, although as an alternative, control of the battery pack 1120 is distributed between the individual HVBMs 1130 of the battery pack 1120.

A consequence of the vehicle components being integrated into the platform 1111 is that these components do not occupy space in the top hat 1112. The platform is a “skateboard type platform”, in that it is self-contained by virtue of integrating the electronic motors, battery and drive components.

The skateboard platform 1111 contains everything that is used by the vehicle 1100 to drive, including the power assembly and the drive assembly. Indeed, the skateboard platform 1111 can be operated without a top hat being installed at all. As a consequence, the top hat can be devoted to satisfying user expectations, as drive and power are taken care of by the platform. Technical benefits of this approach include increased packing efficiency, thus minimising the mass of the platform. Furthermore, the modular nature of Arrival's components enhance serviceability of the vehicle, with each module independently being assigned responsibility for the functions that it performs. Components installed as part of the skateboard platform 1111 include the battery pack 1120 (one or more high-voltage battery module HVBM together with Flex PCB connection), traction motor, traction inverter, battery management system (BMS), onboard charger, charging controller, DC-DC converter, integrated drive unit (IDU), drive control unit (DCU), suspension systems, and thermal systems. The simplicity of configuring the platform 1111 to include the drive components makes servicing easier, as servicing of platforms is performed using the same techniques for a variety of vehicles.

The skateboard 1111 has a substantially flat top surface 1124, which increases the design freedom available for the top hat 1112. The skateboard 1111 has a low height profile, which ensures easy entry and exit from the vehicle, for users and cargo. The self-contained nature of the platform allows the top hat design to be devoted to satisfying user requirements, instead of mitigation being made to accommodate components that are common to all vehicles of the class. The versatility of the top hat design ensures that it is accessible to drivers, passengers and cargo, optimising the functionality of the vehicle as a whole.

The length of the skateboard platform is selected by choosing a length of the centre extrusions 1121, with the number of battery modules (HVBM) along the length of the battery pack being chosen so that they fit within the centre module 1121, between the wheels.

We can generalise this feature to:

A vehicle including a pair of longitudinal chassis beams or extrusions that are each joined to a front cradle and to a rear cradle, each cradle supporting at least one suspension wishbone;
and in which the overall length of the vehicle has been selected from a range of different possible lengths and the vehicle has been configured to that overall length by including a pair of longitudinal chassis beams or extrusions of the appropriate length.

A vehicle system including multiple different vehicle types, each vehicle type including a skateboard type platform including a pair of longitudinal chassis beams or extrusions that are each joined to a front cradle and to a rear cradle, each cradle supporting at least one suspension wishbone;
and in which vehicles of different overall length can be configured by including a pair of longitudinal chassis beams or extrusions of different length in those vehicles.

A fleet of vehicles, each vehicle selected from a vehicle system, in which the vehicle system includes multiple different vehicle lengths, each vehicle including a skateboard type platform including a pair of longitudinal chassis beams or extrusions that are each joined to a front cradle and to a rear cradle, each cradle supporting at least one suspension wishbone;
and in which vehicles of different overall length can be configured by including a pair of longitudinal chassis beams or extrusions of different length in those vehicles.
and in which an operator of the fleet, when specifying its requirements for the vehicles in its fleet, selects the overall length or lengths needed to meet its requirements.

A method of designing and assembling a vehicle, the method including:

(i1) selecting a length for the vehicle from a range of different available vehicle lengths using an automated vehicle design tool;
(ii) configuring the skateboard type platform by altering the length of a pair of longitudinal chassis beams or extrusions in the platform, in dependence on the selected vehicle length, using the automated vehicle design tool;
(iii) assembling the vehicle by joining the longitudinal chassis beams or extrusions to a front cradle and to a rear cradle, each cradle supporting at least one suspension wishbone; and assembling a body for the selected vehicle type to the configured skateboard type platform.

Optional Sub-Features:

Centre Extrusions:
skateboard type platform includes a pair of longitudinal beams or extrusions.
extrusions are a pair of aluminium one-piece longitudinal extrusions.
longitudinal beams or extrusions are joined to front and rear cradles.
each longitudinal beam or extrusion is rigidly joined to a cradle using a rigid beam or rod that passes through a recess or hollow in both the longitudinal beam or extrusion and a recess or hollow in the cradle.
the rigid beam is itself hollow.
the rigid beam is an inner extrusion.
there are upper and lower rigid beams or inner extrusions.
each longitudinal beam or extrusion comprising one or more coolant channels.
each longitudinal beam or extrusion is configured to hold one or more active cooling devices (e.g. a solid state cooling device, such as a Peltier device).
the active cooling device is held by a cavity of the longitudinal beam or extrusion or is mounted to the longitudinal beam or extrusion.
each longitudinal beam or extrusion comprising a first channel and a second channel, and is further configured to hold one or more active cooling device, wherein the active cooling device is configured to transfer thermal energy from the first coolant channel to the second coolant channel.
any applicable sub-feature from Feature 1 above.

Feature 4: Different Vehicles can have Different Battery Capacities

FIG. 179A shows an exploded view of the battery pack 1120 which includes a plurality of battery modules 1130, a plurality of battery module fasteners 1143, a plurality of electrical connectors 1142, a cooling plate assembly 1140, and a housing 1141. The plurality of battery modules includes a top row of battery modules 1130a and a bottom row of battery modules 1130b. The top row of battery modules 1130a are electrically connected to one another by a flexible Printed Circuit Board (Flex PCB) (not shown), and electrically connected to the rest of the vehicle via a top pack connector 1142a. The bottom row of battery modules 1130b are electrically connected to one another by a flexible Printed Circuit Board (Flex PCB) (not shown), and electrically connected to the rest of the vehicle via a bottom pack connector 1142b. Details of the Flex PCB are described in detail elsewhere (see Section G), with bespoke dimensions being configured to the specific vehicle being designed.

The cooling plate assembly 1140 is provided between the top row of battery modules 1130a and the bottom row of battery modules 1130b. The cooling plate assembly comprises a cooling plate top sheet 1140a, a cooling plate bottom sheet 1140c, a cooling circuit 1140b, and a plurality of T-slot connectors 1140d.

FIG. 179B illustrates a cross section view from the front of the battery pack 1120, through the module fasteners 1143 that connect the battery modules 1130. FIG. 179C illustrates a cross section view from the front of the battery pack 1120, through the battery modules 1130. FIG. 179D illustrates a cross section view from the side of the battery pack 1120, through the centre of the battery pack 1120.

Each battery module 1130 has a base plate which is physically connected adjacent to the cooling plate assembly 1140. The battery pack 1120 illustrated includes ten battery modules 1130, with five arranged in the top row and five arranged in the bottom row. Thus, the battery modules of the bottom row 1130b are provided inverted with respect to the battery modules of the top row 1130a, so that the top row is connected to the cooling plate top sheet 1140a and the bottom row is connected to the cooling plate bottom sheet 1140c.

It is not essential for the battery pack 1120 to include a cover 1141, with the function of the cover 1141 instead being provided by the cover of the platform (1124, 1125). Thus, the battery pack 1120 can be accessed by removing the top cover 1124 of the platform for the purpose of performing maintenance of the battery pack from above. As an alternative, or in addition, the battery pack 1120 can be accessed by removing the bottom cover 1125 of the platform. Thus, the battery pack can be accessed from below for the performing of maintenance on the battery pack from below. With this arrangement it is possible for a hot swap of the battery modules to be performed.

When installed, the HVBMs 1140 are connected via the Flex PCB cable. Adjacent to the battery pack 1120 on either side are provided centre extrusions 1121, which are configured to facilitate cooling by transferring heat from the battery pack 1120 to coolant that passes through coolant channels of the centre extrusions 1121. The upper row of battery modules 1130a and the bottom row of battery modules 1130b each include a Universal Connector (1142a, 1142b), which are used to connect the battery pack 1120 to the Super Junction Box (SJB) 1128. The top of the SJB 1128 includes a Universal Connector, which is used to connect the platform 1111 to a corresponding contact of the top hat 1112.

The principle of Robofacturing relates to techniques and systems that enable autonomous robotic production and assembly of devices, including entire vehicles. The goal of robotic assembly, to the greatest extent possible, is a key motivation behind specific aspects of design of Arrival products. A conventional vehicle assembly process makes use of a conveyer belt, along which specialised tools, with specialised engineers being positioned to attend to specific assembly stages. Conventional vehicle assembly is typically expensive, relying on economies of scale in a large factory that covers a large production space. Arrival's Robofacturing approach reduces capital investment by routinely making use of standardised industrial robots, each of which typically performs a number of tasks.

FIGS. 180A-180G illustrate a production method S1110 of the battery pack:
In a first step, cooling tubes of the cooling circuit 1140b are assembled to form a manifold (S1111, FIG. 180B), which is achieved, for example, by brazing.
In a second step, the manifold 1140b and T-Slot connectors 1140d are assembled to the upper and lower cooling plates 1140a,c (S1112, FIG. 180C), thus forming the cooling assembly 1140. This is achieved for example by brazing, adhesives or screws.
In a third step, the top row of battery modules 1130a is connected to the cooling assembly base plate 1140a (S1113, FIG. 180D). To achieve this, a thermal interface paste is applied to the top of the cooling plate 1140a, and then the top layer of battery modules 1130a is bolted to the cooling plate 1140a. A plurality of module fasteners 1143 (e.g., nuts and bolts) attach the components of the cooling plate 1140.
In a fourth step, an electrical connection is provided between the battery modules 1130a of the battery pack (S1114, FIG. 180E). This is achieved by connecting a Flex PCB cable to each of the battery modules in the row 1130a.
The Flex PCB is shown connecting 5 HVBM of the platform in a ‘tram-line’ configuration. A bespoke Flex PCB is produced for the specific configuration of HVBM 1130, so that all electrical connections of the Flex PCB line up with the electrical connections of each HVBM in the battery pack 1120. This simplifies assembly, as once the HVBM are in place, they can be electronically connected by forming the electrical interface with the rest of the vehicle.
The Flex PCB (interconnect Flex) provides the sole electrical interface between the HVBM and the rest of the vehicle. The Flex performs high voltage power distribution to a load, as well as low voltage power distribution to components such as the battery management system.
In a fifth step, a housing 1141 is applied to the battery pack (S1115, FIG. 180F). The end of the Flex PCB is attached to the electrical connector. The top cover 1141a is attached to the base plate using screws or removable urethane adhesive.
In a sixth step, the procedure is repeated for the bottom row of battery modules 1130b (S1116, FIG. 180G). Thus, the bottom row of battery modules 1130b is connected to the cooling assembly base plate 1140c by the plurality of module fasteners 1143 (e.g. nuts and bolts) (S1113, FIG. 180D), then the electrical connection is provided between the battery modules 1130b of the battery pack (S1114, FIG. 180E), then the housing 1141b is applied to the battery pack (S1115, FIG. 180F). If a bottom row of battery modules 1130b is not provided, then this procedure is not performed.
The production of a bespoke battery pack for the specific vehicle of the P1 class is simplified because shared components are connected by applying shared techniques. The assembly of these components by robots enhances safety, so that engineers have reduced exposure to the high voltage of the HVBMs.

An example of an attribute of the vehicle that can be customised is the maximum number of battery modules that can be installed in the vehicle. This is implemented by the design and production of a vehicle having a platform of bespoke length and width. A bespoke top hat is configured to be attached to such a platform. Such a vehicle becomes functional upon installation of a number of battery modules ranging from a single battery module up to the maximum. As a consequence, the range of the vehicle is customised.

The width of the skateboard is constrained by the width of the battery pack, which in itself is constrained by the number of battery modules that are arranged horizontally along the width of the vehicle. A skateboard that is narrow in profile is achieved by providing a battery pack having a width of a single battery module. A narrow vehicle profile is particularly valued for vehicles designed to navigate roads that are narrow or high in traffic volume, with a further benefit being a reduction in air resistance compared to wider vehicles. Accordingly, a linear arrangement of battery modules is envisaged, as exemplified by the battery pack shown in FIG. 177B.

A skateboard that is wide in profile is achieved by providing a battery pack having a width of two or more battery modules. A wide vehicle is particularly valued for vehicles designed for a number of passengers or cargo, such as for ride-hailing applications. Furthermore, this enhances the capacity of the vehicle to accommodate battery modules, extending the range of the vehicle.

The length of the skateboard is constrained by the length of the battery pack, which in itself is constrained by the number of battery modules that are arranged horizontally along the length of the vehicle. Thus, a skateboard that is long in profile is achieved by providing a battery pack having a number of HVBM arranged along the length of the vehicle, for example a battery pack having 5 HVBM. A long vehicle profile is particularly valued for vehicles designed to accommodate passengers or goods, with space being provided in the interior of the vehicle to accommodate them. Accordingly, a two dimensional array of battery modules is envisaged, arranged in a grid formation.

The height of the skateboard is constrained by the height of the battery pack, which in itself is constrained by the number of battery modules that are arranged vertically. Thus, a skateboard that is low in profile is achieved by providing a battery pack having a height of as few HVBM as possible (e.g., a single deck of HVBM, or a double deck of HVBM). A low skateboard profile is particularly valued, making it easier for people and goods to enter and exit the vehicle. Accordingly, a three-dimensional array of battery modules is envisaged, arranged in a grid formation. Although high voltage battery modules are specified as an example, as an alternative, disclosure is provided of an array of low voltage battery modules being connected in series to provide a high voltage battery pack.

The characteristic narrow profile of the platform shown in FIGS. 177A-177D is commonly referred to as a “sausage” shape. The versatility of this platform shape is achieved by virtue of the HVBM being rectangular in shape. Accordingly, the HVBM tesselate to be packaged into a grid arrangement. The tessellation of Arrival's HVBM provides a simple geometrical connection, so that each HVBM can be conveniently electrically connected via the Flex PCB, and can be conveniently cooled by the cooling plate assembly.

Providing a platform that is tailored to accommodate Arrival's HVBM distinguishes from legacy original equipment manufacturers (OEMs), who typically assemble components that are created by third parties, resulting in a battery pack having a complex shape in order to accommodate as many cells as possible.

A consequence of Arrival providing a platform that is shaped to accommodate HVBM in a simple arrangement is that the HVBM can be easily assembled by robots. Thus, the arrangement of components within the platform contributes to the provision of a cost effective way of designing and producing bespoke vehicles.

We can generalise this feature to:

A vehicle including a skateboard type platform; in which the skateboard type platform includes an array of battery modules and, when the vehicle was being designed, then the battery capacity or required range of the vehicle was specified by a customer and then an appropriate number of battery modules was automatically assigned for use in the skateboard type platform of that vehicle by an automated vehicle design tool.

A vehicle system including multiple different vehicle types, each vehicle type including a skateboard type platform;
in which the skateboard type platform includes an array of battery modules and, when a specific vehicle is being designed, then the battery capacity of the vehicle is specified by a customer and then an appropriate number of battery modules is assigned for use in the skateboard type platform of that vehicle.

A fleet of vehicles, each vehicle including a skateboard type platform;
in which the skateboard type platform includes an array of battery modules and, when a specific vehicle is being designed, then the battery capacity of the vehicle is specified by a customer and then an appropriate number of battery modules is assigned for use in the skateboard type platform of that vehicle by an automated vehicle design tool;
and in which an operator of the fleet, when specifying its requirements for the vehicles in its fleet, selects the battery capacity or capacities needed for these vehicles to meet its requirements.

A method of designing and assembling a vehicle, the method including:

(i) selecting a battery capacity for the vehicle from a range of different battery capacities, using a vehicle design tool;
(ii) configuring a skateboard type platform by assigning an appropriate number of battery modules for use in the skateboard type platform, using the vehicle design tool;
(iii) assembling the skateboard type platform by assembling the battery modules into the skateboard type platform of that vehicle.

Optional Sub-Features:
any applicable sub-feature from Feature 1 above.
The battery modules are high voltage battery modules, for example, as described in Section G.
The Robofacturing techniques set out in Section E are applicable to the production of the vehicle and its components.

Feature 5: Double-Deck Battery Pack

An example of an attribute of the vehicle that can be customised is the height of the vehicle interior with respect to the ground. This is implemented by the design and production of a vehicle having a platform of bespoke height. The selection of vehicle height of the platform is achieved by selecting the number of layers of battery modules that are arranged vertically. The selection of vehicle height is further achieved by tuning the suspension. A bespoke top hat is configured to be attached to such a platform. As a consequence, users can enter and exit the vehicle taking a step that is suited to their mobility. Goods can be loaded and unloaded tailored to mobility specifications.

The design of each vehicle involves selecting a bespoke number of battery modules depending on the specifications of the vehicle. A lower chassis is provided by arranging a battery pack having a single row of battery modules, with the provision of additional rows being optional. A low chassis is valued to both passenger vehicles and cargo vehicles, because the resulting low step between the vehicle and the ground makes it easy for the driver or passenger to enter or exit the vehicle, which is particularly beneficial when loading and unloading goods.

FIG. 177B provides an arrangement of 10 HVBM, with 2 rows being arranged vertically in groups of 5 HVBM. In an alternative arrangement, the vehicle is configured to accommodate up to 20 HVBM, with 2 rows being arranged vertically, each row including an array of 10 HVBM. A selected width profile is achieved by arranging vertically a selected number of HVBM. Although high voltage battery modules are specified as an example, as an alternative, disclosure is provided of an array of low voltage battery modules being connected in series to provide a high voltage battery pack.

We can generalise this feature to:

A vehicle including a skateboard type platform; in which the skateboard type platform includes a double layer of battery modules.

A vehicle system including multiple different vehicle types, each vehicle type including a skateboard type platform;
in which the skateboard type platform includes a double layer of battery modules.

A fleet of vehicles, each vehicle including a skateboard type platform;
in which the skateboard type platform includes a double layer of battery modules.

A method of assembling a vehicle, the method including:

(i) assembling a battery pack for the vehicle as a double layer of battery modules.

Optional Sub-Features:
battery modules are arranged as two or more layers to form a battery pack.
pair of longitudinal beams or extrusions supports a number of the battery modules, formed as a battery pack.
battery modules are arranged as a single row of parallel connected battery modules running longitudinally along the length of the vehicle and inside longitudinal beams or extrusions.
battery modules are arranged as two layers to form a battery pack, with the top layer facing upwards, and the lower layer facing downwards, so that each battery module presents its base to a central battery pack base plate that runs through the central chassis extrusion.
the central battery pack base plate includes a liquid cooling system.
each battery module is configured to operate as part of a vehicle battery pack that includes multiple, identical such battery modules, in which each battery module (i) generates at least 300V output and (ii) is electrically connected in parallel with at least 2 other substantially similar battery modules to form the battery pack.
each battery module has the same, square cross section.
each battery module has a size that conforms to regular size intervals and is part of a family of other types of components with sizing that also conforms to the same size intervals.
Each battery module is a 350×350×100 mm grid sized component.
each battery module generates at least 300V output, and (i) includes a single outer shell or lid that is configured to enclose an array of rechargeable cells and seal against a rigid base of the module, and (ii) is configured to be electrically connected to further, substantially similar, battery modules, to form a complete battery pack.
each battery module is configured to operate as part of a battery pack that includes multiple, identical such battery modules, in which each battery module (i) includes rechargeable cells configured to generate, at a pair of output terminals, at least 300V and (ii) delivers power over a substantially low profile, printed circuit board (PCB) flexible electrical conductor.
each vehicle battery module is configured to delivers HV output directly into the HV power bus of a vehicle.
each battery module is configured to electrically engage with a conductor that is integrated into a vehicle component or other vehicle structure that has a purpose in addition to conducting power, such as a structural component or panel.
the battery pack is configured to include a number of parallel connected battery modules, such as 1, 2 3 . . . n battery modules.
the battery pack includes: an array of parallel connected battery modules; a liquid cooling plate; a liquid cooling system; and top and bottom, one piece rigid covers that enclose battery module.
any applicable sub-feature from Feature 1 above.
The battery modules are high voltage battery modules, for example, as described in Section G.

Feature 6: Central Chassis Extrusion Supports Battery Modules

The platform structure is formed from a number of modules (the front module, centre module, and rear module, which can be considered a cradle that supports components of the platform). The cradle confers structural rigidity, thus maintaining the shape of the vehicle. This enhances the safety of the vehicle by protecting vehicle components and vehicle occupants in the event of a collision. Vehicle components are supported by the cradle interior, the cradle exterior, and also within the cradle itself.

The cradle supports many of the vehicle components, particularly vehicle electronics, suspension, power conversion and drive system components. The cradle acts as an enclosure for vehicle components, and also serves as a frame for components that are attached to the outside of the cradle housing. A structural connection is made to the centre extrusion with nesting extrusions. Electrical, fluid, hydraulic brake lines are connectorized and mate when the structural connection is made.

FIGS. 182A-182B illustrate a centre module of the cradle, which is formed of the pair of central extrusions 1121 together with the battery pack 1120. As shown in FIG. 179B, module fasteners 1143 (nuts and bolts) serve to attach the battery modules to the cooling plate 1140. Furthermore, the module fasteners 1143 serve to attach the battery modules to the T-slots 1140d. Each T-slot 1140d has a “T” shape, with the base of the T being arranged horizontally to confer attachment to the rest of the battery pack 1120, and the head of the T shape being arranged vertically to confer attachment to the central extrusions 1121 of the cradle. Each T-slot 1140d is configured to slot into the cradle. This is achieved by the T-slot 1140d being configured to slot into a central extrusion 1121 of the centre module of the cradle.

Each central extrusion 1121 comprises an open channel configured to receive the T-slots. This open channel runs along the length of the central extrusion 1121. Accordingly, the T-slot 1140d is brought into engagement with one end of the central extrusion 1121, and slotted into place so that the T-slot 1140d of the battery pack 1120 is held securely by the central extrusion 1121. The efficiency of the vehicle design is enhanced by selecting the order of steps that occur. This convenient attachment technique facilitates robofacturing, as the battery pack is removably installing into the centre module in a single direction and in a single step.

The platform incorporates the battery modules that power the vehicle, the motor and drive train, as well as the suspension and wheels. As a consequence, the platform includes all of the components that are used to power and drive the vehicle, so that bespoke platforms can be provided that will all confer this functionality. Thus, there is no need for the top hat design to confer power and drive functionality, since this is already accommodated by the platform. This enhances the design freedom available for the top hat, allowing a wide range of top hats to be available that are bespoke to user requirements.

The centre module serves a number of functions, and is designed to have structural rigidity that confers protection to these components, while also contributing to maintaining the shape of the vehicle as a whole. The centre module is produced quickly and cost-effectively by extrusion. The centre module is formed from Aluminium, which is light in weight while providing strength to the platform structure. In the event of a collision, energy is transferred along the length of the vehicle, protecting the vehicle occupants and critical components such as the battery pack.

The centre module comprises a left centre extrusion and a right centre extrusion, with their length being selected to accommodate the chosen top hat. The centre module is assembled to a front module and rear module having a selected width for the chosen top hat. Both the left centre extrusion and the right centre extrusion share the same extrusion profile. Accordingly, they share the same tooling die. Thus, the left centre extrusion and the right centre extrusion illustrate the principle that vehicle components make use of shared constituent parts and shared production processes. The production of fewer different components enhances simplicity of the P1 platform. This allows investment to be made in creating constituent parts that are customised in specific ways in order to create bespoke vehicles. In the case of the left centre extrusion and right centre extrusion, it is the length of these parts which is customised. Nevertheless, use of the same tooling die for each of the bespoke vehicles simplifies the production process.

The centre module accommodates vehicle components. The centre module extrusion is shaped to receive the battery modules, so that they can be easily and quickly slotted into and out of the battery pack.

Each centre extrusion is shaped to include: an upper cylindrical cavity which accommodates a top pivot pin 1167, a lower cylindrical cavity which accommodates the torsion bar 1168, a coolant channel through which liquid coolant flows along the length of vehicle during use, multiple cavities to route brake lines and electrical harnesses, and clips to attach a solid state cooling assembly. The design of the centre extrusion offers a high degree of freedom, allowing the position of each constituent component to be modified to achieve optimal performance. What is important is the functionality that each constituent component serves. Housing these constituent component within the centre extrusions enhances their functionality, also making best use of the space available.

The above arrangement illustrates the coolant channel and the solid state cooling assembly running along the length of each centre extrusion, in a central region between the upper cavity and lower cavity. The coolant channels are positioned closer to the battery pack, and the solid state cooling assembly is positioned along the outside edge of the cradle closer to the external environment. During use, the coolant channel and the solid state cooling assembly serve to transfer heat from the battery pack out to the external environment. Furthermore, cradle being formed of metal, conducts heat emitted by the battery pack, this heat being radiated to the external environment.

The coolant channels contribute to a passive thermal management system (described in detail below). The solid state cooling assembly contributes to an active thermal management system (described in detail below). Passive cooling is provided by thermal energy passing from the battery pack to coolant that flows through the coolant channels. During operation of the solid state cooling assembly, active cooling is provided by thermal energy passing from the coolant in the coolant channels to the outer surface of the platform.

The suspension includes a pivot pin 1167 and a torsion bar 1168. The suspension rotates about both the pivot pin 1167 and the torsion bar 1168. The torsion bar 1168 serves to restore the vehicle to its normal drive height. The torsion bar 1168 is anchored at one end to the vehicle body, and at the other end to the suspension lower link. When the vehicle passes over a bump, the torsion bar 1168 twists, storing energy. This energy is subsequently released as the torsion bar 1168 twists back to its original configuration, thus restoring the vehicle height. The torsion bar 1168 offers an adjustable ride height by tuning the torsion bar 1168 to the appropriate level. The adjustment flag demonstrates the amount of adjustment.

The extrusion includes pick up points to which the torsion bar 1168 is attached. Thus, the torsion bar 1168 and the pivot pin 1167 are integrated within the chassis, hidden from view. This makes an efficient use of space, because the extrusion accommodates multiple uses in addition to conferring strength to the platform.

We can generalise this feature to:

A vehicle including a skateboard type platform;
in which the skateboard type platform includes two longitudinal extruded beams and an array of battery modules positioned between these beams.

A vehicle system including multiple different vehicle types, each vehicle type including a skateboard type platform;
in which the skateboard type platform includes two longitudinal extruded beams and an array of battery modules positioned between these beams.

A fleet of vehicles, each vehicle including a skateboard type platform;
in which the skateboard type platform includes two longitudinal extruded beams and an array of battery modules positioned between these beams;
and in which an operator of the fleet, when specifying its requirements for the vehicles in its fleet, selects the battery capacity or capacities, or vehicle range or ranges, needed for these vehicles to meet its requirements and each vehicle is then automatically provided with the appropriate number of battery modules between these beams.

A method of designing and assembling a vehicle, the method including:

(i) selecting a battery capacity for the vehicle from a range of different battery capacities, using an automated vehicle design tool;
(ii) configuring a skateboard type platform by assigning an appropriate number of battery modules for use in the skateboard type platform, using the vehicle design tool, to give the selected battery capacity;
(iii) assembling the vehicle by assembling the battery modules between two longitudinal extruded beams in the skateboard type platform.

Optional Sub-Features:

Battery Modules
pair of longitudinal beams or extrusions supports a number of battery modules, formed as a battery pack.
battery modules are arranged as a single row of parallel connected battery modules running longitudinally along the length of the vehicle and inside the longitudinal beams or extrusions.
battery modules are arranged as two layers to form a battery pack, with the top layer facing upwards, and the lower layer facing downwards, so that each battery module presents its base to a central battery pack base plate that runs through the central chassis extrusion.
the central battery pack base plate includes a liquid cooling system.
the battery pack comprising a fixture configured to hold the battery pack in place and also to restrict the flow of thermal energy between the battery pack and a passive cooling device (e.g. by the fixture having a low cross sectional area).
battery modules are arranged as two or more layers to form a battery pack.
each battery module is configured to operate as part of a vehicle battery pack that includes multiple, identical such battery modules, in which each battery module (i) generates at least 300V output and (ii) is electrically connected in parallel with at least 2 other substantially similar battery modules to form the battery pack.
each battery module has the same, square cross section.
each battery module has a size that conforms to regular size intervals and is part of a family of other types of components with sizing that also conforms to the same size intervals.
Each battery module is a 350×350×100 mm grid sized component.
each battery module generates at least 300V output, and (i) includes a single outer shell or lid that is configured to enclose an array of rechargeable cells and seal against a rigid base of the module, and (ii) is configured to be electrically connected to further, substantially similar, battery modules, to form a complete battery pack.
each battery module is configured to operate as part of a battery pack that includes multiple, identical such battery modules, in which each battery module (i) includes rechargeable cells configured to generate, at a pair of output terminals, at least 300V and (ii) delivers power over a substantially low profile, printed circuit board (PCB) flexible electrical conductor.
each vehicle battery module is configured to delivers HV output directly into the HV power bus of a vehicle.
each battery module is configured to electrically engage with a conductor that is integrated into a vehicle component or other vehicle structure that has a purpose in addition to conducting power, such as a structural component or panel.
the battery pack is configured to include a number of parallel connected battery modules, such as 1, 2 3 . . . n battery modules.
the battery pack includes: an array of parallel connected battery modules; a liquid cooling plate; a liquid cooling system; and top and bottom, one piece rigid covers that enclose battery module.
any applicable sub-feature from Feature 1 above.
The battery modules are high voltage battery modules, for example, as described in Section G.

Feature 7: Central Chassis Extrusion Includes Torsion Bar

The battery pack is supported by a cradle, formed of a front cradle 1122 and a rear cradle 1123, which are both joined by centre extrusions 1121. The front cradle 1122 and rear cradle 1123 are constructed using the same principles, and the same components, which makes the production of the cradle cost effective and efficient. The cradle provides mounts, upon which the top hat 1112 is attached to the chassis 1111. Furthermore, the cradle includes the suspension system and attaches the chassis to the wheels.

FIGS. 181A-181G provides details of a production process of a cradle of the skateboard platform. FIG. 181A shows an exploded view of the cradle. The front cradle includes four inner extrusions 1161, two centre extrusions 1121, two pod mounts 1163, a cross plate 1164, a steering rack 1165, four wishbones 1166, two pivot pins 1167, two torsion bars 1168, and two adjustment spline flags 1169. FIG. 181B shows a flow chart that details method steps of the production process S1120:
As a first step, inner extrusions 1161 are assembled (S1121, FIG. 181C), by pivot bushings being pressed into four inner extrusions 1161.
As a second step, cradle extrusions 1121 are assembled (S1122, FIG. 181D), by two of the inner extrusions 1161 being slid into a left cradle extrusion 1121, and two of the inner extrusions 1161 being slid into a right cradle extrusion 1121. The inner extrusions 1161 are then secured in place by bolts.
As a third step, the cradle extrusions 1121 are installed with a cross plate 1164 and pod mounts 1163 (S1123, FIG. 181E). The left cradle extrusion 1121 and right cradle extrusion 1121 are attached to the pod mounts 1163 and cradle cross plate 1164, for example by bolts or welding.
As a fourth step, the cross plate 1164 is installed with the steering rack 1165 (S1124, FIG. 181F), by sliding steering rack 1165 into position, which is then secured to the cross plate 1164 by screws.
As a fifth step, the cradle is installed with wishbones 1166 (S1125, FIG. 181G), with the wishbones 1166 being attached to the centre extrusions 1121. The wishbones 1166 are positioned into pivot cut-outs. This allows the wishbones 1166 to pivot with respect to the chassis, thus providing a pre-built component of the suspension.
As a sixth step, the cradle is installed with torsion bars (S1125, FIG. 181G), the top wishbones 1166 being secured by sliding pivot pins 1167 into the inner extrusions 1161. The bottom wishbones 1166 are secured by sliding torsion bars 1168 into the inner extrusions 1161. An adjustment flag 1169 is slid onto a spline at the end of the each torsion bar 1168. Covers are attached to the end of the inner extrusions.

The length of the steering rack 1165 is modified to fit the application. Accordingly, the front cradle can be configured for the specific vehicle in which it is installed. Thus, the width of the vehicle is an example of an attribute that can be customised for each specific combination of platform and top hat. Customisation of vehicle length and width is accompanied by customisation of the suspension. Examples of cradles having different suspension configurations include: off road applications, omni directional wheels, and fixed suspension for factory and warehouse setting, front cradle with single centred wheel for a three-wheeled vehicle application.

The cross plate 1164 provides a mount for the steering rack 1165, and sets the gap between the cradle extrusions 1121. The cross plate 1164 is formed of Aluminium sheet metal, and produced by stamping. The width of vehicle is customised by selecting the width of the cross plate. Left and right cradle extrusions include pre-machined slots for connection to wishbone pivots. Each cradle extrusion 1121 includes a steering rack 1165 passthrough and battery attachment. The cradle extrusions 1121 are joined by box section, and post-machined. The left and right cradle extrusions 1121 are interchangeable, as both have the same design, with a consequence that fewer types of components are produced. The top hat connectors provide simple, structural connect to the vehicle upper assembly.

The wishbones 1166 connect to pre-machined slots of the cradle extrusion 1121. The wishbones 1166 are illustrated in isolation, although a simple connection technique is to create a pre-built suspension separately, before the wishbones 1166 of the suspension are mounted. A pre-built suspension corner typically includes the wishbones, knuckle, damper, wheel hub, brake, and wheel.

The adjustment spline flag 1169 acts as a spring element for suspension, and defines the bottom of the wishbone pivots. The adjustment spline flag 1169 touches off and reacts against the vehicle structure, to resist rotation on the free end of the torsion bar 1168. A screw within the flag can be adjusted to vary wishbone angles and ride height of the vehicle.

To form a completed cradle, the front cradle 1122 and rear cradle 1123 are connected together by the centre extrusions 1121. Components of the vehicle are installed within the cradle. The cradle provides structure to the platform. Additional protection of the platform components and the vehicle as a whole is conferred by surrounding the cradle by a housing (the top cover, the bottom cover, the front end module, and the rear end module).

Arrival's Robofacturing principle of design and production is embraced at all scales, ranging from the assembly of specific components up to the assembly of the vehicle as a whole. This is particularly the case for the Car and its constituent components, although concepts illustrated herein will be understood to be apply to other Arrival products. All of the assembly processes are intended to be performed by robots. Corresponding principles and techniques are applied for the production of both the front cradle 1122 and the rear cradle 1123. A complete cradle (1121, 1122, 1123) is assembled by robots. Furthermore, robots are used to install the cradle with vehicle components such as the battery pack 1120, the drive unit, the electronics architecture and the thermal architecture.

We can generalise this feature to:

A vehicle including a skateboard type platform including two longitudinal beams; and in which a torsion bar passes through each beam.

A vehicle system including multiple different vehicle types, each vehicle type including a skateboard type platform including two longitudinal beams; and in which a torsion bar passes through each beam.

A fleet of vehicles, each vehicle including a skateboard type platform including two longitudinal beams;
in which a torsion bar passes through each beam;
and in which an operator of the fleet, when specifying its requirements for the vehicles in its fleet, selects, directly or indirectly, the torsion bar setting needed for these vehicles to meet its requirements and each vehicle is then provided with torsion bars at the required setting.

A method of designing and assembling a vehicle, the method including:

(i) assembling a skateboard type platform with two longitudinal beams;
(ii) passing a torsion bar through each longitudinal beam.

Optional Sub-Features:
any applicable sub-feature from Feature 1 above.
The Robofacturing techniques set out in Section E are applicable to the production of the vehicle and its components.

Feature 8: Single Power and Data Connection Port Between Skateboard and Body

Vehicles designed according to this system have a shared electrical architecture, which simplifies their production, and ensures that available resources are optimised when creating bespoke vehicles. The electronics architecture of the vehicle platform comprises a battery pack, a super junction box, a rear electrical system and a front electrical system.

FIGS. 183A-183F provide details of a super junction box (SJB) 1128 of the skateboard platform 1111, which serves as an example to illustrate a number of input ports and output ports of the various components that are distributed around the vehicle. The SJB 1128 includes different types of input ports and different types of output ports. In particular, the SJB 1128 includes a number of Universal Connectors 1181a,b,c. Each Universal Connector 1181 is configured to serve as both an input port and an output port. Vehicle components typically make use of Universal Connectors 1181, so that shared hardware is used to connect each component to the electrical architecture of the vehicle.

The electrical wiring between the components includes Universal Connector Plugs which are shaped to correspond to the Universal Connector 1181. To connect a component to the electrical architecture of the vehicle, a Universal Connector Plug is inserted into the Universal Connector 1181 of that component. This can be performed by a robot, which facilitates assembly of the vehicle by robots. Accordingly, electrical safety is enhanced, because human engineers are kept away from electrical hardware as it is being installed.

Nevertheless, for situations where it is optimal, the connection between the platform and the top hat are provided by separate high voltage connectors, low voltage connectors, and communication connectors. The rear view of the SJB 1128 component shown above includes alternative outputs and inputs 1182a,b that are utilised.

The Universal Connector 1181 input ports and output ports are illustrated having the following six connections:
HV+, HV−, LV+, LV−, CAN+, CAN−.
The high voltage (HV+, HV−) connections of the power inputs and power outputs serve to transmit electrical power having a high voltage that corresponds to the HVBM, typically at least 300V.
The low voltage (LV+, LV−) connections of the power inputs and power outputs serve to transmit electrical power having a low voltage, typically corresponding to 12V.
The communication network (CAN+, CAN−) connections of the power inputs and power outputs serve to transmit data signals.

As an alternative, the Universal Connector 1181 input ports and output ports are illustrated having the following six connections:
HV+, HV−, IV+, IV−, LV+, LV−, CAN+, CAN−.
The intermediate voltage (IV+, IV−) connections of the power inputs and power outputs serve to transmit electrical power having an intermediate voltage, typically corresponding to 48V.

The data connection ensures that the components can communicate with one another. Connection of components (e.g., via the Universal Connector 1181) forms a communication network between the connected components. The components communicate their status to other members of the communication network. Examples of status that are communicated include component identity, component authentication, component safety status. Accordingly, the status of each component can be monitored. This embraces Arrival's modularity principle, because each component is assigned responsibility for monitoring its own status, and reporting that status as appropriate.

The Universal Connector 1181 is configured to transmit power and transmit data. Furthermore, the Universal Connector 1181 is configured to transmit power at a plurality of voltage levels. Consolidation of power connection and data connection simplifies the connection between the vehicle components. Each junction box of the P1 vehicle receives electrical power via one or more power input, and transmits power via one or more power output. The SJB 1128 receives electrical power from the battery pack via one or more power input, and transmits power to other vehicle components via one or more power output.

The terms power input and power output are used here in the context of HVBM discharge. When the HVBM are being recharged, the flow of electrical energy occurs in the opposite direction, with the roles reversing for power input and power output.

The rear electrical system houses the charge port. The rear cradle accommodates the vehicle interface enclosure, which houses the ignition switch, e-stop and charge connector. During charging, electrical energy passes from the charge connector to the HVBM, via the SJB 1128.

The SJB 1128 comprises a number of electrical connections which are used by the SJB 1128 to provide electrical communication between the SJB 1128 and another component. The SJB 1128 comprises a number of data connections which are used by the SJB 1128 to provide data communication with another component. Some connections of the SJB 1128 are Universal Connectors 1181 (described above), which serve to consolidate the electrical connections and the data connections. This makes it easier for the SJB 1128 to be plugged in to form electrical and data connections with another component. Simplification of the assembly process for the electronic hardware facilitates production by robots, which enhances electrical safety of vehicle production.

FIG. 183C shows the SJB 1128 being housed by the cradle, and in electrical communication with the batter pack and the drive unit. The electrical connections of the SJB 1128 includes power inputs and power outputs. The SJB 1128 functions to consolidate power conversion, thereby reducing the number of power conversion devices that are installed by the vehicle. These drawings depict an example SJB 1128 having a first power input 1181a that receives electrical power from the first (upper) battery pack 1130a, and a second power input 1181b that receives electrical power from the second (lower) battery pack 1130b.

The drawings illustrate an example SJB 1128 having a first power output that transmit electrical power to the Universal Connector 1181 for distribution to the top hat, and a second power output that transmits electrical power to components of platform.

FIG. 183D provides a cross section view, showing the SJB 1128 in position between the battery pack 1120 and the rear cradle 1123. Power inputs 1181a,b receive electrical power from the HVBM 1130 via the Flex PCB 1135. The upper output port (Universal Connector 1181c) transmits electrical power to the top hat. Rear output ports 1182 transmit electrical power to the rear electrical system (motor, inverter) 1137. It is possible for the SJB 1128 to include additional power outputs, which direct electrical power to other components of the vehicle, such as to the front of the platform and the rear of the platform. Installing additional power outputs (e.g. in the side of the SJB 1128) facilitates the provision of power via the central extrusions of the cradle.

The super junction box 1128 consolidates the platform electronics into a modular unit. This facilitates robotic assembly in two key ways. Firstly, production of the SJB 1128 as a stand-alone module means that assembly of the SJB 1128 is performed in isolation. Secondly, the SJB 1128 is designed to be assembled as part of the platform by robots, bringing the SJB 1128 into position from a specific direction (e.g., from above) and securing it in place. This robofacturing principle applies in general to components of the platform.

We can generalise this feature to:

A vehicle including a skateboard type platform and in which different components or parts of the vehicle are attachable to the skateboard type platform;
and in which the skateboard type platform includes a universal data and power connection port that the different components of the vehicle are each configured to connect to.

A vehicle system including multiple different vehicle types, each vehicle type including a skateboard type platform and in which different components or parts of the vehicle are attachable to the skateboard type platform;
and in which the skateboard type platform includes a universal data and power connection port that the different components of the vehicle are each configured to connect to.

A fleet of vehicles, each vehicle selected from a vehicle system including multiple different vehicle types, each vehicle type including a skateboard type platform and in which different components or parts of the vehicle are attachable to the skateboard type platform;
and in which the skateboard type platform includes a universal data and power connection port that the different components of the vehicle are each configured to connect to;
and in which an operator of the fleet, when specifying its requirements for the vehicles in its fleet, selects, directly or indirectly, the data and power requirements for these vehicles to meet its requirements and each vehicle is then provided with a data and power network that meets its requirements.

A method of designing and assembling a vehicle, the method including:

(i) selecting a number of components of the vehicle from a range of different components that are available, using an automated vehicle design tool;
(ii) assembling the selected number of components to the configured skateboard type platform using a universal data and power connection port in the skateboard type platform that the different components or parts of the vehicle each are configured to connect to.

Optional Sub-Features:

Universal Data and Power Connection Port:
a connectivity port between the vehicle components includes the following connections: HV+, HV−, LV+, LV−, CAN+, CAN−.
the connectivity port between the components further includes the following connections: IV+, IV−.

Components that are Connectable Via a Universal Data and Power Connection Port:
a vehicle body.
a junction box (e.g. the super junction box).
one or more battery packs.

Connectivity Between the Platform and the Body:
different body types are all configured to attach to the same skateboard type platform using the same physical, data and power connection interfaces.
ethernet data connectivity links the skateboard type platform and each vehicle body.
wireless data connectivity links the skateboard type platform and each vehicle body.
an automated vehicle design tool is used to design the data and power network in the skateboard platform and the body.
any applicable sub-feature from Feature 1 above.

Feature 9: Vehicle Assembly

Customised attributes of the vehicle 1100 are designed by vehicle builder software that configures shared components and processes according to the selected attributes. Bespoke vehicles within the vehicle class are assembled at the microfactory.

Individual components are produced as stand-alone modules. Some components (e.g. HVBM) are produced centrally and then delivered to the microfactories ready to be assembled. Some components (e.g. battery pack) are produced at the microfactory separately from the rest of the vehicle. At the microfactory, all of the components are brought together to create the bespoke vehicle.

Accordingly, the customised attributes are achieved by implementing shared assembly processes. This is achieved by the shared assembly processes being customised according to the design specifications.

The P1 class of vehicles is particularly optimised to be produced by robots. Production by robots is simplified by reducing the number of directions for which assembly processes take place. A production process is provided with assembly processes being performed along a first direction, followed by assembly processes being performed along a second direction, and so on. This enhances production efficiency because the same robot can be used to perform a number of assembly processes, which reduces the number of robots that need to be used to work on the vehicle.

FIG. 183E shows a cassette 1185 which is installed into a top hat 1112 of the vehicle 1110. FIG. 183F shows an exploded view of the vehicle 1110 including the cassette 1185. The top hat 1112 includes the cassette 1185, a lower panel, side panels and a roof. The cassette 1185 includes connections to which lights can be mounted, and so demonstrates how the electronics is simplified within the top hat. Motion of each component into position is performed along an installation path that is optimised for robotic handling, installation or assembly.

In the above example, the platform is illustrated having a “bucket” shape, which demonstrates an alternative to the “sausage” shape that was shown previously. Thus, the specific shape attributes of the platform is not important, with the key concept being that the platform attributes and the top hat attributes are selected to provide bespoke vehicles of a specific vehicle class. Accordingly, the principles demonstrated herein are applicable across many classes of vehicle, and are not restricted to the P1 vehicle class.

Each top hat of the P1 class includes a number of replaceable body panels. Arrival body panels are formed of composites which are non-metallic, and so there is no need for panels to be welded together. Replaceability is conferred by each body panel and top hat frame including reversible fixings, each of which is releasably secured. Each body panel includes a clip and a fastener, with the frame of the top hat including a corresponding clip and fastener. To attach a body panel to the frame, the body panel and frame are clipped together by the clip at a first end and then secured together by the fastener at a second end. To detach a body panel from the frame, the fastener is released at the second end, and then the body panel is unclipped at the first end. Body panels are produced by applying shared techniques and components, while conferring a shape that is bespoke to that specific vehicle. The shape of each body panel is selected to facilitate robotic assembly. This is achieved because the body panels and the top hat frame make use of fixings that are shared across the P1 vehicle class.

The top hat cassette 1185 is illustrated by a housing that accommodates wiring that transmit electrical power within the top hat. As an alternative or in addition, the top hat cassette 1185 is integrated within body panels of the vehicle, which reduces the amount of space that is occupied by vehicle electronics. For panels which integrate electronics, such vehicle panels are fabricated making use of shared composite production techniques.

A key assembly stage in the production of the P1 vehicle is the mounting of the P1 top hat onto the P1 platform. The top hat and platform are assembled separately, and then brought together. Vehicle interior assembly occurs before and/or after assembly of the top hat and platform.

The platform and top hat are brought together, and physically connected by a releasably secure joint. The platform and top hat incorporate corresponding fixings, which are positioned relative to one another, so that the joint is secured once the top hat has been brought in position above the platform. If the top hat is ever to be separated from the platform, this is achieved by releasing the joint so that they are no longer secured together.

A vehicle includes a plurality of fixings that hold the top hat securely in place above the platform. Each of these fixings incorporates a male member and a female member. It is envisaged that the top hat includes male members which are inserted into female members of the platform. However, it will be appreciated that instead or in addition, the platform can include male members that are inserted into female members of the top hat.

FIGS. 184A-184H provides details of a production process S1130 for mounting the top hat to the skateboard platform. FIG. 184A illustrates a pod mount which is positioned within a void of each of the wishbones, on the left and right sides of both the front cradle and rear cradle. Thus, each platform comprises four pod mounts. The drawing below illustrates a platform having four female members which are configured to attach to four male members of the top hat. However, it will be appreciated that other fixings are available, with the pod mount illustrating an example attachment of the platform that provides a physical connection to the top hat. A key principle is each platform of the P1 class making use of the same type of fixings, and so bespoke P1 platforms can be assembled by applying shared techniques, thus facilitating cost-effective production by robots.

FIG. 184B provides a flow chart detailing method steps of the production process S1130. FIG. 184C illustrates a first step S1131 of positioning the top hat above the pod mount. FIG. 184D illustrating a second step S1132 of lowering the top hat onto the pod mount. FIG. 184E illustrating a third step S1133 of locking the top hat into place.

Each male member has a locking mechanism configured to hold the male member in place relative to the female member. Each female member has a slit through which the locking mechanism can be passed. The locking mechanism of the male member can be moved between a first position and a second position. When the locking mechanism of the male member is in the first position, the locking mechanism can pass through the slit of the female member. When the locking mechanism of the male member is in the second position, the locking mechanism is blocked by edges of the slits of the female member.

To secure the joint between the top hat and the platform:
the male member is inserted into the female member when the locking member is in the first position; and then
the locking mechanism is moved from the first position to the second position.

Once the joint is secured, the male member and female member are prevented by the locking mechanism from being separated from one another.

The platform and top hat can be released by performing the locking procedure in reverse. To release the joint between the top hat and the platform:
the locking mechanism is moved from the second position to the first position.
the male member is separated from the female member.

As a consequence, the top hat and platform are separated. This allows maintenance to be performed on the platform from above, and the top hat from below. After such maintenance, the top hat is once again attached to the platform.

A specific example is illustrated in the drawings below. The top hat includes a plurality of male members (also referred to as “platform connectors” or “pod mounts”). The cradle of the platform includes a plurality of female members (also referred to as “top hat connectors”). The male member and female member are shaped to correspond to one another. In this example, each female member has a hole through which the locking mechanism of the male member is inserted. The female member is topologically ring-shaped, with the centre of the ring accommodating the locking mechanism when it is in the first position, and exterior edges of the ring preventing the locking mechanism from being released back through the centre of the ring when the locking mechanism is in the second position. Accordingly, when the joint between the male member and the female member is locked, relative motion of the top hat and platform is inhibited.

The male member and the female member have a corresponding shape, so that the male member fits inside the female member. The male member and female member are elongate in shape, specifically having a rectangular profile with curved edges. The elongate shape ensures that twisting does not occur between the male member and female member when they are locked together. Thus, then the joint has been secured, the locking mechanism prevents vertical movement between the male member and female member, while the elongate shape prevents radial movement about the vertical axis.

FIG. 184F showing a locking mechanism in an unlocked position. FIG. 184G showing a locking mechanism in an locked position. Viewed from above, the above-left image shows the locking mechanism of the male member arranged in an unlocked configuration (first position), for which it can move in or out of the hole of the female member. Viewed from above, the above-right image shows the locking mechanism of the male member arranged in a locked configuration (second position), for which it cannot move relative to female member.

After dropping the pod mount (male member) into the top hat connector (female connector), the locking mechanism is turned 90 degrees, locking the pod mount into place. Moving the locking mechanism between the first position and second position is achieved using a specialist locking tool that is shaped to correspond to the male member. As an example of robofacturing, the provision of a specialist locking tool that is robotically controlled to move the locking mechanism between the first position and the second position contributes to the autonomous assembly of the top hat and platform.

FIG. 184H provides a view from below of the skateboard platform with the locking mechanism in the locked position. The top hat is joined to the platform by four such joints, which are illustrated in the locked position so that the top hat is secured in place relative to the platform.

Each bespoke platform shares parts and assembly processes, which permits cost-effective design and production. This is illustrated by providing a bespoke platform having selected dimensions (length, width, height) by virtue of positioning the fixings as appropriate for connection with a bespoke top hat. This same principle is applied for the positioning of the electronics connection between the platform and top hat, the tuning of the suspension of the platform, and the arrangement of the components within the platform.

We can generalise this feature to:

A vehicle including:
a skateboard type platform with one or more attributes; and
a plurality of components which are designed for an installation path to a final position corresponding to the one or more attribute, in which the installation path is optimised for robotic handling, installation or assembly, such as autonomous robotic handling, installation or assembly.

A vehicle selected from a vehicle system, in which the vehicle system includes vehicles with multiple different vehicle body types, each vehicle including:
a skateboard type platform with one or more attribute; and
a plurality of components which are designed for an installation path to a final position corresponding to the one or more attribute, in which the installation path is optimised for robotic handling, installation or assembly, such as autonomous robotic handling, installation or assembly.

A fleet of vehicles, each vehicle selected from a vehicle system, in which the vehicle system includes vehicles with multiple different vehicle body types, each vehicle including:
a skateboard type platform with one or more attribute; and
a plurality of components which are designed for an installation path to a final position corresponding to the one or more attribute, in which the installation path is optimised for robotic handling, installation or assembly, such as autonomous robotic handling, installation or assembly.

A method of designing and assembling a vehicle, the method including:

(i) selecting one or more attribute for the vehicle from a range of different available vehicle attributes using the vehicle design tool;
(ii) configuring a skateboard type platform for the vehicle according to the one or more attribute by installing a plurality of components which are designed for an installation path to a final position corresponding to the one or more attribute, in which the installation path is optimised for robotic handling, installation or assembly, such as autonomous robotic handling, installation or assembly.

Optional Sub-Features:

Robotic Assembly
all parts of the skateboard type platform are optimised or designed for robotic handling and/or assembly.
a body is moved vertically with respect to the skateboard type platform to join to the platform.
the body is moved by a robotic assembly system to join to the platform.
the skateboard platform and the vehicle body are secured together solely with mechanical fixing systems.
the skateboard platform and the vehicle body are secured together with mechanical fixing systems that are configured to mechanically lock together.
the mechanical fixing systems are configured for robotic handling and manipulation.

Vehicle Types
the vehicle system includes vehicles of the following different types: car, van, roadster,
the different types of vehicles all share the same skateboard platform structure of front left and right cradles, rear left and right cradles, joined together by a pair of longitudinal beams or extrusions.
the skateboard type platform supports different types of bodies.
different types of bodies include bodies for the following types of vehicle: autonomous delivery drone; 2 seat passenger car; 3 seat passenger car; 4 seat passenger car; sports car; roadster; van; pick-up truck, bus.
the different types of bodies fitted to the skateboard type platform are available in different lengths and/or widths.

Components in the Skateboard Type Platform:
skateboard type platform includes one or more of the following components: battery modules; battery modules collected together to form a battery pack; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform passive cooling device; active cooling device.
one or more of the components are optimised for is optimised for robotic handling, installation or assembly, such as autonomous robotic handling, installation or assembly.
skateboard type platform supports electric motors mounted to the platform.
a skateboard type platform is a vehicle platform that includes a chassis structure that supports an integral or internal battery pack and where a flat topped cover of the battery pack forms or supports a flat top of the skateboard type platform.
any applicable sub-feature from Feature 1 above.
The Robofacturing techniques set out in Section E are applicable to the production of the vehicle and its components.

### Appendix 1

This Appendix 1 is a consolidated review of the key Features given earlier in Sections A-K; the sections names correspond to the section names used in the main description:
Appendix 1 Section A: Hardware modularity; the Unified Hardware Platform
Appendix 1 Section B: Software modularity, the Unified Software Architecture and Plug and Play Methodology
Appendix 1 Section C: The Arrival Cyber Security System
Appendix 1 Section D: The Arrival Technology Platform: Creating a new vehicle design using the Vehicle Builder tool
Appendix 1 Section E: Robofacturing: robotic data-driven continuous delivery production
Appendix 1 Section F: The Arrival microfactory
Appendix 1 Section G: The Arrival Battery Module and the Flex PCB connector:
Appendix 1, Section H The Arrival Composites system
Appendix 1, Section I: The Arrival Van System
Appendix 1, Section J: The Arrival Bus System
Appendix 1 Section K: The Arrival Car System

We now list the key Features and optional sub-features for each Section A-K. Note that any Feature can be combined with, use or implement other compatible Features from its Section and also from any other Section; any Feature can be combined with, use or implement other optional compatible sub-features from its Section and also from any other Section; any optional sub-feature can combined with, use or implement other compatible optional sub-features from its Section and also from any other Section.

Appendix 1 Section A: Hardware modularity; the Unified Hardware Platform

Feature 1: Modular Hardware Component Sizing

1: A vehicle component that is modular or standardised by virtue of having a size that conforms to regular size intervals and is part of a family of other types of components, all with sizing that also conforms to the same size intervals.
2: A vehicle including a vehicle component that is modular or standardised by Feature of having a size that conforms to regular size intervals and is part of a family of other types of components, all with sizing that also conforms to the same size intervals.
3: A fleet of vehicles, each vehicle including a vehicle component that is modular or standardised by virtue of having a size that conforms to regular size intervals and is part of a family of other types of components, all with sizing that also conforms to the same size intervals;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
substantially all of the structural components used in the vehicle are modular or standardised vehicle components, having a size that conforms to the regular size intervals.
substantially all of the longitudinal extruded beams or members used in the chassis or skateboard of the vehicle are modular or standardised vehicle components, having a size that conforms to the regular size intervals.
substantially all of the transverse extruded beams or members used in the chassis or skateboard of the vehicle are modular or standardised vehicle components, having a size that conforms to the regular size intervals.
substantially all of the vertical extruded beams or members used in the superstructure or body of the vehicle are modular or standardised vehicle components, having a size that conforms to the regular size intervals.
substantially all of the vertical extruded beams or members used in the superstructure or body of the vehicle are separated by horizontal distances that conform to the regular size intervals.
the structural cast wheel arches or wheel supports used in the vehicle are modular or standardised vehicle components, having a size that conforms to the regular size intervals.
the front and rear suspension cradles of the vehicle are modular or standardised vehicle components, having a size that conforms to the regular size intervals.
the body panels used in the vehicle are modular or standardised vehicle components, having a size that conforms to the regular size intervals.
substantially all of the body panels used in the vehicle are composite panels.
where the vehicle is constructed from a number of transverse chassis sections, then some or all of those transverse chassis sections are modular or standardised vehicle components, having a size that conforms to the regular size intervals.
substantially all of the battery modules used in the vehicle are modular or standardised vehicle components that have a size that conforms to the regular size intervals.
the casing of the battery pack that contains the battery modules is a modular or standardised vehicle component that has a size that conforms to the regular size intervals.
one or more of the following are modular or standardised vehicle components that have a size that conforms to the regular size intervals: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
the size intervals are configured to facilitate robotic handling and assembly.
the size intervals are selected to facilitate computer assisted design of the component.
the size intervals are selected to minimise the computation time for trajectory planning and collision detection.
the size of a component is defined by an automated sizing algorithm.
the size of a component is defined by an automated sizing algorithm that calculates the optimal size for that component, given multiple input parameters.
the size of a component is selected to facilitate computer vision based detection, including pose and orientation detection.
the size of a component is selected to facilitate calculation of the swing path during handling and installation.
some or all components have a similar shape.
some or all components have a similar, simplified box-like shape.
some or all components have a flat top.
some or all components have a flat sides.
some or all components have a flat base.
sizing is defined by 100 mm increments.
sizing is defined by 10 mm increment.
the component is made from rigid material to minimise deformation during handling.

Feature 2: Modular Hardware Components Installed Using the Same Regular, Rectilinear Grid or Installation Pattern

1: A vehicle component that is modular or standardised by virtue of being part of a family of other types of components, all being configured to be positioned or installed in the vehicle in a regular, rectilinear grid or installation pattern.
2: A vehicle including a vehicle component that is modular or standardised by virtue of having a size that conforms to regular size intervals and is part of a family of other types of components, all being configured to be positioned or installed in the vehicle in a regular, rectilinear grid or installation pattern.
3: A fleet of vehicles, each vehicle including a vehicle component that is modular or standardised by virtue of having a size that conforms to regular size intervals and is part of a family of other types of components, all being configured to be positioned or installed in the vehicle in a regular, rectilinear grid or installation pattern;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
rectilinear grid or installation pattern is optimised for robotic installation or assembly, such as autonomous robotic installation or assembly.
rectilinear grid or installation pattern is optimised to facilitate computer vision based detection of the position of component.
rectilinear grid or installation pattern is optimised to facilitate computer vision based detection of the correct installation of a component.
rectilinear grid or installation pattern is selected to facilitate calculation of the swing path during handling and installation.
the size of robotic cells in a vehicle production environment and their placement conforms to same rectilinear grid or installation pattern.
the size and routing of pathways for AMRs in a vehicle production environment conforms to same rectilinear grid or installation pattern.
vehicle component is modular or standardised by virtue of having a size that conforms to regular size intervals and is part of a family of other types of components, all with sizing that also conforms to the same size intervals, as per Feature 1 and its optional sub-features.

Feature 3: Modular Hardware Components Configured for Robotic Assembly

1: A vehicle component that is modular or standardised by virtue of being part of a family of other types of components, all having external surface or casing feature or features that are optimised for robotic handling, installation or assembly, such as autonomous robotic handling, installation or assembly.
2: A vehicle including a vehicle component that is modular or standardised by virtue of being part of a family of other types of components, all having external surface or casing feature or features that are optimised for robotic handling, installation or assembly, such as autonomous robotic handling, installation or assembly.
3: A fleet of vehicles, each vehicle including a vehicle component that is modular or standardised by virtue of being part of a family of other types of components, all having external surface or casing feature or features that are optimised for robotic handling, installation or assembly, such as autonomous robotic handling, installation or assembly;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
external surface or casing feature or features are gripping features.
external surface or casing feature or features are a sufficient grasping surface, close to the component centre of mass.
external surface or casing feature or features enable accurate component location or localisation.
external surface or casing feature or features enable a secure grip during robotic handling, enabling movement with fast acceleration and deceleration.
some or all of the family of components have a similar shape.
some or all of the family of components have a similar, simplified box-like shape.
some or all of the family of components have a flat top.
some or all of the family of components have a flat side.
some or all of the family of components have a flat base.
sizing is defined by 100 mm increments.
sizing is defined by 10 mm increment.
size of a component is defined by an automated sizing algorithm.
size of a component is defined by an automated sizing algorithm that calculates the optimal size for that component, given multiple input parameters.
casing feature or features of a component are selected to facilitate computer vision based detection, including pose and orientation detection.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.

Feature 4: Modular Hardware Components that are Box Shaped

1: A vehicle component that is modular or standardised by virtue of being part of a family of other types of components, all having the same overall box shape, the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors.
2: A vehicle including a vehicle component that is modular or standardised by virtue of being part of a family of other types of components, all having the same overall box shape, the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors.
3: A fleet of vehicles, each vehicle including a vehicle component that is modular or standardised by virtue of being part of a family of other types of components, all having the same overall box shape, the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; sensors; weight sensors; computer vision sensors; LIDAR sensors; radar-based sensors;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
box shape is optimised for robotic handling, installation or assembly, such as autonomous robotic handling, installation or assembly.
box shape is selected to facilitate computer vision based detection, including pose and orientation detection.
box size is selected to conform to regular size intervals
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features.

Feature 5: Modular Hardware Components with Install Path Optimised for Robotic Installation

1: A vehicle component that is modular or standardised by virtue of being part of a family of other types of components, all designed for an installation path to a position, in which the installation path is optimised for robotic handling, installation or assembly, such as autonomous robotic handling, installation or assembly, during a vehicle assembly process.
2: A vehicle including a vehicle component that is modular or standardised by virtue of being part of a family of other types of components, all designed for an installation path to a position, in which the installation path is optimised for robotic handling, installation or assembly, such as autonomous robotic handling, installation or assembly, during a vehicle assembly process.
3: A fleet of vehicles, each vehicle including a vehicle component that is modular or standardised by virtue of being part of a family of other types of components, all designed for an installation path to a position, in which the installation path is optimised for robotic handling, installation or assembly, such as autonomous robotic handling, installation or assembly during a vehicle assembly process;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
installation path is selected to ensure enough space for robotic operations.
installation path is selected to ensure enough access space for a robotic head.
robots approach in the axis of fasteners for the component, and don't require leverage (such as for a spanner).
installation path is calculated in CAD using a wireframe draggable model of the component and the robot.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features.
vehicle component is modular or standardised by virtue of being part of a family of other types of components, all having the same overall box shape, as per Feature 4 and its optional sub-features.

Feature 6: Modular Hardware Components with Standardised Fasteners

1: A vehicle component that is modular or standardised by virtue of being part of a family of other types of components, that each use the same, standardised physical installation systems, that are each optimised for robotic handling and use.
2: A vehicle including a vehicle component that is modular or standardised by virtue of being part of a family of other types of components, that each use the same, standardised physical installation systems, that are each optimised for robotic handling and use.
3: A fleet of vehicles, each vehicle including a vehicle component that is modular or standardised by virtue of being part of a family of other types of components, that each use the same, standardised physical installation systems, that are each optimised for robotic handling and use;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
standardised physical installation systems include physical fasteners.
physical fasteners are self-aligning or self-locating.
robots approach a fastener or the location of the fastener in the axis of the fastener.
self-aligning or self-locating fastener is a bullet shaped pin.
bullet shaped pin either includes a shoulder or has no shoulder.
bullet shaped pins are overmoulded into, or adhered onto, other components.
bullet shaped pins are adhered with a suitable adhesive to the surface of other components.
bullet shaped pins are push-fit.
Parts with two or more alignment pins automatically rotate a part into position as the pins align with their corresponding holes.
standardised physical installation systems include glue based systems.
robots are configured for one or more of: Pick and Place, Insert, Glue, Screw, Welding.
A software implemented tool assess the number of operations, the time taken to complete the operations, and the actions involved to give feedback on a total cost of assembly, and where errors may occur.
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.
family of other types of components includes one or more of: frames, panels, motors, chassis elements.
vehicle component is modular or standardised by virtue of having a size that conforms to regular size intervals and is part of a family of other types of components, all with sizing that also conforms to the same size intervals, as per Feature 1 and its optional sub-features.
vehicle component is modular or standardised by virtue of being part of a family of other types of components, all being configured to be positioned or installed in the vehicle in a regular, rectilinear grid or installation pattern, as per Feature 2 and its optional sub-features.
vehicle component is modular or standardised by virtue of being part of a family of other types of components, all having external surface or casing feature or features that are optimised for robotic handling, installation or assembly, such as autonomous robotic handling, installation or assembly, as per Feature 3 and its optional sub-features.
vehicle component is modular or standardised by virtue of being part of a family of other types of components, all having the same overall box shape, as per Feature 4 and its optional sub-features.
vehicle component is modular or standardised by virtue of being part of a family of other types of components, all designed for an installation path to a position, in which the installation path is optimised for robotic handling, installation or assembly, such as autonomous robotic handling, installation or assembly, as per Feature 5 and its optional sub-features.

Feature 7: Modular Hardware Components with Standardised Self-Aligning Electrical Interfaces

1. A vehicle component that is modular or standardised by virtue of being part of a family of other types of components, that each use the same, standardised self-aligning electrical interfaces, that are each optimised for robotic handling and use.
2. A vehicle including a vehicle component that is modular or standardised by virtue of being part of a family of other types of components, that each use the same, standardised self-aligning electrical interfaces, that are each optimised for robotic handling and use.
3. A fleet of vehicles, each vehicle including a vehicle component that is modular or standardised by virtue of being part of a family of other types of components, that each use the same, standardised self-aligning electrical interfaces, that are each optimised for robotic handling and use.
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features:
standardised self-aligning electrical interfaces includes a float to cope with misalignment during assembly.
standardised self-aligning electrical interfaces enable automatic connection of electrical components upon mechanical assembly into a vehicle.
standardised self-aligning electrical interfaces include pre-alignment pins to aid in auto-alignment of connectors.
pre-alignment pins are tapered conical or rounded pins.
vehicle component includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform; Flex PCB conductor; sensors; weight sensors; computer vision sensors; LIDAR sensors; radar-based sensors.

Feature 8: Modular Hardware Components that Use Same Unique ID System

1. A vehicle component that is modular or standardised by virtue of being part of a family of other types of components, that each use the same, standardised identification system that gives each individual component a unique identification that is (i) computer readable but not meaningful to a human; and (ii) enables each individual component to be tracked from initial production to initial installation, and subsequent servicing and end-of-life.
2: A vehicle including a vehicle component that is modular or standardised by virtue of being part of a family of other types of components, that each use the same, standardised identification system that gives each individual component a unique identification that is (i) computer readable but not meaningful to a human; and (ii) enables each individual component to be tracked from initial manufacture to initial installation, and subsequent servicing and end-of-life.
3: A fleet of vehicles, each vehicle including a vehicle component that is modular or standardised by virtue of being part of a family of other types of components, that each use the same, standardised identification system that gives each individual component a unique identification that is (i) computer readable but not meaningful to a human; and (ii) enables each individual component to be tracked from initial manufacture to initial installation, and subsequent servicing and end-of-life;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
component is tracked using a smart or computer implemented supply chain system.
real-time component data is fed into the computer implemented supply chain system, which automatically adjusts supply chain parameters, such as which components are ordered and their delivery schedules, based on the real-time data.
the real-time data fed to the computer implemented supply chain system includes real-time installation data.
the real-time data fed to the computer implemented supply chain system includes real-time component performance data.
the real-time data fed to the computer implemented supply chain system includes real-time component maintenance data.
the real-time data fed to the computer implemented supply chain system includes real-time component fault data.
real-time component data is fed to an AB testing system for analysis.
real-time component data is analysed for predictive maintenance.
unique identification is a 2D barcode and/or RFID tag.
component is any component used in the vehicle.

Feature 9: Modular Hardware Components that are Black

1: A vehicle component that is modular or standardised by virtue of being part of a family of other types of components, all optimised for robotic computer vision recognition and/or optimised for radiant heat dissipation, by virtue of being substantially black in colour.
2: A vehicle including a vehicle component that is modular or standardised by virtue of being part of a family of other types of components, all optimised for robotic computer vision recognition and/or optimised for radiant heat dissipation, by virtue of being substantially black in colour.
3: A fleet of vehicles, each vehicle including a vehicle component that is modular or standardised by virtue of being part of a family of other types of components, all optimised for robotic computer vision recognition and/or optimised for radiant heat dissipation, by virtue of being substantially black in colour;
and in which an operator of the fleet defines a specific set of requirements it has for one or more vehicles in the fleet, and those requirements are used, for example by an automated vehicle design tool, when selecting the modular or standardised vehicle components to be used in vehicles in the fleet.

Optional Sub-Features
family of other types of components includes one or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing; sensors; weight sensors; computer vision sensors; LIDAR sensors; radar-based sensors.

Appendix 1 Section B: Software Modularity: The Unified Software Architecture and Plug and Play Methodology

Feature 1: Modular Software Components are Used by the Vehicle Builder Tool when Planning a New Vehicle

1: A method of configuring software in a vehicle, including the following steps:
(i) an automated vehicle design tool (a) accessing data that defines a range of system functions and features to be implemented in the vehicle, and then (b) selecting and generating a list of modular software components for some or all of the ECUs in the vehicle and corresponding set of requirements and tasks for the ECUs to implement the range of the system functions and features;
(ii) the automated vehicle design tool then automatically designing a plan for distributing or allocating the software components across these ECUs, to meet a set of requirements and the tasks assigned to the ECUs by the automated vehicle design tool for implementing the range of the system functions and features.
2: A vehicle including ECUs, in which modular software components for the ECUs have been automatically distributed or allocated by an automated vehicle design tool to meet a set of requirements and tasks assigned to the ECUs by the automated vehicle design tool for implementing a range of system functions and features in the vehicle.
3: A fleet of vehicles, each including ECUs, in which modular software components for the ECUs in each vehicle have been distributed or allocated by an automated vehicle design tool to meet a set of requirements and tasks assigned to the ECUs by the automated vehicle design tool for implementing a range of system functions and features in the vehicle;
and an operator of the fleet defines the range of system functions and features for one or more vehicles in the fleet, and those system functions and features are used by the automated vehicle design tool when selecting and generating the list of the modular software components and the set of requirements and tasks assigned to the ECUs in each respective vehicle in the fleet.
   4: A vehicle ECU in which modular software components for the ECU have been automatically distributed or allocated to that ECU by an automated vehicle design tool to meet a set of requirements o and tasks assigned to the ECU by the automated vehicle design tool for implementing a range of system functions and features in the vehicle.
   5: Software components for a vehicle ECU, in which the software components are modular and are automatically distributed or allocated to that ECU by an automated vehicle design tool to meet a set of requirements and tasks assigned to that ECU by the automated vehicle design tool for implementing a range of system functions and features in the vehicle.

Optional Sub-Features:
the modularity of the software components enables the automated vehicle design tool to select appropriate software components for a specific ECU, depending on the individual requirements of that specific ECU and the tasks performed by that specific ECU.
the software components include software components of (i) an application layer and (ii) a basic software layer, or middleware layer, that insulates or separates the application layer from hardware specific features of an ECU and presents a standardised interface to the application layer.
the basic software layer provides one or more of: interface to the electrical or data values generated by the ECU; virtual communications bus; real-time scheduling of software components; data storage services; maintenance of non-volatile data; ECU fault diagnosis; cryptographically authenticate data.
the automated vehicle design tool selects the software components for some or all of the ECUs in the vehicle to meet customer specified requirements.
the automated vehicle design tool arranges or distributes software components across the ECUs in an optimized way.
the automated vehicle design tool calculates the network load and computing capacity for an arrangement of ECUs, and software components.
the automated vehicle design tool optimises the following: network load; software module or component operations or capacity.
the automated vehicle design tool allocates software components on different ECUs to serve various hardware components or devices in an optimized way.
at vehicle build time, an ECU is installed in a vehicle and then automatically provided with some or all of the software components specified at design time by the automated vehicle design tool.
at vehicle build time, an ECU is automatically provided with some or all of the software components specified at design time by the automated vehicle design tool and is then installed in the vehicle as a firmware.
the software components are reusable; the software components are designed to be atomic or modular so that reusability can happen across different applications and different vehicles, including vehicles with different hardware topologies.
the software components are transferable; the software components are allocatable to different ECUs because of the hardware abstraction provided by the basic software layer.
the software components are scalable and extensible: common software components are adaptable to different vehicle platforms, so that proliferation of software with similar functionality is avoided.
the software components are extensible; a software component can be extended from an already existing component to provide new behavior.
the software components are encapsulated: the software components do not expose any aspect of their internal behavior and only their required/provided interfaces are visible within the architecture.
the software components are independent: the software components are designed to have minimal dependencies on other components so that modularity can be achieved.
the software components are configured to communicate with other software components either locally when residing on the same ECU or via vehicle networks.
the software components are configured for unified or consistent monitoring and diagnostics.
the software components are configured for unified or consistent cybersecurity measures.
the software components are configured for unified or consistent configuration.
the software components are configured for unified or consistent updating procedures.
the automated vehicle design tool is configured to design a range of different vehicles with different capabilities, such as a range of electric vans, with different lengths and/or heights and/or battery capacity.
the automated vehicle design tool is configured to design different types of vehicles, such as cars and/or vans, and/or trucks, and/or buses.
the automated vehicle design tool is configured to send data defining the software components to be used in a vehicle to a robotic manufacturing environment that builds or assembles a vehicle as designed by the automated vehicle design tool, and the ECUs in the vehicle are provisioned with the modular software components specified by the vehicle design tool and composed into a firmware, and that provisioning occurs in the robotic manufacturing environment.

Feature 2: Software Component Pre-Integration is Verified by the Vehicle Builder Tool

1: A method of configuring software in a vehicle, including the following steps:
(i) an automated vehicle design tool, prior to being tasked with designing a specific vehicle, accessing data that defines a range of modular software components, and then selecting and generating a list of the software components for some or all of the ECUs in the vehicle;
(ii) the automated vehicle design tool then automatically testing the inter-operability or integration of the system, including the software components, ECUs and related sub-systems, such as sensors.
2: A vehicle including ECUs, in which the ECUs, software components for the ECUs and related sub-systems, such as sensors, have been automatically tested for inter-operability or integration by an automated vehicle design tool, prior to that automated tool being tasked with designing a specific vehicle.
3: A fleet of vehicles, each including ECUs, in which software components for the ECUs and related sub-systems, such as sensors, have been automatically tested for inter-operability or integration by an automated vehicle design tool, prior to that automated tool being tasked with designing a specific vehicle;
and an operator of the fleet defines a specific set of requirements it has for one or more vehicles in the fleet, and those requirements are used by the automated vehicle design tool when selecting and generating the list of the software components for each respective vehicle.
   4: A vehicle ECU in which software components for the ECU and related sub-systems, such as sensors, have been automatically tested for inter-operability or integration by an automated vehicle design tool, prior to that automated tool being tasked with designing a specific vehicle.
   5: Software components for a vehicle ECU, in which the software components have been automatically tested for inter-operability or integration by an automated vehicle design tool, prior to that automated tool being tasked with designing a specific vehicle.

Optional Sub-Features:
As Feature 1

Feature 3: Software Component Operation for a New Vehicle Design is Fully Simulated in the Vehicle Builder Tool

1: A method of configuring software in a vehicle, including the following steps:
(i) an automated vehicle design tool, when tasked with designing a specific vehicle, accessing data that defines a range of modular software components, and then selecting and generating a list of the software components for some or all of the ECUs in the vehicle;
(ii) the automated vehicle design tool then automatically simulating the operation of the system including the software components, ECUs and related sub-systems, such as sensors, to test and verify the inter-operability, integration and operational performance of that simulated system.
2: A vehicle including ECUs, in which simulated software components for the ECUs and related sub-systems, such as sensors, have been automatically tested, in simulation, for inter-operability, integration and operational performance by an automated vehicle design tool, when that automated tool was tasked with designing that vehicle.
3: A fleet of vehicles, each including ECUs, in which software components for the ECUs and related sub-systems, such as sensors, have been automatically tested, in simulation, for inter-operability, integration and operational performance by an automated vehicle design tool, when that automated tool was tasked with designing vehicles in the fleet of vehicles;
and an operator of the fleet defines a specific set of requirements it has for one or more vehicles in the fleet, and those requirements are used by the automated vehicle design tool when selecting the software components for each respective vehicle in the fleet.
   4: An ECU for a vehicle, in which simulated software components for the ECU and related sub-systems, such as sensors, have been automatically tested, in simulation, for inter-operability, integration and operational performance by an automated vehicle design tool, when that automated tool was designing the vehicle.
   5: Software components for a vehicle ECU, in which simulated software components have been automatically tested, in simulation, for inter-operability, integration and operational performance by an automated vehicle design tool, when that automated tool was designing a vehicle with that ECU.

Optional Sub-Features
As Feature 1

Feature 4: Software Components Selected in Vehicle Builder are Automatically Provisioned at Robofacturing Build Time

1: A method of assembling or building a vehicle, including the following steps:
(i) an automated vehicle design tool, when tasked with designing a specific vehicle, accessing data that defines a range of modular software components, and then selecting and generating a list of the software components for some or all of the ECUs in the vehicle;
(ii) the automated vehicle design tool sending data, defining the selected software components to be used in the vehicle, to a robotic manufacturing environment;
(iii) the robotic manufacturing environment building or assembling the vehicle as designed by the automated vehicle design tool, and the ECUs in the vehicle are automatically provisioned with the modular software components specified by the vehicle design tool, and that automatic provisioning occurs in the robotic manufacturing environment.
2: A vehicle including ECUs, in which (i) modular software components for the ECUs have been selected by an automated vehicle design tool, when tasked with designing the vehicle, (a) accessing data that defines a range of modular software components, and then (b) selecting and generating a list of the software components for some or all of the ECUs in the vehicle;
and in which (ii) the ECUs are automatically provisioned with the modular software components specified by the vehicle design tool, and that automatic provisioning occurs in a robotic manufacturing environment that builds or assembles the vehicle as designed by the automated vehicle design tool.
   3: A fleet of vehicles, each vehicle including ECUs, and in which (i) modular software components for the ECUs have been selected by an automated vehicle design tool, when tasked with designing a vehicle, (a) accessing data that defines a range of modular software components, and then (b) selecting and generating a list of the software components for some or all of the ECUs in the vehicle;
and in which (ii) the ECUs are automatically provisioned with the modular software components specified by the vehicle design tool, and that automatic provisioning occurs in a robotic manufacturing environment that builds or assembles each vehicle in the fleet, as designed by the automated vehicle design tool;
and an operator of the fleet defines a specific set of requirements it has for one or more vehicles in the fleet, and those requirements are used by the automated vehicle design tool when selecting the software components for each respective vehicle in the fleet.
   4: A vehicle ECU in which (i) modular software components for the ECUs have been selected by an automated vehicle design tool, when tasked with designing a vehicle, (a) accessing data that defines a range of modular software components, and then (b) selecting and generating a list of the software components for some or all of the ECUs in the vehicle;
and in which (ii) the ECU is automatically provisioned with the modular software components specified by the vehicle design tool, and that automatic provisioning occurs in a robotic manufacturing environment that builds or assembles the vehicle as designed by the automated vehicle design tool.
   5: Software components for a vehicle ECU, in which (i) modular software components for the ECUs have been selected by an automated vehicle design tool, when tasked with designing a vehicle, (a) accessing data that defines a range of modular software components, and then (b) selecting and generating a list of the software components for some or all of the ECUs in the vehicle;
and in which (ii) the ECU is automatically provisioned with the modular software components specified by the vehicle design tool, and that automatic provisioning occurs in a robotic manufacturing environment that builds or assembles the vehicle as designed by the automated vehicle design tool.

Optional Sub-Features
As Feature 1

Feature 5: Software Component Operation with Performance Feedback Loop

1: A method of improving the design of software components in a vehicle, including the following steps:
(i) software components in a vehicle automatically monitoring their performance during ordinary use and causing feedback data to be sent over a network to an automated performance tool;
(ii) the automated performance tool analysing or using that feedback data, or data derived from that feedback data for one or more of the following purposes: to improve the design of future software components; for predictive maintenance and software component updates; for rapid identification of software component faults and their source; for software component A/B testing; for software component supplier feedback.
2: A vehicle including software components that automatically monitor their performance during ordinary use and cause feedback data to be sent over a network to an automated performance tool;
the automated performance tool analysing or using that feedback data, or data derived from that feedback data, for one or more of the following purposes: to improve the design of future software components; for predictive maintenance and software component updates; for rapid identification of software component faults and their source; for software component A/B testing; for software component supplier feedback.
   3: A fleet of vehicles, including software components that automatically monitor their performance during ordinary use and cause feedback data to be sent over a network to an automated performance tool; the automated performance tool analysing or using that feedback data, or data derived from that feedback data for one or more of the following purposes: to improve the design of future software components; for predictive maintenance and software component updates; for rapid identification of software component faults and their source; for software component A/B testing; for software component supplier feedback.
   4: A vehicle ECU in which software components for the ECU automatically monitor their performance during ordinary use and cause feedback data to be sent over a network to an automated performance tool;
the automated performance tool analysing or using that feedback data, or data derived from that feedback data, for one or more of the following purposes: to improve the design of future software components; for predictive maintenance and software component updates; for rapid identification of software component faults and their source; for software component A/B testing; for software component supplier feedback.
   5: Software components for a vehicle ECU, in which the software components automatically monitor their performance during ordinary use and cause feedback data to be sent over a network to an automated performance tool;
the automated performance tool analysing or using that feedback data, or data derived from that feedback data, for one or more of the following purposes: to improve the design of future software components; for predictive maintenance and software component updates; for rapid identification of software component faults and their source; for software component AB testing; for software component supplier feedback.

Optional Sub-Features
As Feature 1

Feature 6: Design and Build Tool Chain: Combining Vehicle Builder and Robofacturing Tools

1: A method of designing and building a vehicle, including the following steps:
(i) an automated vehicle design tool accessing data that defines a range of modular software components, and then selecting and generating a list of the software components for the vehicle;
(ii) the automated vehicle design tool then automatically designing a plan for distributing or allocating the software components across sub-systems, such as ECUs, in the vehicle, to meet requirements and/or the tasks assigned by the automated vehicle design tool;
(iii) the automated vehicle design tool sending data defining the software components to be used in the vehicle to a robotic manufacturing environment that builds or assembles a vehicle as designed by the automated vehicle design tool.
2: A vehicle including ECUs, in which software components have been distributed or allocated across sub-systems, including ECUs, in the vehicle, to meet requirements and/or tasks assigned by an automated vehicle design tool;
the automated vehicle design tool having sent data defining the software components to a robotic manufacturing environment to enable the vehicle, as designed by the automated vehicle design tool, to be assembled with those software components.
   3: A fleet of vehicles, each including ECUs, in which software components have been distributed or allocated across sub-systems, including ECUs, in the vehicle, to meet requirements and/or tasks assigned by an automated vehicle design tool;
the automated vehicle design tool having sent data defining the software components to a robotic manufacturing environment to enable the vehicle, as designed by the automated vehicle design tool, to be assembled with those software components;
and in which an operator of the fleet defines a specific set of requirements it has for one or more vehicles in the fleet, and those requirements were used by the automated vehicle design tool when selecting and generating the list of the software components for each respective vehicle in the fleet.
   4: A vehicle ECU in which software components for the ECU have been distributed or allocated across sub-systems, including ECUs, in the vehicle, to meet requirements and/or tasks assigned by an automated vehicle design tool;
the automated vehicle design tool having sent data defining the software components to a robotic manufacturing environment to enable the ECU to be configured with those software components.
   5: Software components for a vehicle ECU, in which the software components have been distributed or allocated across sub-systems, including ECUs, in the vehicle, to meet requirements and/or tasks assigned by an automated vehicle design tool;
the automated vehicle design tool having sent data defining the software components to a robotic manufacturing environment to enable the ECU to be configured with those software components.

Optional Sub-Features
As Feature 1

Feature 7: Modular Software Components Used by Vehicle Builder to Generate a Firmware for a Vehicle Model Based on Customer-Specific Selection of System Features.

1: A method of generating a firmware for a vehicle, comprising:
(i) an automated vehicle design tool (a) obtaining data on a vehicle hardware topology, the topology comprising modular hardware components and ECUs, and desired system features for the vehicle, and (b) selecting system functions to provide the desired system features and modular software components to enable performing the system functions based on the data;
(ii) the automated vehicle design tool then automatically (a) creating a scheme of allocation of the modular software components on the ECUs to control the modular hardware components for performing the system functions and (b) generating a firmware for the vehicle using the modular software components and the scheme of allocation of the same on the ECUs.
2: A vehicle comprising modular hardware components and ECUs that has a firmware generated automatically by an automated vehicle design tool by means of
selecting system functions to provide the vehicle with desired system features and modular software components to enable performing the system functions, and
creating a scheme of allocation of the modular software components on the ECUs to control the modular hardware components for performing the system functions.
   3: A fleet of vehicles, each vehicle comprising modular hardware components and ECUs and having a firmware generated automatically by an automated vehicle design tool by means of selecting system functions to provide the vehicle with desired system features and modular software components to enable performing the system functions, and of creating a scheme of allocation of the modular software components on the ECUs to control the modular hardware components for performing the system functions;
wherein an operator of the fleet defines the desired system features to be implemented in each individual vehicle in the fleet, wherein the desired system features defined for at least one vehicle in the fleet differ from the desired system features defined for at least one other vehicle in the fleet.
   4: A firmware for a vehicle comprising modular hardware components and ECUs, the firmware being generated automatically by an automated vehicle design tool by means of
selecting system functions to provide the vehicle with desired system features and modular software components to enable performing the system functions, and
creating a scheme of allocation of the modular software components on the ECUs to control the modular hardware components for performing the system functions.

The following optional sub-features are relevant to the Feature 1 clauses:
The automated vehicle design tool is configured for creating the scheme of allocation of the modular software components on the ECUs optimized in terms of a volume of network communications between the components and/or a use of computing resources of each ECU.
The modularity of the software components enables the automated vehicle design tool to select appropriate software components for each ECU in the vehicle, depending on a specification of said ECU and system functions to be performed by modular hardware components connected with said ECU.
The modular software components include software components of (i) an application layer and (ii) a basic software layer, or middleware layer, that insulates or separates the application layer from hardware specific features of an ECU and presents a standardised interface to the application layer.
The basic software layer provides one or more of: interface to the electrical or data values generated by the ECU; virtual communications bus; real-time scheduling of software components; data storage services; maintenance of non-volatile data; ECU fault diagnosis; cryptographically authenticate data.
At vehicle build time, an ECU is automatically provided with the firmware generated at the vehicle design time by the automated vehicle design tool.
The modular software components are reusable and designed to be atomic so that reusability can happen across different applications and different vehicles, including vehicles with different hardware topologies.
The modular software components are transferable as being allocatable to different ECUs because of the hardware abstraction provided by the basic software layer.
The modular software components are scalable and extensible as being automatically adaptable to different vehicle platforms.
The modular software components are independent as being designed to have minimal dependencies on other components.
The modular software components are configured to communicate with other software components either locally, within the same ECU, or via vehicle networks.
The modular software components are configured to enable unified or consistent monitoring and diagnostics of the vehicle systems.
The modular software components are configured to enable unified or consistent cybersecurity measures.
The modular software components are configured to enable unified or consistent updating procedures.
The automated vehicle design tool is configured to generate a firmware for a range of different vehicles with different system features [symbol] such as electric vans with different lengths and/or heights and/or battery capacity.
The automated vehicle design tool is configured to generate a firmware for different types of vehicles, including different types of electric vehicles, such as electric cars, vans, trucks, and buses.
The automated vehicle design tool is configured to send the firmware generated for a vehicle to a robotic production environment that produces or assembles the vehicle as designed by the automated vehicle design tool to enable provisioning the vehicle with the firmware in the robotic production environment.

Feature 8: Software Components Operation is Verified with Vehicle Builder.

1: A method of generating a firmware for a vehicle, comprising:
(i) an automated vehicle design tool (a) obtaining data on a vehicle hardware topology, the topology comprising modular hardware components and ECUs, and desired system features for the vehicle, (b) selecting system functions to provide the desired system features and modular software components to enable performing the system functions based on the data, and (c) creating a scheme of allocation of the modular software components on the ECUs to control the modular hardware components for performing the system functions;
(ii) the automated vehicle design tool (a) simulating an operation of the vehicle with the modular software components allocated on the ECUs to verify proper performance of the system functions, and (b) generating a firmware for the vehicle using the modular software components and the scheme of allocation of the same on the ECUs if the proper performance of the system functions is verified in the simulation.
2: A vehicle comprising modular hardware components and ECUs that has a firmware generated automatically by an automated vehicle design tool by means of
selecting system functions to provide the vehicle with desired system features and modular software components to enable performing the system functions, and creating a scheme of allocation of the modular software components on the ECUs to control the modular hardware components for performing the system functions,
wherein the firmware is generated by the automated vehicle design tool after simulating an operation of the vehicle with the modular software components allocated on the ECUs to verify proper performance of the system functions.
   3: A fleet of vehicles, each vehicle comprising modular hardware components and ECUs and having a firmware generated automatically by an automated vehicle design tool by means of selecting system functions to provide the vehicle with desired system features and modular software components to enable performing the system functions, creating a scheme of allocation of the modular software components on the ECUs to control the modular hardware components for performing the system functions, and simulating an operation of the vehicle with the modular software components allocated on the ECUs to verify proper performance of the system functions;
wherein an operator of the fleet defines the desired system features to be implemented in each individual vehicle in the fleet, wherein the desired system features defined for at least one vehicle in the fleet differ from the desired system features defined for at least one other vehicle in the fleet.
   4: A firmware for a vehicle comprising modular hardware components and ECUs, the firmware being generated automatically by an automated vehicle design tool by means of
selecting system functions to provide the vehicle with desired system features and modular software components to enable performing the system functions,
creating a scheme of allocation of the modular software components on the ECUs to control the modular hardware components for performing the system functions, and
simulating an operation of the vehicle with the modular software components allocated on the ECUs to verify proper performance of the system functions.

Feature 9: OTA Vehicle Firmware Provisioning

1: A method of provisioning a firmware to a vehicle, comprising:
(i) an automated vehicle design tool (a) obtaining data on a vehicle hardware topology, the topology comprising modular hardware components and ECUs, and desired system features for the vehicle, (b) selecting system functions to provide the desired system features and modular software components to enable performing the system functions based on the data, (c) creating a scheme of allocation of the modular software components on the ECUs to control the modular hardware components for performing the system functions, and (d) generating a firmware for the vehicle using the modular software components and the scheme of allocation of the same on the ECUs;
(ii) a software provisioning system (a) receiving the firmware generated by the automated vehicle design tool, and (b) provisioning the firmware to the vehicle by means of an over the air (OTA) update.
2: A vehicle comprising modular hardware components and ECUs that has a firmware provided via an over the air (OTA) update by a software provisioning system that is received the firmware from an automated vehicle design tool,
wherein the automated vehicle design tool is configured to generate the firmware by means of
(a) obtaining data on a vehicle hardware topology, the topology comprising modular hardware components and ECUs, and desired system features for the vehicle, (b) selecting system functions to provide the desired system features and modular software components to enable performing the system functions based on the data, (c) creating a scheme of allocation of the modular software components on the ECUs to control the modular hardware components for performing the system functions, and (d) generating the firmware for the vehicle using the modular software components and the scheme of allocation of the same on the ECUs.
   3: A fleet of vehicles, each vehicle comprising modular hardware components and ECUs and having a firmware provided via an over the air (OTA) update by a software provisioning system that is received the firmware from an automated vehicle design tool,
wherein the automated vehicle design tool is configured to generate the firmware by means of (a) obtaining data on a vehicle hardware topology, the topology comprising modular hardware components and ECUs, and desired system features for the vehicle, (b) selecting system functions to provide the desired system features and modular software components to enable performing the system functions based on the data, (c) creating a scheme of allocation of the modular software components on the ECUs to control the modular hardware components for performing the system functions, and (d) generating the firmware for the vehicle using the modular software components and the scheme of allocation of the same on the ECUs;
wherein an operator of the fleet defines the desired system features to be implemented in each individual vehicle in the fleet, wherein the desired system features defined for at least one vehicle in the fleet differ from the desired system features defined for at least one other vehicle in the fleet.

Feature 10: Performance Feedback Loop Enabled by Vehicle Firmware.

1: A method of monitoring a vehicle performance, comprising:
(i) automated vehicle design tool generating a firmware for a vehicle by means of selecting system functions to provide the vehicle with desired system features and modular software components to enable performing the system functions, and creating a scheme of allocation of the modular software components on the ECUs to control the modular hardware components for performing the system functions,
wherein the modular software components are configured to enable monitoring performance of the modular hardware components under their control and the respective system functions during ordinary use of the vehicle with the firmware and causing feedback data to be sent over a network to a vehicle analysis tool;
   (ii) the vehicle analysis tool analysing or using that feedback data, or data derived from that feedback data for one or more of: vehicle components health monitoring, predictive maintenance, and software updates.
   2: A vehicle comprising modular hardware components and ECUs that has a firmware generated automatically by an automated vehicle design tool by means of selecting system functions to provide the vehicle with desired system features and modular software components to enable performing the system functions, and creating a scheme of allocation of the modular software components on the ECUs to control the modular hardware components for performing the system functions,
wherein the modular software components are configured to enable monitoring performance of the modular hardware components under their control and the respective system functions during ordinary use of the vehicle with the firmware and causing feedback data to be sent over a network to a vehicle analysis tool configured for analysing or using that feedback data, or data derived from that feedback data for one or more of: vehicle components health monitoring, predictive maintenance, and software updates.
   3: A fleet of vehicles, each vehicle comprising modular hardware components and ECUs and having a firmware generated automatically by an automated vehicle design tool by means of selecting system functions to provide the vehicle with desired system features and modular software components to enable performing the system functions, and creating a scheme of allocation of the modular software components on the ECUs to control the modular hardware components for performing the system functions,
wherein the modular software components are configured to enable monitoring performance of the modular hardware components under their control and the respective system functions during ordinary use of the vehicle with the firmware and causing feedback data to be sent over a network to a vehicle analysis tool,
wherein the vehicle analysis tool is configured by an operator of the fleet for analysing or using that feedback data, or data derived from that feedback data for one or more of: vehicle components health monitoring, predictive maintenance, and software updates of the vehicles in the fleet,
wherein the operator of the fleet has defined the desired system features to be implemented in each individual vehicle in the fleet, wherein the desired system features defined for at least one vehicle in the fleet differ from the desired system features defined for at least one other vehicle in the fleet.

Appendix 1 Section C: The Arrival Cyber Security System

Feature 1: Vehicle with Proximity Sensor that Provides Vehicle Access

1: A vehicle access control system including a touch or proximity sensor [symbol] such as a capacitive touch sensor, integrated into an external surface of the vehicle and which triggers an unlocking of a vehicle door or other access only if (i) a wireless key, such as the one provided by a NFC fob or smartphone or other personal device, using Bluetooth, LTE or UWB communications, e.g. using PKE—passive keyless entry, approved for that vehicle is present sufficiently close to the sensor and (ii) the sensor is activated.

Optional Sub-Features:
The sensor is sensitive to the hand of a user.
The sensor is sensitive to a signal emitted by an electronic device (e.g., a phone or fob).
The sensor is sensitive to receive UWB signals and/or NFC signals.
The sensor is integrated into an exterior panel of the vehicle.
The exterior panel of the vehicle is formed from composite material.

Feature 2: Two-Way Verification or Authentication of Vehicle Components

1: A modular component of a vehicle comprising a plurality of electrical or electronical modular components each being part of a data-connected network and configured for two-way verification or authentication of itself and other modular components in the network,
wherein the modular component (i) is itself verified or authenticated, using a secure protocol, by another modular component in the network and (ii) is configured to verify or authenticate another modular component in the network.
   2: A vehicle including a plurality of electrical or electronical modular components each being part of a data-connected network and configured for two-way verification or authentication of itself and other modular components in the network,
wherein each of the modular components (i) is itself verified or authenticated, using a secure protocol, by another modular component in the network and (ii) is configured to verify or authenticate another modular component in the network.
   3: A fleet of vehicles, in which each vehicle includes a plurality of modular component each being part of a data-connected network and configured for two-way verification or authentication of itself and other modular components in the network,
wherein each modular component (i) is itself verified or authenticated, using a secure protocol, by another modular component in the network and (ii) is configured to verify or authenticate another modular component in the network;
and in which an operator of the fleet has defined security parameters that define at least one of: a number of modular software components in the network subject to the two-way verification or authentication; circumstances in which each of the modular components shall perform the two-way verification or authentication of itself and other modular components in the network; a time or frequency at which each of the modular components performs the two-way verification or authentication of itself and/or other modular components in the network; and restrictions of functionality that applied to modular components failed the two-way verification or authentication.

Feature 3: An Untrusted Vehicle Network

1: A vehicle comprising a plurality of electrical or electronical modular components each being part of a data-connected network, wherein the network is threated as untrusted so as all communications between the modular components in the network are encrypted, and each of the modular components is configured to not accept commands from other vehicle component in the network without verification or authentication of itself and/or the other vehicle component.
2: A fleet of vehicles, in which each vehicle includes a plurality of modular component each being part of a data-connected network, wherein the network is threated as untrusted so as all communications between the modular components in the network of each vehicle are encrypted, and each of the modular components of the vehicle is configured to not accept commands from other component in the network without verification or authentication of itself and/or the other vehicle component.

Feature 4: Distributed Verification or Authentication Components in a Vehicle

1: A modular component of a vehicle comprising a plurality of electrical or electronical modular components each being part of a data-connected network and configured for a joint verification or authentication of itself and other modular components in the network with other modular components in the network,
wherein the modular component (i) is itself verified or authenticated jointly by a group of other modular components in the network and (ii) is configured to participate in joint verification or authentication of another modular component with a group of other modular components in the network.
   2: A vehicle including a plurality of electrical or electronical modular components each being part of a data-connected network and configured for joint verification or authentication of itself and other modular components in the network,
wherein each of the modular components (i) is itself verified or authenticated jointly by a group of other modular components in the network and (ii) is configured to participate in joint verification or authentication of another modular component with a group of other modular components in the network.
   3: A fleet of vehicles, in which each vehicle includes a plurality of modular component each being part of a data-connected network and configured for joint verification or authentication of itself and other modular components in the network,
wherein each of the modular components (i) is itself verified or authenticated jointly by a group of other modular components in the network and (ii) is configured to participate in joint verification or authentication of another modular component with a group of other modular components in the network;
and in which an operator of the fleet has defined security parameters that define at least one of: a number of modular software components in the network subject to the joint verification or authentication; a minimum number of modular software components in the group to enable joint verification or authentication of another modular component; circumstances in which each of the modular components shall perform the joint verification or authentication of itself and other modular components in the network; a time or frequency at which each of the modular components performs the joint verification or authentication of itself and/or other modular components in the network; and restrictions of functionality that applied to modular components failed the joint verification or authentication.

Feature 5: Vehicle Components with Integrated Hardware Security Modules

1: A vehicle including a plurality of electrical or electronical modular components each being part of a data-connected network and having an integrated hardware security module (HSM) for verification or authentication of itself and other modular components in the network.
2: A fleet of vehicles, in which each vehicle includes a plurality of modular component each being part of a data-connected network and having an integrated hardware security module (HSM) for verification or authentication of itself and other modular components in the network.

Feature 6: Vehicle Security System with a Divided Secret

1: A vehicle including a plurality of electrical or electronical modular components, each being part of a data-connected network and provided with a unique part of secret key,
wherein each of the modular components is configured to participate in joint verification or authentication of itself or another modular component with a group of other modular components in the network by combining the unique parts of the secret key provided to the modular components of the group.
   2: A fleet of vehicles, in which each vehicle includes a plurality of electrical or electronical modular components, each being part of a data-connected network and provided with a unique part of secret key,
wherein each of the modular components is configured to participate in joint verification or authentication of itself or another modular component with a group of other modular components in the network by combining the unique parts of the secret key provided to the modular components of the group,
   wherein an operator of the fleet defines security parameters that define at least one of: a number of modular software components in the network subject to the joint verification or authentication with the secret key; a minimum number of modular software components in the group to enable joint verification or authentication of another modular component with the secret key; circumstances in which each of the modular components shall perform the joint verification or authentication of itself and other modular components in the network with the secret key; a time or frequency at which each of the modular components performs the joint verification or authentication of itself and/or other modular components in the network with the secret key; and restrictions of functionality that applied to modular components failed the joint verification.

Appendix 1 Section D: Creating a New Vehicle Design Using the Vehicle Builder Tool

Feature 1: Generic Robofacturing and Roboservices Workflow for any Device

1: A method of automated production of a device, comprising the following steps:
(i) an automated device design tool analysing a design for the device and planning an automated production of that device by selecting robotic services from a catalogue of available robotic services;
(ii) the automated device design tool sending data defining the production of the device to an automated robotic manufacturing environment;
(iii) the automated robotic manufacturing environment then producing, or controlling the production of, the device, by (a) using the data sent by the automated vehicle design tool and (b) using the selected robotic services.
2: A device made using an automated production process as defined above.

Optional Sub-Features:
robotic services are the services available from all agents in the automated robotic manufacturing environment.
services include any of the following, in relation to a component or item: storing; retrieving; moving; delivering; gripping; rotating; pick and placing; assembling; gluing;
inserting; joining; welding; any other handling operation.
agents include: fixed robots (e.g. with 6 degrees of freedom); and mobile robots or AMRs.
agents include: fixed robots; and mobile robots or AMRs, and humans equipped with wireless information terminals.
different fixed robots each have specialised end-effectors for providing specific robotic services.
robotic services are defined by an extensible and standardised list or schema of capabilities, enabling any supplier to provide services for the automated robotic manufacturing environment, provided that those services conform to the list or schema of capabilities.
the device is a vehicle.
the automated device design tool is configured to enable a range of different vehicles to be designed.
the automated device design tool is configured to enable vehicles to be designed that specifically meet a customer's (e.g. B2B customer) set of requirements.
the automated device design tool analyses a design for the vehicle and plans an optimal, automated production of that vehicle using the catalogue of available robotic services.
robotic services are used in the automated robotic manufacturing environment to perform actions on components that are each optimised for robotic handling.

Feature 2: Robofacturing Vehicle Workflow with Performance Feedback Loop

1: A method of improving the design of a vehicle, including the following steps:
(i) an automated device design tool analysing a design for the vehicle and planning an optimal, automated production of that vehicle;
(ii) the automated device design tool sending data defining the production of the vehicle to an automated robotic manufacturing environment, the vehicle including components that are configured to monitor their performance;
(iii) the automated robotic manufacturing environment then producing, or controlling the production of, the vehicle, using the data sent by the automated vehicle design tool;
(iv) the components automatically monitoring their performance during ordinary use and sending feedback data;
(v) the automated device design tool analysing or using that feedback data, or data derived from that feedback data for one or more of the following purposes: to improve the design of future vehicles; for predictive maintenance and component swap-outs; for rapid identification of faults and their source; for A/B testing; for supplier feedback.
2: A vehicle designed using the above method, each vehicle including a vehicle component that is configured for automatically monitoring its performance during ordinary use and sending feedback data to an automated device design tool that analyses or uses that feedback data, or data derived from that feedback data for one or more of the following purposes: to improve the design of future vehicles; for predictive maintenance and component swap-outs; for rapid identification of faults and their source; for A/B testing; for supplier feedback.
3: A fleet of vehicles, each vehicle including a vehicle component that is configured for automatically monitoring its performance during ordinary use and sending feedback data to an automated device design tool that analyses or uses that feedback data, or data derived from that feedback data for one or more of the following purposes: to improve the design of future vehicles; for predictive maintenance and component swap-outs; for rapid identification of faults and their source; for A/B testing; for supplier feedback;
and in which an operator of the fleet defines a specific set of requirements it has for one or more vehicles in the fleet, and those requirements are used by the automated vehicle design tool, when selecting which vehicle components are used in vehicles in the fleet.

Optional Sub-Features
as Feature 1

Feature 3: Generic Robofacturing Workflow with Device Builder Front End

1: A method of designing and assembling a device, with the following steps:
(i) an automated device design tool accessing data that defines a range of components, each optimised for robotic assembly, and then automatically selecting and generating a list of the components that optimally meet requirements, such as customer requirements;
(ii) the automated device design tool sending the list of selected components to an automated robotic manufacturing environment;
(iii) the automated robotic manufacturing environment then assembling, or controlling the assembly of, the device, using the component list sent by the automated vehicle design tool.
2: A device designed and assembled using the above method.

Optional Sub-Features:
device is one of the following: small passenger car, large passenger car, small van, large van, specialist vans, truck and lorries of different lengths and capacities, buses of different lengths and capacities
automated device design tool is configured to design any of the following: small passenger car, large passenger car, small van, large van, specialist vans, truck and lorries of different lengths and capacities, buses of different lengths and capacities
automated robotic manufacturing environment is configured to assemble at least one of the following: small passenger car, large passenger car, small van, large van, specialist vans, truck and lorries of different lengths and capacities, buses of different lengths and capacities
automated robotic manufacturing environment is configured to assemble several of the following: small passenger car, large passenger car, small van, large van, specialist vans, truck and lorries of different lengths and capacities, buses of different lengths and capacities.
automated robotic manufacturing environment implement semantic (ontology driven) decision making; self-learning and be self-controlled

Feature 4: Vehicle Robofacturing Workflow with Vehicle Builder Front End

1: A method of designing and assembling a vehicle, with the following steps:
(i) an automated vehicle design tool accessing data that defines a range of modular hardware components, each optimised for robotic assembly, and a range of modular software components, and then selecting and generating a list of the modular hardware and modular software components that meet customer specified requirements;
(ii) the automated vehicle design tool sending the list of selected modular hardware and modular software components to an automated robotic manufacturing environment;
(iii) the automated robotic manufacturing environment then assembling, or controlling the assembly of, the vehicle, using the modular hardware and modular software component list sent by the automated vehicle design tool.
2: A vehicle including modular hardware components, each optimised for robotic assembly, and modular software components, selected by an automated vehicle design tool to meet customer specified requirements; and where the vehicle has been assembled in an automated robotic manufacturing environment using the selected modular hardware components, and modular software components.
3: A fleet of vehicles, each vehicle including modular hardware components, each optimised for robotic assembly, and modular software components, selected by an automated vehicle design tool to meet customer specified requirements;
and where the vehicle has been assembled in an automated robotic manufacturing environment using the selected modular hardware components, and modular software components;
and in which an operator of the fleet has defined a specific set of requirements it has for one or more vehicles in the fleet, and those requirements have been used by the automated vehicle design tool, when selecting which modular hardware components modular software components are to be used in vehicles in the fleet.

Optional Sub-Features:
the automated vehicle design tool includes a user interface that accepts inputs defining customer specified requirements.
the automated vehicle design tool automatically selects optimal hardware and/or software components that meet the customer specified requirements.
the automated vehicle design tool automatically designs a wiring plan or schematic for the selected hardware components.
the automated vehicle design tool automatically designs a software installation plan for the selected software components.
the automated vehicle design tool automatically designs a software installation plan for installing various selected software components in various selected hardware component.
the automated vehicle design tool accesses data defining vehicle structural (e.g. chassis) and non-structural (e.g. panel) elements.
the automated vehicle design tool creates a custom vehicle design which matches a customer's specific requirements.
the automated vehicle design tool displays all selected features, together with features inherited from these features, and then assigns components to perform all of these features and lists name, supplier, model number, weight, voltage, interfaces, documentation for each component.
the automated vehicle design tool automatically generates a connection plan that connects the components to the appropriate IO modules through an algorithm that automatically computes the number and type of modules, optimised in terms of required pin types and cost.
the automated vehicle design tool automatically fills out all pinouts with the components pins according to the pin specifications and component locations.
the automated vehicle design tool completes and stores the entire wiring specification.
the automated vehicle design tool stores the complete dataset defining the vehicle and supplies it to an automated inventory ordering and logistics systems, supplies and robotic manufacturing systems.
the intended use or location of the vehicle, or any other use or environmental input parameter affecting the optimal design, configuration or component choice of that vehicle, is fed to the automated vehicle design tool, and components, features, settings or other parameters that are optimal for that vehicle, are automatically selected by the automated vehicle design tool.
a data analytics engine is programmed to decide on the optimal design, configuration or component choices for the vehicle, based on data returned from in-the-field vehicles, and that optimal design, configuration or component choice is provided to the data to automated vehicle design tool.
the automated robotic manufacturing environment is configured to determine by itself, dynamically, (i) what steps to perform, (ii) when to perform those step, (iii) by what agents, including both robotic agents and also non-robotic agents, those steps should be performed and (iv) how those agents are to interact with each other to build or assemble a vehicle.
the automated robotic manufacturing environment operates with no pre-defined Takt time.
the automated robotic manufacturing environment includes robotic agents that are organised as a group of cells, each cell with no more than 10 fixed robots, served by AMRs (autonomous mobile robots), and the group of cells works together to assemble substantially an entire, complete vehicle.
the automated robotic manufacturing environment is sited in a factory that hosts at least the robotic agents of the robotic manufacturing environment, and is less than 100,000 square meters in area, and preferably between 10,000 and 50,000 square meters

Feature 5: Vehicle Builder Tool

1: A method of designing a vehicle including the steps of:
A. an automated vehicle design tool accessing data defining (i) a unified hardware platform that defines the physical dimensions and the power and data interfaces for a range of modular hardware components (ii) a unified software platform that defines a range of available software components;
B. the automated vehicle design tool receiving customer requirements for a new vehicle;
C. the automated vehicle design tool automatically selecting optimal hardware and/or software components to meet those customer requirements.
2: An automated vehicle design tool system for designing a vehicle, in which:
A. the automated vehicle design tool accesses data defining (i) a unified hardware platform that defines the physical dimensions and the power and data interfaces for a range of hardware components and (ii) a unified software platform that defines a range of software components;
B. the automated vehicle design tool receiving customer requirements for a new vehicle;
C. the automated vehicle design tool automatically selecting optimal hardware and/or software components to meet those customer requirements.
3: A vehicle including hardware and software components, selected by an automated vehicle design tool to meet customer requirements.
4: A fleet of vehicles, each vehicle including hardware and software components, selected by an automated vehicle design tool to meet customer requirements;
and in which an operator of the fleet has defined a specific set of requirements it has for one or more vehicles in the fleet, and those requirements have been used by the automated vehicle design tool, when selecting which hardware and software components are to be used in vehicles in the fleet.

Optional Sub-Features:
the automated vehicle design tool automatically designs a wiring plan or schematic for the selected hardware components.
the automated vehicle design tool automatically designs a software installation plan for the selected software components.
the automated vehicle design tool automatically designs a software installation plan for installing various selected software components in various selected hardware component.
the automated vehicle design tool automatically designs a vehicle with an optimised selection and arrangement from the unified hardware platform and from the unified software platform.
the automated vehicle design tool accesses data defining all vehicle structural (e.g. chassis) and non-structural (e.g. panel) elements.
the automated vehicle design tool enables custom vehicle design which matches a customer's requirements.
the automated vehicle design tool displays all selected features, together with features inherited from these features, and then assigns components to perform all of these features and lists name, supplier, model number, weight, voltage, interfaces, documentation for each component.
the automated vehicle design tool automatically generates a connection plan that connects the components to the appropriate IO modules through an algorithm that automatically computes the number and type of modules, optimised in terms of required pin types and cost.
the automated vehicle design tool automatically fills out all pinouts with the components pins according to the pin specifications and component locations.
the automated vehicle design tool completes and stores the entire wiring specification.
the automated vehicle design tool stores the complete dataset defining the vehicle and supplies it to an automated inventory ordering and logistics systems, supplies and robotic manufacturing systems.
the intended use or location of the vehicle, or any other use or environmental input parameter affecting the optimal design, configuration or component choice of that vehicle, is fed to the automated vehicle design tool, and components, features, settings or other parameters that are optimal for that vehicle, are automatically selected by the automated vehicle design tool.
a data analytics engine is programmed to decide on the optimal design, configuration or component choices for the vehicle, based on data returned from in-the-field vehicles, and that optimal design, configuration or component choice is provided to the data to automated vehicle design tool.
the automated robotic manufacturing environment is configured to determine by itself, dynamically, (i) what steps to perform, (ii) when to perform those step, (iii) by what agents, including both robotic agents and also non-robotic agents, those steps should be performed and (iv) how those agents are to interact with each other to build or assemble a vehicle.
the automated vehicle design tool sends instructions out to a robotic manufacturing environment that is configured to assemble a complete vehicle using the selected hardware and software components.
the automated vehicle design tool stores and uses data relating to modular vehicle components
   the vehicle component is modular or standardised by virtue of having a size that conforms to regular size intervals and is part of a family of other types of components, all with sizing that also conforms to the same size intervals.
   the vehicle component is modular or standardised by virtue of being part of a family of other types of components, all being configured to be positioned or installed in the vehicle in a regular, rectilinear grid or installation pattern.
   the vehicle component is modular or standardised by virtue of being part of a family of other types of components, all having external casing feature or features that are optimised for robotic handling, installation or assembly, such as autonomous robotic handling, installation or assembly
   the vehicle component is modular or standardised by virtue of being part of a family of other types of components, all having the same overall box shape, the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.
   the vehicle component is modular or standardised by virtue of being part of a family of other types of components, all designed for an installation path to a final position, in which the installation path is optimised for robotic handling, installation or assembly, such as autonomous robotic handling, installation or assembly.
   the vehicle component is modular or standardised by virtue of being part of a family of other types of components, that each use the same, standardised physical installation systems, that are each optimised for robotic handling and use
   the vehicle component is modular or standardised by virtue of being part of a family of other types of components, that each use the same, standardised identification system that gives each individual component a unique identification that is (i) computer readable; and (ii) enables each individual component to be tracked from initial manufacture to initial installation, and subsequent servicing and end-of-life.
   the vehicle component is modular or standardised by virtue of being part of a family of other types of components, all optimised for robotic computer vision recognition and/or optimised for radiant heat dissipation, by virtue of being substantially black in colour.
the automated robotic manufacturing environment operates with no pre-defined Takt time.
the automated robotic manufacturing environment includes robotic agents that are organised as a group of cells, each cell with no more than 10 fixed robots, served by AMR (autonomous mobile robots), and the group of cells works together to assemble substantially an entire, complete vehicle.
the automated robotic manufacturing environment is sited in a factory that hosts at least the robotic agents of the robotic manufacturing environment, and is less than 100,000 square meters in area, and preferably between 10,000 and 50,000 square meters.

Feature 6: Components Suitable for Vehicle Builder

1: A vehicle component that is modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power.
2: A vehicle including components that are modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power.
3: A fleet of vehicles, each vehicle including components that are modular by virtue of being part of a family of other types of components, all being tested and pre-integrated with each other, and which are each described by data used by an automated vehicle design tool that is configured to (i) automatically design a vehicle including that component, and other components from that family of components, and to (ii) automatically generate an optimised data and power connection plan for all components that send or receive data and/or use power; and in which an operator of the fleet has defined a specific set of requirements it has for one or more vehicles in the fleet, and those requirements have been used by the automated vehicle design tool, when selecting which hardware and software components are to be used in vehicles in the fleet.

Optional Sub-Features
automated vehicle design tool that is configured to automatically generate an optimised physical layout plan in the vehicle for all components
By using the grid size as bounds for production geometry, spaces left for components will never be too small, and components will never be too large.

Feature 7: Vehicle Builder: Wiring Plan

1: A method of designing and assembling a vehicle, with the following steps:
(i) an automated vehicle design tool accessing data that defines a range of components, including ECUs, and then selecting and generating a list of the components that meet customer specified requirements;
(ii) the automated vehicle design tool then using a wiring algorithm to automatically design a wiring plan or schematic for the components.
2: A method of designing and assembling a vehicle, with the following steps:
(i) an automated vehicle design tool accessing data that defines a range of components, including ECUs, and then selecting and generating a list of the components that meet customer specified requirements;
(ii) the automated vehicle design tool then using a wiring algorithm to automatically design a wiring plan or schematic for the components along with configurations of vehicle networks.
3: A vehicle including components, and each selected by an automated vehicle design tool to meet customer requirements;
where the components are linked by a wiring network designed by a wiring algorithm that is used by, or is part of, the automated vehicle design tool.
   4: A fleet of vehicles, each vehicle including components selected by an automated vehicle design tool to meet customer requirements;
where the components are linked by a wiring network designed by a wiring algorithm that is used by, or is part of, the automated vehicle design tool.
and in which an operator of the fleet has defined a specific set of requirements it has for one or more vehicles in the fleet, and those requirements have been used by the automated vehicle design tool, when selecting which components are to be used in vehicles in the fleet.

Optional Sub-Features
the wiring plan is an optimised plan for connecting the hardware components to a vehicle data or message bus, such as a CAN bus.
the wiring plan is an optimised plan for connecting hardware components to vehicle ECUs.
the wiring algorithm arranges or distributes software modules across the ECUs in an optimized way.
the wiring algorithm calculates the network load and computing capacity for an arrangement of ECUs, software modules and wiring.
the wiring algorithm optimises the following: network load; software module capacity;
and wiring length.
the wiring plan includes connections to ECUs or, equivalently, I/O modules, including assigning pins in the ECU modules and hardware components.
wiring plan defines a firmware configuration for the ECU modules, taking into account the pin allocation.
each pin is described with parameters (such as voltage, current, direction, connection type) and function (e.g. Left High Beam Lamp or Front EC Water temp).
the wiring algorithm takes as inputs: list of hardware components, including modules which themselves include various hardware components; physical layout or position in the vehicle of these components.
the wiring algorithm takes as inputs: list of available ECU modules.
the wiring algorithm evaluates one or more of the following: the optimal types of ECU modules; the optimal assignment of component pins to I/O module pins; the optimal position of ECU modules in the vehicle.
the wiring algorithm sequentially evaluates the following: the optimal types of ECU modules; the optimal assignment of component pins to ECU module pins; the optimal position of ECU modules in the vehicle.
the optimal types of ECU modules is determined using a constraint programming solution to a combinatorial optimisation problem.
the optimal assignment of component pins to ECU module pins is treated as a constrained clustering or minimal-cost flow problem to solve for the shortest total wire length.

Feature 8: Cost Optimised Evaluation of Robotic Assembly

1: A method of assembling a vehicle, in which a software implemented tool evaluates a total cost of assembly for one or multiple components and evaluates multiple different robotic assembly process and/or robotic services, taking into account: the number of robotic services operations, the time taken to complete the robotic services operations, where errors may occur and any other actions involved to give feedback on a total cost of assembly; and the tool then generates an optimal robotic assembly process.
2: A vehicle assembled using robotic assembly processes and/or robotic services that have been selected by a software implemented tool that has evaluated a total cost of assembly for one or multiple components and has evaluated multiple different robotic assembly process and/or robotic services, taking into account: the number of robotic services operations, the time taken to complete the robotic services operations, where errors may occur and any other actions involved to give feedback on a total cost of assembly; and the tool then generates an optimal robotic assembly process.
3: A fleet of vehicles, each vehicle assembled using robotic assembly processes and/or robotic services that have been selected by a software implemented tool that has evaluated a total cost of assembly for one or multiple components and has evaluated multiple different robotic assembly processes and/or robotic services, taking into account: the number of robotic services operations, the time taken to complete the robotic services operations, where errors may occur and any other actions involved to give feedback on a total cost of assembly; and the software tool then generates an optimal robotic assembly process;
and in which an operator of the fleet has defined a specific set of requirements it has for one or more vehicles in the fleet, and those requirements have been used by the software implemented tool when selecting which robotic assembly processes and/or robotic services are to be used when assembling vehicles in the fleet.

Optional Sub-Features:
robotic assembly evaluation process takes into account which process involves: Fewer unique robotic services operations; Fewer robotic services operations overall; fewer connection points to define in D2R; Combined operations (integrated functions, such as cooling pipes in casting).
robotic assembly evaluation process takes into account which processes involves engaging parts with a single vector of movement.
robotic assembly evaluation process takes into account which processes permit alignment to be determined through force/torque sensor feedback on the robots.
robotic assembly evaluation process takes into account which processes co-ordinate or match grasping certainty axis with direction of insertion and connection features.
robotic assembly evaluation process takes into account which processes permit sequential bottom-up build operations that avoid parallel operations.
robotic assembly evaluation process takes into account which processes permit positioning components first and then fixing them in place.
robotic assembly evaluation process takes into account which processes avoid moving large or heavy assemblies.
robotic assembly evaluation process takes into account the assembly force required.

Feature 9: Automated E/E Design for a Vehicle with Vehicle Builder

1: A method of designing a vehicle, wherein an automated vehicle design tool is used for:
(a) obtaining data on a vehicle hardware topology, the topology comprising modular hardware components, and desired system features of the vehicle,
(b) determining system functions and a set of ECUs required to provide the desired system features in the vehicle based on the data,
(c) assigning pins of the modular hardware components to pins of the ECUs,
(d) defining an arrangement of the ECUs in the vehicle and a wiring plan to connect the modular hardware components with the ECUs based on the assignment of the pins,
(e) selecting modular software components to enable performing the system functions and allocating the modular software components on the ECUs, and
(f) defining a networks configuration for the vehicle to enable communications of the modular software components allocated on different the ECUs with each other as required for performing the system functions with providing the desired system features.

Optional Sub-Features:
The automated vehicle design tool includes a user interface (UI) that accepts inputs defining customer's requirements for the vehicle including the desired system features.
The automated vehicle design tool is configured for determining the required set of ECUs optimized in terms of a number and/or costs of the ECUs.
The automated vehicle design tool is configured for determining the required set of ECUs by solving a combinatorial optimization problem (COP) with a constraint programming approach.
The automated vehicle design tool is configured for assigning the pins and defining the arrangement of the ECUs in a way optimized in terms of a length of wiring harness required to connect the modular hardware components with the ECUs.
The automated vehicle design tool is configured for assigning the pins by solving a constrained clustering or minimal-cost flow problem.
The modular software components are allocated on the ECUs in accordance with their specifications to match the ECUs' type and parameters.
The modular software components are allocated on the ECUs to match Automotive Safety Integrity Level (ASIL) of the software components, of the system features and functions and of the ECUs.
The automated vehicle design tool is configured for defining the networks configuration optimized in terms of network loads.
The automated vehicle design tool is configured for defining the networks configuration in which high ASIL communications are separated from low ASIL communications.
The automated vehicle design tool is configured to access to and use data from libraries of modular hardware components and modular software components.
The automated vehicle design tool is configured to display all desired system features, together with functions inherited from the features and modular hardware components required to perform all the functions and provide the features, and to list parameters of each modular hardware component such as name, supplier, model number, weight, voltage, interfaces etc.
The automated vehicle design tool is configured to complete and store the entire wiring specification of the vehicle.

Feature 10: Vehicle Robofacturing Workflow with Vehicle Builder Front End

1: A method of producing a vehicle in a robotic production environment, comprising:
(i) an automated vehicle design tool (a) obtaining data on a vehicle hardware topology, the topology comprising modular hardware components, and desired system features of the vehicle, (b) determining system functions and a set of ECUs required to provide the desired system features in the vehicle based on the data, (c) defining an arrangement of the ECUs in the vehicle and a wiring plan to connect the modular hardware components with the ECUs, and (d) defining a networks configuration for the vehicle to enable communications of the modular hardware components with each other as required for performing the system functions with providing the desired system features;
(ii) the automated vehicle design tool sending the wiring plan and the network configuration to an operations control system of an autonomous production environment;
(iii) the operations control system controls the autonomous production environment for producing the vehicle in accordance with the wiring plan and the network configuration.

Optional Sub-Features
The autonomous production environment includes robotic agents that are organized as a group of workcells, each workcell with up to 10 fixed robots, served by autonomous mobile robots (AMRs), wherein the group of workcells operate together to produce or assemble substantially an entire, complete vehicle.
The autonomous production environment is sited in a factory that hosts at least the robotic agents of the autonomous production environment, and is less than 100,000 square meters in area, preferably between 10,000 and 50,000 square meters.

Appendix 1 Section E: Robofacturing: Robotic Data-Driven Continuous Delivery Production

Feature 1: Multi-Agent Robotic Production Environment

1: A robotic production environment comprising a plurality of agents, each agent providing one or more abilities consisting of separate actions performed by agents using resources available at the robotic production environment, wherein one ability can be provided by different agents including robotic agents, human agents, and virtual entities.

Feature 2: Robotic Production Environment Control Through a Shared Global Memory

1: A robotic production environment comprising a plurality of agents, each agent providing one or more abilities consisting of separate actions performed by agents using resources available at the robotic production environment, wherein one ability can be provided by different agents including robotic agents, human agents, and virtual entities,
wherein the robotic production environment further comprises a structured, shared global memory, called Blackboard, storing data about all agents, abilities, and resources of the robotic production environment that is dynamically updated by agents, abilities, and an operations control system of the robotic production environment, and
wherein the robotic production environment operations control and management is conducted through writing to and/or reading data from Blackboard.

Feature 3: Robotic Production Environment with Abilities that Read Data from and/or Write Data to Blackboard

1: A robotic production environment comprising a plurality of agents, each agent providing one or more abilities consisting of separate actions performed by agents using resources available at the robotic production environment, wherein one ability can be provided by different agents including robotic agents, human agents, and virtual entities,
wherein the robotic production environment further comprises an operations control system that operates abilities that are configured for reading data from and/or writing data to a structured, shared global memory of the robotic production environment, called Blackboard.

Feature 4: Logic Programming Language for Robotics Process Management and Control

1: A programming language for robotics process management and control that is designed as a logic process language supporting both data and control flows and decision making based on logic rules.
2: A programming language for robotics process management and control that provides, by its design, for canonical data description of any robotic production process enabling all participants of any interaction in a robotic production environment to use a single form of data and unambiguously recognize the context of the interaction.
3: A programming language for robotics process management and control that is designed for describing an operation by means of a program comprising rules for the operation execution in a robotic environment, wherein the program contains all necessary information about rules, their parameters, an order of execution and any conditions of execution of the operation.
4: A programming language for robotics process management and control that is designed for describing an operation by means of a program comprising rules for the operation execution in a robotic environment, wherein the program is configured to cause the operation to read data from Blackboard as input parameter(s) and/or write data to Blackboard as output parameter(s) of the operation.
5: A programming language for robotics process management and control that is designed for describing a complex operation by means of a program comprising rules for the complex operation execution in a robotic environment, wherein the program comprises preconditions setting conditions that must be satisfied before the execution of the complex operation, wherein the preconditions are configured to enable selecting alternative abilities or operations defined by the rules during the execution of the complex operation by an Execution Engine.
6: A programming language for robotics process management and control that is designed for describing an operation by means of a program comprising rules for the operation execution in a robotic environment, wherein the program comprises preconditions setting conditions that must be satisfied before the execution of the operation, wherein the preconditions are configured to describe how to find a specific structure or a value in Blackboard to enable the operation checking if Blackboard has a required data or if a particular field has a required value.
7: A programming language for robotics process management and control that is designed for describing a complex operation by means of a program comprising rules for the complex operation execution in a robotic environment, wherein the program comprises preconditions setting conditions that must be satisfied before the execution of the complex operation, wherein the preconditions are configured to comprise logical operators to define what condition(s) among the conditions must be satisfied before the execution of the complex operation.
8: A programming language for robotics process management and control that is designed for describing a complex operation by means of a program comprising rules for the complex operation execution in a robotic environment, wherein the program comprises a parent operation that comprises one or more other abilities or operations that are children of the parent operation, wherein the parent operation comprises the same child ability or operation twice or more times.
9: A programming language for robotics process management and control that is designed for describing a complex operation by means of a program comprising rules for the complex operation execution in a robotic environment, wherein the program comprises a parent operation that comprises one or more other abilities or operations that are children of the parent operation, wherein each rule is a signature of a child ability or operation in the description of its parent operation, and each rule comprises parameters and definitions of the parameters of the child ability or operation.
10: A programming language for robotics process management and control that is designed for describing an operation by means of a program comprising rules for the operation execution in a robotic environment, wherein the program comprises a description of an order in which rules must be executed.
11: A programming language for robotics process management and control that is designed for describing an operation by means of a program comprising rules for the operation execution in a robotic environment, wherein the program comprises a constraint defining a condition that must be fulfilled to execute the operation including one or more of requirements for agents and/or resources required for the execution.
12: A programming language for robotics process management and control that is designed for describing an operation by means of a program comprising rules for the operation execution in a robotic environment, wherein the program comprises a constraint defining a condition that must be fulfilled to execute the operation including a reference to a description of a rule to which the constraint is applied.

Feature 5: Autonomous Production Based on Robotic Services

1: A robotic production environment that is configured to autonomously produce a product by using a set of robotic services each being a combination of manpower, hardware and software components working together and integrated with OCS of the robotic production environment to perform a certain set of atomic operations on certain tangible and/or intangible objects.
2: A robotic service description comprising an operation sequence description that contains one or more operation steps, wherein the description comprises resources required for execution each of the operation steps so as a cost of certain step or of the whole operation can be calculated.
3: A robotic service description comprising an operation sequence description that contains one or more operation steps, wherein the description comprises a layout of the service defining a template for creation of a workcell implementing the service.
4: A robotic service description comprising an operation sequence description that contains one or more operation steps, wherein the description is configured for enabling a simulation of the operation sequence execution in a workcell to prove the operation steps feasibility and determine KPIs of the same.

Feature 6: Robotic Production Environment Design and Simulation in One System

1: A system for automated design of robotic production environment layouts,
the system being configured for:
generating a robotic production environment layout based on a Robofacturing Bill of Materials (rBOM) that describe a process of production of a product of given design, including data about robofacturing services, equipment, resources, and time required for the production, and
creating a virtual twin of the robotic production environment using the microfactory layout, and
simulating the production of the product by the virtual twin.
   2: An automated system for designing robotic robotic production environment layouts,
the system being configured for:
iteratively generating a plurality of possible robotic production environment layouts based on a Robofacturing Bill of Materials (rBOM) that describe a process of production of a product of given design, including data about robofacturing services, equipment, resources, and time required for the production,
simulating the production process in a virtual robotic production environment using each of plurality of possible robotic production environment layouts to define KPIs associated with the plurality of possible robotic production environment layouts, and
selecting or generating an optimal robotic production environment layout based on the KPIs' analysis.
   3: An automated system for designing robotic production environment layouts,
the system being configured for:
generating a robotic production environment layout based on a Robofacturing Bill of Materials (rBOM) that describe a process of production of a product of given design, including data about robofacturing services, equipment, resources, and time required for the production of the product in the robotic production environment,
simulating the production process in a virtual robotic production environment using each of plurality of possible robotic production environment layouts to define KPIs associated with the plurality of possible robotic production environment layouts,
   selecting or generating an optimal layout based on the KPIs' analysis, and
generating a Factory Control Model comprising instructions that can be used by an Operations Control System of a robotic production environment with the optimal layout for implementing the production process.
   4: An automated or semi-automated system for creating a Robofacturing Bill of Materials (rBOM) that describe a process of production of a product of given design, including data about robofacturing services, equipment and time required for the production,
wherein the system is configured to provide a feedback on robofacturing feasibility and costs of producing the product, its part or subassembly.

Feature 7: Dynamic Operations Control in a Robotic Production Environment Through an Execution Graph

1: An operations control system of a robotic production environment, configured for:
building a common Factory Control Model (FMC) in the form of a production graph, using a robotic production environment layout and the production process description including Robofacturing Bill of Materials (rBOM), and
dynamically choosing agents for performing operations of the production process be means of runtime execution of operations from the production graph.

Optional Sub-Features:
The production graph is reversed before its runtime execution.
The production graph is written on Blackboard
The production graph is continuously updated during its runtime execution by means of writing data on state of a robotic environment of the robotic production environment to Blackboard.

Appendix 1 Section F: The Arrival Microfactory

The Arrival robotic production environment defined in this Appendix 1 Section F may use the hardware modularity Features and related optional sub-features described in Appendix 1 Section A; may use the software modularity Features and related optional sub-features described in Appendix 1 Section B; may use the security architecture Features and related optional sub-features described in Appendix 1 Section C; may use the Arrival Technology Platform Features and related optional sub-features described in Appendix 1 Section D; may use the Robofacturing Features and related optional sub-features described in Appendix 1 Section E; may assemble and install the battery modules and flexible PCB connector Features and related optional sub-features described in Appendix 1 Section G; may assemble the van, bus and car vehicles with Features and related optional sub-features described in Appendix 1 Section I, J and K.

Feature 1: Microfactory Making Composite Panels and Assembling Complete Vehicles

1. A vehicle robotic production environment, in which the environment hosts robotic agents that are organised as groups of cells, each cell with no more than 10 robots, served and (i) one group of cells is responsible for one or more stages in transforming fabric into vehicle composite panels and other parts, eliminating the need for steel panel pressing equipment; (ii) other cells assemble at least portions of a vehicle together, and each cell is served by AMRs (autonomous mobile robots), eliminating the need for a moving production line in the production environment.
2: A robotic production cell for vehicle production, comprising no more than 10 robots, and (i) the cell is responsible for one or more stages in transforming fabric into vehicle composite panels and other parts, eliminating the need for steel panel pressing equipment; or (ii) the cell is responsible for assembling at least portions of a vehicle together, and the cell is served by AMRs (autonomous mobile robots), eliminating the need for a moving production line in the factory.
3: A robotic vehicle production method, in which robotic agents are organised as groups of cells, each cell with no more than 10 robots, and the method includes the steps of (i) one group of cells transforming fabric into vehicle composite panels and other parts, eliminating the need for steel panel pressing equipment; (ii) other cells assembling at least portions of a vehicle together, and the cells are served by AMRs (autonomous mobile robots), eliminating the need for a moving production line in the factory.
4: A vehicle assembled in a robotic production environment, in which the environment hosts robotic agents that are organised as groups of cells, each cell with no more than 10 robots, and (i) one group of cells is responsible for one or more stages in transforming fabric into vehicle composite panels and other parts, eliminating the need for steel panel pressing equipment; (ii) other cells assemble at least portions of a vehicle together, and the cells are served by AMRs (autonomous mobile robots), eliminating the need for a moving production line in the production environment.
5: A fleet of vehicles, each vehicle assembled in a robotic production environment, in which the environment hosts robotic agents that are organised as groups of cells, each cell with no more than 10 robots, and (i) one group of cells is responsible for one or more stages in transforming fabric into vehicle composite panels and other parts, eliminating the need for steel panel pressing equipment; (ii) other cells assemble at least portions of a vehicle together, and the cells are served by AMRs (autonomous mobile robots), eliminating the need for a moving production line in the production environment;
and in which an operator of the fleet has defined a specific set of requirements it has for one or more vehicles in the fleet, and those requirements have been used in the robotic production environment to assemble each of the vehicles in the fleet.

Feature 2: Robotic Cell-Based Factory Designed by Simulation Tool

1. A robotic production environment comprising a number of robotic production cells for vehicle production, each cell comprising a group (e.g. 2 to 10, but typically 4 to 6) of robots that are programmed to assemble, using robotic services, at a fixed location and not a moving production line, at least part of the vehicle by joining together multiple, modular components designed or selected for robotic production, handling or assembly;
and in which the layout or arrangement of cells in the environment has been designed by an automated simulation tool which takes into account parameters including: production cost; production time; production quality; component availability; use of AMRs to transport components and sub-assemblies.
   2: A robotic production cell for vehicle production, the cell comprising a group (e.g. 2 to 10, but typically 4 to 6) of robots that are programmed to assemble, using robotic services, at a fixed location and not a moving production line, at least part of the vehicle by joining together multiple, modular components designed or selected for robotic production, handling or assembly;
and in which the layout or arrangement of the cell in a production environment has been designed by an automated simulation tool which takes into account parameters including: production cost; production time; production quality; component availability; use of AMRs to transport components and sub-assemblies.
   3: A vehicle assembled in a robotic production environment, in which the layout or arrangement of a cell in the production environment has been designed by an automated simulation tool which takes into account parameters including: production cost; production time; production quality; component availability; use of AMRs to transport components and sub-assemblies;
and in which the cell comprises a group (e.g. 2 to 10, but typically 4 to 6) of robots that are programmed to assemble, using robotic services, at a fixed location and not a moving production line, at least part of the vehicle by joining together multiple, modular components designed or selected for robotic production, handling or assembly.

B. Building the Arrival Microfactory

Feature 3: Microfactory Under 25,000 m²

1. A robotic production environment that is configured to assemble vehicles, in which the environment (i) hosts robotic agents that are organised as groups of cells, each cell with no more than 10 fixed robots, served by AMRs (autonomous mobile robots), and each cell is responsible for production or assembly of at least portions of a vehicle, the portions having been designed or selected for robotic production, handling or assembly; and (ii) the groups of cells are located in a factory that is a less than 25,000 square meters in area.
2. A vehicle assembled in a robotic production environment, in which the environment (i) hosts robotic agents that are organised as groups of cells, each cell with no more than 10 fixed robots, served by AMRs (autonomous mobile robots), and each cell is responsible for production or assembly of at least portions of a vehicle, the portions having been designed or selected for robotic production, handling or assembly; and (ii) the groups of cells are located in a factory that is a less than 25,000 square meters in area.

Feature 4: Microfactory without a Moving Production Line

1. A method of constructing a vehicle robotic production environment, including the following steps:
(i) selecting or constructing a warehouse or factory of under 25,000 square meters with a conventional flat concrete floor that has not been strengthened for a vehicle body panel stamping press;
(iii) installing a number of robotic cells configured to assemble least portions of a vehicle together, without also installing a moving production line.
2: A vehicle assembled in a robotic production environment, in which the robotic production environment is a warehouse or factory of under 25,000 square meters with a conventional flat concrete floor that has not been strengthened for a vehicle body panel stamping press, and includes a number of robotic cells configured to assemble least portions of a vehicle together, without using a moving production line.

Feature 5: Microfactory without a Paint Shop

1. A method of constructing a vehicle robotic production environment, including the following steps:
(i) selecting or constructing a warehouse or factory of under 25,000 square meters with a conventional flat concrete floor that has not been strengthened for a vehicle body panel stamping press;
(ii) installing a number of robotic cells configured to transform thermoplastic yarn into coloured vehicle composite panels and other parts, without also installing a paint shop of the kind needed to paint conventional pressed steel parts.
2: A vehicle assembled in a robotic production environment that has been constructed using a method including the following steps:
(i) selecting or constructing a warehouse or factory of under 25,000 square meters with a conventional flat concrete floor that has not been strengthened for a vehicle body panel stamping press;
(ii) installing a number of robotic cells configured to transform thermoplastic yarn into coloured vehicle composite panels and other parts, without also installing a paint shop of the kind needed to paint conventional pressed steel parts.

C. Building Arrival Vehicles in the Arrival Microfactory

Feature 6: Robotic Small Cells Assemble Entire Vehicle

1. A robotic production environment comprising a number of robotic production cells for vehicle production, each cell comprising a group of robots that are programmed to assemble, at a fixed location and not a moving production line, at least part of the vehicle by joining together multiple, modular components, each component designed or selected for robotic production, handling or assembly; and the cells together assemble substantially the entire vehicle.
2: A robotic vehicle production method, comprising the step of assembling, across a number of robotic production cells each programmed to assemble at a fixed location and not a moving production line, at least part of the vehicle by joining together multiple, modular components, each component designed or selected for robotic production, handling or assembly; and in which the cells together assemble substantially the entire vehicle.
3: A vehicle assembled in a robotic production environment comprising a number of robotic production cells for vehicle production, each cell comprising a group of robots that are programmed to assemble, at a fixed location and not a moving production line, at least part of the vehicle by joining together multiple, modular components, each component designed or selected for robotic production, handling or assembly; and in which the cells together assemble substantially the entire vehicle.

Feature 7: All Vehicle Components are Designed for Robotic Handling

1. A robotic production environment comprising a number of robotic production cells for vehicle production, each cell comprising a group of robots that are programmed to assemble, at a fixed location and not a moving production line, at least part of the vehicle by (a) joining together multiple components to form a structural chassis, and a body structure, and (b) adding body panels and roof panels to the body structure, and all of the components and the panels are designed or selected for robotic production, handling or assembly.
2: A robotic vehicle production method, comprising the following steps that take place in a robotic production environment comprising a number of robotic production cells for vehicle production, each cell comprising a group of robots that are programmed to assemble, at a fixed location and not a moving production line, at least part of the vehicle; in which the steps are: (a) joining together multiple components to form a structural chassis, and a body structure, and (b) adding body panels and roof panels to the body structure, all of the components and the panels being designed or selected for robotic production, handling or assembly;
4: A vehicle assembled in a robotic production environment comprising a number of robotic production cells for vehicle production, each cell comprising a group of robots that are programmed to assemble, at a fixed location and not a moving production line, at least part of the vehicle by (a) joining together multiple components to form a structural chassis, and a body structure, and (b) adding body panels and roof panels to the body structure, and all of the components and the panels are designed or selected for robotic production, handling or assembly.

Feature 8: Vehicle with Customer-Specified Configuration

1. An electric vehicle design and production process, the vehicle available in multiple different configurations that differ by one or more of the following variables: length, width, height, presence of specific sensors, presence of specific driving aids, presence of any customer-specified option;
and an automated vehicle design tool then automatically selects components required for a specified configuration; and automatically generates build instructions for that vehicle or a fleet of those vehicles;
and a robotic production environment then automatically builds or assembles the vehicle or vehicles, as designed by the automated vehicle design tool, with the specified configuration, using the build instructions.
   2: A robotic vehicle production method for a vehicle available in multiple different configurations that differ by one or more of the following variables: length, width, height, presence of specific sensors, presence of specific driving aids, presence of any customer-specified option; the method comprising the steps of:
   (a) an automated vehicle design tool automatically selecting components required for a specified configuration; and automatically generating build instructions for that vehicle or a fleet of those vehicles;
   (b) a robotic production environment automatically building or assembling the vehicle or vehicles, as designed by the automated vehicle design tool, with the specified configuration, using the build instructions.
   3: A vehicle assembled in a robotic production environment, the vehicle being available in multiple different configurations that differ by one or more of the following variables: length, width, height, presence of specific sensors, presence of specific driving aids, presence of any customer-specified option; in which:
   (a) an automated vehicle design tool has automatically selected components required for a specified configuration; and automatically generated build instructions for that vehicle or a fleet of those vehicles;
   (b) a robotic production environment automatically built or assembled the vehicle, as designed by the automated vehicle design tool, with the specified configuration, using the build instructions.
   4: A fleet of vehicles, each vehicle assembled in a robotic production environment, in which the vehicle is available in multiple different configurations that differ by one or more of the following variables: length, width, height, presence of specific sensors, presence of specific driving aids, presence of any customer-specified option; in which:
   (a) an automated vehicle design tool has automatically selected components required for a specified configuration defined by a fleet operator; and automatically generated build instructions for that vehicle or a fleet of those vehicles;
   (b) a robotic production environment automatically built or assembled the vehicle, as designed by the automated vehicle design tool, with the specified configuration, using the build instructions.

Feature 9: Vehicle with Customer-Specified Battery Capacity

1. An electric vehicle design and production process, the vehicle including multiple battery modules; in which an automated vehicle design tool automatically selects battery-related components required for a specified battery capacity or range; and automatically generates build instructions for that vehicle or fleet of vehicles;
and a robotic production environment then automatically builds or assembles the vehicle as designed by the automated vehicle design tool, including a battery pack with the number of battery modules required to meet the specified battery capacity or range, using the build instructions.
   2: A vehicle including multiple battery modules; in which the vehicle has been configured using an automated vehicle design tool that has automatically selected battery-related components required for a specified battery capacity or range for the vehicle, and automatically generated build instructions for that vehicle;
and a robotic production environment has then automatically built or assembled the vehicle as designed by the automated vehicle design tool, including a battery pack with the number of battery modules required to meet the specified battery capacity or range, using the build instructions.
   3: A fleet of vehicles, each vehicle assembled in a robotic production environment, in which the vehicles in the fleet have been configured using an automated vehicle design tool that has automatically selected battery-related components required for a battery capacity or range for each of the vehicles in the fleet, and has automatically generated build instructions for that vehicle;
and a robotic production environment has then automatically built or assembled the vehicle as designed by the automated vehicle design tool, including a battery pack with the number of battery modules required to meet the specified battery capacity or range, using the build instructions;
and in which an operator of the fleet has defined the specified set of battery capacity or range requirements it has for one or more vehicles in the fleet, and those requirements have been used in the robotic production environment to assemble each of the vehicles in the fleet.

Feature 10: Vehicle with Integrated, Customer-Specified Sensors

1. An electric vehicle design and production process, the vehicle including multiple sensor based systems, such as ADAS, LIDAR, computer vision based driver monitoring, computer vision based passenger monitoring, load or weight sensors, that each conform to a standardised plug and play model;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicles as designed by the automated vehicle design tool, integrating the sensor based systems into the vehicles, using the build instructions.
   2: A vehicle assembled in a robotic production environment, the vehicle including multiple sensor based systems, such as ADAS, LIDAR, computer vision based driver monitoring, computer vision based passenger monitoring, load or weight sensors, that each conform to a standardised plug and play model;
in which the vehicle has been configured by a customer specifying which sensor based systems or their related functionality are required for that vehicle, and an automated vehicle design tool has then automatically selected components required for the specified sensor based systems or their related functionality; and automatically generated build instructions for that vehicle;
and a robotic production environment has then automatically built or assembled the vehicle as designed by the automated vehicle design tool, integrating the sensor based systems into the vehicles, using the build instructions.
   3: A fleet of vehicles, each vehicle assembled in a robotic production environment, in which each vehicle includes multiple sensor based systems, such as ADAS, LIDAR, computer vision based driver monitoring, computer vision based passenger monitoring, load or weight sensors, that each conform to a standardised plug and play model;
and in which the fleet of vehicles have been configured by a fleet operator specifying which sensor based systems or their related functionality are required for that fleet of vehicles, and an automated vehicle design tool has then automatically selected components required for the specified sensor based systems or their related functionality; and has automatically generated build instructions for that vehicle;
and a robotic production environment has then automatically built or assembled the fleet of vehicles as designed by the automated vehicle design tool, integrating the sensor based systems into the vehicles, using the build instructions.

D. Autonomous Operation in the Arrival Microfactory

Feature 11: Robotic Assembly that is Autonomous at the Robot Level

1. A robotic production environment comprising a number of robotic production cells for vehicle production, each cell comprising a group of robots that are autonomously capable, at an individual robot level, of assembling, at a fixed location and not a moving production line, at least part of the vehicle by joining together multiple, modular components, each selected or designed for robotic handling or installation.
2. A robotic vehicle production method, comprising the step of assembling the vehicle at a robotic production environment comprising a number of robotic production cells for vehicle production, each cell comprising a group of robots that are autonomously capable, at an individual robot level, of assembling, at a fixed location and not a moving production line, at least part of the vehicle by joining together multiple, modular components, each selected or designed for robotic handling or installation.
3. A vehicle assembled in a robotic production environment by joining together multiple, modular components, each selected or designed for robotic handling or installation in a robotic production environment comprising a number of robotic production cells for vehicle production, each cell comprising a group of robots that are autonomously capable, at an individual robot level, of assembling, at a fixed location and not a moving production line, the vehicle.

Feature 12: Robotic Assembly that is Autonomous at the Cell Level

1. A robotic production environment comprising a number of robotic production cells for vehicle production, each cell comprising a group of robots that are autonomously capable, at an individual cell level, of assembling, at a fixed location and not a moving production line, at least part of the vehicle by joining together multiple, modular components, each selected or designed for robotic handling or installation.
2. A robotic vehicle production method, comprising the step of assembling the vehicle at a robotic production environment comprising a number of robotic production cells for vehicle production, each cell comprising a group of robots that are autonomously capable, at an individual cell level, of assembling, at a fixed location and not a moving production line, at least part of the vehicle by joining together multiple, modular components, each selected or designed for robotic handling or installation.
3 A vehicle assembled in a robotic production environment by joining together multiple, modular components, each selected or designed for robotic handling or installation in the robotic production environment, the environment comprising a number of robotic production cells for vehicle production, each cell comprising a group of robots that are autonomously capable, at an individual cell level, of assembling the vehicle, at a fixed location and not a moving production line, by joining together the multiple, modular components.

Feature 13: Robotic Assembly that is Autonomous at the Factory Level

1. A robotic production environment comprising a number of robotic production cells for vehicle production, each cell comprising a group of robots that are autonomously capable, at a factory level, to assemble, at a fixed location and not a moving production line, at least part of the vehicle by joining together multiple, modular components, each selected or designed for robotic handling or installation.
2. A robotic vehicle production method, comprising the step of assembling the vehicle at a robotic production environment comprising a number of robotic production cells for vehicle production, each cell comprising a group of robots that are autonomously capable, at a factory level, of assembling, at a fixed location and not a moving production line, at least part of the vehicle by joining together multiple, modular components, each selected or designed for robotic handling or installation.
3. A vehicle assembled in a robotic production environment, by joining together multiple, modular components, each selected or designed for robotic handling or installation in the robotic production environment, the environment comprising a number of robotic production cells for vehicle production, each cell comprising a group of robots that are autonomously capable, at a factory level, of assembling the vehicle, at a fixed location and not a moving production line, by joining together the multiple, modular components.

Feature 14: Autonomous Agent Based Production

1. A robotic production environment that is configured to determine by itself, dynamically, (i) what steps to perform, (ii) when to perform those step, (iii) by what agents, including both robotic agents and also non-robotic agents, those steps should be performed and (iv) how those agents are to interact with each other to build or assemble a device; and in which the robotic agents are organised as cells, each with no more than ten robots, served by autonomous mobile robots (AMRs).
2: A robotic production method, comprising the step of a robotic production environment determining by itself, dynamically, (i) what steps to perform, (ii) when to perform those step, (iii) by what agents, including both robotic agents and also non-robotic agents, those steps should be performed and (iv) how those agents are to interact with each other to build or assemble a device; and in which the robotic agents are organised as cells, each with no more than ten robots, served by autonomous mobile robots (AMRs).

Feature 15: Semantic Model

1. A robotic production environment that is configured to assemble vehicles in a robotic production environment, in which the robotic production system (i) hosts robotic agents that are organised as groups of cells, each cell with no more than 10 fixed robots, served by AMRs (autonomous mobile robots), and each cell is responsible for production of, transforming, handling or assembling some part of a vehicle;
and the robotic production environment is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle;
and the robotic production environment uses a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.
   2. A robotic vehicle production method, comprising the step of assembling vehicles in a robotic production environment, in which the robotic production system (i) hosts robotic agents that are organised as groups of cells, each cell with no more than 10 fixed robots, served by AMRs (autonomous mobile robots), and each cell is responsible for production of, transforming, handling or assembling some part of a vehicle;
and the robotic production environment is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle;
and the robotic production environment uses a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.
   3. A vehicle assembled in a robotic production environment, that is configured to assemble vehicles in a robotic production environment, in which the robotic production system (i) hosts robotic agents that are organised as groups of cells, each cell with no more than 10 fixed robots, served by AMRs (autonomous mobile robots), and each cell is responsible for production of, transforming, handling or assembling some part of a vehicle;
and the robotic production environment is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle;
and the robotic production environment uses a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.

Feature 16: Takt Time Agnostic Production

1. A robotic production environment for production of a vehicle, in which the environment operates with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.
2. A robotic vehicle production method, comprising the step of operating a robotic production environment in which the environment operates with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.
3. A vehicle assembled in a robotic production environment, in which the environment operates with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.

Optional Sub-Features (Relevant to all Section F Features)

Context
the robotic production environment is a ‘microfactory’ that is between approximately 5,000 and 25,000 square metres in size
the microfactory is between approximately 10,000-25,000 square metres in size
the microfactory does not have a moving production line along which the vehicle is incrementally assembled, but instead fixed cells served by AMRs
the microfactory does not have a metal body panel pressing plant, or use pressed metal body panels, but instead a composite panel production environment
the microfactory does not have a paint shop configured to paint pressed metal body panels, but instead a coloured composite panel production environment
the microfactory is a conventional warehouse with a flat concrete floor that has not been strengthened for a metal body panel pressing plant
the microfactory is a conventional warehouse that does not have environmental systems required for a paint shop configured to paint pressed metal body panels
the robotic production environment includes both the factory and computing resources that are external to the factory, e.g. cloud-based.
the robotic production environment includes multiple such factories and is a distributed system

Robotic Production Environment or System Operation
the robotic production environment or system is configured to automatically determine, dynamically and in real-time (i) what steps or robotic services to perform, (ii) when to perform those steps or robotic services, (iii) by what agents, including cells of robots, those steps or robotic services should be performed and (iv) how those agents are to interact with each other, to build or assemble a vehicle.
the robotic production environment or system implements semantic (ontology driven) decision making
the robotic production environment or system uses a semantic (ontology driven) model of physical features, such as the location and function of agents, including robots, end-effectors used by robots, AMRs, cells served by AMRs, and fixed static objects.
the robotic production environment or system implements self-learning or automatically adapts and improves its operations
the robotic production environment or system enables re-configurable, just-in-time vehicle production
the robotic production environment or system includes a model or map of the physical environment that is generated or augmented or refined in real time by AMRs and robots using at least SLAM computer vision techniques
the robotic production environment or system includes a master semantic model of the physical environment that enables AMRs and robotic agents to relate at a semantic level to the function or other attributes of objects, both fixed and dynamic they detect;
the robotic production environment or system is automatically reconfigurable through software-implemented changes to automatically: make different components, to assemble different types of vehicles, to assemble different configurations of the same type of vehicles, to use different assembly techniques, to use different components, or to transport vehicle parts or structures through the physical environment of the factory using alternate physical routes.
the robotic production environment or system is automatically reconfigurable through software-implemented changes that alter one or more of: the function of robotic agents, the physical location or arrangement of robotic agents, the number of operative robotic agents; the routes taken by AMRs.
there is no pre-defined Takt time in relation to the completion of any robotic services, or the completion of a set of robotic services
robotic production environment implements semantic (ontology driven) decision making, self-learning and is self-controlled.
robotic production environment builds or assembles a device as designed by the automated vehicle design tool and using modular hardware components and modular software components.
robotic production environment is instructed to build a device using data sent from the automated vehicle design tool
robotic agents are configured for some or all of: pick and place, insert, glue, screw, welding
robotic agents are served by AMRs for parts delivery
robotic production environment includes multiple cells, each with no more than 10 fixed robots, served by AMR (autonomous mobile robots).
The robotic production environment is configured to produce or assemble vehicles.
robotic production environment builds or assembles a vehicle as designed by an automated vehicle design tool.
the robotic production environment is as defined in any preceding Features 1-16.

Cell Operation
the robotic production environment includes robotic agents that are organised as a group of cells in the factory, each cell with no more than 10 fixed robots, such as 6DoF robots, served by AMRs (autonomous mobile robots), and the group of cells works together to assemble substantially an entire, complete vehicle.
the totality of cells in the factory are responsible for assembling substantially an entire, complete vehicle.
each cell is responsible for assembling at least portions of a vehicle and is configured to automatically determine dynamically and in real-time, autonomously or in conjunction with other computing resources in the robotic production environment (i) what steps or robotic services to perform, (ii) when to perform those steps or robotic services, (iii) by what agents, including both robotic agents and also non-robotic agents, those steps or robotic services should be performed and (iv) how those agents are to interact with each other, to build or assemble a vehicle.
cells exchange data with other cells in the factory, directly, or over a network
each cell of robots is configured to dynamically and in real-time work out amongst themselves, arbitrating as required, and execute, the optimal production process for each vehicle sub-assembly or components they assemble.
A cell undertakes the assembly and joining of modular transverse chassis sections together for a specific vehicle
A cell undertakes the joining of frames or modular body parts to modular transverse chassis sections
A cell undertakes the joining of modular drivetrains to modular transverse chassis sections
A cell undertakes the joining of modular wheel housings to modular transverse chassis sections
A cell undertakes the joining of, or insertion, of modular battery packs to the chassis
A cell undertakes the assembly and joining of modular components to the chassis
the assembly of the chassis and the addition one or more of the drivetrain, suspension, battery packs for a specific vehicle is all completed by a single cell
using components that conform to enables low volume (e.g. 10,000 or fewer vehicles per year) yet economically viable production of vehicles in the microfactory
the cells work co-operatively to enable low volume, customer specific production of vehicles
Adding further cells in a microfactory enables scaling of production capacity

Vehicle Builder
the robotic production environment receives data from an automated vehicle design tool defining the production of a vehicle
the automated vehicle design tool defines all components needed to assemble a vehicle, and the location of all components and the power and/or data network for components
the robotic production environment then produces, or controls the production of, the vehicle, by (a) using the data sent by the automated vehicle design tool and (b) using robotic services, as defined by the automated vehicle design tool or a different tool.
the automated vehicle design tool is configured to enable a range of different vehicles to be designed
the automated vehicle design tool is configured to enable vehicles to be designed that specifically meet a customer's (e.g. B2B customer) set of requirements
the automated vehicle design tool analyses a design for the vehicle and plans an optimal, automated production of that vehicle using a catalogue of available robotic services
the robotic production environment receives a list of selected components from the automated vehicle design tool, the automated device design tool having automatically generated the list of the components to optimally meet requirements, e.g. customer requirements
the automated vehicle design tool is configured to design any of the following: small passenger car, large passenger car, small van, large van, specialist vans, truck and lorries of different lengths and capacities, buses of different lengths and capacities

Robotic Services
robotic services are the services available from all agents in the automated robotic production environment
robotic services include any of the following, in relation to a component or item: storing; retrieving; moving; delivering; gripping; rotating; pick and placing; assembling; gluing; inserting; joining; welding; any other handling operation
robotic services include locating a component or item using a machine vision system
robotic services include identifying a component or item using a machine vision system
each cell implements a specific sub-set of all available robotic services
different fixed robots each have specialised end-effectors for providing specific robotic services
robotic services are defined by an extensible and standardised list or schema of capabilities, enabling any supplier to provide services for the automated robotic production environment, provided that those services conform to the list or schema of capabilities.
robotic services are used in the automated robotic production environment to perform actions on components, and the components are each optimised for robotic handling
robotic services include any of: identifying the pose of a component; reading the unique ID of a component; picking up the component; moving the component to a target position; attaching the component to another component; fastening the component to another component; screwing a standardised fastener; punching a standardised fastener; connecting standardised electrical interfaces.
robotic services includes gluing and some robots include glue delivery effectors that are configured to inject glue into glues holes in chassis sections of a vehicle platform to join those sections together
the vehicle includes a structural chassis made up of transverse sections that are configured to be glued together, and in which each section includes one or more glues holes and channels to enable glue from the glue delivery effectors to flow under pressure around tenons or other joints that are themselves optimised in shape to ensure effective and complete glue coverage.
each section includes one or more glue channels and a foam bung configured to seal a channel

Agents Operations:
agents include: fixed robots (e.g. with 6 degrees of freedom); cells of robots; groups of cells of robots; and mobile robots or AMRs.
agents include: fixed robots (e.g. with 6 degrees of freedom); cells of robots; groups of cells of robots; and mobile robots or AMRs, and humans equipped with wireless information terminals
robotic agents are configured for some or all of: pick and place, insert, glue, screw, welding
robotic agents are served by AMRs for parts delivery
AMRs and robots use SLAM based computer vision systems to generate a map of their local environment
AMRs and robots use a semantic (ontology driven) model of physical features, such as the location and function of other AMRs, robots, end-effectors used by robots, targets being handled or modified by the robotic end-effectors

Factory Layout:
the physical layout or arrangement of cells in the robotic production environment is optimised by an automated layout design tool that determines the optimal layout or arrangement of cells and the robotic services they each perform
automated layout design tool determines the optimal layout or arrangement of cells and the robotic services they each perform, taking into account parameters such as: production cost; production time; production quality; component availability; use of AMRs to transport components to cells and sub-assemblies to and from cells.
automated layout design tool determines the distribution of component stores in the production environment
automated layout design tool determines the arrangement of paths or tracks for AMRs to reach component stores and provide components to cells in the production environment
automated layout design tool determines the layout or arrangement of cells and the robotic services they each perform using simulation, including simulation using a robotic services control system
automated layout design tool plans the optimal layout or arrangement of cells on a standardised rectilinear grid
the robotic services control system used in the simulation is also used to control robotic services in the real-world

Vehicle Variants:
the robotic production environment is configured to assemble at least one of the following: small passenger car, large passenger car, small van, large van, specialist vans, truck and lorries of different lengths and capacities, buses of different lengths and capacities
the robotic production environment is configured to assemble several of the following: small passenger car, large passenger car, small van, large van, specialist vans, truck and lorries of different lengths and capacities, buses of different lengths and capacities.
vehicle can be any of a car, van, bus, truck
single robotic production environment can produce any of the following: a car, van, bus or truck
each cell can be re-purposed to be part of a set of cells that produce any of a car, van, bus or truck
vehicle can have a range of different battery modules (HVBMs), for example 12, 18, 24, 30 and 36 for a van, giving 44 kWh, 67 kWh, 89 kWh, 111 kWh, 133 kWh respectively.
using the automated vehicle design tool, van length can be selected from at least two different lengths, and a van of each length can have a height selected from at least two different heights, and a van of a given length and height can have a number of HVBMs selected from at least three different numbers of HVBMs.
using the automated vehicle design tool, bus length can be selected from at least two different lengths, and a bus of each length can have a number of HVBMs selected from at least two different numbers of HVBMs.

Specific Vehicle Assembly Operations in the Factory:
the robotic production environment assembles a specific type of body module
for a bus, the body module types are: a front module, a wheel housing module, a door module, a window-only module, a rear module
further body module types include: a driver module, a driverless cab module, a passenger module, a rear module, a cargo module, or any task specific module, and all are configured to be fixed to the chassis sections in substantially the same manner e.g. by a robotic production system
Each body module is configured to be glue bonded together, e.g. using a robotic production system.
the robotic production environment assembles a vehicle with a skateboard chassis
vehicle includes a structural chassis made up of transverse sections that are configured to be joined together by a robotic production system to provide a substantially flat-topped platform.
vehicle includes a structural chassis made up of transverse sections that are configured to be glued together by a robotic production system to provide a substantially flat-topped platform.
vehicle includes a substantially flat-topped platform onto which different modules can be placed, such as a driver module, a driverless cab module, a rear module, a cargo module, or any task specific module, and all are configured to be fixed to the flat-topped platform in substantially the same manner by a robotic production system.
vehicle includes a substantially flat-topped platform including shaped channels into which modules are configured to be slotted by a robotic production system.
vehicle includes a suspension spring for a wheel that is attached to the apex of a structural wheel housing (e.g. a single large aluminium casting) that is attached to the skateboard chassis, and the spring is positioned substantially vertically within the wheel housing.
vehicle has an internal floor that is substantially flat and sits over the skateboard chassis
vehicle includes wheel arches made as a large single casting onto which the motor or IDU, and suspension mounts are directly attached and the wheel arches are attached to the skateboard chassis
the robotic production environment or cell assembles a chassis or platform configured to receive multiple integrated drive units (IDU)
each IDU conforms to one of the following types: an IDU including a motor and control electronics; an IDU including a motor, control electronics and a differential; an IDU including two motors and a gearbox; and in which each type of IDU is configured to be bolted or attached to the chassis or platform or a structural wheel arch (e.g. a single large cast aluminium wheel arch) by a robotic assembly system.
the robotic production environment assembles modular transverse chassis sections
   modular transverse chassis sections have a fixed length, e.g. 1.5 m
   modular transverse chassis sections for wheel housings have the same fixed length as modular transverse chassis sections for the main body of the vehicle
   modular transverse chassis sections have a structural one piece bottom plate
   modular transverse chassis sections are configured to support an extruded aluminium frame
   vehicles of different length are assembled using a different number of modular transverse chassis sections
   modular transverse chassis sections are joined together when oriented horizontally, so that additional chassis sections extend the vehicle longitudinally
   The modular transverse chassis sections, when joined together, provide a substantially flat-topped chassis or platform.
   modular transverse chassis sections include a central rigid beam that connects to a rigid structure in an adjacent chassis section
   modular transverse chassis sections for wheel housings include a flat, extruded aluminium panel with a cut-out on opposite sides, shaped to receive a wheel housing
   An integrated drive unit (IDU) is attached to a modular transverse chassis section
   a modular transverse chassis section is configured to receive multiple different types of integrated drive unit (IDU), which each conform to one of the following types: an IDU including a motor and control electronics; an IDU including a motor, control electronics and a differential; an IDU including two motors and a gearbox; and in which each type of IDU is configured to be bolted or attached to a modular transverse chassis section or a structural wheel arch (e.g. a single large cast aluminium wheel arch)
   the modular transverse chassis sections are glued together, e.g. using a robotic production system
   each modular transverse chassis section includes one or more glues holes and channels to enable glue to flow under pressure around tenons or other joints that are themselves optimised in shape to ensure effective and complete glue coverage.
   Each modular transverse chassis section includes one or more glue channels and a foam bung configured to seal a channel
   Battery pack modules of a standardised size are assembled into or onto a modular transverse chassis section
      the robotic production environment assembles frames:
each modular transverse chassis section includes a channel or socket into which body frames are configured to be slotted, e.g. by a robot
the body frames are made of extruded aluminium beams or poles
the body frames are made of extruded aluminium beams or poles that have male/female friction fit joints that are glue bonded together
some body frames are configured to receive and retain body panels
body panels are made of a composite material
body panels are made of aluminium skimmed thermoplastic
body panels are glued to the frames by a robot
some body frames are configured to receive and retain display panels (e.g. LED displays)
some body frames are configured for a specific type of body module
   the robotic production environment assembles modular vehicle components:
the vehicle component is modular or standardised by virtue of having a size that conforms to regular size intervals and is part of a family of other types of components, all with sizing that also conforms to the same size intervals.
the vehicle component is modular or standardised by virtue of being part of a family of other types of components, all being configured to be positioned or installed in the vehicle in a regular, rectilinear grid or installation pattern.
the vehicle component is modular or standardised by virtue of being part of a family of other types of components, all having an external casing feature or features that are optimised for robotic handling, installation or assembly, such as autonomous robotic handling, installation or assembly
the vehicle component is modular or standardised by virtue of being part of a family of other types of components, all having the same overall type of shape (e.g. box type shape), the family of components including two or more of the following: battery module; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform.
the vehicle component is modular or standardised by virtue of being part of a family of other types of components, all designed for an installation path to a final position, in which the installation path is optimised for robotic handling, installation or assembly, such as autonomous robotic handling, installation or assembly.
the vehicle component is modular or standardised by virtue of being part of a family of other types of components, that each use the same, standardised physical installation systems, that are each optimised for robotic handling and use
the vehicle component is modular or standardised by virtue of being part of a family of other types of components, that each use the same, standardised identification system that gives each individual component a unique identification that is (i) computer readable; and (ii) enables each individual component to be tracked from initial production to initial installation, and subsequent servicing and end-of-life.
the vehicle component is modular or standardised by virtue of being part of a family of other types of components, that each use the same, standardised physical connectors
the vehicle component is modular or standardised by virtue of being part of a family of other types of components, that each use the same, standardised data and/or power interface
the vehicle component is modular or standardised by virtue of being part of a family of other types of components, that each use the same, standardised security system or protocol
components are defined by grid-based modular shape and sizing to assist computer vision analysis and robotic handling
components include flat surfaces to facilitate robotic gripping
components include extrusions, such as aluminium extrusions
components include one or more structural wheel arch castings, each configured with mounting features for an integrated drive train to be mounted against
components include structural wheel arch castings, each configured with mounting features for a suspension system to be mounted against
components include composite panels
components are not spot welded together but mechanically attached, with adhesive binding

Appendix 1 Section G: The Arrival Battery Module and the Flex Connector

In this Appendix 1, Section G, we summarise the key Features of the Arrival battery module and the Flex PCB system.

The Arrival battery module and the Flex PCB system defined in this Appendix 1 Section G may use the hardware modularity Features and related optional sub-features described in Appendix 1 Section A; may use the software modularity Features and related optional sub-features described in Appendix 1 Section B; may use the security architecture Features and related optional sub-features described in Appendix 1 Section C; may be handled by the Arrival Technology Platform Features and related optional sub-features described in Appendix 1 Section D; may be handled by the Robofacturing Features and related optional sub-features described in Appendix 1 Section E; may be assembled and installed using the robotic production environment and microfactory Features and related optional sub-features described in Appendix 1 Section F; may be installed in or be part of the vehicle system Features and related optional sub-features described in Appendix 1 Section I, J and K.

Group A: Core Battery Module Principles

Feature 1. Battery Module Generates an Output at a 300V+DC Bus and is Connected in Parallel to Other Battery Modules to Form a Battery Pack

1. A battery module configured to operate as part of a vehicle battery pack that includes multiple, identical such battery modules, in which each battery module (i) generates at least 300V nominal output and (ii) is electrically connected in parallel with at least 2 other substantially similar battery modules to form the battery pack.

Feature 2. Battery Module Operates as an Autonomous Module in a Battery Pack

1. A battery module that (i) includes an array of rechargeable cells and monitoring and control systems configured to enable the battery module to operate using autonomous monitoring and control; and (ii) is configured to be electrically connected to further battery modules, to form a complete battery pack.

Group B: Battery Module Physical Structure Features

Feature 3. Battery Module with Standard Grid Sizing

1. A battery module configured to operate as part of a vehicle battery pack that includes multiple, identical such battery modules, in which each battery module has a size that conforms to a regular size interval scale and is part of a family of other types of components with sizing that also conforms to the same size interval scale.

Feature 4: Modular Components Installed Using the Same Regular, Rectilinear Grid or Installation Pattern

1. A battery module configured for robotic installation or assembly into a device or system by virtue of being configured to be positioned in a regular, rectilinear grid or installation pattern.

Feature 5. Battery Module Configured for Robotic Assembly

1. A battery module configured to operate as part of a vehicle battery pack that includes multiple, identical such battery modules, in which each battery module is configured for robotic installation or assembly to the battery pack by virtue of having a shape that is optimised for robotic installation or assembly.

Feature 6. Battery Module that Sits on a Rigid Base Plate that in Turn Sits on a Liquid Cooled Plate

1. A vehicle battery module including multiple cylindrical form-factor rechargeable cells, in which the battery module includes a base on which the rechargeable cells are positioned, in which the base provides a structurally rigid support for the cells and also provides thermal cooling for the cells.

Feature 7. Battery Module in which all Rechargeable Cells have the Same Polarity Orientation

1. A vehicle battery module including multiple cylindrical form-factor rechargeable cells, in which the battery module includes a base on which the rechargeable cells are positioned, in which the base provides a structurally rigid support for the cells and in which all cells in the battery module are oriented with the same polarity orientation.

Feature 8. Battery Module that has its Own Cover, and Connects to Other Similar Modules to Form a Battery Pack

1. A vehicle battery module that generates at least 300V output at maximum charge, and (i) includes a single outer shell or lid that is configured to enclose an array of rechargeable cells and seal against a rigid base of the module, and (ii) is configured to be electrically connected to further, substantially similar, battery modules, to form a complete battery pack.

Feature 9. Battery Module that Slides into Chassis Void

1. A vehicle battery module, configured to operate as part of a battery pack that includes multiple, identical such battery modules, in which one or more battery modules are configured to be inserted, either individually or when part of a battery pack, into a void sitting over a substantially flat chassis base of the vehicle.

Group C: Battery Module Internal Component Features

Feature 10. Battery Module with Internal Isolation Switch

1. A vehicle battery module configured to operate as part of a battery pack that includes multiple, identical such battery modules, in which each battery module (i) includes rechargeable cells configured to generate, at a pair of output terminals, at least 300V nominal and (ii) includes an internal isolation switch system, configured to isolate all cells from one or both of the output terminals.

Feature 11. Battery Module with a Bypass Series Switch

1. A vehicle battery module configured to operate as part of a battery pack that includes multiple, identical such battery modules, in which each battery module (i) includes rechargeable cells configured to generate, at a pair of output terminals, at least 300V nominal and where at least some of the cells are connectable in series to form a string of cells, and the module includes a switch that is configured to either connect two or more cells in series or to bypass those cells.

Feature 12. Battery Module with Layered Component Architecture

1. A vehicle battery module with a layer construction in which, sitting over battery cells, are one or more separate layers with components or systems that enable the battery module to manage its internal operation, each layer each occupying substantially the entire width or cross-section area of the battery module.

Group D: Battery Module and the Complete Power System, Including BMS and the Battery Pack

Feature 13. Battery Module with Flexible PCB Power Cable

1. A vehicle battery module configured to operate as part of a battery pack that includes multiple, identical such battery modules, and which delivers power over a substantially low profile, printed circuit board (PCB) flexible electrical conductor.

Feature 14. Battery Module that Delivers HV Direct to the HV Bus

1. A vehicle battery module configured to deliver HV output directly into the HV power bus of a vehicle.

Feature 15. Battery Module that Connects to Integrated Power Cables

1. A vehicle battery module configured to electrically engage with a conductor that is integrated into a vehicle component or other vehicle structure that has a purpose in addition to conducting power, such as a structural component or panel.

Feature 16. Battery Pack Including Battery Modules and a BMS

1. A vehicle battery pack comprising multiple battery modules, where the battery pack is configured to be assembled from multiple parallel connected battery modules, each module generating a high voltage output at a voltage magnitude that is used in a system powered by the module and that is at least 300V nominal;
and a battery management system is distributed across each individual battery module and is also in a master BMS that is external to all battery modules, so that each individual battery module is able to galvanically isolate itself, and the master BMS is also able to independently galvanically isolate any battery module.

Group E: Battery Module Operational Features

Feature 17. Battery Module Implementing Plug and Play Software Components

1. A vehicle battery module, configured to operate as part of a battery pack that includes multiple, identical such battery modules, in which each battery module is provisioned with modular software components that monitor and control battery systems, and the modular software components include (i) an application layer and (ii) a basic software layer, or middleware layer, that insulates or separates the application layer from hardware specific features of the battery module and presents a standardised interface to the application layer.

Feature 18. Battery Module with Decentralised Autonomy, Operating in a Distributed Architecture

1. A vehicle battery module, configured to operate as part of a battery pack that includes multiple, identical such battery modules, in which each battery module is provisioned with modular software components that monitor and control battery systems to enable the battery module to operate autonomously and individual modular software components exchange data with modular software components on other battery modules to provide a distributed architecture.

Feature 19 Battery Module with Performance Reporting

1. A battery module configured to operate as part of a battery pack that includes multiple, identical such battery modules, in which each battery module is part of a data-network that establishes a network of modules, and each battery module includes an internal performance monitoring and management sub-system that autonomously manages the battery module and reports data to an external BMS.

Feature 20. Battery Module that Autonomously Negotiates with Other Battery Modules

1. A battery module configured to operate as part of a battery pack that includes multiple, identical such battery modules, in which each battery module is part of a data-connected network of modules, and each module is configured to autonomously negotiate with other modules to determine power or performance compatibility.

Feature 21. Battery Module with Crypto-Network

1. A battery module configured to operate as part of a battery pack that includes multiple, identical such battery modules, in which each battery module is part of a data-connected network of modules configured for two-way verification or authentication, and where each module (i) is itself verified or authenticated, using a secure protocol, by a sub-system in the device that the battery module is installed in and (ii) each battery module verifies or authenticates a sub-system in the device that the battery module is installed in.

Feature 22. Battery Module that Self-Initialises

A vehicle battery module configured to operate as part of a battery pack that includes multiple,

1. identical such battery modules, in which each battery module is part of a data-connected network of vehicle battery modules, and in which each battery module configures itself or otherwise self-initialises to operate with the network when it is added to the network or is turned on.

Feature 23: Battery Module with Ambient Pressure Equalisation Vent

1. A battery module with ingress protection of at least IP 65, in which the battery module includes an air pressure equalisation vent configured to enable air pressure equalisation inside the module to ambient or external air pressure whilst maintaining ingress protection.

Feature 24: Battery Module with Gas Escape Vents

1. A battery module with a case or lid that provides ingress protection of at least IP 65, in which the battery module includes gas escape vents in the case or lid, and in which one or more labels cover the gas escape vents in normal use, and the labels are configured to release to enable pressurised gases, arising from cell failure, inside the module to escape from the battery module.

Feature 25: Battery Module with Internal Monitoring or Control Systems

1. A battery module configured to operate as part of a vehicle battery pack that includes multiple, identical such battery modules, in which each battery module (i) includes an array of rechargeable cells and also monitoring or control systems configured to enable the battery module to monitor or control itself; and (iii) is configured to be electrically connected in series and/or parallel to an array of further battery modules, to form a complete battery pack with a decentralised monitoring or control architecture.

Appendix 1 Section H: The Arrival Composites System

In this Appendix 1, Section H, we summarise the key Features of the Arrival Composites system.

Note also that the vehicles, vehicle systems, vehicle fleets described above in Appendix 1 Section I and Appendix 1 Section J and Appendix 1 Section K can utilise the composite-related Features and related optional sub-features described in this Appendix 1 Section H. The composite parts and panels defined in this Appendix 1 Section H can use or implement the hardware modularity Features described in Appendix 1 Section A; can be integrated into the vehicle design flow and Vehicle Builder software tool described in Appendix 1 Section D; and can be assembled into vehicles using the robotic production environment and microfactories described in Appendix 1 Section E.

We organise these Key Features into the following five groups:

Group A: Producing the composite parts or panels
Group B: Properties of composite parts and panels
Group C Smart composite parts or panels
Group D Factory integration; Vehicle Assembly using Composite Parts or Panels
Group E Automotive vehicles with composite parts or panels

Within each group are a number of Key Features:

### Group A: Producing the Composite Parts or Panels

Feature 1: Fibre and yarn brought together only at weaving
Feature 2: Fibre and yarn relative proportions are fixed only at weaving
Feature 3: Fabric structure with co-moulded core
Feature 4: AMR supplies fabric structures to the moulding cell
Feature 5: Multi-use flexible membrane for Arrival MultiForm
Feature 6: Automated sliders for tooling
Feature 7: Direct heating of vacuum forming tool with modular replaceable skin
Feature 8: Pitch Fibre Mould Skin
Feature 9: Underside of mould is vented to the atmosphere
Feature 10: Pressure applied by a heated silicone tool
Feature 11: Robotic arrangement of the fabric in the mould

Group B: Properties of Composite Parts and Panels
Feature 12: Fabric structure that is moulded into a soft-touch panel
Feature 13: Fabric structure that is moulded into a textile-surfaced panel
Feature 14: Fabric structure that is moulded into a panel with a grain or patterned surface
Feature 15: Fabric structure that is moulded into a panel with a scratch-concealing structure
Feature 16: Fabric structure that is co-moulded with polymer objects
Feature 17: Fabric structure that is co-moulded with integral locator feature

Group C Smart Composite Parts or Panels
Feature 18: Composite panel with integrated electronics
Feature 19: Composite panel with co-moulded electronic components
Feature 20: Composite panels with integral identification tags
Feature 21: Composite panels with electrically conductive tracks
Feature 22: Composite panels with networked sensors
Feature 23: Composite panels where outputs from multiple low accuracy sensors are combined

Group D Factory Integration; Vehicle Assembly Using Composite Parts or Panels
Feature 24: Composite panel with integral fixing features
Feature 25: Composite Panel with auto-aligning features
Feature 26: Automated system for producing automotive composite parts or
panels from fibre and a matrix
Feature 27: Integrated control system for production and assembly of panels or parts
Feature 28: Matrix production of composite parts or panels
Feature 29: Matrix production integration
Feature 30: Composite panels that are mechanically attached using robots

Group E Automotive Vehicles with Composite Parts or Panels
Feature 31: Vehicle side panels are all non-stressed composite panels
Feature 32: Vehicle side panels are coloured (not painted) composite panels
Feature 33: Vehicle skateboard platform supports different composite panel top hats
Feature 34: Vehicle skateboard platform supports different top hats comprising composite parts

Feature 1: Fibre and Yarn Brought Together Only at Weaving

1. A system for the production of automotive composite parts or panels, the system including a moulding cell with a tool to mould a fabric structure, made of fibre and a thermoplastic matrix, into a composite part or panel, in which separate fibre and matrix yarns are brought together only immediately prior to, or as an integral part of, combining the fibre and matrix yarns together to form the fabric structure, using a weaving or a non-weaving process.

Optional Sub-Features:
fibre rovings or yarn and thermoplastic matrix yarn are brought together in a loom that weaves the fibre rovings or yarn and the matrix yarns together into the fabric structure.
the fibre and the matrix yarn are not co-mingled and are separate strands, yarns or filaments prior to being woven together.

Feature 2: Fibre and Yarn Relative Proportions are Fixed Only at Weaving

1. A system for the production of automotive composite parts or panels, the system including a moulding cell with a tool to mould a fabric structure, made of fibre and a thermoplastic matrix, into a composite part or panel, in which separate fibre and matrix yarns are brought together in relative proportions chosen to give required material properties only at the point of weaving or otherwise combining the fibre and matrix yarns together to form a fabric.

Optional Sub-Features:
The required material properties include one or more of: strength (e.g. specific strength, impact strength), stiffness, ductility, durability, weight, scratch resistance, appearance, UV light resistance.
The required properties are varied along the length of the fabric.
The required properties are varied along the length of the fabric to optimise the performance of the composite part or panel which the fabric is going to be used to produce.
The required properties are varied across the width of the fabric.
The required properties are varied along the width of the fabric to optimise the performance of the composite part or panel which the fabric is going to be used to produce.
The required properties are varied across the thickness of the fabric.
The required properties are varied along the thickness of the fabric to optimise the performance of the composite part or panel which the fabric is going to be used to produce.

Feature 3: Fabric Structure with Co-Moulded Core

1. A system for the production of automotive composite parts or panels, the system including a moulding cell with a tool to mould a fabric structure, made of fibre and a thermoplastic matrix, into a composite part or panel, in which the fabric structure is automatically provided with a core by an automatic or robotic system, and is co-moulded in the moulding cell with that core, and that core has been automatically selected to impart required properties to the part or panel.

Optional Sub-Features:
The core confers selected or required properties to the part or panel, or specific regions of the part or panel.
The core confers selected or required properties including any one or more of: thickness, stiffness, weight, durability, strength, sound absorption.
The core is, or includes a honeycomb, foam or other low density structure, to increase the thickness of the part or panel without adding substantially to its weight.
The core is formed of recycled composite material (e.g. PPGF).
The core is attached to the fabric structure before the fabric structure is moulded to form the panel or part.
The core is arranged on, under or between layers of fabric that are made of fibre and thermoplastic matrix.
The core is made from one or more of: polyester or polyethylene terephthalate; high-performance fibres; thermoplastic matrix materials, balsa.
The fabric structure includes multiple, separate cores.

Feature 4: AMR Supplies Fabric Structures to the Moulding Cell

1. A system for the production of automotive composite parts or panels, the system including a moulding cell with a tool to mould a fabric structure, made of fibre and a thermoplastic matrix, to form a composite part or panel, in which an autonomous guided vehicle (i) supplies the fabric structure to the moulding cell and an autonomous guided vehicle then (ii) moves the composite part or panel formed by the cell away from the cell, for example to a trimming cell to trim and shape the composite part or panel to a final shape.

Optional Sub-Features:
An autonomous robot or other robot removes the fabric structure from the autonomous guided vehicle into the moulding cell.
An autonomous robot or other robot removes the composite part or panel formed by the cell away from the cell and on to an autonomous guided vehicle.
The autonomous robot or other robot and the autonomous guided vehicles are controlled or report to a shared computer system that tracks the operation of the robots and autonomous guided vehicles, and also the moulding cells.
The shared computer system can re-program the selection of which moulding cells are used and when those moulding cells are used, and can control or direct the operation of the robots and autonomous guided vehicles.

Feature 5: Multi-Use Flexible Membrane for Arrival MultiForm

1. A system for the production of automotive composite parts or panels, the system including a moulding cell with a tool to mould a fabric structure, made of fibre and a thermoplastic matrix, into a composite part or panel, in which the cell includes a flexible membrane that is configured to press the fabric structure against the tool surface to enable an automotive composite part or panel to be formed;
and the flexible membrane is a multi-use membrane configured to produce multiple different parts or panels.

Optional Sub-Features:
the membrane is made of silicone.
a robotic system automatically changes the mould to enable parts or panels of different shape to be sequentially and automatically moulded in the same moulding cell.

Feature 6: Automated Sliders for Tooling

1. A system for the production of automotive composite parts or panels, the system including a moulding cell with a tool to mould a fabric structure, made of fibre and a thermoplastic matrix, into a composite part or panel, in which the tool includes one or more automated sliders configured to enable tooled features, such as undercuts, to be created automatically.

Optional Sub-Features:
An autonomous robot or other robot moves the sliders in and out of position in the tool.

Feature 7: Direct Heating of Vacuum Forming Tool with Modular Replaceable Skin

1. A system for the production of automotive composite parts or panels, the system including a moulding cell with a tool to mould and heat a fabric structure, made of fibre and a thermoplastic matrix, into an automotive composite part or panel, in which the tool is a modular tool that includes a tooling skin that is a modular replaceable tooling skin that is configured to be swapped in and out of the tool, and is configured to sit on or otherwise attach to a substrate which remains in or part of the tool when the skin is replaced.
replaceable tooling skin is a composite skin for low volume production runs.
replaceable tooling skin is 3d printed.
replaceable tooling skin is a nickel skin for high volume production runs.
replaceable tooling skin is a modular skin and part of a set of modular skins, all configured to sit on or against the same substrate in the tool.
replaceable tooling skin is a modular skin and part of a set of modular skins for different parts or panels.
replaceable tooling skin is configured to be robotically handled, e.g. withdrawn from the tool substrate and placed against the tool substrate.

Feature 8: Pitch Fibre Mould Skin

1. A system for the production of automotive composite parts or panels, the system including a moulding cell with a tool to mould and heat a fabric structure, made of fibre and a thermoplastic matrix, to form a composite part or panel, in which the tool includes a support, and a mould or mould skin that rests on the support and which shapes the fabric structure;
in which the mould or mould skin is made of thermally conductive carbon fibre combined with matrix resin.

Optional Sub-Features:
the mould or mould skin is set into shape by an adhesive, such as epoxy or epoxy resin.
the support is made of low thermal conductivity material, such as basalt.

Feature 9: Underside of Mould is Vented to the Atmosphere

1. A system for the production of automotive composite parts or panels, the system including a mould that heats a fabric structure, made of fibre and a thermoplastic matrix, into an automotive composite part or panel, in which the fabric structure sits in or against a mould, and the mould is retained by a mould support;
and the mould support is configured to be vented to the atmosphere when a vacuum is applied to press a membrane against the fabric structure.

Feature 10: Pressure Applied by a Heated Silicone Tool

1. A system for the production of automotive composite parts or panels, the system including a moulding cell to mould and heat a fabric structure, made of fibre and a thermoplastic matrix, into a composite part or panel, in which the cell includes a flexible silicone tool that is configured to expand when heated to press the fabric structure against a mould and to melt the thermoplastic matrix, in order to form the composite part or panel.

Feature 11: Robotic Arrangement of the Fabric in the Mould

1. A system for the production of automotive composite parts or panels, the system including a cell with a tool to mould a fabric structure, made of fibre and a thermoplastic matrix, into a composite part or panel, in which the fabric structure is arranged in the mould by a robotic system that includes one or more end-effectors configured to form the fabric structure into the correct shape or position in the mould

For all the systems defined above in Features 1-11 (as well as the subsequent Features in this Appendix 1 Section H), the following optional sub-features may apply:

The Fibre
the fibre is, or includes, glass fibre, e.g. formed as a glass fibre roving
the fibre is, or includes, carbon fibre, or silicon carbide, or boron, or basalt
the fibre is a mix or combination of different types of fibre, or fibre with different properties
the fibre is, or includes, is PP (polypropylene), PET (polyethylene terephthalate), PA (polyamide), UHMWPE (ultra-high molecular weight polyethylene), PLA (polylactic acid)

The Matrix
the thermoplastic matrix is a thermoplastic polymer, such as polypropylene, polyester or polyethylene terephthalate, that has been formed into the thermoplastic matrix yarn
the thermoplastic matrix is an adhesive or thermosetting resin, such as an epoxy resin
the thermoplastic matrix is fused with the fibre by any of: consolidating, fully or partially melting, sintering, activating a chemical reaction, such as a polymerisation reaction.

The Fabric Structure
the fabric structure is formed from glass fibre roving and thermoplastic matrix yarns that are woven together.
the fabric structure is a fibre reinforced polymer, such as glass-reinforced plastic (GRP) or carbon reinforced plastic, or a combination of different.
the fabric structure is any one or more of the following: a woven fabric, a non-woven fabric, a knitted fabric, a laid fabric, a flat fabric, a flat weave fabric; a 3D weave fabric, a multi-layer fabric made using a 3D weaving process.
the fabric structure is any one or more of the following: a fabric structure made by interweaving; a fabric structure made by intertwining; a fabric structure made by inter-looping.
the fabric structure is made up of a single layer of fabric.
the fabric structure is made up of multiple layers of fabric.
the fabric structure is a multi-dimensional or 3D structure, such as a 3D woven structure.
the fabric structure is a 3D structure combined with one or more layers of fabric.
the fabric structure comprises two or more sub-layers, for example sub-layers formed from a mesh of structural fibres, alternating layers of polymer and fibres, or multiple layers of woven or non-woven composite fabric.
the performance properties (e.g. one or more of strength, stiffness, ductility, durability, weight, scratch resistance, appearance, UV light resistance) of the finished composite part or panel is achieved through the appropriate choice, applied to regions of the fabric structure, separate layers of fabric making up the fabric structure, or the entirety of the fabric structure, of one or more of the following: type of the fibre; type of the glass fibre; thickness of the fibre; type of the matrix yarn; thickness of the matrix yarn; relative proportions of the fibre and the matrix; weaving pattern of the fabric; type of weave of each fabric layer or of the fabric structure; choice of fabric for each layer in a stack of layers that is moulded in the moulding cell; choice of additives applied to the fibre; choice of additives applied to the matrix yarn; choice of additives applied to one or more of the fabric layers; choice of additives applied to the fabric structure; type of layers or coatings applied to the top of the fabric structure.
the performance properties (e.g. specific strength, impact strength), stiffness, ductility, durability, weight, scratch resistance, appearance, UV light resistance) are optimised or customised for one or more regions of the part or panel.
the ductility of the part or panel is configured such that the part or panel rebounds or reforms after impacts that are below a threshold.
a colour layer, free of any fibres, sits over the fabric structure.
the colour layer is formed from a polymer yarn.
the colour layer includes a coloured layer sandwiched between the fabric structure and an outermost, clear protective layer.
the colour layer includes one or more of: a pigment, a dye, a flame retardant a UV-absorbing additive.
the colour layer is painted.
the colour layer is a foil layer.
a veil layer sits over the fabric structure and underneath the colour layer.
the veil layer is configured to reduce print-through of the underlying fibres in the fabric structure.
the diameter of the fibres in the veil layer is less than the diameter of the fibres in the fabric structure.
the fabric structure is configured so that the part or panel is able to store and provide electrical power.

The Moulding Cell
the moulding cell produces a finished part.
the moulding cell produces a finished part that needs only trimming of excess material.
the moulding cell is a vacuum moulding cell.
the moulding cell includes a multi-use silicone membrane to form a vacuum seal around the fabric structure.
the moulding cell includes a heat source and combines vacuum and heat moulding of the fabric structure.
the moulding cell does not include a heat source and there is a separate heating system that heats the fabric structure before the fabric structure is moulded by the moulding cell.
the moulding cell is a pressure moulding cell that applies pressure to mould the fabric structure.
the mould in the moulding cell is positioned above the fabric structure and the fabric structure is forced up against the mould.
the mould in the moulding cell is positioned below the fabric structure and the fabric structure is forced down against the mould.
the mould is replaceable by an automated process that enables parts or panels with different shapes to be sequentially and automatically moulded by the moulding cell.
the moulding cell uses a 3D printed mould.
the 3D printed mould is recyclable.
the moulding cell raise the temperature of the fabric structure (composite precursor material above a reaction threshold temperature to fuse the fabric structure; and then actively or passively cools the fabric structure to below the reaction threshold temperature to set the composite part or panel.
the moulding cell is capable of moulding (e.g. sequentially) multiple different shapes of parts or panels.
robots automatically replace the moulds in the moulding cell with the required moulds, when different shapes of parts or panels need to be formed.
the fabric structure is cut into shape (e.g. laser cut, or any other textile cutting technique); multiple pieces of cut fabric structure are then assembled to form the fabric structure, or precursor material, and the fabric structure or precursor material are then sent to the moulding cell for moulding into parts or panels.
the moulding cell is controlled by an automated control system that controls the AMR that supplies fabric to the moulding cell, the robot that automatically loads and positions the fabric in the moulding cell, the robot that automatically withdraws the finished part to an AMR that moves the finished part to a trimming cell and any other post-moulding steps.

Re-Cycling
offcuts from the fabric structure are recycled or re-used to make injection moulded feedstock or for other processes.
offcuts from the fabric structure are combined together (e.g. by needle punching or stitching) to form a part (e.g. a core) of new fabric structure from which new composite parts or panels can be made.
trimmings from moulded parts are recycled or re-used, e.g. for injection moulded feedstock.
trimmings from moulded parts are chemically processed and used to make composite parts or panels.

For all the systems defined above, the following also apply:

A method of producing an automotive composite part or panel using the above system.

An automotive composite part or panel made using the above system or method.

A vehicle including one or more composite parts or panels made using the above system or method.

Group B: Properties of Composite Parts and Panels

Feature 12: Fabric Structure that is Moulded into a Soft-Touch Panel

1. A method of producing automotive composite parts or panels, the method using a moulding cell with a tool to mould a fabric structure, made of fibre and a thermoplastic matrix, to form a composite part or panel, in which at least some of the fabric structure includes a compressible or elastomer region so that the part or panel is a soft-touch part or panel.

Optional Sub-Features:
the fabric structure is made up of layers of fabric, and one of those layers is the compressible or elastomer layer.
the part is a dashboard, door trim or other internal automotive part.
the panel is an exterior panel.

Feature 13: Fabric Structure that is Moulded into a Textile-Surfaced Panel

1. A method of producing automotive composite parts or panels, the method using a moulding cell with a tool to mould a fabric structure, made of fibre and a thermoplastic matrix, to form a composite part or panel, in which the top-most region of the fabric structure has a textile-like surface, so that the part or panel has a textile-like surface.

Optional Sub-Features:
the fabric structure is made up of layers of fabric, and the top layer has a textile surface.
the part is a headliner, or a footwell, boot/trunk wall or other interior surface.
the panel is an exterior panel.

Feature 14: Fabric Structure that is Moulded into a Panel with a Grain or Patterned Surface

1. A method of producing automotive composite parts or panels, the method using a moulding cell with a tool to mould a fabric structure, made of fibre and a thermoplastic matrix, to form a composite part or panel, in which the surface of the tool includes a pattern or grain that is imparted or transferred to the top layer of the composite part or panel.

Optional Sub-Features:
the fabric structure is made up of layers of fabric, and the top layer is given the patterned or grained surface.
the part is a dashboard or other interior surface.
the panel is an exterior panel.

Feature 15: Fabric Structure that is Moulded into a Panel with a Scratch-Concealing Structure

1. A method of producing automotive composite parts or panels from a fabric structure, made of fibre and a thermoplastic matrix, and in which a finish layer or a top layer to that structure has a specific colour;
and in addition one or more underlying portions of the fabric structure has a colour that is the same as, or is sufficiently similar to, the specific colour of the finish layer or the top layer, so that scratches that penetrates the finish layer or the top layer, or other damage that affects the finish layer or the top layer, are concealed or not readily noticeable.

Optional Sub-Features:
one or more fabric layers in the structure has a colour that is the same as or sufficiently similar to the colour of the finish layer or the top layer, so that scratches that penetrate the finish layer or the top layer are concealed or not prominent.
the finish layer or the top layer is an integral part of the fabric structure.
the finish layer or the top layer is formed from the fabric structure.
the colour in the fabric structure is conferred by one or more pigments.
   The matrix yarn includes one or more pigments before it is woven together into the fabric structure.
the finish or top layer includes a first pigment, and the fabric structure includes a second pigment:
   The first pigment and the second pigment are the same.
   The first pigment and the second pigment are different.

Feature 16: Fabric Structure that is Co-Moulded with Polymer Objects

1. A method of producing automotive composite parts or panels, in which a moulding cell moulds a fabric structure, made of fibre and a thermoplastic matrix, into an automotive composite part or panel, and in which one or more plastic or other polymer objects are added to one or more layers and are co-moulded into the composite part or panel.
the object is shaped and positioned to impart a specific localised shape or feature to the part or panel.

Feature 17: Fabric Structure that is Co-Moulded with Integral Locator Feature

1. A method of producing automotive composite parts or panels, in which a moulding cell moulds layers of a fabric structure, made of fibre and a thermoplastic matrix, to form the composite part or panel; in which the part or panel is moulded with an integral locator feature that is configured to define a precise location on the part or panel.

Optional Sub-Features:
the locator feature is configured to enable the part or panel to be accurately located with respect to another part or panel, or other type of structure.

For all the methods defined above, the following also apply:

A system for producing an automotive composite part or panel configured to use the above method.

An automotive composite part or panel made using the above system or method.

A vehicle including one or more composite parts or panels made using the above system or method.

Group C Smart Composite Parts or Panels

Feature 18: Composite Panel with Integrated Electronics

1. An automotive composite part or panel that includes one or more electronic components formed directly in or on the composite part or panel during the production process of the part or panel.

Optional Sub-Features:
the composite part or panel is made using a fabric structure, made of fibre and a thermoplastic matrix.
the composite part or panel is made from a fabric structure with several fabric layers, such as layers of glass fibre-reinforced polypropylene (PPGF), or a 3D weave of thermoplastic glass fibre and a matrix, and the electronic component is formed or positioned on one of these layers or in the 3D weave.
the electronic component is a RFID component used to identify the part or panel.
the electronic component is an active component, such as a battery, integrated circuit, or sensor.
the electronic component is a passive component, such as an antenna, capacitor or inductor.

Feature 19: Composite Panel with Co-Moulded Electronic Components

1. A system for producing automotive composite parts or panels, the system including a mould that moulds a fabric structure, made of fibre and a thermoplastic matrix, to form an automotive composite part or panel, in which one or more electronic components are added to the fabric structure and are co-moulded into the composite part or pane during the moulding process.

Optional Sub-Features:
the composite part or panel is made using a fabric structure, made of glass fibre and a thermoplastic matrix.
the composite part or panel is made from a fabric structure with several fabric layers, such as layers of glass fibre-reinforced polypropylene (PPGF), or a 3D weave of thermoplastic glass fibre and a matrix, and the electronic component is added to one or more fabric layers or in the 3D weave and is then co-moulded into the composite part or panel.
the electronic component is a RFID component used to identify the part or panel.
the electronic component is an active component, such as a battery, integrated circuit, or sensor.
the electronic component is a passive component, such as an antenna, capacitor or inductor.

Feature 20: Composite Panels with Integral Identification Tags

1. Vehicle with composite parts or panels that include, integrated within the body of at least one part or of at least one panel, an identification tag, such as a RFID tag, formed into the part or panel during a moulding process that moulds a fabric structure, made of fibre and a thermoplastic matrix, to form the automotive composite part or panel, and in which one or more identification tags are added to the fabric structure to enable identification and tracking of the part or panel in warehousing and in production operations.

Optional Sub-Features:
the identification tag provides a unique identifier.
the identification tag is a passive device.
the identification tag can be written to and has read/write capability.
the identification tag is formed into the part or panel during a vacuum forming process.
the identification tag is used by robotic devices to identify the part or panel during vehicle assembly.
the identification tag includes data that relates to the production batch and/or production process.
the identification tag is used to authenticate a part or panel as being from an authorised source.
the identification tag is used to identify the part or panel throughout its lifetime, including to end-of-life re-cycling.
the composite part or panel is made from a fabric structure with several fabric layers, such as layers of glass fibre-reinforced polypropylene (PPGF), or a 3D weave of thermoplastic glass fibre and a matrix, and the passive identification tag is formed or positioned on one of these layers or in the 3D weave.
the composite part or panel is made from a fabric structure with several fabric layers, such as layers of glass fibre-reinforced polypropylene (PPGF), or a 3D weave of thermoplastic glass fibre and a matrix, and the passive identification tag is added to one or more fabric layers or in the 3D weave and is then co-moulded into the composite part or panel.

Feature 21: Composite Panels with Electrically Conductive Tracks

1. An automotive composite part or panel formed from a fabric structure, made of fibre and a thermoplastic matrix, in which one or more electrically conductive lines, tracks or other structures, are formed directly in or on the fabric structure and have defined borders that are inside, or within the edges the fabric structure.

Optional Sub-Features:
electrically conductive lines, tracks or other structures are formed directly in or on the fabric structure as part of the process for forming the fabric structure.
electrically conductive lines, tracks or other structures are formed directly in or on the fabric structure as part of the weaving process for forming the fabric structure.
fabric structure is made up of layers of a thermoplastic glass fibre and matrix fabric, and at least one of the layers includes one or more of the electrically conductive lines, tracks or other structures formed directly in or on that layer.
lines, tracks or other structures are discrete or bounded structures in or on the layer.
lines, tracks or other structures are predetermined or specifically designed.
electrically conductive lines or structures carry data.
electrically conductive lines or structures carry power.
electrically conductive lines or structures are tapes.
electrically conductive lines or structures are flexible PCBs.
electrically conductive lines or structures are made of conductive glue, such as silver doped epoxy resin.
electrically conductive lines or structures are embedded conductive fibres.
electrically conductive lines or structures are embedded optical fibres.
electrically conductive lines or structures are created or added during the production process of the part or panel.
electrically conductive lines or structures form a grid or array to which components are added during vehicle production.
electrically conductive lines or structures include fuse areas that can be blown to configure the electrically conductive lines or structures into a desired pattern.
electrically conductive lines or structures replace vehicle wiring harnesses.

Feature 22: Composite Panels with Networked Sensors

1. Vehicle with composite parts or panels that include a distributed array of sensors whose output is collectively analysed to provide environmental information, with no individual sensor providing data of sufficient trustworthiness to be solely acted on, but which, when combined, is sufficiently reliable to be acted on.

Optional Sub-Features:
sensors are integrated within the body of at least one part or at least one panel.
composite panels are exterior vehicle body panels.
composite parts comprise a frame of the vehicle.
multiple panels include sensors that form part of the distributed array.
sensors are configured for robotic assembly into a body panel.
sensors connect to data and/or power lines or other structures that are integrally formed on or in the part or panel.
sensors include computer vision sensors.
sensors include people or device proximity sensors.
sensors are low-cost sensors that individually do not provide data of sufficient trustworthiness to be solely acted on.

Feature 23: Composite Panels where Outputs from Multiple Low Accuracy Sensors are Combined

1. A composite part or panel including a distributed array of sensors, each sensor being configured to contribute phase and magnitude information of limited accuracy, wherein the phase and magnitude information from individual sensors can be combined so that the composite part or panel serves as a sensor having an enhanced level of accuracy.

Optional Sub-Features:
the sensors serve as passive detectors or active detectors.
the sensors are configured to measure attributes of at least one of the external environment of the vehicle, the internal environment of the vehicle, and the condition of the vehicle itself.
each sensor is configured to withstand a temperature at which the part or panel is moulded into shape.
the sensors are configured to measure attributes of one or more other vehicle in the vicinity of the sensors (e.g. the position of the vehicle, the speed of the vehicle, and the direction of motion of the vehicle).
each sensor is part of a MEMS device which is integrated within the part or panel.
each MEMS device includes at least one of a microphone, a pressure sensor, a load sensor, a fibre optic sensor, a lidar sensor, a radar sensor, a force sensor, a strain sensor, and a stress sensor.
the part or panel comprises one or more piezo devices configured to emit or receive sound waves at subsonic frequency.

Group D Factory integration; Vehicle Assembly using Composite Parts or Panels

Feature 24: Composite Panel with Integral Fixing Features

1. An automotive composite part or panel that is produced using a moulding cell that moulds a fabric structure, made of fibre and a thermoplastic matrix, to form the composite part or panel;
in which the part or panel is moulded with an integral fixing feature that is configured to enable the part or panel to be attached or fixed to another part or panel or other structure by a robotic device.

Feature 25: Composite Panel with Auto-Aligning Features

1. A method of producing automotive composite parts or panels, the method using a moulding cell with a tool to mould a fabric structure, made of fibre and a thermoplastic matrix, to form a composite part or panel, in which the composite part or panel is shaped to include features that, when assembled with another structure, correctly aligns the part or panel, e.g. in the X, Y and/or Z directions, in relation to the other structure.

Feature 26: Automated System for the Production of Automotive Composite Parts or Panels from Fibre and a Matrix

1. An automated system for the production of automotive composite parts or panels, the system including the following sub-systems:
a loom to weave or otherwise combine fibre and matrix yarn into fabric;
a moulding cell to mould the fabric into a composite part or panel;
a trimming cell to trim and shape the composite part or panel to a final shape, and in which all sub-systems are connected together in a data network and form a single, integrated system for the creation of automotive composite parts or panels from source fibre and a matrix.

Feature 27: Integrated Control System for the Production and Assembly of Panels or Parts

1. A factory including an automated system for the production of automotive composite parts or panels from source fibre and a matrix; in which production of composite parts or panels is determined by the requirements of a control system that also controls robotic cells that assemble the parts or panels into vehicles.

Feature 28: Matrix or Cell-Based Production of Composite Parts or Panels

1. A factory including multiple robotic cells that use matrix assembly operations controlled by a cell-based or matrix assembly software system, and not a conventional production line, to produce composite parts or panels, where the cells are not restricted from handling materials in a sequence defined by the cells' physical location;
in which the robotic cells include cells for some or all of the following: a spinning machine to spin fibre and yarns, a loom to weave the fibre and yarns into a fabric structure, a moulding cell to mould the fabric structure into a composite part or panel, a trimming cell to trim and shape the composite part or panel to a final shape, and a bonding cell to bond different part or panel sections together.

Optional Sub-Features:
robotic cells are configured to perform cell-based or matrix assembly operations using computer vision to identify, track, and perform tasks.
the moulding cell is configured to perform moulding and demoulding using matrix assembly operations controlled by the cell-based or matrix assembly software system.

Feature 29: Cell-Based or Matrix Production Integration

1. A factory including multiple robotic cells that use matrix assembly operations controlled by a matrix assembly software system, and not a conventional production line, to assemble vehicle sub-systems and vehicles and in which at least some of the body parts or panels for the vehicle are not made of stamped or pressed metal but instead from composite parts or panels made from fibre and a matrix in an automated production system;
and in which the matrix assembly software system sends demand data to the production system and the production system sends supply data to the matrix assembly software system.

Feature 30: Composite Panels that are Mechanically Attached Using Robots

1. An automotive composite part or panel that is produced using a moulding cell that moulds a fabric structure, made of fibre and a thermoplastic matrix, to form the composite part or panel; in which the part or panel is configured for robotic attachment to structural members in a vehicle during the building of the vehicle.

Optional Sub-Features:
parts or panels are flat, curved, or have any required shaped or thickness or variable thickness.
panels are non-stressed.
panels are configured for mechanical attachment to parts or panels using clips.
parts or panels are configured for chemical or glue attachment.
parts or panels are removable and recyclable as a feedstock for injection moulding.
parts comprise a frame of the vehicle.
structural members include a skateboard platform.
structural members include vertical frames, such as aluminium extruded frames.
composite parts or panels are produced using reinforcing glass fibres and a thermoplastic polymer, such as polypropylene.
composite parts or panels are a glass-reinforced plastic (GRP).
composite parts or panels are made from woven thermoplastic composite yarns.
composite panels make up substantially all side panels of the vehicle.
composite panels make up substantially all roof panels of the vehicle.
composite panels make up substantially all front and rear panels of the vehicle.
composite parts make up substantially all of the frame of the vehicle.
vehicle is an electrically powered vehicle.
vehicle is a car, van, or bus.

Group E Automotive vehicles with composite parts or panels

Feature 31: Vehicle Side Panels are all Non-Stressed Composite Panels

1. Automotive vehicle with composite body panels that make up substantially all side panels of the vehicle and are non-stressed, providing no substantial torsional rigidity for the vehicle.

Feature 32: Vehicle Side Panels are Coloured (not Painted) Composite Panels

1. Automotive vehicle with composite body panels that make up substantially all side panels of the vehicle and are coloured during the panel production process.

Feature 33: Vehicle Skateboard Platform Supports Different Composite Panel Top Hats

1. Automotive vehicle skateboard platform configured to receive composite body panels that make up substantially all side panels of the vehicle and which are available or capable of being produced in a number of different shapes to enable various different vehicle types, such as van, car, pick-up truck, to be produced with the same vehicle skateboard platform.

Feature 34: Vehicle Skateboard Platform Supports Different Top Hats Comprising Composite Parts

1. Automotive vehicle skateboard platform configured to receive a frame structure formed from composite parts, the frame structure being available in a number of different shapes to enable various different vehicle types, such as van, car, pick-up truck, to be produced with the same vehicle skateboard platform.

The following optional sub-features apply to each of the preceding Features 1-34:
glass fibre and matrix yarns are only brought together at the time of weaving and are not co-mingled or plied.
yarn is formed from glass fibre and a matrix that are not co-mingled.
yarn is formed from glass fibre and a matrix that are co-mingled.
thermoplastic matrix is polypropylene.
proportions of glass fibre to the matrix in the yarn are chosen to give the final composite part or panel redefined properties.
yarn is glass fibre-reinforced polypropylene (PPGF).
a kitting cell assembles a stack of layers of fabric together, in which different layers provides specific material properties.
offcuts of fabric, e.g. from any kitting cell (if used), are re-used as core layers.
autonomous guided vehicle (AMR) transfers fabric, or the stack of layers (e.g. from the kitting cell, if used) to the moulding cell.
an autonomous robot in or associated with the kitting cell and an autonomous guided vehicle (AMR) are configured to move relative to one another to build up one or more stacks of layers of composite material on an upper surface of the autonomous guided vehicle (AMR).
stack of layers includes a colour layer and a veil layer sitting over the layers of fabric.
The veil layer confers surface texture, minimising pattern show through, and contributing to the binding of the colour layer to the layers of composite material.
the moulding cell is a vacuum moulding cell.
the moulding cell is a pressure moulding cell.
composite panels are side panels of a vehicle.
composite panels are roof panels of a vehicle.
composite panels are door panels of a vehicle.
composite panels are interior panels of a vehicle.
composite parts comprise a frame of a vehicle.

Composite Precursor Material
the moulding cell forms a stack of precursor material.
A stack of precursor material comprises a plurality of fabric layers, with the number and/or thickness of the layers being selected according to the part to be produced.
A layer of precursor fabric material is formed by glass fibre roving and matrix yarn being woven together in a loom.
   the matrix is a thermoplastic.
Each layer of the stack of precursor material has one or more attributes that are customised for the part that is to be produced.
   the layer comprises a selected fibre (e.g. glass fibre).
   the layer comprises a selected matrix (e.g. polypropylene).
   the layer comprises a selected proportion of fibre to matrix (e.g. 60:40).
The stack of precursor material further comprises one or more finish layers.
   the finish layer is a laminated layer.
   the stack comprises a colour layer.
   the stack comprises a veil layer (e.g. an elastomer veil, e.g. chemically compatible with matrix so that the composite material is suitable for recycling)
   finish layers confer a class A finish, a gloss finish, a non-woven finish, or a tactile finish.
   finish layers applied to both sides of the stack.
Each layer of precursor material in the stack has a colour that is substantially similar to the colour of the finish layer.
A layer of the precursor material is formed of recycled composite material (e.g. PPGF)
A layer of the precursor material is configured to conduct electricity.
   The conductive composite layer comprises conductive particles.

Kitting of the Precursor Material:
The precursor material is cut into shape, and formed into a stack of fabric layers.

Electronic Components
Electronic components are integrated within the stack of precursor material (e.g. RFID tags; alternative to cassette).
Electrical contacts are integrated within the stack of precursor material.

Transfer of Precursor into Mould:
the stack of precursor material including the finish layer is transferred into the mould.
the finish layer is transferred into the mould, and then the precursor material is transferred into the mould.
a release layer is provided in the mould, fabric, veil or film, to facilitate removal of the consolidated composite material.
the mould is coated with the release layer, and the fabric structure is then positioned in the mould.
the fabric structure is coated with the release layer, and is then positioned in to the mould.
Transfer of the precursor material to the mould is performed autonomously.
Transfer of the precursor material to the mould is performed by an autonomous robot.
The precursor material is arranged in the mould by an autonomous robot system with a computer vision system configured to assess whether the precursor material is correctly positioned in the mould and one or more end-effectors configured to form the precursor material into the correct shape or position in the mould.

Attributes of the Mould:
The mould is hollow and is formed by a moulding process.
   The mould comprises a valve configured to maintain air pressure outside the mould, so that it is not crushed due to the vacuum.
A mould skin is inserted into a mould support.
   The mould skin is formed from the pattern.
   The mould skin comprises pitch fibre (e.g. carbon fibre, which has a high thermal conductivity).
   The mould skin comprises high-temperature tooling resin (e.g. epoxy, which improve efficiency by reducing the heating time).
   The surface of mould skin has a durable coating (e.g. a 95% aluminium gel coat or deposition).
The mould is configured to engage with a membrane to form an air-tight seal.
   The membrane is configured to dissipate heat quickly (e.g. a thin layer of rubber or silicone).

The Mould is Single Sided:
A single sided mould is brought into contact with a first side of the stack of precursor material.
   A vacuum bag is brought into contact with a second side of the precursor material.
   A membrane is brought into contact with a second side of the precursor material.
   A plug is brought into contact with a second side of the precursor material.
   A tool formed from silicone is brought into contact with a second side of the precursor material.
The second side of the stack of precursor material comprises a release layer.
The second side of the stack of precursor material comprises a breather layer.

The Mould is Produced from a Pattern:
The pattern is created from CAD that specifies the shape of the finished part.
The finished part is designed so that panel is draped over a frame, which ensures that the panel is non-stressed.

Pressure Differential:
One or more fluid conduits are configured to remove or supply fluid.
Consolidation of the composite is performed at low pressure.
   Negative pressure is achieved by pumping air out of the mould via the one or more fluid conduits.
Consolidation of the composite is performed by application of positive pressure.

Heating Device:
Heating is local.
   heating is provided by an induction technique.
   heating is provided by a resistive technique.
   heating is provided by a conductive technique.
The heating device is integrated into the mould.
The heating device is integrated into the composite precursor material.
The precursor material is vacuum formed before being heated (this technique makes it easier to handle precursor).
The precursor material is heated before being vacuum formed.
   pre-heating material between 2 diaphragms, and then forming.

Cooling of the Consolidated Material:
The apparatus for producing the composite part further includes a cooling device.
   The cooling device is a fan.
   cooling is introduced via the membrane.
   cooling is introduced via the mould.
Heat dissipates well from thin film of silicone.
Pitch fibre is a conductor of heat.
Basalt is an insulator of heat, so cooling adapted to accommodate for this.

For the Case of the Mould being Positioned Below the Composite Material:
The precursor composite material is brought into position within the mould, before a vacuum seal is formed on the other side.

Mould Support:
The mould support is hollow, and comprises a valve which is used to vent the mould support to air pressure during the vacuum seal process.
The mould support comprises a table, onto which the mould is placed.
The mould support comprises a buck, into which the mould is placed.
   The buck is formed of basalt.
   The mould is formed of pitch fibre.

Composite Support:
The composite is transferred from the kitting cell to the moulding cell by an autonomous vehicle.
The mould itself provides the composite support during the moulding process.
The precursor material is positioned within the mould autonomously by a machine.

Transfer mechanism:
Pressure differential is a vacuum:
   Thin film of air tight membrane (e.g. a thin film of silicone).
   Air tight membrane brought into position from above (therefore, this serves as a diaphragm, holding the composite precursor material in place as a flat surface).
Pressure differential applies positive pressure:
   A plug which is pushed into the mould (e.g. a plug of silicone).
   The shape of the plug is selected that accommodates the thermal expansion of the plug.

For the case of the mould positioned above the composite material:
A vacuum is formed raising the composite precursor material into position within the mould.

Mould support:
In use, the mould is disposed above the composite material.
The mould is held in position above the composite material by the mould support.

Composite support:

The composite support comprises a table, onto which the composite precursor material is placed.
The composite support comprises a diaphragm, onto which the composite precursor material is placed.
The composite support comprises a first diaphragm onto which the composite precursor material is placed, and a second diaphragm which in use is positioned above the composite precursor material.

Transfer mechanism:
The transfer mechanism is configured to actuate a pressure differential across the composite precursor material to confirm the precursor material to the mould.

Appendix 1 Section I: The Arrival Van System

In this Appendix 1, Section I, we summarise the key Features of the Arrival Van system.

Note also that the vehicles described in this Appendix 1 Section I can use some or all of the Features and optional sub-features relating to: the hardware modularity described in Appendix 1 Section A; the software modularity described in Appendix 1 Section B; the security model described in Appendix 1 Section C; can be designed using some or all of the Features and optional sub-features relating to vehicle design flow and Vehicle Builder software tool described in Appendix 1 Section D; can be assembled into vehicles using some or all of the Features and optional sub-features relating to the robotic production environment and microfactories described in Appendix 1 Section E; can use some or all of the Features and optional sub-features relating to the battery modules and PCB connector described in Appendix 1 Section G; can utilise some or all of the Features and optional sub-features relating to the composite panels and parts described in Appendix 1 Section H; can use some or all of the Features and optional sub-features relating to the Arrival Bus described in Appendix 1 Section J; and can use some or all of the Features and optional sub-features relating to the Arrival Car described in Appendix 1 Section K.

This Appendix 1, Section I describes a number of features, adopted variously in the Arrival Van implementations of the invention. We categorise these features into the following five groupings:
A. Arrival Van: Driver Ergonomic Features
B. Arrival Van: Physical Construction Features
C. Arrival Van: Automated Customer Configuration using Vehicle Builder and Automated Production using Robofactoring in a Microfactory

A. Arrival Van: Driver Ergonomic Features

Feature 1: Van with Single Uninterrupted Internal Floor from Driver Seat Through to Cargo Area, Sitting on a Low Level Chassis with a Battery Pack

1. An electric van with (i) a flat floor mounted on a chassis, and (ii) a battery pack or packs that is in, or part of, or mounted on, the chassis; and where the flat floor is a single, flat uninterrupted floor surface that is no more than 480 mm up from the ground and is configured to provide a pathway that leads from the driver's seat, into and through a cargo area in the van.

Optional Sub-Features:
single, flat uninterrupted floor surface covers substantially the entire cargo area through which a driver passes in normal use when selecting and picking up packages that are stored in the cargo area.
single, flat uninterrupted floor surface continues to an internal step that leads to a rear door.
single, flat uninterrupted floor surface continues to a rear door.
skateboard platform includes multiple battery modules, such as HVBMs.
floor surface is approximately 460 mm from the ground.
the ground clearance of the van is approximately 180 mm.
driver's footrest is approximately 250 mm-260 mm above the single, flat uninterrupted floor surface.
the driver's seat raised platform extends into a footwell and the brake and accelerator pedals are mounted above the raised platform.
floor surface has a surface configured for cleaning.
height of the van above the floor surface is at least 2200 mm so that a typical driver can walk through the driver's cabin into and through the cargo area, without bending down.
the van includes driver doors and a side door for the cargo area, the side door being approximately 1700 mm high and 1350 mm wide.
side and roof panels are made from lightweight composites.
the van is at least in part configured using an automated vehicle design tool that automatically selects components required for a customer's specification; and
automatically generates build instructions for that van or fleet of vans.
the van is produced in a microfactory.

Feature 2: Van with Single Uninterrupted Internal Floor from the Driver Seat Through to the Cargo Area, Sitting on a Low Level Chassis with a Battery Pack, and with a Single Walk-in Step Up from the Ground to the Driver Cab

1. An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and where the driver cabin includes a single internal step down to a lower area, or walk-in step, that is adjacent to a door to the driver cabin, and the walk-in step is no more than 350 mm above the ground, and the height of the single step up to the single, flat uninterrupted floor surface is no more than 180 mm.

Optional Sub-Features:
single, flat uninterrupted floor surface covers substantially the entire cargo area through which a driver passes in normal use when selecting and picking up packages that are stored in the cargo area.
single, flat uninterrupted floor surface continues to an internal step that leads to a rear door.
single, flat uninterrupted floor surface continues to a rear door.
the walk-in step is approximately 300 mm above the ground.
the height of the single step is approximately 160 mm.
the lower area, or walk-in step, is approximately 650 mm wide.
single, flat uninterrupted floor surface covers substantially the entire cargo area through which a driver passes in normal use when selecting and picking up packages that are stored in the cargo area.
driver's footrest is approximately 250 mm-260 mm above the single, flat uninterrupted floor surface.
floor surface is approximately 460 mm from the ground.
floor surface is no more than approximately 480 mm from the ground.
the driver's seat raised platform extends into a footwell and the brake and accelerator pedals are mounted above the raised platform.
skateboard platform includes multiple battery modules, such as HVBMs.
floor surface has a surface configured for cleaning.

Feature 3: Van with Single Uninterrupted Internal Floor from the Driver Seat Through to the Cargo Area, Sitting on a Low Level Chassis with a Battery Pack and with a Single Walk-in Step Up from the Ground to the Cargo Area

1. An electric van with (i) a flat floor mounted on a chassis, and (ii) a battery pack or packs that is in, or part of, or mounted on, the chassis; and where the flat floor is a single, flat uninterrupted floor surface that is configured to provide a pathway that leads from the driver's seat, into and through a cargo area in the van;
and there is a single internal or external step down to a lower area, or walk-in step or ramp that is in or adjacent to the cargo area, and the walk-in step or ramp is no more than 350 mm above the ground at its lowest point, and the height of the single step or ramp from that lowest point up to the single, flat uninterrupted floor surface is no more than 180 mm.

Optional Sub-Features:
single, flat uninterrupted floor surface covers substantially the entire cargo area through which a driver passes in normal use when selecting and picking up packages that are stored in the cargo area.
single, flat uninterrupted floor surface continues to an internal step that leads to a rear door.
single, flat uninterrupted floor surface continues to a rear door.
the internal step down is no more than 200 mm in height.
the internal step down is approximately 160 mm in height.
the internal step down lies beyond one end of the skateboard platform.
a roller door covers the full height exit.
stair tread or surface is at the base of a full height exit from the rear of the van.
floor surface is approximately 460 mm from the ground.
floor surface is no more than 480 mm from the ground.

Feature 4: Van with Single Uninterrupted Internal Floor from Driver Seat Through to Cargo Area, Sitting on a Low Level Chassis with a Battery Pack and with the Single Uninterrupted Floor Continuing to a Raised Platform the Driver's Seat is Mounted on

1. An electric van with (i) a flat floor mounted on a chassis, and (ii) a battery pack or packs that is in, or part of, or mounted on, the chassis; and where the flat floor is a single, flat uninterrupted floor surface and is configured to provide a pathway that leads from the driver's seat, into and through a cargo area in the van;
and in which the driver's seat is mounted on a platform that is raised above the single, flat uninterrupted floor surface and that also provides a footrest for the driver whilst driving, and the footrest is configured so that the driver can pivot across or turn on the seat to put his or her feet on the uninterrupted floor surface and to then move up and out from the driver's seat to the passenger exit without any hindrance or obstruction from the footrest.

Optional Sub-Features:
the rear surface of the footwell is substantially flat or includes no features or obstructions, other than the accelerator and brake pedal.
footwell runs uninterrupted across the width of the driver cabin to a raised platform;
and an accelerator and a brake pedal is mounted in the footwell.
there is no handbrake or gear shift or bulkhead protruding into the footwell.
a dashboard or runs across the width of the driver cabin, lying over the footwell
the dashboard has a substantially flat surface facing into the driver cabin.
the dashboard has a substantially flat and straight surface facing into the driver cabin.
the dashboard includes or has mounted on it a rectangular touch screen display that shows normal van operational data, such as speed, range, sat nav with route guidance, and also integrates all driver work or task information, such as information on packages to be delivered, whether the delivery schedule is being met, voice call or text function to let package recipients know when the driver will deliver their package, reporting delays in delivering packages to recipients and to a central office.
raised platform includes a seat post on which the driver's seat is mounted.
driver's footrest is approximately 250 mm-260 mm above the single, flat uninterrupted floor surface.
skateboard platform provides a substantially flat floor for substantially the entire cargo area through which a driver passes in normal use when selecting and picking up packages that are stored in the cargo area.
skateboard platform includes multiple battery modules, such as HVBMs.
floor surface is approximately 460 mm from the ground.
floor surface is no more than 480 mm from the ground.
floor surface has a surface configured for cleaning.

Feature 5: Van with a Low Level Chassis with Large Driver Cone of View

1. An electric van with (i) a flat floor mounted on a chassis, and (ii) a battery pack or packs that is in, or part of, or mounted on, the chassis; and where the flat floor is no more than 480 mm up from the ground;
and in which the bottom and top edges of the windscreen and the driver's seat are configured to give the driver a cone of view that is at least 45 degrees.

Optional Sub-Features:
the driver's seat positions the driver's face approximately 2200 mm from the front of the van.
base of the windscreen is approximately 1100 mm from the ground.
base of the windscreen is approximately 125 mm from the front of the van.
the base of the windscreen is no more than approximately 140 mm from the frontmost part of the van.
the base of the driver's seat is no more than approximately 800 mm above the ground;
the driver's seat is mounted on a seat column and the top of that platform is approximately 730 mm-740 mm above the ground.
the height of the top of the skateboard platform is approximately 460 mm from the ground.
the cone of view enjoyed by the driver is approximately 46 degrees.
cone of view from the top of the cone to the horizontal, or the forward-up vision, is approximately 29 degrees.
cone of view from the top of the cone to the horizontal, or the forward-up vision, is at least 27 degrees.
cone of view from the bottom of the cone to the horizontal, or the forward-down vision, is approximately 17 degrees.
cone of view from the bottom of the cone to the horizontal, or the forward-down vision, is at least 15 degrees.
the bulkhead that separates the driver cab from the cargo area is no more than 2500 mm from the front of the van and the back of the driver's seat is adjacent to that bulkhead.

Feature 6: Van with a Low Level Chassis, with a Driver Seat Positioned at an Optimal Distance from the Front of the Van

1. An electric van with a platform configured to provide a single, flat uninterrupted floor surface and pathway from the driver's seat, into and through the length of a cargo area in the van;
and in which the driver's seat is mounted on a seat column and the top of that seat column is no more than 800 mm above the ground; and the driver's seat positions the driver's face between 2000 mm and 2400 mm from the front of the van.

Optional Sub-Features:
the base of the windscreen is approximately 125 mm from the frontmost part of the van.

Feature 7: Van with a Landscape Mode Touchscreen Positioned Above the Bottom Edge of the Dashboard

1. An electric van with a platform configured to provide a single, flat uninterrupted floor surface that extends from the driver cabin, into and through a cargo area in the van, and to the rearmost end of the cargo area, and a dashboard, a steering wheel mounted over the dashboard and a landscape format touchscreen that enables the driver to control vehicle functions, and to display navigation and routing information;
and in which the bottom edge of the landscape format touchscreen is positioned sufficiently above the bottom edge of the dashboard that a driver can approach the driver's seat from the passenger side and move his or her legs across to sit down in the driver's seat without any hindrance or obstruction from the touchscreen.

Optional Sub-Features:
The lower edge of the touchscreen is above the lower edge of the steering wheel.
the mid-height of the touchscreen aligns with the middle of the steering wheel.
the touchscreen is generally at the same height as the steering wheel.

Feature 8: Vehicle with UWB Proximity Sensor that Provides Secure Vehicle Access

1. A vehicle access control system including a touch or proximity sensor (such as a capacitive touch sensor) integrated into an external or internal surface of the vehicle by each door to the vehicle and which controls the unlocking of a specific vehicle door, and not a general opening of all doors to the vehicle, only if (i) a wireless key approved for that vehicle is present sufficiently close to a sensor that is adjacent to that specific door and (ii) the sensor is manually activated by a driver's touch or proximity or specific gesture.

Optional Sub-Features:
The sensor is sensitive to the hand of a user.
The sensor is sensitive to a signal emitted by an electronic device (e.g., a phone or fob).
The sensor is a touch or proximity capacitive sensor
The sensor receives UWB signals and/or NFC signals.
The sensor is integrated into an exterior panel of the vehicle.
The exterior panel of the vehicle is formed from composite material.
The door is a hinged door, sliding door, roller shutter door or other form of closure.

Feature 9: Steering Wheel with Integral Touch Pads

1. Vehicle with a steering wheel including one or more directional touch sensors integrated into the steering wheel and each including a substantially flat top surface configured to operate as a touch pad.
the mid-height of the touchscreen aligns with the middle of the steering wheel.
the touchscreen is generally at the same height as the steering wheel.

B. Arrival Van: Physical Construction Features

Feature 10: Van with Lightweight Body Made from Composite Panels

1. An electric van with (i) a flat floor mounted on a chassis, and (ii) a battery pack or packs that is in, or part of, or mounted on, the chassis; and body panels made of composite material mounted on light weight extruded aluminium struts or members that are connected to the chassis.

Optional Sub-Features:
composite exterior and interior side panels are attached to the aluminium struts or members.
aluminium struts or members are substantially straight.
aluminium struts or members are made of extruded aluminium.
aluminium struts or members are fixed using glue to the skateboard platform.
aluminium struts or members extend across the roof.
one or more transparent or partially transparent composite panels are used for the roof.

Feature 11: Van with Composite Exterior and Interior Side Panels, Each with a Class A Surface

1. An electric van with composite exterior side panels, each with a Class A surface.

Optional Sub-Features:
composite exterior and interior side panels are also attached to structural pillars.
structural pillars are substantially straight.
structural pillars are made of extruded aluminium.
structural pillars are fixed using glue to the skateboard platform.
structural pillars extend across the roof.
one or more transparent or partially transparent composite panels are used for the roof.

Feature 12: Van with Side Door In-Between Structural Pillars

1. An electric van in which the sides of a cargo area are formed using substantially straight, vertical structural pillars that are attached to the platform, with composite panels fitted between at least some of the structural pillars, and a cargo door is positioned between two of the vertical, structural pillars.

Optional Sub-Features:
the side door for the cargo area is approximately 1700 mm high and 1350 mm wide.
the cargo door is non-structural.
the skin of the cargo door is a lightweight composite panel.
structural pillars are approximately vertical.
structural pillars are inclined at no more than 10 degrees to the vertical
structural pillars are made from extruded aluminium.
the gap between pairs of structural pillars is approximately 1500 mm.
there are three sets of structural pillars.
there are four sets of structural pillars.
the side door for the cargo area, the side door being approximately 1700 mm high and 1350 mm wide.
a bulkhead separating the driver cabin from the cargo area is formed from substantially straight structural pillars.
the panels are made of composite material.
skateboard platform configured to provide a single, flat uninterrupted floor surface and pathway from the driver's seat, into and through the length of a cargo area in the van.

Feature 13: Van with Forward Bulkhead

1. An electric van with a platform configured to provide a single, flat uninterrupted floor surface and pathway from the driver's seat, into and through the length of a cargo area in the van; in which the floor surface is no more than 480 mm from the ground; and the bulkhead that separates the driver cab from the cargo area is no more than 2500 mm from the front of the van.

Optional Sub-Features:
the bulkhead that separates the driver cab from the cargo area is approximately 2300 mm from the front of the van.
the bulkhead is formed from substantially straight structural pillars.
the height of the top of the skateboard platform is approximately 460 mm from the ground.

Feature 14: Van with Fully Customisable Cargo Area

1. An electric van in which the length of the cargo area defined by a customer for that van, determines, when the van is being automatically configured for production by an automated vehicle design tool, a required length for extruded aluminium longitudinal members that define the sides of the chassis or platform;
and the height of the cargo area defined by the customer determines, when the van is being automatically configured for production by the automated vehicle design tool, determines a required height of extruded aluminium structural pillars that are themselves attached to the chassis or platform.

Optional Sub-Features:
the bulkhead that separates the driver cab from the cargo area is no more than 2500 mm from the front of the van.
the bulkhead that separates the driver cab from the cargo area is approximately 2300 mm from the front of the van.
the bulkhead is formed from substantially straight structural pillars.
structural pillars are substantially straight.
structural pillars are made of extruded aluminium.
structural pillars are fixed using glue to the skateboard platform.
structural pillars extend across the roof.
composite exterior and interior side panels are also attached to structural pillars.
translucent roof panel is also attached to structural pillars.
skateboard platform provides a substantially flat floor for substantially the entire cargo. area through which a driver passes in normal use when selecting and picking up packages that are stored on the shelves.

Feature 15: Van with Shelves Cantilevered to Structural Pillars, and the Pillars are Fixed to the Chassis

1. An electric van with shelves fitted in a cargo area of the van, in which the shelves are mounted on cantilever arms and the cantilever arms are themselves fixed to vertical structural frames or pillars that form the structural skeleton of the sides of the cargo area and the vertical structural frames or pillars are themselves attached to a platform that provides a substantially flat floor for substantially the entire cargo area through which a driver passes in normal use when selecting and picking up packages that are stored on the shelves.

Optional Sub-Features:
structural pillars are substantially straight.
structural pillars are made of extruded aluminium.
structural pillars are fixed using glue to the skateboard platform.
structural pillars extend across the roof.
composite exterior and interior side panels are also attached to the structural pillars.
the vertical position of the cantilever arms on the straight, structural pillars is set when the van is assembled.
the vertical position of the cantilever arms on the straight, structural pillars is adjustable after the van is assembled.
skateboard platform.
the shelves are coated in a material that facilitates cardboard packages being slide along the length of the shelves.

Feature 16: Van with Skylights

1. A electric van with roof panels made of composite material mounted on light weight extruded aluminium struts or members, and each including a central clear or transparent section configured to form part of a skylight running over some or all of the cargo area.

Optional Sub-Features:
the central clear or transparent section is itself made of composite material.
the central clear or transparent section is itself made of translucent plastic.

Feature 17: Vehicle with Service Hatch

1. A vehicle with a single region for all service connections for consumable fluids, such as coolant fluid, brake fluid, and windscreen cleaner fluid, and which is accessed by opening a hinged flap or other cover that is located at waist height or above.

Optional Sub-Features:
the hinged flap is positioned underneath and substantially adjacent to the windscreen.
the hinged flap runs across the width of the vehicle.
the hinged flap exposes the vehicle headlights.

Feature 18: Van with Independent Suspension System Mounted in Each Structural Wheel Arch

1. An electric van in which an independent suspension system is mounted directly to a structural wheel arch.

Optional Sub-Features
suspension mounting point is at the top or apex of the structural wheel arch, which is substantially symmetrical.
a motor is mounted directly to the structural wheel arch.

Feature 19: Van with Side Window Including a Drop-Down Glazing Unit

1. Van with side window including a drop-down glazing unit that is integrated within the side window.

C. Arrival Van: Automated Customer Configuration using Vehicle Builder and Automated Production using Robofactoring at a Microfactory

Feature 20: Vehicle with Customer-Specified Battery Capacity

1. An electric vehicle design and production process, the vehicle including multiple batteries;
in which a customer specifies the battery capacity or range required for a specific new vehicle or fleet of vehicles, and an automated vehicle design tool then automatically selects battery-related components required for the specified battery capacity or range; and automatically generates build instructions for that vehicle or fleet of vehicles;
and a robotic production environment then automatically builds or assembles the vehicle as designed by the automated vehicle design tool, including a battery pack that meets the specified battery capacity or range.

Feature 21: Vehicle with Integrated, Customer-Specified Sensors

1. An electric vehicle design and production process, the vehicle including multiple sensor based systems, such as ADAS, LIDAR, computer vision based driver monitoring, computer vision based cargo monitoring, load or weight sensors;
in which a customer specifies which sensor based systems or their related functionality are required for a specific new vehicle or fleet of vehicles, and an automated vehicle design tool then automatically selects components required for the specified sensor based systems or their related functionality; and automatically generates build instructions for that vehicle or fleet of vehicles;
and a robotic production environment then automatically builds or assembles the vehicle as designed by the automated vehicle design tool, integrating the sensor based systems into the vehicle.

Feature 22: Van with Configurable Cargo Area

An electric van design and production process, the van including a cargo area;
in which a customer specifies the requirements for the cargo area; and an automated vehicle design tool then automatically selects components required for that specification; and automatically generates build instructions for that van or fleet of vans;
and a robotic production environment then automatically builds or assembles the vehicle as designed by the automated vehicle design tool, including a cargo area that meets that specification.

Feature 23: Robotic, Cell Based Production

1. A method of producing a vehicle, in which a robotic production environment assembles, at a fixed location and not a moving production line, at least the chassis, composite body panels and supporting structures for those panels using instructions generated by an automated vehicle design tool from a customer specification for that vehicle.

Feature 24: The Microfactory

1. A vehicle production factory comprising a number of robotic production cells for vehicle production, each cell comprising a group of robots that are programmed to assemble, at a fixed location and not a moving production line, at least the chassis, composite body panels and supporting structures for those panels using instructions generated by an automated vehicle design from a customer specification for that vehicle.

Feature 25: Post Production Change to a Different Battery Pack Capacity

1. An electric vehicle with an original factory-installed battery pack, including multiple battery modules, with a specific battery capacity;
in which the vehicle is configured to enable the original battery pack to be altered by adding one or more further battery modules to the battery pack, or removing one or more battery modules from the battery pack.

Feature 26: Post Production Update of Integrated, Customer-Specified Sensors

1. An electric vehicle with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the vehicle's data and security network and systems.

Optional features:
The sensors include one or more of the following: ADAS, LIDAR, computer vision based driver monitoring, computer vision based cargo monitoring, load or weight sensors

Appendix 1 Section J: The Arrival Bus System

In this Appendix 1, Section J, we summarise the key Features of the Arrival Bus system.

Note also that the vehicles described in this Appendix 1 Section J can use some or all of the Features and optional sub-features relating to: the hardware modularity described in Appendix 1 Section A; the software modularity described in Appendix 1 Section B; the security model described in Appendix 1 Section C; can be designed using some or all of the Features and optional sub-features relating to vehicle design flow and Vehicle Builder software tool described in Appendix 1 Section D; can be assembled into vehicles using some or all of the Features and optional sub-features relating to the robotic production environment and microfactories described in Appendix 1 Section E; can use some or all of the Features and optional sub-features relating to the battery modules and PCB connector described in Appendix 1 Section G; can utilise some or all of the Features and optional sub-features relating to the composite panels and parts described in Appendix 1 Section H; can use some or all of the Features and optional sub-features relating to the Arrival Van described in Appendix 1 Section I; and can use some or all of the Features and optional sub-features relating to the Arrival Car described in Appendix 1 Section K.

This Appendix 1, Section J describes a number of features, adopted variously in the Arrival Bus implementations of the invention. We categorise these features into the following five groupings:
A. Arrival Bus Physical Features
B. Arrival Bus Information Systems
C. Arrival Bus Ticketing Features
D. Arrival Bus Utilisation Measurement Features
E. Arrival Bus Automated Customer Configuration using Vehicle Builder and Automated Production using Robofacturing at a Microfactory

A. Arrival Bus Physical Features

Feature 1: Bus with 4 Tyres and Reduced Rolling Resistance

1. An electric bus (i) with only 4 tyres and (ii) a flat floor mounted on a chassis, and (iii) a battery pack or packs that is in, or part of, or mounted on, the chassis.

Optional Sub-Features:
Bus has a substantially 50:50 unladen weight distribution over the front and rear axles.
The bus has only 4 tyres.
The bus is a 12 m long bus and has a gross combination mass of over 8000 Kg.
The 12 m long bus has an unladen weight of approximately 8,000 Kg-10,000 Kg.
The 12 m long bus has a gross combination mass of approximately 16,000 Kg.
The 12 m bus includes seating for at least 30 passengers.
The 12 m long bus includes approximately 36 seats.
The bus has body panels made of composite material mounted on light weight extruded aluminium struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 2: Bus with 50:50 Weight Distribution Improved Handling

1. An electric bus with two axles and 50:50 weight distribution over each axle and a flat floor mounted on a chassis, and a battery pack or packs that is in, or part of, or mounted on, the chassis.

Optional Sub-Features:
The bus has only 4 tyres.
The bus is a 12 m long bus and has a gross combination mass of over 8000 Kg.
The 12 m long bus has an unladen weight of approximately 8,000 Kg-10,000 Kg.
The 12 m long bus has a gross combination mass of approximately 16,000 Kg
The 12 m bus includes seating for at least 30 passengers.
The 12 m long bus includes approximately 36 seats.
The bus has body panels made of composite material mounted on light weight extruded aluminium struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 3: Bus with Lightweight Composite Body

1. A bus with body panels made of composite material mounted on or including light weight extruded aluminium struts or members, delivering an unladen mass for a 12 m bus of not substantially more than 8,000 Kg-10,000 Kg.

Optional Sub-Features:
the composite body panels have a Class A surface.
the composite body panels are thermoplastic composite body panels that include a colour formed in the interior of the body panel.
The bus has only 4 tyres.
The 12 m long bus has a gross combination mass of approximately 16,000 Kg.
The 12 m bus includes seating for at least 30 passengers.
The 12 m long bus includes approximately 36 seats.
The bus has body panels made of composite material mounted on light weight extruded aluminium struts or members.
The bus has a chassis and the light weight extruded aluminium struts or members are attached to the chassis to form the body superstructure to which the body panels are attached.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 4: Bus with Lightweight Composite Body and Panoramic Glazing

1. A bus with roof panels made of composite material mounted on light weight extruded aluminium struts or members, and each including a central clear or transparent section configured to form part of a panoramic roof running over substantially the entire length of the bus where passengers sit or stand.

Optional Sub-Features:
The bus constructed from a number of transverse sections.
Several transverse sections include a glass side window, and the central clear or transparent section is aligned to sit directly over this side window.
The side windows of a transverse section are secured in an extruded metal frame structure that continues over the roof, and retain the roof panels for that transverse section.
the clear or transparent sections are each made of glass.
The bus is a 12 m long bus and has a gross combination mass of over 8,000 Kg.
The 12 m long bus has an unladen weight of approximately 8,000 Kg-10,000 Kg.
The 12 m long bus has a gross combination mass of approximately 16,000 Kg
The 12 m bus includes seating for at least 30 passengers.
The 12 m long bus includes approximately 36 seats.
The bus has body panels made of composite material mounted on light weight extruded aluminium struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 5: Bus with a Low-Floor that is Fully Flat from the Front of the Bus to the Rearmost Seats

1. A low-floor bus with a flat floor running the entire length of the bus, the flat floor mounted on a chassis and extending from a front access door through the bus to the rearmost seats.

Optional Sub-Features:
The bus has a ride floor height of approximately 360 mm above the ground.
The bus has a ride floor height of approximately 340 mm-380 mm above the ground.
The bus has a ride floor height of approximately 450 mm above the ground.
The bus has a ride floor height of approximately 430 mm-470 mm above the ground.
The bus has an access floor height of approximately 240 mm above the ground.
The bus has an access floor height of approximately 220 mm-260 mm above the ground.
The bus has an access floor height of approximately 330 mm above the ground.
The bus has an access floor height of approximately 310 mm-350 mm above the ground.
The bus has only 4 tyres.
The bus is a 12 m long bus and has a gross combination mass of over 8000 Kg.
The 12 m long bus has an unladen weight of approximately 8,000 Kg-10,000 Kg.
The 12 m long bus has a gross combination mass of approximately 16,000 Kg.
The 12 m bus includes seating for at least 30 passengers.
The 12 m long bus includes approximately 36 seats.
The bus has body panels made of composite material mounted on light weight extruded aluminium struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 6: Bus with a Motor Mounted within a Wheel Arch

1. A low-floor bus, with a flat floor running the entire length of the bus, in which a drivetrain, including at least an electric motor, is mounted within a structural wheel arch.

Optional Sub-Features:
the drivetrain mounted within the wheel arch includes: two motors, two inverters, a twin input gearbox, and a driveshaft.
the drivetrain mounted within a wheel arch includes: a motor, an inverter, a gearbox, and a driveshaft.
each wheel arch comprises a single structural casting.
each wheel arch comprises a single structural aluminium casting.
each wheel arch comprises a single structural metal casting, such as a steel casting.
each wheel arch includes a single structural aluminium casting and the drivetrain is attached to the casting.
a fully independent suspension system is attached to each wheel arch.
a motor is mounted within each of the rear wheel arches.
a motor is mounted within each of the front and the rear wheel arches.
a drivetrain is mounted within each of the rear wheel arches.
a drivetrain is mounted within each of the front and the rear wheel arches.
The bus has a ride floor height of approximately 360 mm above the ground.
The bus has a ride floor height of approximately 340 mm-380 mm above the ground.
The bus has a ride floor height of approximately 450 mm above the ground.
The bus has a ride floor height of approximately 430 mm-470 mm above the ground.
The bus has an access floor height of approximately 240 mm above the ground.
The bus has an access floor height of approximately 220 mm-260 mm above the ground.
The bus has an access floor height of approximately 330 mm above the ground.
The bus has an access floor height of approximately 310 mm-350 mm above the ground
The bus has only 4 tyres.
The bus is a 12 m long bus and has a gross combination mass of over 8000 Kg.
The 12 m long bus has an unladen weight of approximately 8,000 Kg-10,000 Kg
The 10.5 m long bus has an unladen weight of approximately 8,000 Kg-9,000 Kg
The 12 m long bus has a gross combination mass of approximately 16,000 Kg
The 12 m bus includes seating for at least 30 passengers.
The 12 m long bus includes approximately 36 seats.
The bus has body panels made of composite material mounted on light weight extruded aluminium structural struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 7: Bus with Central HV Bus Bar

1. A bus with a central HV backbone including pre-installed connection interfaces for HV battery packs, traction inverters, and front and rear HV distribution systems.

Optional Sub-Features:
The bus has only 4 tyres.
The bus is a 12 m long bus and has a gross combination mass of over 8000 Kg
The 12 m long bus has an unladen weight of approximately 8,000 Kg
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 8: Bus with Distributed ECUs

1. A bus with a distributed network of ECUs configured to enable de-centralised, distributed control and/or monitoring of ECUs by other ECUs.

Optional Sub-Features:
the software components that enable an ECU to monitor or control another ECU are generated or selected when the bus is being configured by an automated vehicle builder system.
the software components are written to the ECUs as firmware
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members.
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

Feature 9: Bus with Seating Mounted Above a Flat Floor

1. A bus including passenger seats that are each cantilever mounted against a substantially vertical structural strut or beam system that forms part of the side of the bus and not the floor.

Optional Sub-Features:
The cantilever is an L shaped cantilevered bracket that extends from the substantially vertical structural strut or beam system.
the substantially vertical structural strut or beam system is attached to the bus chassis or skateboard platform.
the substantially vertical structural strut or beam system continues to the roof of the bus.
the substantially vertical structural strut or beam system is attached to a substantially horizontal structural strut or beam system to form the superstructure of the bus.
The cantilever is a composite and aluminium extrusion cantilever.
The seat is made from a single unibody hard shell.
Each seat has a flush fitting cushion that stops short of the top of the unibody shell, so that the top of the unibody shell presents a grab-able area without the need for providing an added pole or handle appendage.
the floor is a flat floor running the entire length of the bus that provides a single flat surface under all seats to facilitate cleaning, and the floor is mounted on a chassis that includes a battery pack or packs (e.g. a battery pack or packs is in, or part of, or mounted on the chassis).
The bus has a floor height of approximately 360 mm above the ground.
The bus has a floor height of approximately 300 mm-420 mm above the ground.
The bus is a 12 m long bus and has a gross combination mass of over 8000 Kg
The 12 m long bus has an unladen weight of approximately 8,000 Kg-10,000 Kg.
The 12 m long bus has a gross combination mass of approximately 16,000 Kg
The 12 m bus includes seating for at least 30 passengers
The 12 m long bus includes approximately 36 seats.
The bus has body panels made of composite material mounted on light weight extruded aluminium struts or members
The bus has a flat floor running the entire length of the bus, the flat floor being mounted on a chassis that includes a battery pack or packs (e.g. a battery pack that is in, or part of, or mounted on, the chassis).
The bus has a flat floor, mounted on a chassis that includes a battery pack or packs and the flat floor extends from a front access door through the bus to the rearmost seats (e.g. to under at least part of the rearmost seats, or to under the whole of the rear seats).
The bus has a flat floor running the entire length of the bus, in which an electric motor is mounted within a wheel arch (e.g. the two rear wheel arches, or all four wheel arches).
The bus is constructed from a series of transverse sections of the same length, and each transverse section includes body and roof parts or panels made of composite material.
The bus is constructed from the following series of transverse sections: driver section, door section, body panel section, wheel arch section and rear section.
The bus is constructed from a series of transverse sections of the same length, and the length of the bus is altered by changing the number of internal transverse sections (i.e. excluding the driver and the rear sections).
each internal transverse sections is configurable as a door section, body panel section, or wheel arch section.
the door section, body panel section, and wheel arch section each include an opening for glazing, of substantially the same length (i.e. the horizontal dimension).
the door section, body panel section, and wheel arch section each include a display panel mounting area, above the opening in each section.
the door section, body panel section, and wheel arch section each include or connect to a composite roof panel with an opening for a roof window, configured so that adjacent roof windows run substantially the entire length of each section.
each internal transverse sections is approximately 1.5 m in length.
A 10.5 m bus has five internal transverse sections (i.e. excluding the driver and the rear section); a 12 m bus has six internal transverse sections; a 13.5 m bus has seven internal transverse sections and a 15 m bus has eight internal transverse sections.
each internal transverse sections is configured to be robotically assembled and for all internal transverse sections to be joined together using a robotic assembly process.
the robotic assembly process is arranged to be implemented in a microfactory.

B. Arrival Bus Information Systems

Feature 10: Displaying Sensor-Derived Environmental Information

1. A vehicle with an exterior display system operable to display environmental information that (i) relates to the environment external to the vehicle, and (ii) has been derived from data sources that are external to and remote from the vehicle.
2. A vehicle with an exterior display system operable to display environmental information that (i) relates to the environment internal to the vehicle, and (ii) has been derived from data sources that are internal to or integral with the vehicle.
3. A vehicle with an exterior display system operable to display environmental information that (i) relates to the environment external to the vehicle, and the environment internal to the vehicle, and (ii) has been derived from data sources that are internal to or integral with the vehicle, as well as external to and remote from the vehicle.

Optional Sub-Features:

The Vehicle
Vehicle is a bus and the display system is operable also to display destination and/or route information

The Environmental Information

Environmental information includes road conditions, such as obstructions, roadworks, status of traffic lights, whether snow or ice is detected by the data sources.
Environmental information includes road traffic conditions, including congestion information, such as congestion for the likely route of the vehicle.
Environmental information includes information on pedestrians and cyclists in the vicinity of the vehicle.
Environmental information includes whether it is safe or not for any other vehicle in proximity to the vehicle to perform an action in view of nearby road users or pedestrians detected by the data sources.
Environmental information includes whether it is safe or not to overtake the vehicle in view of nearby road users or pedestrians, detected by the data sources.
Environmental information includes whether passengers (including children) are waiting to board the vehicle, are entering into or alighting from the vehicle.
Environmental information includes whether passengers (including children) are waiting to alight from inside the vehicle.
Environmental information includes the number of passengers waiting to board the vehicle.
Environmental information includes whether there are passengers seeking to board the vehicle or on the vehicle require assistance, such as wheelchair bound passengers, or people with walking or mobility issues, expectant mothers, or people with pushchairs or prams, and the exterior display then automatically displays a relevant message, for example a message indicating that the vehicle is automatically lowering an access ramp; or a message requesting that passengers are to give priority or make space or offer a seat or offer other assistance.
Environmental information includes the number of available seats in the vehicle.
Environmental information includes the data connectivity speed available to passengers in the vehicle.
Environmental information includes services available to passengers in the vehicle, such as food or drink.
Environmental information includes movement and ‘sway’ of passengers, and the vehicle uses this information automatically to compensate driver (assist or autonomous) controls to optimise for passenger comfort and safety.
Environmental information includes the ambient lighting or temperature in the vehicle.
Environmental information includes solar loading, e.g. as detected using computer vision, and the vehicle uses this information to control zonal lighting and heating/cooling.
Environmental information includes how heavily an area or different seats have been used, and the vehicle generates data from this that influences how and where the vehicle is cleaned.
Environmental information includes bus journey location and times to future stops or destinations, using traffic flow and speed data that is specific to the bus and its specific route, including the use of bus priority lanes, and the vehicle displays this data in real-time to passengers using interior displays.
Environmental information excludes the operational status of the vehicle, or the intent or actions of any driver, such as braking or indicating a turn.
Environmental information excludes the number of passengers in the vehicle.

The Data Sources
Data sources includes one or more cameras in the vehicle.
Data sources includes one or more cameras external to the vehicle.
Data sources includes one or more computer vision systems, such as computer vision systems that can detect whether passengers are waiting to board the vehicle, and/or entering into or alighting from the vehicle.
Data sources includes one or more computer vision systems that can detect where passengers are sitting in the bus.
Data sources includes one or more computer vision systems that can detect where passengers are standing in the bus.
Data source can detect whether passengers require assistance, such as wheelchair bound passengers, or people with walking or mobility issues, expectant mothers, or people with pushchairs or prams, and take appropriate, pre-determined actions depending on the nature of assistance that is appropriate.
Data sources includes one or more pose detection systems.
Data sources includes road traffic data sources.
Data sources include any vehicle control system, such as steering, accelerator, braking.
Data sources include one or more voice or speech recognition data sources.
Data sources include one or more weight or load sensors.
   Weight or load sensors can establish whether the loading and load distribution. is within safe limits and can generate a warning if it is not.
Data sources include wi-fi or other wireless comms servers that determine the extent of use of those comms by passengers.
Data sources includes one or more systems that can detect one or more of: age, sex, other demographic data, of individual passengers.
Data sources includes one or more systems that can detect interactions between passengers, including interactions indicating potential or actual threatening or other undesirable behaviour.

Display UI
One or more interior displays mirror or replicate some or all of what is shown by the exterior display system.
A display in a driver's cabin in the vehicle displays any of the environmental information.
A display in a rear view mirror, whether reflective or a camera-based display, can display any of the environmental information.
The exterior display system includes one or more of: a display at the rear of the vehicle, a display at the front of the vehicle, a display running along the length of the vehicle; a display running along the length of the vehicle and above the side windows of the vehicle; a display wrapped around substantially all sides of the vehicle (e.g. at least 80% of the total linear length).
The exterior display system includes a display running substantially continuously around the perimeter of the vehicle, below the roof.
Vehicle can share any data that would be shown on the exterior display to a server and hence to a connected web browser, web app or app, to display the same or related data
   A potential passenger can view whether any seats are available on a specific vehicle from a web browser, web app or app.
   A potential or actual passenger can view road traffic conditions, including congestion information, such as congestion for the likely route of the vehicle, from a web browser, web app or app.
   A potential or actual passenger can view whether passengers are waiting to board the vehicle, are entering into or alighting from the vehicle from a web browser, web app or app.

Feature 11: Passenger Location Analysis

1. A bus with a passenger analysis system that automatically generates data on the location or other spatial distribution of passengers in the bus, or intended passengers for the bus, using one or more external and/or internal sensors located in or on the bus, such as a computer vision system.

Optional Sub-Features:

The Location or Other Spatial Distribution Data
Spatial distribution data includes whether or where there are passengers waiting near the bus exit(s) to alight from inside the vehicle.
Spatial distribution data includes whether or where there are passengers waiting near the bus entrance(s) to board the vehicle.
Spatial distribution data includes whether or where there are passengers waiting near the bus entrance(s) seeking to board the vehicle or on the vehicle that require assistance, such as wheelchair bound passengers, or people with walking or mobility issues, expectant mothers, or people with pushchairs or prams.
Spatial distribution data includes where there are occupied seats and where there are unoccupied seats.
Spatial distribution data includes where and/or how many passengers are standing in the bus.
Spatial distribution data includes how close passengers are to each other.
Spatial distribution data includes whether reserved seats are in fact occupied.
Spatial distribution data includes the number of passengers, determined by a people counting system.

The Sensors/Computer Vision System
Sensors include a computer vision system.
Computer vision system includes one or more cameras in the vehicle.
Computer vision system includes one or more cameras external to the vehicle.
Computer vision system includes one or more computer vision systems that can detect whether passengers are waiting to board the vehicle, and/or are entering into or alighting from the vehicle.
Computer vision system includes one or more computer vision systems that can detect where passengers are sitting in the bus.
Computer vision system includes one or more computer vision systems that can detect where passengers are standing in the bus.
Computer vision system includes one or more computer vision systems that can count the number of passengers in the bus.
Computer vision system includes one or more computer vision systems that can count the number of people waiting to board the bus.
Computer vision system includes one or more computer vision systems that can count the number of passengers waiting to leave the bus.
Computer vision system includes one or more pose detection systems.
   pose detection system can infer if, or probabilistically estimate whether, a passenger is intending to alight or intending to remain on the bus.
Computer vision system can detect whether passengers require assistance, such as wheelchair bound passengers, or people with walking or mobility issues, expectant mothers, or people with pushchairs or prams, and take appropriate, pre-determined actions depending on the nature of assistance that is appropriate.
   pre-determined actions include: automatically lowering an access ramp; automatically requesting that passengers are to make space or offer a seat or offer other assistance.
Computer vision system includes one or more systems that can detect one or more of: age, sex, other demographic data, of individual passengers.
Computer vision system includes one or more systems that can detect interactions between passengers, including interactions indicating potential or actual threatening or other undesirable behaviour.
Computer vision system includes one or more systems that can detect whether passengers are wearing hats, scarfs or face masks or coverings.
Computer vision system uses thermal analysis of passengers, e.g. to differentiate them from the vehicle when locating the positions of passengers to determine safe loading and distribution of passengers.

Other Data Sources
Bus also includes one or more voice or speech recognition data sources.
Bus also includes one or more weight or load sensors.
   Weight or load sensors can establish whether the loading and load distribution is within safe limits and can generate a warning if it is not.
Bus also includes wi-fi or other wireless comms servers that determine the extent of use of those comms by passengers.
A passenger's bus ticketing app is a data source; the passenger can open the app on their smartphone etc and send data, such as an alert if they feel in danger or are unwell, or wish to alert the driver or a service or help center for any reason; because the location of the passenger is known, a computer vision system in the bus can be controlled to view that location and the driver and/or a remote help centre can then assess the situation; if a passenger is being threatened or assaulted, then the driver can stop the bus and wait for police support.

Display UI
Bus includes one or more displays that generate and display information directing where passengers are to enter and leave the bus, based on dynamic or real-time data from the data sources.
Bus includes one or more displays that generate and display information indicating the location of any available seats, based on dynamic or real-time data from the data sources.
Bus includes one or more displays that generate and display information indicating the location of any available seats for priority passengers, such as pregnant mothers, passengers with mobility issues, based on dynamic or real-time data from the data sources.
Bus includes one or more displays that generate and display information based on the data sources, such as guidance or warning information, images of passengers exhibiting potential or actual threatening or other undesirable behaviour, based on dynamic or real-time data from the data sources.
The display(s) are in the passenger area.
The display(s) are in the driver area or cabin.
Bus can automatically send data requesting assistance, including police or ambulance intervention.
Bus can share any data that would be shown on a display on or in the bus to a server and a connected app, to display the same or related data on the app.

Other Uses Cases
Passenger analysis system automatically alters an operational parameter of the bus depending on the data.
Passenger analysis system automatically stops the bus at the next request bus stop if there are passengers standing near the exit.
Bus is configured to dynamically modify the conditions in the bus (e.g. lighting, thermal (HVAC), sound/music, displayed information etc.) depending on the location or spatial distribution or thermal profile of passengers within it.
   this can also be done zonally within the vehicle e.g. turn off heating in unoccupied parts of the bus which reduces power consumption.
Bus is configured to dynamically change the types of advertisements displayed within the bus depending on the location of the passengers within it.
Bus is configured to dynamically track one or more of the load, capacity, flow of passengers, types of passengers in the bus and display that information on a display in the driver's cabin.
Bus is configured to automatically detect if there are standing passengers and to recommend to the driver a gentle driving style if there are standing passengers.
Bus is configured to automatically detect if there are standing passengers and to implement a gentler driving style (e.g. reduce hard acceleration; reduce sharpness of hard braking, provided that safety is not compromised) if there are standing passengers.
The location of passengers wearing a face mask and passengers not wearing a face mask is detected.
The location of passengers that maintain and/or fail to maintain more than a pre-set distance from other passengers is detected.
The location of passengers with an abnormal body temperature, as measured by a remote infra-red computer vision system, is detected.

Feature 12: Bus with Behavioural Modelling

1. A bus with a passenger analysis system that automatically generates data on the behaviour of passengers in the bus, or intended passengers for the bus, using a computer vision system; and automatically initiating a bus operation depending on data from the computer vision system.

Optional Sub-Features:

The Behaviour
The behaviour is a fall or trip or impact inside the bus and the bus operation is stopping the bus or advising the driver to stop the bus.
The behaviour is whether a seat belt is being worn and the bus operation is displaying or giving an advisory asking that seat belts be worn.
The behaviour is excessive swaying of standing passengers and the bus operation is slowing or reducing the acceleration/deceleration of the bus, or advising the driver to slow or reduce the acceleration/deceleration of the bus.
The behaviour is excessive swaying of standing passengers and the bus operation is stiffening the air suspension.
The behaviour is whether a wheelchair or pram space is occupied by a non-priority passenger at a time when a wheelchair or pram user is nearby and the bus operation is displaying or giving an advisory asking for the wheelchair or pram space to be clear.
The behaviour is approaching closely to another passenger when there is ample space on the bus not to approach so closely and the and the bus operation is displaying or giving an advisory that passengers should maintain a safe distance from other passengers.
The behaviour is anti-social, drunken or threatening behaviour and the bus operation is displaying or giving an advisory to stop such behaviour.
The behaviour is a fare payment action, such as presenting a contactless ticket to a card reader in the bus and bus operation is displaying or giving an advisory to confirm payment.
The behaviour is a fare evasion action, such as never presenting a contactless ticket to a card reader in the bus, and the bus operation is displaying or giving an advisory that fare evasion has been detected.
The behaviour is a fare evasion action, such as appearing to present a contactless ticket to a card reader in the bus but without triggering a payment and the bus operation is displaying or giving an advisory that fare evasion has been detected.
The behaviour is passenger flow through the bus and the bus operation is assessing whether the flow meets passenger safety or comfort standards.
The behaviour is data relating to where people are sitting or standing in the bus and the bus operation is modifying the bus HVAC for greater passenger comfort.
The behaviour is one or more of dwell time in different locations in the bus, and the bus operation is making multivariate adjustments of internal environment (such as lighting, temperature, displayed content)
   The multivariate adjustments are made to one or more of: the whole bus, or to zones within the bus, at different times of day, in different weather conditions, in different locations.
The behaviour is detected using frame to frame differencing (cameras and seats are fixed, whereas humans and luggage moves).
The behaviour is the type of clothing worn by passengers and the bus operation is automatically adjusting the internal environment depending on the type of clothing.
The behaviour is whether a wheelchair, pram or luggage is moving without human control and the bus operation is giving an emergency warning.
The behaviour is whether passengers sing along with or move along with music played in the bus and the bus operation is to display or give encouragement.
   song lyrics scroll along or are shown on the displays.
The behaviour is whether passengers are swaying excessively and the bus operation is automatically adjusting the air suspension settings to reduce swaying.
Computer vision is supplemented with a speech recognition and analysis system
   the speech recognition and analysis system is programmed to detect threatening, drunken or anti-social behaviour.

Feature 13: Displaying Dynamic, Environment-Based Advertising Content

1. A bus with a display (e.g. external or internal) connected to a content server that generates or selects advertising content for the display; in which one or more dynamic parameters selected to be relevant to passengers on the bus or people outside the bus are tracked and the server generates or selects advertising content based on the real-time value of the parameters.

Optional Sub-Features:
Parameter is the location of the vehicle.
Parameter is the time of day.
Parameter is the weather or lighting or temperature.
Parameter is the traffic conditions.
Parameter is the specific demographic of passengers.
Parameter is the behaviour of passengers.
Parameter is the language spoken by passengers.
Parameter is cookies or other data identifying preferences or behaviours and that is detectable from a smartphone, smartwatch, tablet, laptop or other electronic device used by a passenger.
Parameter is detected or inferred or obtained by a sensor in the vehicle.
content server that generates or selects content based on any combination of the above parameters.
Sensor is a computer vision system.
Sensor is a speech or language analysis system.
Content is video advertising content.
Content includes news content.
Content includes entertainment content.
Display is internal and/or external to the bus.
Content is dynamically generated in real-time, as opposed to being stored and retrieved.
Content server can be local to the vehicle, or in the cloud, or distributed between the vehicle and the cloud

Feature 14: Contactless ‘Stop Request’ Sensor

A vehicle including a single function proximity-sensitive sensor that is tuned to (i) detect the proximity of a hand without the need to contact the sensor and (ii) to send a control input to a bus control system.

Optional Sub-Features:
The vehicle is a bus and the sensor is a ‘stop request’ sensor and the control input is a request from a passenger that the bus stop at the next stop.
The control input automatically opens or closes a door of the vehicle.
the sensor is a ‘ramp request’ sensor and the control input is a request from a passenger that the bus stop deploy its access ramp.
The sensor is tuned to the specific electromagnetic environment it is in.
The sensor provides visual, haptic or sound-based feedback when activated.
The proximity-sensitive sensor is a capacitive sensor.
One capacitive plate of the sensor is a conductive plastic member.
An electrical connection between the conductive plastic member and the capacitance measurement circuit board is achieved by dual-purposing metallic fixing screws that attach the plastic member to the circuit board.
Proximity trigger thresholds used by the capacitance measurement circuit can be modified using over-the-air updates.
Proximity trigger thresholds used by the capacitance measurement circuit can be modified dynamically depending on environmental conditions in or outside the vehicle, as automatically measured by vehicle sensors.
The proximity-sensitive sensor is integrated into a vertical support pole in the bus.
The proximity-sensitive sensor is positioned on the outside of the bus near a door with an access ramp.
Each vertical support pole in the bus includes an integrated proximity-sensitive sensor.
Passenger instead uses an app on the passenger's smartphone or smartwatch or other personal, connected device.
Passenger speaks a request that the bus should stop, and the bus includes a microphone and speech recognition and analysis system that detects the request passes that request to the bus control system.

Feature 15: Wrap-Around Display Screen

1. A vehicle including a series of display screens that extend along substantially the entire length of the bus, over all doors, and runs along substantially all of the front and rear of the bus, giving the appearance of a display that substantially wraps around the bus.

Optional Sub-Features:
the display is connected to a content server that can generate one or more of the following: route information, passenger guidance information and also advertisements.
The display screen is made up of separate display screen modules that are substantially flush with one another and the glass window or door panels they each sit over.
The display screen is made up of separate display screen modules occupying at least 75% of the length of the vehicle.
The display screen is made up of separate display screen modules occupying at least 75% of the width of the front and rear of the bus,
The display screen is made up of separate display screen modules that appear to form a continuous display band around the vehicle.
The display screen runs in a band, of substantially constant height.
The display screen runs in a band, of substantially constant height above the passenger windows of the vehicle.
The display screen is made up of separate display screen modules that are each formed into a modular body section, and the vehicle is made up of multiple, transverse modular body sections that are joined, bonded or glued together.
The display screen includes flexible display screen modules that form curved edges of the vehicle.
The display screen is covered by a cover of glass, plastic or other translucent material, and that cover forms a single surface that appears continuous to a person viewing the vehicle from the roadside.
Each display screen module is connected to a content server that can generate multi-modal content—i.e. content of different types, namely route information, passenger information, and also advertisements.
The content can be automatically selected based on variable parameters.
The parameters include proximity to a bus stop (e.g. the display content changes from advertisements to alternating between passenger guidance, such as which doors should be used to enter the bus, and route and traffic information).
the parameters include the time of day (e.g. the display content changes to dim at night, or show advertisements more appealing to a night crowd, such as alcohol).
the parameters include cold weather outside the vehicle (e.g. the display content alternates between showing advertisements and displaying the warm the ambient temperature in the bus).
the parameters include hot weather outside the vehicle (e.g. the display content alternates between showing advertisements and displaying the cool, air-conditioned the ambient temperature in the bus).
Each display screen module includes not only an outward-facing display panel, but also an inward-facing display panel as well, so that passengers inside the bus also experience a full length, apparently continuous display screen, running over all the windows and doors of the bus.

Feature 16: Bus with Weight Sensors

1. A bus with weight sensors configured to measure the total passenger weight, e.g. axle weight sensors that generate an alert to the driver if the total passenger weight exceeds a threshold.

Optional Sub-Features:
the weight sensors include weight sensors mounted on one or both axles.
the weight sensors include weight sensors mounted on or forming part of the bus suspension system.
the weight sensors include weight sensors that are attached to the seats or seat mounts.
the weight sensors include weight sensors that are attached to a floor that passengers stand on.
the weight sensors include load cells.
the weight sensors generate weight data which is stored in the bus.
the bus includes or is connected to a weight analysis system which processes the weight data.
the weight analysis system determines if the passenger weight exceeds a safe threshold and generates an alarm, such as a driver alarm, if the threshold is exceeded.
the bus includes a computer vision based people counting system and the output from the people counting system is compared or combined with the weight data to reach an estimate of the number of passengers travelling in the bus.
the number of passengers travelling in the bus at any time is used by a bus scheduling system that schedules additional buses if that number exceeds a threshold.

C. Arrival Bus Ticketing Features

Feature 17: Differential Bus Ticket Pricing Based on Sensor Data.

1. A bus ticketing system configured to generate bus tickets with pricing dependent on real-time data from one or more sensors in the bus which determine the bus occupancy or number of standing or seated passengers. e.g. reduced pricing if numbers of standing passengers exceeds a threshold.

Optional Sub-Features:
the bus ticketing system is configured to issues tickets with reduced pricing if the numbers of standing passengers exceeds a threshold.
sensors are or include weight sensors or load cells attached to each seat.
sensors are or include weight sensors or load cells attached to the floor of the bus.
sensors are or include weight sensors or load cells attached to handrails in the bus.
sensors are or include computer vision based people counting systems.
the bus includes an external display that shows the bus occupancy, such as: the number of seats available, the number of passengers on board, the number of standing passengers.

Feature 18: Bus Tickets Sold for Specific Unoccupied Seats Based on Real-Time Sensor Data

1. A bus ticketing system configured to generate a bus ticket for a specific seat dependent on real-time data from one or more sensors in the bus, which determine occupancy for that specific seat.

Optional Sub-Features:
sensor is a weight sensor for an individual seat or seat mount.
sensor is a load cell for an individual seat or seat mount.
sensor is a computer vision system.
each seat includes a light or other display to indicate whether it is reserved or not.
bus ticket is a virtual or e-ticket.
the bus includes an external display that shows if any seats are available.

Feature 19: Dynamic Pricing of Seats Based on Real-Time Temperature Sensor Data

1. A bus ticketing system configured to generate a bus ticket with pricing dependent on real-time data from one or more sensors or control devices.

Optional Sub-Features:
sensors are temperature or climate sensors.
sensor is a location sensor.
control device is a clock.
control device is a driver-activated HMI.
temperature sensor measures the internal temperature in the bus.
temperature sensor measures the external temperature.
control device is an A/C activation control device.
the bus includes an external display that shows when AC is turned on.
the bus includes an external display that shows when discounted fares are available.
bus ticket is a virtual or e-ticket.

D. Arrival Bus Utilisation Measurement Features

Feature 20: Bus with Ticketing System and Vehicle Weight Sensing

1. A bus configured with (i) a ticketing system that tracks the numbers of tickets issued to passengers and (ii) a weight sensor system to measure the weight of passengers in the bus and (iii) an analysis system to determine if the weight of passengers at a given time is consistent with the number of tickets issued to passengers travelling on the bus at that time.

Optional features or sub-features:
weight sensors are or include weight sensors or load cells attached to each seat.
weight sensors are or include weight sensors or load cells attached to the floor of the bus.
weight sensors are or include weight sensors or load cells attached to handrails in the bus.
weight sensors estimate the weight of passengers on the bus before and after each bus stop.
analysis system generates a driver alert if there is a discrepancy between the numbers of passengers estimated from the weight sensors and the tickets sold.
bus includes a computer vision based passenger counting system.
output from the computer vision based passenger counting system is combined with output from the weight sensors to generate a combined estimate of the number of passengers on the bus at any time.

Feature 21: Bus with Ticketing System and People Counting

1. A bus configured with (i) a ticketing system that tracks the numbers of tickets issued to passengers and (ii) a computer vision based passenger counting system and (iii) an analysis system to determine if the number of passengers counted at a given time is consistent with the number of tickets issued to passengers travelling on the bus at that time.
analysis system generates a driver alert if there is a discrepancy between the numbers of passengers estimated from the computer vision sensor and the tickets sold by the ticketing system.
bus includes a weight sensor system to measure the weight of passengers in the bus
weight sensors are or include weight sensors or load cells attached to each seat.
weight sensors are or include weight sensors or load cells attached to the floor of the bus.
weight sensors are or include weight sensors or load cells attached to handrails in the bus.
weight sensors estimate the weight of passengers on the bus before and after each bus stop.
output from the computer vision based passenger counting system is combined with output from the weight sensors to generate a combined estimate of the number of passengers on the bus at any time.

Feature 22: Bus with Sensors Recording Dynamic Usage

1. A bus with sensors in the bus that measure bus dynamic usage, such as how many stops/starts, acceleration data, deceleration data, load under acceleration, load under deceleration, range travelled, battery charging data, battery state of health data; and that data is used when determining a residual value for components in the bus.

Optional Sub-Features:
component is a battery module or battery pack.
component is an inverter.
component is a motor.
usage includes any of: how many stops/starts, acceleration data, deceleration data, load under acceleration, load under deceleration, range travelled, battery charging data, battery state of health data, extent of super-fast charging, frequency of being charged to maximum, maintenance; repairs.
usage includes extent of super-fast, very high kWh DC charging.
usage includes extent of charging to maximum capacity.

Feature 23: Bus with Use-Based Maintenance Schedule

1. A bus generating maintenance schedule based on data from sensors in the bus that (i) measure vehicle weight and (ii) measure bus dynamic usage, such as how many stops/starts, acceleration data, deceleration data, load under acceleration, load under deceleration, range travelled, battery charging data, battery state of health data.

Optional Sub-Features:
usage includes any of: how many stops/starts, acceleration data, deceleration data, load under acceleration, load under deceleration, range travelled, battery charging data, battery state of health data, extent of super-fast charging, frequency of being charged to maximum.
usage includes extent of super-fast, very high kWh DC charging.
usage includes extent of charging to maximum capacity.
bus includes an accelerometer to record shocks, pot holes or accidents.
bus includes a weight sensor system to measure the weight of passengers in the bus.
weight sensors are or include weight sensors or load cells attached to each seat.
weight sensors are or include weight sensors or load cells attached to the floor of the bus.
weight sensors are or include weight sensors or load cells attached to handrails in the bus.

Feature 24: Method of Modelling the Predicted Lifetime of Components

1. A method of modelling the predicted lifetime of components in a bus using data from sensors in the bus that (i) measure vehicle weight and (ii) measure bus dynamic usage.

Optional Sub-Features:
usage includes any of: how many stops/starts, acceleration data, deceleration data, load under acceleration, load under deceleration, range travelled, battery charging data, battery state of health data, extent of super-fast charging, frequency of being charged to maximum.
usage includes extent of super-fast, very high kWh DC charging.
usage includes extent of charging to maximum capacity.
bus includes an accelerometer to record shocks, pot holes or accidents.
bus includes a weight sensor system to measure the weight of passengers in the bus.
weight sensors are or include weight sensors or load cells attached to each seat.
weight sensors are or include weight sensors or load cells attached to the floor of the bus.
weight sensors are or include weight sensors or load cells attached to handrails in the bus.

E. Bus Configurability—e.g. Automated Customer Configuration Using Vehicle Builder and Automated Production Using Robofacturing at a Microfactory

Feature 25: Modular Transverse Chassis Sections

1. A vehicle that includes a structural chassis made up of multiple, modular transverse chassis sections that are configured to be joined together by a robotic production system to provide a vehicle of the required dimensions.

Optional Sub-Features:
the sides of the bus are formed using substantially straight, vertical structural pillars that are attached to a transverse chassis section of approximately 1.5 m in length.
multiple transverse chassis section are joined together to form the complete bus chassis or platform.
a passenger door is positioned between two of the vertical, structural pillars and has an opening width of approximately 1210-1250 mm.
a structural wheel arch is attached to a transverse chassis section.

Feature 26: Robotic, Cell Based Production

1. A method of producing a vehicle, in which a robotic production system assembles, at a cell of robots at a fixed location, and not a moving production line, at least part of the vehicle by robotically attaching components together to form parts of the vehicle, and substantially an entire vehicle is assembled at multiple such cells.

Optional features or sub-features:
robots at a cell join together extruded aluminium sections to form a superstructure for the body of the vehicle.
robots at a cell join extruded aluminium sections to parts of a chassis or skateboard platform.
robots at a cell join composite body panels to extruded aluminium support structures for those panels.
robots at a cell join together multiple, modular transverse chassis sections to form a structural chassis.
robots at a cell follow instructions generated by an automated vehicle design tool
each cell includes between two and ten robots.

Feature 27: Cell with Self-Governing Robots

1. A robotic production cell for vehicle production, comprising a group (e.g. 2 to 10) of self-governing robots that are programmed to dynamically work out amongst themselves, arbitrating as required, and execute the optimal production process for each new vehicle they build.

Feature 28: The Microfactory

1. A vehicle production factory comprising a number of robotic production cells for vehicle production, each cell comprising a group of robots that are programmed to assemble, at a fixed location and not a moving production line, at least part of the vehicle by robotically attaching components together to form parts of the vehicle, and substantially an entire vehicle is assembled at multiple such cells.

Feature 29: Bus with Customer-Specified Battery Capacity

1. An electric bus design and production process, the bus including multiple batteries; in which a customer specifies the battery capacity or range required for a specific new bus or fleet of buses, and an automated vehicle design tool then automatically selects battery-related components required for the specified battery capacity or range; and automatically generates build instructions for that vehicle or fleet of vehicles;
and a robotic production environment then automatically builds or assembles the bus as designed by the automated vehicle design tool, including a battery pack that meets the specified battery capacity or range.

Feature 30: Vehicle with Integrated, Customer-Specified Sensors

1. An electric bus design and production process, the vehicle including multiple sensor based systems, such as ADAS, LIDAR, computer vision based driver monitoring, computer vision based passenger monitoring, load or weight sensors;
in which a customer specifies which sensor based systems or their related functionality are required for a specific new bus or fleet of buses, and an automated vehicle design tool then automatically selects components required for the specified sensor based systems or their related functionality; and automatically generates build instructions for that vehicle or fleet of vehicles;
and a robotic production environment then automatically builds or assembles the bus as designed by the automated vehicle design tool, integrating the sensor based systems into the bus.

Feature 31: Post-Production Change to a Different Battery Pack Capacity

1. An electric bus with an original factory-installed battery pack, including multiple battery modules, with a specific battery capacity;
in which the bus is configured to enable the original battery pack to be altered by adding one or more further battery modules to the battery pack, or removing one or more battery modules from the battery pack.

Feature 32: Post-Production Update of Integrated, Customer-Specified Sensors

1. An electric bus with an original factory-installed sensor system that conforms to a hardware modularity specification and to a data and security interface specification; in which the vehicle is configured to enable the original sensor system to be replaced with an improved or different sensor system, and that improved or different sensor system is configured to conform to the hardware modularity specification and to the data and security interface specification, and to automatically form part of the bus' data and security network and systems.

For Features 25-32, the following optional sub-features are relevant:
robots at a cell join together extruded aluminium sections to form a superstructure for the body of the vehicle.
robots at a cell join extruded aluminium sections to parts of a chassis or skateboard platform.
robots at a cell join composite body panels to extruded aluminium support structures for those panels.
robots at a cell join together multiple, modular transverse chassis sections to form a structural chassis.
robots at a cell follow instructions generated by an automated vehicle design tool.
each cell includes between two and ten robots.
each cell comprises a group of robots that are programmed to assemble one or more of the chassis, composite body panels and supporting structures for those panels, drivetrain, and structural wheel arches, using instructions generated by an automated vehicle design system.

Modular Transverse Chassis Sections
Modular transverse chassis sections have a fixed length, e.g. 1.5 m.
Modular transverse chassis sections for wheel housings have the same fixed length as modular transverse chassis sections for the main body of the vehicle.
Modular transverse chassis sections have a structural one piece bottom plate.
Modular transverse chassis sections are configured to support an extruded aluminium frame.
Vehicles of different length are assembled using a different number of modular transverse chassis sections.
Modular transverse chassis sections are joined together when oriented horizontally, so that additional chassis sections extend the vehicle longitudinally.
The modular transverse chassis sections, when joined together, provide a substantially flat-topped chassis or platform.
Modular transverse chassis sections include a central rigid beam that connects to a rigid structure in an adjacent chassis section.
Modular transverse chassis sections for wheel housings include a flat, extruded aluminium panel with a cut-out on opposite sides, shaped to receive a wheel housing.
A drivetrain or integrated drive unit (IDU) is attached to a modular transverse chassis section.
A modular transverse chassis section is configured to receive multiple different types of integrated drive unit (IDU), which each conform to one of the following types: an IDU including a motor and control electronics; an IDU including a motor, control electronics and a differential; an IDU including two motors and a gearbox; and in which each type of IDU is configured to be bolted or attached to a modular transverse chassis section.
The modular transverse chassis sections are glued together, e.g. using a robotic production system.
Each modular transverse chassis section includes one or more glues holes and channels to enable glue to flow under pressure around tenons or other joints that are themselves optimised in shape to ensure effective and complete glue coverage.
Each modular transverse chassis section includes one or more glue channels and a foam bung configured to seal a channel.
Battery pack modules of a standardised size are assembled into or onto a modular transverse chassis section.

Frames
Each modular transverse chassis section includes a channel or socket into which body frames are configured to be slotted, e.g. by a robotic production system.
The body frames are made of extruded aluminium beams or poles.
The body frames are made of extruded aluminium beams or poles that have male/female friction fit joints that are glue bonded together.
Some body frames are configured to receive and retain body panels.
Body panels are made of a composite material.
Some body frames are configured to receive and retain display panels (e.g. LED displays).
Some body frames are configured for a specific type of body module.

Body Modules
Each body frame forms a specific type of body module.
For a bus, the body module types are: a front module, a wheel housing module, a door module, a window-only module, a rear module.
Further body module types include: a driver module, a driverless cab module, a passenger module, a rear module, a cargo module, or any task specific module, and all are configured to be fixed to the chassis sections in substantially the same manner e.g. by a robotic production system.
Each body module is configured to be glue bonded together, e.g. using a robotic production system.

Microfactory Cells
A cell includes no more than 10 robots.
Each robot in a cell is statically floor mounted.
Each robot in a cell undertakes multiple different types of assembly tasks.
Each cell is also served by mobile robots.
A cell undertakes the assembly and joining of modular transverse chassis sections together for a specific vehicle.
A cell undertakes the joining of frames or modular body parts to modular transverse chassis sections.
A cell undertakes the joining of modular drivetrains to modular transverse chassis sections.
A cell undertakes the joining of modular wheel housings to modular transverse chassis sections.
A cell undertakes the joining of modular battery packs to the chassis.
A cell undertakes the assembly and joining of modular components to the chassis.
the assembly of the chassis and the addition one or more of the drivetrain, suspension, battery packs for a specific vehicle is all completed by a single cell.
Localising the assembly of the chassis and the addition one or more of the drivetrain, suspension, battery packs to a single production cell enables low volume (e.g. 1,000 or fewer vehicles per year) yet economically viable production of vehicles.
Localising the assembly of the chassis and the addition one or more of the drivetrain, suspension, battery packs to a single production cell enables low volume, customer specific production of vehicles.
Adding further cells enables scaling of production capacity.
Each cell is connected to all other cells in a microfactory, over a data network.
The microfactory is less than 100,000 square metres in size.
Microfactory is less than 50,000 square metres.
Microfactory is approximately 20,000 square metres.

Appendix 1 Section K: The Arrival Car System

In this Appendix 1, Section K, we will use a simplified feature organisation compared to that used in the main description.

Note specifically also that the vehicles, vehicle systems, vehicle fleets and methods described below can utilise any and all the Features and related optional sub-features described in the other Sections A-J in this Appendix 1. For example, the vehicles, vehicle systems, vehicle fleets and methods vehicles described below can incorporate or otherwise use the hardware and software modularity concepts described earlier in Appendix 1 Section A and Appendix 1 Section B; is designed to include the security architecture described in Appendix 1 Section C; and is configured using the Vehicle Builder system of Appendix 1 Section D. They can be brought from design to production in 12 months with no price premium for being zero emission, and are produced using small cells of robots, with each cell producing both sub-assemblies and the entire vehicle (see Appendix 1 Section E for more on Robofacturing) in relatively small and low capital expenditure (CapEx) microfactories (see Appendix 1 Section F) that are not based on conventional long moving production lines. They are configured to use modular high voltage battery modules (see Appendix 1 Section G), a scalable system which enables battery packs to be made for the entire range of Arrival vehicles. Microfactories do not need huge steel panel presses because Arrival vehicles use body panels that are not made of pressed steel, but instead lightweight composites; composite panels can be made for the entire range of Arrival vehicles (see Appendix 1 Section H). The Arrival Car System implements the principles of the Arrival Van System (see Appendix 1 Section I) and the Arrival Bus System (see Appendix 1 Section J).

Feature 1: Vehicle with Different Body Types and Customised Attributes

1: A vehicle selected from a vehicle system, in which the vehicle system includes vehicles with multiple different vehicle body types, each vehicle including a skateboard type platform with one or more attributes;
and in which different vehicle body types are all configured to attach to the same skateboard type platform.
   2: A vehicle system including vehicles with multiple different vehicle body types, each vehicle including a skateboard type platform with one or more attributes;
and in which vehicle bodies of different body types are all configured to attach to the same skateboard type platform.
   3: A fleet of vehicles, each vehicle selected from a vehicle system, in which the vehicle system includes vehicles with multiple different vehicle body types, each vehicle including a skateboard type platform with one or more attributes;
and in which different vehicle body types are all configured to attach to the same skateboard type platform;
and in which an operator of the fleet selects the body type or types and the one or more attributes of the skateboard type platform, to meet its requirements.
   4: A method of designing and assembling a vehicle, the method including:
   (i) selecting one or more attributes for the vehicle from a range of different available vehicle attributes using the vehicle design tool;
   (ii) configuring a skateboard type platform for the vehicle according to the one or more attributes;
   (iii) assembling the selected body type to the configured skateboard type platform.

Optional Sub-Features:

General:
different vehicle body types include several of the following: autonomous delivery drone; 2 seat passenger car; 3 seat passenger car; 4 seat passenger car; sports car;
roadster; van; pick-up truck, bus.
different vehicle body types include all of the following: autonomous delivery drone; 2 seat passenger car; 3 seat passenger car; 4 seat passenger car; sports car; roadster; van;
pick-up truck.
vehicle bodies of different body types are all configured to attach to the same skateboard type platform
available attributes include: vehicle length, vehicle width, wishbone width, battery capacity, vehicle range, height of skateboard platform, number of electric motors, type of thermal architecture, suspension stiffness, ride height, charging capability (AC, DC or both).

Vehicle Length:
attribute is a configurable length of the skateboard type platform.
attribute is a configurable length of the skateboard type platform that is not limited to two or three available lengths, but can be any length within a defined maximum and minimum length.
attribute is a configurable length of the skateboard type platform that is not limited to two or three available lengths, but can be any length within a defined maximum and minimum length and the size increments separating available lengths is less than one of the following: 50 cm, or 40 cm, or 30 cm or 20 cm or 10 cm.
attribute is a configurable length of the skateboard type platform that is selected from a list of possible lengths, and there are at least 3, 4, 5, 6, 7, 8, 9 or 10 or more possible lengths a customer can choose from.
vehicles of different overall length can be configured by including a pair of longitudinal chassis beams or extrusions of different length in those vehicles.
length is configurable by altering the length of the longitudinal extruded beams and the vehicle can be configured with at least one of: 3, 4, 5, 6, 7, 8, 9 or 10 or more, different lengths.
length is configurable by increments of approximately the length of an individual battery module.
length of a battery module is 350 mm.
length is configurable by increments of approximately 355 mm.

Vehicle Width:
attribute is a configurable width of the skateboard type platform.
attribute is a configurable width of the skateboard type platform that is not limited to two or three available widths, but can be any length within a defined maximum and minimum width.
attribute is a configurable width of the skateboard type platform that is not limited to two or three available widths, but can be any width within a defined maximum and minimum width and the size increments separating available widths is less than one of the following: 50 cm, or 40 cm, or 30 cm or 20 cm or 10 cm.
attribute is a configurable width of the skateboard type platform that is selected from a list of possible widths, and there are at least 3, 4, 5, 6, 7, 8, 9 or 10 or more possible widths a customer can choose from.
vehicles of different overall width differ in having a front cradle and a rear cradle of different width.
vehicles of different overall width differ in having a one or more wishbones of different width.
width is configurable by increments of approximately the width of an individual battery module.
width of a battery module is 350 mm.
width is configurable by increments of approximately 355 mm.

Batteries:
the battery capacity or range of the vehicle is specified by a customer and then an appropriate number of battery modules is assigned for use in the skateboard type platform of that vehicle.
the skateboard type platform includes two longitudinal extruded beams and an array of battery modules positioned between these beams.
length is configurable by increments of the length of an individual battery module and the battery modules are each parallel connected and deliver a high voltage output that is the same as the high voltage output of the entire pack of battery modules.
width is configurable by increments of the width of an individual battery module and the battery modules are each parallel connected and deliver a high voltage output that is the same as the high voltage output of the entire pack of battery modules.
each individual battery module outputs between 300V and 450V.
the skateboard type platform includes a double layer of battery modules
battery modules are as defined in Section G.

Thermal Management:
the vehicle includes a thermal management system configured to perform at least one of passive cooling and active cooling, wherein passive cooling maintains a temperature that is above an ambient temperature, and wherein active cooling maintains a temperature that is below the ambient temperature.
the vehicle includes a thermal management system configured to perform both passive cooling and active cooling, where the active cooling includes a Peltier or solid state thermoelectric cooling system.
the vehicle includes a thermal management system that includes a Peltier or solid state thermoelectric cooling system.

Vehicle Design and Assembly:
vehicle is designed using an automated vehicle design tool.
available attributes include any variable that can be selected using an automated vehicle design tool.
available attributes include any variable that can be selected using an automated vehicle design tool as defined in Section D.
skateboard platform is optimised for robotic handling, installation or assembly, such as autonomous robotic handling, installation or assembly.
vehicle is optimised for robotic handling, installation or assembly, such as autonomous robotic handling, installation or assembly.
vehicle includes a pair of longitudinal chassis beams or extrusions and a torsion bar passes through each longitudinal beam.
the longitudinal chassis beams or extrusions are designed for robotic handling and assembly.
vehicle includes a pair of longitudinal chassis beams or extrusions and a front and rear cradle attached to the beams, with at least one wishbone attached to each side of each cradle, and each cradle includes a cut out section and each wishbone is then configured to attach through the cut out section to a torsion bar that passes through that cradle.
each cradle includes a cut out section there is an upper and a lower one wishbone attached to each side of each cradle, and each upper wishbone is configured to pivot in a cut out around a pin that passes through each cradle.
each cradle is designed for robotic handling and assembly.
the skateboard type platform includes a universal data and power connection port that a number of components in the vehicle body are configured to connect to.
all parts of the skateboard type platform are optimised or designed for robotic handling and/or assembly.
a body is moved vertically with respect to the skateboard type platform to join to the platform.
the body is moved by a robotic assembly system to join to the platform.
the skateboard platform and the vehicle body are secured together solely with mechanical fixing systems.
the skateboard platform and the vehicle body are secured together with mechanical fixing systems that are configured to mechanically lock together.
the mechanical fixing systems are configured for robotic handling and manipulation
skateboard type platform supports electric motors mounted to the platform.
a skateboard type platform is a vehicle platform that includes a chassis structure that supports an integral or internal battery pack and where a flat topped cover of the battery pack forms or supports a flat top of the skateboard type platform.
vehicle is assembled in a robotic production environment as defined in Section E.
vehicle is assembled in a microfactory as defined in Section F.

Feature 2: Vehicle with Customised Length and Body Type

1: A vehicle selected from a vehicle system, in which the vehicle system includes vehicles with multiple different vehicle body types, each vehicle including a skateboard type platform with a configurable length;
and in which different vehicle body types are all configured to attach to the same skateboard type platform.
   2: A vehicle system including vehicles with multiple different vehicle body types, each vehicle including a skateboard type platform with a configurable length;
and in which vehicle bodies of different body types are all configured to attach to the same skateboard type platform.
   3: A fleet of vehicles, each vehicle selected from a vehicle system, in which the vehicle system includes vehicles with multiple different vehicle body types, each vehicle including a skateboard type platform with a configurable length;
and in which different vehicle body types are all configured to attach to the same skateboard type platform;
and in which an operator of the fleet selects the body type or types and the skateboard type platform length, to meet its requirements.
   4: A method of designing and assembling a vehicle, the method including:
   (i) selecting a length for the vehicle from a range of different available vehicle lengths using the vehicle design tool;
   (ii) configuring a skateboard type platform for the vehicle by altering its length, in dependence on the selected vehicle length;
   (iii) assembling the selected body type to the configured skateboard type platform.

Optional Sub-Features:
any applicable sub-feature from Feature 1 above.

Feature 3: Different Vehicles have Different Lengths of Central Extrusion

1: A vehicle including a pair of longitudinal chassis beams or extrusions that are each joined to a front cradle and to a rear cradle, each cradle supporting at least one suspension wishbone;
and in which the overall length of the vehicle has been selected from a range of different possible lengths and the vehicle has been configured to that overall length by including a pair of longitudinal chassis beams or extrusions of the appropriate length.
   2: A vehicle system including multiple different vehicle types, each vehicle type including a skateboard type platform including a pair of longitudinal chassis beams or extrusions that are each joined to a front cradle and to a rear cradle, each cradle supporting at least one suspension wishbone;
and in which vehicles of different overall length can be configured by including a pair of longitudinal chassis beams or extrusions of different length in those vehicles.
   3: A fleet of vehicles, each vehicle selected from a vehicle system, in which the vehicle system includes multiple different vehicle lengths, each vehicle including a skateboard type platform including a pair of longitudinal chassis beams or extrusions that are each joined to a front cradle and to a rear cradle, each cradle supporting at least one suspension wishbone;
and in which vehicles of different overall length can be configured by including a pair of longitudinal chassis beams or extrusions of different length in those vehicles.
and in which an operator of the fleet, when specifying its requirements for the vehicles in its fleet, selects the overall length or lengths needed to meet its requirements.
   4: A method of designing and assembling a vehicle, the method including:
   (i1) selecting a length for the vehicle from a range of different available vehicle lengths using an automated vehicle design tool;
   (ii) configuring the skateboard type platform by altering the length of a pair of longitudinal chassis beams or extrusions in the platform, in dependence on the selected vehicle length, using the automated vehicle design tool;
   (iii) assembling the vehicle by joining the longitudinal chassis beams or extrusions to a front cradle and to a rear cradle, each cradle supporting at least one suspension wishbone; and assembling a body for the selected vehicle type to the configured skateboard type platform.

Optional Sub-Features:

Centre Extrusions:
skateboard type platform includes a pair of longitudinal beams or extrusions.
extrusions are a pair of aluminium one-piece longitudinal extrusions.
longitudinal beams or extrusions are joined to front and rear cradles.
each longitudinal beam or extrusion is rigidly joined to a cradle using a rigid beam or rod that passes through a recess or hollow in both the longitudinal beam or extrusion and a recess or hollow in the cradle.
the rigid beam is itself hollow.
the rigid beam is an inner extrusion.
there are upper and lower rigid beams or inner extrusions.
each longitudinal beam or extrusion comprising one or more coolant channels.
each longitudinal beam or extrusion is configured to hold one or more active cooling devices (e.g. a solid state cooling device, such as a Peltier device).
the active cooling device is held by a cavity of the longitudinal beam or extrusion or is mounted to the longitudinal beam or extrusion.
each longitudinal beam or extrusion comprising a first channel and a second channel, and is further configured to hold one or more active cooling device, wherein the active cooling device is configured to transfer thermal energy from the first coolant channel to the second coolant channel.
any applicable sub-feature from Feature 1 above.

Feature 4: Different Vehicles can have Different Battery Capacities

1: A vehicle including a skateboard type platform; in which the skateboard type platform includes an array of battery modules and, when the vehicle was being designed, then the battery capacity or required range of the vehicle was specified by a customer and then an appropriate number of battery modules was automatically assigned for use in the skateboard type platform of that vehicle by an automated vehicle design tool.
2: A vehicle system including multiple different vehicle types, each vehicle type including a skateboard type platform;
in which the skateboard type platform includes an array of battery modules and, when a specific vehicle is being designed, then the battery capacity of the vehicle is specified by a customer and then an appropriate number of battery modules is assigned for use in the skateboard type platform of that vehicle.
   3: A fleet of vehicles, each vehicle including a skateboard type platform;
in which the skateboard type platform includes an array of battery modules and, when a specific vehicle is being designed, then the battery capacity of the vehicle is specified by a customer and then an appropriate number of battery modules is assigned for use in the skateboard type platform of that vehicle by an automated vehicle design tool;
and in which an operator of the fleet, when specifying its requirements for the vehicles in its fleet, selects the battery capacity or capacities needed for these vehicles to meet its requirements.
   4: A method of designing and assembling a vehicle, the method including:
   (i) selecting a battery capacity for the vehicle from a range of different battery capacities, using a vehicle design tool;
   (ii) configuring a skateboard type platform by assigning an appropriate number of battery modules for use in the skateboard type platform, using the vehicle design tool;
   (iii) assembling the skateboard type platform by assembling the battery modules into the skateboard type platform of that vehicle.

Optional Sub-Features:
any applicable sub-feature from Feature 1 above.
The battery modules are high voltage battery modules, for example, as described in Section G.
The Robofacturing techniques set out in Section E are applicable to the production of the vehicle and its components.

Feature 5: Double-Deck Battery Pack

Claim 1: A vehicle including a skateboard type platform; in which the skateboard type platform includes a double layer of battery modules.

Claim 2: A vehicle system including multiple different vehicle types, each vehicle type including a skateboard type platform;
in which the skateboard type platform includes a double layer of battery modules.
   3: A fleet of vehicles, each vehicle including a skateboard type platform;
in which the skateboard type platform includes a double layer of battery modules.
   4: A method of assembling a vehicle, the method including:
   (i) assembling a battery pack for the vehicle as a double layer of battery modules.

Optional Sub-Features:
battery modules are arranged as two or more layers to form a battery pack.
pair of longitudinal beams or extrusions supports a number of the battery modules, formed as a battery pack.
battery modules are arranged as a single row of parallel connected battery modules running longitudinally along the length of the vehicle and inside longitudinal beams or extrusions.
battery modules are arranged as two layers to form a battery pack, with the top layer facing upwards, and the lower layer facing downwards, so that each battery module presents its base to a central battery pack base plate that runs through the central chassis extrusion.
the central battery pack base plate includes a liquid cooling system.
each battery module is configured to operate as part of a vehicle battery pack that includes multiple, identical such battery modules, in which each battery module (i) generates at least 300V output and (ii) is electrically connected in parallel with at least 2 other substantially similar battery modules to form the battery pack.
each battery module has the same, square cross section.
each battery module has a size that conforms to regular size intervals and is part of a family of other types of components with sizing that also conforms to the same size intervals.
Each battery module is a 350×350×100 mm grid sized component.
each battery module generates at least 300V output, and (i) includes a single outer shell or lid that is configured to enclose an array of rechargeable cells and seal against a rigid base of the module, and (ii) is configured to be electrically connected to further, substantially similar, battery modules, to form a complete battery pack.
each battery module is configured to operate as part of a battery pack that includes multiple, identical such battery modules, in which each battery module (i) includes rechargeable cells configured to generate, at a pair of output terminals, at least 300V and (ii) delivers power over a substantially low profile, printed circuit board (PCB) flexible electrical conductor.
each vehicle battery module is configured to delivers HV output directly into the HV power bus of a vehicle.
each battery module is configured to electrically engage with a conductor that is integrated into a vehicle component or other vehicle structure that has a purpose in addition to conducting power, such as a structural component or panel.
the battery pack is configured to include a number of parallel connected battery modules, such as 1, 2 3 . . . n battery modules.
the battery pack includes: an array of parallel connected battery modules; a liquid cooling plate; a liquid cooling system; and top and bottom, one piece rigid covers that enclose battery module.
any applicable sub-feature from Feature 1 above.
The battery modules are high voltage battery modules, for example, as described in Section G.

Feature 6: Central Chassis Extrusion Supports Battery Modules

1: A vehicle including a skateboard type platform;

in which the skateboard type platform includes two longitudinal extruded beams and an array of battery modules positioned between these beams.

2: A vehicle system including multiple different vehicle types, each vehicle type including a skateboard type platform;
in which the skateboard type platform includes two longitudinal extruded beams and an array of battery modules positioned between these beams.
   3: A fleet of vehicles, each vehicle including a skateboard type platform;
in which the skateboard type platform includes two longitudinal extruded beams and an array of battery modules positioned between these beams;
and in which an operator of the fleet, when specifying its requirements for the vehicles in its fleet, selects the battery capacity or capacities, or vehicle range or ranges, needed for these vehicles to meet its requirements and each vehicle is then automatically provided with the appropriate number of battery modules between these beams.
   4: A method of designing and assembling a vehicle, the method including:
   (i) selecting a battery capacity for the vehicle from a range of different battery capacities, using an automated vehicle design tool;
   (ii) configuring a skateboard type platform by assigning an appropriate number of battery modules for use in the skateboard type platform, using the vehicle design tool, to give the selected battery capacity;
   (iii) assembling the vehicle by assembling the battery modules between two longitudinal extruded beams in the skateboard type platform.

Optional Sub-Features:

Battery Modules
pair of longitudinal beams or extrusions supports a number of battery modules, formed as a battery pack.
battery modules are arranged as a single row of parallel connected battery modules running longitudinally along the length of the vehicle and inside the longitudinal beams or extrusions.
battery modules are arranged as two layers to form a battery pack, with the top layer facing upwards, and the lower layer facing downwards, so that each battery module presents its base to a central battery pack base plate that runs through the central chassis extrusion.
the central battery pack base plate includes a liquid cooling system.
the battery pack comprising a fixture configured to hold the battery pack in place and also to restrict the flow of thermal energy between the battery pack and a passive cooling device (e.g. by the fixture having a low cross sectional area).
battery modules are arranged as two or more layers to form a battery pack.
each battery module is configured to operate as part of a vehicle battery pack that includes multiple, identical such battery modules, in which each battery module (i) generates at least 300V output and (ii) is electrically connected in parallel with at least 2 other substantially similar battery modules to form the battery pack.
each battery module has the same, square cross section.
each battery module has a size that conforms to regular size intervals and is part of a family of other types of components with sizing that also conforms to the same size intervals.
Each battery module is a 350×350×100 mm grid sized component.
each battery module generates at least 300V output, and (i) includes a single outer shell or lid that is configured to enclose an array of rechargeable cells and seal against a rigid base of the module, and (ii) is configured to be electrically connected to further, substantially similar, battery modules, to form a complete battery pack.
each battery module is configured to operate as part of a battery pack that includes multiple, identical such battery modules, in which each battery module (i) includes rechargeable cells configured to generate, at a pair of output terminals, at least 300V and (ii) delivers power over a substantially low profile, printed circuit board (PCB) flexible electrical conductor.
each vehicle battery module is configured to delivers HV output directly into the HV power bus of a vehicle.
each battery module is configured to electrically engage with a conductor that is integrated into a vehicle component or other vehicle structure that has a purpose in addition to conducting power, such as a structural component or panel.
the battery pack is configured to include a number of parallel connected battery modules, such as 1, 2 3 . . . n battery modules.
the battery pack includes: an array of parallel connected battery modules; a liquid cooling plate; a liquid cooling system; and top and bottom, one piece rigid covers that enclose battery module.
any applicable sub-feature from Feature 1 above.
The battery modules are high voltage battery modules, for example, as described in Section G.

Feature 7: Central Chassis Extrusion Includes Torsion Bar

1: A vehicle including a skateboard type platform including two longitudinal beams; and in which a torsion bar passes through each beam.
2: A vehicle system including multiple different vehicle types, each vehicle type including a skateboard type platform including two longitudinal beams; and in which a torsion bar passes through each beam.
3: A fleet of vehicles, each vehicle including a skateboard type platform including two longitudinal beams;
in which a torsion bar passes through each beam;
and in which an operator of the fleet, when specifying its requirements for the vehicles in its fleet, selects, directly or indirectly, the torsion bar setting needed for these vehicles to meet its requirements and each vehicle is then provided with torsion bars at the required setting.
   4: A method of designing and assembling a vehicle, the method including:
   (i) assembling a skateboard type platform with two longitudinal beams;
   (ii) passing a torsion bar through each longitudinal beam.

Optional Sub-Features:
any applicable sub-feature from Feature 1 above.
The Robofacturing techniques set out in Section E are applicable to the production of the vehicle and its components.

Feature 8: Single Power and Data Connection Port Between Skateboard and Body

1: A vehicle including a skateboard type platform and in which different components or parts of the vehicle are attachable to the skateboard type platform;
and in which the skateboard type platform includes a universal data and power connection port that the different components of the vehicle are each configured to connect to.
   2: A vehicle system including multiple different vehicle types, each vehicle type including a skateboard type platform and in which different components or parts of the vehicle are attachable to the skateboard type platform;
and in which the skateboard type platform includes a universal data and power connection port that the different components of the vehicle are each configured to connect to.
   3: A fleet of vehicles, each vehicle selected from a vehicle system including multiple different vehicle types, each vehicle type including a skateboard type platform and in which different components or parts of the vehicle are attachable to the skateboard type platform;
and in which the skateboard type platform includes a universal data and power connection port that the different components of the vehicle are each configured to connect to;
and in which an operator of the fleet, when specifying its requirements for the vehicles in its fleet, selects, directly or indirectly, the data and power requirements for these vehicles to meet its requirements and each vehicle is then provided with a data and power network that meets its requirements.
   4: A method of designing and assembling a vehicle, the method including:
   (i) selecting a number of components of the vehicle from a range of different components that are available, using an automated vehicle design tool;
   (ii) assembling the selected number of components to the configured skateboard type platform using a universal data and power connection port in the skateboard type platform that the different components or parts of the vehicle each are configured to connect to.

Optional Sub-Features:

Universal Data and Power Connection Port:
a connectivity port between the vehicle components includes the following connections: HV+, HV−, LV+, LV−, CAN+, CAN−.
the connectivity port between the components further includes the following connections: IV+, IV−.

Components that are Connectable Via a Universal Data and Power Connection Port:
a vehicle body.
a junction box (e.g. the super junction box).
one or more battery packs.

Connectivity Between the Platform and the Body:
different body types are all configured to attach to the same skateboard type platform using the same physical, data and power connection interfaces.
ethernet data connectivity links the skateboard type platform and each vehicle body.
wireless data connectivity links the skateboard type platform and each vehicle body.
an automated vehicle design tool is used to design the data and power network in the skateboard platform and the body.
any applicable sub-feature from Feature 1 above.

Feature 9: Vehicle Assembly

1: A vehicle including:
a skateboard type platform with one or more attributes; and
a plurality of components which are designed for an installation path to a final position corresponding to the one or more attribute, in which the installation path is optimised for robotic handling, installation or assembly, such as autonomous robotic handling, installation or assembly.
   2: A vehicle selected from a vehicle system, in which the vehicle system includes vehicles with multiple different vehicle body types, each vehicle including:
a skateboard type platform with one or more attribute; and
a plurality of components which are designed for an installation path to a final position corresponding to the one or more attribute, in which the installation path is optimised for robotic handling, installation or assembly, such as autonomous robotic handling, installation or assembly.
   3: A fleet of vehicles, each vehicle selected from a vehicle system, in which the vehicle system includes vehicles with multiple different vehicle body types, each vehicle including:
a skateboard type platform with one or more attribute; and
a plurality of components which are designed for an installation path to a final position corresponding to the one or more attribute, in which the installation path is optimised for robotic handling, installation or assembly, such as autonomous robotic handling, installation or assembly.
   4: A method of designing and assembling a vehicle, the method including:
   (i) selecting one or more attribute for the vehicle from a range of different available vehicle attributes using the vehicle design tool;
   (ii) configuring a skateboard type platform for the vehicle according to the one or more attribute by installing a plurality of components which are designed for an installation path to a final position corresponding to the one or more attribute, in which the installation path is optimised for robotic handling, installation or assembly, such as autonomous robotic handling, installation or assembly.

Optional Sub-Features:

Robotic Assembly
all parts of the skateboard type platform are optimised or designed for robotic handling and/or assembly.
a body is moved vertically with respect to the skateboard type platform to join to the platform.
the body is moved by a robotic assembly system to join to the platform.
the skateboard platform and the vehicle body are secured together solely with mechanical fixing systems.
the skateboard platform and the vehicle body are secured together with mechanical fixing systems that are configured to mechanically lock together.
the mechanical fixing systems are configured for robotic handling and manipulation.

Vehicle Types
the vehicle system includes vehicles of the following different types: car, van, roadster,
the different types of vehicles all share the same skateboard platform structure of front left and right cradles, rear left and right cradles, joined together by a pair of longitudinal beams or extrusions.
the skateboard type platform supports different types of bodies.
different types of bodies include bodies for the following types of vehicle: autonomous delivery drone; 2 seat passenger car; 3 seat passenger car; 4 seat passenger car; sports car; roadster; van; pick-up truck, bus.
the different types of bodies fitted to the skateboard type platform are available in different lengths and/or widths.

Components in the Skateboard Type Platform:
skateboard type platform includes one or more of the following components: battery modules; battery modules collected together to form a battery pack; master BMS; low voltage battery; onboard charger; charging controller; DC-DC converter; integrated drive unit; traction inverter; drive control unit; communications module; ethernet switch; HMI platform; video surveillance system; vehicle sound engine platform; unified computing platform passive cooling device; active cooling device.
one or more of the components are optimised for is optimised for robotic handling, installation or assembly, such as autonomous robotic handling, installation or assembly.
skateboard type platform supports electric motors mounted to the platform.
a skateboard type platform is a vehicle platform that includes a chassis structure that supports an integral or internal battery pack and where a flat topped cover of the battery pack forms or supports a flat top of the skateboard type platform.
any applicable sub-feature from Feature 1 above.
The Robofacturing techniques set out in Section E are applicable to the production of the vehicle and its components.

1. A vehicle robotic production environment, in which the environment hosts robotic agents that are organised as groups of cells, each cell with no more than 10 robots, and in which:
(i) one group of cells transforms fabric into vehicle composite panels and other parts, eliminating the need for steel panel pressing equipment;
(ii) other cells assemble at least portions of a vehicle together from modular components; and
(iii) each cell is served by AMRs (autonomous mobile robots), eliminating the need for a moving production line in the production environment.
Core features

2. The vehicle robotic production environment of claim 1 in which the production environment is installed in a factory, or a network of factories, that are each less than 25,000 square meters in area.

3. The vehicle robotic production environment of claim 1 in which the production environment is installed in a building with a conventional flat concrete floor that has not been strengthened for a vehicle body panel stamping press.

4. The vehicle robotic production environment of claim 1 in which some of the cells are configured to transform fabric into coloured vehicle composite panels and other parts, removing the need to install a paint shop of the kind needed to paint conventional pressed steel parts.

5. The vehicle robotic production environment of claim 1 in which each cell comprises a group of robots that are programmed to assemble, at a fixed location and not a moving production line, at least part of the vehicle by joining together multiple, modular components, each component designed or selected for robotic production, handling or assembly; and the cells together assemble substantially the entire vehicle.

6. The vehicle robotic production environment of claim 1 in which each cell comprises a group of robots that are programmed to assemble, at a fixed location and not a moving production line, at least part of the vehicle by (a) joining together multiple components to form a structural chassis, and a body structure, and (b) adding composite body panels and composite roof panels to the body structure, and all of the components and the panels are designed or selected for robotic production, handling or assembly.
Robotic Production Environment Reconfigurability

7. The vehicle robotic production environment of claim 1 in which the robotic production environment is configured to assemble at least one of the following vehicle types: small passenger car, large passenger car, small van, large van, specialist vans, truck and lorries of different lengths and capacities, buses of different lengths and capacities and in which multiple cells can be re-purposed to be part of a set of cells that produce any of those types of vehicle.

8. The vehicle robotic production environment of claim 1 in which the robotic production environment is configured to be automatically reconfigurable through software-implemented changes to automatically: make different components, to assemble different types of vehicles, to assemble different configurations of the same type of vehicles, to use different assembly techniques, to use different components, or to transport vehicle parts or structures through the physical environment of the factory using alternate physical routes.

9. The vehicle robotic production environment of claim 1 in which the robotic production environment is automatically reconfigurable through software-implemented changes that alter one or more of: the function of robotic agents, the physical location or arrangement of robotic agents, the number of operative robotic agents; the routes taken by AMRs.
Robotic Production Environment Layout

10. The vehicle robotic production environment of claim 1, having a layout or arrangement of cells positioned on a standardised rectilinear grid.

11. The vehicle robotic production environment of claim 1 in which the physical layout or arrangement of cells in the robotic production environment has been planned by an automated layout design tool that determines the optimal or preferred layout or arrangement of cells and the robotic services they each perform.

12. The vehicle robotic production environment of claim 1 in which the layout or arrangement of cells in the environment has been designed by an automated simulation tool which takes into account parameters including: production cost; production time; production quality; component availability; use of AMRs to transport components and sub-assemblies.

13. The vehicle robotic production environment of claim 1 in which the robotic production environment is configured to include a model or map of its physical environment that is generated or augmented or refined in real time by AMRs and robots using at least SLAM computer vision techniques.

14. The vehicle robotic production environment of claim 1 in which the robotic production environment includes a master semantic model of its physical environment that enables AMRs and robotic agents to relate at a semantic level to the function or other attributes of objects, both fixed and dynamic they detect.

15. The vehicle robotic production environment of claim 1 in which an automated layout design tool determines the layout or arrangement of cells and the robotic services they each perform using simulation, including simulation using a robotic services control system, and the robotic services control system used in the simulation is also used to control robotic services in the real-world robotic production environment.
Vehicle Design Tool

16. The vehicle robotic production environment of claim 1 in which the robotic production environment includes or accesses an automated vehicle design tool.

17. The vehicle robotic production environment of claim 16 in which the automated vehicle design tool is configured to enable vehicles to be designed that specifically meet a customer's (e.g. B2B customer) set of requirements.

18. The vehicle robotic production environment of claim 16 in which the robotic production environment is configured to automatically build or assemble the vehicle, as designed by the automated vehicle design tool, with a customer specified configuration, using build instructions automatically generated by the automated vehicle design tool, and the customer specified configuration includes one or more of: battery capacity or range, vehicle length, vehicle height, vehicle weight, vehicle width, specific sensors.

19. The vehicle robotic production environment of claim 16 in which:
(i) the automated device design tool is configured to automatically analyse a design for the vehicle and plan an automated production of that device by selecting robotic services from a catalogue of available robotic services;
(ii) the automated device design tool is configured to send data defining the production of the device to the automated robotic production environment;
(iii) the automated robotic production environment is configured to produce, or control the production of, the device, by (a) using the data sent by the automated vehicle design tool and (b) using the selected robotic services.

20. The vehicle robotic production environment of claim 16 in which:
(i) the automated vehicle design tool is configured to access data that defines a range of modular hardware components, each optimised for robotic assembly, and a range of modular software components, and then selecting and generating a list of the modular hardware and modular software components that meet customer specified requirements;
(ii) the automated vehicle design tool is configured to send the list of selected modular hardware and modular software components to the automated robotic production environment;
(iii) the automated robotic production environment is configured to then assemble, or control the assembly of, the vehicle, using the modular hardware and modular software component list sent by the automated vehicle design tool.

21. The vehicle robotic production environment of claim 16 comprising a software implemented tool configured to evaluate a total cost of assembly for one or multiple components and configured to evaluate multiple different robotic assembly process and/or robotic services, taking into account: the number of robotic services operations, the time taken to complete the robotic services operations, where errors may occur and any other actions involved to give feedback on a total cost of assembly; and the tool then generates an optimal robotic assembly process that is then implemented in the robotic production environment.

22. The vehicle robotic production environment of claim 16 in which:
(i) the automated vehicle design tool is configured to (a) obtain data on a vehicle hardware topology, the topology comprising modular hardware components, and desired system features of the vehicle, (b) determine system functions and a set of ECUs required to provide the desired system features in the vehicle based on the data, (c) define an arrangement of the ECUs in the vehicle and a wiring plan to connect the modular hardware components with the ECUs, and (d) define a networks configuration for the vehicle to enable communications of the modular hardware components with each other as required for performing the system functions with providing the desired system features;
(ii) the automated vehicle design tool is configured to send the wiring plan and the network configuration to an operations control system of the robotic production environment;
(iii) the operations control system is configured to control the robotic production environment to produce the vehicle in accordance with the wiring plan and the network configuration.
Robotic services

23. The vehicle robotic production environment of claim 1, configured to produce, or control the production of, the vehicle, by using selected robotic services.

24. The vehicle robotic production environment of claim 23 in which robotic services include any of the following, in relation to a component or item: storing; retrieving; moving; delivering; gripping; rotating; pick and placing; assembling; gluing; inserting; joining; welding; any other handling operation.

25. The vehicle robotic production environment of claim 23 in which robotic services include locating a component or item using a machine vision system.

26. The vehicle robotic production environment of claim 23 in which robotic services include identifying a component or item using a machine vision system.

27. The vehicle robotic production environment of claim 23 in which each cell implements a specific sub-set of all available robotic services.

28. The vehicle robotic production environment of claim 23 in which different fixed robots each have specialised end-effectors for providing specific robotic services.

29. The vehicle robotic production environment of claim 23 in which robotic services are defined by an extensible and standardised list or schema of capabilities, enabling any supplier to provide services for the automated robotic production environment, provided that those services conform to the list or schema of capabilities.

30. The vehicle robotic production environment of claim 23 in which robotic services are used in the automated robotic production environment to perform actions on components, and the components are each optimised for robotic handling.

31. The vehicle robotic production environment of claim 23 in which robotic services include any of: identifying the pose of a component; reading the unique ID of a component; picking up the component; moving the component to a target position; attaching the component to another component; fastening the component to another component; screwing a standardised fastener; punching a standardised fastener; connecting standardised electrical interfaces.

32. The vehicle robotic production environment of claim 23 in which robotic services includes gluing and some robots include glue delivery effectors that are configured to inject glue into glues holes in chassis sections of a vehicle platform to join those sections together.
Autonomous operation

33. The vehicle robotic production environment of claim 1 in which the robotic production system is configured to use a semantic model of physical features or objects within the factory environment, such as the location and function of one or more of (i) the robotic agents, including end-effectors used by robotic agents and the objects manipulated by those end-effectors and the targets for those objects; (ii) the AMRs; (iii) the cells that host the robotic agents.

34. The vehicle robotic production environment of claim 1 in which the robotic production environment is configured to operate with no pre-defined Takt time and is configured to automatically determine, by itself or in conjunction with other with other local or non-local computing resources, dynamically and in real-time (i) what steps to perform, (ii) when to perform those step, (iii) by what agents, including both robotic agents and also non-robotic agents, those steps should be performed and (iv) how those agents are to interact with each other, in order to build or assemble the vehicle.

35. The vehicle robotic production environment of claim 1 in which the robotic production environment or system uses a semantic (ontology driven) model of physical features, such as the location and function of agents, including robots, end-effectors used by robots, AMRs, cells served by AMRs, and fixed static objects.

36. The vehicle robotic production environment of claim 1 in which the robotic production environment is configured to implement self-learning or to automatically adapt and improve its operations.
Cell operation

37. The vehicle robotic production environment of claim 1 in which a cell undertakes the assembly and joining together of one or more of the following:
(i) modular components to form part or all of a chassis or skateboard platform;
(ii) modular components to form part or all of a superstructure for the vehicle body;
(iii) modular transverse chassis sections;
(iv) frames or modular body parts to modular chassis sections;
(v) modular drivetrains to modular wheel arches;
(vi) modular drivetrains to chassis sections;
(vii) modular wheel arches to chassis sections;
(viii) battery modules to form a battery pack;
(ix) composite body panels to a superstructure for the vehicle body;
(x) composite body panels to chassis sections.

38. The vehicle robotic production environment of claim 1 in which multiple cells of robots are configured to dynamically and in real-time work out amongst themselves, arbitrating as required, and execute, the optimal production process for each vehicle sub-assembly or components they assemble.
Agents

39. The vehicle robotic production environment claim 1 in which the robotic agents include: fixed robots (e.g. with 6 degrees of freedom); cells of robots; groups of cells of robots; and mobile robots or AMRs.

40. The vehicle robotic production environment of claim 1 in which agents include: fixed robots (e.g. with 6 degrees of freedom); cells of robots; groups of cells of robots; and mobile robots or AMRs, and humans equipped with wireless information terminals.

41. The vehicle robotic production environment of claim 1 in which robotic agents are configured for some or all of: pick and place, insert, glue, screw.

42. The vehicle robotic production environment of claim 1 in which cells of robots are served by AMRs for parts delivery.

43. The vehicle robotic production environment of claim 1 in which AMRs and robots use SLAM based computer vision systems to generate a map of their local environment.

44. The vehicle robotic production environment of claim 1 in which AMRs and robots use a semantic (ontology driven) model of physical features, such as the location and function of other AMRs, robots, end-effectors used by robots, targets being handled or modified by the robotic end-effectors.

45. The vehicle robotic production environment of claim 1 wherein the control and management of the operations of the robotic production environment is conducted by writing to and/or reading data from a structured, shared global memory that stores data about all agents, abilities, and resources of the robotic production environment.
Composite panels and other parts

46. The vehicle robotic production environment of claim 1 comprising an automated system for the production of automotive composite parts or panels from source fibre and a thermoplastic matrix; in which production of composite parts or panels is determined by the requirements of a control system that also controls robotic cells that assemble the parts or panels into vehicles.

47. The vehicle robotic production environment of claim 1 comprising multiple robotic cells that use cell-based assembly operations controlled by a software system, and not a conventional production line, to assemble vehicle sub-systems and vehicles and in which at least some of the body parts or panels for the vehicle are not made of stamped or pressed metal but instead from composite parts or panels made from fibre and a thermoplastic matrix in an automated production system;
and in which the cell-based assembly software system sends demand data to the production system and the production system sends supply data to the cell-based assembly software system.

48. The vehicle robotic production environment of claim 1 comprising multiple robotic cells that use cell-based assembly operations controlled by a software system, and not a conventional production line, to produce composite parts or panels, where the cells are not restricted from handling materials in a sequence defined by their physical location;
in which the robotic cells include cells for some or all of the following: a spinning machine to spin fibre and yarns, a loom to weave the fibre and yarns into a fabric structure, a moulding cell to mould the fabric structure into a composite part or panel, a trimming cell to trim and shape the composite part or panel to a final shape, and a bonding or assembly cell to bond different part or panel sections together.

49. The vehicle robotic production environment of claim 1 comprising a system for the production of automotive composite parts or panels, the system including a moulding cell with a tool to mould a fabric structure, made of fibre and a thermoplastic matrix, to form a composite part or panel, in which an autonomous mobile robot (i) supplies the fabric structure to the moulding cell and an autonomous mobile robot then (ii) moves the composite part or panel formed by the cell away from the cell, for example to a trimming cell to trim and shape the composite part or panel to a final shape.

50. The vehicle robotic production environment of claim 1 comprising an automated system for producing automotive composite parts or panels, the system including the following sub-systems:
a loom to weave or otherwise combine fibre and thermoplastic matrix yarn into fabric;
a moulding cell to mould the fabric into a composite part or panel;
a trimming cell to trim and shape the composite part or panel to a final shape, and in which all sub-systems are connected together in a data network and form a single, integrated system for the creation of automotive composite parts or panels from source fibre and a thermoplastic matrix.
